(19) United States
(12) Patent Application Publication
(10) Pub. No.: US 2003/0056205 A1
(43) Pub. Date: Mar. 20, 2003

(54) System of reusable software parts for event flow synchronization and desynchronization, and methods of use

(75) Inventors: Vladimir I. Miloushev, Laguna Niguel, CA (US); Peter A. Nickolov, Irvine, CA (US)

Correspondence Address: Doyle B. Johnson, Crosby, Heafey, Roach & May, P.O. Box 7936, San Francisco, CA, 94120-7936, US

(73) Assignee: Z-FORCE CORPORATION

(21) Appl. No.: 09/780,335

(22) Filed: Feb. 9, 2001

Related U.S. Application Data
(62) Division of application No. 09/640,898, filed on Aug. 16, 2000.
(60) Provisional application No. 60/149,371, filed on Aug. 16, 1999.
(60) Provisional application No. 60/149,624, filed on Aug. 16, 1999.

(51) Int. Cl. G06F 9/44

(52) U.S. Cl. 717/162

(57) ABSTRACT

A system of reusable software parts for designing and constructing software components, applications and entire systems by assembly. Parts for generating events, shaping, distributing and controlling flows of events and other interactions are included. Also included are parts for handling synchronization and desynchronization of events and other interactions between parts, as well as parts for handling properties, parameterizing and serializing components, applications and systems. In addition, innovative adapter parts for interfacing parts that are not designed to work together are included. The system includes a dynamic container for software parts which supports integration of dynamically changing sets of parts into statically defined structures of parts. Other reusable parts for achieving such integration are also included.

### BACKGROUND OF THE INVENTION

(1). Field of the Invention

The present invention is related to the field of object-oriented software engineering, and, more specifically, to reusable software components.

(2). Discussion of the Background Art

Over the last twenty years, the object paradigm, including object-oriented analysis, design, programming and testing, has become the predominant paradigm for building software systems. A wide variety of methods, tools and techniques have been developed to support various aspects of object-oriented software construction, from formal methods for analysis and design, through a number of object-oriented languages, component object models and object-oriented databases, to a number of CASE systems and other tools that aim to automate one or more aspects of the development process.

With the maturation of the object paradigm, the focus has shifted from methods for programming objects as abstract data types to methods for designing and building systems of interacting objects. As a result, methods and means for expressing and building structures of objects have become increasingly important. Object composition has emerged and is rapidly gaining acceptance as a general and efficient way to express structural relationships between objects. New analysis and design methods based on object composition have developed and most older methods have been extended to accommodate composition.

Composition Methods

The focus of object composition is to provide methods, tools and systems that make it easy to create new objects by combining already existing objects.

An excellent background explanation of analysis and design methodology based on object composition is contained in Real-time Object-Oriented Modeling (ROOM) by Bran Selic et al., John Wiley & Sons, New York, in which Selic describes a method and a system for building certain specialized types of software systems using object composition.

Another method for object composition is described in HOOD: Hierarchical Object-Oriented Design by Peter J. Robinson, Prentice-Hall, Hertfordshire, UK, 1992, and “Creating Architectures with Building Blocks” by Frank J. van der Linden and Jürgen K. Müller, IEEE Software, 12:6, November 1995, pp. 51-60.

Another method of building software components and systems by composition is described in a commonly assigned international patent application entitled “Apparatus, System and Method for Designing and Constructing Software Components and Systems as Assemblies of Independent Parts”, serial number PCT/US96/19675, filed Dec. 13, 1996 and published Jun. 26, 1997, which is incorporated herein by reference and referred to herein throughout as the “'675 application.”

Yet another method that unifies many pre-existing methods for design and analysis of object-oriented systems and has specific provisions for object composition is described in the OMG Unified Modeling Language Specification, version 1.3, June 1999, led by the Object Management Group, Inc., 492 Old Connecticut Path, Framingham, Mass. 01701.

Composition-based Development

Composition—building new objects out of existing objects—is the natural way in which most technical systems are made. For example, mechanical systems are built by assembling together various mechanical parts and electronic systems are built by assembling and connecting chips on printed circuit boards. But today, despite its many benefits, the use of composition to build software systems is quite limited, because supporting software design by composition has proven to be extremely difficult. Instead, inferior approaches to composition, which were limited and often hard-to-use, were taken because they were easier to support. Approaches such as single and multiple inheritance, aggregation, etc., have been widely used, resulting in fragile base classes, lack of reusability, overwhelming complexity, high rate of defects and failures.

Early composition-based systems include HOOD (see earlier reference), ObjecTime Developer by ObjecTime Limited (acquired by Rational Software Corp.), Parts Workbench by Digitalk, and Parts for Java by ObjectShare, Inc. (acquired by Starbase Corp.). Each of these systems was targeted to solve a small subset of problems. None of them provided a solution applicable to a broad range of software application types without impeding severely their performance. Specifically, use of these systems was primarily in (a) graphical user interfaces for database applications and (b) high-end telecommunication equipment.

One system that supports composition for a broad range of applications without performance impediments is the system described in the commonly assigned '675 application, with which it is possible to create new, custom functionality entirely by composition and without new program code. This system was commercialized in several products, including ClassMagic and DriverMagic, and has been used to create a variety of software components and applications ranging from graphical user interface property sheets, through Microsoft COM components, to various communications and device drivers.

Since 1996, other composition approaches have been attempted in research projects such as Espresso SCEDE by Faison Computing, Inc., and in commercial products such as Parts for Java by ParcPlace-Digitalk (later ObjectShare, Inc.), and Rational Rose RealTime by Rational Software Corp. None of these has been widely accepted or proven to be able to create commercial systems in a broad range of application areas. The only system known to the inventors that allows effective practicing of object composition in a wide area of commercial applications is the system described in the '675 application. The system and method described in the '675 application and its commercial and other implementations are referred to hereinafter as the “'675 system.”

Dynamically Changing Sets of Objects

Despite the apparent superiority of the system described in the '675 application, it, like all other composition-based systems described above failed to address adequately the important case in which part of the composed structure of objects needs to change dynamically, in response to some stimulus.

Except in trivial cases, most working, commercially viable software components and applications require at least one element that requires dynamic changes. Examples include the ability to dynamically create and destroy a number of sub-windows in a given window of a graphical user interface, and the ability to dynamically create and destroy a connection object in a communications protocol stack when a connection is established and dropped.

Although most of the above-described composition-based systems do have the ability to modify structure dynamically, they do this through some amount of custom code and a violation of the composition view of the software system being built—in both cases essentially undermining the composition approach and at least partially sacrificing its advantages.

In fact, one of the most common objections to the composition-based software design approach is that the structure of software applications is generally dynamic and changes all the time, and so the ability to compose statically new components is of very limited use. Furthermore, the implementation of the functionality required to handle dynamic structures is quite complex, requires high professional qualifications and is frequently a source of hard-to-find software defects. As a result, the systematic and effective practice of software design and development by composition is seriously limited whenever the underlying system does not provide a consistent, efficient, universal and easy-to-use support for dynamically changeable structures of objects.

Reusable Objects

Even if support for static composition and dynamic structures of objects is available, the use of composition is still difficult without a significant number of readily available and easily reusable objects from which new functionality can be composed.

Without such a library of reusable objects the composition systems mentioned above including the system described in the '675 application is useful primarily for decomposing systems and applications during design, and in fact, all these systems have been used mostly in this way. With decomposition, the system designer uses a composition-based system to express the required functionality in terms of subsystems and large-scale (thousands of lines of code) components, from which those systems are to be composed. This approach inevitably leads to defining subsystems and components in a way that makes them quite specific to the particular application. Individual components defined in such custom way then have to be custom implemented, which is typically achieved by either writing manually or generating unique code that expresses the specific functionality of the component being developed.

Because of this absence of a substantial set of reusable component objects from which new functionality can be easily composed, composition-based systems are essentially used in only two capacities: (a) as design automation aids, and (b) as integration tools or environments, with which individual components and subsystems designed for composition but developed in the traditional way can be put together quickly.

In order to practice composition to the full extent implied by the very name of this method and in a way that is similar to the way composition is used in all other technical disciplines, there is a need for a set of well-defined, readily available and easily reusable components, which is sufficiently robust to implement new and unanticipated application functionality, so that most, if not all of this new functionality can be built by composing these pre-existing objects into new, application-specific structures.

The issue of software reusability has been addressed extensively over the last thirty years by a wide variety of approaches, technologies, and products. While the complete set of attempted approaches is virtually impossible to determine, most people skilled in the art to which this invention pertains will recognize the following few forms as the only ones which have survived the trial of practice. These include function libraries, object-oriented application frameworks and template libraries, and finally, reusable components used in conjunction with component object models like Microsoft COM, CORBA and Java Beans.

Function libraries have been extremely successful in providing reusable functionality related to algorithms, computational problems and utility functions, such as string manipulation, image processing, and similar to them. However, attempts to use function libraries to package reusable functionality that has to maintain a significant state between library calls, or that needs to use a substantial number of application-specific services in order to function, typically lead to exploding complexity of the library interface and increased difficulties of use, as well as application-dependent implementations. An excellent example of the inadequacy of the functional library approach to reusable functionality can be found in Microsoft Windows 98 Driver Development Kit, in particular, in libraries related to kernel streaming and USB driver support. These libraries, which provide less than half of the required functionality of both kernel streaming and USB drivers, do so at the expense of defining hundreds of API calls, most of which are required in order to utilize the reusable functionality offered by the library. As a result, attempts to actually use these libraries require very substantial expertise, and produce code that is unnecessarily complex, very difficult to debug, and almost impossible to separate from the library being used.

Application-specific object-oriented frameworks proliferated during the early to mid-nineties in an attempt to provide a solution to the exploding complexity of GUI-based applications in desktop operating systems like Microsoft Windows and Mac OS. These frameworks provide substantial support for functionality that is common among typical windows-based applications, such as menus, dialog boxes, status bars, common user interface controls, etc. They were, in fact, quite successful in lowering the entry barrier to building such applications and migrating a lot of useful functionality from DOS to Windows. Further use, however, showed that application-specific frameworks tend to be very inflexible when it comes to the architecture of the application and make it exceedingly difficult to build both new types of applications and applications that are substantially more complex than what was envisioned by the framework designers. It is not accidental that during the peak time of object-oriented framework acceptance, the major new Windows application that emerged—Visio from Shapeware, Inc., (now Microsoft Visio), was built entirely without the use of such frameworks.

Component object models, such as Microsoft COM and ActiveX, Java Beans and, to a lesser extent, CORBA, were intended to provide a substantially higher degree of reusability. These technologies provide the ability to develop binary components that can be shipped and used successfully without the need to know their internal implementations. Components defined in this way typically implement input interfaces, have some kind of a property mechanism and provide rudimentary mechanisms for binding outgoing interfaces, such as COM connectable objects and the Java event delegation model.

And, indeed, component object models are considerably more successful in providing foundations for software reuse. Today, hundreds of components are available from tens of different companies and can be used by millions of developers fairly easily.

Nevertheless, these component object technologies suffer from a fundamental flaw which limits drastically their usability. The cost at which these technologies provide support for component boundaries, including incoming and outgoing interfaces and properties, is so high (in terms of both run-time overhead and development complexity) that what ends up being packaged or implemented as a component is most often a whole application subsystem consisting of tens of thousands of lines of code.

This kind of components can be reused very successfully in similar applications which need all or most of the functionality that these components provide. Such components are, however, very hard to reuse in new types of applications, new operating environments, or when the functionality that needs to be implemented is not anticipated by the component designer. The main reason for their limited reusability comes from the very fact that component boundaries are expensive and, therefore, developers are forced to use them sparingly. This results in components that combine many different functions, which are related to each other only in the context of a specific class of applications.

As we have seen above, the type of reuse promoted by most non-trivial functional libraries and practically all application frameworks and existing component object models makes it relatively easy to implement variations of existing types of applications but makes it exceedingly difficult and expensive to innovate in both creating new types of applications, moving to new hardware and operating environments, such as high-speed routers and other intelligent Internet equipment, and even to add new types of capabilities to existing applications.

What is needed is a reuse paradigm that focuses on reusability in new and often unanticipated circumstances, allowing software designers to innovate and move to new markets without the tremendous expense of building software from scratch. The system described in the '675 application provides a component object model that implements component boundaries, including incoming and outgoing interfaces and property mechanisms, in a way that can be supported at negligible development cost and runtime overhead. This fact, combined with the ability to compose easily structures of interconnected objects, and build new objects that are assembled entirely from pre-existing ones, creates the necessary foundations for this type of reuse paradigm. Moreover, the '675 system, as well as most components built in conjunction with it, are easily portable to new operating systems, execution environments and hardware architectures.

### SUMMARY OF THE INVENTION

Advantages of the Invention

1. It is therefore a first advantage of the present invention to provide a set of easily reusable components that implement most of the fundamental functionality needed in a wide variety of software applications and systems.

2. It is a second advantage of the present invention to provide a set of reusable components that can be parameterized extensively without modifying their implementation or requiring source code, thus achieving the ability to modify and specialize their behavior to suit many different specific purposes as required.

3. Yet another advantage of the present invention is to provide a set of reusable components that can be combined easily into different composition structures, in new and unanticipated ways, so that even entirely new application requirements and functionality can be met by combining mostly, if not only, pre-existing components.

4. One other advantage of the present invention is to provide a set of reusable components that implements fundamental software mechanisms in a way that makes these mechanisms readily available to system developers, without requiring substantial understanding of their implementation.

5. Yet another advantage of the present invention is that it provides a set of reusable parts such that each of these parts implements one well-defined mechanism or function in a way that allows this function to be combined with other functions in unanticipated ways.

6. Still another advantage of the present invention is that it provides a set of reusable parts defined so that most of these parts can be implemented in a way that is independent from any specific application, so that the parts can be reused easily in new and widely different application areas and domains.

7. One other advantage of the present invention is that it provides a set of reusable parts most of which can be implemented with no dependencies on any particular operating system, execution environment or hardware architecture, so that this set of parts and any systems built using it can be easily ported to new operating systems, environments and hardware.

8. Yet another advantage of the present invention is that it provides a set of reusable parts that encapsulate large number of interactions with hardware and operating system environments, so that components and systems built using these parts have no inherent dependencies on the execution environment and can be moved to new operating systems, environments and hardware with no modification.

9. Yet another advantage of the present invention is that it provides reusable parts that can initiate outgoing interactions in response to events that come from the outside of the designed system, thereby providing a uniform way for interfacing the functionality of the designed system with outside software or hardware.

10. Still another advantage of the present invention is that it provides reusable parts that can be inserted on a given connection between other parts without modifying the semantics of this connection, and generate notifications whenever an interaction happens between those other parts, so that yet other parts can receive that notification and take appropriate actions.

11. Another advantage of the present invention is that it provides reusable parts that convert one interface, logical or physical contract, or a set of incoming events, into another, thereby making it easy to combine components that cannot be connected directly or would not work if connected directly.

12. Yet another advantage of the present invention is that it provides reusable parts that can be used to connect one part to many other parts even when the first part is not designed to interact with more than one other part, and distribute the interactions between the parts so connected, so that various non-trivial structures of parts can be easily composed.

13. Still another advantage of the present invention is that it provides reusable parts that can be connected to those outputs of other parts which have no meaningful use within a specific design, so that outgoing interactions through those outputs do not cause malfunction or disruption of the operation of the system and to provide a specific, pre-defined response to such outgoing operations.

14. Another advantage of the present invention is that it provides reusable parts that accept a flow of events or incoming interactions and produce an outgoing flow based on the history of the incoming interactions and a set of desired characteristics of the output flow, so that an existing flow of events can be transformed into a desirable one.

15. One other advantage of the present invention is that it provides reusable parts that can be inserted on a given connection between other parts without affecting the semantics of that connection, and provide observable indications of the interactions that transpire between those other parts.

16. Yet another advantage of the preset invention is that it provides reusable parts that store incoming events and forward them to their outputs in response to specific other events or in a given thread of execution, thereby providing an easy way to desynchronize and decouple interactions between other parts.

17. Another advantage of the present invention is that it provides reusable parts that convert incoming calls or synchronous requests into pairs of asynchronous interactions consisting of requests and replies, so that components that expect that their outgoing requests will be handled synchronously can be combined easily with components that process incoming requests asynchronously.

18. Sill another advantage of the present invention is that it provides reusable parts that make it possible to disable temporarily the flow of events on a given connection and accumulate incoming events in this state until the flow is enabled again, so that other parts are not forced to accept and handle incoming events in states in which it is not desirable to do so.

19. One other advantage of the present invention is that it provides reusable parts that allow other parts to process incoming flows of events one event at a time by accumulating or otherwise holding interactions or requests that arrive while the first interaction is in progress, so that those other parts are not forced to accept and process incoming interactions concurrently.

20. One other advantage of the present invention is that it provides reusable parts that expose the properties of other components and structures of components in the form of an interface that can be connected to yet another component, so that that other component can access, enumerate and modify those properties.

21. One other advantage of the present invention is that it provides reusable parts that can serve as containers for variable sets of properties and their values, and expose those sets through an interface that can be connected to other components so that those components can inspect and modify those property sets.

22. One other advantage of the present invention is that it provides reusable parts that can obtain variable sets of data values from outside storage and set those values as properties on structures of other components, so that those structures of components can be parameterized to operate in a variety of pre-defined ways or in accordance with previously saved persistent state.

23. One other advantage of the present invention is that it provides reusable parts that can enumerate persistent properties of other components, structures of components, and entire applications, and store the identifiers and values of those properties on external storage, so that the persistent state of those components, structures of components and applications can be preserved for future restoration.

24. One other advantage of the present invention is that it provides reusable parts that convert a connectable interface for accessing properties into a set of events, and vice-versa, so that components that initiate operations on properties do not have to be dependent on the specific definition of this interface.

25. One other advantage of the present invention is that it provides reusable parts that set values of specific properties in response to incoming events so that event flows can be converted to data operations.

26. Still another advantage of the present invention is to provide a container for a dynamic set of software objects that presents that set as a single object.

27. Another advantage of the present invention is to provide the dynamic container in a way that the single object which represents the dynamic set can be easily used in statically composed structures of objects.

28. Still another advantage of the present invention is the provision of the dynamic container in such a way that when the contained objects have certain terminals and properties, the single object has the same terminals and properties.

29. Yet another advantage of the present invention is that the dynamic container further provides the ability to create and destroy instances of objects, access their properties, connect and disconnect them, and so on, in a uniform way defined by the container itself and not requiring knowledge of the specific class of the contained objects.

30. One other advantage of the present invention is that each object instance of the set of objects in the dynamic container can be individually selected and addressed for any purpose by a unique identifier assigned by the container.

31. Another advantage of the present invention is that each object instance of the set of objects in the dynamic container can have a unique identifier associated with it, the identifier being assigned by the software system outside of the container, so that each object instance can be individually selected and addressed for any purpose by the unique identifier.

32. Yet another advantage of the present invention is that the set of software objects in the dynamic container can be enumerated at any time so that software can determine what is the set of objects contained at that time.

33. One other advantage of the present invention is that a single implementation of the dynamic container is sufficient to handle any case where dynamic structures of objects are necessary.

34. Another advantage of the present invention is the properties and terminals of the single object can be manipulated even when the dynamic container contains no objects (the container is empty).

35. Yet another advantage of the present invention is that the dynamic container can be parameterized (configured) with a name of a class of which instances are created, such that the software that initiates the creation of new object instances in the container can perform the initiation without knowledge of the class name.

36. One other advantage of the present invention is that the dynamic container can, upon its own creation or another designated event, automatically create a desirable set of instances, freeing the outside system from the need to control the initial set of object instances.

37. Another advantage of the present invention is that an instance of the dynamic container can contain other instances of the dynamic container.

38. One other advantage of the present invention is that it provides reusable parts that cause other parts to be created on a pre-determined event, so that the newly created parts can handle that event and others related to it.

39. Yet another advantage of the present invention is that it provides reusable parts that control a dynamic container for part instances and initiate the creation, destruction, parameterization and other preparations for normal operation of new part instances in the container, whenever such new instances are needed, so that other parts will be able to use them without the need to control their life cycle, or even be aware that these parts are created dynamically.

40. Another advantage of the present invention is that it provides reusable parts that determine what part instances need to be created and maintained in a dynamic set of instances, so that there will be a proper set of these instances needed for the operation of a system or component.

41. Still another advantage of the present invention is that it provides reusable parts that register part instances under a predetermined identifier, so that these instances can be accessed by a publicly known identifier, or included in other structures of parts by reference.

42. One other advantage of the present invention is that it provides reusable parts that make one or more classes of parts available in executable code memory, relocated as may be required, and ready for instantiation whenever such parts are needed, and remove them when no longer needed, so that these parts don't have to be in that memory when not needed.

43. Yet another advantage of the present invention is that it provides reusable parts that convert a set of events into a factory interface for creating and destroying objects in a dynamic set of objects (possibly, part instances), so that components that initiate such creation and destruction do not have to be dependent on the specific definition of the factory interface.

44. Another advantage of the present invention is that it provides reusable parts that filter a set of operations on a factory interface for creating and destroying objects to either create dynamically new part instances or obtain identifiers to already existing part instances, so that a new instance is created only when its services are first heeded, is made available to any part that requires such services, and can be destroyed when its services are no longer needed.

45. Another advantage of the present invention is that it defines reusable interfaces and events that make it easy to build reusable software parts and construct software systems by composition using such parts.

To address the shortcomings of the background art, the present invention therefore provides:

A computer-implemented method in a computer system for designing a software system in which system at least a first object is created arbitrarily earlier than a second object and the second object is automatically connected to at least the first object, the method comprising the steps of:

creating the first object;

creating a first container object capable of holding at least one other object of arbitrary object class;

defining at least a first template connection between the first object and the first container object;

creating the second object;

connecting the second object to the first object using the first template connection in which template the first container object is replaced with the second object.

This method may alternatively be practiced wherein the step of creating the second object is performed by the first container object; or wherein the step of connecting the second object to the first object is performed by the first container object; or wherein the step of creating the second object is performed by the first container object and the step of connecting the second object to the first object is performed by the first container object; or wherein connections between all objects are established between connection points on the objects; or wherein the first template connection is defined in a data structure. The invention also provides a system created using any one of the above-listed methods.

Additionally, the invention provides a method for describing connections between a plurality of objects in a software system in which at least a first object of the plurality is created arbitrarily later than the remainder of the plurality, the method comprising the steps of:

defining at least a second object of the remainder;

defining a first container object which will be used as a placeholder for defining connections between the first object and the remainder;

defining at least a first connection between the second object and the first object by using the first container object in place of the first object.

Additionally, the invention provides a method for describing connections between a first plurality of objects in a software system and a second plurality of objects in the software system, the second plurality being created arbitrarily later than the first plurality, the method comprising the steps of:

defining at least a first object of the first plurality;

defining a first container object which will be used as a placeholder for defining connections between the first object and each object of the second plurality;

defining at least a first connection to be created between the first object and each object of the second plurality as a connection between the first object and the first container object.

Additionally, the invention provides, in a software system having a plurality of objects, a container object comprising:

a first memory for keeping reference to at least a first object of arbitrary object class;

a section of program code causing the first memory to be modified so that it will contain a first reference to a second object;

a section of program code accessing a data structure and determining that at least a first connection needs to be established between the second object and at least a third object;

a section of program code causing the first connection to be established.

The container object may further comprise a section of program code causing the second object to be created.

Additionally, the invention provides, in a software system having a plurality of objects, a container object comprising:

a memory for keeping at least one reference to a contained object of arbitrary class;

a connection point for receiving requests to modify the set of contained objects;

at least one virtual connection point that accepts at least a first connection to be established to the contained object, the acceptance occurring before the contained object is added to the contained object; and

a section of program code that establishes the first connection when the contained object is added to the container object.

In addition, the invention provides, in a software system having a plurality of objects, a container object comprising:

a first memory for keeping at least one reference to a contained object of arbitrary class;

a connection point for receiving requests to modify the set of contained objects;

at least one virtual property that accepts the value to be set in a first property on the contained object, the virtual property being capable of accepting values of a plurality of data types;

a section of program code that sets the first property on the contained object to the accepted value when the contained object is added to the contained object.

In a software system, the software system having a plurality of objects, a container object comprising:

a first memory for keeping a first plurality of contained objects of arbitrary classes;

a second memory for keeping a second plurality of unique identifiers, each identifier of the second plurality associated with exactly one object of the first plurality;

at least a first property, the first property being a second property of a first object of the first plurality and the first property being identified by a combined identifier produced by combining the associated identifier of the first object and the identifier of the second property.

Moreover, each property immediately above may comprise a terminal, and in either embodiment,-the second memory may be removed and contained objects may be identified by identifiers assigned by the container.

The invention further provides a container object class in a software system, the software system having a first plurality of objects, each object of the first plurality belonging to an object class, the container object class comprising:

means for holding a second plurality of contained objects, the means being applicable to contained objects of any class;

means for changing the set of the contained objects, the means being applicable to contained objects of any class;

means for presenting the plurality of contained objects as a single object, the means being applicable to contained objects of any class.

It should be noted that the single object may comprise an instance of the container object class, and the container object may comprise an instance of the container object class.

The invention further provides, in a software system, the software system having a plurality of objects, each object of the plurality of objects belonging to an object class, the software system having means for building at least one structure of connected objects and means of describing the structure of connected objects, a container object class comprising:

means for holding a plurality of contained objects, the means being applicable to contained objects of any class;

means for changing the set of the contained objects programmatically, the means being applicable to contained objects of any class;

means for presenting the plurality of contained objects as a single object in the structure of connected objects, the means being applicable to contained objects of any class.

Also, the container object may comprise an instance of the container object class.

The invention further provides, in a software system having at least a first object and a second object, the first object having at least one first connection point, the second object having at least one second connection point, the first connection point being used to establish a first connection between the first connection point of the first object and the second connection point of the second object, and the software system having means of requesting the establishment of a connection between connection points, a container object comprising:

means for adding and removing the first object from the container;

means for defining a third connection point on the container object;

means for transforming a requests for establishing of a connection between the second connection point and the third connection point into a request for establishing a connection between the second connection point and the first connection point.

The invention further provides that the system can include means of identifying the first connection point using a first identifier, the container object having the additional means to identify the third connection point using the first identifier. Also, the software system can include means of identifying the first connection point using a first identifier, the container object having the additional means to identify the first object using a second identifier and the container object having the additional means to identify the third connection point using a combination of the first identifier and the second identifier.

The invention further provides a container object in a software system, the software system having at least one first object and the container object, the first object having at least one first property, the software system having means of requesting operations over the first property, the container comprising:

means for adding and removing the first object from the container;

means for defining a second property on the container object;

means for transforming a request for operations over the second property into a request for operations over the first property.

The software system may also include means of identifying the first property using a first identifier, the container object having the additional means to identify the second property using the first identifier; or means of identifying the first property using a first identifier, the container object having the additional means to identify the first object using a second identifier and the container object having the additional means to identify the second property using a combination of the first identifier and the second identifier. The specified means of the container may also be implemented independently of the class of the first object.

The invention further provides a container object in a software system, the software system having a plurality of objects, the software system having means for requesting operations over an object, the container object comprising:

means for holding a plurality of contained objects;

means for changing the set of the contained objects programmatically;

means for identifying each object of the contained objects by a separate, unique identifier for each object;

means of handling requests for operations over any object of the contained objects wherein the identifier is used to determine which object of the contained objects should handle the request.

Alternatively, the container may include additional means of automatically assigning the unique identifier to each object added to the container. Also, the unique identifier may be assigned outside of the container, and the container may have the additional means of associating the unique identifier with each the contained object.

The invention further provides a method for caching and propagating property values to a dynamic set of objects in a software system, the software system having a plurality of objects, each of the objects having a plurality of properties, each the property having a value and an identifier, the method comprising the steps of:

accepting a first request to modify the value of a first property on behalf of the dynamic set of objects as if the dynamic set of objects were one object;

storing the value and identifier of the first property in a first data storage;

retrieving the value and identifier of the first property from the first data storage;

issuing a request to modify the value of the first property on a first object of the dynamic set of objects, using the value and identifier retrieved from the first data storage.

The invention further provides a method for caching and propagating outgoing connections of a dynamic set of objects in a software system, the software system having a plurality of objects, the software system having means for establishing connections between the objects, the connections providing means for a first connected object to make outgoing calls to a second connected object, the method comprising the steps of:

accepting the request to establish a first outgoing connection between the dynamic set of objects and a first object, as if the dynamic set of objects were a single object;

storing a first data value necessary to effect the first connection in a first data storage;

retrieving the first data value from the first data storage;

issuing a request to establish a second connection between a second object of the dynamic set and the first object, using the first data value retrieved from the first data storage.

Additionally, the invention provides a container object within a software system that utilizes either or both of the two methods for caching decribed immediately above.

The invention further provides a container object in a software system, the software system having a plurality of objects, the software system having means for building at least one structure of connected objects, the software system having a first means of describing the structure, the container object being a first object in the structure, the first object having a first connection to at least a second object in the structure, the first connection being described by the first means, the container comprising:

means for holding a plurality of contained objects;

means for changing the set of the contained objects programmatically;

means for connecting each of the contained objects to the second object.

Alternatively, the above-described container object may include the additional means of establishing all connections between the container and other objects in the structure, the all connections being described by the first means, the additional means causing the establishing of each of the all connections between each of the contained objects and the other objects in the structure.

The invention further provides a container object in a software system, the software system having a plurality of objects, the software system having means of building at least one structure of connected objects, the software system having a first means of describing the structure, the software system providing a second means of enumerating all connections described by the first means, the container being a first object in the structure, the container being connected to at least a second object in the structure, the container comprising:

means for holding a plurality of contained objects;

means for changing the set of the contained objects programmatically;

means for finding a first described connection between the container and the second object;

means for establishing the first connection between a third object contained in the container and the second object.

Alternatively, the container may establish connections between a first connection point of the third object and a second connection point of the second object.

The invention further provides a container object in a software system, the software system having a plurality of objects, the container having a first connection to at least one object, the first connection being described in a first data structure, the container comprising:

means for holding a plurality of contained objects;

means for changing the set of the contained objects programmatically;

means for determining a first set of connections to be established for each object added to the set of contained objects based on the set of connections described in the first data structure;

means for establishing the first set of connections.

Alternatively, the container may further comprise means for dissolving the first set of connections, or may further comprise:

means for remembering a second set of outgoing connections from the container to other objects

means for excluding the second set of connections from the first set of connections

means for establishing the second set of outgoing connections for each object added to the set of contained objects.

Alternatively, the container wherein may further comprise:

means for remembering properties set on the container;

means for setting remembered properties on each new object added to the set of contained objects;

means for propagating properties set on the container to all objects in the set of contained objects;

The invention further provides a container object in a software system, the software system containing a plurality of objects, the software system having a first means to establish connections between connection points of objects of the plurality, the first means providing the ability to establish more than one connection to a first connection point of a first object, the container object having a second connection point connected to the first connection point of the first object, the container comprising:

means for holding a plurality of contained objects;

means for changing the set of the contained objects programmatically;

means for establishing a separate connection between a connection point on each object of the plurality of contained objects and the first connection point of the first object.

Alternatively, the container may further comprise means for remembering properties set on the container.

The invention further provides a part for distributing events among a plurality of parts, the part comprising:

a multiple cardinality input,

a multiple cardinality output,

means for recording references to parts that are connected to the output

means for forwarding events received on the input to each of the connected objects to the output.

The invention further provides a part for distributing events and requests between a plurality of other parts, the part comprising:

a first terminal for receiving calls;

a second terminal for sending calls out to a first connected part;

a third terminal for sending calls out to a second connected part;

means for choosing whether to send the received call through the second terminal or through the third terminal.

The invention further provides a part for distributing events and requests between a plurality of other parts, the part comprising:

a first terminal for receiving calls;

a second terminal for sending calls out to a first connected part;

a third terminal for sending calls out to a second connected part;

means for choosing whether to first send the received call through the second terminal and then through the third terminal or to first send the received call through the third terminal and then through the second terminal.

The invention further provides a part for distributing events and requests between a plurality of other parts, the part comprising:

a first terminal for receiving calls;

a second terminal for sending calls out to a first connected part;

a third terminal for sending calls out to a second connected part;

means for sending a first received call as a first call to the second terminal and then, based on value returned from the first call, choose whether or not to send the first received call as a second call to the third terminal.

The invention still further provides a method for desynchronizing events and requests in a software system, the method comprising the steps of:

storing the event in a memory;

receiving a pulse signal;

retrieving the event from the memory and continuing to process the event in the execution context of the pulse signal.

The invention still further provides a part in a software system, the part comprising:

a first terminal for receiving calls;

a second terminal for sending calls out to a first connected part;

a third terminal for receiving a pulse call;

a memory for storing call information received from the first terminal;

a section of program code that is executed when the part receives the pulse calls, the section retrieving the call information from the memory and sending a call out to the second terminal.

Alternatively, in the part described immediately above, the memory can hold call information for a plurality of calls, or the memory can comprise a queue, or the memory can comprise a stack.

The invention still further provides a part in a software system, the part comprising:

a first terminal for receiving calls;

a second terminal for sending calls out to first connected part;

a memory for storing call information received from the first terminal;

a means for obtaining execution context;

a section of program code that is executed in the execution context, the section retrieving the call information from the memory and sending a call out to the second terminal.

Alternatively, in the part described immediately above, the means for obtaining execution context may comprise a thread of execution in a multithreaded system, or the means for obtaining execution context may comprise a timer callback, or the means for obtaining execution context may comprise a subordinate part. Also in the alternative, the means for obtaining execution context may comprise a subordinate part, the subordinate part having a primary function of providing execution context for other parts.

The invention further provides a part in a software system, the part comprising:

a first subordinate part for storing incoming data; and

a second subordinate part for generating execution context.

Alternatively, the part may further comprise a connection between the first subordinate part and the second subordinate part.

The invention further provides a part in a software system, the part comprising:

a first terminal for receiving an incoming request;

a second terminal for sending out an outgoing request;

a third terminal for receiving a request completion indication;

a synchronization object for blocking the thread in which the incoming request was received until the request completion indication is received.

Alternatively, the second terminal and the third terminal may comprise one terminal.

The invention further provides a part in a software system, the part comprising:

an input terminal for receiving calls of a first type;

an output terminal for sending calls of a second type;

means for converting calls of the first type to calls of the second type.

The invention further provides a part in a software system, the part comprising:

an input terminal for receiving calls of a first type and sending calls of the first type;

an output terminal for receiving calls of a second type and sending calls of the second type;

means for converting calls of the first type to calls of the second type;

means for converting calls of the second type to calls of the first type.

Alternatively, any of the parts described herein may be further characterized such that: the first type and the second type differ by physical mechanism, or the first type and the second type differ by logical contract.

The invention further provides a part in a software system, the part comprising:

a first terminal for receiving a first request and sending a second request;

a second terminal for sending the first request;

a third terminal for receiving the second request.

Alternatively, the part described immediately above may be further characterized such that:

the first terminal is a bidirectional terminal;

the second terminal is an output terminal;

the third terminal is an input terminal.

The invention further provides a part in a software system, the part comprising:

a first terminal for receiving calls;

a second terminal for sending out calls received on the first terminal;

a third terminal for sending out calls whenever a call is received on the first terminal.

In the alternative, the part described above may be further characterized such that the part further comprises a first property for defining a criterion for selecting for which calls received on the first terminal the part will send out calls through the third terminal, or such that the part further comprises a second property for configuring what call the part will send out the third terminal, or such that the part further comprises a third property for configuring what call the part will send out the third terminal before sending out a call received on the first terminal to the second terminal, or such that the part further comprises a third property for configuring what call the part will send out the third terminal after sending out a call received on the first terminal to the second terminal, or such that the part further comprises a third property for configuring whether a call out through the third terminal should be made before or after sending out a call received on the first terminal to the second terminal.

The invention further provides a part in a software system, the part comprising:

a first terminal for receiving calls;

a second terminal for sending out calls received on the first terminal;

a third terminal for sending out calls whenever a call sent out the second terminal returns a pre-determined value.

Alternatively, the part described above may be further characterized such that the part further comprises a property for configuring the pre-determined value, or such that the pre-determined value indicates that the second call has failed, or such that the pre-determined value indicates that the second call has succeeded.

The invention further provides a part in a software system, the part comprising:

a first terminal for receiving calls;

a second terminal for sending out calls received on the first terminal;

a first property for configuring a first value;

a third terminal for sending out notification calls whenever a call sent out the second terminal returns a second value that matches the first value.

Alternatively, the part described above may further comprise a second property for configuring whether the part will send out the notification calls if the second value matches the first value or if the second value differs from the first value.

The invention further provides a part in a software system, the part comprising:

a terminal for receiving calls of arbitrary logical contract;

a property for defining a return value.

Alternatively, he part described above may further comprise a property for configuring the logical contract for calls received on the terminal. Also, the part may be further characterized such that the terminal is an input terminal, or such that the terminal is a bidirectional terminal and the part does not make calls out the terminal.

The invention further provides a part in a software system, the part comprising:

a terminal for receiving a first call and a reference to a first memory;

a property for defining a return value;

a section of program code for freeing the first memory.

Alternatively, the part described above may be further characterized such that the part further comprises means for determining whether the section of program code should be executed for the first call, or such that the part further comprises means for determining whether the section of program code should be executed for the first call based on a value contained in the first memory.

The invention further provides a part in a software system, the part comprising:

a first terminal for receiving a first call;

a second terminal for sending out the first call;

means for extracting data from the first call;

means for formatting the extracted data as a first text;

means for sending out the first text.

Alternatively, the part described above may be further characterized such that the means for sending out the first text is a third terminal, or the means for sending out the first text is a section of program code that invokes a function for displaying the first text on a console.

The invention further provides a first structure of connected parts in a software system, the first structure comprising:

a factory part for determining when a new part should be created;

a container part for holding a first plurality of parts of arbitrary part class;

a connection between the factory part and the container part.

In the alternative, the structure described above may be further charcterized such that:

the factory part has a first terminal;

the container part has a second terminal;

the connection is established between the first terminal and the second terminal.

Also, the structure may further comprise a demultiplexing part having a first terminal for receiving calls, a second terminal for sending out calls and means for selecting a part connected to the second terminal, or may further comprise a plurality of connections, each connection established between the second terminal of the demultiplexing part and a terminal of each part in the first plurality. Also, the connection demultiplexing part and the factory part may comprise one part.

In the alternative, the invention further provides a composite part in a software system, the composite part comprising the structure described above. In the alternative, the structure may further comprise an enumerator part for defining the set of parts in the first plurality. The structure may further comprise a connection between the enumerator part and the factory part. Also, the structure may be further characterized such that the enumerator uses a data container for defining the parts in the first plurality. Also, the enumerator may comprise means for enumerating a set of peripheral devices connected to a computer system, or may further comprise a first property for configuring a limitation on the type of peripheral devices to be enumerated.

Alternatively, the structure may comprise a parameterizer part for retrieving the value for at least one property to be set on each part of the first plurality. Also, the parameterizer part may retrieve the value from a data container, or the parameterizer part may use a persistent identifier to select the value among a set of values, or the structure may further comprise a serializer part for saving the value of at least on property of each part in the first plurality, or the structure may further comprise a trigger part for initiating the saving of the value, or the structure may further comprise a parameterizer part for retrieving the value for a first property to be set on each part of the first plurality and for saving the value of the first property. Also, in the alternative, the structure may be further characterized such that the factory part determines whether to create a new part in the first plurality or to use an existing part in the first plurality based a persistent identifier provided to the factory part, or such that the structure further comprises a loader part for bringing in memory a class for a part to be created, or such that the structure further comprises:

a connection between the factory part and the loader part;

a connection between the loader part and the container part.

[structure: factory: genus] A part in a software system, the part comprising:

a first terminal for receiving calls;

a second terminal for sending out calls received on the first terminal;

a third terminal for sending out requests to create new parts;

means for selecting calls received on the first terminal for which the part sends out requests on the third terminal.

The invention further provides a method for designing access to a hardware component in a component-based software system, the method comprising the steps of:

designating a first software component for receiving interrupts from the hardware component;

designating a at least a second software component for accessing input and output ports of the hardware component;

designating a third software component for handling interrupts received by the first software component;

designating a fourth software component for manipulating the hardware component;

connecting the first software component to the third software component;

connecting the second software component to the fourth software component.

In the alternative, the method described above may further comprise the step of connecting the third software component and the fourth software component, or may be further characterized such that the third software component and the fourth software component are one component.

The invention further provides a part in a software system, the part comprising:

a first terminal for sending out calls;

a section of program code for receiving control when an interrupt occurs and sending out a call through the first terminal.

Alternatively, the part described above may further comprise a property for configuring which hardware interrupt vector among a plurality of hardware interrupt vectors the part should receive, or may further comprise a section of program code for registering the part to receive control when the interrupt occurs.

The invention further provides a part in a software system, the part comprising:

a terminal for receiving requests to access at least one port of a hardware component;

a property defining the base address of the port;

a section of code that accesses the port when a request is received on the first terminal.

Alternatively, the part described above may comprise a memory-mapped port, or an input-output port, or the requests may include a read request and a write request.

The invention further provides a structure of connected parts in a software system, the structure comprising:

an interrupt source part for receiving interrupt from a hardware component;

at least one port accessor part for accessing ports of the hardware component;

at least one controller part for controlling the hardware component.

In the alternative, the the structure described above may be further characterized such that the controller part accesses the hardware component exclusively through the interrupt source part and the port accessor part, or such that the structure further comprises:

a connection between the interrupt source part and one of the controller parts;

a connection between one of the port accessor parts and one of the controller parts.

Alternatively, the invention further provides a composite part in a software system, the composite part containing any structure described above

The invention further provides a method for designing software system in which system at least a first object is created arbitrarily earlier than a second object and the second object is automatically connected to at least the first object, the method comprising the steps of:

creating the first object;

creating a first container object capable of holding at least one other object of arbitrary object class;

defining at least a first template connection between the first object and the first container object;

creating the second object;

connecting the second object to the first object using the first template connection in which template the first container object is replaced with the second object

### BRIEF DESCRIPTION OF THE DRAWINGS

The aforementioned features and advantages of the invention as well as additional features and advantages thereof will be more clearly understood hereinafter as a result of a detailed description of a preferred embodiment of the invention when taken in conjunction with the following drawings in which:

FIG. 1 illustrates an event source by thread, DM_EST

FIG. 2 illustrates an event source, thread-based, DM_EVS

FIG. 3 illustrates an event source with DriverMagic pump, DM_ESP

FIG. 4 illustrates an event source by Windows message, DM_ESW

FIG. 5 illustrates a timer event source, DM_EVT

FIG. 6 illustrates a event source on interrupt, DM_IRQ

FIG. 7 illustrates a notifier, DM_NFY

FIG. 8 illustrates an advanced event notifier, DM_NFY2

FIG. 9 illustrates a notifier on status, DM_NFYS

FIG. 10 illustrates the internal structure of the DM_NFYS notifier

FIG. 11 illustrates a bi-directional notifier, DM_NFYB

FIG. 12 illustrates the internal structure of the DM_NFYB notifier

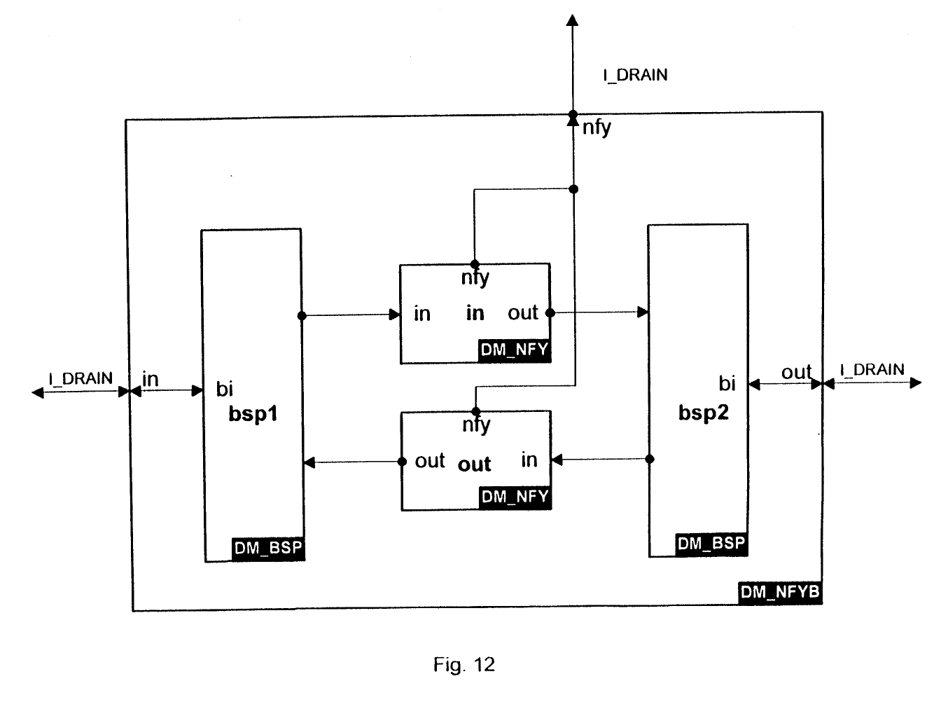

FIG. 13 illustrates a poly-to-drain adapter, DM_P2D

FIG. 14 illustrates a drain-to-poly adapter, DM_D2P

FIG. 15 illustrates a poly-to-drain adapter that provides the operation bus as event bus, DM_NP2D

FIG. 16 illustrates a drain-to-poly adapter that uses the event bus as operation bus, DM_ND2P

FIG. 17 illustrates a bidirectional drain-to-poly adapter, DM_BP2D

FIG. 18 illustrates an interface-to-interface adapter, DM_D2M

FIG. 19 illustrates an event set-to-event set adapter, DM_DIO2IRP

FIG. 20 illustrates a usage of the DM_DIO2IRP adapter

FIG. 21 illustrates another event set-to-event set adapter, DM_A2K

FIG. 22 illustrates a usage of the DM_A2K adapter

FIG. 23 illustrates an interface-to-event set adapter, DM_IES

FIG. 24 illustrates a usage of the DM_IES adapter

FIG. 25 illustrates a stateful adapter, DM_PLT

FIG. 26 illustrates the internal structure of the DM_PLT adapter

FIG. 27 illustrates an event recoder adapter, DM_ERC

FIG. 28 illustrates a status recoder adapter, DM_STX

FIG. 29 illustrates a usage of the DM_STX adapter

FIG. 30 illustrates another usage of the DM_STX adapter

FIG. 31 illustrates an asynchronous completer, DM_ACT

FIG. 32 illustrates a string formatter, DM_SFMT

FIG. 33 illustrates an event bus distributor, DM_EVB

FIG. 34 illustrates a notation used to reprsent the DM_EVB event bus in diagrams

FIG. 35 illustrates a usage of the DM_EVB event bus

FIG. 36 illustrates a distributor for service, DM_DSV

FIG. 37 illustrates cascading of distributors

FIG. 38 illustrates an event replicator distributor, DM_RPL

FIG. 39 illustrates an event sequencer distributor, DM_SEQ

FIG. 40 illustrates an event sequencer distributor with thread, DM_SEQT

FIG. 41 illustrates the internal structure of the DM_SEQT distributor

FIG. 42 illustrates a life-cycle sequencer, DM_LFS

FIG. 43 illustrates an event-controlled multiplexer distributor, DM_MUX

FIG. 44 illustrates a property-controlled switch distributor, DM_SWP

FIG. 45 illustrates a bidirectional property-controlled switch distributor, DM_SWPB

FIG. 46 illustrates a connection demultiplexer distributor, ZP_CDM

FIG. 47 illustrates a bidirectional connection demultiplexer distributor, ZP_CDMB

FIG. 48 illustrates a connection multiplexer-demultiplexer distributor, ZP_CMX

FIG. 49 illustrates a usage of ZP_CMX for connecting multiple clients to a server

FIG. 50 illustrates another usage of ZP_CMX with dynamic structure of parts

FIG. 51 illustrates an event splitter filter distributor, DM_SPL

FIG. 52 illustrates a bidirectional event splitter filter, DM_BFL

FIG. 53 illustrates the internal structure of the DM_BFL filter

FIG. 54 illustrates a filter by integer value distributor, DM_IFLT

FIG. 55 illustrates a bidirectional filter by integer value, DM_IFLTB

FIG. 56 illustrates the internal structure of the DM_IFLTB filter

FIG. 57 illustrates a usage of the DM_IFLT filter

FIG. 58 illustrates a string filter distributor, DM_SFLT

FIG. 59 illustrates a string filter by four, DM_SFLT4

FIG. 60 illustrates a filter for Windows kernel mode input-output request packet (IRP) events, DM_IRPFLT

FIG. 61 illustrates a bi-directional splitter distributor, DM_BSP

FIG. 62 illustrates a usage of the DM_BSP bi-directional slitter, for connecting two parts with unidirectional terminals to another part with a bi-directional terminal

FIG. 63 illustrates a usage of the DM_BSP bi-directional splitter, for connecting a part with two uni-directional terminals to a part with a bi-directional terminal

FIG. 64 illustrates an interface splitter distributor, DM_DIS

FIG. 65 illustrates an idle generator by event distributor, DM_IEV

FIG. 66 illustrates a unidirectional drain stopper terminator, DM_STP

FIG. 67 illustrates a bi-directional drain stopper terminator, DM_BST

FIG. 68 illustrates a unidirectional polymorphic stopper terminator, DM_PST

FIG. 69 illustrates a b-directional polymorphic stopper terminator, DM_PBS

FIG. 70 illustrates the internal structure of the DM_BST terminator

FIG. 71 illustrates the internal structure of the DM_PST terminator

FIG. 72 illustrates the internal structure of the DM_PBS terminator

FIG. 73 illustrates the universal stopper terminator, DM_UST

FIG. 74 illustrates the drain stopper terminator, DM_DST

FIG. 75 illustrates the internal structure of the DM_DST terminator

FIG. 76 illustrates an event consolidator, DM_ECS

FIG. 77 illustrates a bi-directional event consolidator, DM_ECSB

FIG. 78 illustrates an indicator, DM_IND

FIG. 79 illustrates a call tracer indicator, DM_CTR

FIG. 80 illustrates a bus dumper indicator, DM_BSD

FIG. 81 illustrates a fundamental desynchronizer, DM_FDSY

FIG. 82 illustrates an event desynchronizer, DM_DSY

FIG. 83 illustrates a desynchronizer for requests, DM_DSYR

FIG. 84 illustrates the internal structure of the DM_DSYR desynchronizer

FIG. 85 illustrates an event desynchronizer with external control (feed), DM_DWI

FIG. 86 illustrates an event desynchronizer with consolidateable external control, DM_DWI2

FIG. 87 illustrates the internal structure of the DM_DW12 desynchronizer

FIG. 88 illustrates desynchronizers with own thread, DM_DWT and DM_DOT

FIG. 89 illustrates the internal structure of the DM_DWT desynchronizer

FIG. 90 illustrates the internal structure of the DM_DOT desynchronizer

FIG. 91 illustrates a usage of the DM_DWT desynchronizer

FIG. 92 illustrates a usage of two DM_DWT desynchronizers to keep separate the order of events from two event sources

FIG. 93 illustrates a usage of the DM_DOT desynchronizers

FIG. 94 illustrates desynchronizers with external thread (on DriverMagic pump), DM_DWP and DM_DOP

FIG. 95 illustrates the internal structure of the DM_DWP desynchronizer

FIG. 96 illustrates the internal structure of the DM_DOP desynchronizer

FIG. 97 illustrates desynchronizers on Windows messages, DM_DWW and DM_DOW

FIG. 98 illustrates the internal structure of the DM_DWW desynchronizer

FIG. 99 illustrates the internal structure of the DM_DOW desynchronizer

FIG. 100 illustrates a desynchronizer for requests with own thread, DM_RDWT

FIG. 101 illustrates the internal structure of the DM_RDWT desynchronizer

FIG. 102 illustrates a bidirectional resynchronizer, DM_RSB

FIG. 103 illustrates a resynchronizer, DM_RSY

FIG. 104 illustrates the internal structure of the DM_RSY resynchronizer

FIG. 105 illustrates a usage of the DM_RSY resynchronizer

FIG. 106 illustrates a usage of the DM_RSB resynchronizer

FIG. 107 illustrates a cascaded usage of resynchronizers

FIG. 108 illustrates a synchronous event buffer, DM_SEB

FIG. 109 illustrates the internal structure of the DM_SEB buffer

FIG. 110 illustrates an event buffer with postpone capability, DM_SEBP

FIG. 111 illustrates the internal structure of the DM_SEBP buffer

FIG. 112 illustrates a usage of the DM_SEBP buffer

FIG. 113 illustrates an asymmetrical bi-directional event buffer, DM_ASB

FIG. 114 illustrates the internal structure of the DM_ASB buffer

FIG. 115 illustrates an asymmetrical buffer for requests, DM_ASBR2

FIG. 116 illustrates the internal structure of the DM_ASBR2 buffer

FIG. 117 illustrates the internal structure of the DM_ASBR buffer

FIG. 118 illustrates an event serializer, DM_ESL

FIG. 119 illustrates the internal structure of the DM_ESL event serializer

FIG. 120 illustrates a request serializer, DM_RSL

FIG. 121 illustrates the internal structure of the DM_RSL request serializer

FIG. 122 illustrates an IRP event popper, DM_EPP

FIG. 123 illustrates the internal structure of the DM_EPP event popper

FIG. 124 illustrates a property exposer, DM_PEX

FIG. 125 illustrates a virtual property container, DM_VPC

FIG. 126 illustrates a hierarchical repository, DM_REP

FIG. 127 Illustrates the binary structure of the DM_REP serialized image

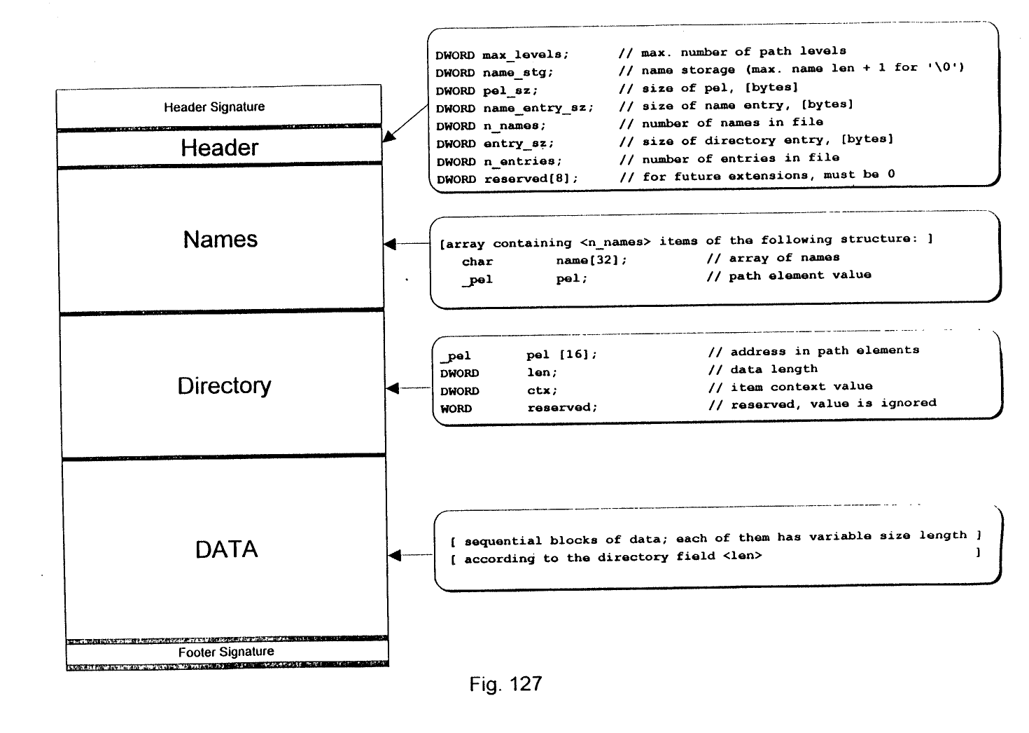

FIG. 128 illustrates a parameterizer from registry, DM_PRM

FIG. 129 illustrates a serializer to registry, DM_SER

FIG. 130 illustrates the internal structure of the DM_SER serializer

FIG. 131 illustrates an activation/deactivation adaptor, DM_SERADP

FIG. 132 illustrates an event to property interface converter, DM_E2P

FIG. 133 illustrates a property to event adapter, DM_P2E

FIG. 134 illustrates a property setter adapter, DM_PSET

FIG. 135 illustrates an eight property setters adapter, DM_PSET 8

FIG. 136 illustrates a graphical representation of a dynamic container for parts

FIG. 137 illustrates types of connections between contained objects and objects outside of the container that the preferred embodiment can support

FIG. 138 illustrates types of connections between contained objects and objects outside of the container that the preferred embodiment does not support

FIG. 139 illustrates an example of a device driver architecture designed using a part array. The array is used to contain a dynamic set of part instances, one per each individual device that is serviced by the driver

FIG. 140 illustrates a Windows WDM Plug-and-Play device driver factory, DM_FAC

FIG. 141 illustrates a Windows NT device driver factory, DM_FAC

FIG. 142 illustrates a VxD device driver factory, DM_VX FAC

FIG. 143 illustrates a device enumerator on registry, DM_REN

FIG. 144 illustrates a PCI device enumerator, DM_PEN

FIG. 145 illustrates a PCMCIA device enumerator, DM_PCEN

FIG. 146 illustrates a singleton registrar, DM_SGR

FIG. 147 illustrates a device stacker, DM_DSTK

FIG. 148 illustrates a create/bind factory interface adapter, DM_CBFAC

FIG. 149 illustrates a usage of the DM_CBFAC factory interface adapter

FIG. 150 illustrates an event to factory adapter, ZP_E2FAC

### DETAILED DESCRIPTION OF THE INVENTION

The following definitions and references will assist the reader in comprehending the enclosed description of a preferred embodiment of the present invention.

The preferred embodiment is a software component object (part) that implements a dynamic container for other parts (hereinafter the Part Array or Array). The part is preferably used in conjunction with the method and system described in the '675 application.

The terms ClassMagic and DriverMagic, used throughout this document, refer to commercially available products incorporating the inventive System for Constructing Software Components and Systems as Assemblies of Independent Parts in general, and to certain implementations of that System. Moreover, an implementation of the System is described in the following product manuals:

“Reference—C Language Binding—ClassMagic™ Object Composition Engine”, Object Dynamics Corporation, August 1998, which is incorporated herein in its entirety by reference;

“User Manual—User Manual, Tutorial and Part Library Reference—DriverMagic Rapid Driver Development Kit”, Object Dynamics Corporation, August 1998, which is incorporated herein in its entirety by reference;

“Advanced Part Library—Reference Manual”, version 1.32, Object Dynamics Corporation, July 1999, which is incorporated herein in its entirety by reference;

“WDM_Driver Part Library—Reference Manual”, version 1.12, Object Dynamics Corporation, July 1999, which is incorporated herein in its entirety by reference;

“Windows NT Driver Part Library—Reference Manual”, version 1.05, Object Dynamics Corporation, April 1999, which is incorporated herein in its entirety by reference.

Appendix 1 describes preferred interfaces used by the parts described herein.

Appendix 2 describes the preferred events used by the parts described herein.

1. Events

One inventive aspect of the present invention is the ability to represent many of the interactions between different parts in a software system in a common, preferably polymorphic, way called event objects, or events.

Events provide a simple method for associating a data structure or a block of data, such as a received buffer or a network frame, with an object that identifies this structure, its contents, or an operation requested on it. Event objects can also identify the required distribution discipline for handling the event, ownership of the event object itself and the data structure associated with it, and other attributes that may simplify the processing of the event or its delivery to various parts of the system. Of particular significance is the fact that event objects defined as described above can be used to express notifications and requests that can be distributed and processed in an asynchronous fashion.

The word “event” is used herein most often in reference to either an event object or the act of passing of such object into or out of a part instance. Such passing preferably is done by invoking the “raise” operation defined by the I_DRAIN interface, with an event object as the operation data bus. The I_DRAIN interface is a standard interface as interfaces are described in the '675 application. It has only one operation, “raise”, and is intended for use with event objects. A large portion of the parts described in this application are designed to operate on events.

Also in this sense, “sending an event” refers to a part invoking its output I_DRAIN terminal and “receiving an event” refers to a part's I_DRAIN input terminal being invoked.

1.1. Event Objects

An event object is a memory object used to carry context data for requests and for notifications. An event object may also be created and destroyed in the context of a hardware interrupt and is the designated carrier for transferring data from interrupt sources into the normal flow of execution in systems based on the '675 system.

An event object preferably consists of a data buffer (referred to as the event context data or event data) and the following “event fields”:

event ID—an integer value that identifies the notification or the request.

size—the size (in bytes) of the event data buffer.

attributes—an integer bit-mask value that defines event attributes. Half of the bits in this field are standard attributes, which define whether the event is intended as a notification or as an asynchronous request and other characteristics related to the use of the event's memory buffer. The other half is reserved as event-specific and is defined differently for each different event (or group of events).

status—this field is used with asynchronous requests and indicates the completion status of the request (see the Asynchronous Requests section below).

The data buffer pointer identifies the event object. Note that the “event fields” do not necessarily reside in the event data buffer, but are accessible by any part that has a pointer to the event data buffer.

The event objects are used as the operation data of the I_DRAIN interface's single operation—raise. This interface is intended for use with events and there are many parts described in this application that operate on events.

The following two sections describe the use of events for notifications and for asynchronous requests.

1.2. Notifications

Notifications are “signals” that are generated by parts as an indication of a state change or the occurrence of an external event. The “recipient” of a notification is not expected to perform any specific action and is always expected to return an OK status, except if for some reason it refuses to assume responsibility for the ownership of the event object.

The events objects used to carry notifications are referred to as “self-owned” events because the ownership of the event object travels with it, that is, a part that receives a notification either frees it when it is no longer needed or forwards it to one of its outputs.

1.3. Asynchronous Requests

Using event objects as asynchronous requests provides a uniform way for implementing an essential mechanism of communication between parts:

the normal interface operations through which parts interact are in essence function calls and are synchronous, that is, control is not returned to the part that requests the operation until it is completed and the completion status is conveyed to it as a return status from the call.

the asynchronous requests (as the name implies) are asynchronous; control is returned immediately to the part that issues the request, regardless of whether the request is actually completed or not. The requester is notified of the completion by a “callback”, which takes a form of invoking an incoming operation on one of its terminals, typically, but not necessarily, the same terminal through which the original request was issued. The “callback” operation is preferably invoked with a pointer to the original event object that contained the request itself. The “status” field of the event object conveys the completion status.

Many parts are designed to work with asynchronous requests. Note, however that most events originated by parts are not asynchronous requests—they are notifications or synchronous requests. The “event recoder” (DM_ERC herein), in combination with other parts may be used to transform notifications into asynchronous requests.

The following special usage rules preferably apply to events that are used as asynchronous requests:

1. Requests are used on a symmetrical bi-directional I_DRAIN connection.

2. Requests may be completed either synchronously or asynchronously.

3. The originator of a request (the request ‘owner’) creates and owns the event object. No one except the ‘owner’ may destroy it or make any assumptions about its origin.

4. A special data field may be reserved in the request data buffer, referred to as “owner context”—this field is private to the owner of the request and may not be overwritten by recipients of the request.

5. A part that receives a request (through an I_DRAIN.raise operation) may:

a) Complete the request by returning any status except ST_PENDING (synchronous completion);

b) Retain a pointer to the event object and return ST_PENDING. This may be done only if the “attr” field of the request has the CMEVT_A_ASYNC_CPLT bit set. In this case, using the retained pointer to execute I_DRAIN.raise on the back channel of the terminal through which the original request was received completes the request. The part should store the completion status in the “status” event field and set the CMEVT_A_COMPLETED bit in the “attributes” field before completing the request in this manner.

6. A part that receives a request may re-use the request's data buffer to issue one or more requests through one of its I_DRAIN terminals, as long as this does not violate the rules specified above (i.e., the event object is not destroyed or the owner context overwritten and the request is eventually completed as specified above).

Since in most cases parts intended to process asynchronous requests may expect to receive any number of them and have to execute them on a first-come-first-served basis, such parts are typically assembled using desynchronizers which preferably provide a queue for the pending requests and take care of setting the “status” field in the completed requests.

1.4. The Notion of Event as Invocation of an Interface Operation

It is important to note that in many important cases, the act of invoking a given operation on an object interface, such as a v-table interface, can be considered an event to the large degree similar to events described above. This is especially true in the case of interfaces which are defined as bus-based interfaces; in such interfaces, data arguments provided to the operation, as well as, data returned by it, is exchanged by means of a data structure called bus. Typically, all operations of the same bus-based interface are defined to accept one and the same bus structure.

Combining an identifier of the operation being requested with the bus data structure is logically equivalent to defining an event object of the type described above. And, indeed, some of the inventive reusable parts described in this application use this mechanism to convert an arbitrary interface into a set of events or vice-versa.

The importance of this similarity between events and operations in bus-based interfaces becomes apparent when one considers that it allows the application of many of the parts, design patterns and mechanisms for handling, distributing, desynchronizing and otherwise processing flows of events, to any bus-based interface. In this manner, an outgoing interaction on a part that requires a specific bus-based interface can be distributed to multiple parts, desynchronized and processed in a different thread of execution, or even converted to an event object. In all such cases, the outgoing operation can be passed through an arbitrarily complex structure of parts that shape and direct the flow of events and delivered to one or more parts that actually implement the required operation of that interface, all through the use of reusable software parts.

2. Event Flow Parts

Another inventive aspect of the present invention is the ability to use reusable parts to facilitate, control and direct flows of events in a particular application or system. The existence of such parts, herein called “event flow parts”, provides numerous benefits. For example, it makes it possible to design and implement a wide variety of application-specific event flow structures simply by combining instances of reusable parts. In another example, one can implement advanced event flow characteristics, such as distribution disciplines, one-to-many and many-to-one relationships, intelligent event distribution based on state, data contained in the event, or status returned by a specific part, and many others, again, by interconnecting instances of reusable parts.

This section describes a number of inventive reusable event flow parts, which preferably form a basis for building most event flow structures in software systems and applications built using object composition.

2.1. Event Sources

Event sources are parts that generate outgoing events spontaneously, as opposed to in response to receiving another event on an input. Usually, event sources generate output events in response to things that happen outside of the scope of the structure of parts in which they are connected.

Event sources preferably have a bidirectional terminal, through which they generate, or “fire”, outgoing events and receive control events, preferably “enable” and “disable”. In addition, event sources preferably define properties through which their operation can be parameterized.

When assembled in a structure with other parts, an event source preferably remains inactive until it receives the first “enable” event from one of these parts. After becoming enabled, the event source may (but not necessarily would) generate one or more outgoing events, which are used by other parts to perform their operations. At some point in time or another, a part other than the source may generate a “disable” event. On receiving this event, the event source becomes disabled and does not generate outgoing events until enabled again. While practical in many cases, the ability to enable and disable the event source from outside is not required for the advantageous operation of this type of reusable parts.

Event sources vary primarily in the specific mechanism or cause which triggers the generation of outgoing events. For example, an interrupt event source, such as the DM_IRQ part described herein, receives hardware interrupts from a peripheral device and generates events for each received interrupt. In another example, a timer event source, such as the DM_EVT part described herein, creates an operating system timer object, and generates outgoing events when that timer expires or fires periodically.

Another type of the inventive event source is a part that controls an operating system or hardware-defined thread of execution and generates outgoing events in the execution context (e.g., stack, priority, security context, etc.), of that thread, so that other parts and structures of parts can operate within that context. An example of such thread event source is the DM_EST part described herein.

As one skilled in the art to which the present invention pertains can easily see, many other types of the inventive event source parts can be defined and may be desirable in different classes of applications or different operating environments. For example, the DM_ESW event source described herein is an event source that is somewhat similar to a thread event source but generates outgoing events in the execution context associated with a specific operating system window object, as this term is defined by the Microsoft Windows family of operating systems. Another example, the DM_EVS event source described herein provides outgoing events in a context of a specific thread which it owns and then only upon completion of an “overlapped” operating system call or upon the signaling of a synchronization object, as those terms are defined in the Microsoft Windows family of operating systems.

In many cases, it may be beneficial to define different event sources, such as timer and thread, so that they have similar boundaries and interfaces, and may be interchanged in the design as required. However, this is a convenience and not necessarily a requirement.

Reusable event source parts have many advantages, among them the ability to insulate the rest of the application from an important class of operating system or hardware-dependent interactions, in which the outside environment invokes the application being designed. Another advantage of using these parts is to separate the creation and management of execution contexts, such as threads, as well as the definition of their characteristics, from the parts and structures of parts that operate in these contexts.

2.2. Notifiers

Notifiers are parts that can be inserted on a connection between two other parts without affecting the semantics of the interactions between those parts. Notifiers monitor those interactions and generate an outgoing event whenever an interaction that satisfies a specific condition occurs.

Notifiers preferably have three terminals: “in”, “out” and “nfy”. The “in” and “out” terminals are used to connect the notifier to the parts whose interaction is to be monitored. The notifier generates outgoing events through the “nfy” terminal.

Notifiers preferably define properties through which the notification conditions can be specified or modified, as well as properties that define the characteristics of the outgoing notification event.

When assembled in a structure of parts, a notifier accepts calls through its “in” terminal, forwards them without modifications to the “out” terminal, and checks if the specified condition is satisfied by that interaction. If the condition is true, the notifier creates an event object as parameterized and sends it out through its “nfy” terminal. Conditions monitored by notifiers preferably include the passing of an event object with specific characteristics, such as identifier, attributes, etc., return of a specific status code from the “out” terminal, or the value of a specific field in the data bus satisfying a specific expression. In addition, notifiers may generate the outgoing notification before, after or both before and after forwarding the incoming event or interaction to the “out” terminal.

An example of a notifier which monitors for a specific event identifier is the inventive DM_NFY part described herein. Another example of a notifier which monitors the return status of the interaction is the inventive DM_NFYS part described herein.

Another type of notifier is the idle generator. Unlike other types of notifiers, idle generators produce series of outgoing events, preferably until one of these events returns a pre-defined completion status. An example of this type is the inventive DM_IEV part described herein.

As will be understood by those skilled in the art to which the present invention pertains, many other types of the inventive notifier parts can be defined and may be desirable in different classes of applications or in different operating environments.

Reusable notifier parts have many advantages, among them the ability to cause the execution of one or more auxiliary functions when a certain interaction takes place, without either of the parts participating in that interaction being responsible for causing the execution, or even having to be aware that the execution takes place. In this manner, the inventive notifier parts described herein provide a universal mechanism for extending the functionality of a given structure of parts in a backward-compatible way, as well as for synchronizing the state of two or more parts or structures of parts in a way that does not introduce undue coupling between them.

2.3. Adapters

Adapters are parts the primary function of which is to convert one interface, set of events or logical contract, into another. Adapters make it possible to combine the functionality of two parts that are not designed to work directly together.

Adapters preferably have two terminals, “in” and “out”. The “in” terminal is used to receive incoming operations or events that belong to one of the interfaces; in response to these operations or events, the adapter issues outgoing operations or events, that comply with the second interface through its “out” terminal.

Adapters preferably define properties through which their operation can be modified as needed by the specific interface translation that a given adapter implements.

Since the primary purpose of an adapter is to convert one interface into another, the number of possible and potentially useful adapter parts is virtually unlimited. One advantageous type of inventive adapters is an adapter that converts operations of any bus-based v-table interface into events. Examples of such adapters are the inventive parts DM_P2D and DM_NP2D described herein, as well as the DM_D2P, DM_ND2P and DM_BD2P, which provide the opposite and combined conversions. Another type of inventive adapters converts one set of events complying to a given protocol into another set, protocol or interface. Examples include the inventive parts DM_A2K, DM_DIO2IRP, and DM_IES described herein. Yet another advantageous type of inventive adapters include adapters that modify selected characteristics of events that pass through them; an example of this type of adapter is the inventive part DM_ERC described herein. One other advantageous type of inventive adapter is an adapter that modifies the return status of an operation, such as the inventive part DM_STX described herein.

Still another type of inventive adapter is the asynchronous completers. An asynchronous completer guarantees that certain requests received on its “in” terminal will always complete asynchronously, even when the part connected to its “out” terminal completes those requests in a synchronous manner. An example of an asynchronous completer is the inventive part DM_ACT described herein.

Yet another type of inventive adapter is the string formatters that can modify a text string, such as a name or URL path, or any other data value, in a passing event or data bus, according to parameterization that defines a specific transformation expression. An example of this type of adapter is the inventive part DM_SFMT described herein.

Another, particularly important type of inventive adapter is the stateful adapters that maintain substantial state in between interactions and preferably implement state machines that provide complex conversions between widely differing protocols and interfaces. An example of this type of adapter is the inventive part DM_PLT described herein.

2.4. Distributors

Distributors are parts the main purpose of which is to forward, or distribute, interactions initiated by one part to zero or more other parts. Distributors make it easy to implement structures of parts which require interactions that cannot be represented directly by simple one-to-one connections between terminals; such interactions include one-to-many, many-to-one and many-to-many relationships.

Most types of distributors preferably have three terminals: “in”, “out1” and “out2”. They receive incoming interactions on their “in” terminal and forward them to “out1,” out2” or both “out1” and “out2”, according to a specific distribution discipline. This group includes the following types of distributors: (a) distributors for service, (b) event replicators, (c) sequencers, (d) filters, (e) bidirectional splitters, and (f) interface splitters.

Some other types of distributors preferably have an additional control terminal or property used to modify the distribution discipline they apply. This group includes the following types of distributors: (a) multiplexers controlled by event and (b) switches controlled by property value.

Yet other types of distributors preferably have two terminals: an “in” terminal through which they receive interactions, and a multiple cardinality “out” terminal. These types of distributors preferably distribute interactions received on their “in” terminal among different connections established on their “out” terminal. This group includes connection multiplexers and connection demultiplexers.

Other types of distributors preferably have one multiple cardinality, bi-directional terminal, to which other parts are connected. These types of distributors, called buses, accept incoming interactions on any of the connections to that terminal, and distribute them among the same set of connections.

As will be understood by those skilled in the art to which the present invention pertains, many other types of the inventive distributor parts can be defined and may be desirable in different classes of applications or in different operating environments.

The section below describes the preferred distribution disciplines for a variety of distributor types.

Buses are distributors that implement many-to-many connections. They accept events from any of the parts connected to them, and forward them to all other parts, preferably excluding the one that originated that event. An example of a bus distributor is the inventive part DM_EVB described herein.

Distributors for service attempt to submit the incoming interaction to both outputs, in sequence, until a certain condition, preferably related to the status returned from one or both of those outputs, is met. When assembled in structures of parts, distributors for service can be used for a variety of purposes, including, for example: (a) to sequence one and the same operation between multiple parts, (b) to submit the operation to several parts until one of them agrees to execute it, and (c) to submit an operation to one part and then, based on the status returned by it, to conditionally submit the same operation to another part. An example of a distributor for service is the inventive part DM_DSV described herein.

Event replicators are distributors that make a copy of an incoming event or operation bus and submit this copy to its “out2” output either before or after forwarding the original event or operation to “out1”. An example of an event replicator is the inventive part DM_RPL described herein.

Sequencers are a type of distributor that sequence an incoming operation between their outputs until a certain return status is received, and preferably have the ability to sequence a different operation in reverse order. One advantageous use of sequencers is to enable a structure of parts, with the ability to disable back any already enabled part in case one of the parts fails the enable request. This guarantees that the state of all these parts will be coherent: either enabled or disabled. Examples of sequencers are the inventive parts DM_SEQ, DM_SEQT and DM_LFS described herein.

Multiplexers, also known as switches, are a type of distributor that maintain state and forward incoming interactions to one of their outputs depending on that state. This controlling state can be changed preferably by an event received on a control terminal of the multiplexer, or by setting a specific value in a property of the multiplexer. Examples of multiplexers are the inventive parts DM_MUX, ZP_SWP and ZP_SWPB described herein.

Connection multiplexers and demultiplexers are a type of distributor that forward incoming interactions to one of the many possible connections on their “out” terminal and vice-versa. Connection demultiplexers may preferably implement a variety of distribution disciplines, including, for example, (a) by data value in the incoming bus which identifies the outgoing connection and (b) by state controlled in a manner similar to regular multiplexers described above. Connection multiplexers may preferably store an identification of the connection from which the incoming interaction arrives into a specified data field in the bus before forwarding the interaction to the output. Examples of connection multiplexers and demultiplexers are the inventive parts DM_CDM, DM_CDMB and ZP_CMX described herein.

Filters are a type of distributors that forward incoming interactions to “out1” or “out2” based on a data value contained in the bus or on characteristics of the event object or the incoming operation. The conditions and/or expression that a filter evaluates to decide which output to use are preferably specified through properties defined by the filter. Examples of filters are the inventive parts DM_SPL, DM_BFL, DM_IFLT, DM_IFLTB, DM_SFLT, DM_SFLT4 and DM_IRPFLT described herein.

Bi-directional splitters are a type of distributor that preferably have three terminals: an input “in”, an output “out” and a bidirectional terminal “bi”. These distributors forward operations received on their “in” terminal to their “bi” terminal, and forward operations received on their “bi” terminal to their “out” terminal. In this manner, bidirectional splitters distribute the flow of interactions through a single, “bi”, terminal into two separate unidirectional flows that can be forwarded to two separate parts. An example of a bidirectional splitter is the inventive part DM_BSP described herein.

Interface splitters are a type of distributor that forward different operations of one and the same input interface to different outputs. In this manner, interface splitters allow a set of operations defined by a single interface to be implemented by a plurality of parts. An example of an interface splitter is the inventive part DM_DIS described herein.

2.5. Terminators

Terminators are parts that can be connected to those outputs of other parts which have no meaningful use within a specific design, so that outgoing interactions through those outputs do not cause malfunction or disruption of the operation of the system and preferably provide a specific, pre-defined response to such outgoing operations.

Terminators preferably have one terminal, “in”, implemented either as an input terminal or as a bidirectional terminal. In addition, terminators preferably define a property through which the desired return status can be parameterized.

Upon receiving an incoming event, a terminator preferably examines the event attributes, determines if the event object is to be destroyed and the associated data structure is to be freed, and returns the specified return status.

Examples of terminators include the inventive parts DM_STP, DM_BST, DM_PST, DM_PBS, DM_UST and DM_DST described herein.

2.6. Event Consolidators

Event consolidators are parts that provide “reference counting” behavior on a pair of complementary events, for example, “open” and “close”.

An event consolidator allows the first “open” event to pass through, and consumes and counts any additional “open” events it receives. In addition, it counts and consumes any “close” events until their number reaches the number of “open” events. The last “close” event is passed through.

Examples of event consolidators include the inventive parts DM_ECS and DM_ECSB described herein.

2.7. Indicators

Indicators are parts that can be inserted on a given connection between other parts without affecting the semantics of that connection, and provide observable indications of the interactions that transpire between those other parts, preferably in the form of human-readable output or debug notifications. The format of the output is preferably specified in properties defined by the indicator.

Examples of indicators include the inventive parts DM_IND, DM_CTR and DM_BSD described herein.

3. Synchronization Parts

3.1. Desynchronizers

Desynchronizers are parts that decouple the flow of control from the data flow. A simple desynchronizer preferably has input and output terminals that work on the same logical contract, and a queue.

Whenever it receives an input operation, the desynchronizer preferably collects the data arguments into a descriptor, or control block, enqueues the descriptor and returns immediately to the caller. On a separate driving event, such as a timer, a thread or a system idle event, the desynchronizer reads a descriptor from the head of the queue and invokes the respective operation on its output.

We define two categories of simple desynchronizers, with and without external drive, based on how (and when) they receive the driving events. Desynchronizers with external drive define a separate terminal through which another part, preferably an event source, may feed the events. The others arrange to receive the events internally, using operating-system services such as timer callbacks or messages, or even hardware interrupts.

Desynchronizers can be inserted in most connections where the data flow is unidirectional. The other parties in the connection do not have to support explicitly asynchronous connections—they remain unaware of the fact that the connections have been made asynchronous.

Examples of desynchronizers include the inventive parts DM_FDSY, DM_DSY, DM_DSYR, DM_DWI, DM_DW12, DM_DWT, DM_DOT, DM_DWP, DM_DOP, DM_DWW, DM_DOW, and DM_RDWT described herein.

3.2. Resynchronizers

Resynchronizers are parts that split a contract with bi-directional data flow into two—requests and replies. They are preferably used to keep their clients blocked on an operation while allowing the ultimate server connected to their output to perform operations in an event-driven manner for many clients. The resynchronizer is responsible for blocking the incoming calls, for example using operating system provided facilities in multi-threaded environments, until a reply for each respective call arrives.

Typical uses for resynchronizers include, for example, cases when the client part is a wrapper for a legacy component that implements lengthy operations, which involve issuing many outgoing calls. Using the resynchronizer, one can prevent such a part from blocking the system or the server without having to make changes in either of them.

Examples of resynchronizers include the inventive parts DM_RSY and DM_RSYB described herein.

3.3. Event Buffers

Event buffers are parts that forward incoming events and interactions and also have memory to store one or more events or other incoming interactions whenever they cannot be forwarded immediately. These parts make it possible to disable the flow of interaction between other parts temporarily without losing events that occur while the flow is disabled. Once the flow is re-enabled, the stored events and preferably any new incoming events are forwarded as usual.

Event buffers preferably have three terminals: an input “in”, an output “out” and a control input “ctl”. Incoming events arrive on the “in” terminal. If the buffer is enabled, it simply forwards the incoming event to the “out” terminal. If the buffer is disabled, is stores the incoming event. The buffer is preferably enabled and disabled through the “ctl” terminal. Any events that are stored while the buffer is disabled are preferably forwarded to the “out” terminal whenever the buffer is re-enabled, or on another appropriate event.

One type of event buffers has a queue or other means for storing incoming events when the event buffer is disabled and then forwarding them out in the same order in which they arrived. Examples of this type of event buffers are the inventive parts DM_SEB, DM_ASB, DM_ASBR and DM_ASBR2 described herein.

Another type of event buffers also has the ability to temporarily store, or “postpone”, particular events that are rejected by parts connected to their “out” terminal while the buffer is enabled, and attempt to forward them again at a later time. These buffers preferably forward any incoming events through their “out” terminal, and preferably interpret certain return statuses as an indication that the recipient is rejecting the event at that time. The buffers preferably store rejected events until they receive a “flush” event on their “ctl” terminal and attempt to resubmit them at that time. An example of this type of event buffers is the inventive part DM_SEBP described herein.

Event buffers preferably have properties for configuring the maximum number of stored events, the criteria for enabling and disabling the flow, and other purposes.

One skilled in the art to which the present invention pertains can easily see many other types of advantageous event buffers, including, but not limited to, buffers without a control input or different control mechanism, buffers with different storage mechanisms, buffers with different conditions for buffering incoming events, and so on.

Event buffers make it possible to disable temporarily the flow of events on a given connection and accumulate certain or all incoming events, so that other parts or structures of parts are not forced to process these events when it is not desirable to do so.

3.4. Event Serializers

Event serializers are parts that forward incoming interactions one by one and have means to hold further incoming interactions until any pending interaction completes.

Event serializers preferably have an input terminal “in” for receiving incoming events or interactions, an output terminal “out” for forwarding previously received events, and a state for tracking whether an interaction that has been forwarded to “out” has not yet completed. If no interaction is pending, the serializer forwards an incoming interaction directly; while an interaction is pending, the serializer holds all other incoming events or interactions, for example, by storing them in memory or by blocking the calling thread, until the pending interaction completes.

Examples of event serializers include the inventive parts DM_ESL, DM_RSL and DM_EPP described herein. One skilled in the art to which the present invention pertains can easily see many other types of event serializers, for example, ones that use different mechanisms for storing held interactions, and ones that use critical sections or other synchronization objects to hold the calling thread.

Since event serializers pass incoming interactions one at a time, parts connected to their output do not have to accept or handle multiple interactions concurrently.

4. Property Space Support Parts

Another inventive aspect of the present invention is a set of reusable parts that inspect, store and manipulate properties of other parts and structures of parts through interfaces. These parts make it possible to construct functionality needed to access properties by interconnecting existing parts rather than writing code. It also makes it possible to set up the properties of a given part, component or even whole application to pre-configured values read from storage, as well as to preserve and restore the persistent state of that part, component or application.

4.1. Property Exposers

Property exposers are parts that provide access to properties of other parts through a terminal. They make it possible to construct functionality that manipulates those properties by interconnecting parts.

Property exposers preferably have an input terminal “prop”, that exposes an interface or a set of events for requesting property operations, such as get, set, check, enumerate, etc.

A property exposer preferably implements the functionality required by the interface exposed through the “prop” terminal using means defined by the underlying component or object model, such as the '675 system.

One type of property exposer provides access to the property space of an assembly in which the instance of the property exposer is created. An example of this type of property exposer is the inventive part DM_PEX described herein.

Other advantageous property exposers will be apparent to those skilled in the art to which the present invention pertains. By way of example, a property exposer may be configured with information sufficient to identify a specific part instance, the properties of which it is to expose.

4.2. Property Containers

Property containers are parts that have storage for one or more properties and their respective values and make these properties available for access through an interface. They allow other parts to store and examine various sets of properties.

Property containers preferably support arbitrary sets of properties and preferably include means for configuring those sets of properties. These means include, without limitation, properties on the property container itself, interfaces for defining the set of properties, data descriptors, etc.

One type of property container allows definition of the set of stored properties through a terminal. This type of property container preferably has two terminals: a property factory “fac” for creating and destroying properties in the container, and a property access terminal “prp” for accessing property values and enumerating the current set of properties in the container. An example of this type of property container is the inventive part DM_VPC described herein.

One skilled in the art to which the present invention pertains will recognize that other advantageous types of property containers are possible and easy to define. For example, a property container may provide access to the contained set of properties through any mechanism used to access properties of parts. Note that the inventive part DM_ARR described herein can also be used in this capacity.

4.3. Parameterizers

Parameterizers are parts that have means for obtaining a set of property identifiers and values from storage and requesting property set operations requests using those identifiers and values on their output terminal. When combined preferably with a property exposer or other similar part, parameterizers can be used to configure a part or a structure of parts to operate in some desired way or to restore a previously saved persistent state.

One type of parameterizer has an input terminal “in” for receiving, and an output terminal “out”, for forwarding requests for property operations, as well as means for obtaining a set of property identifiers and values from outside storage, such as registry, file or other media.

This type of parameterizer can process a property set request received on its “in” terminal with a specific property identifier by treating the value received with that request as a key that can be used to identify a location in the outside storage, e.g., file name, memory location, registry key, etc. Upon receiving such trigger request, the parameterizer accesses that location to obtain one or more property identifiers and their corresponding values from the storage, and emits property set operations on its “out” terminal, with those identifiers and values. An example of this type of parameterizer is the inventive part DM_PRM described herein.

4.4. Serializers

Serializers are parts that obtain a set of properties that are designated as persistent and save them and their values into a storage. Serializers, in conjunction with property exposers, make it possible to save an arbitrarily defined set of properties into external storage, so that these properties can be restored later, preferably through the use of a parameterizer. The set of properties to be stored is defined by the part or structure of parts whose properties are being serialized.

One type of serializer has an input terminal on which it accepts a request to commence serialization, and an output terminal, through which it collects the set of properties to be serialized. This type of serializer preferably uses persistent storage to save the collected properties and values; such persistent storage is preferably a file or a non-volatile memory. An example of this type of serializer is the inventive part DM_SER described herein.

4.5. Property Interface Adapters

Property interface adapters are parts that convert some interface into a property interface or vice-versa.

Property interface adapters preferably have two terminals: “in” and “out”. A property interface is preferably the I_A_PROP interface described herein.

One type of property interface adapter converts one or more events into respective property operations and vice-versa. Property interface adapters make it easy to use events to manipulate properties. Examples of this type of property interface adapter include the inventive parts DM_P2E and DM_E2P described herein.

One other type of property interface adapter preferably has one or more properties for providing information that is missing from the incoming request but needs to be provided on the output request or vice-versa. Example of this type of property interface adapter include the inventive parts DM_PSET and DM_PSET8.

Yet another type of property interface adapters may add advanced functionality. Examples include filtering out enumerated properties by some template, replacing the identifiers of properties through a translation table, converting property types to achieve type compatibility, and many others.

5. Dynamic Container for Parts

Dynamic containers for parts (hereinafter often referred as “part array” without implication on how the parts are stored or accessed in the container) are parts that preferably have memory for one or more contained parts or references to those parts, and are capable of presenting the set of contained parts as a single part, the container itself. This allows structures of parts to contain dynamically changing subsets of those parts while still being able to describe the structure in a static way.

An example of a dynamic container for parts is the inventive part DM_ARR described herein.

6. Dynamic Structure Support Parts

Dynamic structure support parts make it easy to build functionality for manipulating a dynamically determined set of part instances. They are reusable parts that make it easy to assemble structures of parts that contain such a dynamically determined set of instances.

6.1. Factories

Factories are parts that initiate the creation and other preparations for normal operation of dynamically created instances of parts.

Factories preferably have at least two terminals: an “in” input for receiving events or other interactions on which the factory will initiate a creation of one or more new instances, and a “fact” output for requesting that a new instance is created or otherwise added into a container connected to the “fact” output.

Factories preferably have another terminal, “out” for forwarding the requests received on “in”. Factories may have additional terminals, such as terminals for parameterizing newly created instances, terminals for enumerating a set of instances to be created, for providing requests to one or more of the dynamic instances, and others. Factories preferably can be configured with an identifier of a part class from which the new instances will be created.

6.2. Enumerators

Enumerators are parts that determine what part instances need to be created in a dynamic set of part instances. Enumerators preferably have an “in” terminal for providing information about the dynamic set of parts to be created and means for determining what that set is.

Enumerators may also have an additional terminal, such as a terminal for providing a set of properties to be configured on the dynamically created instances.

Examples of enumerators include the inventive parts DM_REN, DM_PEN and DM_PCEN described herein.

6.3. Registrars

Registrars are parts that register part instances with some registry.

Registrars preferably have a property for specifying an identifier with which a part instance will be registered. One type of registrar registers the instance of the assembly in which it is contained so that this instance can be used by reference in other assemblies. An example of this type of registrar is the inventive part DM_SGR described herein.

Registrars of another type preferably have two properties: “id” for specifying an identifier to register, and “interface” for specifying means for accessing a part instance. Such means may include function pointer, identifier of object through which a part instance can be accessed, etc. An example of this type of registrar is the inventive part DM_DSTK described herein.

6.4. Loaders

Loaders are parts that cause part classes to become available for creation of instances when such instances are needed. One type of loader preferably has two terminals: an “in” terminal of type I_A_FACT for receiving instance creation requests and an “out” terminal for forwarding requests received on “in”. Loaders of this type monitor creation requests received on “in” and, when necessary, load the appropriate module that contains at least the part class an instance of which is being requested, before forwarding the creation request to “out”.

An example of this type of loader is the inventive part DM_LDR described herein. Other advantageous types of loaders may use different mechanisms to determine when a part class needs to be loaded, or may perform different operation to cause the part class to become usable or better to use. Such operations may include relocation in memory, bringing the part class code into faster memory, etc. Such and other variations of loaders will be apparent to those skilled in the art to which the present invention pertains.

6.5. Factory Interface Adapters

Factory interface adapters are parts that convert some interface into a factory interface or vice-versa. A factory interface is preferably an interface similar to the I_A_FACT interface described herein.

Factory interface adapters have at least two terminals: an “in” terminal for receiving requests or events and an “out” terminal for sending outgoing events or requests. Preferably, at least one of the terminals supports the factory interface.

One type of factory interface adapter is a part that makes it convenient to use events to initiate factory interface operations. This type of adapter preferably has its “in” terminal for receiving events and its “out” terminal for requesting factory operations; it may also have properties for configuring what events cause what factory operations and additional information that is needed to perform the factory operation, such as a class identifier. An example of this type of factory interface adapter is the inventive part ZP_E2FAC described herein.

Another type of factory interface adapter has both the “in” and “out” terminal supporting the factory interface and providing advanced functionality on the factory requests. An example of such an adapter is the inventive part DM_CBFAC described herein.

Event Flow Parts Details

Event Sources

DM_EST—Event Source By Thread

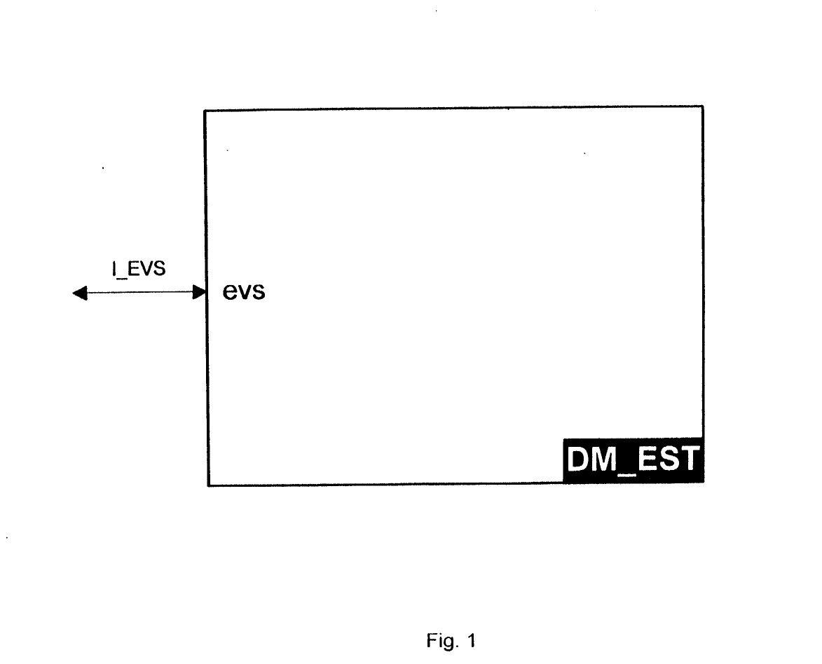

FIG. 1 illustrates the boundary of the inventive DM_EST part.

DM_EST is an event source that generates both singular and periodic events for a part connected to its evs terminal. DM_EST is armed and disarmed via input operations on its evs terminal and generates events by invoking the fire output operation on the same terminal. A user-defined context is passed to DM_EST when armed and is passed back in the fire operation call when the time out period expires.

DM_EST allows itself to be armed only once. If DM_EST has not been armed to generate periodic events, it may be re-armed successfully as soon as the event is generated; this includes being re-armed while in the context of the fire operation call.

DM_EST may be disarmed at any time. Once disarmed, DM_EST will never invoke the fire operation on evs until it is re-armed. The context passed to DM_EST when disarming it must match the context that was passed with the arm operation.

DM_EST may be parameterized with default values to use when generating events and flags that control the use of the defaults and whether or not DM_EST automatically arms itself when activated. These properties can significantly simplify the use of DM_EST in that it is possible to simply connect to and activate DM_EST to obtain a source of events.

1. Boundary

1.1. Terminals

Terminal “evs” with direction “Bidir” and contract In: I_EVS Out: I_EVS_R. Note: Synchronous, v-table, cardinality 1 Used to arm and disarm the event source on the input and also to send the event on the output when the time period expires.

1.2. Events and notifications

DM_EST has no incoming or outgoing events. The “event” generated by DM_EST is a fire operation call defined in I_EVS_R; it is not an event or notification passed via an I_DRAIN interface.

1.3. Special Events, Frames, Commands or Verbs

None.

1.4. Properties

Property “force_defaults” of type “UINT32”. Note: Boolean. If TRUE, the time and continuous properties override the values passed in the I_EVS bus. Default is FALSE.

Property “auto_arm” of type “UINT32”. Note: Boolean. If TRUE, DM_EST will automatically arm itself on activation. DM_EST will return CMST_REFUSE on any evs.arm calls. The force_defaults property must be set to TRUE for this property to be valid. If not, DM_EST will fail its activation. Default is FALSE.

Property “thread_priority” of type “UINT32”. Note: Thread priority of DM_EST's worker thread. Default is THREAD PRIORITY_NORMAL.

Property “time” of type “SINT32”. Note: Default time period in milliseconds. Valid range is 1-0x7fffffff. When this time period expires (after DM_EST is armed), DM_EST will fire an event (by calling evs.fire). Default is −1.

Property “continuous” of type “UINT32”. Note: Boolean. If TRUE and DM_EST is armed, generate periodic events until disarmed. Default is TRUE.

2. Encapsulated Interactions

DM_EST uses the following NT Kernel Mode APIs to control event objects and its worker thread:

KelnitializeEvent( )

KeSetEvent( )

KeClearEvent( )

PsCreateSystemThread( )

PsTerminateSystemThread ( )

KeDelayExecutionThread( )

KeWaitForSingleObject( )

KeWaitForMultipleObjects( )

DM_EST uses the following Windows 95 Kernel Mode APIs to control event objects and its worker thread:

HeapAllocate( )

HeapFree( )

SignalID( )

BlockOnID( )

Get_System_Time( )

Time_Slice_Sleep( )

VWIN32_CreateRingOThread( )

Set_Thread_Win32_Pri( )

Set_Async_Time_Out( )

Create_Semaphore( )

Destroy_Semaphore( )

Signal_Semaphore_No_Switch( )

Wait_Semaphore( )

3. Responsibilities

1. When armed with a time period, generate timer events by calling evs.fire.

2. Generate either one-shot timer events that require arming for each or periodic timer events that require a single arm operation.

3. Allow the re-arming/disarming of the event source while in the context of a evs.fire call.

4. Allow disarming of single or periodic timer events. No events are to be sent out evs.fire at any time while DM_EST is disarmed (even if periodic timer events are pending).

4. Theory of Operation

4.1. Mechanisms

Using a Separate Thread for Arm/Disarm Requests

DM_EST uses a separate thread to arm/disarm the event source. The thread waits for an arm or disarm request and acts appropriately. DM_EST uses events to synchronize the execution and termination of the thread. Each instance of DM_EST maintains its own thread.

Arming the Event Source

When an arm request arrives (within the execution context of a part using DM_EST) the thread created by DM_EST is awakened and begins waiting for the specified time period to expire using KeDelayExecutionThread( ). When the time period has expired the thread will fire an event through the evs terminal.

The event source may be re-armed while in the execution context of a fire event. Upon return from the fire event, the thread will re-arm the event source with the parameters passed with the arm request.

Note that arm requests fail with CMST_REFUSE if DM_EST was parameterized to generate periodic events (continuous property is TRUE).

Disarming the Event Source

When a disarm request arrives (within the execution context of a part using DM_EST), the thread will disarm the event source (if armed). The event source will not fire again until it is re-armed.

The event source may be disarmed while in the execution context of a fire event. Upon return from the fire event, the thread will disarm the event source canceling any previous arm requests. The event source will not fire again until it is re-armed.

Deactivation/Destruction of DM_EST

When the event source is destroyed, DM_EST waits for the worker thread to terminate. DM_EST will then free its resources and will not fire again until it is created, activated and armed.

DM_EST may be deactivated while in the execution context of a fire event.

4.2. Use Cases

Using the Event Source as a One-Shot Timer

1. DM_EST and Part A are created.

2. Part A connects its evs terminal to DM_EST's evs terminal.

3. Both parts are activated.

4. Part A arms DM_EST passing a time period and a context.

5. At some later point, the time period expires.

6. DM_EST's worker thread calls Part A's fire operation through its evs terminal passing the status CMST_OK and the context associated with the event (passed with the arm request).

7. Part A does one of the following:

a. re-arms the event source—the event source is armed and will fire again when appropriate

b. continues execution—the event source is disarmed and will not fire again until Part A re-arms it at a later time

Using the Event Source as a Periodic Timer

1. DM_EST and Part A are created.

2. Part A connects its evs terminal to DM_EST's evs terminal.

3. DM_EST is parameterized with the following:

a. force_defaults is TRUE

b. auto_arm is FALSE

c. time is set to some time interval for each event

d. continuous is TRUE

4. Both parts are activated.

5. Part A arms DM_EST passing a context.

6. At some later point, the time period expires.

7. DM_EST's worker thread calls Part A's fire operation through its evs terminal passing the status CMST_OK and the context associated with the event (passed with the arm request).

8. Part A does one of the following:

c. disarms the event source—the event source is disarmed and will not fire again until Part A re-arms it at a later time

d. continues execution—the event source will re-arm itself and will fire again at a later time

9. If the fire_delay property is not zero, DM_EST sleeps for fire_delay milliseconds before arming itself again for the next fire event.

10. Steps 6-8 are executed many times as long as the event source remains armed.

Auto-Arming the Event Source

1. DM_EST and Part A are created.

2. Part A connects its evs terminal to DM_EST's evs terminal.

3. DM_EST is parameterized with the following:

a. force_defaults is TRUE

b. auto_arm is TRUE

c. time is set to some time interval for each event

d. continuous is TRUE

4. Both parts are activated.

5. At some later point, the time period expires.

6. DM_EST's worker thread calls Part A's fire operation through its evs terminal passing the status CMST_OK.

7. Part A does one of the following:

a. disarms the event source—the event source is disarmed and will not fire again until Part A re-arms it at a later time

b. continues execution—the event source will re-arm itself and will fire again at a later time

8. Steps 5-7 are executed many times as long as the event source remains armed.

Disarm Event Source to Terminate Firing

1. DM_EST and Part A are created.

2. Part A connects its evs terminal to DM_EST's evs terminal.

3. Both parts are activated.

4. Part A arms DM_EST passing a time period and a context.

5. At some later point before the time period expires Part A disarms the event source.

6. The event source is disarmed and will not fire again until it is re-armed.

Deactivation/Destruction of DM_EST While the Event Source is Armed

1. DM_EST and Part A are created.

2. Part A connects its evs terminal to DM_EST's evs terminal.

3. Both parts are activated.

4. Part A arms DM_EST passing a time period and a context.

5. At some later point before the time period has expired, DM_EST is deactivated (not necessarily by Part A).

6. DM_EST signals the worker thread to stop waiting for the specified time period to expire.

7. DM_EST waits for its worker thread to terminate and releases all its resources.

8. DM_EST is destroyed.

DM_EVS—Event Source (Thread-Based)

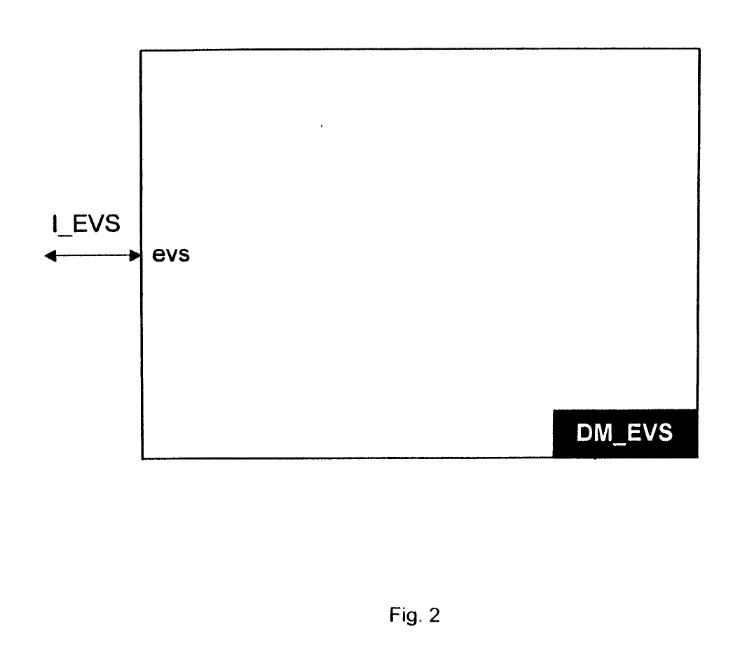

FIG. 2 illustrates the boundary of the inventive DM_EVS part.

DM_EVS is a generator of single and periodical events. DM_EVS uses a conjoint (bidirectional) interfaces I_EVS, output: I_EVS_R for the purpose of arming, disarming and firing events. Parts connected to the evs terminal must implement the I_EVS_R interface in order to receive events from the event source.

The event source uses a separate thread to handle the arm and disarm requests. Each instance of the event source maintains its own thread. When the event source fires, it is always within the execution context of this thread.

The event source is armed by invoking the arm operation on its evs terminal. DM_EVS can be armed with a Win32 synchronization object and/or a timeout period (e.g. a timer can be specified by passing a NULL object handle and a timeout period). When the synchronization object moves into a signaled state or the timeout period expires, the event source will invoke the fire operation through the evs terminal (I_EVS_R). A status is passed with the fire event that describes why the event source fired.

A 32-bit context value must be passed with the arm request in order to identify the fire event. When the fire operation is invoked on the part connected to the evs terminal, this context is passed with the event.

The event source may be armed, disarmed or deactivated at any time (including within the execution context of a fire event). Once the event source is disarmed, it will not fire again until it is re-armed at a later time.

The event source may only be armed once. If the event source is armed more then once, DM_EVS returns CMST_NO_ROOM. The event source may be re-armed after it was disarmed or after the event source fired.

This part is available only Win32 User Mode environment.

5. Boundary

5.1. Terminals

Terminal “evs” with direction “Bidir” and contract In: I_EVS

Out:I_EVS_R. Note: v-table, single cardinality, synchronous This terminal is used to arm and disarm the event source. DM_EVS also uses evs to send an event when a synchronization object is signaled or a timeout occurs.

5.2. Events and Notifications

None.

5.3. Special Events, Frames, Commands or Verbs

None.

5.4. Properties

Property “sync_lifecycle” of type “BOOL”. Note: If TRUE DM_EVS waits for its worker thread to terminate on deactivation. Default is TRUE.

Property “sync_tout” of type “SINT32”. Note: This is the timeout period used when DM_EVS is waiting for its worker thread to terminate; used only if sync_lifecycle is TRUE. Specified in milliseconds. Default is 1000 (1 second).

6. Responsibilities

1. Support event generation (firing) when a synchronization object gets signaled or a timeout period expires upon arrival.

2. Support disarming the event source once it is armed.

3. Support re-arming the event source in the execution context of a fire event.

7. Theory of Operation

7.1. Main Data Structures

None.

7.2. Mechanisms

Using a Separate Thread for Arm/Disarm Requests

DM_EVS uses a separate thread to arm/disarm the event source. The thread waits for an arm or disarm request and acts appropriately. Each instance of DM_EVS maintains its own thread.

Arming the Event Source: Within Client Execution Context

When an arm request arrives (within the execution context of a part using DM_EVS) the thread created by DM_EVS is awakened and begins waiting on the synchronization object that was specified with the arm request. When either the timeout is reached or the synchronization object is signaled, the thread will fire an event through the evs terminal.

Arming the Event Source: Within “Fire” Execution Context

The event source may be armed while in the execution context of a fire event. Upon return from the fire event, the thread will re-arm the event source with the parameters passed with the arm request.

Disarming the Event Source: Within Client Execution Context

When a disarm request arrives (within the execution context of a part using DM_EVS), the thread will disarm the event source (if armed). The event source will not fire again until it is re-armed.

Disarming the Event Source: Within “Fire” Execution Context

The event source may be disarmed while in the execution context of a fire event. Upon return from the fire event, the thread will disarm the event source canceling any previous arm requests. The event source will not fire again until it is re-armed.

Deactivation of DM_EVS: Within Client Execution Context

When the event source is deactivated, if the sync_lifecycle property is TRUE, DM_EVS will wait for the worker thread to terminate. DM_EVS will then free its resources and will not fire again until it is re-activated and re-armed.

If DM_EVS is deactivated while armed, DM_EVS will fire an event with the status CMST_CLEANUP in addition to the steps mentioned above.

Deactivation of DM_EVS: Within “Fire” Execution Context

The event source can be deactivated while in the execution context of a fire event. This should be avoided; the event source can not properly cleanup its resources in this case. The event source will print a message to the debug console and signal the worker thread to destroy iteself.

7.3. Use Cases

Arming: Synchronization Object Signaled

1. DM_EVS and Part A are created.

2. Part A connects its evs terminal to DM_EVS's evs terminal.

3. Both parts are activated.

4. Part A creates an event synchronization object.

5. Part A arms DM_EVS passing the event object, a timeout period and a context associated with the event object.

6. At some later point, the event object becomes signaled.

7. DM_EVS's worker thread calls Part A's fire operation through its evs terminal passing the status CMST_OK and the context associated with the event object (passed with the arm request).

8. Part A does one of the following:

a. re-arms the event source—the event source is armed and will fire again when appropriate

b. continues execution—the event source is disarmed and will not fire again until Part A re-arms it

Arming: Synchronization Object Already in Signaled State

1. DM_EVS and Part A are created.

2. Part A connects its evs terminal to DM_EVS's evs terminal.

3. Both parts are activated.

4. Part A creates an event synchronization object.

5. The event synchronization object enters a signaled state.

6. Part A arms DM_EVS passing the event object, a timeout period and a context associated with the event object.

7. Immediately, DM_EVS's worker thread calls Part A's fire operation through its evs terminal passing the status CMST_OK and the context associated with the event object (passed with the arm request).

8. Part A does one of the following:

c. re-arms the event source—the event source is armed and will fire again when appropriate

d. continues execution—the event source is disarmed and will not fire again until Part A re-arms it

Arming: NULL Synchronization Object

1. DM_EVS and Part A are created.

2. Part A connects its evs terminal to DM_EVS's evs terminal.

3. Both parts are activated.

4. Part A arms DM_EVS passing a NULL object, a timeout period and a context associated with the NULL object.

5. At some later point, the timeout period expires.

6. DM_EVS's worker thread calls Part A's fire operation through its evs terminal passing the status CMST_TIMEOUT and the context associated with the NULL object (passed with the arm request)

7. Part A does one of the following:

e. re-arms the event source—the event source is armed and will fire again when appropriate

f. continues execution—the event source is disarmed and will not fire again until Part A re-arms it

Arming: Timeout Period on Synchronization Object Expired

8. DM_EVS and Part A are created.

9. Part A connects its evs terminal to DM_EVS's evs terminal.

10. Both parts are activated.

11. Part A creates an event synchronization object.

12. Part A arms DM_EVS passing the event object, a timeout period and a context associated with the event object.

13. At some later point, the timeout period expires (the synchronization object never was signaled).

14. DM_EVS's worker thread calls Part A's fire operation through its evs terminal passing the status CMST_TIMEOUT and the context associated with the synchronization object (passed with the arm request).

15. Part A does one of the following:

g. re-arms the event source—the event source is armed and will fire again when appropriate

h. continues execution—the event source is disarmed and will not fire again until Part A re-arms it

Arm Event Source: Sync. Object Owner Thread Terminates

1. DM_EVS and Part A are created.

2. Part A connects its evs terminal to DM_EVS's evs terminal.

3. Both parts are activated.

4. Part A creates a thread that creates a mutex synchronization object.

5. Part A's thread arms DM_EVS passing the mutex object, a timeout period and a context associated with the mutex object.

6. At some later point, the thread that owns the mutex terminates.

7. DM_EVS's worker thread calls Part A's fire operation through its evs terminal passing the status CMST_CANCELED and the context associated with the synchronization object (passed with the arm request).

Disarm Event Source to Terminate Firing

7. DM_EVS and Part A are created.

8. Part A connects its evs terminal to DM_EVS's evs terminal.

9. Both parts are activated.

10. Part A creates an event synchronization object.

11. Part A arms DM_EVS passing the event object, a timeout period and a context associated with the event object.

12. At some later point before the event object is signaled and before the timeout period has expired, Part A disarms the event source.

13. The event source is disarmed and will not fire again until it is re-armed.

Deactivation of DM_EVS While the Event Source is Armed

9. DM_EVS and Part A are created.

10. Part A connects its evs terminal to DM_EVS's evs terminal.

11. Both parts are activated.

12. Part A creates an event synchronization object.

13. Part A arms DM_EVS passing the event object, a timeout period and a context associated with the event object.

14. At some later point before the event object is signaled and before the timeout has expired, DM_EVS is deactivated (not necessarily by Part A).

15. DM_EVS signals the worker thread to stop waiting on the event object.

16. DM_EVS's worker thread calls Part A's fire operation through its evs terminal passing the status CMST_CLEANUP and the context associated with the event object (passed with the arm request).

17. If the deactivation was in the execution context of a fire event, DM_EVS prints a message to the debug console and becomes deactivated without any cleanup.

18. If the deactivation was in any other execution context:

a. If the sync_lifecycle property is TRUE, DM_EVS waits for its worker thread to terminate.

b. DM_EVS releases all its resources and becomes deactivated.

DM_ESP—Event Source by DriverMagic Pump

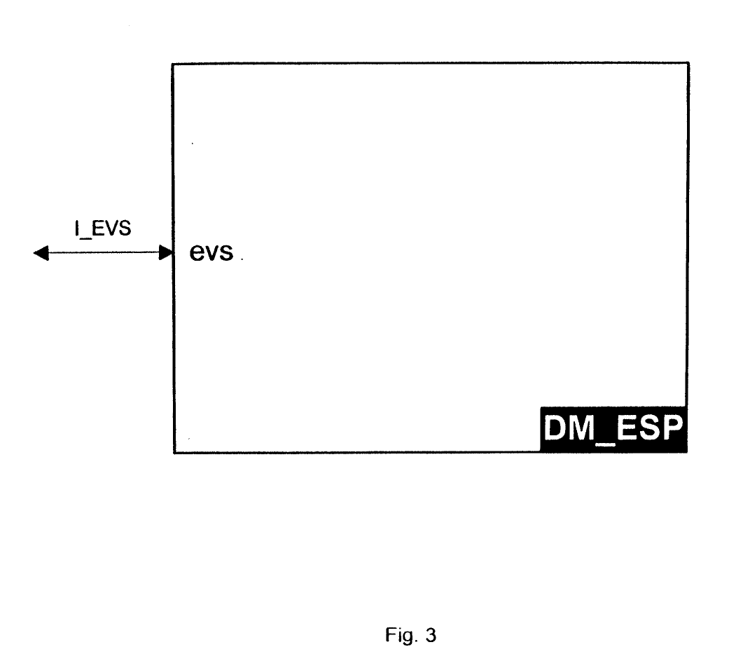

FIG. 3 illustrates the boundary of the inventive DM_ESP part.

DM_ESP is an event source that generates both singular and continuous events by using the DriverMagic pump (queue). DM_ESP can be armed and disarmed from any thread or restricted execution context (i.e. dispatch, interrupts). It can be armed to fire a single event per arming (single shot mode), or to keep firing until disarmed (continuous mode).

DM_ESP may be manually armed and disarmed, including from within the handler of the event it fired. Alternatively, DM_ESP can be parameterized to arm itself automatically upon activation, using the mode specified in its properties; typically, auto_arming is used with continuous mode.

DM_ESP can be armed only once; it must be disarmed before it can be armed again. When arming DM_ESP, the caller can provide a context value; DM_ESP passes this context value with every event it fires. To disarm DM_ESP, the caller must pass the same context value.

8. Boundary

8.1. Terminals

Terminal “evs” with direction “Bidir” and contract In: I_EVS Out: I_EVS_R. Note: Synchronous, v-table, cardinality 1 Used to arm and disarm the event source on the input and also to send the event on the output.

8.2. Events and notifications

DM_ESP has no incoming or outgoing events. The “event” generated by DM_ESP is a fire operation call defined in I_EVS_R; it is not an event or notification passed via an I_DRAIN interface.

8.3. Special Events, Frames, Commands or Verbs

None.

8.4. Properties

Property “force_defaults” of type “UINT32”. Note: Boolean. If TRUE, the continuous property overrides the value passed in the I_EVS bus. Default is FALSE.

Property “auto_arm” of type “UINT32”. Note: Boolean. If TRUE, DM_ESP will automatically arm itself on activation. DM_ESP will return CMST_REFUSE on any evs.arm or evs.disarm calls. The force_defaults property must be set to TRUE for this property to be valid. If not, DM_ESP will fail its activation. Default is FALSE.

Property “continuous” of type “UINT32”. Note: Boolean. If TRUE and DM_ESP is armed, generate continuous events until disarmed. Default is TRUE.

9. Encapsulated Interactions

DM_ESP uses the DriverMagic pump as a source of events.

10. Specification

11. Responsibilities

1. Generate either one-shot events that require arming for each or continuous events that require a single arm operation.

2. When armed, post a fire message to self. When the fire message is dispatched to DM_ESP, fire an event through evs.fire. If in continuous mode, re-post a fire message to self before returning from the message handler.

3. Allow the re-arming/disarming of the event source while in the context of an evs.fire call.

4. Allow disarming of single or continuous events. No events are to be sent out evs.fire at any time while DM_ESP is disarmed (even if one or more fire messages are pending).

12. Theory of Operation

12.1. State Machine

None.

12.2. Mechanisms

Arming the Event Source

When an arm request arrives (within the execution context of a part using DM_ESP) DM_ESP posts a fire message to itself. The DriverMagic pump enqueues this message and dispatches it at a later time. When the fire message handler is called, DM_ESP fires an event through the evs terminal. If armed in continuous mode, DM_ESP re-posts a fire message to itself before returning from the message handler.

The event source may be re-armed while in the execution context of a fire event. Upon return from the fire event, DM_ESP re-arms the event source with the parameters passed with the arm request.

Note that arm requests fail with CMST_REFUSE if DM_ESP is already armed. When DM_ESP is used in continuous mode and is armed once, DM_ESP is considered armed at all times until explicitly disarmed.

Disarming the Event Source

When a disarm request arrives (within the execution context of a part using DM_ESP), the event source becomes disarmed. The event source will not fire again until it is re-armed.

The event source may be disarmed while in the execution context of a fire event. Upon return from the fire event, DM_ESP disarms the event source canceling any previous arm requests. The event source will not fire again until it is re-armed.

Deactivation/Destruction of DM_ESP

When the event source is deactivated or destroyed, DM_ESP disarms itself (if needed). DM_ESP will not fire again until it is created, activated and armed.

DM_ESP may be deactivated while in the execution context of a fire event.

12.3. Use Cases

Using DM_ESP for a One-Shot Event Source

1. DM_ESP and Part A are created.

2. Part A connects its evs terminal to DM_ESP's evs terminal.

3. Both parts are activated.

4. Part A arms DM_ESP passing a context. DM_ESP posts a fire message to itself.

5. At some later point, the fire message is dispatched and its message handler is called.

6. DM_ESP calls Part A's fire operation through its evs terminal passing the status CMST_OK and the context associated with the event (passed with the arm request).

7. Part A does one of the following:

a. re-arms the event source—the event source is armed and will fire again when appropriate

b. continues execution—the event source is disarmed and will not fire again until Part A re-arms it at a later time

Using DM_ESP for a Continuous Source of Events

1. DM_ESP and Part A are created.

2. Part A connects its evs terminal to DM_ESP's evs terminal.

3. DM_ESP is parameterized with the following:

a. force_defaults is TRUE

b. auto_arm is FALSE

c. continuous is TRUE

4. Both parts are activated.

5. Part A arms DM_ESP passing a context.

6. DM_ESP posts a fire message to itself.

7. At some later point, the fire message is dispatched and its message handier is called.

8. DM_ESP calls Part A's fire operation through its evs terminal passing the status CMST_OK and the context associated with the event (passed with the arm request).

9. Part A does one of the following:

a. disarms the event source—the event source is disarmed and will not fire again until Part A re-arms it at a later time

b. continues execution—the event source will re-arm itself and will fire again at a later time

10. Steps 6-9 are executed many times as long as the event source remains armed.

Auto-Arming the Event Source

1. DM_ESP and Part A are created.

2. Part A connects its evs terminal to DM_ESP's evs terminal.

3. DM_ESP is parameterized with the following:

a. force_defaults is TRUE

b. auto_arm is TRUE

c. continuous is TRUE

4. Both parts are activated.

5. DM_ESP posts a fire message to itself.

6. At some later point, the fire message is dispatched and its message handler is called.

7. DM_ESP calls Part A's fire operation through its evs terminal passing the status CMST_OK.

8. Part A does one of the following:

a. disarms the event source—the event source is disarmed and will not fire again until Part A re-arms it at a later time

b. continues execution—the event source will re-arm itself and will fire again at a later time

9. Steps 5-7 are executed many times as long as the event source remains armed.

Disarm Event Source to Terminate Firing

1. DM_ESP and Part A are created.

2. Part A connects its evs terminal to DM_ESP's evs terminal.

3. Both parts are activated.

4. Part A arms DM_ESP passing a context. DM_ESP posts a fire message to itself.

5. At some later point before the fire message handler is called, Part A disarms the event source.

6. The event source is disarmed and will not fire again until it is re-armed.

Deactivation/Destruction of DM_ESP While the Event Source is Armed

1. DM_ESP and Part A are created.

2. Part A connects its evs terminal to DM_ESP's evs terminal.

3. Both parts are activated.

4. Part A arms DM_ESP passing a context. DM_ESP posts a fire message to itself.

5. At some later point before the fire message handler is called, DM_ESP is deactivated (not necessarily by Part A).

6. DM_ESP is destroyed.

13. Notes

1. The events “fired” by DM_ESP are always in the execution context of the DriverMagic pump thread.

2. DM_ESP's fire message handler is unguarded—the evs.fire operation is never called within DM_ESP's guard.

DM_ESW—Event Source by Windows Message

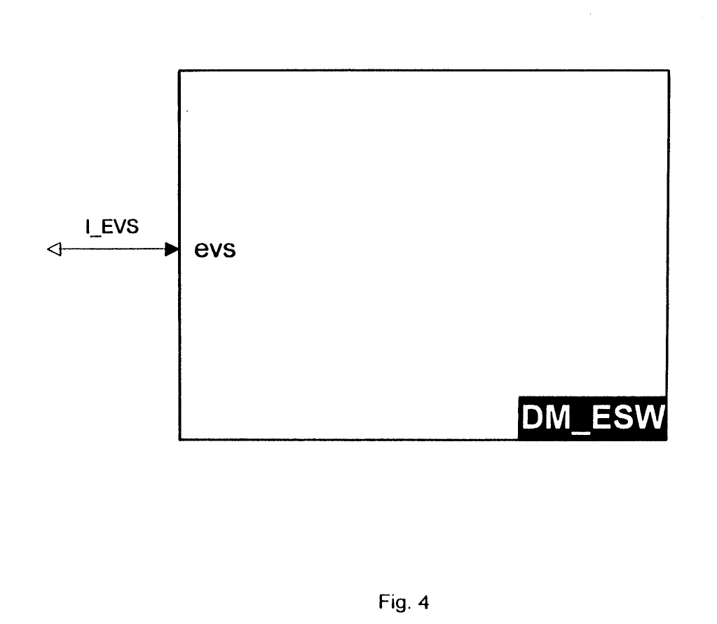

FIG. 4 illustrates the boundary of the inventive DM_ESW part.

DM_ESW is an event source that can generate events in the context of the thread in which DM_ESW was created. DM_ESW can be armed and disarmed from any thread. It can be armed to fire a single event per arming (single shot mode), or to keep firing until disarmed (continuous mode). DM_ESW can delay the firing by a specified time interval from the arming; in continuous mode, subsequent firings are also delayed by the specified time interval.

DM_ESW may be manually armed and disarmed, including from within the handler of the event it fired. Alternatively, DM_ESW can be parameterized to arm itself automatically upon activation, using the mode and time interval specified in its properties; typically, auto_arming is used with continuous mode.

DM_ESW can be armed only once; it must be disarmed before it can be armed again. When arming DM_ESW, the caller can provide a context value; DM_ESW passes this context value with every event it fires. To disarm DM_ESW, the caller must pass the same context value.

To ensure that it fires events in the thread that created it, each instance of DM_ESW uses its own Win32 window to which it posts messages; it fires the events from within the window message handler. Win32 guarantees that the messages are received in the thread that created the window (which is the thread that created DM_ESW).

Note that for DM_ESW to operate properly, there are two requirements coming from Win32:

a. the thread that created DM_ESW should be doing a message loop (i.e., call Win32 GetMessage or PeekMessage)—otherwise DM_ESW will not be able to fire its events

b. DM_ESW should be destroyed in the same thread that created it; otherwise Win32 will not destroy the window and will leak a small amount resources.

DM_ESW is available only in the Win32 environment.

14. Boundary

14.1. Terminals

Terminal “evs” with direction “Bidir” and contract In: I_EVS Out: I_EVS_R. Note: Synchronous, v-table, cardinality 1 Used to arm and disarm the event source on the input and also to send the event on the output when the time period expires.

14.2. Events and Notifications

DM_ESW has no incoming or outgoing events. The “event” generated by DM_ESW is a fire operation call defined in I_EVS_R; it is not an event or notification passed via an I_DRAIN interface.

14.3. Special Events, Frames, Commands or Verbs

None.

14.4. Properties

Property “force_defaults” of type “UINT32”. Note: Boolean. If TRUE, the time and continuous properties override the values passed in the I_EVS bus. Default is FALSE.

Property “auto_arm” of type “UINT32”. Note: Boolean. If TRUE, DM_ESW will automatically arm itself on activation. DM_ESW will return CMST_REFUSE on any evs.arm calls. Default is FALSE.

Property “time” of type “SINT32”. Note: Default time period in milliseconds. Valid range is −1-0x7fffffff: −1: DM_ESW fires event immediately. In continuous mode it continuously fires events in a busy loop (in its window's message handler) until it is disarmed. 0: DM_ESW fires event immediately. In continuous mode it fires events by continuously posting messages to its event window until it is disarmed. all other values: when the time period expires (after DM_ESW is armed), DM_ESW will fire an event (by calling evs.fire). In continuous mode DM_ESW keeps firing events with this period until disarmed. Default is −1.

Property “continuous” of type “UINT32”. Note: Boolean. If TRUE and DM_ESW is armed, generate periodic events until disarmed. If FALSE, DM_ESW needs to be re-armed after each firing. Default is TRUE.

15. Encapsulated Interactions

DM_ESW uses the following Win32 APIs to control its event window and timers:

RegisterClass( )

UnregisterClass( )

CreateWindow( )

DestroyWindow( )

SetTimer( )

KilITimer( )

PostMessage( )

16. Specification

17. Responsibilities

1. Register window class for event window only on first instance constrution of DM_ESW. Unregister window class on destruction of last instance.

2. On construction, create a window in the context of the current thread for event dispatching. On destruction destroy the window.

3. When armed, either post a WM_USER message to the event window or arm a Win32 timer for the specified time period.

4. When the WM_USER or WM_TIMER message is received by the event window message handler, fire an event through evs.fire (within the same thread that created DM_ESW).

5. If time=−1 and armed in continous mode, after firing, enter a busy loop and fire events through evs.fire until disarmed.

6. If time=0 and armed in continous mode, after firing, re-post a WM_USER message to the event window.

7. If time>0 and armed in continous mode, after firing, arm a Win32 timer associated with the event window for the specified amount of time.

8. Allow the re-arming/disarming of the event source while in the context of a evs.fire call.

9. Allow disarming of single or periodic timer events. No events are to be sent out evs.fire at any time while DM_ESW is disarmed.

18. Theory of operation

18.1. Mechanisms

Generating Events Using a Separate Window

DM_ESW uses a window to generate events to its client. Each instance of DM_ESW maintains its own window.

On construction, DM_ESW creates a window in the current thread. When DM_ESW is armed it either posts a WM_USER message to the window or arms a Win32 timer (associated with the window). When the WM_USER message is received or the timer expires, the message handler fires an event. If armed in continuous mode, the message handler will either post a new WM_USER message to the window, arm a Win32 timer or repeatedly fire events until disarmed. See the next mechanism for more information.

DM_ESW destroys the window on destruction. DM_ESW must be destroyed within the same thread that created it, otherwise unpredictable results may occur (a Win32 limitation).

Arming the Event Source

When an arm request arrives (within the execution context of a part using DM_ESW), DM_ESW either posts a WM_USER message to its event window or arms a Win32 timer (associated with the window). When the WM_USER message is received or the timer expires, the message handler fires an event. If in continuous mode, depending on the time property the window's message handler does one of the following:

time is −1: DM_ESW enters a busy loop and continuously fires events through the evs terminal until it is disarmed. During this time, no window messages for the current thread will be processed until DM_ESW is disarmed.

time is 0: DM_ESW re-posts a WM_USER message to its window. When the WM_USER message is received, DM_ESW fires an event through the evs terminal as described above. This continues until DM_ESW is disarmed.

time is >0: DM_ESW arms a Win32 timer with the specified time period and returns. When the time period expires, the message handler receives a WM_TIMER message and DM_ESW fires an event through the evs terminal.

The event source may be re-armed or disarmed while in the execution context of a fire event.

Note: Arm requests fail with CMST_REFUSE if DM_ESW was parameterized to auto_arm itself on activation (auto_arm property is TRUE).

Disarming the Event Source

When a disarm request arrives (within the execution context of a part using DM_ESW), the event source is disarmed (if armed). The event source will not fire again until it is re-armed. The event source may be disarmed while in the execution context of a fire event.

Deactivation/Destruction of DM_ESW

When the event source is destroyed, DM_ESW destroys its event window. DM_ESW then frees its resources and will not fire again until it is created, activated and armed.

DM_ESW may be deactivated while in the execution context of a fire event.

18.2. Use Cases

Using the Event Source as a One-Shot Timer

1. DM_ESW and Part A are created.

2. Part A connects its evs terminal to DM_ESW's evs terminal.

3. Both parts are activated.

4. Part A arms DM_ESW passing a time period >0 and a context.

5. Part A begins running a message dispatch loop for its windows.

6. At some later point, the time period expires.

7. DM_ESW's message handler receives a WM_TIMER message and calls Part A's fire operation through its evs terminal passing the status CMST_TIMEOUT and the context associated with the event (passed with the arm request).

8. Part A does one of the following:

a. re-arms the event source—the event source is armed and will fire again when appropriate

b. continues execution—the event source is disarmed and will not fire again until Part A re-arms it at a later time

Using the Event Source as a Periodic Timer

1. DM_ESW and Part A are created.

2. Part A connects its evs terminal to DM_ESW's evs terminal.

3. DM_ESW is parameterized with the following:

a. force_defaults is TRUE

b. auto_arm is FALSE

c. time is set to some time interval for each event

d. continuous is TRUE

4. Both parts are activated.

5. Part A arms DM_ESW passing a context.

6. Part A begins running a message dispatch loop for its windows.

7. At some later point, the time period expires.

8. DM_ESW's message handler receives a WM_TIMER message and calls Part A's fire operation through its evs terminal passing the status CMST_TIMEOUT and the context associated with the event (passed with the arm request).

9. Part A does one of the following:

a. disarms the event source—the event source is disarmed and will not fire again until Part A re-arms it at a later time

b. continues execution—the event source will re-arm itself and will fire again at a later time

10. Steps 6-8 are executed many times as long as the event source remains armed.

Auto-Arming the Event Source

9. DM_ESW and Part A are created.

10. Part A connects its evs terminal to DM_ESW's evs terminal.

11. DM_ESW is parameterized with the following:

a. force_defaults is TRUE

b. auto_arm is TRUE

c. time is set to some time interval for each event

d. continuous is TRUE

12. Both parts are activated.

13. Part A begins running a message dispatch loop for its windows.

14. At some later point, the time period expires.

15. DM_ESW's message handler receives a WM_TIMER message and calls Part A's fire operation through its evs terminal passing the status CMST_TIMEOUT.

16. Part A does one of the following:

a. disarms the event source—the event source is disarmed and will not fire again until Part A re-arms it at a later time

b. continues execution—the event source will re-arm itself and will fire again at a later time

17. Steps 6-7 are executed many times as long as the event source remains armed.

Disarm Event Source to Terminate Firing

1. DM_ESW and Part A are created.

2. Part A connects its evs terminal to DM_ESW's evs terminal.

3. Both parts are activated.

4. Part A arms DM_ESW passing a time period and a context.

5. Part A begins running a message dispatch loop for its windows.

6. At some later point before the time period expires Part A disarms the event source.

7. The event source is disarmed and will not fire again until it is re-armed.

Deactivation/Destruction of DM_ESW While the Event Source is Armed

1. DM_ESW and Part A are created.

2. Part A connects its evs terminal to DM_ESW's evs terminal.

3. Both parts are activated.

4. Part A arms DM_ESW passing a time period and a context.

5. Part A begins running a message dispatch loop for its windows.

6. At some later point before the time period has expired, DM_ESW is deactivated (not necessarily by Part A).

7. DM_ESW is destroyed.

8. DM_ESW destroys the event window and completes destruction.

19. Notes

1. In order for DM_ESW to work correctly, the application that contains the part must provide a message dispatch loop as defined by Windows. This allows the messages for an application to be dispatched to the appropriate window. Please see the Win32 documentation for more information.

2. As Win32 requires that windows be destroyed in the same thread in which they were created, DM_ESW also must be destroyed in the same thread in which it was created. Failure to do so will typically fail to destroy the window.

3. When DM_ESW is used in continuous mode to fire events in a busy loop (time=−1), an attempt to disarm and re-arm the event source while in the context of a fire event has no effect on the event source. DM_ESW will continue to fire events in a busy loop. This is the intended behavior.

DM_EVT—Timer Event Source

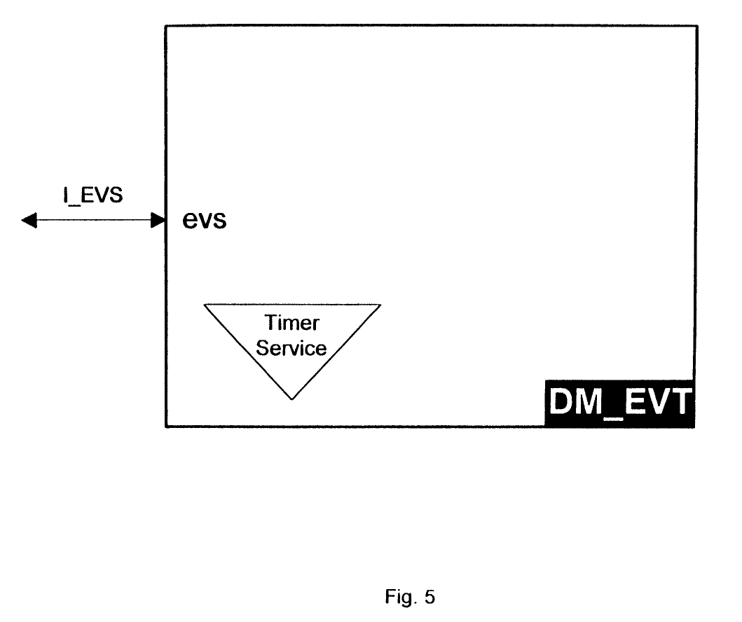

FIG. 5 illustrates the boundary of the inventive DM_EVT part.

DM_EVT is a timer event source that generates both singular and periodic timer events for a part connected to its evs terminal. DM_EVT is armed and disarmed via input operations on its evs terminal and generates timer events by invoking the fire output operation on the same terminal. A user defined context is passed to DM_EVT when armed and is passed back in the fire operation call when the time out period expires.

DM_EVT allows itself to be armed only once. If DM_EVT has not been armed to generate periodic timer events, it may be re-armed successfully as soon as the timer event is generated; this includes being re-armed while in the context of the fire operation call.

DM_EVT may be disarmed at any time. Once disarmed, DM_EVT will never invoke the fire operation on evs until it is re-armed. The context passed to DM_EVT when disarming it must match the context that was passed with the arm operation.

DM_EVT may be parameterized with default values to use when generating events and flags that control the use of the defaults and whether or not DM_EVT automatically arms itself when activated. These properties can significantly simplify the use of DM_EVT in that it is possible to simply connect to and activate DM_EVT to obtain a source of events.

DM_EVT is boundary compatible with the DM_EVS part.

This part is only available in Windows NT/95/98 Kernel Mode environments.

20. Boundary

20.1. Terminals

Terminal “evs” with direction “Bidir” and contract In: I_EVS Out: I_EVS_R. Note: Used to arm and disarm the event source on the input and to send the timer event on the output when the time period expires.

20.2. Events and Notifications

DM_EVT has no incoming or outgoing events. The timer “event” generated by DM_EVT is a fire operation call defined in I_EVS_R; it is not an event or notification passed via an I_DRAIN interface.

20.3. Special Events, Frames, Commands or Verbs

None.

20.4. Properties

Property “force_defaults” of type “UINT32”. Note: Boolean. If non-zero, the time and continuous properties override the values passed in the I_EVS bus. Default is FALSE.

Property “auto_arm” of type “UINT32”. Note: Boolean. If non-zero, DM_EVT will automatically arm itself on activation. DM_EVT will return CMST_REFUSE when on any call evs.arm call. The force_defaults property must be set to TRUE for this property to be valid. If not, DM_EVT will fail its activation. Default is FALSE.

Property “time” of type “SINT32”. Note: Default time period in milliseconds. Valid range is 1-0x7fffffff. Default is 500.

Property “continuous” of type “UINT32”. Note: Boolean. If non-zero and DM_EVT is armed, generate periodic events until disarmed. Default is FALSE.

21. Encapsulated Interactions

21.1. Windows NT Kernel Mode

DM_EVT uses KeInitializeTimerEx( ) and KeInitializeDpc( ) to initialize a timer object and a deferred procedure. DM_EVT utilizes the kernel-mode services KeSetTimerEx( ) and KeCancelTimer( ) to generate and cancel timer events.

DM_EVT does not create any threads.

21.2. Windows 95198 Kernel Mode

DM_EVT utilizes the VMM services Set_Async_Time_Out( ) and Cancel_Time_Out( ) to generate and cancel timer events.

DM_EVT does not create any threads.

22. Specification

23. Responsibilities

5. When armed with a time period, generate timer events by calling evs.fire.

6. Generate either one-shot timer events that require arming for each or periodic timer events that require a single arm operation.

7. Allow the re-arming of the timer event source while in the context of a evs.fire call.

8. Allow disarming of single or periodic timer events. No events are to be sent out evs.fire at any time while DM_EVT is disarmed (even if periodic timer events are pending).

24. Theory of Operation

24.1. State Machine

None.

24.2. Data Structures Used in Windows 95/98 Kernel Mode Environment

Because the embedded timer event handler is invoked in an interrupt context, it cannot access DM_EVT's self. To accommodate this restriction, a structure is allocated that can be shared between DM_EVT's operations and the timer event handier utilizing an interrupt level critical section for synchronization. This structure is allocated on each arm and is freed either by a disarm call or by the message handler in DM_EVT's de-synchronization mechanism (see the following section).

Access to this structure is shared between operations in DM_EVT and the embedded timer event handler, requiring an interrupt level critical section to synchronize access to it.

No specific data structures are used in Windows NT Kernel Mode implementation.

24.3. Mechanisms Used in Windows NT Kernel Mode Environment

Timer Initialization

At creation time DM_EVT initializes a kernel-mode timer object and a deferred procedure call structure (KDPC). DM_EVT initializes the KDPC with the timer callback function and first callback parameter a pointer to self. The KDPC structure is passed as a parameter when DM_EVT set the timer object.

Generating Timer Events

DM_EVT passes a time period and the deferred procedure structure to KeSetTimerEx( ). When the time period expires, the deferred procedure is invoked which posts a VM_EVT_TIMER message to DM_EVT to de-synchronize the timer object event.

Arming and Disarming

DM_EVT is armed and disarmed via the evs operation calls arm and disarm, respectively. When called on evs.arm, DM_EVT sets the time period with KeSetTimerEx( ) and returns. The timer event set by KeSetTimerEx( ) can be periodic or single event, depend on the parameters passed.

When called on evs.disarm, DM_EVT disarmd the timer by calling KeCancelTimer( ).

De-synchronization

The VM_EVT_TIMER message handler checks the context against the one stored in the self (changed after each disarm operation) and, if it matches, invokes the evs.fire operation, otherwise it returns CMST_OK.

24.4. Mechanisms Used in Windows 95/98 Kernel Mode Environment

Generating Timer Events

DM_EVT passes a time period to and registers a callback procedure with the VMM service Set_Async_Time_Out( ). When the time period expires, the callback procedure is invoked, which posts a message to DM_EVT to de-synchronize the VMM timer event (called during interrupt). The method that receives the posted message invokes the evs.fire operation synchronously, if DM_EVT's state allows (e.g., the timer was not disarmed before message was de-queued).

Arming and Disarming

DM_EVT is armed and disarmed via the evs operation calls arm and disarm, respectively. When called on evs.arm, DM_EVT creates a critical section and allocates a context for the embedded timer and registers it with Set_Async_Time_Out( ). DM_EVT also passes Set_Async_Time_Out( ) a callback and a time period. The pointer to the context is saved in the self.

When called on evs.disarm, DM_EVT checks the embedded timer context and, if a timer event is pending, calls Cancel_Time_Out( ) and frees the context. If a timer event is not pending, the critical section is destroyed and the pointer to the context in the self is set to NULL.

De-synchronization

When the callback procedure registered with Set_Async_Time_Out( ) is invoked, the state in the received context is checked to determine if a periodic timer is specified, at which a new event is registered. A VM_EVT_FIRE message is then posted to DM_EVT.

The VM_EVT_FIRE message handler checks the context pointer against the one stored in the self (by the arm operation) and, if it matches, invokes the evs.fire operation. If there are no pending timer events, DM_EVT will free the context and move into a disarmed state.

Managing the Context for the Embedded Timer

The event handler for the embedded system timer executes in an interrupt context, therefore, it cannot access the self. A context that can be shared between DM_EVT's normal operation handlers and the timer event handler is allocated by the evs.arm operation and freed either by the evs.disarm operation or, if already referenced by a posted message, by the handler that receives the message. Reference counters are maintained inside the structure to store the necessary state to determine when the context should be freed (more than one message with the same context may be queued). Additionally, a critical section object is stored in the context and is always accessed before any other field is touched. The critical section is used for synchronization of access to this context.

DM_IRQ—Interrupt Event Source

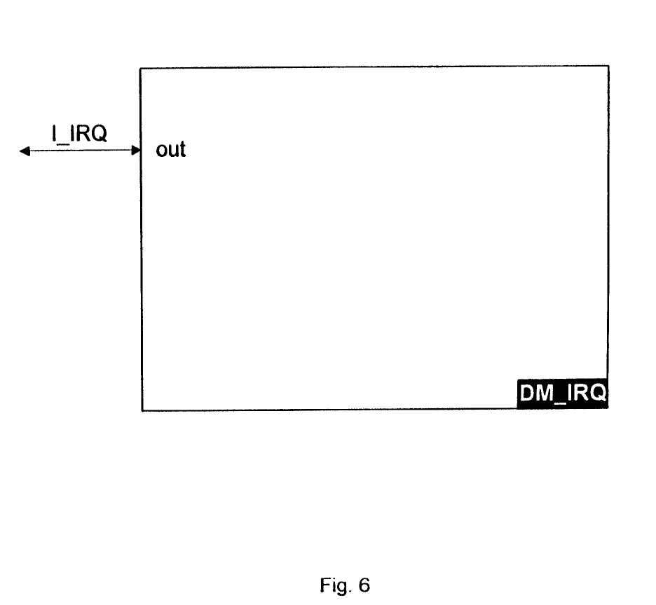

FIG. 6 illustrates the boundary of the inventive DM_IRQ part.

DM_IRQ is an interrupt event source that generates events when a hardware interrupt occurs. DM_IRQ is enabled and disabled via input operations on its out terminal and generates interrupt events by invoking preview and/or submit output operation on the same terminal.

DM_IRQ may be enabled and disabled only at PASSIVE_LEVEL. Once enabled, DM_IRQ will invoke preview and submit operations on its out terminal whenever interrupts occur. Disabling the DM_IRQ will stop generation of output operations through the out terminal. If the auto-enable property is set, enabling of the DM_IRQ is executed internally at activation time.

A user-defined context is passed back to DM_IRQ upon successful return from preview call. This context is used for the subsequent submit call, if the client returns with status CMST_SUBMIT. DM_IRQ maintain statistics counters for the number of generated interrupts, the number of submit commands issued through the out terminal and the number of “missed” submits.

Note: The preview operation is executed at interrupt context. The corresponding operation handler must be unguarded. The submit operation is executed at DISPATCH_LEVEL.

Note DM_IRQ may only be used in the NT Kernel Mode environment.

25. Boundary

25.1. Terminals

Terminal “out” with direction “bi-dir” and contract in: I_IRQ (vtable) out: I_IRQ_R (vtable). Note: Used to enable and disable the event source on the input and to send the interrupt event on the output when the interrupt occurs.

25.2. Events and Notifications

None.

25.3. Special Events, Frames, Commands or Verbs

None.

25.4. Properties

Property “bus” of type “DWORD”. Note: number of the bus on which the device is placed (Mandatory)

Property “bus type” of type “DWORD”. Note: Type of the bus (BUS_TYPE xxx): BUS_TYPE_INTERNAL (1) BUS_TYPE_ISA (2) BUS_TYPE_EISA (3) BUS_TYPE_MICRCHANNEL (4) BUS_TYPE_TURBOCHANNEL (5) BUS_TYPE PCI (6) The default value is BUS_TYPE_PCI

Property “level” of type “DWORD”. Note: IRQ level (IRQL) (Mandatory)

Property “vector” of type “DWORD”. Note: IRQ vector (Mandatory)

Property “irq_mode” of type “DWORD”. Note: IRQ_MODE_LEVEL(O)—level-sensitive interrupt. IRQ_MODE_LATCHED(1)—edge-sensitive The default value is IRQOMODE_LEVEL.

Property “shared” of type “DWORD”. Note: Boolean TRUE if the interrupt can be shared. FALSE—IQR must claim exclusive use of this interrupt. The default value is TRUE.

Property “auto_enable” of type “DWORD”. Note: Boolean. If non-zero, IRQ will automatically enable itself on activation. IRQ will return REFUSE on any enable call. The default value is FALSE.

Property “cnt_received” of type “DWORD

read-only”. Note: Count the number of received interrupts since DM_IRQ was enabled.

Property “cnt_submitted” of type “DWORD read-only”. Note: Count the number of submitted interrupts since DM_IRQ was enabled.

Property “cnt_missed” of type “DWORD read-only”. Note: Count the number of interrupts for which DM_IRQ was not able to execute submit call.

26. Encapsulated Interactions

HalGetInterruptVector—returns a mapped system interrupt vector, interrupt level, and processor affinity mask that device drivers must pass to IoConnectInterrupt.

IoConnectInterrupt—registers an ISR to be called when the interrupt occurs.

IoDisconnectInterrupt—unregisters the Interrupt Service Routine (ISR)

KeInsertQueueDpc—queues a DPC for execution when the IRQL of a processor drops below DISPATCH_LEVEL

KeRemoveQueueDpc—removes a given DPC object from the system DPC queue.

InterlockedCompareExchange—an atomic compare and exchange operation.

27. Specification

28. Responsibilities

1. Provide sufficient properties to identify the interrupt uniquely

2. Allocate and connect interrupt on enable or on activate if the property auto-enable is set.

3. Implement the actual interrupt handier.

4. Process incoming interrupts as follows:

a. call preview

b. depending on the returned status, create a DPC and queue it

c. inform the operating system that this interrupt is recognized

d. maintain the statistic counters

5. On disable, clean up properly. Cancel all outstanding DPCs.

6. Maintain a stack with free DPC structures. They are used for scheduling deferred procedure calls from which context is called submit operations.

7. Check the current IRQ level on all incoming enable and disable calls and refuse the operation if the level is not PASSIVE_LEVEL

8. Guarantee that the submit comes out on IRQL equal to DISPATCH_LEVEL

9. Guarantee that the preview comes out in interrupt context.

10. Guarantee that there will not be any preview or submit calls after the disable operations returns or after it is deactivated.

29. Theory of Operation

29.1. State Machine

None.

29.2. Main Data Structures

A stack of 32 KDPC structures used for issuing the deferred procedure calls.

29.3. Mechanisms

Servicing the Interrupt

When the interrupt occurs, DM_IRQ generates a preview call through its out terminal. If the preview returns status CMST_SUBMIT, DM_IRQ schedules a DPC which sends out a submit call with the returned from preview context.

Enabling and Disabling Interrupts

DM_IRQ expects client to call enable and disable at PASSIVE_LEVEL. The same applies for activation and deactivation with property auto enable set to TRUE. On enable it allocates an interrupt and connects an interrupt handler to it. On disable it disconnects itself from the interrupt and releases all pending DPCs. There will be no outgoing calls after disabling the interrupts.

Allocating Memory for the DM_IRQ Instance

The memory allocated for the DM_IRQ instance is from the non-paged memory pool.

30. Usage Notes

1. The preview operation on the part connected to the DM_IRQ must be unguarded. The preview operation cannot be guarded because it is executed in interrupt context.

2. If the clients needs to access any data during preview or submit it should be in non-paged memory.

3. On preview the client is responsible to synchronize access to any data that is shared between the preview handler and the rest of the code, using appropriate atomic and interlocked operations. Note that no DriverMagic™ APIs may be called during preview.

4. While a preview operation is executed it could be preempted at any time by other preview operation with higher priority or running on different processor.

5. If the interrupt being serviced is level-sensitive, the preview operation handler should cause the device to deassert the interrupt request—otherwise the preview operation will be invoked immediately upon return. For devices that support multiple causes of interrupts, the preview operation needs to clear at least one cause on each invocation. Since the connected part is not supposed to know the type of interrupt (edge-sensitive or level-sensitive), the preview handler should always remove the cause of the interrupt before returning.

6. There is no limitation for the implementation of submit operation on the connected part.

7. DM_IRQ could send out a submit operation at any time. It is in the connected part responsibilities to guard itself from submit reentrancy.

Notifiers

DM_NFY—Notifier

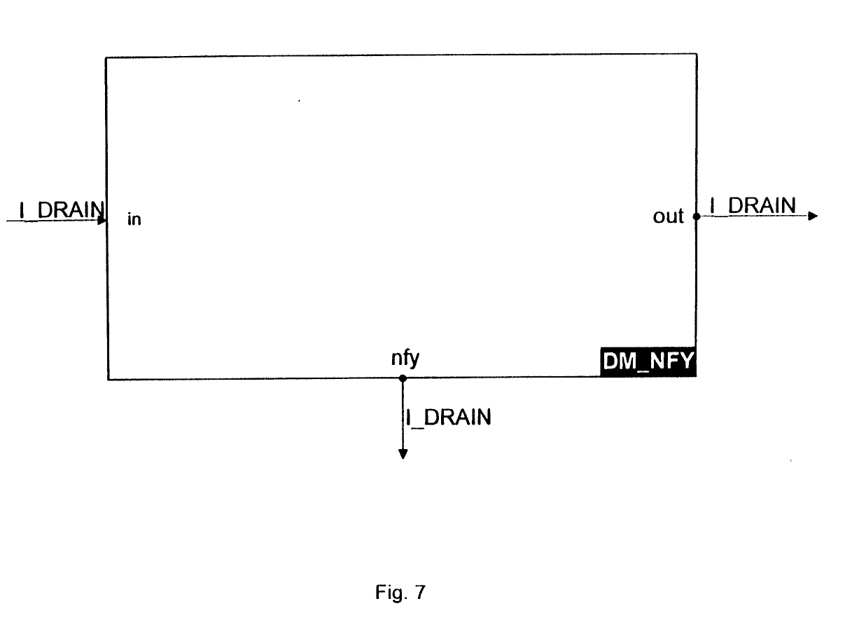

FIG. 7 illustrates the boundary of the inventive DM_NFY part.

DM_NFY is a connectivity part. It passes all events received on its in terminal to its out terminal watching for particular event (trigger) to come. When such trigger event is received, DM_NFY can optionally send two notifications that such event has been received: before and/or after passing it through its out terminal.

The ID of the trigger event as well as the IDs of the notification events are exposed as properties on the DM_NFY boundary.

1. Boundary

1.1. Terminals

Terminal “in” with direction “In” and contract I_DRAIN. Note: All input events are received here and forwarded to out terminal. The status returned is the one returned by the operation on the out terminal. If out terminal is not connected, the operation will return CMST_NOT_CONNECTED. Unguarded. Can be connected when the part is active.

Terminal “out” with direction “Out” and contract I_DRAIN. Note: All input events received on in terminal are forwarded through here. Can be connected when the part is active.

Terminal “nfy” with direction “Out” and contract I_DRAIN. Note: Notifications that the trigger event is received are sent through here. Can be connected when the part is active.

1.2. Events and Notifications

All events received on in terminal are forwarded to out terminal, raising up to two notifications: one before and after the forwarding.

The event IDs are exposed as properties and therefore can be controlled by the outer scope.

The attributes of the notification events are: CMEVT_A_SELF_CONTAINED, CMEVT_A_SYNC, CMEVT_A_ASYNC.

The pre and post notifications are always allocated on the stack.

1.3. Special Events, Frames, Commands or Verbs

None.

1.4. Properties

Property “trigger_-ev” of type “UINT32”. Note: Trigger event ID. Mandatory.

Property “pre ev” of type “UINT32”. Note: Pre-notification event ID. Set to EV_NULL to disable issuing a pre-notification. Default: EV_NULL.

Property “post-ev” of type “UINT32”. Note: Post-notification event ID. Set to EV_NULL to disable issuing a post-notification. Default: EV_NULL.

2. Encapsulated Interactions

None.

3. Specification

4. Responsibilities

1. Pass all events coming on in to out.

2. Watch for trigger event and send pre and/or post notification to nfy when this event arrives.

5. Theory of Operation

DM_NFY passes all events coming at the in terminal through its out terminal and watches for a particular event to arrive. When the event arrives, based on its parameters, DM_NFY issues one or two notifications: before and/or after the event is passed through.

DM_NFY propagates the status returned on the out terminal operation back to the caller of the in terminal operation.

DM_NFY keeps no state.

DM_NFY2—Advanced Event Notifier

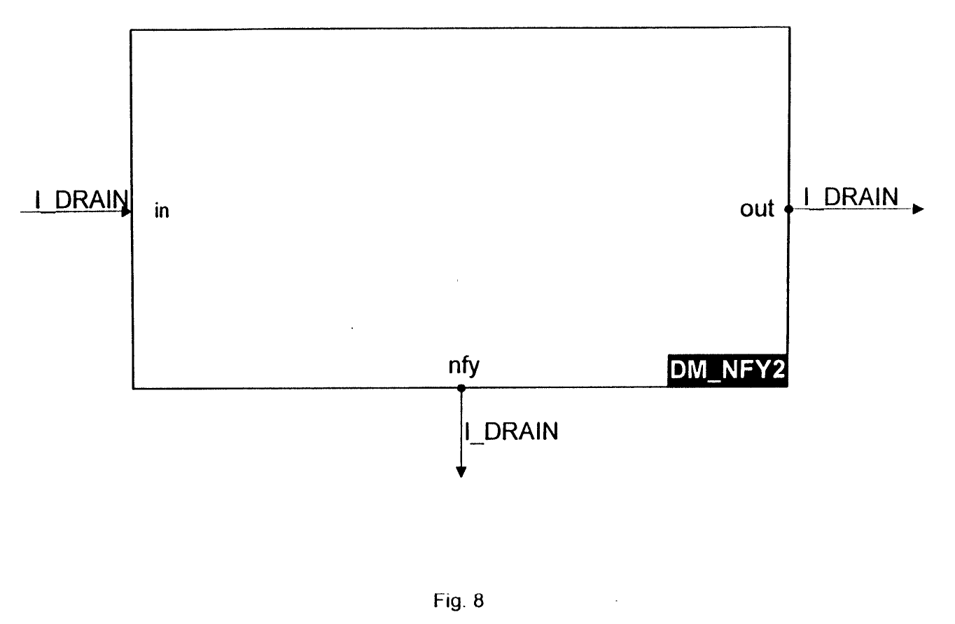

FIG. 8 illustrates the boundary of the inventive DM_NFY2 part.

DM_NFY2 is a connectivity part. It passes all events received on its in terminal to its out terminal watching for particular event (trigger) to come. When such trigger event is received, DM_NFY2 can send one or two notifications that such event has been received: before and/or after passing it through its out terminal.

Unlike the standard notifier (DM_NFY), DM_NFY2 allocates the notification event buses using cm_evt_alloc and allows custom event bus sizes and event attributes.

6. Boundary

6.1. Terminals

Terminal “in” with direction “In” and contract I_DRAIN. Note: All input events are received here and forwarded to out terminal. The status returned is the one returned by the operation on the out terminal. If out terminal is not connected, the operation will return CMST_NOT_CONNECTED. Unguarded. Can be connected when the part is active.

Terminal “out” with direction “Out” and contract I_DRAIN. Note: All input events received on in terminal are forwarded through here. Can be connected when the part is active.

Terminal “nfy” with direction “Out” and contract I_DRAIN. Note: Notifications that the trigger event is received are sent through here. Can be connected when the part is active.

6.2. Events and Notifications

All events received on in terminal are forwarded to out terminal, raising up to two notifications: one before and after the forwarding.

The event IDs, bus size and attributes are exposed as properties and therefore can be controlled by the outer scope.

The pre and post notification event buses are allocated using cm_evt_alloc.

See notes at the end of this data sheet for details on freeing self-owned events and events with asynchronous completion.

6.3. Special Events, Frames, Commands or Verbs

None.

6.4. Properties

Property “trigger_ev” of type “UINT32”. Note: Trigger event ID. Mandatory.

Property “pre_ev” of type “UINT32”. Note: Pre-notification event ID. Set to EV_NULL to disable issuing a pre-notification. Default: EV_NULL.

Property “pre_ev_bus_sz” of type “UINT32”. Note: Specifies the size (in bytes) of the event bus used for the pre-notification event. DM_NFY2 zero-initializes the bus and updates the event header information (event id, bus size and attributes) before sending the event. Default is sizeof (CMEVENT_HDR).

Property “pre_ev_attr” of type “UINT32”. Note: Pre-notification event attributes. These attributes are set by DM_NFY2 after event allocation. Default: CMEVT_A_SYNC_ANY|CMEVT_A_SELF_CONTAINED

Property “post_ev” of type “UINT32”. Note: Post-notification event ID. Set to EV_NULL to disable issuing a post-notification. Default: EV_NULL.

Property “post_ev_bus_sz” of type “UINT32”. Note: Specifies the size (in bytes) of the event bus used for the post-notification event. DM_NFY2 zero-initializes the bus and updates the event header information (event id, bus size and attributes) before sending the event. Default is sizeof (CMEVENT_HDR).

Property “post_ev_attr” of type “UINT32”. Note: Post-notification event attributes. These attributes are set by DM_NFY2 after event allocation. Default: CMEVT_A_SYNC_ANY|CMEVT_A_SELF_CONTAINED

7. Encapsulated Interactions

None.

8. Specification

9. Responsibilities

3. Pass all events coming on in to out.

4. Fail activation if CMEVT_A_ASYNC_CPLT and CMEVT_A_SELF_OWNED attributes are both set for either the pre or post notification event attributes.

5. Watch for trigger event and send pre and/or post notification to nfy when this event arrives.

10. Theory of Operation

DM_NFY2 passes all events coming at the in terminal through its out terminal and watches for a particular event to arrive. When the event arrives, based on its parameters, DM_NFY2 issues one or two notifications: before and/or after the event is passed through.

DM_NFY2 propagates the status returned on the out terminal operation back to the caller of the in terminal operation.

DM_NFY2 keeps no state.

10.1. State Machine

None.

10.2. Main Data Structures

None.

10.3. Mechanisms

None.

11. Notes

1. DM_NFY2's activation will fail if CMEVT_A_ASYNC_CPLT and CMEVT_A_SELF_OWNED attributes are both set for either the pre or post notification event attributes.

2. If a notification event allows asynchronous completion (CMEVT_A_ASYNC_CPLT attribute is set) and the return status of the event processing is CMST_PENDING, DM_NFY2 does not free the notification event. It is up to the recipient of this event to free the event bus. DM_NFY2 will only free the event if a status other than CMST_PENDING is returned.

3. If a notification event is self-owned (CMEVT_A_SELF_OWNED), DM_NFY2 will only free the event bus if the return status is not equal to CMST_OK.

DM_NFYS—Notifier on Status

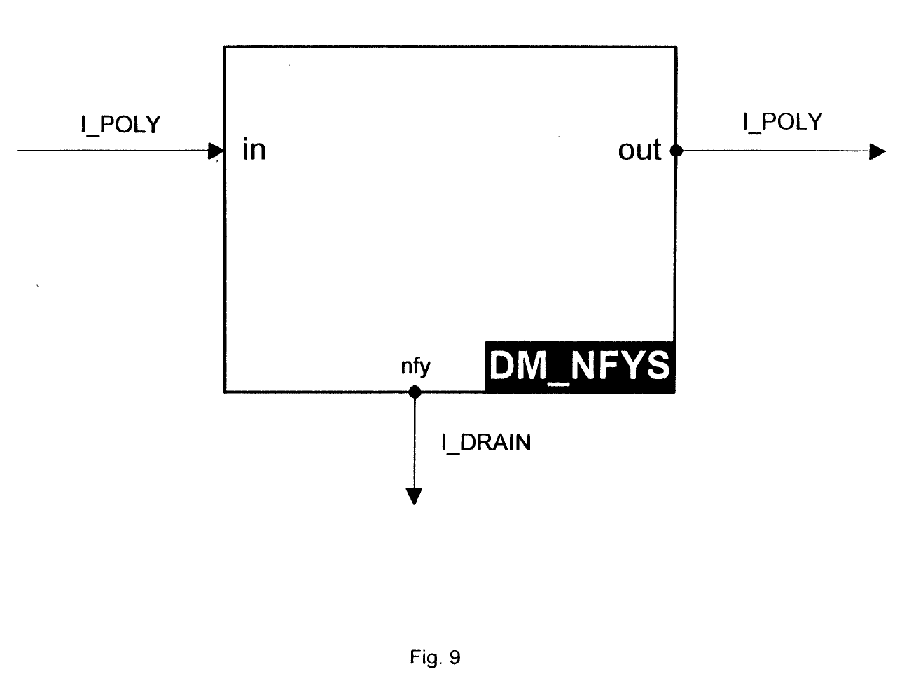

FIG. 9 illustrates the boundary of the inventive DM_NFYS part.

DM_NFYS passes all operations received from the in terminal through the out terminal. If the return status of the operation (passed through out) is equal to a specific status, DM_NFYS generates a notification through the nfy terminal.

The operation status and the notification event ID are set as properties on DM_NFYS.

DM_NFYS always returns the status returned from the out operation. The return status from nfy is ignored.

12. Boundary

12.1. Terminals

Terminal “in” with direction “In” and contract I_POLY. Note: v-table, synchronous, infinite cardinality All operations received on this terminal are forwarded through out.

Terminal “out” with direction “Out” and contract I_POLY. Note: v-table, synchronous, cardinality 1 All operations received from the in terminal are forwarded out through this terminal.

Terminal “nfy” with direction “Out” and contract I_DRAIN. Note: v-table, synchronous, cardinality 1 Depending on the return status of the operation passed through out, DM_NFYS may generate a notification through this terminal.

12.2. Events and Notifications

| Outgoing | | |
|---|---|---|
| Event | Bus | Notes |
| (ev_id) | CMEVENT | This notification is generated |
| | _HDR | by DM_NFYS if the return |
| | | status of the operation |
| | | forwarded through out is |
| | | equal to stat. |
| | | The event is sent with the |
| | | CMEVENT_HDR bus and |
| | | CMEVT_A_SYNC_ANY and |
| | | CMEVT_A_SELF_CONTAINE |
| | | D attributes. The event is |
| | | allocated on the stack. |

12.3. Special Events, Frames, Commands or Verbs

None.

12.4. Properties

Property “stat” of type “UINT32”. Note: Return status that determines if DM_NFYS should generate a notification through its nfy terminal. If the return status of the operation forwarded through out is equal to the value of this property, DM_NFYS generates an ev_id notification. Default is CMST_OK.

Property “ev_id” of type “UINT32”. Note: ID of the notification that DM_NFYS generates through its nfy terminal. Default is EV_NULL (no notifcation is generated).

13. Internal Structure

DM_NFYS is an assembly that is built entirely out of DriverMagic library parts. It is comprised of a “Distributor for Service” (DSV), which forwards unserviced operations to a specific terminal, a “Poly to Drain Adapter” (P2D) that converts I_POLY operations into events, an “Event Notifier” (NFY), which generates a notification when an specific event is received, and an “Event Stopper” (DST) which terminates the event flow from NFY.

Operations received on in are passed through the out terminal. If the return status of the operation is equal to the stat property, the operation is forwarded to P2D. P2D converts the operation call into an EV_REQ_POLY_CALL event. This event is passed to NFY which generates an ev_id notification and passes it out the nfy terminal. The EV_REQ_POLY_CALL event is then passed to DST where it is consumed.

If the return status of the forwarded operation is not equal to stat, the status is returned back to the caller and no further operation is needed.

14. Subordinate's Responsibilities

14.1. DSV—Distributor for Service

1. Forwards incoming operation to out2 if the operation is not serviced by out1.

14.2. P2D—Poly to Drain Adapter

1. Convert operation calls into operation events (EV_REQ_POLY_CALL).

14.3. NFY—Event Notifier

1. Generates an event through aux when a specific event is received on in. The input event is forwarded through out either before or after the genereated event is sent through aux.

14.4. DST—Event Stopper

1. Terminate the event flow by returning a specified status (e.g., CMST_OK).

15. Dominant's Responsibilities

15.1. Hard Parameterization of Subordinates

| Part | Property | Value |
|---|---|---|
| nfy | trigger_ev | EV_REQ_POLY_CALL |
| dsv | hunt_if_match | TRUE |

15.2. Distribution of Properties to the Subordinates

| Property | | | |
|---|---|---|---|
| Name | Type | Dist | To |
| stat | UINT32 | group | dsv.hunt_stat |
| stat | UINT32 | group | dst.ret_s |
| ev_id | UINT32 | redir | nfy.pre_ev |

DM_NFYB—Bi-Directional Notifier

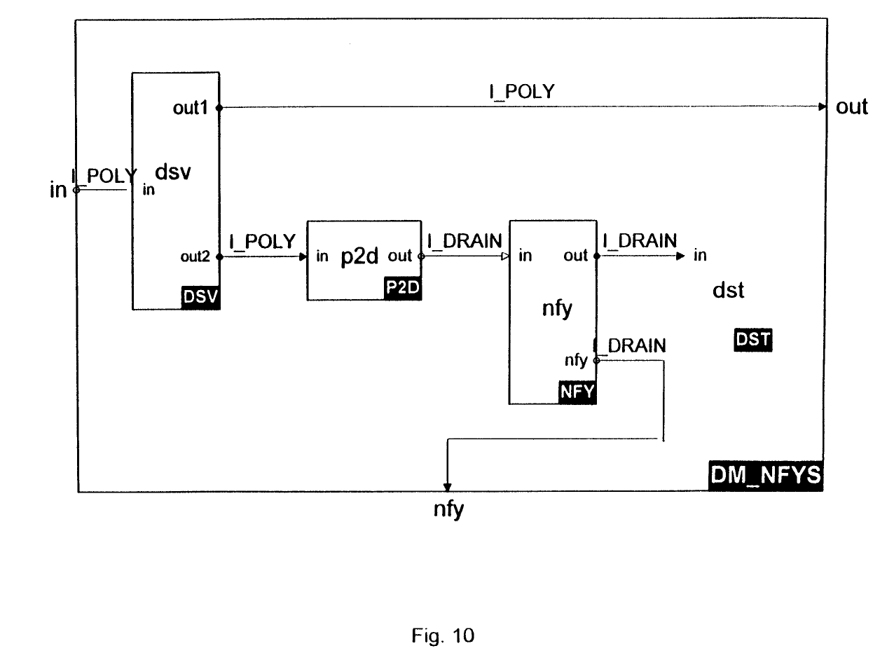

FIG. 10 illustrates the boundary of the inventive DM_NFYB part.

DM_NFYB watches the event flow on its in and out terminals for particular event(s) (i.e., trigger) to come. All events that are received on one terminal are passed to the opposite terminal.

When the trigger event is received, a notification can be sent out the nfy terminal before and/or after passing the event through the opposite terminal.

16. Boundary

16.1. Terminals

Terminal “in” with direction “Bidir” and contract I_DRAIN. Note: All incoming events are forwarded to the out terminal. The status returned is the one returned by the operation on the out terminal. This terminal is unguarded and can be connected when the part is active.

Terminal “out” with direction “Bidir” and contract I_DRAIN. Note: All incoming events are forwarded to the in terminal. The status returned is the one returned by the operation on the in terminal. This terminal is unguarded and can be connected when the part is active.

Terminal “nfy” with direction “out” and contract I_DRAIN. Note: Notifications that a trigger event has been received on either terminal are sent through here. This terminal can be connected when the part is active.

16.2. Events and Notifications

All events received on in terminal are forwarded to out terminal and visa versa, raising up to two notifications: one before and after the forwarding.

16.3. Special Events, Frames, Commands or Verbs

None.

16.4. Properties

Property “trigger_ev” of type “uint32”. Note: Trigger event ID This property is mandatory.

Property “in_pre_ev” of type “uint32”. Note: Pre-notification event ID in response to receiving trigger_ev on the in terminal. Set to EV_NULL to disable issuing a pre-notification. Default: EV_NULL.

Property “in_post-ev” of type “uint32”. Note: Post-notification event ID in response to receiving trigger_ev on the in terminal. Set to EV_NULL to disable issuing a post-notification. Default: EV_NULL.

Property “out_pre_ev” of type “uint32”. Note: Pre-notification event ID in response to receiving trigger_ev on the out terminal. Set to EV_NULL to disable issuing a pre-notification. Default: EV_NULL.

Property “out_post_ev” of type “uint32”. Note: Post-notification event ID in response to receiving trigger ev on the out terminal. Set to EV_NULL to disable issuing a post-notification. Default: EV_NULL.

17. Internal Definition

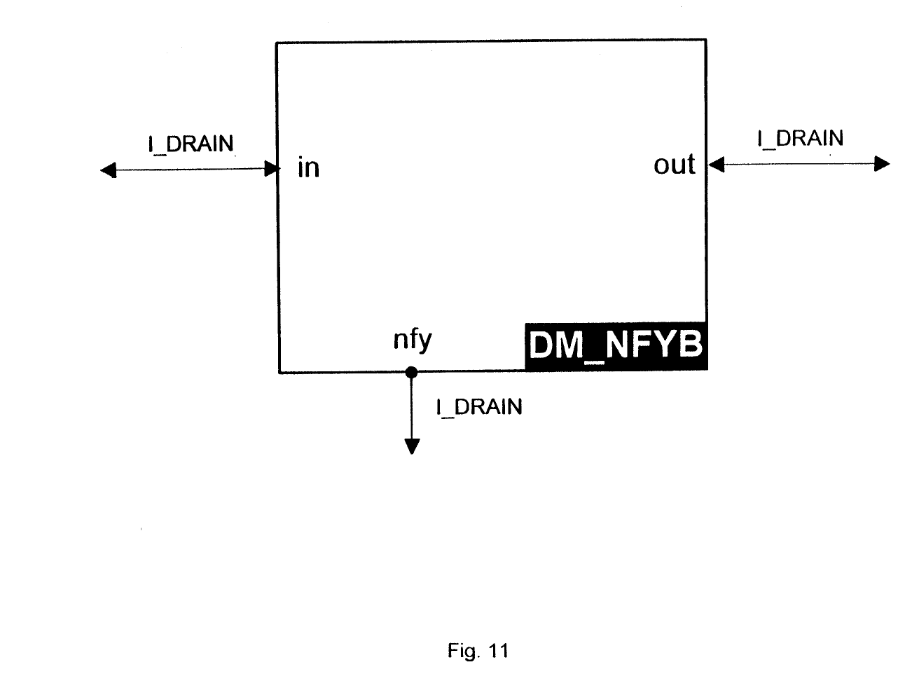

FIG. 11 illustrates the internal structure of the inventive DM_NFYB part.

DM_NFYB is an assembly that is built entirely out of DriverMagic library parts. It is composed of two Bi-directional Splitters (DM_BSP) and two Event Notifiers (DM_NFY).

18. Subordinate's Responsibilities

18.1. DM_BSP—Bi-Directional Splitter

The two DM_BSP parts provide the necessary plumbing to connect DM_NFYB's bi-directional inputs to the DM_NFY's unidirectional input and output.

18.2. DM_NFY—Event Notifier

Each of the DM_NFY parts implements the event notification functionality for a single direction (in → out and out → in). When the trigger event is received, one or two notifications as specified by the xxx.pre_ev and xxx.post_ev properties are sent out the nfy terminal.

19. Dominant's Responsibilities

19.1. Hard Parameterization of Subordinates

None.

19.2. Distribution of Properties to Subordinates

| Property name | Type | Dist | To |
|---|---|---|---|
| trigger_ev | uint32 | group | in.trigger_ev, |
| | | | out.trigger_ev |
| in_pre_ev | uint32 | redir | in.pre_ev |
| in_post_ev | uint32 | redir | in.post_ev |
| out_pre_ev | uint32 | redir | out.pre_ev |
| out_post_ev | uint32 | redir | out.post_ev |

Adapters

DM_P2D—Poly-to-Drain Adapter

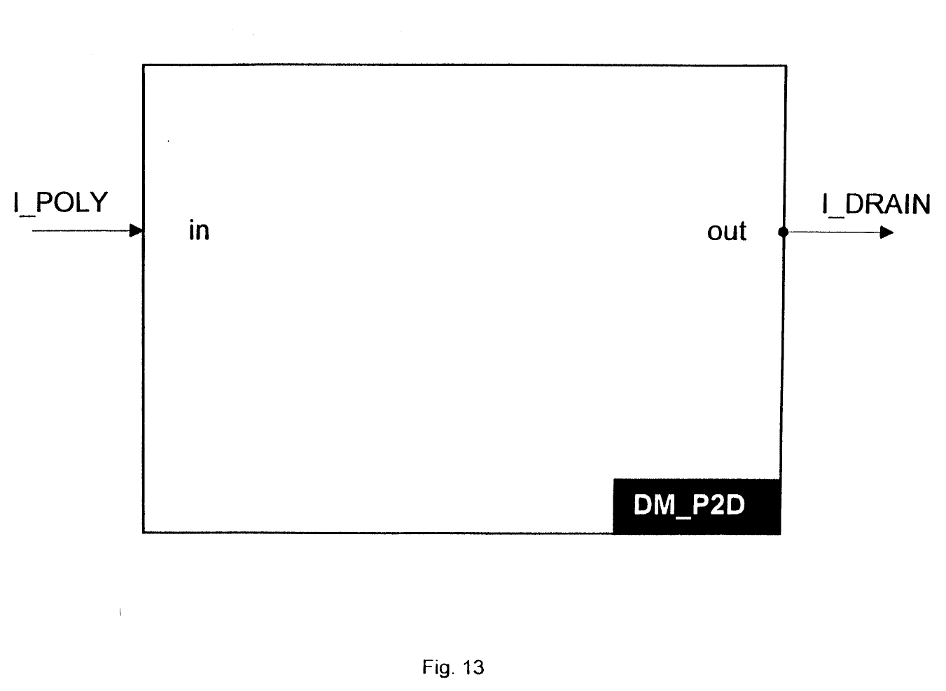

FIG. 13 illustrates the boundary of the inventive DM_P2D part.

DM_P2D converts I_POLY v-table interface operations to EV_REQ_POLY_CALL events. DM_P2D translates an operation call to an event by setting up an event control block, which describes the operation call. The control block contains all the information necessary to reconstruct the call (contract ID, physical mechanism of the operation call, the operation ID of the operation that was called and the operation bus passed with the call). This control block is sent out as a synchronous event.

DM_P2D also enforces that the correct contract ID and synchronicity is supplied on an attempt to connect to its in input. The expected contract ID and synchronicity are specified through the property's expected_cid and expected_sync respectively. This allows the owner of DM_P2D to protect against the connection of a wrong terminal.

1. Boundary

1.1. Terminals

Terminal “in” with direction “in” and contract I_POLY. Note: v-table, infinite cardinality, synchronous All operations on this terminal generate an EV_REQ_POLY_CALL event.

Terminal “out” with direction “out” and contract I_DRAIN. Note: v-table, cardinality 1, synchronous All EV_REQ_POLY_CALL events are passed out through this terminal.

1.2. Events and Notifications

There are no incoming events.

| Outgoing Event | Bus | Notes |
|---|---|---|
| EV_REQ_POLY_{—} | EV_POLY | All incoming operations on |
| CALL | | in are converted to an |
| | | EV_REQ_POLY_CALL event |
| | | and sent through out. |

1.3. Special Events, Frames, Commands or Verbs

None.

1.4. Properties

Property “expected_cid” of type “UINT32”. Note: This is the contract ID of the terminal that is allowed to be connected to in. When it is 0, the part does not enforce the contract ID. Default is 0.

Property “expected_sync” of type “UINT32”. Note: This is the synchronicity of the terminal that is allowed to be connected to in. Default is CMTRM_S_SYNC.

2. Encapsulated Interactions

None.

3. Specification

4. Responsibilities

4. Enforce that the contract ID and synchronicity of the counter terminal of in is the same as the one specified by the expected-cid and expected sync properties respectively.

5. Convert all I_POLY operations into EV_REQ_POLY_CALL events and send them out through the out output terminal.

5. Theory of Operation

5.1. State Machine

None.

5.2. Main Data Structures

DM_P2D uses the following event control block for the EV_REQ_POLY_CALL events it generates:

EVENTX (EV_POLY, EV_REQ_POLY_CALL, CMEVT_A_AUTO,

CMEVT_UNGUARDED)

| // poly event specific data | | |
|---|---|---|
| dword | cid | ; // contract id |
| uint16 | mech | ; // physical mechanism |
| uint32 | op_id | ; // operation id |
| void | *busp | ; // pointer to operation bus |

END_EVENTX

5.3. Mechanisms

Enforcement of Connection Contracts to in

When DM_P2D is connected on in, it compares the contract ID and synchronicity provided on the connection with its expected_cid and expected_sync properties respectively. If either of the two do not match, DM_P2D will refuse the connection.

Conversion of in Operations Into EV_REQ_POLY_CALL Events

When DM_P2D is invoked on one of its in operations, DM_P2D initializes an event control block and sends an EV_REQ_POLY_CALL event through the terminal out. The header of the control block contains the event ID (EV_REQ_POLY_CALL), the size of the control block, and attributes (depends upon successful duplication of the operation bus pointer).

The control block also contains information about the operation call. This includes the physical mechanism used (always v-table) and the contract ID (expected_cid). The ID of the operation invoked and the pointer to the operation bus are also provided. The operation bus is not interpreted by DM_P2D; it is treated as an externally supplied context. After DM_P2D initializes the control block, it sends the event through the out terminal.

The attributes of the events generated by DM_P2D depend upon two variables. The synchronicity of the counter terminal and whether or not the operation bus is pool allocated. The operation bus is pool allocated if it is allocated on the heap using the cm bus alloc function or the bus alloc macro.

The table below describes the attributes of the EV_REQ_POLY_CALL event that DM_P2D generates. The first column is the synchronicity of the counter terminal of the in terminal. The intersections in the table are the attributes of the event. All events have the CMEVT_A_CONST attribute.

| Terminal | Pool allocated | Non pool allocated |
|---|---|---|
| synchronicity | bus | bus |
| Synchronous | CMEVT_A_SYNC | CMEVT_A_SYNC |
| Asynchronous | CMEVT_A_SYNC | Invalid |
| | _ANY and | |
| | CMEVT_A_SELF_{—} | |
| | OWNED | |
| Both | CMEVT_A_SYNC | CMEVT_A_SYNC |

5.4. Use Cases

Operation Invoked on in

1. The counter terminal of in invokes one of its operations. The call comes to one of in operation handlers (Op1-Op64).

2. DM_P2D generates an EV_REQ_POLY_CALL event. The event contains the following information:

a. the event ID (EV_REQ_POLY_CALL)

b. the contract ID (specified by the property expected_cid)

c. the physical mechanism (CMTRM_M₁₃ VTBL)

d. the operation ID

e. the operation bus

f. event attributes (as described in the above table)

3. DM_P2D sends the event through its out output.

DM_D2P—Drain-to-Poly Adapter

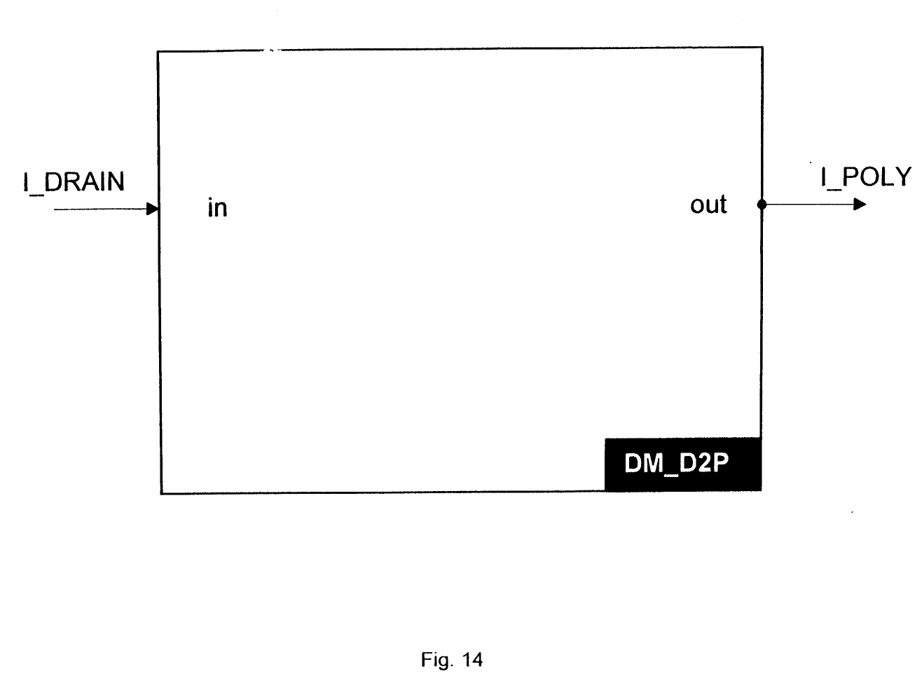

FIG. 14 illustrates the boundary of the inventive DM_D2P part.

DM_D2P converts incoming EV_REQ_POLY_CALL events into operation calls through the I_POLY out terminal. DM_D2P translates an incoming EV_REQ_POLY_CALL event to an operation call by examining the event. The event fully describes the operation call and contains all the information necessary to reconstruct the call (contract ID, physical mechanism, the operation ID and the operation bus passed with the call). This information is used by DM_D2P to reconstruct the operation call through its out output.

DM_D2P also enforces that the correct contract ID is supplied on an attempt to connect to its out output. The expected contract ID is specified through a property called expected cid. This allows the owner of DM_D2P to protect against the connection of a wrong terminal.

6. Boundary

6.1. Terminals

Terminal “in” with direction “In” and contract I_DRAIN. Note: v-table, infinite cardinality, synchronous This terminal receives all the incoming events for DM_D2P.

Terminal “out” with direction “Out” and contract I_POLY. Note: v-table, cardinality 1, synchronous This terminal is used to invoke operations as described in the event EV_REQ_POLY_CALL.

6.2. Events and Notifications

| Incoming Event | Bus | Notes |
|---|---|---|
| EV_REQ_POLY_CA | EV_POLY | All incoming events of |
| LL | | this type on in are |
| | | converted to I_POLY |
| | | operation calls on out. |
| | | Any other events are |
| | | ignored. |

6.3. Special Events, Frames, Commands or Verbs

None.

6.4. Properties

Property “expected_cid” of type “UINT32”. Note: This is the contract ID of the terminal that is allowed to be connected to out. When it is 0, the part does not enforce the contract ID. Default is 0.

7. Encapsulated Interactions

None.

8. Specification

9. Responsibilities

1. Enforce that the contract ID of the counter terminal of out is the same as the one specified by the expected cid property.

2. Convert all incoming EV_REQ_POLY_CALL events into out operation calls.

10. Theory of Operation

10.1. State Machine

None.

10.2. Main Data Structures

DM_D2P interprets the following event control block for the EV_REQ_POLY_CALL events it receives:

EVENTX (EV_POLY, EV_REQ_POLY_CALL, CMEVT_A_AUTO,

CMEVT_UNGUARDED)

| // poly event specific data | | |
|---|---|---|
| dword | cid | ; // contract id |
| uint16 | mech | ; // physical mechanism |
| uint32 | op_id | ; // operation id |
| void | *busp | ; // pointer to operation bus |

END_EVENTX

10.3. Mechanisms

Enforcement of Connection Contracts to Out

DM_D2P has a property called expected-cid. This property lets its owner parameterize DM_D2P to specify that terminals with a particular contract may connect to out. On an attempt to connect to out, the contract ID of the counter terminal is saved so that only the set of operations it specifies can be invoked.

Conversion of EV_REQ_POLY_CALL Events Into Out Operation Calls

When DM_D2P receives an EV_REQ_POLY_CALL event, DM_D2P reconstructs the operation call described by the event. The event contains information about the operation. This includes the physical mechanism used (always v-table in this case), the contract ID, the ID of the operation to invoke and the pointer to the operation bus. The operation bus is not interpreted by DM_D2P; it is treated as an externally supplied context.

Upon receiving an EV_REQ_POLY_CALL event, DM_D2P validates the event for the proper information. DM_D2P then uses the operation ID as an operation index and invokes it. The operation bus from the event is passed with the operation call. DM_D2P will consume all events it receives.

10.4. Use Cases

Event Sent Through in Input

The counter terminal of in sends an event to DM_D2P. The raise operation handler of DM_D2P is called and receives a pointer to an event control block.

1. DM_D2P validates the event for proper information:

a. size>=sizeof (EV_POLY)

b. event ID=EV_REQ_POLY_CALL

c. contract ID=value specified by the property expected_cid

d. mechanism=CMTRM_M_VTBL

e. operation ID is between 1 and 64

2. After validation, DM_D2P uses the operation ID minus one as an operation index and invokes the operation through out. The operation is invoked with the operation bus received in the event.

3. DM_D2P consumes the event, freeing the event bus if it is marked as self-owned.

DM_NP2D, DM_ND2P and DM_BP2D—Poly-to-Drain and Drain-to-Poly Adapters

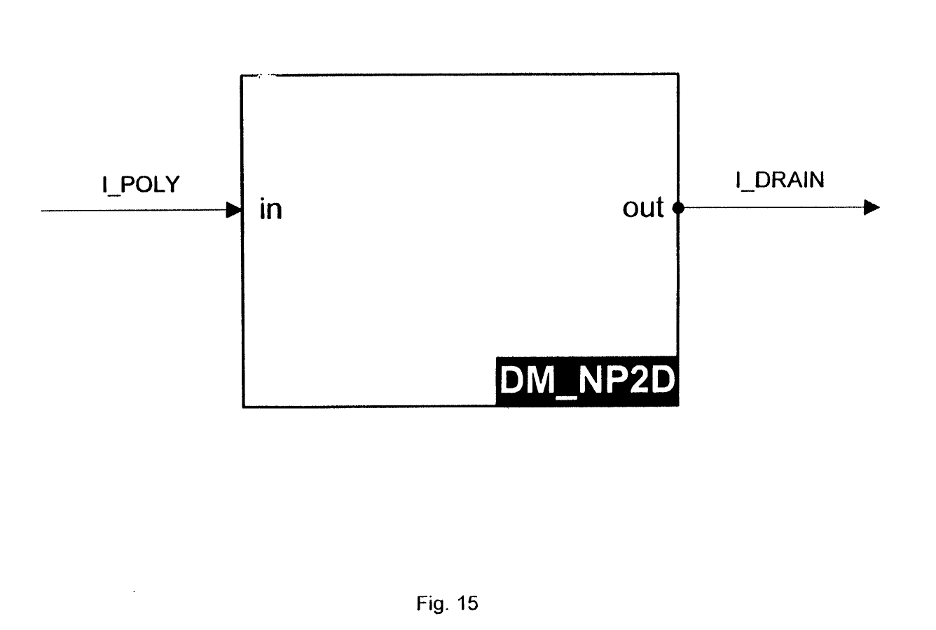

FIG. 15 illustrates the boundary of the inventive DM_NP2D part.

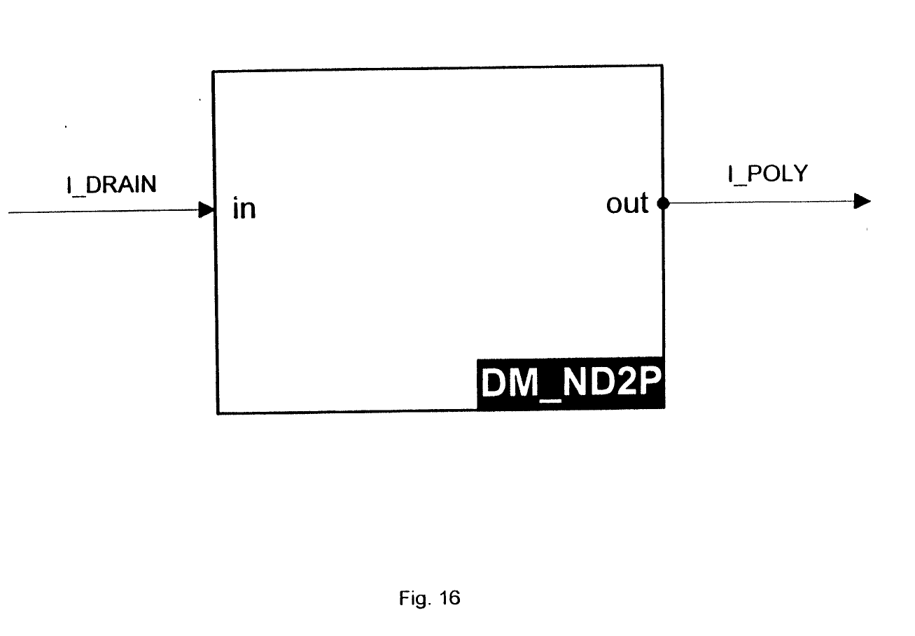

FIG. 16 illustrates the boundary of the inventive DM_ND2P part.

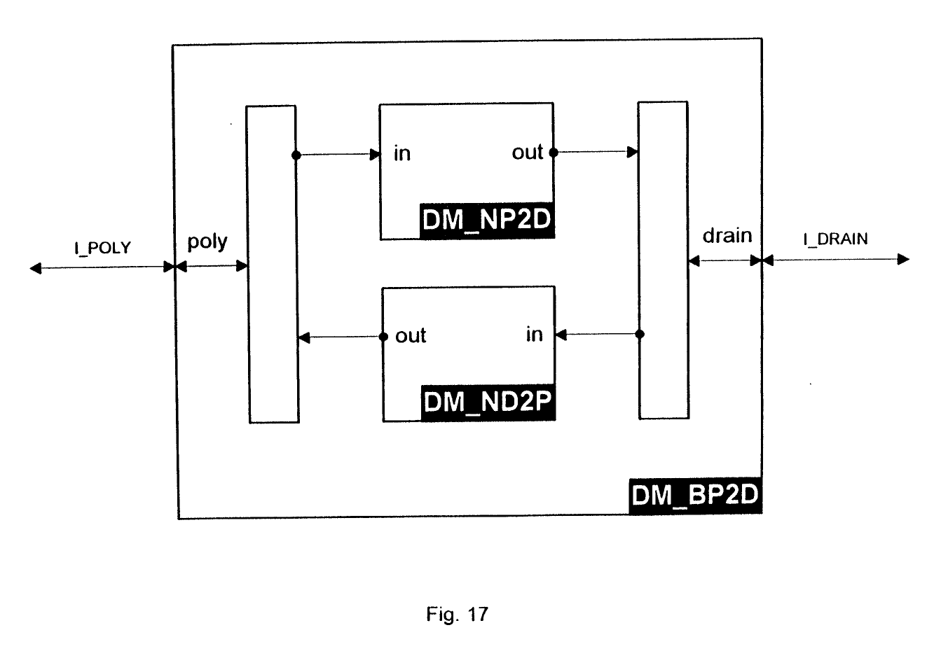

FIG. 17 illustrates the boundary of the inventive DM_BP2D part.

DM_NP2D, DM_ND2P and DM BP2D constitute a set of adapters that convert a v-table interface into an event (I_DRAIN) interface and vice-versa. The set of events is generated by adding the index of the v-table operation to a base value that is provided as a property.

The adapters propagate the operation data when converting from one interface to the other. For this reason, the operation data must be identical between the two interfaces.

When converting from a v-table interface to event interface, the adapters have an option by which return data from the outgoing event may be copied to the original operation bus before returning from the call.

11. Boundary

11.1. Terminals (DM_NP2D)

Terminal “in” with direction “In” and contract I_POLY. Note: All operations on this terminal are converted into events with event IDs of ev-base plus the v-table index of the operation being invoked.

Terminal “out” with direction “Out” and contract I_DRAIN. Note: All converted events are passed out this terminal.

11.2. Terminals (DM_ND2P)

Terminal “in” with direction “In” and contract I_DRAIN. Note: This terminal receives all of the incoming events.

Terminal “out” with direction “Out” and contract I_POLY. Note: This terminal is used to invoke operations. The operation that is invoked is calculated from the event ID received on in less the value of the ev-base property. CMST_NOT_SUPPORTED is returned for unrecognized operations.

11.3. Terminals (DM_BP2D)

Terminal “poly” with direction “Bidir” and contract I_POLY. Note: Incoming operations are converted to events and forwarded out the out terminal.

Terminal “drain” with direction “Bidir” and contract I_DRAIN. Note: All converted events are passed out this terminal. Events received on this terminal are converted to operation calls and invoked out the in terminal.

11.4. Events and Notifications

The events that are received and generated contain the following data:

1. CMEVENT_HDR where the event id is in the range (ev_base+0) . . . (ev_base+63)

2. Operation data

11.5. Special Events, Frames, Commands or Verbs

None.

11.6. Properties (DM_NP2D)

Property “ev_base” of type “uint32”. Note: Event base used to generate event IDs for outgoing events and extract operation IDs for incoming operations. The default is 0x01000800.

Property “ev_attr” of type “uint32”. Note: Event attributes to be set for outgoing events. The CMEVT_A_ASYNC_CPLT attribute must not be set. The default is CMEVT_A_SYNC ANY.

Property “bus_sz” of type “uint32”. Note: Specifies the size of the operation bus received on I_POLY operation calls. The default is 0.

Property “copy_out” of type “uint32”. Note: (Boolean) When TRUE, the contents of the event bus following the CMEVENT_HDR portion are copied to the original operation bus before returning. The default is TRUE.

11.7. Properties (DM_ND2P)

Property “n_ops” of type “uint32”. Note: Specifies the maximum number of operations that can be invoked out the adapter's I_POLY output. This property is mandatory.

Property “ev_base” of type “uint32”. Note: Event base used to generate event IDs for outgoing events and extract operation IDs for incoming operations. The default is 0x00000800.

11.8. Properties (DM_BP2D)

Property “n_ops” of type “uint32”. Note: Specifies the maximum number of operations that can be invoked out the adapter's I_POLY output. This property is mandatory.

Property “ev_base” of type “uint32”. Note: Event base used to generate event IDs for outgoing events and extract operation IDs for incoming operations. The default is 0x00000800.

Property “ev_attr” of type “uint32”. Note: Event attributes to be set for outgoing events. The CMEVT_A_ASYNC_CPLT attribute must not be set. The default is CMEVT_A_SYNC ANY.

Property “bus sz” of type “uint32”. Note: Specifies the size of the operation bus received on I_POLY operation calls. The default is 0.

Property “copy out” of type “uint32”. Note: (Boolean) When TRUE, the contents of the event bus following the CMEVENT_HDR portion are copied to the original operation bus before returning. The default is TRUE.

12. Encapsulated Interactions

None.

13. Specification

14. Responsibilities

1. Convert all incoming operation calls to events and forward out the opposite terminal.

2. Convert all incoming events to operation calls out the opposite terminal.

15. Theory of Operation

15.1. State Machine

None.

15.2. Mechanisms

Conversion of I_POLY Calls to Events

When either poly-to-drain adapter is invoked on its I_POLY input, it allocates an event bus with a size of CMEVENT_HDR+the value of the bus_sz property. The event ID is calculated from the value of the ev-base property plus the v-table index of the operation being called. The event attributes are set to the value of the ev_attr property.

The contents of the incoming bus are copied to the event bus and the event is sent out the I_DRAIN output. If the cpy_out property is TRUE, the contents of the event bus are copied back to the operation bus before returning.

Conversion of Events to I_POLY Operations

When the drain-to-poly adapter is invoked on its I_DRAIN input, it invokes the operation on its I_POLY output specified by the value of the incoming event ID less the value of the ev_base property. The adapter passes a pointer to the event bus data following the CMEVENT_HDR portion of the incoming event bus as the operation bus. If the incoming event bus is CMEVENT_HDR, DM_ND2P passes a NULL operation bus when invoking the operation through its I_POLY output.

DM_D2M—I_DIO to Memory Adapter

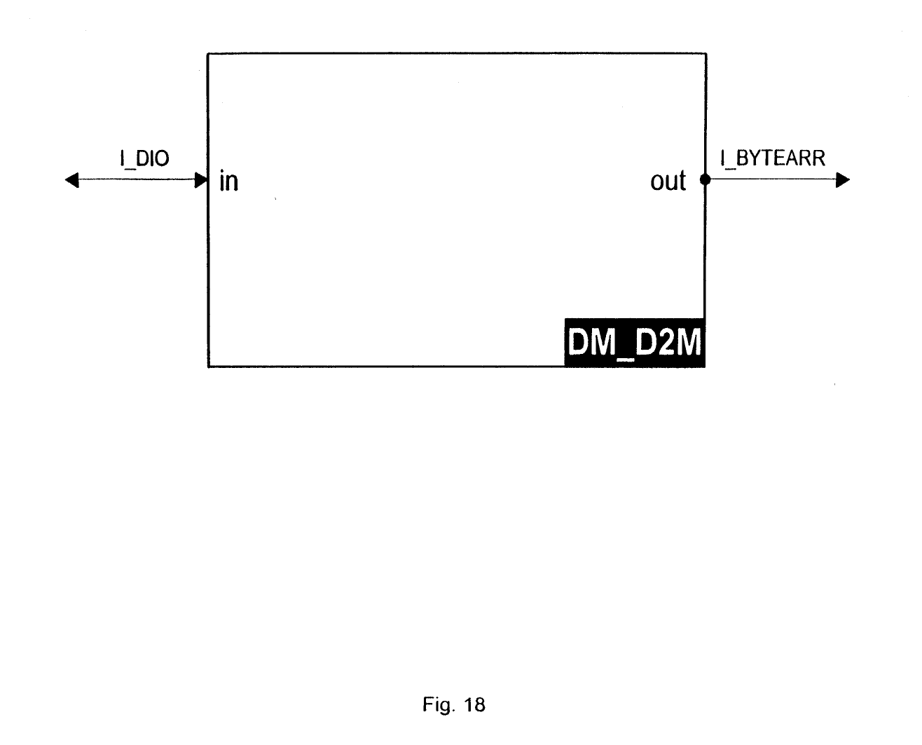

FIG. 18 illustrates the boundary of the inventive DM_D2M part.

DM_D2M is an adapter that translates I_DIO read and write operations invoked on its in terminal into I_BYTEARR read and write operations that are passed through the out terminal.

All other I_DIO operations invoked through the in terminal are not supported (CMST_NOT_SUPPORTED) unless otherwise specified (through a property).

DM_D2M is used for a simple translation of device read and write operations into memory byte-array operations. Most of the I_DIO operation parameters are lost in the translation. If greater functionality is desired, DM_D2M should not be used (instead use the I_DIO interface directly).

16. Boundary

16.1. Terminals

Terminal “in” with direction “Bidir” and contract in: I_DIO out: I_DIO_C. Note: v-table, cardinality 1, synchronous I_DIO read and write operations invoked through this terminal are translated into I_BYTEARR operations and are passed through the out terminal. All other I_DIO operations are not supported (CMST_NOT_SUPPORTED) unless otherwise specified by the support_open close property. Since all operations complete synchronously, the output side of in is not used. This terminal is ungaurded.

Terminal “out” with direction “Out” and contract I_BYTEARR. Note: v-table, cardinality 1, synchronous All read and write operations invoked through in are translated into I_BYTEARR operations and are passed through this terminal.

16.2. Events and Notifications

None.

16.3. Special Events, Frames, Commands or Verbs

None.

16.4. Properties

Property “support_open_close” of type “UINT32”. Note: If TRUE_I_DIO.open, I_DIO.close and I_DIO.cleanup are supported (i.e., DM_D2M returns CMST_SUBMIT on preview and CMST_OK on submit). Default is TRUE.

17. Encapsulated Interactions

None.

18. Specification

19. Responsibilities

Translate I_DIO.read and I_DIO.write operations invoked through the in terminal into I_BYTEARR.read and I_BYTEARR.write operations and pass them through out. Fail all other I_DIO operations invoked through the in terminal with CMST_NOT_SUPPORTED unless otherwise specified by the support-open_close property.

20. Theory of Operation

20.1. Mechanisms

Translation of I_DIO operations into I_BYTEARR operations DM_D2M translates the following operations:

| | |
|---|---|
| I_DIO.read→ | I_BYTEARR.read |
| I_DIO.write | → I_BYTEARR.write |

All other I_DIO operations are not supported unless otherwise specified by the support open close property.

DM_D2M uses the fields of the incoming B_DIO bus to fill in the fields for the B_BYTEARR bus without modification and makes the call. When the I_BYTEARR operation returns, DM_D2M returns the status from the operation.

DM_DIO2IRP—Device I/O to IRP Adapter

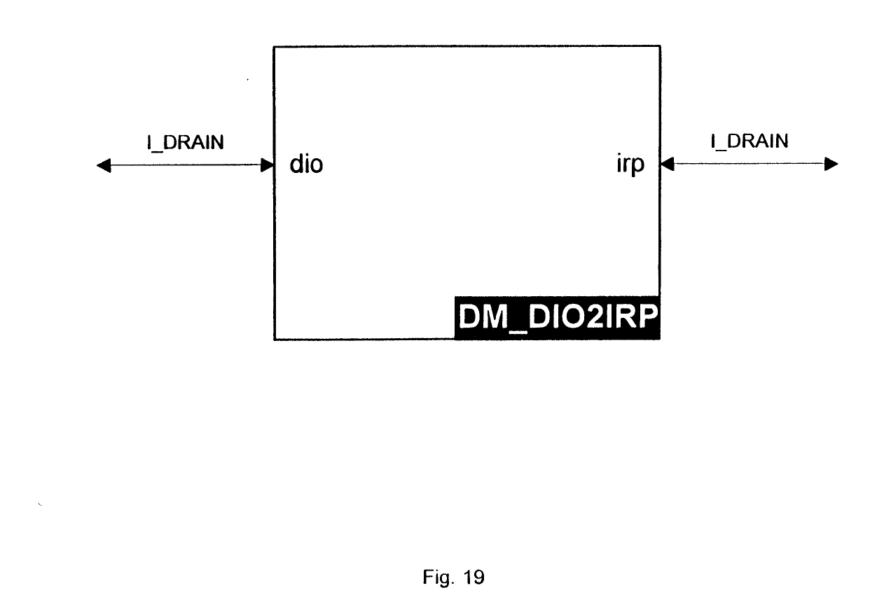

FIG. 19 illustrates the boundary of the inventive DM_DIO2IRP part.

DM_DIO2IRP is an adapter that converts incoming EV_DIO_RQ_XXX requests to EV_REQ_IRP requests suitable for submission to Windows NT/WDM kernel-mode drivers.

When submitting a request, DM_DIO2IRP either allocates a new IRP or uses the IRP that is provided with the EV_DIO_RQ_XXX request. When allocating a new IRP, DM_DIO2IRP determines the number of stack locations to provide based on the current values of its properties and initializes the IRP with the appropriate values provided in the EV_DIO_RQ_XXX request.

21. Boundary

21.1. Terminals

Terminal “dio” with direction “Bidir” and contract I_DRAIN. Note: Input for device I/O (EV DIO_RQ_XXX) requests and output for the completion events of those requests that are processed asynchronously. DM_DIO2IRP converts the request into an EV_REQ_IRP request (allocating and initializing an IRP if one is not provided) and forwards the request to its irp output.

Terminal “irp” with direction “Bidir” and contract I_DRAIN. Note: DM_DIO2IRP sends converted Device I/O requests in the form of EV_REQ_IRP events out this terminal. DM_DIO2IRP receives EV_REQ_IRP events on this terminal when asynchronous IRPs have been completed.

21.2. Events and Notifications

| Incoming Event | Bus | Notes |
|---|---|---|
| EV_DIO_RQ_OPEN | B_EV_D | This event is received on |
| | IO | the dio terminal. |
| | | DM_DIO2IRP requires this |
| | | event to contain a valid IRP |
| | | since most drivers require |
| | | this request to be |
| | | generated by the operating |
| | | system. |
| EV_DIO_RQ_CLOSE | B_EV_D | This event is received on |
| | IO | the dio terminal. |
| | | DM_DIO2IRP requires this |
| | | event to contain a valid IRP |
| | | since most drivers require |
| | | this request to be |
| | | generated by the operating |
| | | system. |
| EV_DIO_RQ_CLEA | B_EV_D | This event is received on |
| NUP | IO | the dio terminal. |
| | | DM_DIO2IRP requires this |
| | | event to contain a valid IRP |
| | | since most drivers require |
| | | this request to be |
| | | generated by the operating |
| | | system. |
| EV_DIO_RQ_READ | B_EV_D | When this event is received |
| | IO | on the dio terminal, |
| | | DM_DIO2IRP generates an |
| | | IRP with a major function |
| | | code of IRP_MJ_READ. |
| EV_DIO_RQ_WRITE | B_EV_D | When this event is received |
| | IO | on the dio terminal, |
| | | DM_DIO2IRP generates an |
| | | IRP with a major function |
| | | code of IRP_MJ_WRITE. |
| EV_DIO_RQ_IOCTL | B_EV_D | When this event is |
| | IO | received, DM_DIO2IRP |
| | | generates an IRP with a |
| | | major function code of |
| | | IRP_MJ_DEVICE_CONTROL |
| EV_DIO_RQ_INTE | B_EV_D | When this event is |
| RNAL_IOCTL | IO | received, DM_DIO2IRP |
| | | generates an IRP with a |
| | | major function code of |
| | | IRP_MJ_INTERNAL_DEVIC |
| | | E_CONTROL. |

Note: DM_DIO2IRP sends completion events for EV_DIO_RQ_XXX requests out the dio terminal.

| Outgoing Event | Bus | Notes |
|---|---|---|
| EV_REQ_IRP | B_EV_IR | DM_DIO2IRP sends this |
| | P | event out its irp terminal to |
| | | submit the generated IRP. |

Note: DM_DIO2IRP receives EV_REQ_IRP completion events on its irp terminal.

21.3. Special Events, Frames, Commands or Verbs

None.

21.4. Properties

Property “n_stk_loc” of type “UINT32”. Note: Number of stack locations to reserve in new IRP. This property is optional and activetime. The default value is 0.

Property “dev_objp” of type “UINT32”. Note: Pointer to device object to use when allocating new IRPs. This property is used only when n_stk_loc is zero. This property is optional and activetime. The default value is 0.

Property “force_new_irp” of type “UINT32”. Note: Boolean: When TRUE, new IRPs are allocated and used regardless if an IRP is provided with the EV_DIO_RQ_XXX event. When FALSE, DM_DIO2IRP allocates and uses a new IRP only if one is not provided with the EV_DIO_RQ_XXX event. The default is FALSE.

22. Encapsulated Interactions

DM_DIO2IRP is designed to operate within a Windows NT/WDM kernel mode driver. It uses the following system services when allocating new IRPs:

IoAllocateIrp( )

IoGetNextIrpStackLocation( )

IoFreeIrp( )

23. Specification

24. Responsibilities

Convert EV_DIO_RQ_XXX requests received on the dio terminal into EV_REQ_IRP requests and send out the irp terminal.

Refuse EV_DIO_RQ_OPEN, EV_DIO_RQ_CLOSE, and EV_DIO_RQ_CLEANUP when no IRP is provided.

Refuse EV_DIO_RQ_XXX request if no IRP provided and the n_stk_loc and dev_objp properties are 0.

Set the async completion attribute of the EV_REQ_IRP request based on the completion nature of the EV_DIO_RQ_XXX request.

Send EV_DIO_RQ_XXX completion event out dio when EV_REQ_IRP event is received on irp.

25. Theory of Operation

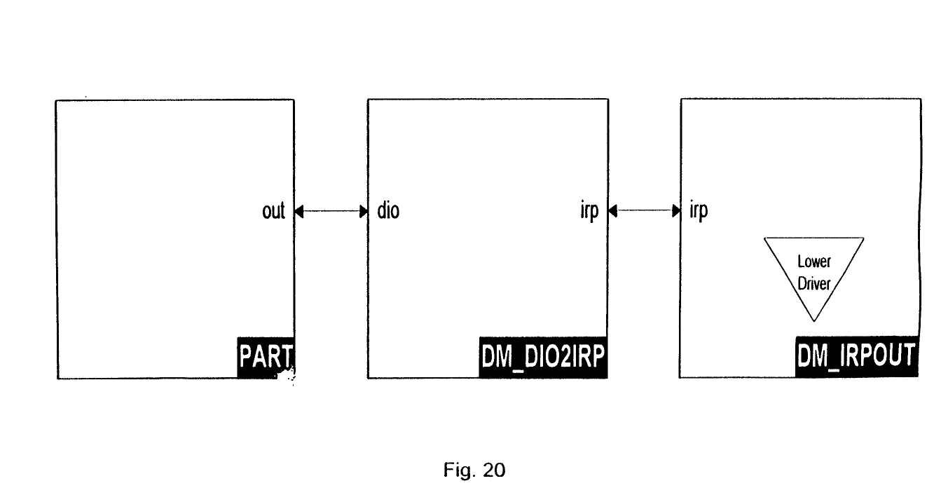

FIG. 20 illustrates an advantageous use of the inventive DM_DIO2IRP part.

25.1. State Machine

None.

25.2. Mechanisms

Allocating IRPs

If DM_DIO2IRP receives an EV_DIO_RQ_XXX request and there is no IRP provided, DM_DIO2IRP will allocate an IRP for the outgoing EV_REQ_IRP request. If an IRP is provided, DM_DIO2IRP uses that IRP when submitting the EV_REQ_IRP request.

If the force_new_irp property is TRUE, DM_DIO2IRP allocates a new IRP regardless if an IRP is provided with the EV_DIO_RQ_XXX request.

Determining if IRP is Available

DM_DIO2IRP checks if the DIO_A_NT_IRP attribute is set in the EV_DIO_RQ_XXX bus to determine if the event contains a valid IRP. If the attribute is set, DM_DIO2IRP interprets the “ctx” field of the event bus as a pointer to a valid NT driver IRP associated with the event.

Determining Number of Stack Locations

DM_DIO2IRP uses one of two methods for determining the number of stack locations to provide when allocating IRPs:

If the n_stk_loc property is non-zero, DM_DIO2IRP reserves the number of stack locations specified by the property.

Otherwise, DM_DIO2IRP uses the device object pointer specified in its dev_objp property to obtain the number of stack locations needed.

If a new IRP is needed and both DM_DIO2IRP's n_stk_loc and dev_objp properties are zero, DM_DIO2IRP fails the EV_DIO_RQ_XXX request.

Completing EV DIO_RQ_XXX Requests

DM_DIO2IRP has no state, so in order to complete asynchronous EV_DIO_RQ_XXX requests, DM_DIO2IRP allocates an extended bus for the outgoing EV_REQ_IRP request. The extended portion of the bus contains the following fields:

(1) A signature so that DM_DIO2IRP can determine if the request was originated by it,

(2) The pointer to the EV_DIO_RQ_XXX event bus, and

(3) A flag specifying if DM_DIO2IRP allocated the IRP so that it may free it when the event completes.

Completion Status Propagation

When DM_DIO2IRP services a synchronous device I/O request, it returns the return status from the EV_REQ_IRP request.

When DM_DIO2IRP services an asynchronous device I/O request, the completion status that it returns comes from the completion status of the EV_REQ_IRP event and not from the IRP itself.

25.3. Use Cases

Submitting Device I/O Requests

DM_DIO2IRP along with DM_IRPOUT is useful when a part needs to initiate and submit a device I/O request to a lower driver, but does not wish to deal with the complexities of allocating, initializing, and completing IRP.

DM_A2K—ASCII to Keystroke Converter

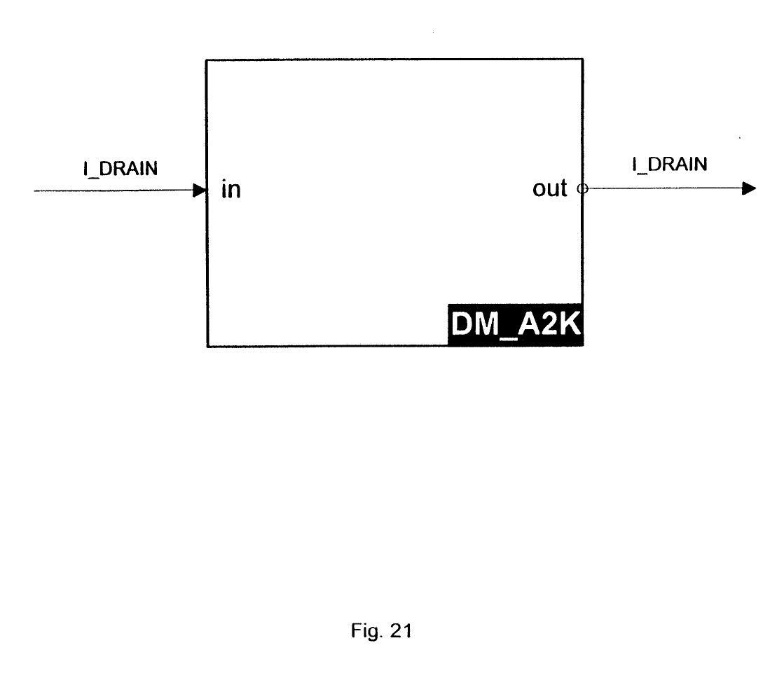

FIG. 21 illustrates the boundary of the inventive DM_A2K part.

DM_A2K converts data that it receives on its input into keystrokes that it sends out its output. Each key specified in the data will result in DM_A2K sending at least two keystrokes out its out terminal (i.e., key down and key up) as if the key were actually pressed on the keyboard. For those keys that require multiple keystrokes (e.g., a capital letter or control key), DM_A2K first outputs the “down” keystrokes for each key followed by the “up” keystrokes in the reverse order.

Before processing any data, DM_A2K sends a request for the current lock state out its out terminal. It uses the response to determine if SHIFT keystrokes need to be generated when outputting capital letters and if NUM LOCK keystrokes need to be generated when outputting keys on the numeric keypad.

By default, DM_A2K does not interpret the data it receives on its input in any way. Each character is converted and output as is, meaning that only those keys that have a direct ASCII representation can be converted. DM_A2K supports only the first 128 ASCII characters.

To provide support for those keys that do not have a direct ASCII representation, DM_A2K defines a simple syntax for describing the keys. The syntax is described later in this document.

26. Boundary

26.1. Terminals

Terminal “in” with direction “In” and contract I_DRAIN (v-table). Note: Input for data that is to be converted to key strokes as if the data was typed on the keyboard.

Terminal “out” with direction “Out” and contract I_DRAIN (v-table). Note: Output for keystroke events and requests for current shift and lock state.

Events and Notifications

| Incoming Event | Bus | Notes |
|---|---|---|
| EV_MESSAGE | B_EV_MS | This event is received on |
| | G | DM_A2K's in terminal. |
| | | It contains data that is |
| | | to be converted to key |
| | | scan codes. |

| Outgoing Event | Bus | Notes |
|---|---|---|
| EV_KBD_EVENT | B_EV_KBD | DM_A2K sends this |
| | | event out its out |
| | | terminal. It contains a |
| | | key scan code and a flag |
| | | indicating whether the |
| | | key is being pressed or |
| | | released. |
| EV_KBD_GET_STATE | B_EV_KBD | DM_A2K sends this |
| | | event out its out |
| | | terminal to request the |
| | | current lock state (i.e., |
| | | CAPS LOCK, NUM |
| | | LOCK, and SCROLL |
| | | LOCK). |

Special Events, Frames, Commands or Verbs

ASCII Representation Syntax

The following tables describe the set of keys that is supported by DM_A2K. The first table provides the string representations for the keys that cannot be specified by a single ASCII character. The second table describes those characters that can be specified by a single ASCII character.

Non-ASCII Keys

| Key Description | ASCII Representation |
|---|---|
| Control Break | CTL-BRK |
| Backspace key | BKS |
| SPACE key | SP |
| Tab | TAB |
| ENTER key | ENTER |
| Left SHIFT key | LSHFT or SHFT |
| Right SHIFT key | RSHFT |
| Left CTL key | LCTL or CTL |
| Right CTL key | RCTL |
| Left ALT key | LALT or ALT |
| Right ALT key | RALT |
| PAUSE key | PAUSE |
| CAPS LOCK key | CAPLK |
| ESC key | ESC |
| PAGE UP key | PUP |
| PAGE DOWN key | PDN |
| END key | END |
| HOME key | HOME |
| LEFT ARROW key | LARW |
| UP ARROW key | UARW |
| RIGHT ARROW key | RARW |
| DOWN ARROW key | DARW |
| PRINT SCREEN key | PRSCR |
| INSERT key | INS |
| DELETE key | DEL |
| Left Windows key (Microsoft | LWIN |
| Natural Keyboard) | |
| Right Windows key (Microsoft | RWIN |
| Natural Keyboard) | |
| Application Key (Microsoft | APP |
| Natural keyboard) | |
| Numeric keypad keys | N0 . . . N9 |
| MULTIPLY key (numeric keypad) | NMUL |
| ADD key (numeric keypad | NADD |
| SEPERATOR key (numeric | NSEP |
| keypad) | |
| SUBTRACT key (numeric keypad) | NSUB |
| DECIMAL key (numeric keypad) | NDEC |
| DIVIDE key (numeric keypad) | NDIV |
| Function keys | F1 . . . F12 |
| NUM LOCK key | NUMLK |
| SCROLL LOCK key | SCRLK |

ASCII Keys

| Description | ASCII Character |
|---|---|
| Number keys | 0 . . . 9 |
| Letter keys | A . . . Z, a . . . z |
| Punctuation and other characters | ' ˜ ! @ # $ % & * ( |
| (space is also in this list) | ) - _ = + { } \| ; : ′ ″ , |
| | < . > / ? |
| Special characters used by | [ ] \ |
| DM_A2K when parsing the ASCII | |
| string. | |

The data received with the EV_MESSAGE event contains the following types of fields:

Literal characters—ASCII characters that are output as is

Special keys—control and special key strokes that don't have ASCII representations

The following table gives a brief description of the different field types and a short example.

| Field Type | Example | Description |
|---|---|---|
| literal | L | A literal is fixed data (ASCII |
| | | character) that is converted |
| | | directly to a scan code without |
| | | further interpretation (except |
| | | for the current caps lock |
| | | state). |
| escape | \×20 | An escape mechanism to |
| literal | \\ | specify literal characters that |
| \<lit> | \[ | are recognized by DM_A2K |
| | \] | when parsing the ASCII string |
| | | (e.g., [, ], \) or control |
| | | characters that do not have |
| | | text representation. |
| | | When the <lit> portion of the |
| | | field is any character except |
| | | ‘x’, DM_A2K declares the |
| | | character as a literal. |
| | | When the first character |
| | | following the ‘\’ is an ‘x’, |
| | | DM_A2K interprets the |
| | | following two characters as |
| | | the hexadecimal equivalent of |
| | | a literal. |
| special key | [ALT-F] | A special key field is an ASCII |
| [<key>] | [CTL-ALT- | representation of key strokes |
| | F] | that either have no ASCII code |
| | [TAB] | (e.g., shift, CTL-ALT-DEL) or |
| | | are commonly used control |
| | | keys (e.g., tab, escape, enter). |
| | | The square brackets are |
| | | required. |
| | | The <key> portion of the |
| | | field is depicted by one or |
| | | more key representations |
| | | separated by ‘-’. |
| | | Keys may be specified in any |
| | | order; the same key cannot be |
| | | specified more than once in |
| | | the field. |
| | | A maximum of 4 keys may be |
| | | specified within the brackets |
| | | and no nesting of special keys |
| | | is allowed. |

Properties

Property “do_special” of type “uint32”. Note: Boolean: When TRUE, DM_A2K recognizes the ASCII representation of the non-ASCII characters contained in square brackets. The default value is FALSE.

Property “do_escape” of type “uint32”. Note: Boolean: When TRUE, DM_A2K recognizes the escape literal field described above. The default value is FALSE.

Encapsulated Interactions

DM_A2K relies on the following C-runtime library functions: strtoul and strspn. Implementations of these functions must be provided by the driver (using DM_A2K) in order to properly use DM_A2K. A driver may fail to compile or load if the proper implementations of these functions are not available.

1. Specification

Responsibilities

1. Interpret data received on the in terminal based on do_special and do-escape properties and convert the data into a series of keystrokes, as if the keys were typed on the keyboard, and send out the out terminal.

2. Interpret the current state of the CAPS LOCK key to determine if SHIFT keystrokes should be generated.

3. Interpret the current state of the NUM LOCK key to determine if the NUM LOCK keystrokes need to be generated when outputting keystrokes for keys on the numeric keypad.

4. Assume that the CAPS, NUM, and SCROLL LOCK indicators are off if the EV_KBD_GET_STATE request fails.

Theory of Operation

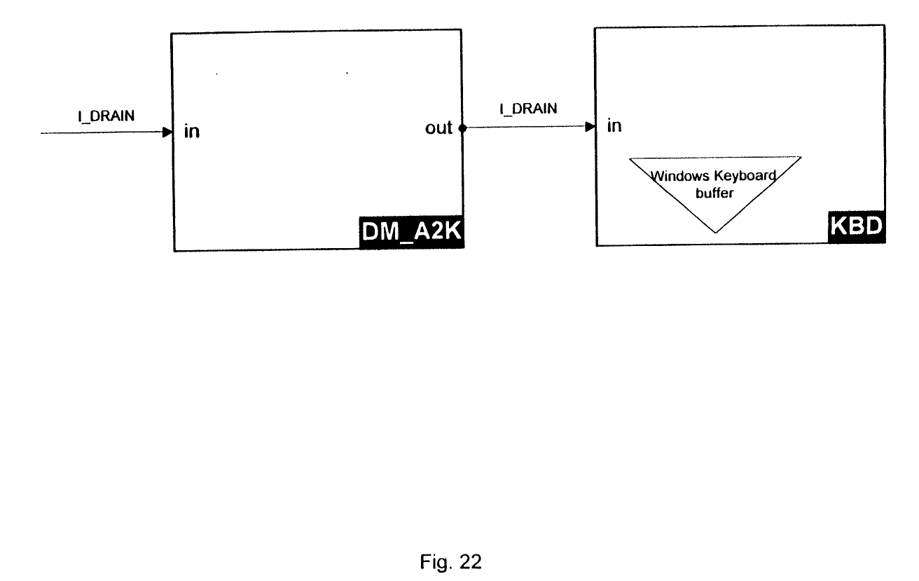

FIG. 22 illustrates an advantageous use of the inventive DM_A2K part.

State Machine

None.

Main Data Structures

ascii2scan table

DM_A2K uses a static table that contains the following information for each ASCII character

the key scan code,

whether a SHIFT, CTL, or ALT keystroke needs to be generated in addition to the key.

whether the NUM LOCK needs to be on

whether the character is an alphabetic character

The ASCII character itself is the index into this table.

string2scan

DM_A2K uses an additional table to map the special key representations to their corresponding scan codes. DM_A2K searches this table synchronously based on the string representation.

Key Stack and Key Queue

DM_A2K implements a small queue and a stack that it uses to output all keystrokes. Key down events are stored on the key_queue and their corresponding key up events are simultaneously pushed onto the key_stack. This ensures that the key up events are sent in the proper order when more than one keystroke is sent (e.g., to output an “A”, send “SHIFT down”, “‘a’ down”, “‘a’ up”, “SHIFT up”).

The size of the queue and stack are based on the following criteria:

A key sequence specified in square brackets (i.e., special keys) cannot be more than 4 keys,

Each key can potentially be accompanied by a SHIFT, CTL, or ALT keystroke or a maximum of 4 keys in a single key sequence.

Each key has the potential to be preceded by a NUM LOCK on keystroke and followed by a NUM LOCK off keystroke.

Each key requires two keystrokes: “key down” and “key up”.

Therefore, the queue has a maximum size of 4*4+4*4=32 and the stack has a depth of 8, which is the number of potential “key up” keystrokes for the 4 keys (not including the NUM LOCK keystrokes).

Mechanisms

Determining if SHIFT Keystroke Should be Sent

DM_A2K outputs a SHIFT keystroke under the following conditions:

If the key is a lowercase letter and the CAPS LOCK is not on

If the key is an uppercase letter and the CAPS LOCK is off

If the key is not a letter and requires a shift. In this situation, DM_A2K ignores the state of the CAPS LOCK.

If the SHIFT key is explicitly specified in a special key field. In this situation, DM_A2K ignores the state of the CAPS LOCK.

Outputting Keystrokes

When DM_A2K receives an EV_MESSAGE event on its in terminal, it first requests the current shift and lock state by sending an EV_KBD_GET_STATE request out its out terminal. If the request fails, DM_A2K assumes that the CAPS, SCROLL, and NUM LOCK LED indicators are not on.

DM_A2K then synchronously scans the data. For each literal found, DM_A2K performs the following tasks:

Uses the character to index into its ascii2scan table and retrieves the scan code

Puts any required SHIFT or CTL key down event onto DM_A2K's queue and pushes the corresponding key up event onto DM_A2K's key stack.

Put the “key down” event onto the queue and push the corresponding “key up” event onto the key stack.

Pops each “key up” event from the key stack and puts the event onto the queue.

Output all keystrokes that are on the queue thereby emptying the queue.

If DM_A2K is configured to interpret escape characters (i.e., its do_escape property is set to TRUE), DM_A2K converts the escape representation into a character and performs the same sequence of operations described above.

If DM_A2K is configured to interpret special keys (i.e., its do_special property is set to TRUE), DM_A2K searches its string2scan table for the string representation and outputs the appropriate keystrokes. The sequence of tasks is the same for a literal except that DM_A2K may turn the NUM LOCK on or off by sending key down and key up keystrokes as required by the key.

After the keystrokes for the key have been outputted and DM_A2K toggled the NUM LOCK, the NUM LOCK state is restored.

Handling Errors and Overflow

DM_A2K may encounter any of the following errors:

ASCII character specified in data is above 127 (i.e., size of the ascii2scan table)

Hexadecimal representation specified by “xhh” is not a valid hexadecimal value (i.e., “h” is not a hexadecimal digit)

Text representation of non-ASCII and control keys is unknown

DM_A2K encounters a stack or queue overflow.

When DM_A2K encounters an error, it will discontinue further processing of the data, discard any keystrokes currently on its queue and stack, and return a bad status.

Use Cases

Emulating Keystrokes

DM_A2K provides an operating system-independent interface by which to generate keystrokes from ASCII text. The KBD part connected to DM_A2K's output provides the operating system-dependent mechanism for feeding keystrokes into the Windows keyboard buffer as if the keys were actually typed by the user.

DM_IES—Idle to Event Source Adapter

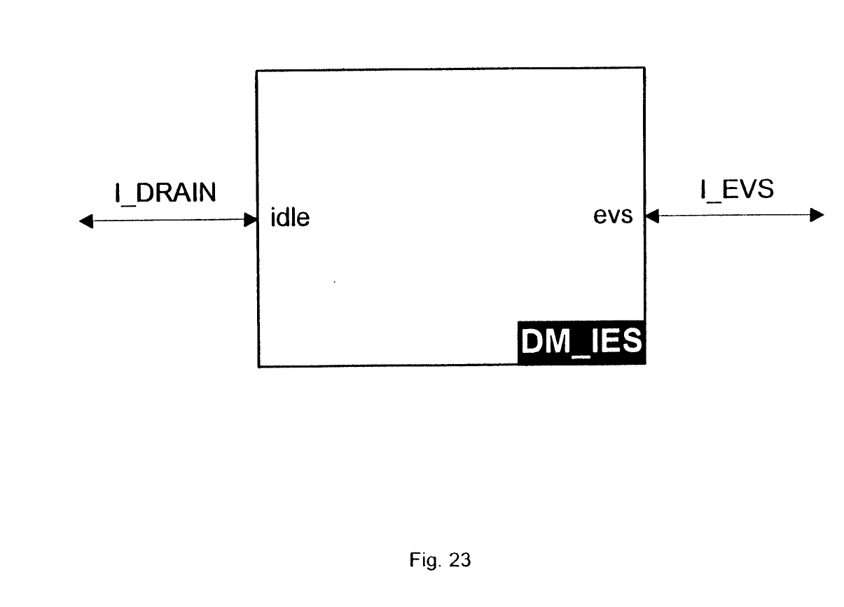

FIG. 23 illustrates the boundary of the inventive DM_IES part.

DM_IES is an adapter that makes it possible to connect parts that rely on idle generation (i.e., DM_DWI) to event sources (i.e., DM_EST).

DM_IES converts EV_REQ_ENABLE and EV_REQ_DISABLE requests received on its idle terminal into arm and disarm operation calls through its evs terminal. DM_IES returns CMST_NOT_SUPPORTED for all other events received on idle.

When the event source connected to evs fires (by invoking the fire operation on evs), DM_IES continuously generates EV_IDLE events through idle until CMST_NO_ACTION is returned from the idle processing or an EV_REQ_DISABLE request is received. This allows, for example, a part connected to the idle terminal to pump events through a system.

DM_IES passes NULL buses with the arm and disarm operations. DM_IES expects that the event source connected to the evs terminal has sufficient defaults in order to handle this situation.

1. Boundary

1.1. Terminals

Terminal “idle” with direction “Plug” and contract I_DRAIN. Note: v-table, cardinality 1, synchronous, unguarded The requests EV_REQ_ENABLE and EV_REQ_DISABLE are expected to be received on this terminal. DM_IES sends EV_IDLE events out this terminal in response to fire operation calls invoked through the evs terminal from an event source.

Terminal “evs” with direction “Bidir” and contract “in: I_EVS_R Out: I_EVS”. Note: v-table, cardinality 1, synchronous, unguarded DM_IES invokes the arm and disarm operations through this terminal in response to receiving EV_REQ_ENABLE and EV_REQ_DISABLE requests from the idle terminal respectively. DM_IES sends EV_IDLE events out the idle terminal in response to fire operation calls invoked through this terminal from an event source.

1.2. Events and Notifications

| Incoming Event | Bus | Notes |
|---|---|---|
| EV_REQ_ENABLE | CMEVENT_{—} | This request is expected to |
| | HDR | be received on the idle |
| | | terminal. |
| | | In response to this request, |
| | | DM_IES invokes the arm |
| | | operation through the evs |
| | | terminal. |
| EV_REQ_DISABLE | CMEVENT_{—} | This event is expected to |
| | HDR | be received on the idle |
| | | terminal. |
| | | In response to this request, |
| | | DM_IES invokes the disarm |
| | | operation through the evs |
| | | terminal and halts any idle |
| | | generation from a previous |
| | | fire. |

1.3

| Outgoing | | |
|---|---|---|
| Event | Bus | Notes |
| EV_IDLE | CMEVENT_{—} | This event is sent through |
| | HDR | the idle terminal. |
| | | EV_IDLE is generated by |
| | | DM_IES when the fire |
| | | operation is invoked |
| | | through the evs terminal. |

1.4. Special Events, Frames, Commands or Verbs

None.

1.5. Properties

Property “force_free” of type “UINT32”. Note: Set to TRUE to free self-owned events received from the idle terminal. Default: FALSE.

2. Encapsulated Interactions

None.

3. Specification

4. Responsibilities

1. In response to receiving EV_REQ_ENABLE and EV_REQ_DISABLE requests on the idle terminal, invoke the arm and disarm operations on the evs terminal respectively.

2. Return CMST_NOT_SUPPORTED for unknown events received on the idle terminal.

3. In response to fire operation calls through the evs terminal, generate EV_IDLE requests through idle until CMST_NO_ACTION is returned from the idle processing or an EV_REQ_DISABLE request is received.

4.1. State Machine

None.

4.2. Main Data Structures

None.

4.3. Mechanisms

Generating EV_IDLE Events in Response to “Fire” Operations

After an EV_REQ_ENABLE request is sent to DM_IES and the event source is armed, DM_IES does nothing until the event source fires at a later time.

When the fire operation is invoked through evs, DM_IES continuously generates EV_IDLE events through idle until CMST_NO_ACTION is returned from the idle processing or an EV_REQ_DISABLE request is received.

DM_IES does not support fire previews. See the I_EVS interface for more information.

DM_IES does not rely on any parameters passed with the fire operation.

Note if DM_IES is disabled and then enabled directly afterwards (while in the context of handling an EV_IDLE event from DM_IES), DM_IES will continue to generate idle events.

4.4. Use Cases

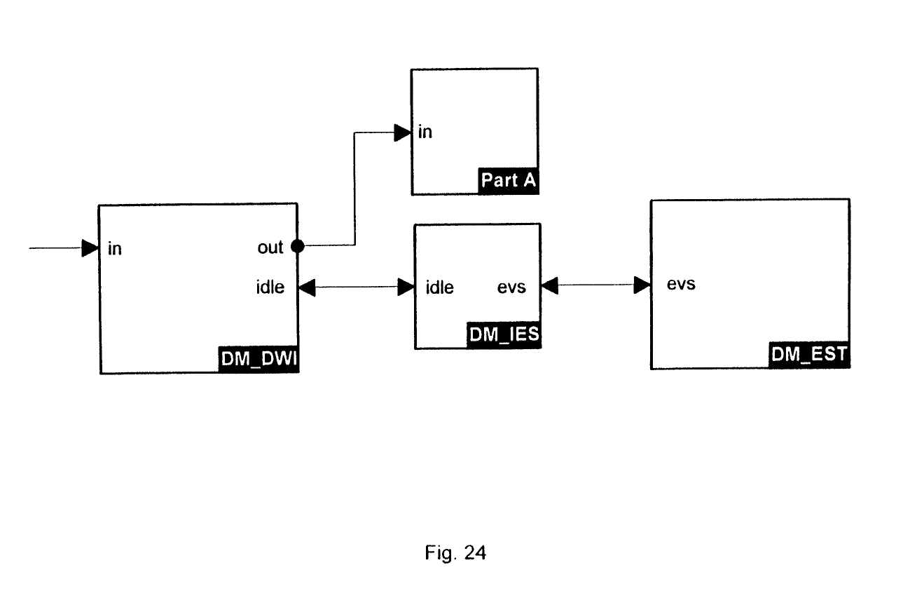

FIG. 24 illustrates an advantageous use of the inventive DM_IES part.

Using DM_IES to Create a Thread-Based Pump for Event Distribution

Please refer to the DM_DWI and DM_EST documentation for details on how they work.

1. The structure in FIG. 2 is created, connected, and activated.

2. Events, requests and notifications are sent through the in terminal of DM_DWI.

3. DM_DWI enqueues the events and issues an EV_REQ_ENABLE request through its idle terminal (only for the first event received).

4. DM_IES receives the enable request and invokes the arm operation through its evs terminal. DM_IES propagates the return status of the operation back to DM_DWI. (This use case assumes the arm operation completed successfully). The event source is armed and will fire according to its default settings.

5. DM_EST eventually fires by invoking the fire operation through its evs terminal.

6. DM_IES receives the fire operation call and generates EV_IDLE events through the idle terminal until CMST_NO ACTION is returned.

7. For each idle event received, DM_DWI dequeues an event and sends it through the out terminal. DM_DWI returns CMST_OK as long as there are more events to send out on its queue.

8. Part A receives the events from DM_DWI and handles them accordingly.

9. Eventually, DM_DWI's queue becomes empty and it sends an EV_REQ_DISABLE request through its idle terminal and returns CMST_NO_ACTION in response to the last EV_IDLE event.

10. DM_IES receives the disable request and disarms the event source by invoking the disarm operation through the evs terminal.

11. In response to the CMST_NO_ACTION return status, DM_IES stops generating EV_IDLE events, sets the completion status to CMST_OK, and returns control back to the event source (by returning from the fire operation call).

12. Steps 2-11 may be repeated again once another event is sent to DM_DWI.

DM_PLT—PnP-to-LFC Event Translator

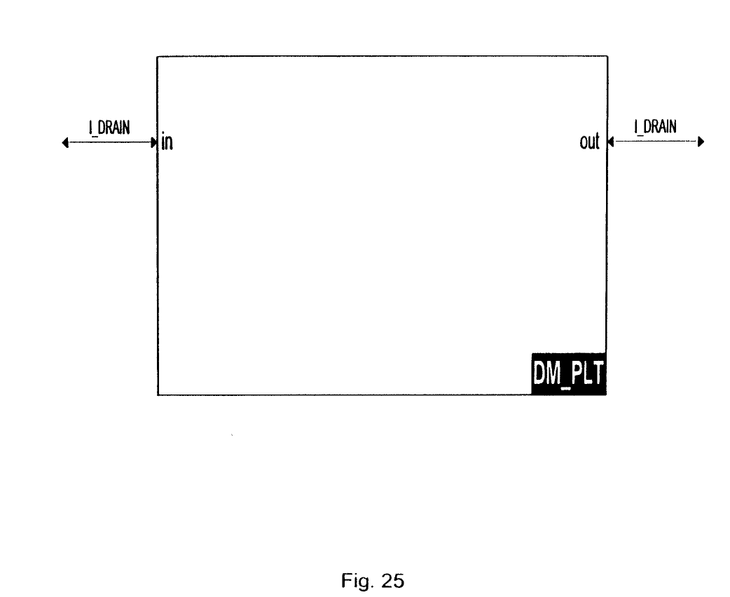

FIG. 25 illustrates the boundary of the inventive DM_PLT part.

DM_PLT translates the Plug-n-Play IRP events (EV_REQ_IRP) coming on its in terminal into life-cycle (LFC) events (EV_LFC_xxx) and forwards these through its out terminal.

Life-cycle events can be completed asynchronously. DM_PLT will complete the IRP event whenever the respective life-cycle event completes. If completion of the life-cycle event is not detected in certain period of time, DM_PLT will automatically complete the IRP event with CMST_TIMEOUT.

To complete the IRP event, DM_PLT will send EV_REQ_IRP event with CMEVT_A_COMPLETED attribute set back to in.

5. Boundary

5.1. Terminals

Terminal “in” with direction “Plug” and contract I_DRAIN. Note: IRP events (EV_REQ_IRP). All events that come at this terminal are completed asynchronously. The back channel of this terminal is used for completion events only. Can be connected at Active Time.

Terminal “out” with direction “Plug” and contract I_DRAIN. Note: Life-cycle events. The back channel is used for completion events only. Can be connected at Active Time.

Events and Notifications Passed Through the “In” Terminal

| Incoming Event | Bus | Notes |
|---|---|---|
| EV_REQ_IRP | B_EV_IRP | Indicates that IRP |
| | | needs processing. |

| Outgoing Event | Bus | Notes |
|---|---|---|
| EV_REQ_IRP | B_EV_IRP | Indicates that IRP |
| | | processing has |
| | | completed. |
| | | This event is a copy |
| | | of the event that was |
| | | processed |
| | | asynchronously with |
| | | CMEVT_A_COMPLETED |
| | | attribute set. |

1.1. Events and Notifications Passed Through the “Out” Terminal

| Outgoing Event | Bus | Notes |
|---|---|---|
| EV_LFC_REQ_START | B_EV_LFC | Request to start |
| | | normal operation. |
| EV_LFC_REQ_STOP | B_EV_LFC | Request to stop |
| | | normal operation. |
| EV_LFC_REQ_DEV_PAUSE | B_EV_LFC | Request to put the |
| | | device in a “paused” |
| | | state. |
| EV_LFC_REQ_DEV_RESUME | B_EV_LFC | Request to revert the |
| UME | | device from “paused” |
| | | state to normal. |
| EV_LFC_NFY_DEV_{—} | B_EV_LFC | Notification that the |
| REMOVED | | device has been |
| | | removed. |

1.2. Special Events, Frames, Commands or Verbs

Upon receiving EV_REQ_IRP event on its in terminal, DM_PLT performs a secondary dispatch by IRPs minor function code for PnP IRPs (IRP_MJ_PNP).

For details on the expected order of IRP events and the order of outgoing LFC events, see the DM_PNS sheet.

1.3. Properties

Property “cplt_tout” of type “UINT32”. Note: LFC completion timeout in miliseconds. Redirected to subordinate TMR, property time. Default: 3000

2. Encapsulated Interactions

DM_PLT is an assembly and does not utilize such interactions. Its subordinates, however, may do so, depending on their implementation. For more information on the subordinates, please refer to the data sheets of:

DM_EVT

DM_PNS

3. Internal Definition

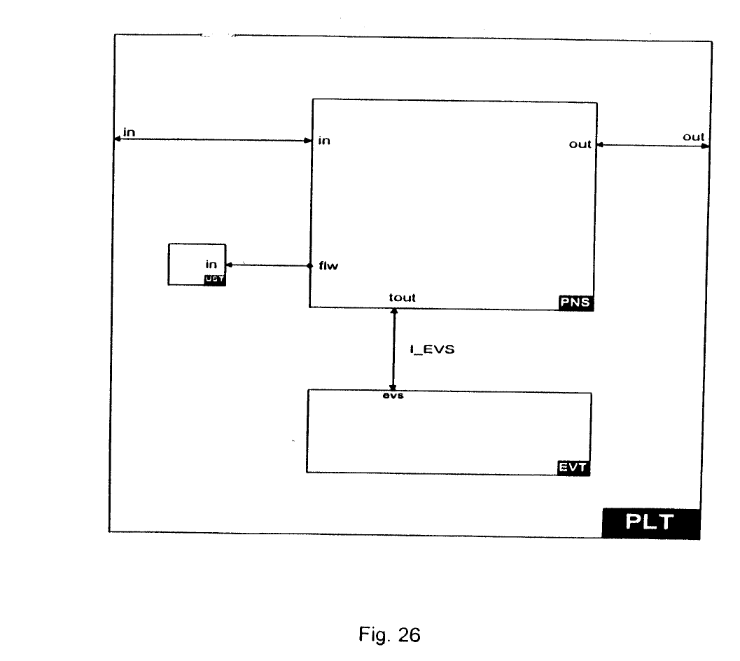

FIG. 26 illustrates the internal structure of the inventive DM_PLT part.

Theory of Operation

DM_PLT is an assembly. The main goal of this assembly is to enhance the functionality of the DM_PNS (PnP-to-LFC State Machine) part with timeout capabilities and provide a simpler boundary. The assembly uses a standard part DM_EVT to provide timer event to DM_PNS and a Event Stopper (DM_STP—standard part) to disable the flow control capabilities of DM_PNS.

Subordinate Parameterization

| Subordinate | Property | Value |
|---|---|---|
| tmr | time | 3000 |

DM_ERC—Event Recoder

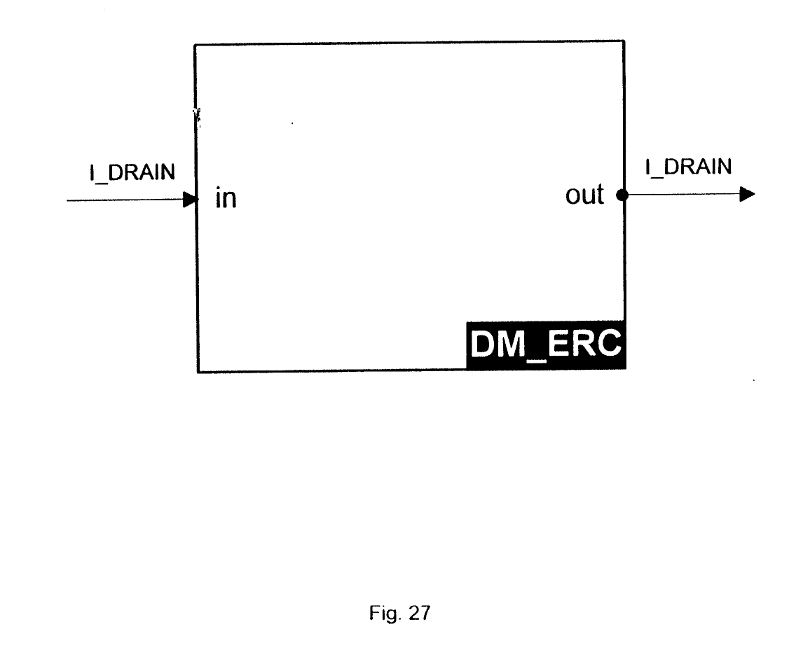

FIG. 27 illustrates the boundary of the inventive DM_ERC part.

DM_ERC is used to remap event IDs and attributes in an event flow. The event IDs and attributes to be remapped are specified as properties.

When DM_ERC receives an event on its in terminal, it first checks if the event ID needs to be remapped. If so, the event ID is remapped according to the out_base property. Second, DM_ERC checks if the event attributes need to be remapped. If so, DM_ERC remaps the attributes and then passes the event through the out terminal.

1. Boundary

1.1. Terminals

Terminal “in” with direction “In” and contract I_DRAIN. Note: Synchronous, v-table, infinite cardinality, floating The attributes and event IDs of the incoming events are remapped (if needed) and are passed through out. This terminal is unguarded.

Terminal “out” with direction “Out” and contract I_DRAIN. Note: Synchronous, v-table, cardinality 1, floating Events received from the in terminal are remapped (if needed) and are passed out this terminal. This terminal is unguarded.

1.2. Events and Notifications

DM_ERC is parameterized with the event IDs of the events passed through out. If needed, DM_ERC remaps the incoming events and their attributes and passes them through out.

1.3. Special Events, Frames, Commands or Verbs

None.

1.4. Properties

Property “in_base” of type “UINT32”. Note: Base ID for incoming events. Default is 0.

Property “out base” of type “UINT32”. Note: Base ID for outgoing events. Default is 0.

Property “n_events” of type “UINT32”. Note: Number of events to remap, starting from xxx_base. Default is 0.

Property “attr_mask” of type “UINT32”. Note: Event attribute mask of event attributes to remap. Default is 0.

Property “attr_val” of type “UINT32”. Note: Event attribute values of event attributes to remap. Default is 0.

Property “and_attr” of type “UINT32”. Note: Event attributes that are ANDed with the incoming event's attributes. Used only if the event's attributes are to be remapped. Default is 0xFFFFFFFF.

Property “or attr” of type “UINT32”. Note: Event attributes that are ORed with the incoming event's attributes. Used only if the event's attributes are to be remapped. Default is 0.

Property “xor_attr” of type “UINT32”. Note: Event attributes that are XORed with the incoming event's attributes. Used only if the event's attributes are to be remapped. Default is 0.

Property “enforce_const” of type “UINT32”. Note: If TRUE, DM_ERC does not modify constant events (CMEVT_A CONST attribute is enforced). Attempts to do so result in an CMST_REFUSE status. If FALSE, DM_ERC modifies the event without consideration of the constant attribute. Default: TRUE.

Property “force_free” of type “UINT32”. Note: Set to TRUE to free self-owned events received from the in terminal. Default: FALSE.

2. Encapsulated Interactions

None.

3. Specification

4. Responsibilities

1. Remap the incoming event ID if needed (as specified by properties).

2. Remap the incoming event attributes if needed (as specified by properties).

3. Refuse to remap any events that have the constant (CMEVT_A_CONST) attribute set only if the enforce_const property is TRUE.

5. Theory of Operation

5.1. State Machine

None.

5.2. Main Data Structures

None.

5.3. Mechanisms

Remapping Event IDs

The incoming event IDs to be remapped are specified by setting the in_base, out_base and n_events properties. The event ID is remapped if it falls in the range of in_base . . . in_base+n_events−1.

The outgoing event ID is calculated by using the out base and in_base properties. The formula for calculating the outgoing event ID is: out_base+(incoming event ID−in_base). There is a one-to-one correspondence between the incoming event IDs and the outgoing event IDs generated by DM_ERC.

Remapping Event Attributes

The incoming event attributes to be remapped are specified by setting the attr_mask and attr_val properties. DM_ERC performs a bit-wise AND between the event attributes and the value of attr_mask; the result is then compared to attr_val. If there is an exact match, the attributes are remapped according to the and_attr, or_attr and xor_attr properties.

If in_base is non-zero, attributes are considered for remapping only if the ID of the incoming event falls in the range in_base. in_base+n_events−1.

If in_base is zero, the event attributes are always remapped as long as they meet the criteria described above.

Use Cases

Remapping a Single Event ID

1. DM_ERC is created and parameterized with the following:

a. in_base=0x222

b. out_base=0x333

c. n_events=1

2. DM_ERC is activated.

3. An event with the ID of 0x222 is passed to DM_ERC through its in terminal.

4. DM_ERC remaps the event ID to 0x333 and passes it through its out terminal.

5. DM_ERC does not modify the event attributes.

6. Steps 3-4 may be repeated several times.

7. DM_ERC is deactivated and destroyed.

Remapping a Range of Event IDs

1. DM_ERC is created and parameterized with the following:

a. in_base=0x222

b. out_base=0x333

c. n_events=5

2. DM_ERC is activated.

3. Events with the IDs of 0x222..0x226 are passed to DM_ERC through its in terminal.

4. DM_ERC remaps the event IDs to 0x333..0x337 and passes them through its out terminal.

5. DM_ERC does not modify the event attributes.

6. Steps 3-4 may be repeated several times.

7. DM_ERC is deactivated and destroyed.

Modifying Event Attributes

1. DM_ERC is created and parameterized with the following:

a. attr_mask=CMEVT_A_SYNC|CMEVT_A_ASYNC

b. attr_val=CMEVT_A_SYNC

c. or_attr=CMEVT_A_ASYNC

d. and_attr=˜CMEVT_A_SYNC

2. DM_ERC is activated.

3. An event with the any event ID and attribute CMEVT_A_SYNC is passed to DM_ERC through its in terminal.

4. DM_ERC does not modify the event ID.

5. The event attribute matches (event attr & attr₁₃ mask==attr_val) so DM_ERC modifies the attributes by doing the following:

a. Adds the CMEVT_A_ASYNC attribute (ORing or_attr)

b. Removes the CMEVT_A_SYNC attribute (ANDing and_attr)

The effect is converting the discipline for the distribution of the event from synchronous to asynchronous.

6. DM_ERC passes the event through its out terminal.

7. Steps 3-6 may be repeated several times.

8. DM_ERC is deactivated and destroyed.

Modifying Event Attributes of a Specific Event

1. DM_ERC is created and parameterized with the following:

a. in_base=0x222

b. out_base=0x222

c. n_events=1

d. attr_mask=CMEVT_A_SYNC_CMEVT_A_ASYNC

e. attr_val=CMEVT_A_SYNC

f. or_attr=CMEVT_A_ASYNC

g. and_attr=˜CMEVT_A_SYNC

2. DM_ERC is activated.

3. An event with an ID of 0x222 and attribute CMEVT_A_SYNC is passed to DM_ERC through its in terminal.

4. DM_ERC does not modify the event ID.

5. The event attribute matches (event attr & attr_mask==attr_val) so DM_ERC modifies the attributes by doing the following:

a. Adds the CMEVT_A_ASYNC attribute (ORing or_attr)

b. Removes the CMEVT_A_SYNC attribute (ANDing and_attr)

The effect is converting the discipline for the distribution of the event from synchronous to asynchronous.

6. DM_ERC passes the event through its out terminal.

7. Steps 3-6 may be repeated several times.

8. DM_ERC is deactivated and destroyed.

Remapping Both an Event's ID and Attributes

1. DM_ERC is created and parameterized with the following:

a. in_base=0x100

b. out_base=0x200

c. n_events=1

d. attr_mask=CMEVT_A_SYNC

e. attr_val=CMEVT_A_SYNC

f. or_attr=CMEVT_A_ASYNC

g. and_attr=˜CMEVT_A_SYNC

2. DM_ERC is activated.

3. An event with the ID of 0x100 and attribute CMEVT_A_SYNC is passed to DM_ERC through its in terminal.

4. DM_ERC remaps the event ID to 0x200.

5. The event attribute matches so DM_ERC modifies the attributes by doing the following:

a. Adds the CMEVT_A_ASYNC attribute (ORing or_attr)

b. Removes the CMEVT_A_SYNC attribute (ANDing and_attr)

The effect is converting a synchronous event to an asynchronous event.

6. DM_ERC passes the event through its out terminal.

7. Steps 3-6 may be repeated several times.

8. DM_ERC is deactivated and destroyed.

DM_STX—Status Recoder

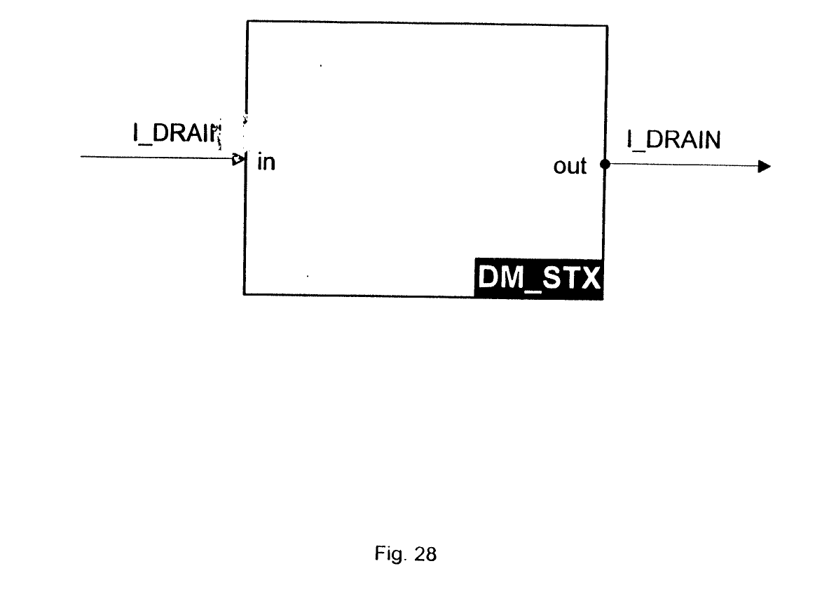

FIG. 28 illustrates the boundary of the inventive DM_STX part.

DM_STX is used to recode return statuses in an event channel.

DM_STX forwards all events received on the in terminal through the out terminal. DM_STX propagates all return status codes back to the original caller with the exception of one—this status is recoded using the values of the s1 and s2 properties.

Cascaded DM_STX's can be used to recode more than one return status.

The events are not interpreted by DM_STX.

The terminals are unguarded providing maximum flexibility in their use.

1. Boundary

1.1. Terminals

Terminal “in” with direction “In” and contract I_DRAIN. Note: v-table, infinite cardinality, synchronous, unguarded Events received from this terminal are forwarded through the out terminal. The event is not interpreted by DM_STX.

Terminal “out” with direction “Out” and contract I_DRAIN. Note: v-table, cardinality 1, synchronous, unguarded Events received through the in terminal are forwarded through this terminal. The event is not interpreted by DM_STX.

1.2. Events and Notifications

Events received on the in terminal are forwarded through the out terminal.

1.3. Special Events, Frames, Commands or Verbs

None.

1.4. Properties

Property “s1” of type “UINT32”. Note: Mandatory. This is the status that DM_STX will recode to s2 if it is returned from the event processing from the out terminal.

Property “s2” of type “UINT32”. Note: Mandatory. This is the status that DM_STX returns (to the counter terminal of in) if the return status from the event processing from the out terminal is s1.

The attributes of the notification events are: CMEVT_A_SELF_CONTAINED, CMEVT_A_SYNC, CMEVT_A_ASYNC.

The pre and post notifications are always allocated on the stack.

1.3. Special Events, Frames, Commands or Verbs

None.

1.4. Properties

Property “trigger_ev” of type “UINT32”. Note: Trigger event ID. Mandatory.

Property “pre_ev” of type “UINT32”. Note: Pre-notification event ID. Set to EV_NULL to disable issuing a pre-notification. Default: EV_NULL.

Property “post_ev” of type “UINT32”. Note: Post-notification event ID. Set to EV_NULL to disable issuing a post-notification. Default: EV_NULL.

2. Encapsulated Interactions

None.

3. Specification

4. Responsibilities

1. Pass all events coming on in to out.

2. Watch for trigger event and send pre and/or post notification to nfy when this event arrives.

5. Theory of Operation

DM_NFY passes all events coming at the in terminal through its out terminal and watches for a particular event to arrive. When the event arrives, based on its parameters, DM_NFY issues one or two notifications: before and/or after the event is passed through.

DM_NFY propagates the status returned on the out terminal operation back to the caller of the in terminal operation.

DM_NFY keeps no state.

DM_NFY2—Advanced Event Notifier

FIG. 8 illustrates the boundary of the inventive DM_NFY2 part.

2. Encapsulated Interactions

None.

3. Specification

4. Responsibilities

1. Recode the event processing return status s1 (from the out terminal) to s2.

2. Forward all events received from the in terminal through the out terminal.

4.1. Use Cases

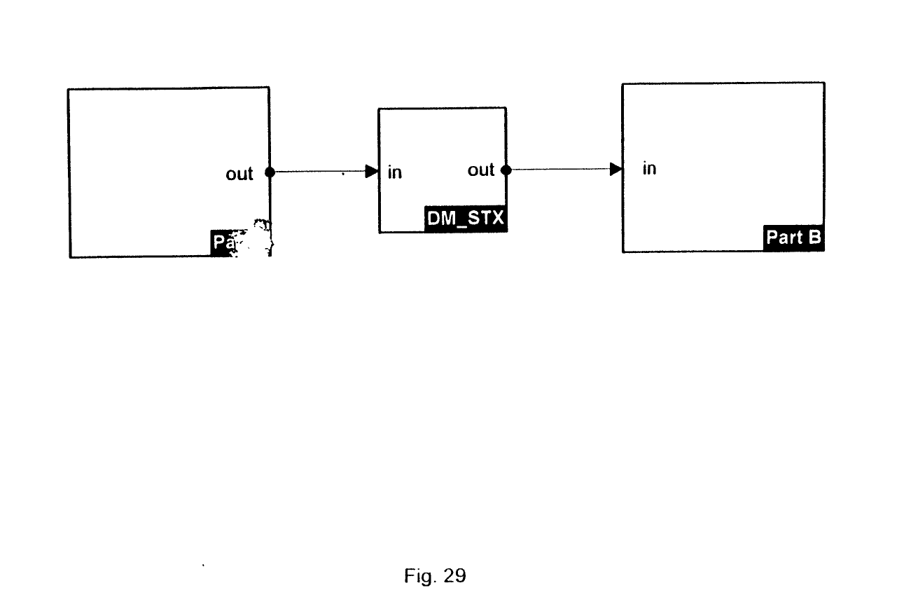

FIG. 29 illustrates an advantageous use of the inventive DM_STX part.

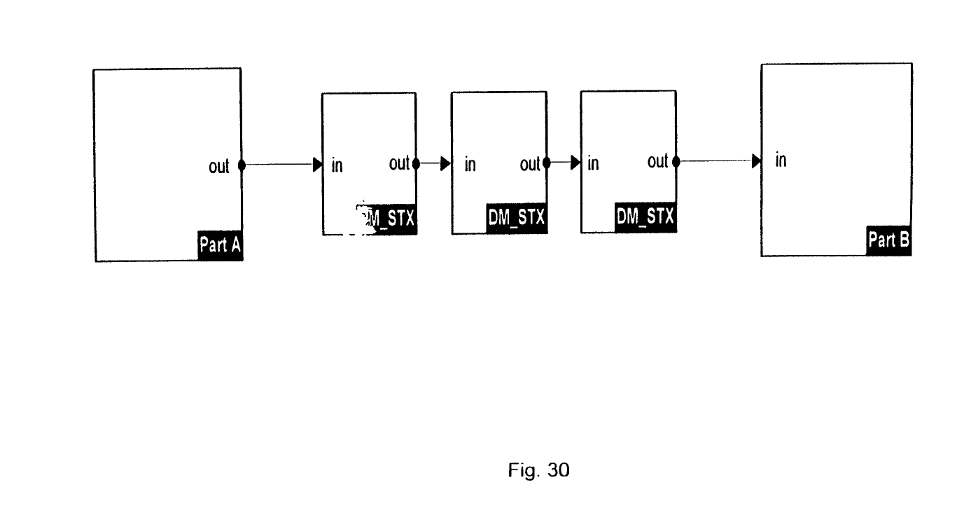

FIG. 30 illustrates an advantageous use of the inventive DM_STX part.

Using DM_STX to Recode a Return Status

1. Part A, Part B and DM_STX are created.

2. DM_STX is parameterized with s1=CMST_NO_ACTION and s2=CMST_OK.

3. All the parts are activated.

4. Part A sends an event through its out terminal.

5. DM_STX receives the event on its in terminal and forwards it through the out terminal.

6. Part B receives the event and returns CMST_NO_ACTION.

7. DM_STX receives the CMST_NO_ACTION return status and returns CMST_OK.

8. Part A receives the CMST_OK status from the event processing and continues execution.

9. Steps 4-8 are executed again, this time Part B returns CMST_FAILED. DM_STX propagates the CMST_FAILED status back to Part A.

Using Cascaded Status Recoders

This use cause demonstrates the usage when there is a need to recode different statuses along the same channel. In this example, 3 status recoders are cascaded—one for each of 3 status' that are recoded to a different status if returned from the event processing on Part B.

1. The structure in FIG. 5 is created, parameterized, and activated.

2. Part A sends an event to the first status recoder. The recoder passes it through the out terminal.

3. The second recoder receives the event and passes it through the out terminal.

4. The third recoder receives the event and passes it through the out terminal.

5. Part B receives the event and returns CMST_NO ACTION. Control is returned to the second recoder.

6. The second recoder receives the CMST_NO_ACTION return status and returns CMST_OK.

7. Part A receives the CMST_OK status from the event processing and continues execution.

DM_ACT—Asynchronous Completer

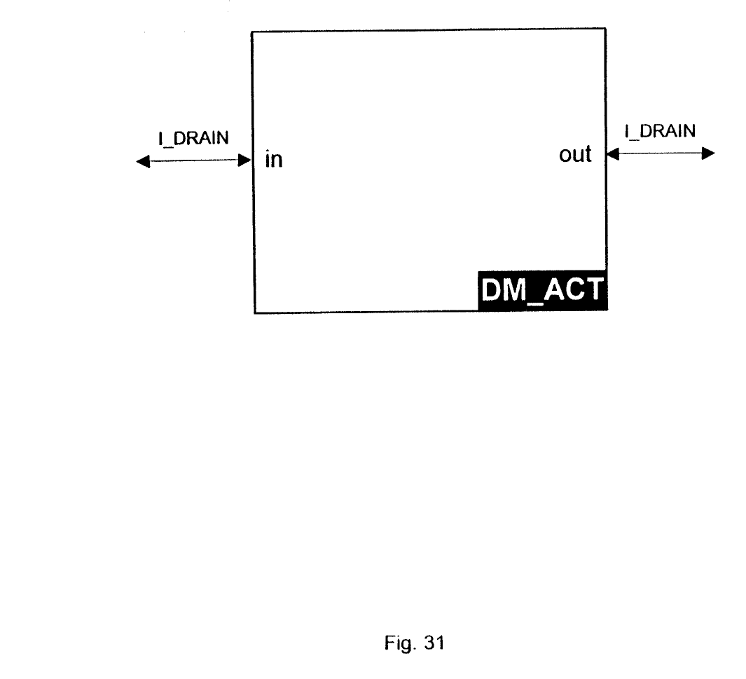

FIG. 31 illustrates the boundary of the inventive DM_ACT part.

DM_ACT is an adapter that converts synchronously completed events on its out terminal into events that complete asynchronously on in.

Events that complete asynchronously on out are simply passed through with no modification.

5. Boundary

5.1. Terminals

Terminal “in” with direction “Plug” and contract I_DRAIN. Note: Incoming events are received here.

Terminal “out” with direction “Plug” and contract I_DRAIN. Note: Outgoing events are sent through here.

5.2. Properties

Property “cplt_s_offs” of type “UINT32”. Note: Offset in bytes of the completion status in the event bus. Mandatory.

Property “enforce_async” of type “UINT32”. Note: Boolean. Set to TRUE to enforce that the incoming events allow asynchronous completion. If TRUE and the incoming event does not allow asynchronous completion, CMST_REFUSE is returned as an event distribution status.

6. Encapsulated Interactions

None.

7. Specification

8. Responsibilities

1. Transform synchronous completion of an outgoing event into asynchronous completion of the incoming event that generated the former.

9. Theory of Operation

9.1. Mechanisms

Transformation of Synchronous Completion to Asynchronous One

Sending a completion event back to the channel that originated the event within the input call simulates asynchronous completion.

This feature is used by DM_ACT to transform synchronous completion of events on its out terminal to events completing asynchronously on in.

DM_ACT passes all incoming events through its out terminal and for those that return distribution status different than CMST_PENDING (synchronous completion), DM_ACT stores this status at the completion status field in the event bus (the same one passed on in) and returns CMST_PENDING. The storage for the completion status field is computed from cplt_S_offs property and the event bus pointer.

For events that when passed to out, naturally complete asynchronously (by returning CMST_PENDING), DM_ACT does not do anything and is only a pass-through channel.

DM_SFMT—String Formatter

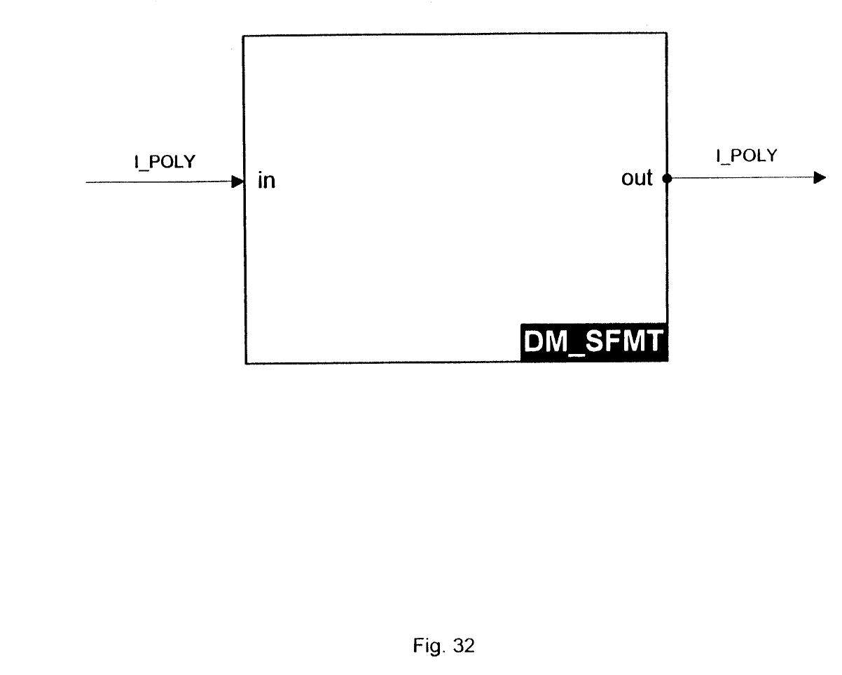

FIG. 32 illustrates the boundary of the inventive DM_SFMT part.

DM_SFMT modifies a string in the incoming bus by adding a prefix and/or suffix to it and passes the operation to out. The input bus may be restored before DM_SFMT returns from the operation.

10. Boundary

10.1. Terminals

Terminal “in” with direction “in” and contract I_POLY. Note: v-table, infinite cardinality. Add prefix and suffix to string in bus and forward operation to out.

Terminal “out” with direction “out” and contract I_POLY. Note: Output for operations containing modified strings.

10.2. Events and Notifications

None.

10.3. Special Events, Frames, Commands or Verbs

None.

10.4. Properties

Property “offset” of type “UINT32”. Note: Offset of string in event bus. The default value is 0x00.

Property “by_ref” of type “UINT32”. Note: (boolean) If TRUE, the string in the bus is by reference. If FALSE, the string is contained in the bus. The default value is FALSE.

Property “max_size” of type “UINT32”. Note: Maximum number of characters that may be stored at offset if string is contained in the bus The default value is 0—no maximum.

Property “prefix” of type “ASCIZ”. Note: Prefix to be added to incoming string. The default value is “ ”.

Property “suffix” of type “ASCIZ”. Note: Suffix to be added to incoming string. The default value is “ ”.

Property “undo” of type “UINT32”. Note: (boolean) If TRUE, the change to the bus will be restored before returning from the operation. The default is FALSE.

11. Encapsulated Interactions

None.

12. Specification

13. Responsibilities

1. Add prefix and suffix to string in bus for operations received on in and forward the operation with modified bus to out.

2. Restore bus to original contents before returning from call if undo is TRUE.

14. Theory of Operation

14.1. State machine

None.

14.2. Mechanisms

Dereferencing String

If the by_ref property is FALSE, then the offset in the bus is treated as a byte location representing the first character of the string. If the by_ref property is TRUE, then the offset is treated as a DWORD value that represents the pointer to the string.

Handing Strings Contained in the Bus

When DM_SFMT is invoked on an operation, it first calculates the length of the new string. If the length of the new string is greater than the value of the max_size property, DM_SFMT writes debug output to the debug console and fails the operation. If there is space, DM_SFMT modifies the string (in place) in the bus by adding the prefix and/or suffix, and forwards the operation to its out output.

Upon return DM_SFMT restores the original string(in place) if undo is set and returns the status from the call to out.

Handing Strings by Reference

When DM_SFMT is invoked on an operation that contains a string by reference, it saves the pointer to the original string in the bus so that it may restore it later. DM_SFMT allocates a new buffer, adds the prefix and suffix to the string, stores the pointer in the bus, and forwards the operation to out.

If DM_SFMT is unable to allocate the necessary memory, it writes debug output to the debug console and fails the operation.

Upon return, DM_SFMT frees its allocated string, restores the saved pointer in the bus, and returns the status from the call to out if undo is set.

If the operation returns CMST_PENDING (indicating that the operation is going to be completed asynchronously), DM_SFMT doesn't free the allocated string, displays debug output, and returns the same status. Distributors

DM_EVB—Event Bus

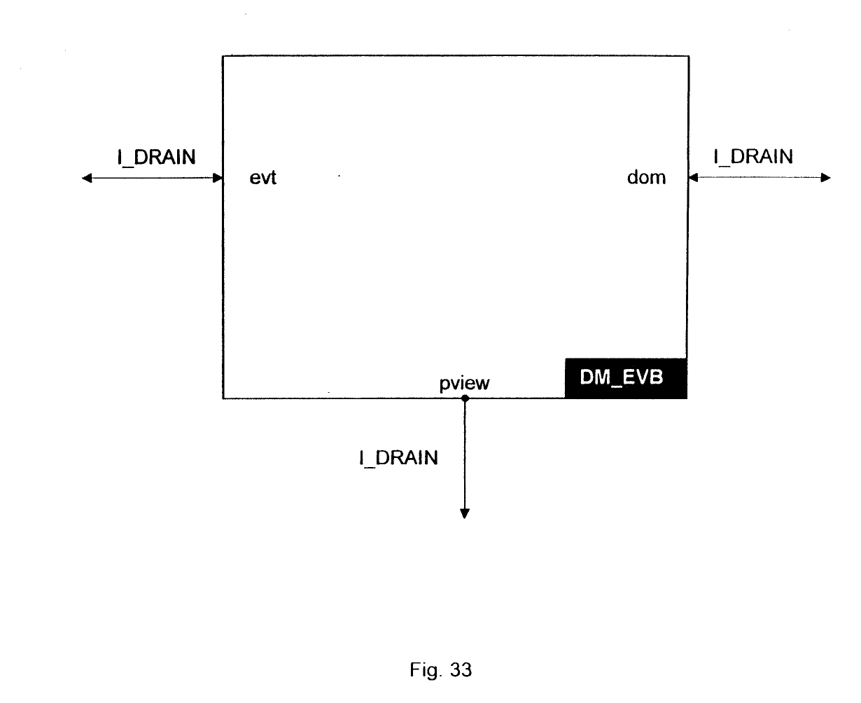

FIG. 33 illustrates the boundary of the inventive DM_EVB part.

The primary function of DM_EVB is to distribute incoming events to all parts connected to its terminals. A special discipline of distribution is followed: an incoming event is optionally sent for preview (if do_pview property is TRUE), if that is successful (return status equals status specified by pview_st_ok), the event is distributed among the recipients. The participants can be connected to two terminals for event distribution: dom and evt. The dom terminal accepts only one connection, as the intent is this terminal to be connected to a dominant. The evt terminal has unlimited cardinality and can be used for connecting subordinate parts. This terminal can be connected at active time; that allows it to be connected to dynamically created parts.

The part connected to the dom terminal is guaranteed to receive the incoming events either before or after the parts connected to evt terminal. The “before” or “after” decision is based on the value of dom_first property. The order of distribution among the parts connected to the evt terminal is not guaranteed.

DM_EVB optionally desynchronizes all incoming events before sending them out through the dom and evt terminals. This is controlled by the sync property.

If no explicit parameterization is used, DM_EVB will skip the preview; it will desynchronize and distribute all incoming events first to all the parts connected to the evt terminal and then to the part connected to the dom terminal.

1. Event Bus Notation

The horizontal line represents the DM_EVB part. The labels on the line represent the names of the DM_EVB terminals. The line emanating from the pview label represents a unidirectional connection. The line emanating from the dom label represents a bidirectional connection between DM_EVB and the dominant. The remaining lines emanating from the event bus are bi-directional connections between DM_EVB's evt terminal and other parts.

The name of the evt terminal may be omitted; any connection to and from the bus, that doesn't have a terminal label next to it, is assumed to be through the evt terminal.

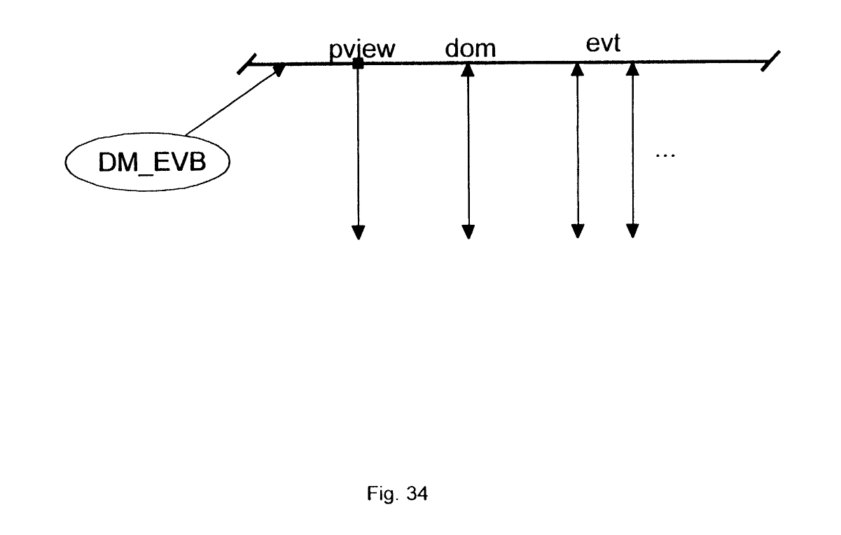

FIG. 34 illustrates an advantageous use of the inventive DM_EVB part.

2. Boundary

2.1. Terminals

Terminal “evt” with direction “Bi, In or Out” and contract I_DRAIN. Note: v-table, distinguishable connections, infinite cardinality, synchronous, active-time. General-purpose distribution terminal.

Terminal “dom” with direction “Bi” and contract I_DRAIN. Note: v-table, cardinality 1, floating, synchronous. Terminal for distributing events to the dominant (assembly).

Terminal “pview” with direction “Out” and contract I_DRAIN. Note: v-table, cardinality 1, floating, synchronous. Preview output. Events are sent synchronously through this terminal before they are desynchronized and distributed further. The status returned by sending the event through this terminal determines whether a particular event will be distributed further or not. If the return status is the one specified by pview_st_ok then the event distribution continues; otherwise the event is ignored and not distributed through any of the other terminals.

Note Although the evt terminal is a bi-directional terminal, it will accept a connection in any direction: in, out or bi-directional.

2.2. Events and Notifications

| Incoming | | |
|---|---|---|
| Event | Bus | Notes |
| <all> | CMEVENT_{—} | By default all incoming |
| | HDR | events are distributed first |
| | /CMEvent | to all recipients connected |
| | | to the evt terminal and |
| | | then to the one connected |
| | | to the dom terminal. |
| | | The dom_first property |
| | | can reverse this behavior. |
| | | The distribution can be |
| | | prevented if: |
| | | 1. the preview is enabled |
| | | (do_pview property) |
| | | AND |
| | | 2. the pview terminal is |
| | | connected and preview |
| | | operation returns value |
| | | different than the one |
| | | set to the pview_st_ok |
| | | property. |

| Outgoing | | |
|---|---|---|
| Event | Bus | Notes |
| <all> | CMEVENT_{—} | See above. |
| | HDR | |
| | /CMEvent | |

2.3. Special Events, Frames, Commands or Verbs

None.

2.4. Properties

Property “sync” of type “UINT32”. Note: Boolean. When TRUE, DM_EVB distributes all incoming events synchronously in the thread of the caller. Default is FALSE.

Property “dom_first” of type “UINT32”. Note: Boolean. When TRUE,. DM_EVB distributes the incoming events to the dominant (dom terminal) first and then to all remaining recipients (evt terminal). Default is FALSE.

Property “do_pview” of type “UINT32”. Note: Boolean. When TRUE, DM_EVB first sends the event synchronously through the pview terminal and, if the status returned matches pview_st_ok, it distributes the event further through dom and evt terminals. Default is FALSE.

Property “pview_st_ok” of type “UINT32”. Note: Only the low-order 16 bits are used. This is the status that indicates whether the preview operation is successful or not. If the status returned by the output through pview terminal matches the value set in this property, this is an indication of success for the purposes of further event distribution. Default is CMST_OK.

Property “detect” of type “UINT32”. Note: Boolean. When TRUE, DM_EVB attempts to detect changes in the bus after distributing the event to each recipient. In general, setting this property to TRUE will slow down the operation of DM_EVB. The intended use of this property is for debugging purposes. Default is FALSE.

Property “enforce” of type “UINT32”. Note: Boolean. When TRUE, DM_EVB enforces that each recipient receives the original copy of the bus as it came with the incoming event. In general setting this property to TRUE will slow down the operation of DM_EVB. The intended use of this property is for debugging purposes. Default is FALSE.

3. Encapsulated Interactions

None.

4. Specification

5. Responsibilities

1. Distribute all incoming events to all parts connected to dom and evt terminals, in the order specified by the property dom_first.

2. Send event for “preview” through pview terminal according to do_pview property if the pview output is connected. Stop further distribution if the preview is not successful.

3. Desynchronize all incoming events unless otherwise specified in sync property.

6. Theory of Operation

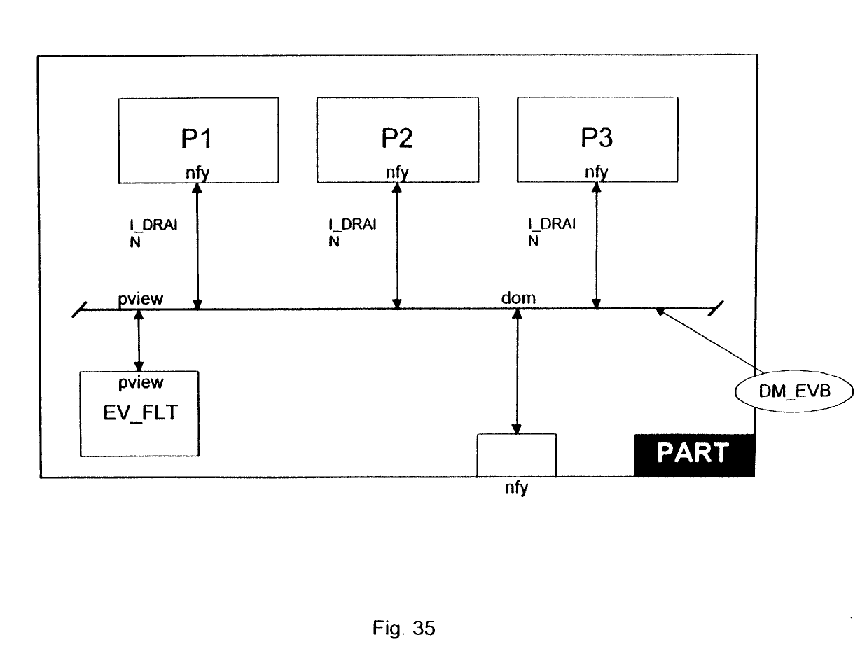

FIG. 35 illustrates an advantageous use of the inventive DM_EVB part.

6.1. State Machine

None.

6.2. Main Data Structures

None.

6.3. Mechanisms

Caller Identification

DM_EVB uses the connection IDs specified when its evt terminal is connected in order to be able to distinguish between the connections to this terminal. As a result, CM_EVT can determine through which connection a given event came and not send that event back through the same connection.

Enforcement of Bus Contents

Detection of bus changes is done by binary comparison of the contents of the bus after sending it to an individual recipient. Enforcing the contents of the bus is done by overwriting it with the contents from the original bus before sending it to the next recipient.

6.4. Use Cases

Distribution Among Peers

In case of peer distribution, the dom terminal is unconnected and no events come in from this terminal—all events come from the evt terminal.

DM_EVB desynchronizes it (unless sync property is TRUE) and sends it out to all parts connected to the evt terminal except the one that sent the event in.

Distribution in an Assembly

In this case there is a part connected to the dom terminal (the dominant) as well as subordinates connected to the evt terminal. There are two possibilities: the dominant sending events to the bus or subordinate sending events to the bus.

In the first case DM_EVB desynchronizes the event sent by the dominant and distributes this event to all subordinates connected to the evt terminal.

In the second case DM_EVB depending on the dom-first property sends the event first to the dominant and then to the subordinates or backwards. DM_EVB does not distribute the event to the part that sent it.

Dominant Filters Events out During Preview

In this case all terminals are connected and the do_pview property is set to TRUE. The dom terminal is connected to the dominant, evt to subordinates and pview to another terminal implemented on the dominant as well.

When an event comes through evt or dom, DM_EVB sends it out immediately for preview through the pview terminal. The dominant connected at the other end, receives this event and decides not to distribute it further. For this to happen, the dominant returns CMST_CANCELLED or other status code that is different from the value of the pview_st_ok property. When the DM_EVB receives such a status, it does not distribute the event. This way the event is filtered out.

Dominant Replaces the Event During Preview With Another Event

In this case, again all terminals are connected and the do_pview property is set to TRUE. The dom terminal is connected to the dominant, evt to subordinates and pview to another terminal implemented on the dominant as well.

When the dominant receives the event for a preview, it returns a status different than the value of pview_st_ok property. However, before it does that, it sends another event back to the bus through the terminal connected to dom terminal on the DM_EVB.

Note that at this moment the pview input implementation in the dominant is re-entered to preview the newly sent event; the dominant must be prepared to handle it properly.

When the replacement event is previewed successfully, the original event is not distributed further as the dominant rejected (absorbed) it, but the replacement event is distributed as usual—DM_EVB first desynchronizes it and then sends it to the subordinates. Note also, that the new event will reach all subordinates connected to the bus, including the one that generated the event that the dominant recoded.

Distribution of Notifications in a Static Assembly

In this case all notification terminals of subordinates are connected to the evt terminal, dom terminal is connected to an interior terminal on the assembly (i.e., the dominant), and the pview terminal is connected to a EV_FLT subordinate which implements the filtering of notifications.

The notifications from subordinates are distributed to all other subordinates before they go out of the assembly. Note that in most cases when filtering is used, it is done by the dominant; in this case the pview terminal of the bus is connected to an interior terminal on the assembly.

If the assembly does not have need to process the notifications itself, but it needs to be able to send them out—and, possibly, to accept incoming events and notifications—the DM_EVB dom terminal can be exposed through the assembly boundary as a pass-through terminal.

Note Exposing the evt terminal of the event bus through the assembly boundary is strongly discouraged, because: (a) the order of distribution through this terminal is not guaranteed, and (b) it is possible to get a duplicate connection ID between the inner and the outer assembly (ClassMagic generates connection IDs for static connections to be unique within the scope of the assembly).

DM_DSV—Distributor for Service

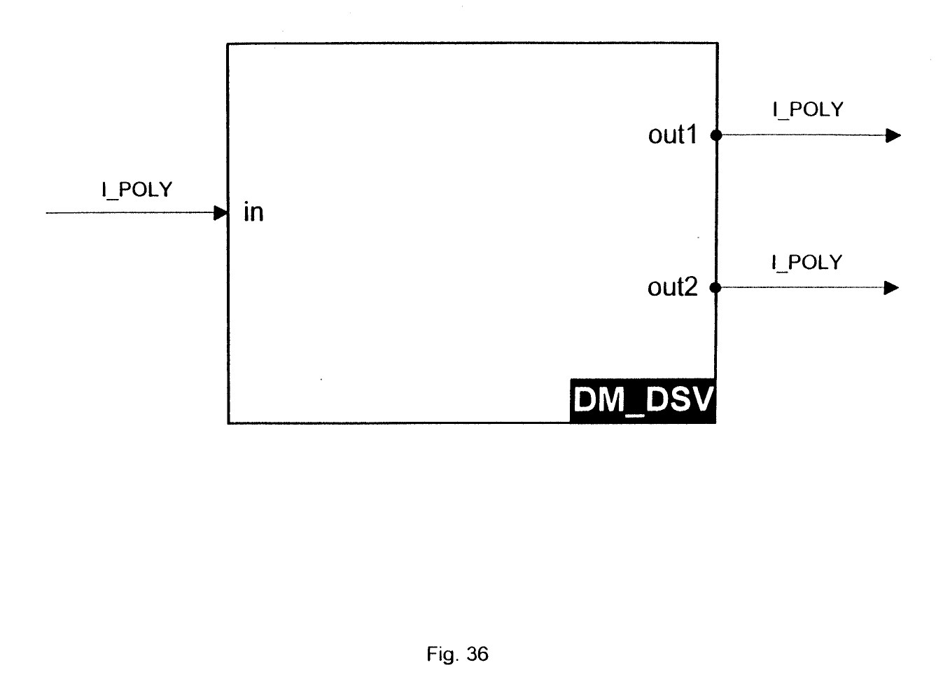

FIG. 36 illustrates the boundary of the inventive DM_DSV part.

DM_DSV forwards all operations received on in to out2 and if the call returns a status that specifies the operation was not serviced, DM_DSV forwards the operation to out2.

The status that is returned on in is the last status:

If the operation is not forwarded to out2, then the status from out1 is returned.

If the operation is forwarded to out2, the status from out2 is returned.

7. Boundary

7.1. Terminals

Terminal “in” with direction “in” and contract I_POLY. Note: v-table, infinite cardinality, unguarded. Operations received are forwarded to out1 and if the status returned indicates that the operation was not serviced, then it is forwarded to out2.

Terminal “out1” with direction “out” and contract I_POLY. Note: Output for forwarded operations.

Terminal “out2” with direction “out” and contract I_POLY. Note: Output for operations not serviced by out1.

7.2. Events and Notifications

None.

7.3. Special Events, Frames, Commands or Verbs

None.

7.4. Properties

Property “hunt_stat” of type “UINT32”. Note: Return status to recognize on out1. The default is CMST_NOT SUPPORTED.

Property “hunt_if_match” of type “UINT32”. Note: (boolean) If TRUE, DM_DSV hunts for service on out2 if out1 returned exactly hunt_stat. If FALSE, hunt for service on out2 only if status on out1 doesn't match hunt_stat. The default is TRUE.

8. Encapsulated Interactions

None.

9. Specification

10. Responsibilities

1. Forward all operations received on in to out1. Either return from the call or forward the operation to out2 based on the status returned and the values of DM_DSV's hunt_stat and hunt_if_match properties.

11. Theory of Operation

11.1. State Machine

None.

11.2. Mechanisms

None.

11.3. Use Cases

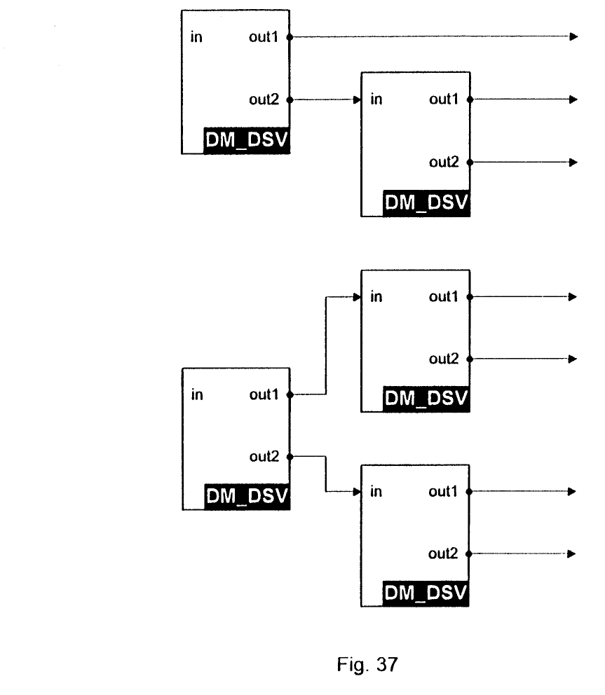

FIG. 37 illustrates an advantageous use of the inventive DM_DSV part.

Try out2 if Operation Not Served by out1

If the return status from out1 is equal to the value of the hunt_stat property and the hunt_if_match property is TRUE, DM_DSV forwards the operation to out2.

Try out2 if out1 Fails

If the return status from out1 is not equal to the value of the hunt_stat property and the hunt_if₁₃ match property is FALSE, DM_DSV forwards the operation to out2.

Cascading DM_DSV

DM_DSV may be cascaded to achieve hunting for service among more than two terminals.

DM_RPL—Event Replicator

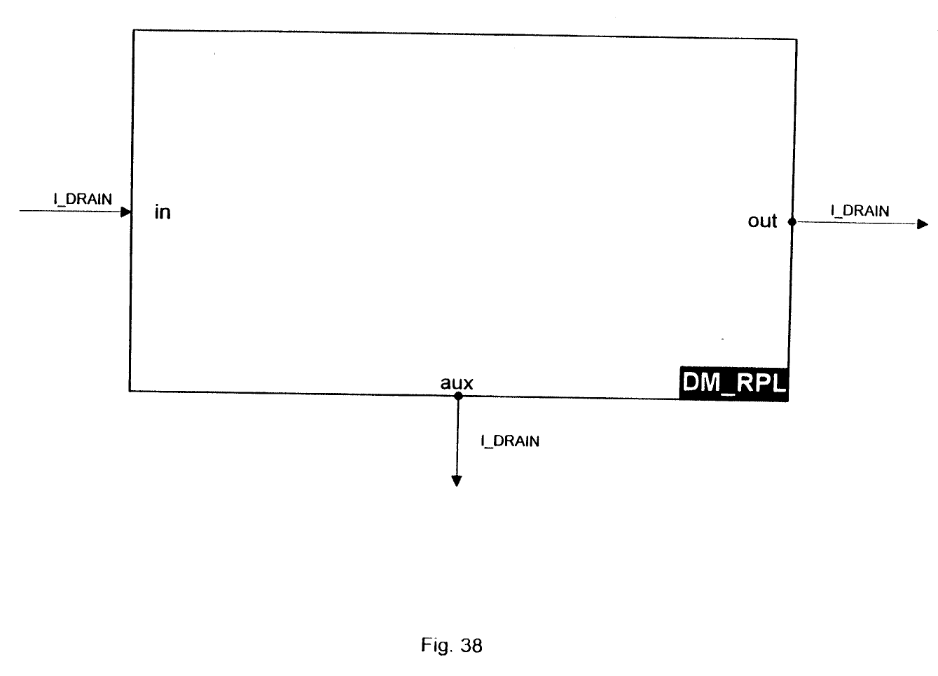

FIG. 38 illustrates the boundary of the inventive DM_RPL part.

DM_RPL is a connectivity part. DM_RPL passes the events received on its in terminal to the out terminal and, in addition, duplicates them and sends the duplicates to its aux terminal.

The status returned by the operation on the out terminal is propagated back to the sender of the event.

Optionally, DM_RPL can be programmed (through property) to send the duplicates before it passes the event out.

The duplicate events are allocated using the ClassMagic event allocation mechanism and are always self-owned. All other attributes are kept intact.

12. Boundary

12.1. Terminals

Terminal “in” with direction “In” and contract I_DRAIN. Note: All input events received here are forwarded to out terminal. The status returned is the one returned by the operation on the out terminal. If out terminal is not connected, the operation returns CMST_NOT_CONNECTED. Unguarded. Can be connected when the part is active.

Terminal “out” with direction “Out” and contract I_DRAIN. Note: All events received on in terminal are forwarded through here. Can be connected when the part is active.

Terminal “aux” with direction “Out” and contract I_DRAIN. Note: All duplicate events are sent through here. Can be connected when the part is active.

12.2. Events and Notifications

Each event received on in terminal is forwarded to the out terminal and a duplicate event is sent out through the aux terminal.

12.3. Special Events, Frames, Commands or Verbs

None.

12.4. Properties

Property “aux_first” of type “UINT32”. Note: Set to TRUE to send the duplicate events (going through aux terminal) first—before the original event is passed through the out terminal. Default: FALSE.

13. Encapsulated Interactions

None.

14. Specification

15. Responsibilities

6. Pass all events coming on in to out.

7. Duplicate events coming on in and send the duplicates to aux.

16. Theory of Operation

DM_RPL duplicates the incoming events and sends the duplicates through a separate terminal. The memory for the duplicates is allocated using pool allocation (provided by the ClassMagic engine).

DM_SEQ—Event Sequencer

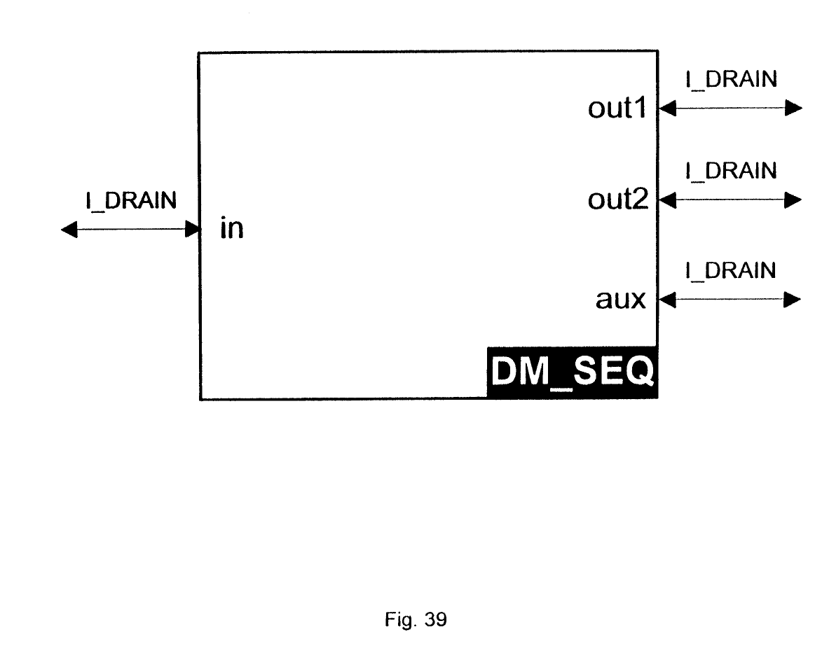

FIG. 39 illustrates the boundary of the inventive DM_SEQ part.

The primary function of DM_SEQ is to distribute incoming events received on in to the parts connected to the out1 and out2 terminals.

The incoming event IDs are parameterized on DM_SEQ—DM_SEQ supports up to 16 events. Each event has a corresponding distribution discipline and cleanup event ID (also specified through properties). These properties describe how the events are distributed and also upon failure, the cleanup event that should be sent.

DM_SEQ supports four distribution disciplines: fwd_ignore, bwd_ignore, fwd_cleanup, bwd_cleanup. Events may be distributed either sequentially (out1..out2) or backwards (out2..out1). The main difference is whether DM_SEQ ignores the return status from the event processing (fwd_ignore, bwd_ignore) or takes it into account (fwd_cleanup, bwd_cleanup). See the Mechanisms section for more information on the distribution disciplines.

The events sent through out1 and out2 can be completed either synchronously or asynchronously—DM_SEQ takes care of the proper sequencing, completion and necessary cleanup.

Unrecognized events received on in or aux are passed out through the opposite terminal without modification. This enables DM_SEQ to be inserted in any event flow and provides greater flexibility.

17. Boundary

17.1. Terminals

Terminal “in” with direction “Plug” and contract I_DRAIN. Note: v-table, synchronous, cardinality 1 Incoming events for distribution are received here. All recognized events are distributed according to their discipline. All unrecognized events are passed through aux. Unrecognized events (received from aux) are sent out this terminal.

Terminal “out1” with direction “Plug” and contract I_DRAIN. Note: v-table, synchronous, cardinality 1 Event distribution terminal. The distribution depends upon the discipline of the event received on in.

Terminal “out2” with direction “Plug” and contract I_DRAIN. Note: v-table, synchronous, cardinality 1 Event distribution terminal. The distribution depends upon the discipline of the event received on in.

Terminal “aux” with direction “Plug” and contract I_DRAIN. Note: v-table, synchronous, cardinality 1, floating Unrecognized events received from this terminal are passed out in. Unrecognized events received from in are passed out this terminal.

17.2. Events and Notifications

DM_SEQ is parameterized with the event IDs of the events it distributes to out1 and out2. When one of these events are received from in, DM_SEQ distributes the event according to its discipline. If the distribution fails and the discipline allows cleanup, DM_SEQ distributes the cleanup event in the reverse order from where the distribution failed.

If the event received on in can be distributed asynchronously, DM_SEQ will send a completion event through in when the event distribution has completed.

If the event sent through out1 or out2 can be completed asynchronously, the completion event bus must be the same (or similar) for all the events DM_SEQ handles.

All unrecognized events received from either in or aux are passed through the opposite terminal without modification.

17.3. Special Events, Frames, Commands or Verbs

None.

17.4. Properties

Property “unsup_ok” of type “BOOL”. Note: If TRUE, a return status of CMST_NOT_SUPPORTED from the event distribution terminals out1 or out2 is remapped to CMST_OK. Default is TRUE.

Property “async_cplt_attr” of type “UINT32”. Note: Value of the attribute that signifies a recognized event received from in can be processed asynchronously. The default is: EVT_A_ASYNC_CPLT

Property “cplt_attr” of type “UINT32”. Note: Value of the attribute that signifies that the processing of the asynchronous event distributed to out1 or out2 has been completed. When an event distributed through out1 or out2 is processed asynchronously, the completion event passed back to DM_SEQ is expected to have this attribute set. The default is: EVT_A_COMPLETED

Property “cplt_s_offs” of type “UINT32”. Note: Offset in completion event bus for the completion status. The size of the storage must be at least sizeof (cmstat). Default is 0x0C. (first field in event bus after standard fields id, sz and attr)

Property “ev[0].ev_id-ev[15].ev_id” of type “UINT32”. Note: Event IDs that DM_SEQ distributes to out1 and out2 when received on the in terminal. The default values are EV_NULL.

Property “ev[0].disc-ev[15].disc” of type “ASCIZ”. Note: Distribution disciplines for ev[0].ev_id-ev[15].ev_id, can be one of the following: fwd_ignore bwd_ignore fwd_cleanup bwd_cleanup See the Mechanisms section for descriptions of the disciplines. The default values are fwd ignore.

Property “ev[0].cleanup id-ev[15].cleanup_id” of type “UINT32”. Note: Event IDs used for cleanup if the event distribution fails. The cleanup event is not sent if it is EV_NULL. Cleanup events are used only if the distribution discipline is fwd_cleanup or bwd_cleanup. The default values are EV_NULL.

18. Encapsulated Interactions

None.

19. Specification

20. Responsibilities

1. or all unrecognized events received from in, pass out aux without modification.

2. For all unrecognized events received from aux, pass out in without modification.

3. For all recognized events received from in, distribute them to out1 and out2 according to their corresponding discipline (parameterized through properties—see the Mechanisms section for definitions of the distribution disciplines).

4. Allow both synchronous and asynchronous completion of the distributed events.

5. Fail the event distribution if a recognized synchronous event received on in is processed asynchronously by out1 or out2.

6. Track events and their sequences, ignoring events that come out-of-sequence (e.g., completion coming back through a terminal on which DM_SEQ did not initiate an operation; or getting a new event through in while event distribution is in progress).

7. Do not process any new recognized events while event distribution is pending.

8. If so configured, remap the status CMST_NOT_SUPPORTED received from the event distribution to CMST_OK.

21. Theory of Operation

21.1. State Machine

None.

21.2. Main Data Structures

None.

21.3. Mechanisms

Event Distribution Disciplines

The following disciplines are used to define how the recognized events received on in are distributed to out1 and out2. These are specified for each event through properties. There is a one-to-one correspondence between a recognized event, cleanup event, and the event distribution discipline.

fwd_ignore (broadcast event forward and ignore return status):

Send event through out1, ignore return status (if CMST_PENDING, return to the caller—processing of asynchronous event is pending).

Send event through out2, ignore return status (if CMST_PENDING, return to the caller—processing of asynchronous event is pending).

Complete event distribution with CMST_OK.

bwd_ignore (broadcast event backwards and ignore return status):

Send event through out2, ignore return status (if CMST_PENDING, return to the caller—processing of asynchronous event is pending).

Send event through out1, ignore return status (if CMST_PENDING, return to the caller—processing of asynchronous event is pending).

Complete event distribution with CMST_OK.

fwd_cleanup (broadcast event forward and cleanup on failure):

Send event through out1, save return status

If status is CMST_PENDING, return to the caller—processing of asynchronous event is pending. When asynchronous event has completed, extract completion status.

If return status or completion status is not CMST_OK, complete event distribution with failed status

Send event through out2, save return status

If status is CMST_PENDING, return to the caller—processing of asynchronous event is pending. When asynchronous event has completed, extract completion status.

If return status or completion status is not CMST_OK and the cleanup event id is not EV_NULL, send the cleanup event through out1 and ignore the return status (if CMST_PENDING, return to the caller—processing of asynchronous event is pending. Continue to next step only when event processing has completed).

Complete event distribution with the failed status or CMST_OK if the event was distributed successfully.

bwd_cleanup (broadcast event backwards and cleanup on failure):

Send event through out2, save return status

If status is CMST_PENDING, return to the caller—processing of asynchronous event is pending. When asynchronous event has completed, extract completion status.

If return status or completion status is not CMST_OK, complete event distribution with failed status

Send event through out1, save return status

If status is CMST_PENDING, return to the caller—processing of asynchronous event is pending. When asynchronous event has completed, extract completion status.

If return status or completion status is not CMST_OK and the cleanup event id is not EV_NULL, send the cleanup event through out2 and ignore the return status (if CMST_PENDING, return to the caller—processing of asynchronous event is pending. Continue to next step only when event processing has completed).

Complete event distribution with the failed status or CMST_OK if the event was distributed successfully.

Note that depending on the value of the unsup_ok property, a CMST_NOT SUPPORTED return status from out1 or out2 may be mapped to CMST_OK and the event distribution will continue.

Synchronous and Asynchronous Sequencing

DM_SEQ uses sequencer tables that define the steps taken for each distribution discipline defined above. Steps are performed only after the previous step has completed. Each step may be completed either synchronously (getting any status other than CMST_PENDING) or asynchronously (getting a CMST_PENDING status).

DM_SEQ uses a sequencer to execute each of the steps, including any cleanups. As long as steps complete synchronously, DM_SEQ feeds events automatically into the sequencer to advance to the next step; when an event gets desynchronized (returns CMST_PENDING), DM_SEQ uses the respective completion event (the same event with the cplt_attr attribute set) to resume feeding the sequencer. When the distribution is complete, DM_SEQ sends the same event with the cplt_attr attribute set out the in terminal (only if the original event received from in specified asynchronous completion).

Preventing Reentrancy

When DM_SEQ receives a completion indication from out1 or out2, it posts a message to itself and processes the indication asynchronously. This prevents recursion into the part that sent the completion indication.

Recognizing Out-of-Sequence Events

DM_SEQ keeps in its state what was the last event or request it sent out and through which terminal it sent it (out1 or out2). When it gets a completion indication, DM_SEQ asserts that the terminal is the same and the completed operation was the one DM_SEQ requested.

If they match, DM_SEQ proceeds with the next step in the sequence. Otherwise, it ignores the indication and prints a message to the debug console.

DM_SEQ handles out-of-order requests on in: if it receives a new recognized event on in while it is in the middle of event distribution (at any stage), DM_SEQ fails that new event/request and prints a message to the debug console.

Generating Cleanup Events

The cleanup events sent by DM_SEQ are allocated dynamically (not on the stack). The attributes and size of the event depend upon whether the original event is allowed to complete asynchronously. The rules are as follows:

If the original event is only allowed to complete synchronously:

size=sizeof (CMEVENT_HDR)

attributes=CMEVT_A_SELF_CONTAINED|CMEVT_A_SYNC

If the original event is allowed to complete asynchronously:

size=cplt_s_offs+sizeof (cmstat)

attributes=CMEVT_A_SELF_CONTAINED|CMEVT_A_SYNC|async_cplt_attr

22. Notes

1. DM_SEQ does not allow self-owned events (CMEVT_A_SELF_OWNED) to be distributed through its terminals. Upon receiving such an event, DM_SEQ fails with CMST_REFUSE.

DM_SEOT—Event Sequencer on Thread

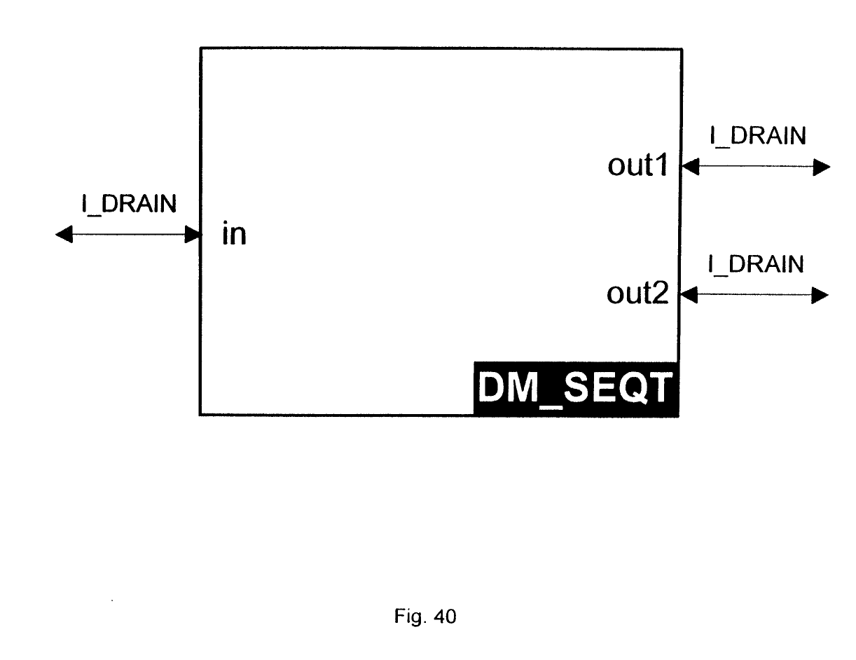

FIG. 40 illustrates the boundary of the inventive DM_SEQT part.

The primary function of DM_SEQT is to distribute incoming events received on in to the parts connected to the out1 and out2 terminals. The events sent through out1 and out2 are in the context of DM_SEQT's worker thread (unlike DM_SEQ where the events are in the context of the DriverMagic's pump thread). Each instance of DM_SEQT preferably has its own worker thread.

The incoming event IDs are parameterized on DM_SEQT—DM_SEQT supports up to 16 events. Each event has a corresponding distribution discipline and cleanup event ID (also specified through properties). These properties describe how the events are distributed and also upon failure, the cleanup event that should be sent.

DM_SEQT supports four distribution disciplines: fwd_ignore, bwd_ignore, fwd_cleanup, bwd_cleanup. Events may be distributed either sequentially (out1..out2) or backwards (out2..out1). The main difference is whether DM_SEQT ignores the return status from the event processing (fwd_ignore, bwd_ignore) or takes it into account (fwd_cleanup, bwd_cleanup). See the Mechanisms section for more information on the distribution disciplines.

The events sent through out1 and out2 can be completed either synchronously or asynchronously—DM_SEQT takes care of the proper sequencing, completion and necessary cleanup.

Unrecognized events received on in or aux are passed out through the opposite terminal without modification. This enables DM_SEQT to be inserted in any event flow and provides greater flexibility.

23. Boundary

23.1. Terminals

Terminal “in” with direction “Plug” and contract I_DRAIN. Note: v-table, synchronous, cardinality 1 Incoming events for distribution are received here. All recognized events are distributed according to their discipline.

Terminal “out1” with direction “Plug” and contract I_DRAIN. Note: v-table, synchronous, cardinality 1 Event distribution terminal. The distribution depends upon the discipline of the event received on in.

Terminal “out2” with direction “Plug” and contract I_DRAIN. Note: v-table, synchronous, cardinality 1 Event distribution terminal. The distribution depends upon the discipline of the event received on in.

23.2. Events and Notifications

DM_SEQT is parameterized with the event IDs of the events it distributes to out1 and out2. When one of these events are received from in, DM_SEQT distributes the event according to its discipline. If the distribution fails and the discipline allows cleanup, DM_SEQT distributes the cleanup event in the reverse order from where the distribution failed.

If the event received on in can be distributed asynchronously, DM_SEQT will send a completion event through in when the event distribution has completed.

23.3. Special Events, Frames, Commands or Verbs

None.

23.4. Properties

Property “thread_priority” of type “UINT32”. Note: Specifies the priority of the worker thread. The values for this property depend on the environment. It is used directly to call the environment specific function that sets the thread priority (SetThreadPriority in Win32, KeSetPriorityThread in WDM, etc.). This property is redirected to the RDWT subordinates.

Property “disable_diag” of type “UINT32”. Note: Boolean. This determines whether DM_RDWT prints debug output indicating that a call through out failed. A call through out fails if the return status is not equal to ok-stat. This property affects only the checked build of DM_RDWT. This property is redirected to the RDWT subordinates. Default is FALSE.

Property “cplt_s_offs” of type “UINT32”. Note: Offset in bytes of the completion status in the request bus. This property is redirected to the RDWT and SEQ subordinates. Mandatory.

Property “ev[0].ev_id-ev[15].ev₁₃ id” of type “UINT32”. Note: Event IDs that DM_SEQT distributes to out1 and out2 when received on the in terminal. This property is redirected to the SEQ subordinate. The default values are EV_NULL.

Property “ev[0].disc-ev[15].disc” of type “ASCIZ”. Note: Distribution disciplines for ev[0].ev_id-ev[15].ev_id, can be one of the following: fwd_ignore bwd_ignore fwd_cleanup bwd_cleanup See the Mechanisms section of the DM_SEQ documentation for descriptions of the disciplines. This property is redirected to the SEQ subordinate. The default values are fwd ignore.

Property “ev[0].cleanup id-ev[15].cleanup_id” of type “UINT32”. Note: Event IDs used for cleanup if the event distribution fails. The cleanup event is not sent if it is EV_NULL. Cleanup events are used only if the distribution discipline is fwd_cleanup or bwd_cleanup. This property is redirected to the SEQ subordinate. The default values are EV_NULL.

24. Encapsulated Interactions

None.

25. Specification

26. Responsibilities

1. For all recognized events received from in, distribute them to out1 and out2 according to their corresponding discipline (parameterized through properties).

2. Allow both synchronous and asynchronous completion of the distributed events.

3. Fail the event distribution if a recognized synchronous event received on in is processed asynchronously by out1 or out2.

4. Track events and their sequences, ignoring events that come out-of-sequence (e.g., completion coming back through a terminal on which DM_SEQT did not initiate an operation; or getting a new event through in while event distribution is in progress).

5. Do not process any new recognized events while event distribution is pending.

6. If so configured, remap the status CMST_NOT_SUPPORTED received from the event distribution to CMST_OK.

7. Distribute all events passed out of out1 and out2 in the context of DM_SEQT's own worker thread.

27. Internal Definition

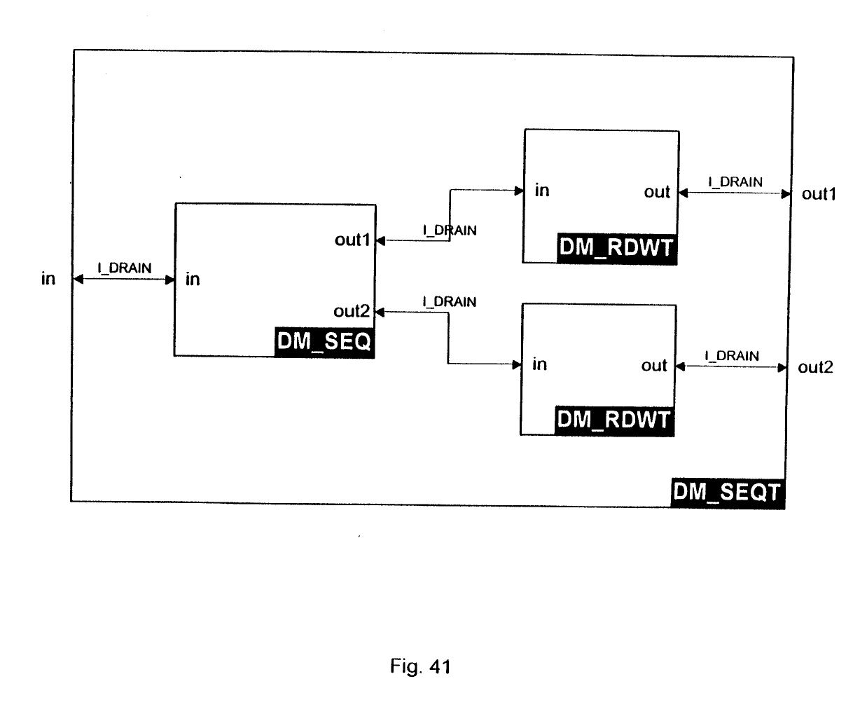

FIG. 41 illustrates the internal structure of the inventive DM_SEQT part.

28. Theory of Operation

DM_SEQT is an assembly built entirely of DriverMagic parts.

The events received through the in terminal are distributed to out1 and out2 according to their discipline. All events passed out of out1 and out2 are in the context of DM_SEQT's own worker threads, one for each channel.

Please see the DM_SEQ data sheet for more information about the sequencer and how it works.

28.1. Mechanisms

Event Distribution Disciplines

The following disciplines are used to define how the recognized events received on in are distributed to out1 and out2. These are specified for each event through properties. There is a one-to-one correspondence between a recognized event, cleanup event, and the event distribution discipline.

fwd_ignore (broadcast event forward and ignore return status):

Send event through out1, ignore return status (if CMST_PENDING, return to the caller—processing of asynchronous event is pending).

Send event through out2, ignore return status (if CMST_PENDING, return to the caller—processing of asynchronous event is pending).

Complete event distribution with CMST_OK.

bwd_ignore (broadcast event backwards and ignore return status):

Send event through out2, ignore return status (if CMST_PENDING, return to the caller—processing of asynchronous event is pending).

Send event through out1, ignore return status (if CMST_PENDING, return to the caller—processing of asynchronous event is pending).

Complete event distribution with CMST_OK.

fwd_cleanup (broadcast event forward and cleanup on failure):

Send event through out1, save return status If status is CMST_PENDING, return to the caller—processing of asynchronous event is pending. When asynchronous event has completed, extract completion status.

If return status or completion status is not CMST_OK, complete event distribution with failed status

Send event through out2, save return status

If status is CMST_PENDING, return to the caller—processing of asynchronous event is pending. When asynchronous event has completed, extract completion status.

If return status or completion status is not CMST_OK and the cleanup event id is not EV_NULL, send the cleanup event through out1 and ignore the return status (if CMST_PENDING, return to the caller—processing of asynchronous event is pending. Continue to next step only when event processing has completed).

Complete event distribution with the failed status or CMST_OK if the event was distributed successfully.

bwd_cleanup (broadcast event backwards and cleanup on failure):

Send event through out2, save return status

If status is CMST_PENDING, return to the caller—processing of asynchronous event is pending. When asynchronous event has completed, extract completion status.

If return status or completion status is not CMST_OK, complete event distribution with failed status

Send event through out1, save return status

If status is CMST_PENDING, return to the caller—processing of asynchronous event is pending. When asynchronous event has completed, extract completion status.

If return status or completion status is not CMST_OK and the cleanup event id is not EV_NULL, send the cleanup event through out2 and ignore the return status (if CMST_PENDING, return to the caller—processing of asynchronous event is pending. Continue to next step only when event processing has completed).

Complete event distribution with the failed status or CMST_OK if the event was distributed successfully.

Note that depending on the value of the unsup_ok property, a CMST_NOT SUPPORTED return status from out1 or out2 may be mapped to CMST_OK and the event distribution will continue.

Synchronous and Asynchronous Sequencing

DM_SEQT uses sequencer tables that define the steps taken for each distribution discipline defined above. Steps are performed only after the previous step has completed. Each step may be completed either synchronously (getting any status other than CMST_PENDING) or asynchronously (getting a CMST_PENDING status).

DM_SEQT uses a sequencer to execute each of the steps, including any cleanups. As long as steps complete synchronously, DM_SEQT feeds events automatically into the sequencer to advance to the next step; when an event gets desynchronized (returns CMST_PENDING), DM_SEQT uses the respective completion event (the same event with the cplt_attr attribute set) to resume feeding the sequencer. When the distribution is complete, DM_SECT sends the same event with the cplt_attr attribute set out the in terminal (only if the original event received from in specified asynchronous completion).

Preventing Reentrancy

When DM_SEQT receives a completion indication from out1 or out2, it posts a message to itself and processes the indication asynchronously. This prevents recursion into the part that sent the completion indication.

Recognizing Out-of-Sequence Events

DM_SEQT keeps in its state what was the last event or request it sent out and through which terminal it sent it (out1 or out2). When it gets a completion indication, DM_SEQT asserts that the terminal is the same and the completed operation was the one DM_SEQT requested.

If they match, DM_SEQT proceeds with the next step in the sequence. Otherwise, it ignores the indication and prints a message to the debug console.

DM_SEQT handles out-of-order requests on in: if it receives a new recognized event on in while it is in the middle of event distribution (at any stage), DM_SEQT fails that new event/request and prints a message to the debug console.

Generating Cleanup Events

The cleanup events sent by DM_SEQT are allocated dynamically (not on the stack). The attributes and size of the event depend upon whether the original event is allowed to complete asynchronously. The rules are as follows:

If the original event is only allowed to complete synchronously:

size=sizeof (CMEVENT_HDR)

attributes=CMEVT_A_SELF_CONTAINED|CMEVT_A_SYNC

If the original event is allowed to complete asynchronously:

size =cplt_s_offs+sizeof (cmstat)

attributes=CMEVT_A_SELF_CONTAINED|CMEVT_A_SYNC|async_cplt_attr

29. Subordinate's Responsibilities

29.1. DM_SEQ—Event Sequencer

For all recognized events received from in, distribute them to out1 and out2 according to their corresponding discipline

Track events and their sequences, ignoring events that come out-of-sequence (e.g., completion coming back through a terminal on which DM_SEQ did not initiate an operation; or getting a new event through in while event distribution is in progress).

29.2. DM_RDWT—Request Desynchronizer with Thread

Desynchronize all incoming requests received from in and send them through out. Use a dedicated worker thread to call the out terminal.

30. Dominant's Responsibilities

30.1. Hard Parameterization of Subordinates

| Subordinate | Property | Value |
|---|---|---|
| SEQ | cplt_attr | CMEVT_A_COMPLETED |
| | async_cplt_attr | CMEVT_A_ASYNC_CPLT |

30.2. Distribution of Properties to the Subordinates

| Property Name | Type | Dist | To |
|---|---|---|---|
| unsup_ok | UINT32 | Redir | seq.unsup_ok |
| ev[0].ev_id- | UINT32 | Redir | seq.ev[0].ev_id- |
| ev[15].ev_id | | | seq.ev[15].ev_id |
| ev[0].disc- | UINT32 | Redir | seq.ev[0].disc- |
| ev[15].disc | | | seq.ev[15].disc |
| ev[0].cleanup_id- | UINT32 | Redir | seq.ev[0].cleanup_id- |
| ev[15].cleanup_id | | | seq.ev[15].cleanup_id |

31. Notes

1. DM_SEQT does not allow self-owned events (CMEVT_A_SELF_OWNED) to be distributed through its terminals. Upon receiving such an event, DM_SEQT fails with CMST_REFUSE.

DM_LFS—Life-Cycle Sequencer

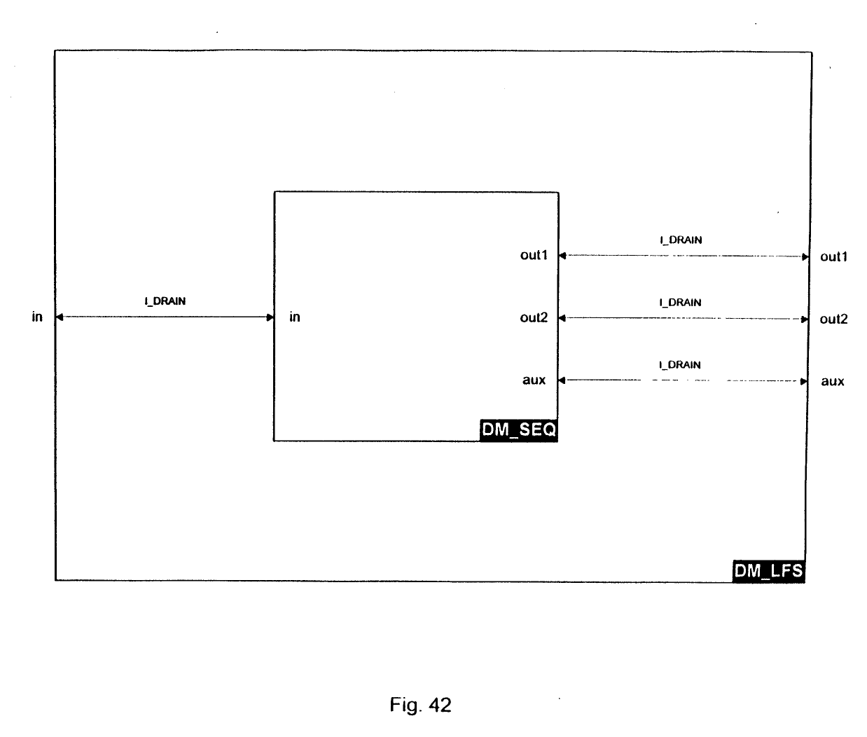

FIG. 42 illustrates the boundary of the inventive DM_LFS part.

The primary function of DM_LFS is to distribute incoming life-cycle events received on in to the parts connected to the out1 and out2 terminals.

DM_LFS relies on DM_SEQ for the event distribution functionality. DM_LFS parameterizes DM_SEQ with life-cycle events (defined below). See the hard parameterization section below for a list of life-cycle events that DM LFS handles. Additional events may be distributed by setting properties on DM LFS. For more information about the event distribution, see the DM_SEQ documentation.

32. Boundary

32.1. Redirected Terminals

All the following terminals are redirected to DM_SEQ:

Terminal “in” with direction “Plug” and contract I_DRAIN. Note: v-table, synchronous, cardinality 1 Incoming events for distribution are received here. All recognized events are distributed according to their discipline. All unrecognized events are passed through aux. Unrecognized events (received from aux) are sent out this terminal.

Terminal “out1” with direction “Plug” and contract I_DRAIN. Note: v-table, synchronous, cardinality 1 Event distribution terminal. The distribution depends upon the discipline of the event received on in.

Terminal “out2” with direction “Plug” and contract I_DRAIN. Note: v-table, synchronous, cardinality 1 Event distribution terminal. The distribution depends upon the discipline of the event received on in.

Terminal “aux” with direction “Plug” and contract I_DRAIN. Note: v-table, synchronous, cardinality 1, floating Unrecognized events received from this terminal are passed out in. Unrecognized events received from in are passed out this terminal.

32.2. Events and Notifications

DM_LFS parameterizes DM_SEQ to handle life-cycle events. The remaining events that can be handled by DM_SEQ can be parameterized from the outside of DM_LFS. These are redirected properties on DM_LFS; see below for more details.

32.3. Special Events, Frames, Commands or Verbs

None.

32.4. Redirected Properties

All the following properties are redirected to DM_SEQ:

Property “unsup_ok” of type “BOOL”. Note: If TRUE, a return status of CMST_NOT SUPPORTED from the event distribution terminals out1 or out2 is remapped to CMST_OK. Default is TRUE.

Property “ev[0].ev_id-ev[11].ev_id” of type “UINT32”. Note: Event IDs that DM LFS distributes to out1 and out2 when received on the in terminal. The default values are EV NULL.

Property “ev[0].disc-ev[11].disc” of type “ASCIZ”. Note: Distribution disciplines for ev[0].ev_id-ev[8].ev_id, can be one of the following: fwd_ignore bwd_ignore fwd_cleanup bwd_{—cleanup See the DM}_SEQ documentation for descriptions of the disciplines. The default values are fwd ignore.

Property “ev[0].cleanup_id-evt[11].cleanup_id” of type “UINT32”. Note: Event IDs used for cleanup if the event distribution fails. The cleanup event is not sent if it is EV_NULL. Cleanup events are used only if the distribution discipline is fwd_cleanup or bwd_cleanup. The default values are EV_NULL.

32.5. Hard Parameterization

All the following properties are set on DM_SEQ:

Property “unsup_ok” of type “BOOL”. Note: TRUE

Property “async_cplt_attr” of type “UINT32”. Note: EVT_A_ASYNC_CPLT

Property “cplt_attr” of type “UINT32”. Note: EVT_A COMPLETED

Property “cplt_s_offs” of type “UINT32”. Note: 0x0C

Property “ev[0].ev_id” of type “UINT32”. Note: EV_LFC_REQ_START

Property “ev[0].disc” of type “ASCIZ”. Note: “fwd_cleanup”

Property “ev[0].cleanup_id” of type “UINT32”. Note: EV_LFC_REQ_STOP

Property “ev[1].ev_id” of type “UINT32”. Note: EV LFC_REQ_STOP

Property “ev[1].disc” of type “ASCIZ”. Note: “bwd_ignore”

Property “ev[1].cleanup_id” of type “UINT32”. Note: EV_NULL

Property “ev[2].ev_id” of type “UINT32”. Note: EV_LFC_REQ_DEV_PAUSE

Property “ev[2].disc” of type “ASCIZ”. Note: “bwd_cleanup”

Property “ev[2].cleanup_id” of type “UINT32”. Note: EV_LFC_REQ_DEV_RESUME

Property “ev[3].ev_id” of type “UINT32”. Note: EV_LFC_REQ_DEV_RESUME

Property “ev[3].disc” of type “ASCIZ”. Note: “fwd_cleanup”

Property “ev[3].cleanup_id” of type “UINT32”. Note: EV_LFC_REQ_DEV_PAUSE

33. Encapsulated Interactions

None.

DM_MUX—Event-Controlled Multiplexer

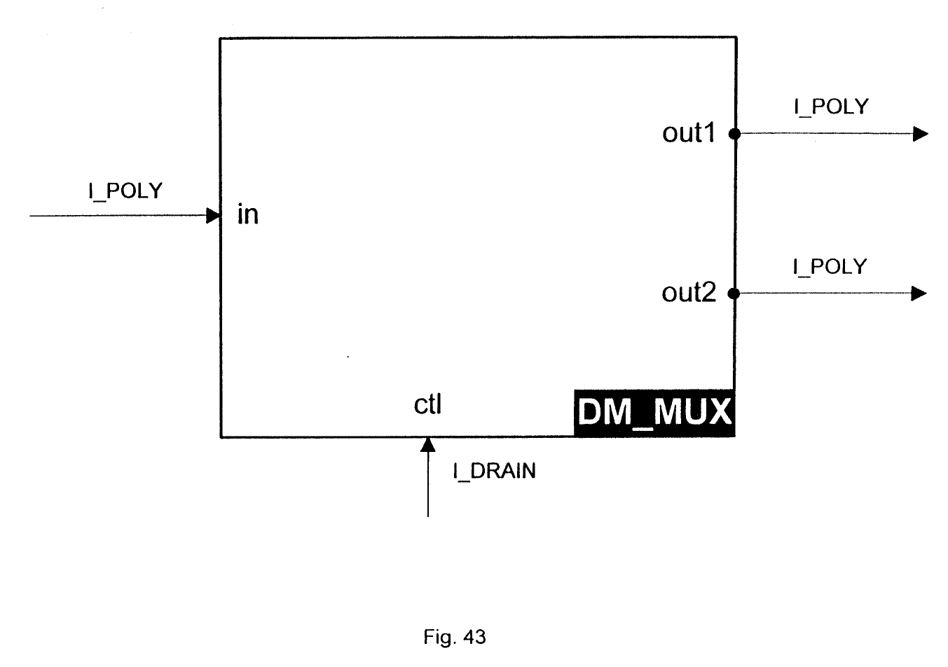

FIG. 43 illustrates the boundary of the inventive DM_MUX part.

DM_MUX forwards operations received on its in input to either its out1 or out2 outputs. The outgoing terminal, which DM MUX forwards incoming operations to, is controlled via three events it receives on its ctl terminal.

DM_MUX is parameterized with the three events via properties. One event switches outgoing operations to out1, one event switches outgoing operations to out2, and the last event toggles the outgoing operation terminal (i.e., out1 if out2 is selected and out2 if out1 is selected) By default, DM_MUX forwards operations received its in terminal to its out1 terminal.

34. Boundary

34.1. Terminals

Terminal “in” with direction “in” and contract I_POLY. Note: v-table, infinite cardinality, unguarded. Operations received are forwarded to either out1 or out2.

Terminal “out1” with direction “out” and contract I_POLY. Note: Output for forwarded operations.

Terminal “out2” with direction “out” and contract I_POLY. Note: Output for forwarded operations.

Terminal “ctl” with direction “in” and contract I_DRAIN. Note: v-table, infinite cardinality, unguarded. Receive events that control multiplexer switching.

34.2. Events and Notifications

DM_MUX recognizes three specific events: ev_out1, ev_out2 and ev_toggle on its ctl terminal. The event IDs for these events are specified as properties and are described in the table below.

| Incoming | | |
|---|---|---|
| Event | Bus | Notes |
| (ev_out1) | CMEVENT_{—} | Select out1 for outgoing |
| | HDR | operations. |
| | | The default is |
| | | EV_REQ_ENABLE. |
| (ev_out2) | CMEVENT_{—} | Select out2 for outgoing |
| | HDR | operations. |
| | | The default is |
| | | EV_REQ_DISABLE. |
| (ev_toggle) | CMEVENT_{—} | Select the other output for |
| | HDR | outgoing operations (i.e., |
| | | out1 if out2 is selected and |
| | | out2 if out1 is selected). |
| | | The default is EV_NULL. |

34.3. Special Events, Frames, Commands or Verbs

None.

34.4. Properties

Property “ev_out1” of type “UINT32”. Note: Event ID to switch to out1.

Property “ev_out2” of type “UINT32”. Note: Event ID to switch to out2.

Property “ev_toggle” of type “UINT32”. Note: Event ID to switch to the other output (i.e., out1 if out2 is selected and out2 if out1 is selected).

35. Encapsulated Interactions

None.

36. Specification

37. Responsibilities

1. Forward operations received on in to out1 or out2 based upon control events received on ctl terminal.

38. Theory of Operation

38.1. State Machine

DM_MUX keeps state as to which outx terminal it is to forward operations received on its in terminal to. The state is controlled by the events it receives on its ctl input. DM MUX uses InterlockedExchange( ) to update its state. By default, DM_MUX's state specifies that it is to forward operations to its out1 terminal.

ZP_SWP and ZP_SWPB—Property-Controlled Switches

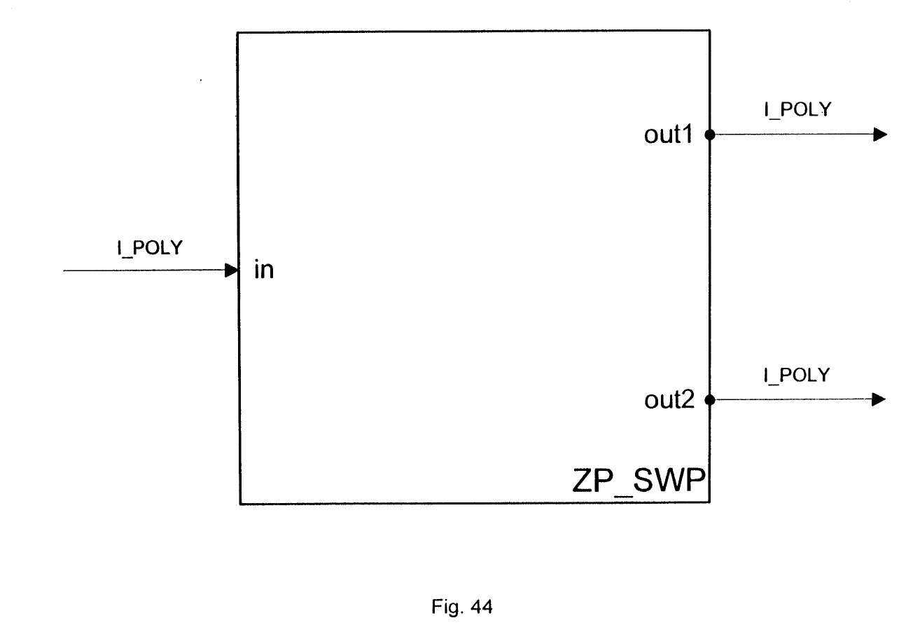

FIG. 44 illustrates the boundary of the inventive DM_SWP part.

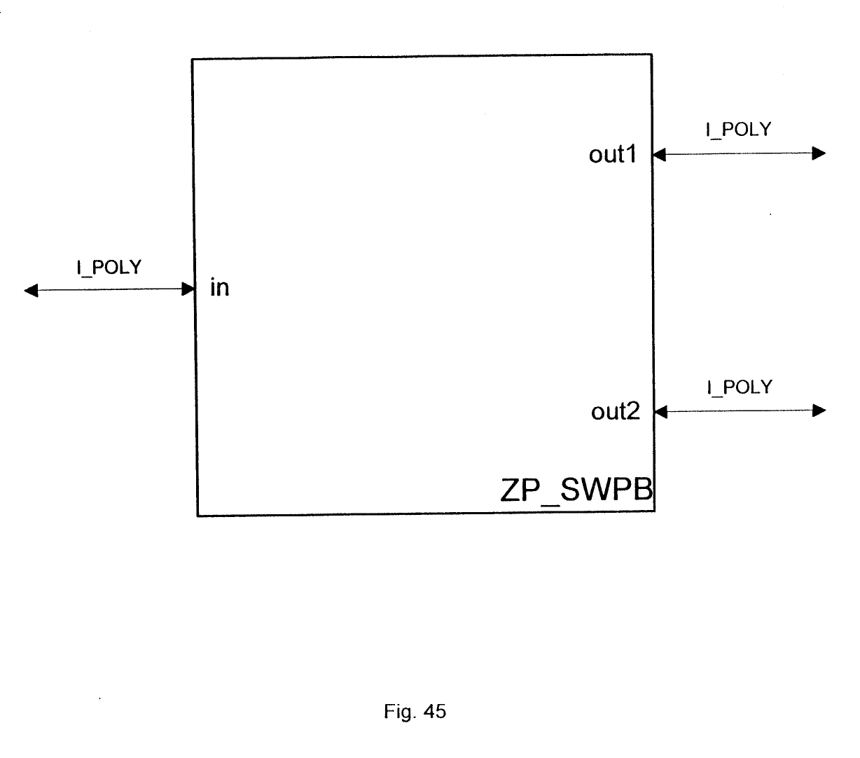

FIG. 45 illustrates the boundary of the inventive DM_SWPB part.

The property-controlled switches forward operations received on the in input to one of their outputs (out1 or out2).

The selection of the outgoing terminal is controlled by the value of a property that is modifiable while the part is active. When the value of property falls within a programmable range (defined by the min, max and mask properties), all events received on the in terminal are forwarded through the out1 terminal; otherwise they are forwarded through the out2 terminal.

ZP_SWPB is a bi-directional version of ZP_SWP. In the in to out direction it operates exactly as ZP_SWP. It forwards all operations received on its out1 and out2 terminals to the in terminal.

These parts provide a way to direct a flow of operations through different paths, depending on the value of a property that can be modified dynamically.

39. Boundary

39.1. Terminals (ZP_SWP)

Terminal “in” with direction “in” and contract I_POLY. Note: v-table, infinite cardinality, unguarded. Operations received are forwarded to either out1 or out2.

Terminal “out1” with direction “out” and contract I_POLY. Note: Output for forwarded operations.

Terminal “out2” with direction “out” and contract I_POLY. Note: Output for forwarded operations.

39.2. Terminals (ZP_SWPB)

Terminal “in” with direction “Bidir” and contract I_POLY. Note: v-table, infinite cardinality, unguarded. Operations received are forwarded to either out1 or out2.

Terminal “out1” with direction “Bidir” and contract I_POLY. Note: Output for forwarded operations. Operations received are forwarded to in.

Terminal “out2” with direction “Bidir” and contract I_POLY. Note: Output for forwarded operations. Operations received are forwarded to in.

39.3. Properties

Property “val” of type “uint32”. Note: This property is modifiable. Specifies the value used to determine which terminal the operation is sent out. ZP_SWP/ZP_SWPB masks the value of this property with mask before comparing it to min and max. Default is 0.

Property “mask” of type “uint32”. Note: Bitwise mask ANDed with the value of val property. before comparing it to min and max. Default is 0xFFFFFFFF (no change).

Property “min” of type “uint32”. Note: Lower boundary of the out1 operations. This is the lowest integer value (inclusive) of the val property upon which all operations will be forwarded through out1 terminal. Default is 0.

Property “max” of type “uint32”. Note: Upper boundary of the out1 operations. This is the upper most integer value of the val property (inclusive) upon which all operations will be forwarded through out1 terminal. Default is 0xFFFFFFFF.

39.4. Events and Notifications

None.

39.5. Special Events, Frames, Commands or Verbs

None.

40. Encapsulated Interactions

None.

41. Specification

42. Responsibilities

1. Forward operations received on in to out1 or out2 based the value of val property.

2. (ZP_SWPB) Forward operations received on out1 and out2 to in.

ZP_CDM, ZP_CDMB—Connection Demultiplexers

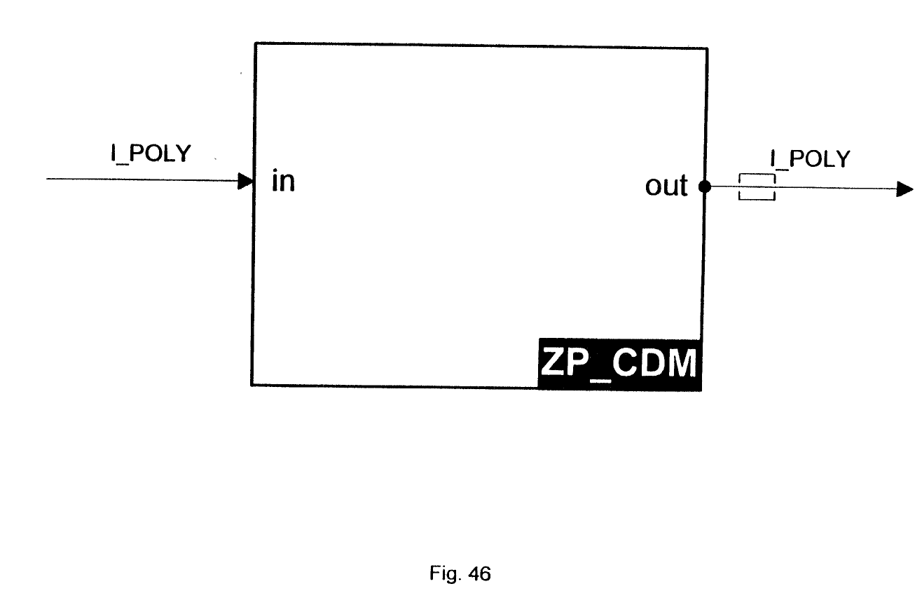

FIG. 46 illustrates the boundary of the inventive DM_CDM part.

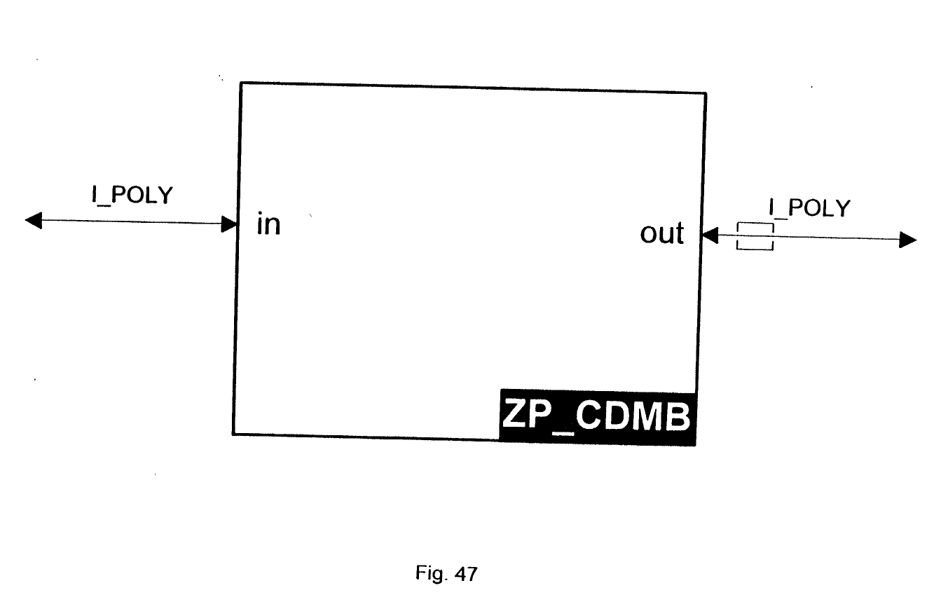

FIG. 47 illustrates the boundary of the inventive DM_CDMB part.

ZP_CDM and ZP_CDMB demultiplex operations received on their input to one of the connections of their multiplexed output terminal. ZP_CDM(B) picks the ID of the connection to which the output is directed from a fixed offset in the operation bus. This offset and the data field size are programmable as properties.

All operations received on the out terminal of ZP_CDMB are forwarded to the in terminal.

ZP_CDM and ZP_CDMB are parts that have “infinite cardinality” outputs, that is, outputs that can be connected to any number of inputs (another such part is the event bus—ZP_EVB).

ZP_CDM(B) can be used with structures that allow connecting multiple parts to a single terminal and provide a known unique connection ID for each established connection. Currently, the only such structure is provided by the part array (ZP_ARR)—when it creates and connects a new part in the array, it automatically assigns the part ID to all connections established with that part.

43. Boundary

43.1. Terminals (ZP_CDM)

Terminal “in” with direction “in” and contract I_POLY. Note: All operations received on this terminal are forwarded to the out terminal connection specified by the connection ID retrieved from operation bus.

Terminal “out” with direction “out” and contract I_POLY. Note: Output for forwarded operations. This terminal may be connected and disconnected while the part is active. This is an “infinite cardinality” output—unlike a normal output terminal, it will accept any number of simultaneous connections.

43.2. Terminals (ZP_CDMB)

Terminal “in” with direction “bi” and contract I_POLY. Note: All operations received on this terminal are forwarded to the out terminal connection specified by the connection ID stored in the operation bus.

Terminal “out” with direction “bi” and contract I_POLY. Note: All operations received on this terminal are forwarded to the in terminal. This terminal may be connected and disconnected while the part is active. This is an “infinite cardinality” bidirectional terminal—unlike a normal output or bi-directional terminal, it will accept any number of simultaneous connections.

43.3. Properties

Property “id_offset” of type “uint32”. Note: Offset in operation bus where connection ID is stored. The default is 0.

Property “id_sz” of type “uint32”. Note: Size of the connection ID field in bytes. This property can have a value between 1 and 4 inclusive. For sizes greater than 1, the byte order is assumed to be the natural byte order of the host CPU. Important: if 2 or 4 is used, the id_offset must be a valid offset to a uint16 or uint32 structure field, respectively, aligned as necessary. If 1 or 3 is used, the offset can be anywhere in the bus. The default is 4.

Property “id_sgnext” of type “uint32”. Note: Boolean. If TRUE, connection IDs smaller than 4 bytes are sign extended. The default is FALSE.

44. Specification

45. Responsibilities

1. Sign extend connection IDs with size less than 4 bytes when id_sgnext property is TRUE.

2. Enter the part guard when selecting the connection to ensure that the terminal selection and activetime connection and disconnection of the out terminal are serialized.

3. Forward operations received on in to out by performing atomic selection on out terminal.

4. Forward operations received on out to in.

46. Theory of Operation

46.1. Mechanisms

Performing Atomic Selection of “out” Output

When ZP_CDM and ZP_CDMB receive a call on its in terminal, they perform the following operations:

Enter the part guard using z_part_enter( )

Select the outgoing connection and obtain the pointer to the interface

Leave the part guard suing z_part_leave( )

Make the outgoing call.

ZP_CMX—Connection Multiplexer/De-Multiplexer

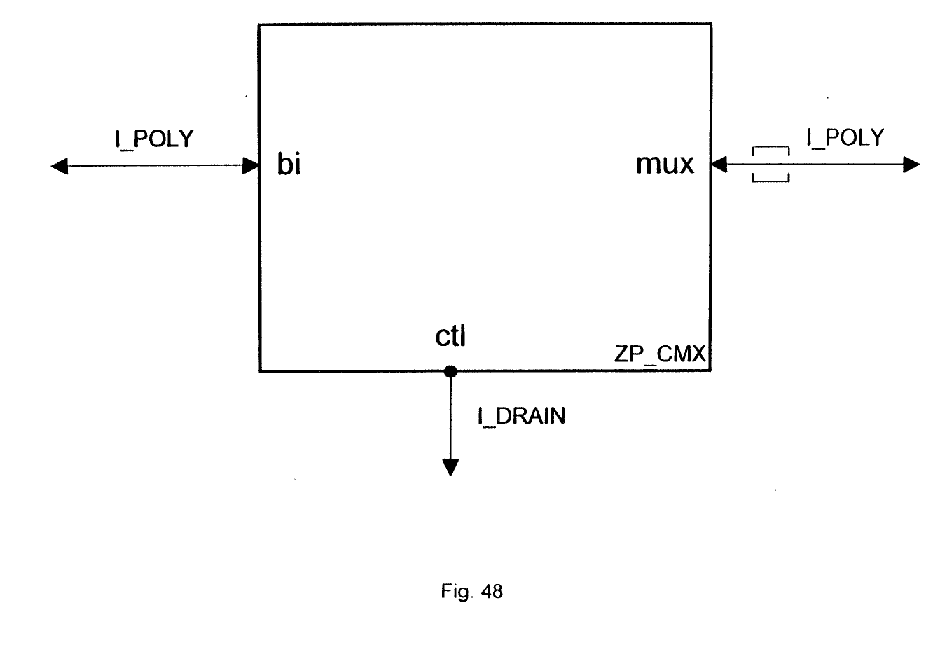

FIG. 48 illustrates the boundary of the inventive DM_CMX part.

ZP_CMX is a plumbing part that allows a single bi-directional terminal to be connected to multiple distinguishable bidirectional terminals and vice versa. Operations received on the bi terminal are forwarded out the mux terminal using a connection ID or an internally generated id stored in the operation bus. Operations received on the mux terminal are forwarded out the bi terminal with ZP_CMX stamping the connection id and optionally stamping an external connection context into the bus.

While ZP_CMX is active, it has the option to generate event requests out its ctl terminal when a connection is established and/or dissolved on its mux terminal. These requests provide the recipient with the ability to assign an external context to the connection, which can be used at a later time to process operation requests more efficiently.

ZP_CMX can be used to dispatch requests to one of many recipients (e.g., parts within a part array) or to connect multiple clients to a single server.

Both of ZP_CMX's input terminals are unguarded and may be invoked at interrupt time.

47. Boundary

47.1. Terminals

Terminal “bi” with direction “bi” and contract I_POLY. Note: Operations received on this terminal are forwarded to the mux terminal. The connection is specified by a connection ID or an internally generated identifier stored in the operation bus.

Terminal “mux” with direction “bi” and contract I_POLY. Note: Operations received on this terminal are redirected to the bi terminal. ZP_CMX stamps a connection identifier and context into the operation bus before forwarding the operation. This is an “infinite cardinality” output—unlike a normal output terminal, it will accept any number of simultaneous connections. This terminal may be connected and disconnected while the part is active.

Terminal “ctl” with direction “Out” and contract I_DRAIN. Note: Event requests are generated out this terminal when the mux terminal is connected and/or disconnected while ZP_CMX is active. This terminal may remain unconnected and may not be connected while the part is active.

47.2. Properties

Property “use_conn_id” of type “uint32”. Note: Boolean. When TRUE, ZP_CMX uses a connection ID to dispatch operations received on the bi terminal to the mux terminal. When FALSE, ZP_CMX uses an internally generated id stored in the operation bus to dispatch the call (faster than when using the connection id). Default is FALSE.

Property “id_offset” of type “uint32”. Note: Offset in operation bus for connection ID storage. When use_conn_id is FALSE, it is assumed that id_offset specifies the offset of a_ctx field in the operation bus; otherwise it assumes that id_offset specifies the offset of a DWORD field. The default is 0.

Property “conn_ctx_offset” of type “uint32”. Note: Offset in operation bus where the connection context returned on ctl_connect_ev request is stored for operations traveling from mux to bi. When the value is −1 and/or ZP_CMX's ctl terminal is not connected, no context is stored in the bus. The default is −1.

Property “ctl_connect_ev” of type “uint32”. Note: Event request to generate out ctl when a connection on the mux terminal is established (connected). When the value is EV NULL, no event is generated. The default is EV_NULL.

Property “ctl_disconnect_ev” of type “uint32”. Note: Event to generate out ctl when a connection on the mux terminal is dissolved (disconnected). When the value is EV_NULL, no event is generated. The default is EV_NULL.

Property “ctl_bus_sz” of type “uint32”. Note: Size of event bus for connect and disconnect event requests generated out the ctl terminal. The value of this property must be at least as large to accommodate storage for connection ID and context as specified the ctl_id_offset and ctl_conn_ctx offset properties. The default is 0.

Property “ctl_id_offset” of type “uint32”. Note: Offset in event bus for connection id storage. When use_conn_id is FALSE, it is assumed that ctl id offset specifies the offset of a ctx field in the operation bus; otherwise it is assumes that ctl_id_offset specifies the offset of a DWORD field. When the value is −1, no ID is stored in the event bus. The default is −1.

Property “ctl_conn_ctx_offset” of type “uint32”. Note: Offset in event bus for connection context storage. The recipient of the ctl_connect_ev request provides the connection context and this context is stamped into the bus of operations traveling from mux to bi. When the value is −1, no context is stored in the event bus. The default is −1.

47.3. Events and Notifications

Terminal: ctl

| Event | Dir | Bus | Notes |
|---|---|---|---|
| (ctl_connect_ev) | out | any | ZP_CMX generates this |
| | | | request when a connection |
| | | | is established on its mux |
| | | | terminal. |
| | | | The event data may contain |
| | | | a connection identifier as |
| | | | specified by the |
| | | | use_conn_id property. |
| (ctl_disconnect_ev) | out | any | ZP_CMX generates this |
| | | | request when a connection |
| | | | is dissolved on its mux |
| | | | terminal. |
| | | | The event data may contain |
| | | | a connection identifier as |
| | | | specified by the |
| | | | use_conn_id property and or |
| | | | a connection context that |
| | | | was returned with the |
| | | | ctl_connect_ev request. |

48. Specification

49. Responsibilities

1. Forward operations received on bi to mux using the connection ID specified at id_offset when use_conn_id is TRUE.

2. Forward operations received on bi to mux using an internally generated connection id specified at id_offset when use_conn_id is FALSE.

3. Stamp connection ID as specified by use_conn_id into bus on operations traveling from mux to bi.

4. Stamp connection context into bus of operations traveling from mux to bi if conn_ctx_offset is not −1.

5. Generate event request out ctl terminal when a connection on mux terminal is established and the value of the ctl_connect_ev property is not EV_NULL.

6. Generate event request out ctl terminal when a connection on mux terminal is dissolved and the value of the ctl_disconnect_ev property is not EV_NULL.

50. Use Cases

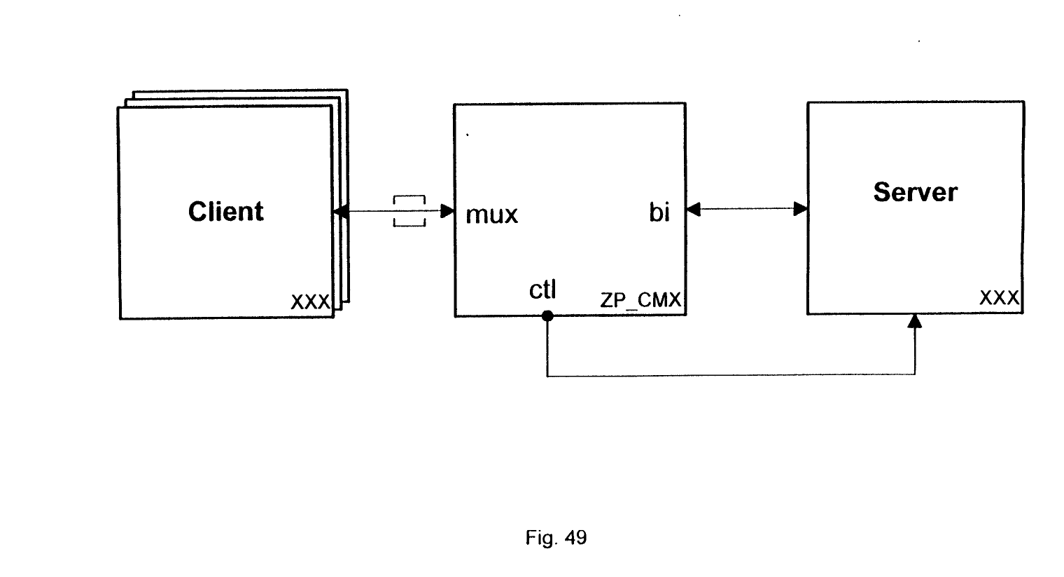

FIG. 49 illustrates an advantageous use of the inventive DM_CMX part.

50.1. Mux Terminal Connection

This use case describes the actions taken by ZP_CMX when it receives a request to establish a connection on its mux terminal

1. If the value of the ctl_connect_ev property is EV_NULL or the ctl terminal is not connected, ZP_CMX establishes the connection and returns.

2. ZP_CMX allocates a ctl connect_ev_event request and if the use_conn_id property is TRUE, stores the actual connection ID at ctl_conn_id offset; otherwise it stores an internally generated connection ID at ctl_conn_id offset.

3. ZP_CMS sends the event out the ctl terminal. If the return status is not ST_OK, ZP_CMX fails the connect request with ST_REFUSE; otherwise ZP_CMX stores the connection context specified at ctl_conn_ctx_offset into the data for the connection and returns success.

50.2. Mux Terminal Disconnection

This use case describes the actions taken by ZP_CMX when it receives a request to dissolve a connection on its mux terminal.

1. If the value of the ctl_disconnect_ev property is EV_NULL or the ctl terminal is not connected, ZP_CMX dissolves the connection and returns.

2. ZP_CMX allocates a ctl_disconnect_ev event request and if the use_conn_id property is TRUE, stores the actual connection ID at ctl conn_id_offset; otherwise it stores an internally generated connection ID at ctl_conn_id offset. ZP_CMX also stores the connection context that was returned on Ctl_connect_ev at ctl_conn_ctx_offset.

3. ZP_CMX sends the event out the ctl terminal. If the return status is not ST_OK, ZP_CMX displays output to the debug console, dissolves the connection, and returns ST_OK; otherwise it simply dissolves the connection and returns ST_OK.

50.3. De-Multiplexing Operations

When ZP_CMX receives an operation on its bi terminal, it extracts the connection identifier stored at id_offset in the operation bus and interprets its value based on the value of its use_conn_id property. ZP_CMX selects the appropriate connection on its mux terminal and forwards the operation without modification.

50.4. Multiplexing Operations

When ZP_CMX receives on operation on its mux terminal, it performs the following actions before forwarding the operation to its bi terminal:

1. Stamps the connection identifier at id_offset based on the value of its use₁₃ conn_id property.

2. Stamps the connection context associated with the connection at conn_ctx_offset.

3. Forwards the operation to the bi terminal.

51. Typical Usage

52. Using ZP_CMX to Allow Connection of Multiple Clients to a Single Server

The following diagram illustrates how ZP_CMX can be used to manage the connections between multiple clients and a single server component. It is assumed that the server is able to handle multiple sessions at a time.

In the above scenario, ZP_CMX's use_conn_id property is set to FALSE. When a connection is established, ZP_CMX generates a connect request out its ctl terminal and the server returns a connection context that ZP_CMX is to stamp into the bus of operations received on that connection of the mux terminal. This gives the server the ability to quickly identify the client that originated an operation request it receives.

When ZP_CMX receives a request on its mux terminal, it stamps the connection identifier of the connection on which it received the call into the operation bus and stamps the connection context provided by the server and forwards the call out its bi terminal. When ZP_CMX receives a request on its bi terminal from the server, it extracts the connection identifier from the operation bus, resolves the mux terminal connection and forwards the operation.

When ZP_CMX receives a disconnect request, it generates an event request out its ctl terminal to allow the server to perform any necessary cleanup before the connection is dissolved.

53. Using ZP_CMX With the Dynamic Structure Framework

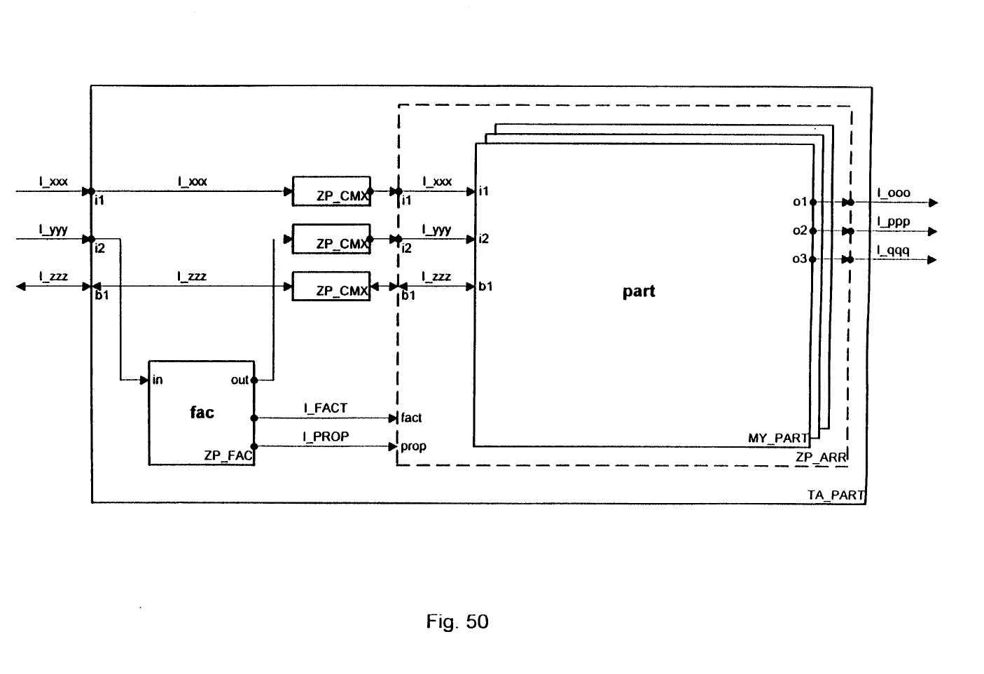

FIG. 50 illustrates an advantageous use of the inventive DM_CMX part.

The following diagram illustrates how ZP_CMX is used with the Dynamic Structure Framework parts. Its functionality is similar to that of ZP_CDMB.

In the above scenario, ZP_CMX's use_conn_id property is set to TRUE. When a request is distributed to any of the part instances it carries an identifier that uniquely specifies the actual recipient (part instance (i.e., connection) ID). ZP_CMX extracts the identifier from the incoming request and dispatches the request to the corresponding part instance.

DM_SPL, DM_BFL—Event Flow Splitters (Filters)

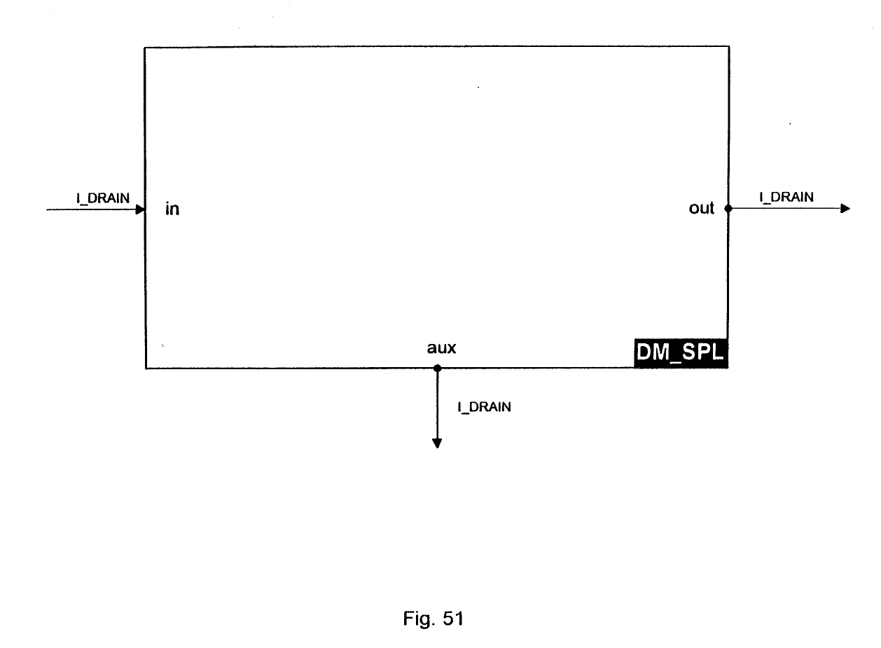

FIG. 51 illustrates the boundary of the inventive DM_SPL part.

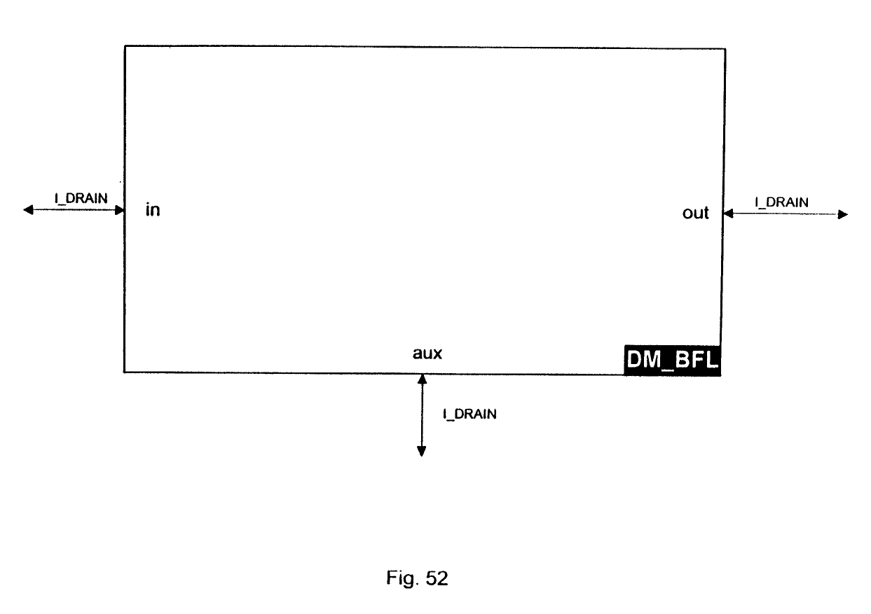

FIG. 52 illustrates the boundary of the inventive DM_BFL part.

DM_SPL is a connectivity part. DM_SPL is designed to split the flow of events received on its in terminal into two: one going out through its out terminal and a second one going out through the aux terminal. The event split depends upon whether the incoming event is in range defined by the ev_min and ev_max properties.

The event flow going through the out terminal (passing through) is considered to be the “main flow”—the majority of the events should go there; the one going to the aux terminal is the “secondary flow” (auxiliary events)—these events are the generally exceptions from the main flow.

DM_SPL can be parameterized for the range of auxiliary events. This range is contiguous (cannot have “holes”) and is defined by the upper and the lower boundaries.

Hint: to construct a non-contiguous range: daisy-chain instances of DM_SPL.

54. Boundary

54.1. Terminals (DM_SPL)

Terminal “in” with direction “In” and contract I_DRAIN. Note: All input events are received here and the main flow is forwarded to out terminal. The auxiliary flow is forwarded to aux terminal. The status returned is the one returned by the operation on the out or aux terminals depending to which terminal the event is forwarded to. If the terminal to which the event is forwarded is not connected, the operation will return CMST_NOT_CONNECTED. Unguarded. Can be connected when the part is active.

Terminal “out” with direction “Out” and contract I_DRAIN. Note: All main flow events received on in terminal are forwarded through here. Can be connected when the part is active.

Terminal “aux” with direction “Out” and contract I_DRAIN. Note: All auxiliary events are forwarded through here. Can be connected when the part is active.

54.2. Terminals (DM_BFL)

Terminal “in” with direction “Plug” and contract I_DRAIN. Note: All input events are received here and the main flow is forwarded to out terminal. The auxiliary flow is forwarded to aux terminal. The status returned is the one returned by the operation on the out or aux terminals depending to which terminal the event is forwarded to. If the terminal to which the event is forwarded is not connected, the operation will return CMST_NOT_CONNECTED. Unguarded. Can be connected when the part is active.

Terminal “out” with direction “Plug” and contract I_DRAIN. Note: All main flow events received on in terminal are forwarded through here. Can be connected when the part is active.

Terminal “aux” with direction “Plug” and contract I_DRAIN. Note: All auxiliary events are forwarded through here. Can be connected when the part is active.

54.3. Events and Notifications

All events received on in terminal are forwarded either to the out or to the aux terminals depending on whether they are considered main flow or auxiliary.

The range of auxiliary event IDs (contiguous) can be controlled by the outer scope by properties.

54.4. Special Events, Frames, Commands or Verbs

None.

54.5. Properties

Property “ev_min” of type “UINT32”. Note: Lower boundary of the auxiliary events. This is the lowest event ID value (inclusive) that will be considered auxiliary. If ev_min is EV_NULL, DM_SPL will consider all events auxiliary if their event ids are less than ev_max. If both ev_min and ev_max are EV_NULL, all events are considered auxiliary and sent through aux. Default: EV_NULL.

Property “ev_max” of type “UINT32”. Note: Upper boundary of the auxiliary events. If ev_max is EV_NULL, DM_SPL will consider all events auxiliary if their event ids are greater than ev_min. If both ev_min and ev_max are EV_NULL, all events are considered auxiliary and sent through aux. Default: EV_NULL.

55. Encapsulated Interactions

None.

56. Specification

57. Responsibilities

8. If event received on the in terminal is between ev_min and ev_max, pass through the aux terminal (auxiliary flow).

9. If event received on the in terminal is not between ev_min and ev_max, pass through the out terminal (main flow).

10. DM_BFL: Pass all events received from aux through in.

11. DM_BFL: Pass all events received from out through in.

58. Theory of Operation

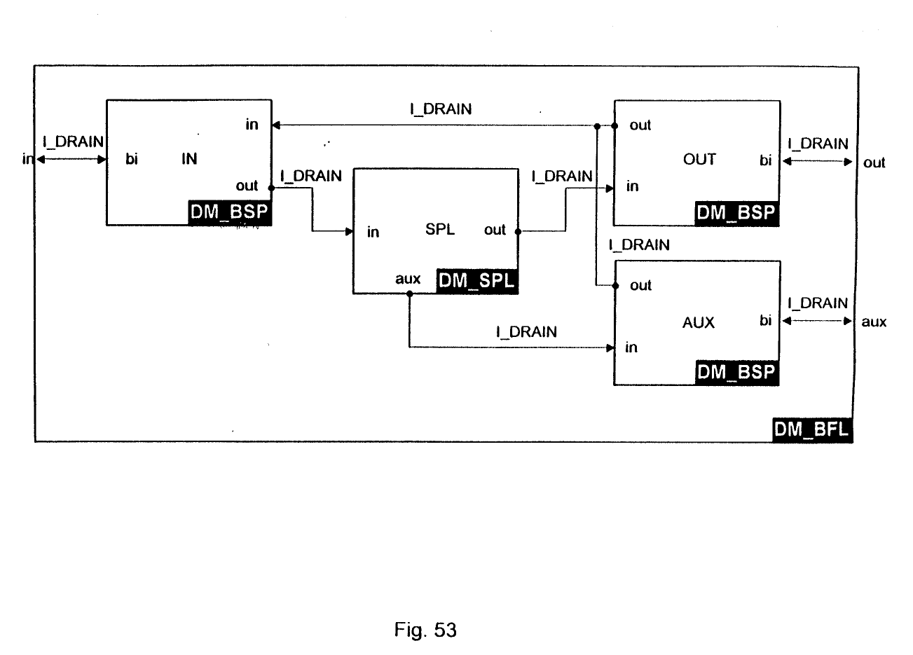

FIG. 53 illustrates the internal structure of the inventive DM_BFL part.

DM_SPL and DM_BFL split the event flow into two flows: main flow and auxiliary events. The main flow events are passed through the out terminal, the auxiliary to aux terminal.

The range of auxiliary events is controlled by properties.

DM_IFLT, DM_IFLTB—Filters by Integer Value

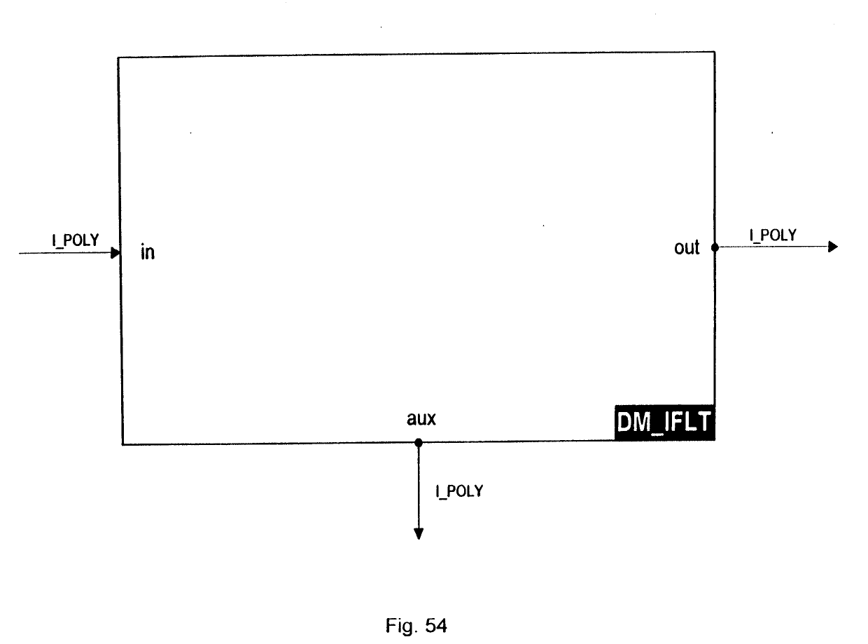

FIG. 54 illustrates the boundary of the inventive DM_IFLT part.

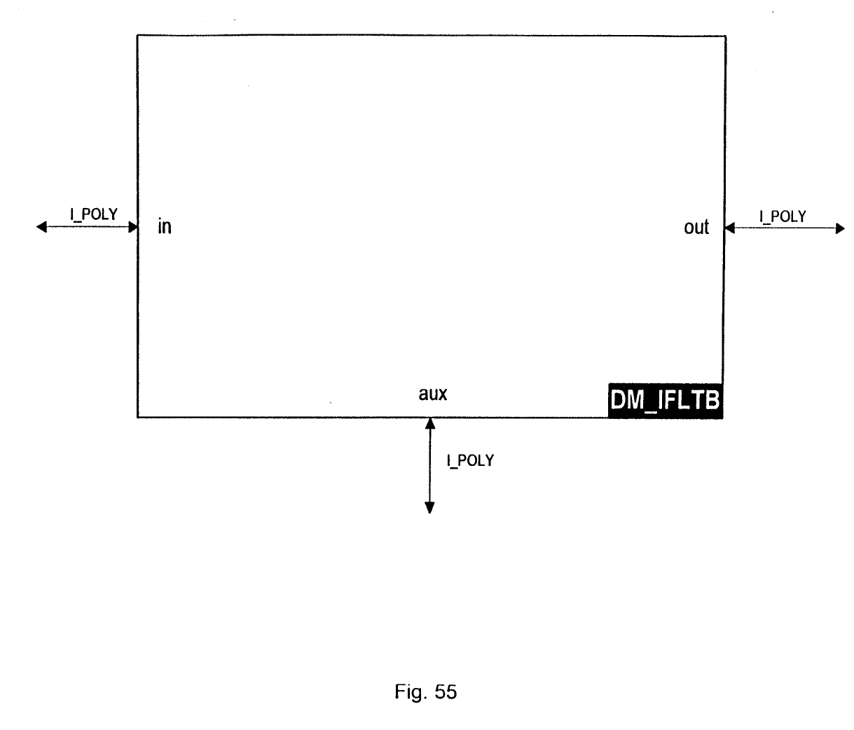

FIG. 55 illustrates the boundary of the inventive DM_IFLTB part.

DM_IFLT/DM_IFLTB are connectivity parts. DM_IFLT/DM_IFLTB are designed to split the flow of operations received on their in terminals into two: one going through their out terminals and a second one going through their aux terminals. The operation split depends upon whether the incoming filter integer value (contained in the operation bus) is in range defined by the min and max properties.

The operation flow going through the out terminal (passing through) is considered to be the “main flow”—the majority of the operations should go here; the one going to the aux terminal is the “secondary flow” (auxiliary operations)—these operations are generally exceptions from the main flow.

DM_IFLT/DM_IFLTB can be parameterized for the range of auxiliary operations. This range is contiguous (cannot have “holes”) and is defined by lower and the upper boundaries (min and max properties respectively).

Note: To construct a non-contiguous auxiliary range, daisy-chain instances of DM_IFLT/DM_IFLTB.

59. Boundary

59.1. Terminals (DM_IFLT)

Terminal “in” with direction “In” and contract I_POLY. Note: All input operations are received here and the main flow is forwarded to the out terminal. The auxiliary flow is forwarded through the aux terminal. The status returned is the one returned by the operation on the out or aux terminals depending on which terminal the operation is forwarded to. If the terminal to which the operation is forwarded is not connected, the operation will return CMST_NOT_CONNECTED. This terminal is unguarded. DM_IFLT does not enter its guard at any time.

Terminal “out” with direction “Out” and contract I_POLY. Note: All main flow operations received on the in terminal are forwarded through here. The main flow are operations in which their buses filter integer value falls outside of the range min . . . max.

Terminal “aux” with direction “Out” and contract I_POLY. Note: All auxiliary operations are forwarded through here. The auxiliary flow are operations in which their buses filter integer value falls in the range of min . . . max.

59.2. Terminals (DM_IFLTB)

Terminal “in” with direction “Plug” and contract I_POLY. Note: All input operations are received here and the main flow is forwarded to the out terminal. The auxiliary flow is forwarded through the aux terminal. The status returned is the one returned by the operation on the out or aux terminals depending on which terminal the operation is forwarded to. If the terminal to which the operation is forwarded is not connected, the operation will return CMST_NOT_CONNECTED. This terminal is unguarded. DM_IFLTB does not enter its guard at any time.

Terminal “out” with direction “Plug” and contract I_POLY. Note: All main flow operations received on the in terminal are forwarded through here. The main flow are operations in which their buses filter integer value falls outside of the range min . . . max. All operations invoked through this terminal are passed directly through in without modification.

Terminal “aux” with direction “Plug” and contract I_POLY. Note: All auxiliary operations are forwarded through here. The auxiliary flow are operations in which their buses filter integer value falls in the range of min . . . max. All operations invoked through this terminal are passed directly through in without modification.

59.3. Events and Notifications

All operations and events received on the in terminal are forwarded either to the out or to the aux terminals depending on whether they are considered main flow or auxiliary.

To use DM_IFLT/DM_IFLTB to filter events by ID, they may be parameterized to use the event ID as the filter integer value. The min and max properties can be used to specify the range of the event IDs that are sent through the aux terminal (auxiliary flow). See the properties below for more information.

59.4. Special Events, Frames, Commands or Verbs

None.

59.5. Properties

Property “offset” of type “UINT32”. Note: Offset of the filter integer value in the bus passed with the operation received on the in terminal (specified in bytes). The offset is specified from the beginning of the operation bus. The size of the integer value stored at this offset is expected to be 32-bits. Default is 0 (first field in operation bus).

Property “mask” of type “UINT32”. Note: Bitwise mask ANDed with the integer value extracted from the operation bus. DM_IFLT/DM_IFLTB masks the extracted integer value before comparing it to min and max. Default is 0xFFFFFFFF (no change).

Property “min” of type “UINT32”. Note: Lower boundary of the auxiliary operations. This is the lowest integer value (inclusive) that is considered auxiliary. If filtering events, this is the lowest event ID that is considered auxiliary. Default is 0.

Property “max” of type “UINT32”. Note: Upper boundary of the auxiliary operations. This is the upper most integer value (inclusive) that is considered auxiliary. If filtering events, this is the upper most event ID that is considered auxiliary. Default is 0xFFFFFFFF.

60. Encapsulated Interactions

None.

61. Specification

62. Responsibilities

12. If the operation filter integer value received on the in terminal is between min and max, pass operation through the aux terminal (auxiliary flow).

13. If the operation filter integer value received on the in terminal is not between min and max, pass operation through the out terminal (main flow).

14. Before comparing the filter integer value with the min and max properties, bitwise AND the filter value with the mask property.

15. DM_IFLTB: Pass all operations received from aux through in.

16. DM_IFLTB: Pass all operations received from out through in.

63. Theory of Operation

DM_IFLT is a coded part.

DM_IFLTB is a static assembly

63.1. Mechanisms

Filtering Operations

DM_IFLT and DM_IFLTB split the operation flow into two flows: main flow and auxiliary. The main flow operations are passed through the out terminal, the auxiliary to the aux terminal.

Which flow an operation belongs to is determined by the filter integer value in the operation bus. DM_IFLT/DM_IFLTB extracts the filter integer value from the operation bus using the offset property. This value is then ANDed (bitwise) with the mask property value. The resulting value is then compared to the min and max values to check which flow the operation belongs to.

The auxiliary flow are operations in which the filter integer value falls into the range min . . . max. Operations in which the filter integer value falls outside of the min . . . max range are considered main flow and are passed through the out terminal.

DM_IFL/DM_IFLTB do not modify the operation bus received on the in terminal.

If a NULL bus is passed with the operation, the operation is passed through the out terminal (main flow).

63.2. Use Cases

Filtering Operations by Integer Value

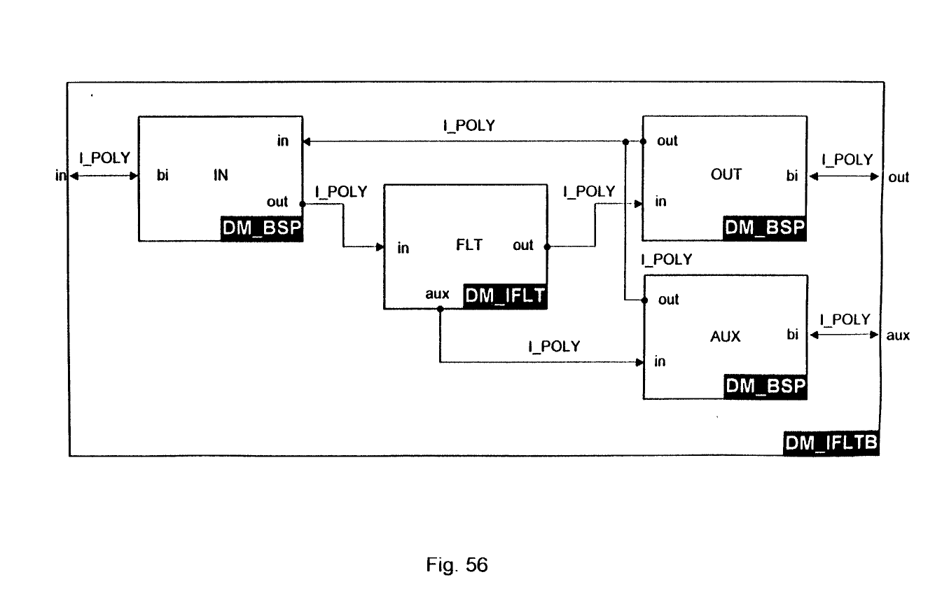

FIG. 56 illustrates the internal structure of the inventive DM_IFLT part.

1. The structure in the above figure is created.

2. DM_IFLT is parameterized with the following:

a. offset=offset of integer value in operation bus

b. mask=mask to AND integer value with

c. min=minimum boundary of auxiliary flow

d. max=maximum boundary of auxiliary flow

3. The structure in the above figure is connected and activated.

4. At some point, Part A invokes an operation through DM_IFLT passing an operation bus that contains some integer value.

5. DM_IFLT extracts the filter integer value from the operation bus passed with the call. DM_IFLT uses the offset property to extract the value.

6. DM_IFLT then ANDs the integer value with the value of the mask property.

7. The resulting value is compared to the min and max properties. If the value is outside this range, the operation is forwarded through the out terminal and arrives in Part B (main flow). Otherwise, the operation is forwarded through the aux terminal and arrives in Part C (auxiliary flow).

8. Steps 4-7 may be executed many times.

Filtering Events by ID

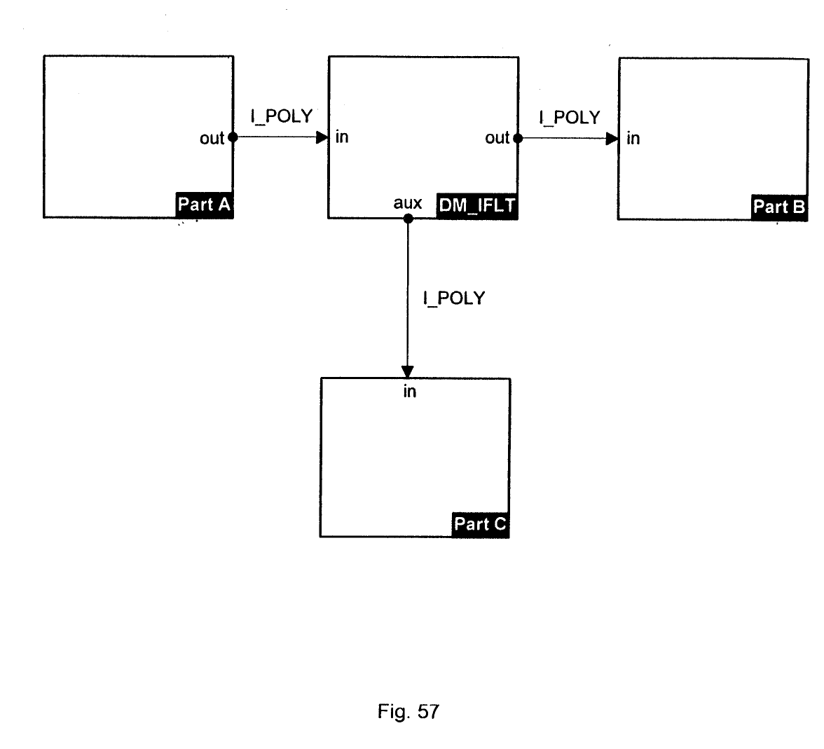

FIG. 57 illustrates an advantageous use of the inventive DM_IFLTB part.

1. The structure in the above figure is created.

2. DM_IFLT is parameterized with the following:

a. offset=offset of the event ID (offsetof (CMEVENT_HDR, id))

b. mask=mask to AND integer value with (0xFFFFFFFF)

c. min=minimum boundary of auxiliary flow events

d. max=maximum boundary of auxiliary flow events

3. The structure in the above figure is connected and activated.

4. At some point, Part A sends an event to DM_IFLT.

5. DM_IFLT extracts the event ID from the event bus passed with the call. DM_IFLT uses the offset property to extract the ID.

6. DM_IFLT then ANDs the event ID with the value of the mask property leaving the event ID unchanged.

7. The event ID is compared to the min and max properties. If the ID is outside this range, the event is forwarded through the out terminal and arrives in Part B (main flow). Otherwise, the event is forwarded through the aux terminal and arrives in Part C (auxiliary flow).

8. Steps 4-7 may be executed many times.

DM_SFLT and DM_SFLT4—String Filters

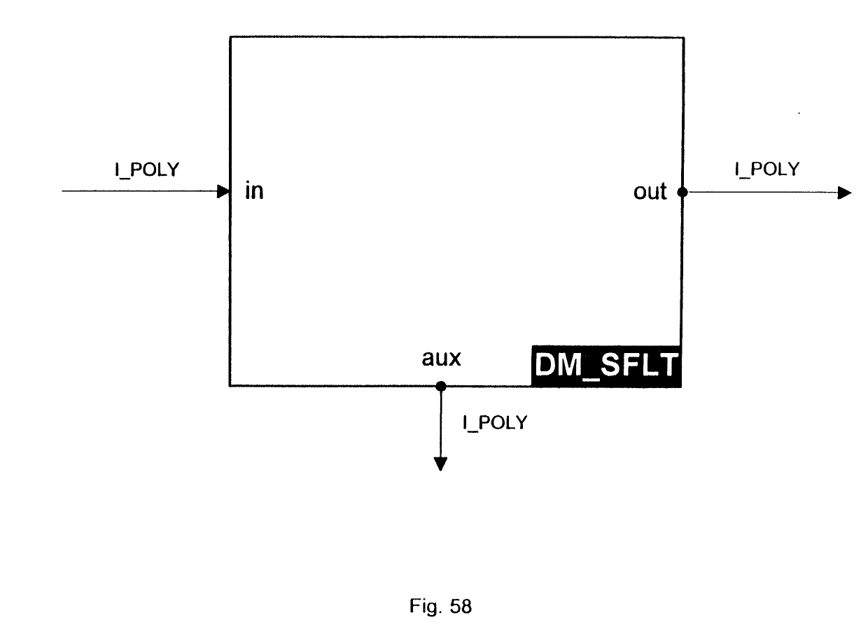

FIG. 58 illustrates the boundary of the inventive DM_SFLT part.

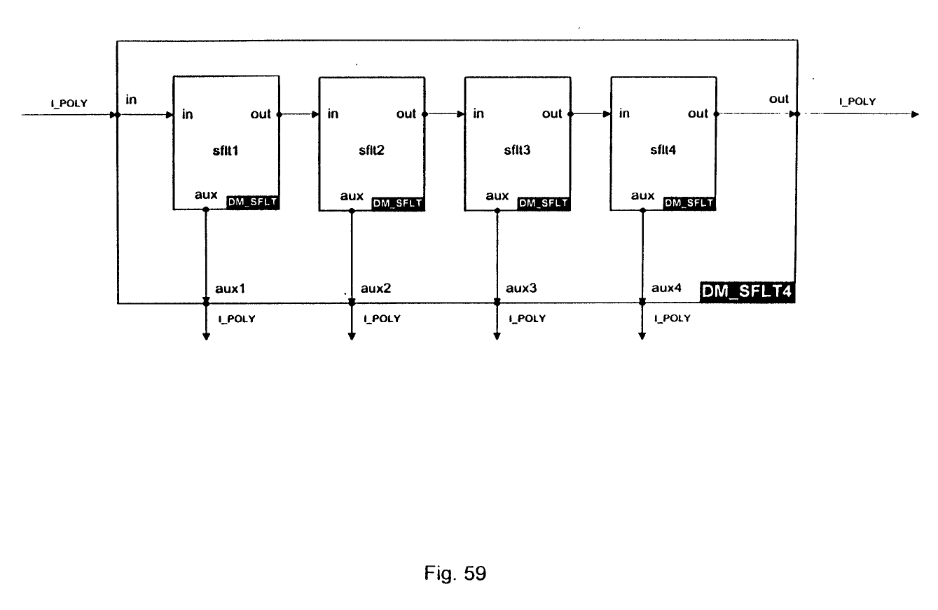

FIG. 59 illustrates the boundary of the inventive DM_SFLT4 part.

DM_SFLT and DM_SFLT4 filter incoming requests received on in by comparing a string contained in the operation bus with a template(s) that the part is parameterized with. When a match is found, DM_SFLT forwards the operation to its aux terminal and DM_SFLT4 forwards the operation to the aux terminal that corresponds to the template that was matched. When no match is found, the operation is forwarded to out.

The template can be one of four forms:

| | |
|---|---|
| “” | →Send all operations out out. |
| “String” | →Match the string exactly. |
| “String*” | →Match strings starting with specified string up to “*”. |
| “*” | →Send all operations out aux. |

64. Boundary

64.1. Terminals (DM_SFLT)

Terminal “in” with direction “In” and contract I_POLY. Note: v-table, infinite cardinality. All operations received are either passed to out terminal or aux terminal based on whether template is matched. This input is unguarded.

Terminal “out” with direction “Out” and contract I_POLY. Note: v-table, cardinality 1 Output for operations that do not match template string.

Terminal “aux” with direction “Out” and contract I_POLY. Note: v-table, cardinality 1 Output for operations that match template string.

64.2. Terminals (DM_SFLT4)

Terminal “in” with direction “In” and contract I_POLY. Note: v-table, infinite cardinality. All operations received are either passed to out or to one of the aux terminals based on which template is matched. This input is unguarded.

Terminal “out” with direction “Out” and contract I_POLY. Note: v-table, cardinality 1 Output channel for those operations where the string does not match any of the templateX properties.

Terminal “aux1” with direction “Out” and contract I_POLY. Note: v-table, cardinality 1 Output channel for those operations that contain a string matching template1 property.

Terminal “aux2” with direction “Out” and contract I_POLY. Note: v-table, cardinality 1 Output channel for those operations that contain a string matching template2 property.

Terminal “aux3” with direction “Out” and contract I_POLY. Note: v-table, cardinality 1 Output channel for those operations that contain a string matching template3 property.

Terminal “aux4” with direction “Out” and contract I_POLY. Note: v-table, cardinality 1 Output channel for those operations that contain a string matching template4 property.

64.3. Events and Notifications

None.

64.4. Special Events, Frames, Commands or Verbs

None.

64.5. Properties (DM_SFLT)

Property “offset” of type “UINT32”. Note: Offset of string in operation bus. The default value is 0x00.

Property “by_ref” of type “UINT32”. Note: (boolean) If TRUE, the string in the bus is by reference. If FALSE, the string is contained in the bus. The default value is FALSE.

Property “ignore_case” of type “UINT32”. Note: (boolean) If TRUE, the string compare is not case-sensitive. The default is TRUE.

Property “template” of type “ASCIZ”. Note: Template to use when comparing strings. The default value is “.

64.6. Properties (DM_SFLT4)

DM_SFLT4 has separate templates for each of its filter channels. All other properties are common to all channels.

Property “offset” of type “UINT32”. Note: Offset of string in operation bus. The default value is 0x00.

Property “by_ref” of type “UINT32”. Note: (boolean) If TRUE, the string in the bus is by reference. If FALSE, the string is contained in the bus. The default value is FALSE.

Property “ignore_case” of type “UINT32”. Note: (boolean) If TRUE, the string compare is not case-sensitive. The default is TRUE.

Property “template1” of type “ASCIZ”. Note: Template to use when comparing strings for operations to be forwarded to aux1. The default is “ ”.

Property “template2” of type “ASCIZ”. Note: Template to use when comparing strings for operations to be forwarded to aux2. The default is “ ”.

Property “template3” of type “ASCIZ”. Note: Template to use when comparing strings for operations to be forwarded to aux3. The default is “ ”.

Property “template4” of type “ASCIZ”. Note: Template to use when comparing strings for operations to be forwarded to aux4. The default is can.

65. Encapsulated Interactions

None.

66. Specification

67. Responsibilities

1. Forward operations that contain a string matching the template property in its bus to the respective aux terminal.

2. Forward all other operations to the out terminal.

68. Theory of Operation

68.1. State Machine

None.

68.2. Mechanisms

Dereferencing String

If the by_ref property is FALSE, then the offset in the bus is treated as a byte location representing the first character of the string. If the by_ref property is TRUE, then the offset is treated as a DWORD value that is converted into a character pointer.

69. Dominant's Responsibilities (DM_SFLT4)

69.1. Hard Parameterization of Subordinates

DM_SFLT4 does not perform any hard parameterization of its subordinates.

69.2. Distribution of Properties to the Subordinates

| Property name | Type | Distr | To |
|---|---|---|---|
| offset | UINT32 | bcast | sfltX.offset |
| by_ref | UINT32 | bcast | sfltX.by_ref |
| ignore_case | UINT32 | bcast | sfltX.ignore_case |
| template1 | ASCIZ | redir | sflt1.template |
| template2 | ASCIZ | redir | sflt2.template |
| template3 | ASCIZ | redir | sflt3.template |
| template4 | ASCIZ | redir | sflt4.template |

DM_IRPFLT—IRP Event Filter

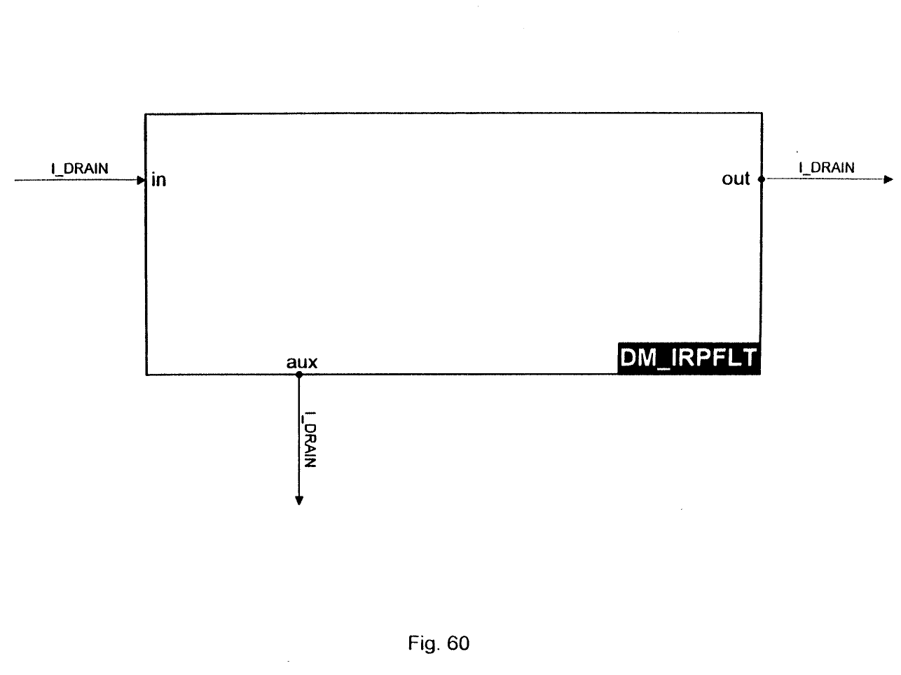

FIG. 60 illustrates the boundary of the inventive DM_IRPFLT part.

DM_IRPFLT is designed to filter IRP events received on its in terminal and send the filtered events to a separate terminal (aux). The events that are not subject to filtering are passed through to the out terminal.

The event flow going through the out terminal (passing through) is considered to be the “main flow”—the majority of the events should go there; the one going to the aux terminal is the “secondary flow” (auxiliary events)—these events are generally exceptions from the main flow.

DM_IRPFLT is parameterized with the function codes (both major and minor) of the auxiliary IRP events. No more than one major and up to 32 minor codes are supported. If no minor codes are specified, the filtering is done only by major function code (the minor is ignored).

70. Boundary

70.1. Terminals

Terminal “in” with direction “In” and contract I_DRAIN. Note: All input events are received here and the main flow is forwarded to out terminal. The auxiliary events are forwarded to aux terminal. The status returned is the one returned by the operation on the out or aux terminals depending to which terminal the event is forwarded to. If the terminal to which the event is forwarded is not connected, the operation will return CMST_NOT_CONNECTED. Unguarded. Can be connected when the part is active.

Terminal “out” with direction “Out” and contract I_DRAIN. Note: All main flow events received on in terminal are forwarded through here. Can be connected when the part is active.

Terminal “aux” with direction “Out” and contract I_DRAIN. Note: All auxiliary events are forwarded through here. Can be connected when the part is active.

70.2. Events and Notifications Received on the “In” Terminal

| Incoming Event | Bus | Notes |
|---|---|---|
| EV_REQ_IRP | B_EV_IRP | Indicates that IRP |
| | | needs processing. |

70.3. Properties

Property “irp_mj” of type “UCHAR”. Note: Major function code of IRP events considered auxiliary. If 0xFF is specified, all events are sent to aux, without regard to other properties. Default: 0xFF.

Property “irp_mon[0..31]” of type “UCHAR”. Note: Array of IRP minor function codes. If irp_mj is not 0xFF, these codes are used to determine whether an IRP event should be sent to considered Default: 0xFF.

71. Encapsulated Interactions

DM_IRPFLT calls the Windows I/O manager to retrieve IRP stack location.

72. Specification

73. Responsibilities

Pass main flow events to out terminal.

Pass auxiliary events to aux terminal

74. Theory of Operation

74.1. Main Data Structures

IO_STACK_LOCATION (System-Defined)

This structure is used by the I/O Manager to pass the arguments for all driver functions (IRP_MJ_xxx).

75. Notes

If DM_IRPFLT is parameterized to filter minor IRP codes and an IRP received on in has a minor code>=32, the IRP is simply passed through the out terminal without modification.

DM_BSP—Bi-Directional Splitter

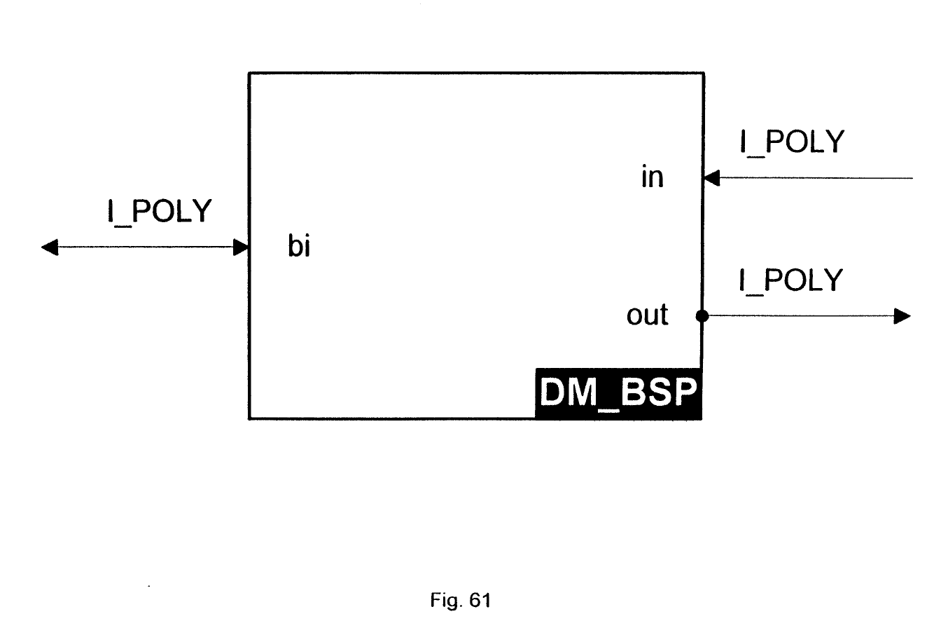

FIG. 61 illustrates the boundary of the inventive DM_BSP part.

DM_BSP is a ClassMagic adapter part that makes it possible to connect parts with bidirectional terminals to parts that have unidirectional terminals.

All of DM_BSP terminals are I_POLY; thus DM_BSP can be inserted between any bus-based cdecl v-table connection (as long as there are no more then 64 operations implemented on the counter terminals of DM_BSP). The terminals are also activetime and unguarded providing maximum flexibility in its use.

DM_BSP is inserted between a part with a bidirectional terminal and one or two parts with unidirectional terminals (one input and one output). DM_BSP forwards operation calls between the parts. Operations invoked on its bi terminal are forwarded out through the out terminal. Operations invoked on its in terminal are forwarded out through the bi terminal. This allows the parts connected to DM_BSP to communicate as if they were directly connected to each other.

The bus passed with the operation calls are not interpreted by DM_BSP.

76. Boundary

76.1. Terminals

Terminal “in” with direction “In” and contract I_POLY. Note: v-table, infinite cardinality, synchronous, unguarded, activetime Operations invoked through this terminal are redirected out through the bi terminal. The bus passed with the call is not interpreted by DM_BSP.

Terminal “out” with direction “Out” and contract I_POLY. Note: v-table, cardinality 1, synchronous, unguarded, activetime Operations invoked through the bi terminal are redirected out through this terminal. The bus passed with the call is not interpreted by DM_BSP.

Terminal “bi” with direction “Bidir (plug)” and contract I_POLY. Note: v-table, cardinality 1, synchronous, unguarded, activetime Operations invoked through this terminal are redirected out through the out terminal. Calls received from the in terminal are redirected out through this terminal. The bus passed with the call is not interpreted by DM_BSP.

76.2. Events and Notifications

None.

76.3. Special Events, Frames, Commands or Verbs

None.

76.4. Properties

None.

77. Encapsulated Interactions

None.

78. Specification

79. Responsibilities

1. Provide a compatible connection between a bi-directional terminal and two uni-directional terminals (one input and one output).

80. Theory of Operation

80.1. State Machine

None.

80.2. Main Data Structures

None.

80.3. Mechanisms

Forwarding Operation Calls Between Parts

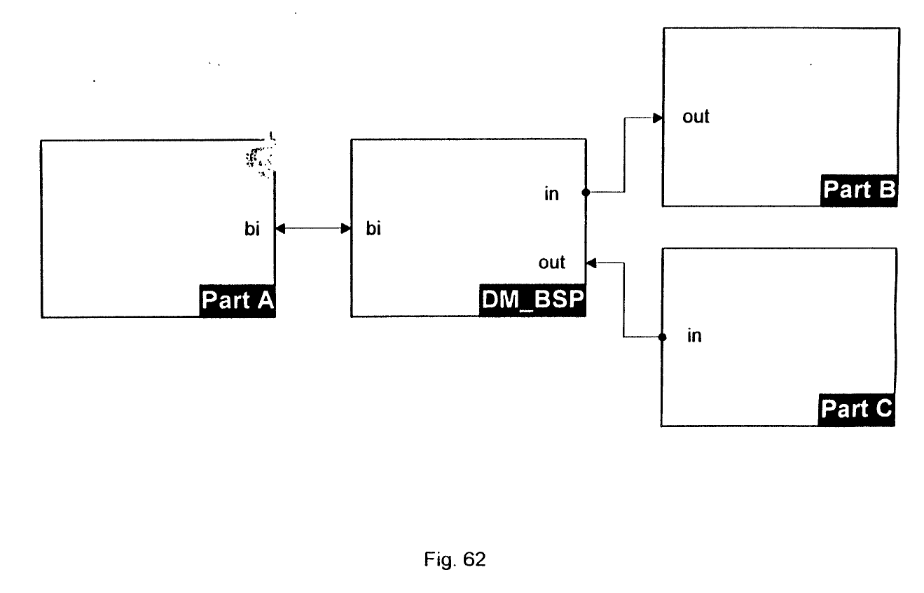

FIG. 62 illustrates an advantageous use of the inventive DM_BSP part.

DM_BSP makes it possible to connect a bidirectional terminal on one part to uni-directional terminals on other parts. DM_BSP accomplishes this by forwarding the operations invoked on them to the appropriate part.

When DM_BSP receives a call through its in terminal, it redirects the call out through its bi terminal. When a call is received on the bi terminal, it is redirected out through the out terminal. This mechanism provides a compatible connection between the counter terminals of in, out and bi. The bus received with the operation calls are not interpreted by DM_BSP.

80.4. Use Cases

Connecting Two Parts to a Bidirectional Terminal Using DM_BSP

1. In order to establish the connections in the diagram above, DM_BSP must be inserted between parts A, B and C.

2. All the parts are constructed.

3. Part A's bi terminal is connected to DM_BSP's bi terminal.

4. DM_BSP's in terminal is connected to Part B's out terminal.

5. DM_BSP's out terminal is connected to Part C's in terminal.

6. All the parts are activated.

7. At some point, Part A invokes an operation through its bi terminal.

8. DM_BSP receives the operation call on its bi terminal and redirects the call out through its out terminal.

9. Part C receives the operation call on its in terminal and executes code for the operation. When the operation is complete, control is returned back to Part A where the operation call originated.

10. At some point, Part B invokes an operation through its out terminal.

11. DM_BSP receives the operation call on its in terminal and redirects the call out through its bi terminal.

12. Part A receives the operation call on its bi terminal and executes code for the operation. When the operation is complete, control is returned back to Part B where the operation call originated.

13. Steps 7-9 and 10-12 may be executed many times.

14. All the parts are deactivated and destroyed.

Connecting a Part With Two Unidirectional Terminals to a Part With a Bi-Directional Terminal Using DM_BSP

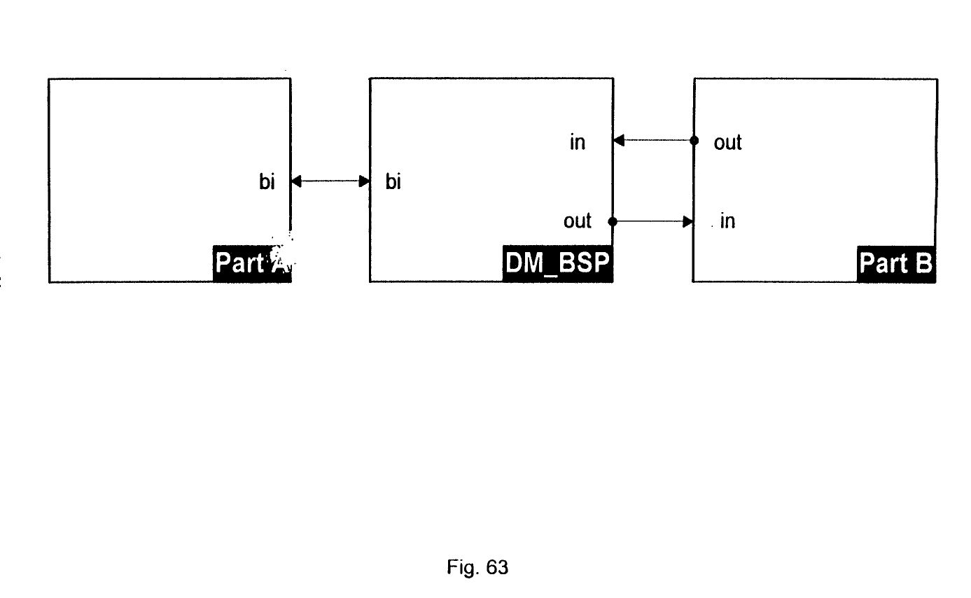

FIG. 63 illustrates an advantageous use of the inventive DM_BSP part.

1. In order to establish the connections in the diagram above, DM_BSP must be inserted between parts A and B.

2. All the parts are constructed.

3. Part A's bi terminal is connected to DM_BSP's bi terminal.

4. DM_BSP's in terminal is connected to Part B's out terminal.

5. DM_BSP's out terminal is connected to Part B's in terminal.

6. All the parts are activated.

7. The operation calls are forwarded in the same way as in the first use case.

8. All the parts are deactivated and destroyed.

DM_DIS—Device Interface Splitter

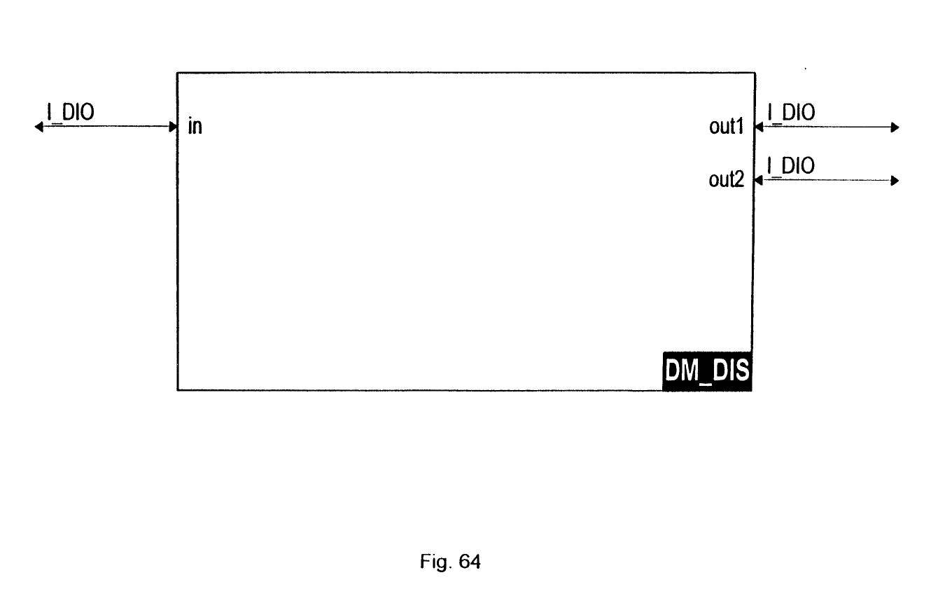

FIG. 64 illustrates the boundary of the inventive DM_DIS part.

DM_DIS dispatches the operations on its in terminal to the out1 and out2 terminals using a preview call to determine which of the two outputs will accept the operations. The preview operation is the same operation as the one received on in, with the DIO_A_PREVIEW attribute set in the bus.

DM_DIS always calls both out1 and out2 on preview and interprets the return status as follows:

CMST_OK—the operation is acceptable, the part will process it synchronously (i.e. will not return CMST_PENDING status).

CMST_SUBMIT—the operation is acceptable, the part claims the exclusive right to execute the operation. The operation may be processed asynchronously.

Other—the operation is not implemented.

Depending on the combination of returned statuses, DM_DIS calls out1, out2 or both with the preview flag cleared. The complete definition of all combinations can be found in the boundary section below.

To allow DM_DIS to be chained, it handles specially incoming calls on in with the preview attribute set—the preview is passed to out1 or out2 and if any of them returns CMST_SUBMIT or CMST_OK, DM_DIS returns with this status and enters a “pass” state, expecting the next call to be the same operation with the preview attribute cleared. This call will be passed transparently to the output(s) that originally returned CMST_SUBMIT or CMST_OK.

Incoming calls on out1 and out2 are forwarded transparently to in.

81. Boundary

81.1. Terminals

Terminal “in” with direction “Bidir” and contract In: I_DIO Out: I_DIO_C. Note: Multiplexed input/output. Incoming calls are dispatched to out1 and out2. See the section “Requirements to Parts Connected to DM_DIS” for requirements to parts connected to this terminal.

Terminal “out1” with direction “Bidir” and contract In: I_DIO_C Out: I_DIO. Note: Dispatched input/output #1. Calls to this terminal are passed transparently to in. See the section “Requirements to Parts Connected to DM_DIS” for requirements to parts connected to this terminal.

Terminal “out2” with direction “Bidir” and contract In: I_DIO_C Out: I_DIO. Note: Dispatched input/output #2. Calls to this terminal are passed transparently to in. See the section “Requirements to Parts Connected to DM_DIS” for requirements to parts connected to this terminal.

81.2. Events and Notifications

None.

81.3. Special Events, Frames, Commands or Verbs

None.

81.4. Properties

None.

81.5. Requirements to Parts Connected to DM_DIS

Requirements to the Parts Connected to out1 and out2

The parts connected to the out1 and out2 terminals should cooperate with DM_DIS by responding to preview calls, so that DM_DIS can determine how to distribute the calls on in to these parts.

When a part receives a call with the preview attribute set it should determine if it will handle the operation and return one of the following statuses:

CMST_OK—the part will handle the operation synchronously and it is OK for another part to handle the same operation (non-exclusive claim).

CMST_SUBMIT—the part will handle the operation either synchronously or asynchronously and it should be the only part to handle the operation (exclusive claim).

Any error status—the part will not handle the operation.

A part performs the operations when it receives them with the preview attribute cleared. If the operation was claimed non-exclusively (by returning CMST_OK on preview) the part should not return CMST_PENDING. DM_DIS will detect this and display an error message on the debug console.

Requirements to the Part Connected to In

A part connected to the in terminal may use two modes of operation:

normal—all calls are submitted with the “preview” attribute cleared.

preview/submit—each call is submitted first with the preview attribute set, then (if the return status is CMST_OK or CMST_SUBMIT) with the preview attribute cleared. If DM_DIS is chained, there should be no intervening calls to other operations between the preview and the submit call. The out1 and out2 terminals of DM_DIS itself conform to these requirements, so that two or more instances of DM_DIS can be chained. If DM_DIS is not chained, there can be any number of operation calls between the preview and the submit call.

A part connected to the in terminal is not required to keep using only one of the above modes—they can be interchanged on a per-call basis.

82. Encapsulated Interactions

None.

83. Specification

84. Responsibilities

Distribute calls on the in terminal to the out1 and out2 terminals, use preview calls to determine which output(s) should handle each call.

Allow connection of a part that uses preview calls (e.g., another instance of DM_DIS) to be connected to the in terminal.

Pass calls from out1 and out2 transparently to in.

85. Theory of Operation

85.1. State Machine

None.

85.2. Main Data Structures

None.

85.3. Mechanisms

Preview Mechanism

DM_DIS uses this mechanism to determine which of the two right-side terminals (out1 or out2) will handle an incoming call from in. The following outcomes are defined:

Non-exclusive claim—one or more outputs will handle the operation. Asynchronous completion is not allowed.

Exclusive claim—only one output will handle the operation. Asynchronous completion is allowed.

Operation Rejected—none of the outputs will handle the operation.

Preview failed—conflicting claims.

DM_DIS performs the following steps:

Call out1 with the preview attribute set and save the return status

Call out2 with the preview attribute set and save the return status

Determine the preview outcome as follows:

one or both preview calls returned CMST_OK, none of them returned CMST_SUBMIT—non-exclusive claim

one of the calls returned CMST_SUBMIT, the other returned an error—exclusive claim

both calls returned an error—operation rejected

none of the above—preview failed

Call Distribution

This mechanism is used when DM_DIS receives the calls on in with the preview attribute cleared:

The preview mechanism (as described above) is invoked to determine the preview outcome.

If the outcome was “non-exclusive claim”—call the terminal(s) that returned CMST_OK, log an error if any of the calls returns CMST_PENDING. The status returned in case both outputs are invoked is the status from the second call if the first one returned CMST_OK and the status from the first call otherwise.

If the outcome was “exclusive claim”—call the terminal that returned CMST_SUBMIT and return the status from that call.

If the outcome was “operation refused” return the status from the first preview.

If the statuses from preview indicate conflict, log an error message and return CMST_UNEXPECTED.

Preview Forwarding

This mechanism is used when DM_DIS is invoked on in with the preview attribute set:

The preview mechanism (as described above) is invoked.

If the operation is rejected—return the status from the preview on out1.

If the preview failed—log an error and return CMST_UNEXPECTED.

Save the outcome, including which output(s) claimed the operation.

Remember the operation that was invoked.

Set “pass” flag—this will cause the next operation on in to be processed as described in the next mechanism below.

Return CMST_OK if the claim was non-exclusive or CMST_SUBMIT if the claim was exclusive.

Submit Forwarding

This mechanism is used when DM_DIS has the “pass” flag set and the in terminal is invoked on the same operation as the one that caused the “pass” flag to be set:

1. Clear the “pass” flag

2. If the saved outcome was “non-exclusive claim”—call the terminal(s) that returned CMST_OK, log an error if any of the calls returns CMST_PENDING. The status returned in case both outputs are invoked is the status from the second call if the first one returned CMST_OK and the status from the first call otherwise.

3. If the saved outcome was “exclusive claim”—call the terminal that returned CMST_SUBMIT and return the status from that call.

85.4. Use Cases

Using DM_DIS to Arbitrate Between Two Parts That Implement Subsets of I_DIO

If two parts implement non-intersecting subsets of I_DIO they can be connected with DM_DIS to produce a single I_DIO terminal that exposes the combined functionality of the two parts. To do this the two parts should:

Check the preview attribute in the bus and return CMST_SUBMIT if it is set and the part implements the requested operation or CMST_NOT_IMPLEMENTED otherwise.

Execute the operation when called with the preview attribute cleared.

While processing a call with the preview attribute set, the parts should not perform any action or state change under the assumption that they will receive the operation later, e.g. invoke complete operation on the back channel of the I_DIO connection.

In this case DM_DIS will:

call the out1 terminal (with preview set)

call the out2 terminal (with preview set)

call out1 or out2 depending on which one returned CMST_SUBMIT and return the status from the operation

Chained Operation

The in terminal of DM_DIS may be connected to another part that uses the preview/submit pattern used by DM_DIS itself.

Case 1 (no CMST_SUBMIT or CMST_OK)

DM_DIS receives a call on in with the preview attribute set.

DM_DIS calls both out1 and out2 with the operation, none of them returns CMST_SUBMIT or CMST_OK

DM_DIS returns the status from out1.

Case 2 (one of the outputs returns CMST_SUBMIT)

DM_DIS receives a call on in with the preview attribute set

DM_DIS calls both out1 and out2 with the operation

the following information is saved:

set “pass” flag

which output returned CMST_SUBMIT (1 or 2)

which I_DIO operation was called

DM_DIS returns CMST_SUBMIT

When the next call is received on in; if not the same call as the one saved in step 3, DM_DIS resets the “pass” flag and processes the call as normal (depending on the preview flag)

If the call is the same: the call is passed to the output (as saved from step 3).

Case 3 (one or both outputs returns CMST_OK)

receive a call on in with the preview attribute set

call both out1 and out2 with the operation

save the following information in self:

set “pass” flag

which output(s) returned CMST_OK

which I_DIO operation was called

return CMST_OK

receive a call on in; if not the same call as the one saved in step 3, reset the “pass” flag and process the call as normal (depending on the preview flag)

If the call is the same: the call is passed to the output(s) (as saved from step 3). If one or both calls return CMST_PENDING, log an error.

If only one output was called—DM_DIS returns the status from that call.

If both outputs were called—DM_DIS returns the status from the second call if the first one returned CMST_OK and the status from the first call otherwise.

Bi-Directional Operation

Parts that implement the I_DIO interface can use the back channel of the I_DIO connection to complete the operations asynchronously. This is done by returning CMST_PENDING when the operation is submitted and invoking I_DIO_C.complete operation on the back channel when the operation is completed.

If a part connected to out1 or out2 has to complete an operation asynchronously, it should return CMST_SUBMIT on preview. This will guarantee that it will be the only part to execute the operation.

If DM_DIS receives CMST_PENDING status from a part that has not claimed exclusive access (by returning CMST_SUBMIT on preview) it will log an error message.

DM_IEV—Idle Generator Driven by Event

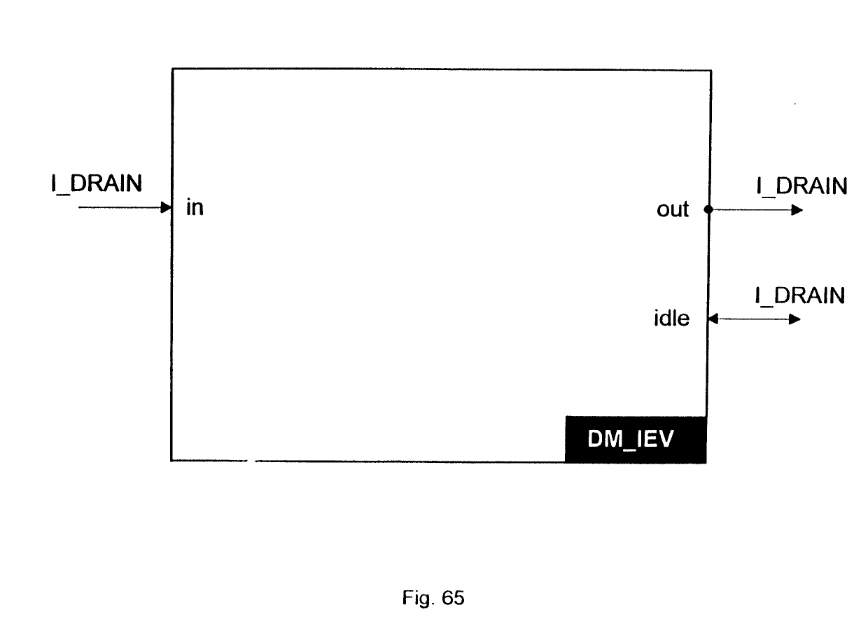

FIG. 65 illustrates the boundary of the inventive DM_IEV part.

DM_IEV generates idle events when it receives an external event. Upon receiving an event (EV_XXX) at its in terminal, DM_EV will continuously generate EV_IDLE events through idle until the sending of the EV_IDLE event returns CMST_NO_ACTION or CMST_BUSY, or until DM_IEV receives an EV_REQ_DISABLE event from idle. The incoming event is not interpreted by DM_IEV; it is always forwarded through the out terminal.

DM_IEV has a property called idle first which controls when the idle generation should take place. If TRUE, the idle generation begins before sending the incoming event through out; otherwise the idle generation happens after the event is sent.

DM_IEV keeps internal state indicating whether the idle generation is enabled or disabled. The idle generation becomes enabled or disabled when DM_IEV receives EV_REQ_ENABLE or EV_REQ_DISABLE, respectively. By default, the idle generation is enabled.

86. Boundary

86.1. Terminals

Terminal “in” with direction “In” and contract I_DRAIN. Note: v-table, infinite cardinality, floating, synchronous. This terminal receives all the incoming events for DM_IEV.

Terminal “out” with direction “Out” and contract I_DRAIN. Note: v-table, cardinality 1, floating, synchronous. DM_IEV sends all events received from in out through this terminal. The events are not interpreted by DM_IEV.

Terminal “idle” with direction “Bi” and contract I_DRAIN. Note: v-table, cardinality 1, synchronous. The EV_IDLE events are sent out through this terminal. EV_REQ_ENABLE and EV_REQ_DISABLE may be received through this terminal to control the idle generation.

86.2. Events and Notifications

| Event | Bus | Notes |
|---|---|---|
| <all> | CMEVENT_{—} | All incoming events received from in |
| | HDR | terminal are passed through out |
| | /CMEvent | terminal. |
| | | Depending on the value of the |
| | | idle_first property, DM_IEV will send |
| | | the event out either before or after |
| | | the idle generation. |

86.3. Special Events, Frames, Commands or Verbs

| Special Incoming | | |
|---|---|---|
| Event | Bus | Notes |
| EV_REQ_ENABLE | CMEVENT_{—} | A request to start the idle |
| | HDR/CME | generation. It is received |
| | vent | through the idle terminal. |
| | | This request is sent by an |
| | | idle consumer. |
| | | Enabling and disabling are |
| | | not cumulative. |
| EV_REQ_DISABLE | CMEVENT_{—} | A request to stop the idle |
| | HDR/CME | generation. It is received |
| | vent | through the idle terminal. |
| | | This request is sent by an |
| | | idle consumer. |
| | | Enabling and disabling are |
| | | not cumulative. |

| Special Outgoing | | |
|---|---|---|
| Event | Bus | Notes |
| EV_IDLE | CMEVENT | This event is generated |
| | _HDR/CME | continuously either before |
| | vent | or after sending the |
| | | incoming event out |
| | | through out (Depending on |
| | | the setting of the idle_first |
| | | property). |

86.4. Properties

Property “idle_first” of type “UINT32”. Note: If TRUE, DM_IEV will generate EV_IDLE events continuously before passing the incoming event to the out terminal. If FALSE, EV_IDLE feed will be generated after passing the incoming event to the out terminal. Non-mandatory, Default is FALSE

87. Encapsulated Interactions

None.

88. Specification

89. Responsibilities

1. Generate EV_IDLE events until the idle generation is disabled or a CMST_NO_ACTION or CMST_BUSY event status is returned.

2. Pass the incoming event through out terminal.

3. Maintain the internal state of the idle generation.

90. Theory of Operation

90.1. Mechanisms

Idle Generation

Idle generation becomes enabled or disabled when DM_IEV receives EV_REQ_ENABLE or EV_REQ_DISABLE respectively (through the idle terminal). By default, idle generation is enabled.

The idle generator is a tight loop that will continuously generate EV_IDLE events through the idle terminal. The generation will stop if the event return status is CMST_NO ACTION or CMST_BUSY or if EV_REQ_DISABLE is received on the idle terminal.

Passing the External Event

The incoming event is passed through the out terminal either before or after the idle generation. This is determined by the value of the idle first property. If the property is TRUE, the incoming event is sent out after the idle generation, otherwise its sent before.

90.2. Use Cases

Idle Generation After Passing the Event Through

1. The counter terminal of in sends an event to DM_IEV. The idle first property is FALSE.

2. The event is passed through the out terminal.

3. If the idle generation is enabled, EV_IDLE events are continuously generated and sent out through the idle terminal. The idle generation stops either when an EV_REQ_DISABLE event is received through the idle terminal or an event status of CMST_NO_ACTION or CMST_BUSY is returned.

4. DM_IEV returns with the status obtained in step 2 above.

Idle Generation Before Passing the Event Through

5. The counter terminal of in sends an event to DM_IEV. The idle first property is TRUE.

6. If the idle generation is enabled, EV_IDLE events are continuously generated and sent out through the idle terminal. The idle generation stops either when an EV_REQ_DISABLE event is received through the idle terminal or when an event status of CMST_NO_ACTION or CMST_BUSY is returned.

7. The event is passed through the out terminal.

Notes

DM_IEV is an idle feed generator driven by external events. Whenever it receives an incoming call (event), the idle generator propagates it to its output and then starts generating idle feed, or pulse event, (EV_IDLE) through its idle terminal. When it receives indication that there is no more need for idle feed, it returns to the original caller.

Together with DM_DWI, this part forms a complete implementation of the run to completion pattern. Whenever an incoming call is received, DM_IEV sends it out for processing; during this processing, one or more events may get enqueued on the idesynchronizer's queue for later processing. When DM_IEV receives control back, it starts feeding events into the desynchronizer, causing all pending events to be distributed. As a result, before DM_IEV returns to its caller, all events that were generated during the processing of the original call, are completely served. In conjunction with the poly-to-drain and drain-to-poly adapters, this mechanism can provide run to completion for practically any input interface.

Terminators

DM_STP, DM_BST, DM_PST, DM_PBS—Event and Operation Stoppers

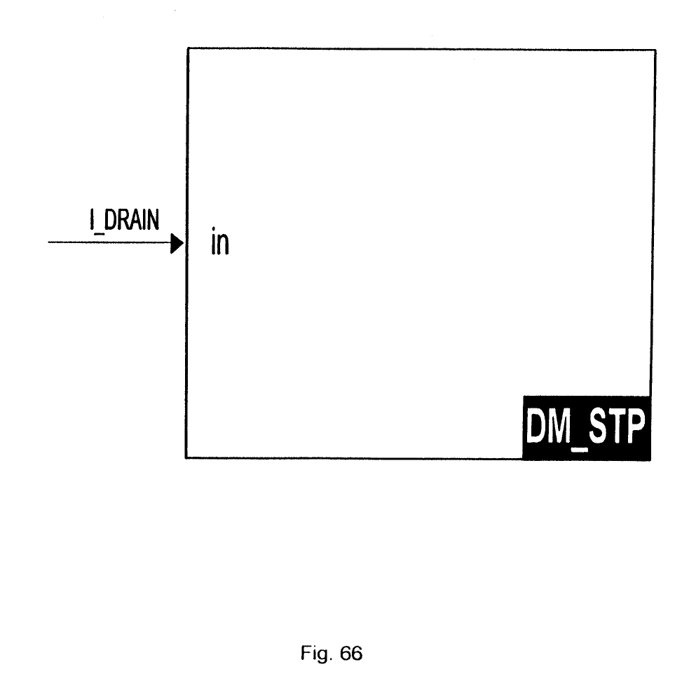

FIG. 66 illustrates the boundary of the inventive DM_STP part.

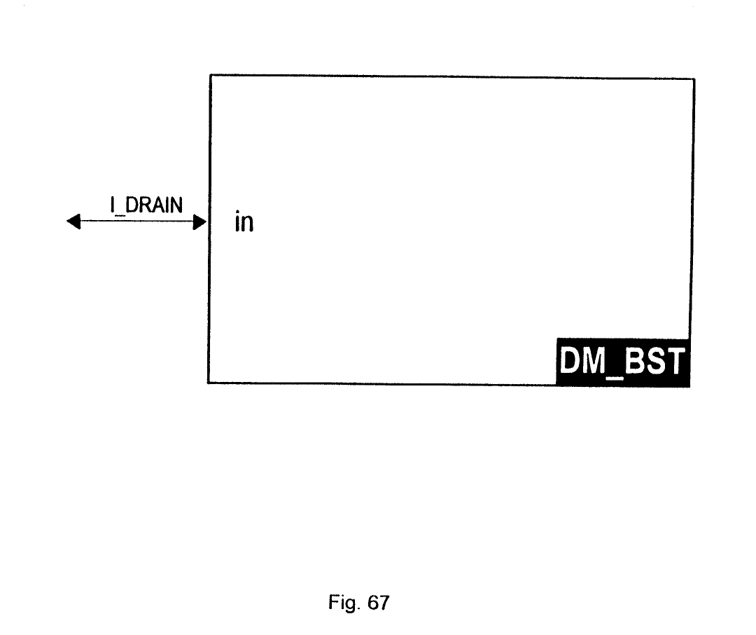

FIG. 67 illustrates the boundary of the inventive DM_BST part.

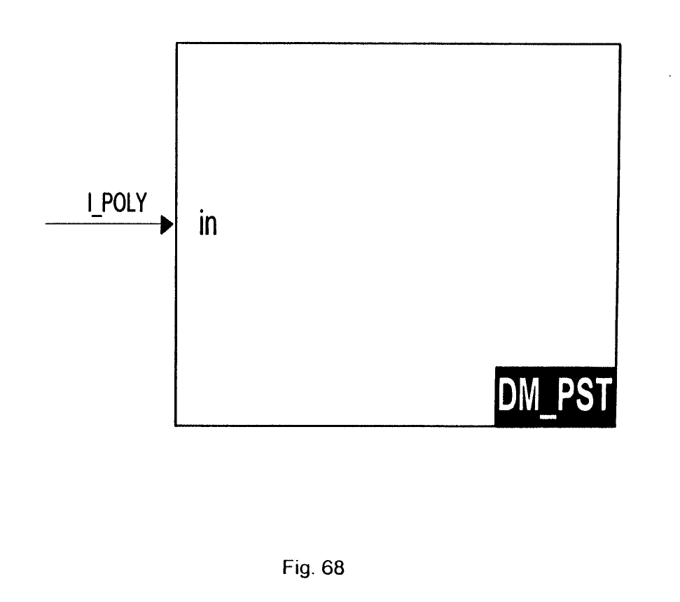

FIG. 68 illustrates the boundary of the inventive DM_PST part.

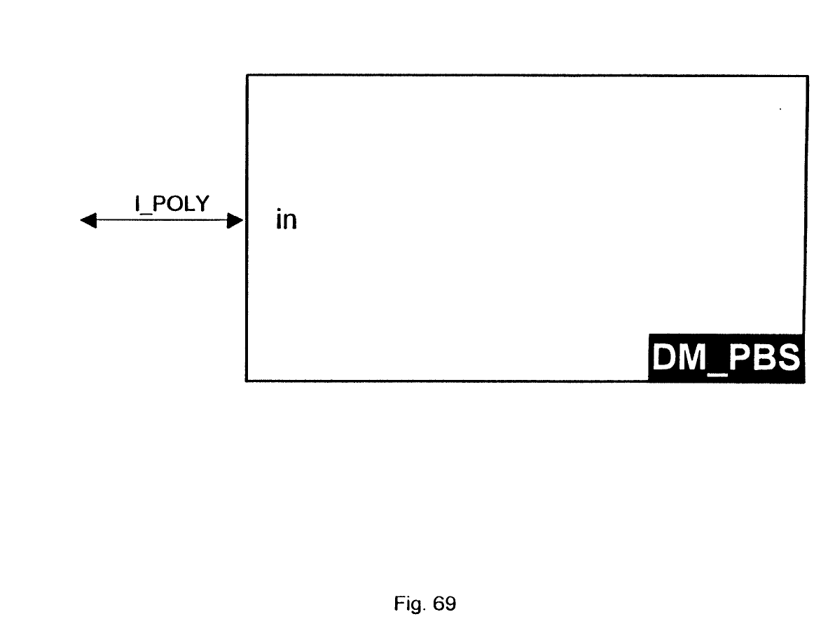

FIG. 69 illustrates the boundary of the inventive DM_PBS part.

DM_STP is a connectivity part. DM_STP consumes all events¹ that come to its in terminal and returns a status code specified in a property. ¹ DM_STP is something like a “black hole”—events go in, nothing goes out.

One of the important aspects of the DM_STP functionality is processing of self-owned events (CMEVT_A_SELF_OWNED). These events need special handling as the ownership of the memory allocated for them travels with them.

DM_STP frees the self-owned events if the return status (specified by a property) is CMST_OK. For compatibility reasons DM_STP exposes a property, which can force freeing the event memory regardless of the return status.

DM_PST and DM_PBS are I_POLY operation stoppers. These parts can be used to stub any interface and return the appropriate status.

1. Boundary

1.1. Terminals (DM_STP)

Terminal “in” with direction “In” and contract I_DRAIN. Note: All input events are received here and consumed by the part. The status returned is the one specified by the ret_s property. Unguarded. Can be connected when the part is active.

1.2. Terminals (DM_BST)

Terminal “in” with direction “Plug” and contract I_DRAIN. Note: All input events are received here and consumed by the part. The status returned is the one specified by the ret s property. Unguarded. Can be connected when the part is active.

1.3. Terminals (DM_PST)

Terminal “in” with direction “In” and contract I_POLY. Note: All operations received here and consumed by the part. The status returned is the one specified by the ret-s property. Unguarded. Can be connected when the part is active.

1.4. Terminals (DM_PBS)

Terminal “in” with direction “Plug” and contract I_POLY. Note: All operations received here and consumed by the part. The status returned is the one specified by the ret_s property. Unguarded. Can be connected when the part is active.

1.5. Events and Notifications

All events received on in terminal are consumed.

The memory allocated for the self-owned events is freed if the return status (property) is CMST_OK.

If the value of the force_free property is TRUE then the memory for the self-owned events is freed regardless of the return status.

1.6. Special Events, Frames, Commands or Verbs

None.

1.7. Properties

Property “ret_s” of type “UINT32”. Note: Status to return on the raise operation.

Default: CMST_OK.

Property “force_free” of type “UINT32”. Note: Set to TRUE to free self-owned events without regard of what ret s value is. Default: FALSE.

2. Encapsulated Interactions

None.

3. Specification

4. Responsibilities

17. DM_STP and DM_BST: Consume all events coming on in.

18. DM_PST and DM_PBS: Stub all operations invoked through the in terminal and return the appropriate status (specified by the ret_S property).

19. Free the memory allocated for self-owned events if necessary.

5. Theory of Operation

DM_STP consumes all events and returns a status specified by a property. The memory allocated for self-owned events is freed if any of the following conditions is satisfied:

a) the value of ret_s property is CMST_OK.

b) the value of the force_free property is TRUE.

5.1. Interior

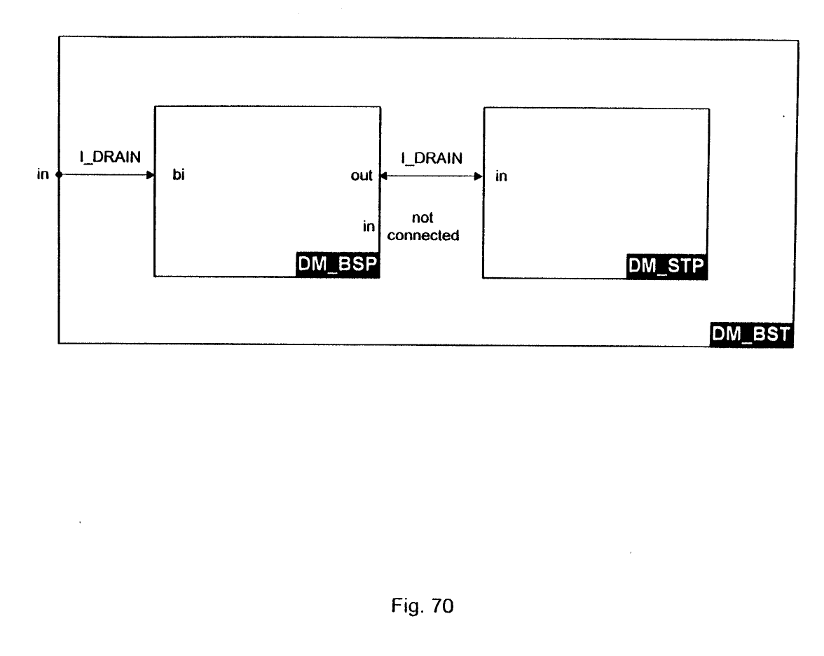

FIG. 70 illustrates the internal structure of the inventive DM_BST part.

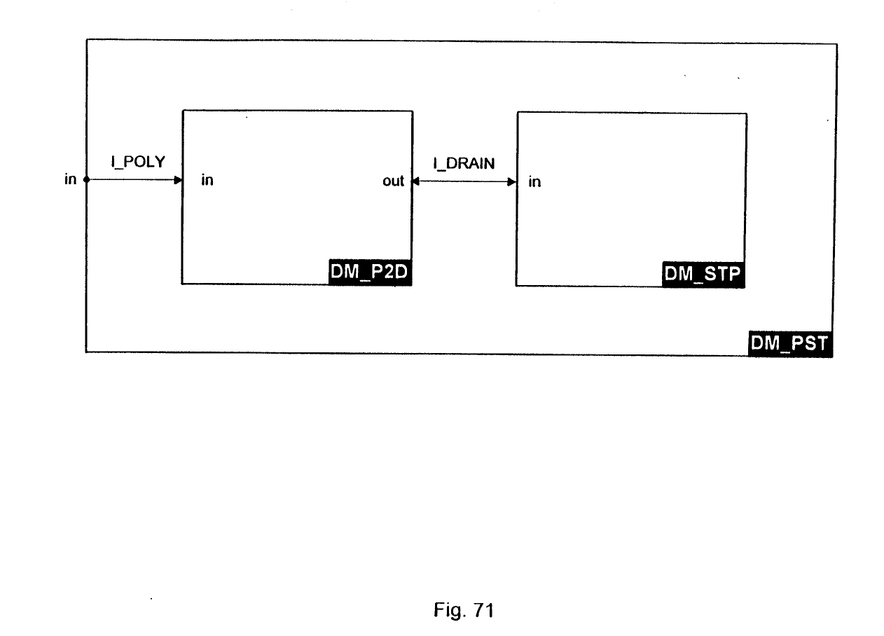

FIG. 71 illustrates the internal structure of the inventive DM_PST part.

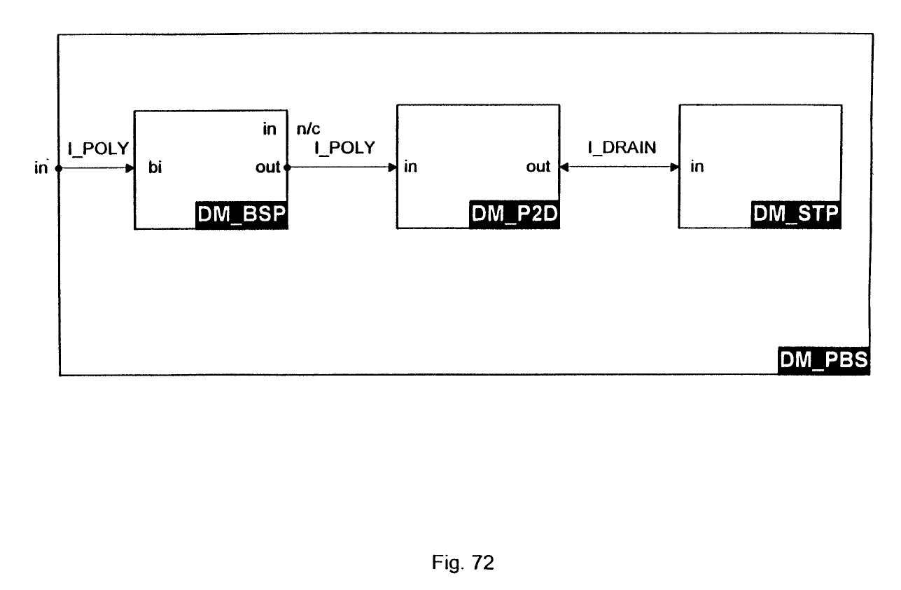

FIG. 72 illustrates the internal structure of the inventive DM_PBS part.

DM_STP is a coded part.

DM_BST, DM_PST and DM_PBS are static assemblies.

DM_UST, DM_DST—Universal and Drain Stoppers

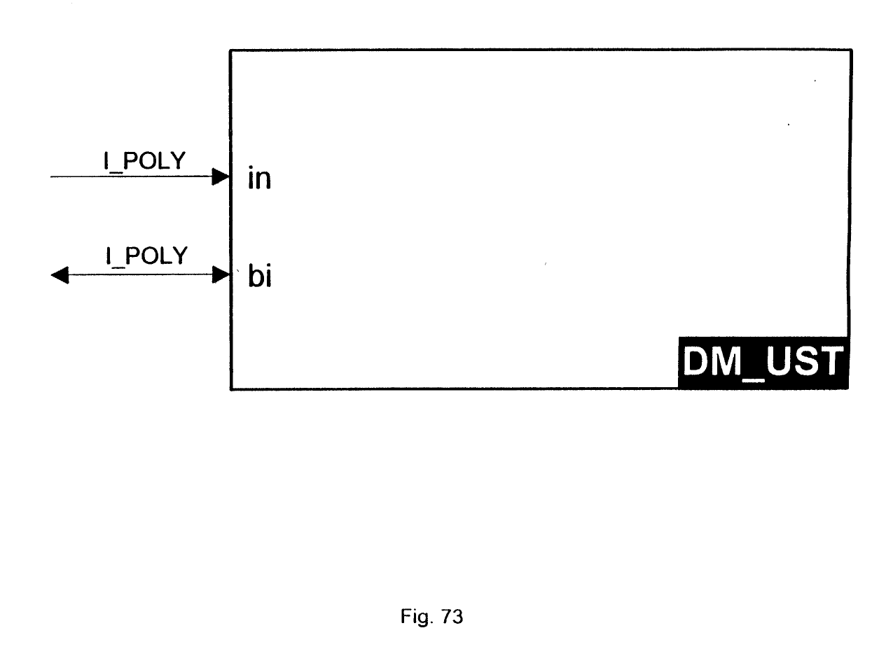

FIG. 73 illustrates the boundary of the inventive DM_UST part.

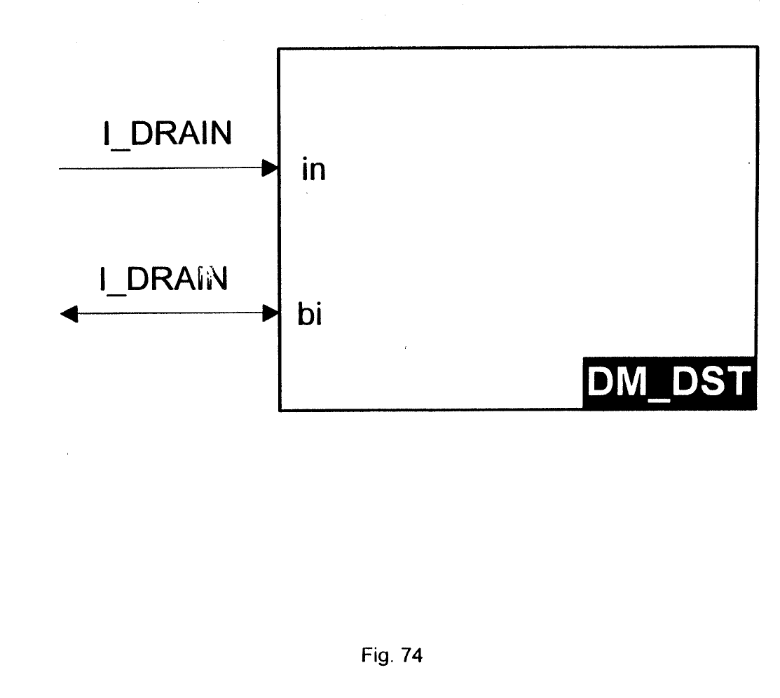

FIG. 74 illustrates the boundary of the inventive DM_DST part.

DM_UST and DM_DST are connectivity parts. They are used to consume all events/operations that come to their in and bi terminals and return a status code specified in a property. They can be used in either unidirectional or bidirectional connections. The terminals are activetime and unguarded providing maximum flexibility in their use.

DM_UST can be used to consume either events or operations, which is controlled through a property. For convenience, DM_DST is provided and can be used for event consumption instead of parameterizing DM_UST.

One of the important aspects of the functionality related to events is the processing of self-owned events (CMEVT_A_SELF_OWNED). These events need special handling as the ownership of the memory allocated for them travels with them.

DM_UST/DM_DST frees the self-owned events if the return status (specified by a property) is CMST_OK. For compatibility with older parts they expose a property, which can force free the event memory regardless of the return status.

6. Boundary

6.1. Terminals (DM_UST)

Terminal “in” with direction “In” and contract I_POLY. Note: v-table, activetime, infinite cardinality, synchronous All operations/events are received here and consumed by the part. Depending on the value of the in_is_drain property, this terminal is expected to be used for either events (I_DRAIN) or operation calls. The status returned is the one specified by the ret_s property. Unguarded. Can be connected when the part is active.

Terminal “bi” with direction “Plug” and contract I_POLY. Note: v-table, activetime, cardinality 1, synchronous Same as the in terminal described above except used for bidirectional connections. The output side of bi is not used.

6.2. Terminals (DM_DST)

Terminal “in” with direction “In” and contract I_DRAIN. Note: v-table, activetime, infinite cardinality, synchronous All events are received here and consumed by the part. The status returned is the one specified by the ret_s property. Unguarded. Can be connected when the part is active.

Terminal “bi” with direction “Plug” and contract I_DRAIN. Note: v-table, activetime, cardinality 1, synchronous Same as the in terminal described above except used for bidirectional connections. The output side of bi is not used.

6.3. Events and Notifications

DM_UST (parameterized as an event stopper) and DM_DST accept any incoming events and notifications on in or bi. They do not send out any events or notifications (the output side of bi is not used).

6.4. Special Events, Frames, Commands or Verbs

None.

6.5. Properties (DM_UST)

Property “in_is_drain” of type “UINT32”. Note: If TRUE, treat the in and bi terminals as I_DRAIN; otherwise as I_POLY. This property defines whether DM_UST is used to consume I_DRAIN events or interface operation calls. Default: FALSE.

Property “ret_s” of type “UINT32”. Note: Status to return on the operation invoked through the in or bi terminals. Default: CMST_OK.

Property “force_free” of type “UINT32”. Note: Set to TRUE to free self-owned events without regard of what ret s value is. Valid only if in_is_drain property is TRUE. Default: FALSE.

6.6. Properties (DM_DST)

Property “ret_s” of type “UINT32”. Note: Status to return on the raise operation. Default: CMST_OK.

Property “force_free” of type “UINT32”. Note: Set to TRUE to free self-owned events without regard of what ret-s value is. Default: FALSE.

7. Encapsulated Interactions

None.

8. Specification

9. Responsibilities

20. DM_UST: Consume either all operations or events received through the in and bi terminals and return the appropriate status (specified by the ret_s property).

21. DM_DST: Consume all events received through the in and bi terminals and return the appropriate status (specified by the ret_s property).

22. DM_UST and DM_DST: Free the memory allocated for self-owned events if necessary.

10. Theory of Operation

DM_UST consumes all events/operations and returns a status specified by the ret_s property.

If using DM_UST or DM_DST to consume events, the memory allocated for self-owned events is freed if any of the following conditions are satisfied:

a) the value of ret s property is CMST_OK.

b) the value of the force-free property is TRUE.

10.1. Interior

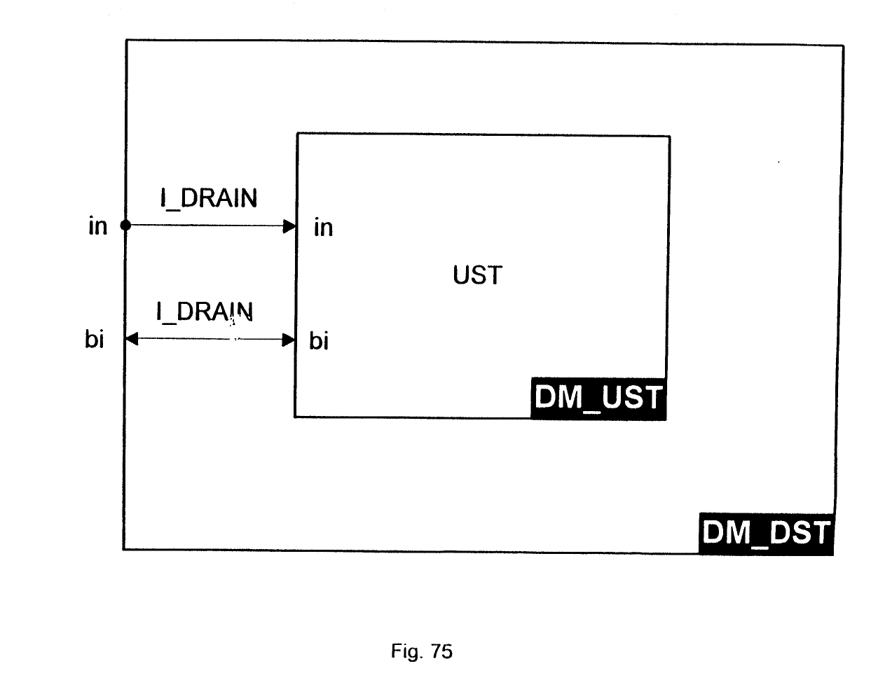

FIG. 75 illustrates the internal structure of the inventive DM_DST part.

DM_UST is a coded part.

DM_DST is a static assembly.

10.2. Hard Parameterization of Subordinates (DM_DST)

| Part | Property | Value |
|---|---|---|
| UST | in_is_drain | TRUE |

10.3.

10.4. Distribution of Properties to the Subordinates (DM_DST)

| Property | | | |
|---|---|---|---|
| Name | Type | Dist | To |
| ret_s | UINT32 | redir | UST.ret_s |
| force_free | UINT32 | redir | UST.force_free |

Event Consolidators

DM_ECSB and DM_ECS—Event Consolidators

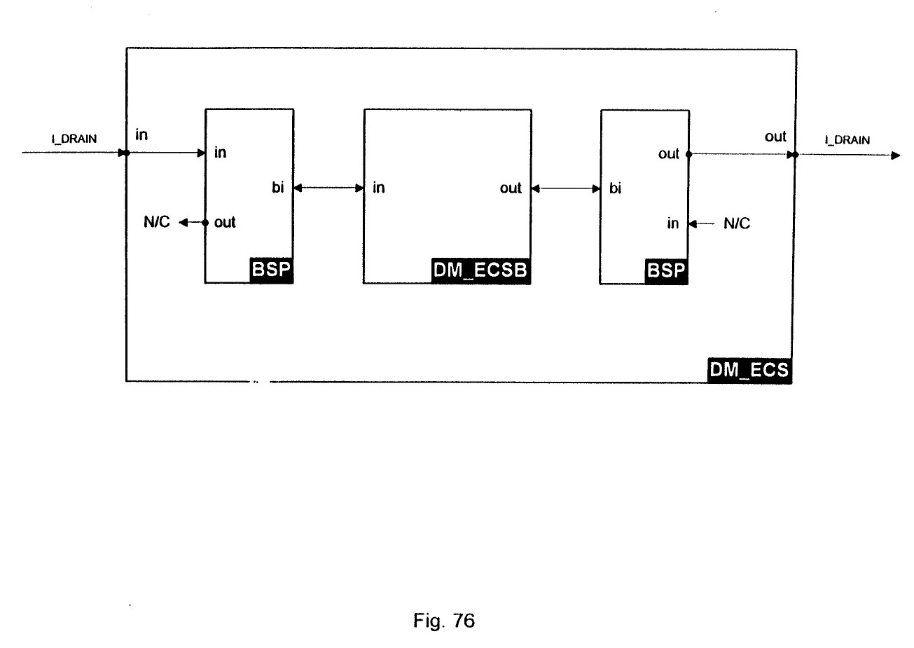

FIG. 76 illustrates the boundary of the inventive DM_ECS part.

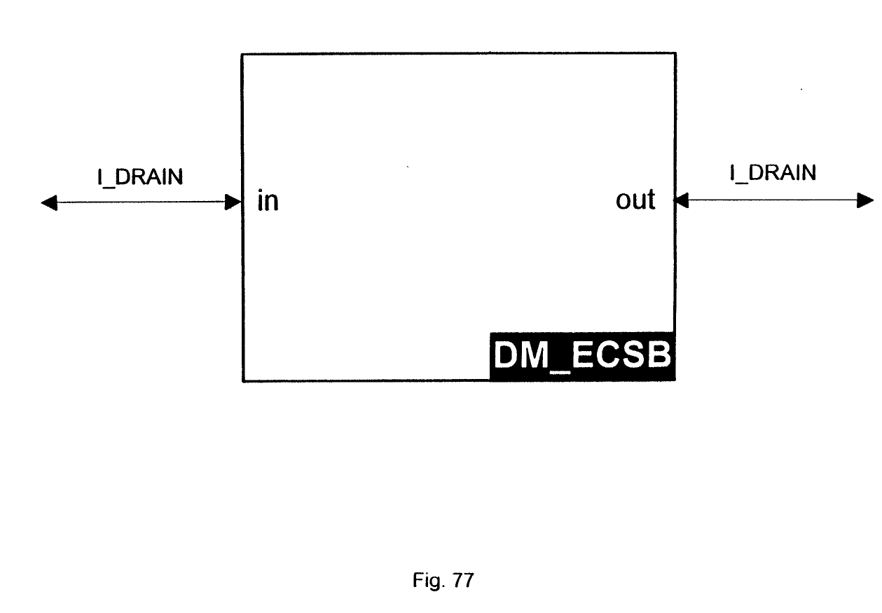

FIG. 77 illustrates the boundary of the inventive DM_ECSB part.

DM_ECSB recognizes a pair of events—the “open” event and the “close” event.

DM_ECSB forwards the first “open” event received on in to out and either counts and consumes or rejects subsequent “open” events depending on how it is parameterized.

DM_ECSB consumes all “close” events except for the last one, which it forwards to its out terminal. If DM_ECSB receives a “close” event and it has not received an “open” event, it returns a status with which it has been parameterized.

DM_ECSB forwards all unrecognized events received on its in terminal to its out terminal and visa versa.

DM_ECSB is able to handle events that are completed asynchronously.

DM_ECS is the uni-directional version of DM_ECSB. It assumes that all events are handled synchronously.

1. Boundary

1.1. Terminals (DM_ECSB)

Terminal “in” with direction “Bidir (plug)” and contract I_DRAIN (v-table). Note: Input for unconsolidated “open” and “close” events and output for completion events.

Terminal “out” with direction “Bidir (plug)” and contract I_DRAIN (v-table). Note: Output for consolidated “open” and “close” events and input for completion events.

1.2. Terminals (DM_ECS)

Terminal “in” with direction “In” and contract I_DRAIN (v-table). Note: Input for unconsolidated “open” and “close” events.

Terminal “out” with direction “Out” and contract I_DRAIN (v-table). Note: Output for consolidated “open” and “close” events.

1.3. Events and Notifications

DM_ECSB recognizes two specific events: ev_open and ev_close. The event IDs for these two events are specified as properties and are described in the table below.

| Incoming Event | Bus | Notes |
|---|---|---|
| ev_open | CMEVENT_ | Synchronous or |
| | HDR or | Asynchronous “open” |
| | extended | event received on in |
| | | terminal or an |
| | | asynchronous completion |
| | | event received on the out |
| | | terminal (DM_ECSB). |
| | | The event ID is specified |
| | | as a property on |
| | | DM_ECSB. |
| ev_close | CMEVENT_ | Synchronous or |
| | HDR or | Asynchronous “close” |
| | extended | event received on in |
| | | terminal or an |
| | | asynchronous completion |
| | | event received on the out |
| | | terminal (DM_ECSB). |
| | | The event ID is specified |
| | | as a property on |
| | | DM_ECSB. |
| all others | CMEVENT_ | All events received on in |
| | HDR or | are forwarded to out. |
| | extended | DM_ECSB: unrecognized |
| | | events received on out are |
| | | forwarded to in if |
| | | DM_ECSB is not expecting |
| | | to receive a completion |
| | | event; otherwise the |
| | | event is refused. |

1.4. Special Events, Frames, Commands or Verbs

None.

1.5. Properties

Property “ev_open” of type “UINT32”. Note: ID of the “open” event. The default is EV_REQ_ENABLE

Property “ev_close” of type “UINT32”. Note: ID of the “close” event. the default is EV_REQ_DISABLE

Property “cplt_s_offset” of type “UINT32”. Note: Offset in event bus for completion status. If the value is 0—do not use. The default is 0x00 for DM_ECS and 0x0C for DM_ECSB.

Property “underflow_s” of type “UINT32”. Note: Status to return when a “close” event is received and there is has been no “open” event received. The default is CMST_NO_ACTION.

Property “reject” of type “UINT32”. Note: (boolean)When TRUE, DM_ECS and DM_ECSB will reject nested “open” events. The default is FALSE.

Property “reject_s” of type “UINT32”. Note: Status to return when rejecting nested “open” events. The default is CMST_REFUSE.

Property “busy_s” of type “UINT32”. Note: Status to return if an “open” or “close” event is received on in and there is already a pending “open” or “close” request. The default is CMST_BUSY.

Property “force_free” of type “UINT32”. Note: (boolean)Set to TRUE to free self-owned events without regard to what the return status is. The default is FALSE.

2. Encapsulated Interactions

None.

3. Specification

4. Responsibilities

1. Maintain counter that is incremented when an “open” event is received and decremented when a “close” event is received.

2. Forward first “open” event and last “close” event received on in to out; consume or reject all others based on parameterization.

3. Forward all non-recognized events received on in to out without modification.

4. Refuse subsequent “open”/“close” events when there is a synchronous/asynchronous event request pending.

5. (DM_ECSB) Forward all non-recognized events received on out to in without modification.

5. Theory of Operation

5.1. State Machine

DM_ECSB implements a small state machine that it uses to handle pending events. Regardless of whether the events complete synchronously or asynchronously, it is possible to get into the following situation: while the first enable is pending, a second one comes. Since DM_ECSB doesn't know whether the first one will succeed, it doesn't know whether to pass it or not. Another situation is where the “close” event comes while the “open” event is still pending.

Note that if the events complete synchronously and the second request comes in another thread, it will be blocked until the first event completes and then it will be processed as usual. The problem exists only if the events may complete asynchronously or the second event may come in the same thread in which the first one is pending (feedback).

To simplify the above situations, DM_ECSB rejects subsequent “open”/“close” events, when it has an event pending, with CMST_BUSY.

The state machine has the following states:

| | |
|---|---|
| S_IDLE | DM_ECSB is waiting for |
| | an “open” or “close” event. |
| S_SYNC_PENDING | DM_ECSB is currently |
| | processing a synchronous |
| | “open” or “close” event |
| S_ASYNC_PENDING_OPEN | DM_ECSB is currently |
| | processing an |
| | asynchronous “open” event |
| | and is waiting for the |
| | completion event. |
| S_ASYNC_PENDING_CLOSE | DM_ECSB is currently |
| | processing an |
| | asynchronous “close” |
| | event and is waiting for the |
| | completion event. |

5.2. Mechanisms

Handling Pending Synchronous Events

When DM_ECSB receives a synchronous “open” or “close” event, and it is in the S_IDLE state and it does not consume/reject the event, it transitions its state to S_SYNC_PENDING and forwards the request to its output. When the operation has completed, DM_ECSB increments/decrements its counter, moves its state back to S_IDLE and returns the status from the call.

If DM_ECSB receives a synchronous “open” or “close” event and it is in any of its S_XXX_PENDING states, it consumes the request and returns the value of its busy_s property.

Handling Pending Asynchronous Events

When DM_ECSB receives a asynchronous “open” or “close” event, and it is in the S_IDLE state and it does not consume/reject the event, it transitions its state to S_ASYNC_PENDING_XXX depending on the event and forwards the request to its output. If the call fails with status other than CMST_PENDING, DM_ECSB moves back to the S_IDLE state. If the operation returned success and DM_ECSB's cplt_offset_s property is not 0, it checks the completion status in the event bus. If it is not CMST_OK or CMST_PENDING, it moves back to the S_IDLE state and returns the status from the call; otherwise it remains in the S_ASYNC_PENDING_XXX state.

When DM_ECSB receives the completion event on its out terminal for the pending event, it increments/decrements its counter appropriately, moves back to the S_IDLE state, and forwards the call to its in terminal.

If DM_ECSB receives an asynchronous “open” or “close” event and it is in any of its S_XXX_PENDING states, it fails the request and returns the value of its busy_s property.

Indicators

DM_IND—Indicator

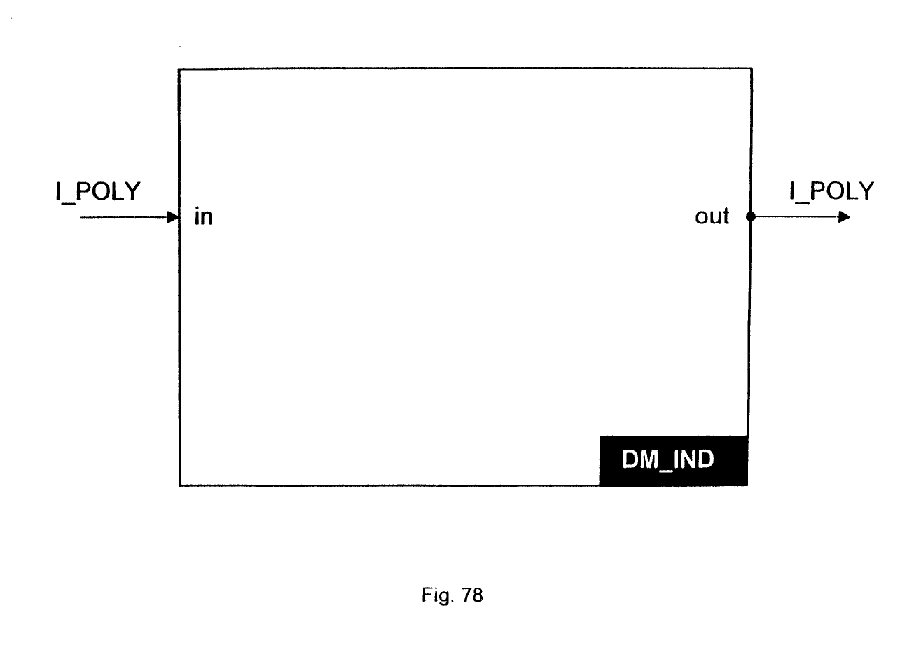

FIG. 78 illustrates the boundary of the inventive DM_IND part. DM_IND is used to trace the program flow through part connections. DM_IND can be inserted between any two parts that have a unidirectional connection. When an operation is invoked on its in terminal, DM_IND dumps the operation bus fields to the debug console by descriptor. The operation is then forwarded to the out terminal. DM_IND does not modify the operation bus.

In order to interpret the operation bus, DM_IND must be parameterized with a pointer to an interface bus descriptor (bus_descp property). This descriptor specifies the format strings and operation bus fields to be dumped. The format string syntax is the same as the one used in printf. The order of the fields in the descriptor needs to correspond to the order of the format specifiers in the format string. The descriptor may have any number of format strings and fields. The only limitation is that the total size of the formatted output cannot exceed 512 bytes. Please see the reference of your C or C++ run-time library for a description of the format string specifiers.

DM_IND's dump output can be disabled by setting the enabled property to FALSE. When disabled, all operation calls are directly passed through out, allowing control over multiple indicators in a system. By default, DM_IND will always dump the operation bus according to its descriptor.

Each DM_IND instance may be uniquely identified. Before dumping the operation bus to the debug console, DM_IND will optionally identify itself by outputting the name property (if not “ ”). This property can be set to any string; it is not interpreted by DM_IND.

1. Boundary

1.1. Terminals

Terminal “in” with direction “In” and contract I_POLY. Note: v-table, cardinality 1, floating, synchronous. All operations invoked through this terminal are passed through the out terminal. DM_IND does not modify the operation bus passed with the call.

Terminal “out” with direction “Out” and contract I_POLY. Note: v-table, cardinality 1, floating, synchronous. All operations invoked on the in terminal are passed through this terminal. If this terminal is not connected, DM_IND will fail the call with CMST_NOT_CONNECTED after displaying the data. DM_IND does not modify the operation bus passed with the call.

1.2. Events and Notifications

None.

1.3. Special Events, Frames, Commands or Verbs

None.

1.4. Properties

Property “name” of type “ASCIIZ”. Note: This is the instance name of DM_IND. It is displayed first in the debug output. Default is ““.

Property “enabled” of type “UINT32”. Note: If TRUE, DM_IND will dump the operation bus to the debug console according to its descriptor (bus-descp). If FALSE, DM_IND will not output anything to the debug console. It will just pass the operation call through out terminal. Default is TRUE.

Property “bus_descp” of type “UINT32”. Note: This is the pointer to the operation bus descriptor used by DM_IND. It describes the output format and the operation bus fields. This property must be set and contain a valid descriptor pointer. This property is mandatory.

2. Encapsulated Interactions

None.

3. Specification

4. Responsibilities

1. Dump the values of the operation bus fields to the debug console according to the bus descriptor.

2. Pass all operation calls on the in terminal out through the out terminal.

5. Theory of Operation

5.1. State Machine

None.

5.2. Main Data Structures

DM_IND uses an operation bus descriptor (supplied from outside by the property bus descp). This descriptor specifies the format strings and operation bus fields. The descriptor is an array of the following structure:

// entry types
enum CMINT_ET

| | | |
|---|---|---|
| { | | |
| CMIND_ET_NONE | = 0, | // no entry type specified |
| CMIND_ET_FORMAT | = 1, | // format string |
| CMIND_ET_VALUE | = 2, | // value field |
| CMIND_ET_REF | = 3, | // reference field |
| CMIND_ET_END | = 4, | // end of table |
| }; | | |

// operation bus table entry
typedef struct CMIND_BUS_ENTRY

| | | |
|---|---|---|
| { | | |
| dword | et | ; // entry type [CMIND_ET_XXX] |
| dword | et_ctx | ; // entry type specific context |
| dword | sz | ; // size of storage |

} CMIND_BUS_ENTRY;

The entry type specifies the type of the field. There are three entry types:

1. format string—The format string describes the way the output will look on the debug console. This entry contains a formatting string, identical to the one used by printf (i.e., “Int=%d, Char=%c\n”).

2. value field—The value field represents an operation bus field that contains a value. An example would be a character, an integer or a pointer to a string.

3. reference field—The reference field represents an operation bus field that should be passed by reference (address of). Use this type to print the value of a string that is contained in the bus. Excluding strings, DM_IND can dump only the value of a pointer, not the data referenced by the pointer.

The entry type context is either an offset to the storage of an operation bus field or a string reference. If the entry type is a format string, the context is a pointer to a string describing the output format. If the entry type is a value or reference field, the context is the offset of the field within the operation bus.

The size is only used by the value field entry type. This represents the size of the storage of the field within the operation bus.

DM_IND defines several macros that aid in defining the operation bus descriptor. The macros are defined below:

| Macro | Description |
|---|---|
| BUS_DUMP_DESC(name | Begin declaration of operation bus |
| | descriptor |
| END_BUS_DUMP_DESC | End declaration of operation bus |
| | descriptor |
| ind_format(str) | Define a format string entry |
| ind_by_val(bus,field) | Define a value field |
| ind_by_ref(bus,field) | Define a reference field |

DM_IND defines several macros that aid in parameterizing the indicator. The macros are defined below:

Note: These macros must follow immediately the DM_IND part entry in the SUBORDINATES table.

// macros used for hard parameterization of the indicator

| Macro | Description |
|---|---|
| ind_dump(name) | Hard parameterizes the “bus_descp” |
| | property to be the address of the |
| | declared bus descriptor |
| ind_disable | Hard parameterizes the “enabled” |
| | property to FALSE |
| ind_name(name) | Hard parameterizes the “name” property |
| | to name |

Here is an example of defining an operation bus descriptor:

BUS_DUMP_DESC (B_EXAMPLE_BUS)

ind_format (“Integer=%d, Character=%c, String=%s”)

ind_format (“Pointer=%1x, Buffer “%s\n”)

ind_by_val (B_EXAMPLE_BUS, integer)

ind_by_val (B_EXAMPLE_BUS, character)

ind_by_val (B_EXAMPLE_BUS, string)

ind_by_val (B_EXAMPLE_BUS, pointer)

ind_by_ref (B_EXAMPLE_BUS, buffer)

END_BUS_DUMP_DESC

Here is the definition of B_EXAMPLE_BUS:

BUS (B_EXAMPLE_BUS)

uint integer;

char character;

char *string;

void *pointer;

char buffer[120];

END_BUS

Here is an example of hard parameterizing DM_IND in the subordinates table:

SUBORDINATES (PART_NAME)

part (ind1, DM_IND)

ind_name (“My example indicator name”)

ind_dump (B_EXAMPLE_BUS)

ind_disable

// other parts . . .

END_SUBORDINATES

5.3. Mechanisms

Dumping an Operation's Bus Contents

DM_IND will assemble all output into one buffer and then dump the entire buffer to the debug console.

To dump the operation bus, DM_IND executes two passes through the operation bus descriptor. During the first pass, DM_IND will collect all format strings and concatenate them. During the second pass, DM_IND will collect all the field values and will assemble them in a separate buffer. DM_IND will then use wvsprintf to format the final output string and output it to the debug console.

The size of the formatted output cannot exceed 512 bytes. If it does there will be a memory overwrite by wvsprintf. DM_IND will attempt to detect overwrites but it cannot prevent them. If an overwrite is detected DM_IND will print a warning to the debug console.

5.4. Use Cases

Tracing/Debugging the Program Flow Through Connections

1. Insert DM_IND between a part A and part B. Part A's output terminal is connected to DM_IND's in terminal and Part B's input terminal is connected to DM_IND's out terminal.

2. Fill out a bus descriptor to get the desired output formatting for the bus.

3. Parameterize DM_IND with a pointer to the bus descriptor and an instance name (instance name is optional).

4. Activate DM_IND.

5. As Part A invokes operations through its output terminal connected to DM_IND, the operation calls come to DM_IND's in terminal. DM_IND displays its instance name (if name is not “ ”) and dumps the formatted operation bus contents to the debug console.

6. The operation call is passed out through DM_IND's out terminal and the operation on part B's input terminal is invoked. The return status from the operation call is returned to the caller.

Note As both terminals of DM_IND are of type I_POLY, care should be taken to use only compatible terminals; DM_IND may not always check that the contract ID is the same.

DM_CTR—Call Tracer

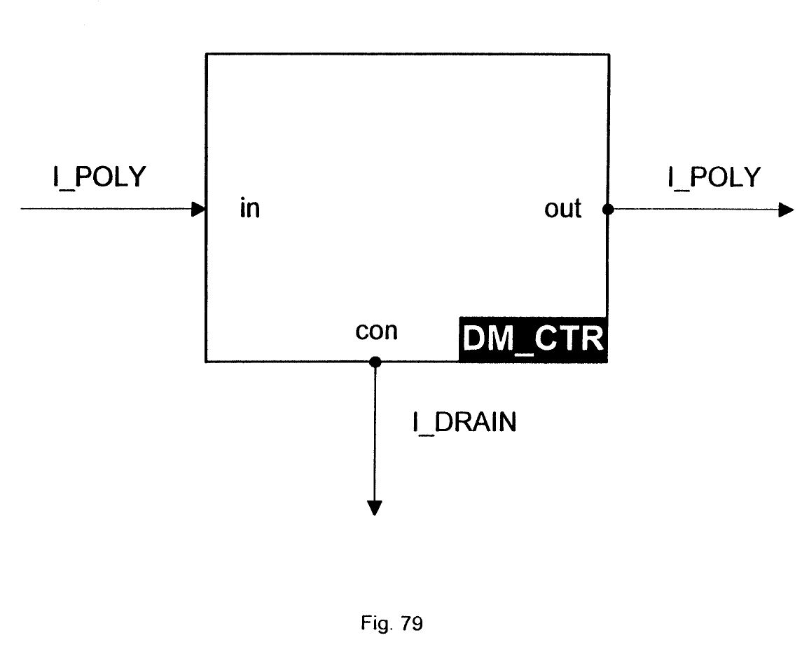

FIG. 79 illustrates the boundary of the inventive DM_CTR part.

DM_CTR is used to trace the program execution through part connections. DM_CTR can be inserted between any two parts that have a unidirectional connection.

When an operation is invoked on its in terminal, DM_CTR dumps the call information to either the debug console or by sending an EV_MESSAGE event through the con terminal (if connected). The operation is then forwarded to the out terminal. When the call returns, DM_CTR outputs the call information and the return status of the operation. DM_CTR does not modify the operation bus.

DM_CTR's output can be disabled through a property. When disabled, all operations are directly passed through out, allowing for selective tracing through a system.

Each DM_CTR instance is uniquely identified. Before dumping the operation bus, DM_CTR will identify itself. This identification includes the DM_CTR unique instance id, recurse count of the operation and other useful information. This identification may also include the value of the name property.

Note As both terminals of DM_CTR are of type I_POLY, care should be taken to use only compatible terminals; DM_CTR may not always check that the contract ID is the same.

6. Boundary

6.1. Terminals

Terminal “in” with direction “In” and contract I_POLY. Note: v-table, infinite cardinality, floating, synchronous. All operations invoked through this terminal are passed through the out terminal. DM_CTR does not modify the bus passed with the operation.

Terminal “out” with direction “Out” and contract I_POLY. Note: v-table, cardinality 1, floating, synchronous. All operations invoked on the in terminal are passed through this terminal. If this terminal is not connected, DM_CTR will return with CMST_NOT_CONNECTED after displaying the call information. DM_CTR does not modify the bus passed with the operation.

Terminal “con” with direction “Out” and contract I_DRAIN. Note: v-table, cardinality 1, floating, synchronous. If connected, DM_CTR sends an EV_MESSAGE event containing the call information through this terminal. In this case no debug output is printed.

6.2. Events and Notifications

| Outgoing | | |
|---|---|---|
| Event | Bus | Notes |
| EV_MESSA | B_EV_M | DM_CTR sends an EV_MESSAGE |
| GE | SG | event containing the call |
| | | information through the con |
| | | terminal (if connected). |
| | | This allows the output to be sent |
| | | to mediums other than the debug |
| | | console. |

6.3. Special Events, Frames, Commands or Verbs

None.

6.4. Properties

Property “name” of type “ASCIIZ”. Note: This is the instance name of DM_CTR. It is the first field in the call information. If the name is “ ”, the instance name printed is “DM_CTR”. Default is “ ”.

Property “enabled” of type “UINT32”. Note: If TRUE, DM_CTR will dump the call information to either the debug console or as an EV_MESSAGE event sent through the con terminal. If FALSE, DM_CTR will not output anything. It will just pass the operation call through the out terminal. Default is TRUE.

Property “op1-op16” of type “ASCIIZ”. Note: These properties are the names of the first 16 operations. DM_CTR uses these names to identify the operation call in the call information output. If the operation name is empty, the operation ID is used. Default is “ ”.

7. Encapsulated Interactions

None.

8. Specification

9. Responsibilities

1. Dump the call information to either the debug console or send an EV_MESSAGE event containing the output.

2. Pass all operation calls on the in terminal out through the out terminal.

10. Theory of Operation

10.1. State Machine

None.

10.2. Main Data Structures

None.

10.3. Mechanisms

Dumping the Call Information

DM_CTR will assemble all output into one buffer and then dump the entire buffer either to the debug console or by sending an EV_MESSAGE event through the con terminal.

DM_CTR determines where to send the output by checking if the con terminal is connected on activation. If con is connected, DM_CTR will send EV_MESSAGE events that contain the output. This enables the output to be sent to a different medium other than the debug console (i.e. serial port). If con is not connected, the output will always go to the debug console.

The format of the call information before DM_CTR passes the incoming call through out is:

| | |
|---|---|
| <instance name> [#<instance id>] | (<re- |

enterance call #>) <operation name/id> (<operation call #>)
called\n

The format of the call information after DM_CTR passes the incoming call through out is:

| | |
|---|---|
| <instance name> [#<instance id>] | (<re- |

enterance call #>) <operation name/id> (<operation call #>)
returned <status text> [<status code>]\n

Example:

MyCTRDump [#3451879] (1) “MyOpName” (3) called\n

MyCTRDump [#3451879] (2) “MyOpName” (4) called\n

MyCTRDump [#3451879] (2) “MyOpName” (4) returned CMST_OK [0]\n

MyCTRDump [#3451879] (1) “MyOpName” (3) returned CMST_OK [0]\n

In the example above, ‘MyOpName’ was called a total of 4 times.

| Field | Description |
|---|---|
| instance name | Unique name of DM_CTR supplied by |
| | user (name property). |
| instance id | Unique instance id of DM_CTR |
| | (assembled by DM_CTR). |
| re-enterance | Value that uniquely identifies the |
| call # | operation call in case of recursive calls |
| | to operations through the same |
| | interface. This makes it easy to trace |
| | recursive operation calls. |
| operation call # | Value that indicates the number of times |
| | operations have been called through this |
| | interface. DM_CTR only keeps track of |
| | the first 16 operations. |
| operation name | Name of operation invoked. |
| | If the operation does not have a name, |
| | DM_CTR will output the following |
| | “operation #XX” where XX is the |
| | operation number. |
| status text | Return status (text form) of operation |
| | invoked through DM_CTR's out |
| | terminal. |
| status code | Return status code of operation invoked |
| | through DM_CTR's out terminal. |

10.4. Use Cases

Tracing/Debugging the Program Flow Through connections (Output Sent to the Debug Console)

1. Insert DM_CTR between part A and part B. Part A's output terminal is connected to DM_CTR's in terminal and Part B's input terminal is connected to DM_CTR's out terminal.

2. Parameterize DM_CTR with an instance name and operation names (instance and operation names are optional).

3. Activate DM_CTR.

4. As Part A invokes operations through its output terminal connected to DM_CTR, the operation calls come to DM_CTR's in terminal. DM_CTR displays the call information to the debug console.

5. The operation call is passed out through DM_CTR's out terminal and the operation on part B's input terminal is invoked. The return status from the operation call is returned to the caller.

Tracing/Debugging the Program Flow Through Connections (Output Sent to Other Mediums)

1. Insert DM_CTR between part A and part B. Part A's output terminal is connected to DM_CTR's in terminal and Part B's input terminal is connected to DM_CTR's out terminal.

2. Connect DM_CTR's con terminal to Part C's in terminal.

3. Parameterize DM_CTR with an instance name and operation names (instance and operation names are optional).

4. Activate DM_CTR.

5. As Part A invokes operations through its output terminal connected to DM_CTR, the operation calls come to DM_CTR's in terminal. DM_CTR sends an EV_MESSAGE event containing the call information through the con terminal.

6. Part C receives the EV MESSAGE event and sends the call information out a serial port to another computer.

7. The operation call is passed out through DM_CTR's out terminal and the operation on part B's input terminal is invoked. The return status from the operation call is returned to the caller.

DM_BSD—Bus Dumper

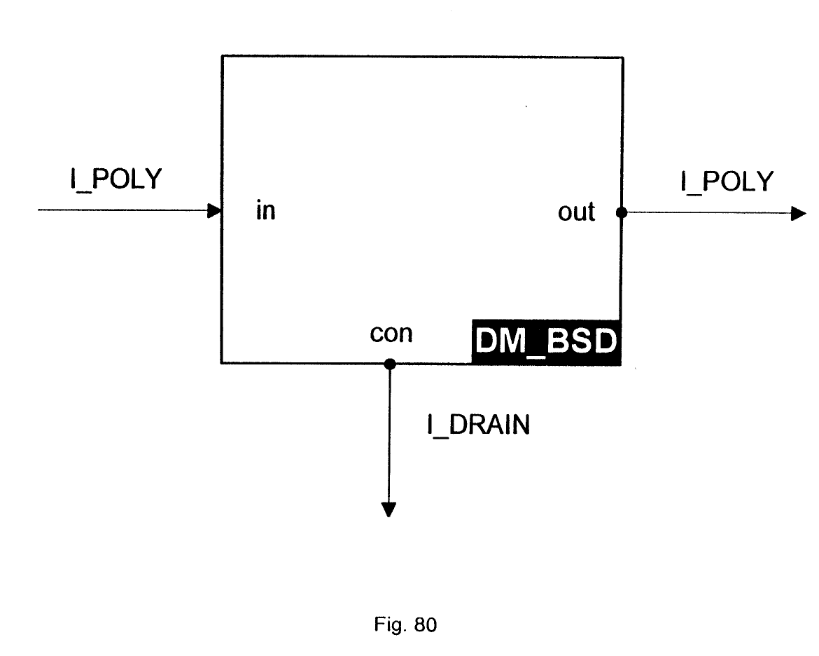

FIG. 80 illustrates the boundary of the inventive DM_BSD part.

DM_BSD is used to trace the program execution through part connections. DM_BSD can be inserted between any two parts that have a unidirectional connection.

When an operation is invoked on its in terminal, DM_BSD dumps the operation bus fields. The dump goes to either the debug console or by sending an EV_MESSAGE event through the con terminal (if connected). The operation is then forwarded to the out terminal. When the call returns, DM_BSD dumps the bus again. The dumping of the bus before and after the operation call can be selectively disabled through properties. DM_BSD does not modify the operation bus.

In order to interpret the operation bus, DM_BSD must be parameterized with a pointer to an interface bus descriptor (bus_descp property). This descriptor specifies the format strings and operation bus fields to be dumped. The format string syntax is the same as the one used in printf.

The order of the fields in the descriptor needs to correspond to the order of the format specifiers in the format string. The descriptor may have any number of format strings and fields. The only limitation is that the total size of the formatted output cannot exceed 512 bytes. Please see the reference of your C or C++ run-time library for a description of the format string specifiers.

DM_BSD's output can be disabled through properties. When disabled, all operations are directly passed through out, allowing for selective tracing through a system. By default, DM_BSD will always dump the operation bus according to its descriptor.

Each DM_BSD instance is uniquely identified. Before dumping the operation bus, DM_BSD will identify itself. This identification includes the DM_BSD unique instance id, recurse count of the operation invoked and other useful information. This identification may also include the value of the name property.

Note As both terminals of DM BSD are of type I_POLY, care should be taken to use only compatible terminals; DM_BSD may not always check that the contract ID is the same.

11. Boundary

11.1. Terminals

Terminal “in” with direction “In” and contract I_POLY. Note: v-table, infinite cardinality, floating, synchronous. All operations invoked through this terminal are passed through the out terminal. DM_BSD does not modify the bus passed with the operation.

Terminal “out” with direction “Out” and contract I_POLY. Note: v-table, cardinality 1, floating, synchronous. All operations invoked on the in terminal are passed through this terminal. If this terminal is not connected, DM_BSD will return with CMST_NOT_CONNECTED after dumping the bus information. DM_BSD does not modify the bus passed with the operation.

Terminal “con” with direction “Out” and contract I_DRAIN. Note: v-table, cardinality 1, floating, synchronous. If connected, DM_BSD sends an EV_MESSAGE event containing the bus dump through this terminal. In this case no debug output is printed.

11.2. Events and Notifications

| Outgoing | | |
|---|---|---|
| Event | Bus | Notes |
| EV_MESSA | B_EV_M | DM_BSD sends an EV_MESSAGE |
| GE | SG | event containing the bus dump |
| | | through the con terminal (if |
| | | connected). |
| | | This allows the dump to be sent |
| | | to mediums other than the debug |
| | | console. |

11.3. Special Events, Frames, Commands or Verbs

None.

11.4. Properties

Property “name” of type “ASCIIZ”. Note: This is the instance name of DM_BSD. It is the first field printed before the bus dump. If the name is “, the instance name printed is “DM_BSD”. Default is “ ”.

Property “enabled” of type “UINT32”. Note: If TRUE, DM_BSD will dump the call information to either the debug console or as an EV_MESSAGE event sent through the con terminal. If FALSE, DM_BSD will not output anything. It will just pass the operation call through the out terminal. Default is TRUE.

Property “bus_descp” of type “UINT32”. Note: This is the pointer to the operation bus descriptor used by DM_BSD. It describes the output format and the operation bus fields. This property must be set and contain a valid descriptor pointer. This property is mandatory.

Property “dump_before” of type “UINT32”. Note: If TRUE, DM_BSD will dump the operation bus before passing the call through the out terminal. Default is FALSE.

Property “dump_after” of type “UINT32”. Note: If TRUE, DM_BSD will dump the operation bus after passing the call through the out terminal. Default is FALSE.

12. Encapsulated Interactions

None.

13. Specification

14. Responsibilities

3. Dump the values of the operation bus fields to an output medium according to the bus descriptor.

4. Pass all operation calls on the in terminal out through the out terminal.

15. Theory of Operation

15.1. State Machine

None.

15.2. Main Data Structures

DM_BSD uses an operation bus descriptor (supplied from outside by the property bus descp). This descriptor specifies the format strings and operation bus fields. The descriptor is an array of the following structure:

// entry types
enum DM_BSD_ET

| | | |
|---|---|---|
| { | | |
| DM_BSD_ET_NONE | = 0, | // no entry type specified |
| DM_BSD_ET_FORMAT | = 1, | // format string |
| DM_BSD_ET_VALUE | = 2, | // value field |
| DM_BSD_ET_REF | = 3, | // reference field |
| DM_BSD_ET_END | = 4, | // end of table |
| }; | | |

// operation bus table entry
typedef struct DM_BSD_BUS_ENTRY

| | | |
|---|---|---|
| { | | |
| dword | et | ; // entry type [DM_BSD_ET_XXX] |
| dword | et_ctx | ; // entry type specific context |
| dword | sz | ; // size of storage |

} DM_BSD_BUS_ENTRY;

The entry type specifies the type of the field. There are three entry types:

4. format string—The format string describes the way the output will look. This entry contains a formatting string, identical to the one used by printf (i.e., “Int=%d, Char=%c\n”).

5. value field—The value field represents an operation bus field that contains a value. An example would be a character, an integer or a pointer to a string.

6. reference field—The reference field represents an operation bus field that should be passed by reference (address of). Use this type to print the value of a string that is contained in the bus. Excluding strings, DM_BSD can dump only the value of a pointer, not the data referenced by the pointer.

The entry type context is either an offset to the storage of an operation bus field or a string reference. If the entry type is a format string, the context is a pointer to a string describing the output format. If the entry type is a value or reference field, the context is the offset of the field within the operation bus.

The size is only used by the value field entry type. This represents the size of the storage of the field within the operation bus.

DM_BSD defines several macros that aid in defining the operation bus descriptor. The macros are defined below:

| Macro | Description |
|---|---|
| DM_BSD_BUS_DUMP_{—} | Begin declaration of operation |
| DESC(name) | bus descriptor |
| DM_BSD_END_BUS_{—} | End declaration of operation |
| DUMP_DESC | bus descriptor |
| dm_bsd_format(str) | Define a format string entry |
| dm_bsd_by_val(bus,field) | Define a value field |
| dm_bsd_by_ref(bus,field) | Define a reference field |

DM_BSD defines several macros that aid in parameterizing the indicator. The macros are defined below:

Note: These macros must follow immediately the DM_BSD part entry in the SUBORDINATES table.

| Macro | Description |
|---|---|
| dm_bsd_dump | Hard parameterizes the “bus_descp” |
| (name) | property to be the address of the |
| | declared bus descriptor |
| dm_bsd_disable | Hard parameterizes the “enabled” |
| | property to FALSE |
| dm_bsd_name | Hard parameterizes the “name” |
| (name) | property to name |
| dm_bsd_dump_{—} | Hard parameterizes the “dump_before” |
| before | property to TRUE |
| dm_bsd_dump_{—} | Hard parameterizes the “dump_after” |
| after | property to TRUE |

Here is an example of defining an operation bus descriptor:

DM_BSD_BUS_DUMP_DESC (B_EXAMPLE_BUS)

dm_bsd_format (“Integer=%d, Character=%c, String=%s”)

dm_bsd_format (“Pointer=%1x, Buffer “%s\n”)

dm_bsd_by_val (B_EXAMPLE_BUS, integer)

dm_bsd_by_val (B_EXAMPLE_BUS, character)

dm_bsd_by val (B_EXAMPLE_BUS, string)

dm_bsd_by_val (B_EXAMPLE_BUS, pointer)

dm_bsd_by_ref (B_EXAMPLE_BUS, buffer)

DM_BSD_END_BUS_DUMP_DESC

Here is the definition of B_EXAMPLE_BUS:

BUS (B_EXAMPLE_BUS)

uint integer;

char character;

char *string;

void *pointer;

char buffer[120];

END_BUS

Here is an example of hard parameterizing DM_BSD in the subordinates table: SUBORDINATES (PART_NAME)

part (ind1, DM_BSD)

dm_bsd_name (“My example bus dumper name”)

dm_bsd_dump (B_EXAMPLE_BUS)

dm_bsd_dump_before

dm_bsd_dump_after

dm_bsd_disable

// other parts . . .

END_SUBORDINATES

15.3. Mechanisms

Dumping an Operation's Bus Contents

DM_BSD will assemble the output into a buffer and then dump the entire buffer either to the debug console or by sending an EV_MESSAGE event through the con terminal.

DM_BSD determines where to send the output by checking if the con terminal is connected on activation. If con is connected, DM_BSD will send EV_MESSAGE events that contain the output. This enables the output to be sent to a different medium other than the debug console (i.e. serial port). If con is not connected, the output will always go to the debug console.

To dump the operation bus, DM_BSD executes two passes through the operation bus descriptor. During the first pass, DM_BSD will collect all format strings and concatenate them. During the second pass, DM_BSD will collect all the field values and will assemble them in a separate buffer. DM_BSD will then use wvsprintf to format the final output string.

The size of the formatted output cannot exceed 512 bytes. If it does there will be a memory overwrite by wvsprintf. DM_BSD will attempt to detect overwrites but it cannot prevent them. If an overwrite is detected DM_BSD will print a warning to the debug console.

The format of the output is:

| | |
|---|---|
| <instance name> [#<instance id>] | (call |

#<re-enterance call #>) <pre/post >\n

<dump of operation bus>\n
.\n

Here is an example:

MyBSDDump [#31378912] (call #5) pre\n

My Operation bus dump:\n

bus.integer=10\n

bus.char=‘A’\n

.\n

| Field | Description |
|---|---|
| instance name | Unique name of DM_BSD supplied by |
| | user (name property). |
| instance id | Unique instance id of DM_BSD |
| | (assembled by DM_BSD). |
| re-enterance | Value that uniquely identifies the |
| call # | operation call in case of recursive calls |
| | to other operations. This makes it easy |
| | to trace recursive operation calls. |
| pre\post | This indicates whether the dump of the |
| | bus is before or after the operation call |
| | passed through out. |
| dump of | This is the contents of the operation bus |
| operation bus | as defined by the bus descriptor |
| | (bus_descp property). |

15.4. Use Cases

Tracing/Debugging the Program Flow Through Connections (Output Sent to the Debug Console)

7. Insert DM_BSD between part A and part B. Part A's output terminal is connected to DM BSD's in terminal and Part B's input terminal is connected to DM_BSD's out terminal.

8. Parameterize DM_BSD with an instance name and bus descriptor (instance name is optional).

9. Activate DM_BSD.

10. As Part A invokes operations through its output terminal connected to DM_BSD, the operation calls come to DM_BSD's in terminal. DM_BSD dumps the formatted operation bus contents to the debug console.

11. The operation call is passed out through DM_BSD's out terminal and the operation on part B's input terminal is invoked. The return status from the operation call is returned to the caller.

Tracing/Debugging the Program Flow Through Connections (Output Sent to Other Mediums)

1. Insert DM_BSD between part A and part B. Part A's output terminal is connected to DM_BSD's in terminal and Part B's input terminal is connected to DM BSD's out terminal.

2. Connect DM_BSD's con terminal to Part C's in terminal.

3. Parameterize DM_BSD with an instance name and operation names (instance and operation names are optional).

4. Activate DM_BSD.

5. As Part A invokes operations through its output terminal connected to DM_BSD, the operation calls come to DM BSD's in terminal. DM_BSD sends an EV_MESSAGE event through the con terminal containing the formatted operation bus contents.

6. Part C receives the EV_MESSAGE event and sends the bus dump out a serial port to another computer.

7. The operation call is passed out through DM_BSD's out terminal and the operation on part B's input terminal is invoked. The return status from the operation call is returned to the caller.

Synchronization Parts Details

Desynchronizers

DM_FDSY—Fundamental Desynchronizer

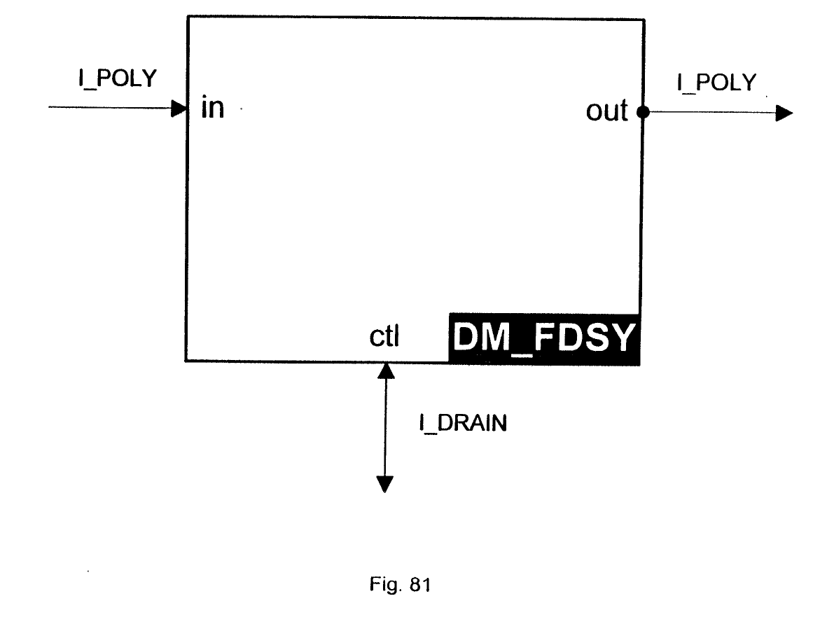

FIG. 81 illustrates the boundary of the inventive DM_FDSY part.

DM_FDSY de-couples the flow of control from the operation flow, a mechanism known as desynchronization. DM_FDSY desynchronizes all operations received on its in terminal. The operation buses are not interpreted by DM_FDSY. DM_FDSY enqueues the operation and its bus; the queue keeps the operations in the same order as they are received. As EV_IDLE/EV_PULSE events are received on its ctl input, DM_FDSY dequeues all the pending operations and sends them through the out terminal (one operation is dequeued for each EV_IDLE/EV_PULSE event received). The size of the queue used by DM_FDSY is dynamic and may be limited by a property called queue_sz.

DM_FDSY issues EV_REQ_ENABLE and EV_REQ_DISABLE requests through its ctl terminal in order to control the pulse generation. The issuing of these requests can be disabled through the property disable_ctl_req.

1. Boundary

1.1. Terminals

Terminal “in” with direction “In” and contract I_POLY. Note: v-table, infinite cardinality, floating, synchronous. DM_FDSY desynchronizes the operations received on this terminal. The bus passed with the operation call is not interpreted by DM_FDSY. This terminal is unguarded. DM_FDSY does not enter its guard at any time.

Terminal “out” with direction “Out” and contract I_POLY. Note: v-table, cardinality 1, synchronous. DM_FDSY sends all desynchronized queued operations out through this terminal (when it receives EV_IDLE/EV_PULSE events from ctl). The bus passed with the operation call is not interpreted by DM_FDSY and is passed directly through the out terminal. The outgoing operations are in the same order as they were received from in.

Terminal “ctl” with direction “Plug” and contract I_DRAIN. Note: v-table, cardinality 1, synchronous. EV_IDLE/EV_PULSE events are received through this terminal so DM_FDSY can dequeue operations and send them through the out terminal (one operation is dequeued for each EV_IDLE/EV_PULSE event received). DM_FDSY generates pulse enable/disable requests through this terminal (unless the disable_ctl_req property is TRUE). This terminal is unguarded. DM_FDSY does not enter its guard at any time.

1.2. Events and Notifications

| Incoming | | |
|---|---|---|
| Event | Bus | Notes |
| EV_RESET | CMEVENT_{—} | This event is received on the ctl terminal. |
| | HDR | In response, DM_FDSY flushes its |
| | | operation queue. No operations are |
| | | invoked through the out terminal. |
| EV_IDLE | CMEVENT_{—} | This event is received on the ctl terminal. |
| | HDR | In response, DM_FDSY dequeues an |
| | | operation and invokes it through out. |
| | | If there are no elements on the queue, |
| | | DM_FDSY will return CMST_NO_{—} |
| | | ACTION even if disable_ctl_req |
| | | property is set to TRUE. |
| EV_PULSE | CMEVENT_{—} | This event is the same as EV_IDLE. |
| | HDR | |

| Outgoing | | |
|---|---|---|
| Event | Bus | Notes |
| EV_REQ_{—} | CMEVENT_{—} | DM_FDSY sends this request through ctl |
| ENABL | HDR | when an operation is invoked on the in |
| | | terminal and the operation queue was |
| | | empty. |
| | | DM_FDSY sends this event only if |
| | | disable_ctl_req property is FALSE. |
| EV_REQ_{—} | CMEVENT_{—} | DM_FDSY sends this request through ctl |
| DISABLE | HDR | if the operation queue is empty (after |
| | | receiving EV_IDLE/EV_PULSE and |
| | | dequeueing the last operation). |
| | | DM_FDSY sends this event only if |
| | | disable_ctl_req property is FALSE. |

1.3. Special Events, Frames, Commands or Verbs

None.

1.4. Properties

Property “queue_sz” of type “UINT32”. Note: This is the number of events that the operation queue can hold. If 0, the queue will extend itself when it gets full (the number of operations the queue can hold is limited only by available memory). Default is 0.

Property “disable_ctl_req” of type “UINT32”. Note: Boolean. If FALSE, DM_FDSY sends requests through ctl to enable/disable the pulse generation when needed. If TRUE, requests are never sent through ctl. Default is FALSE.

Property “ok_stat” of type “UINT32”. Note: This specifies the status that DM_FDSY returns on calls through in if the operation was successfully enqueued. This status is also used to determine if operations passed through out succeeded. Default is CMST_OK.

Property “disable_diag” of type “UINT32”. Note: Boolean. This determines whether DM_FDSY prints debug output indicating that a call through ctl or out failed. A call through ctl fails if the return status is not equal to CMST_OK. A call through out fails if the return status is not equal to ok_stat. This property affects only the checked build of DM_FDSY. Default is FALSE.

2. Specification

3. Responsibilities

1. Desynchronize all incoming operations received through the in terminal and return the appropriate status.

2. When an EV_IDLE/EV_PULSE event is received from the ctl terminal, dequeue and invoke an operation through the out terminal.

3. Do not interpret or modify the operation bus passed with operation calls received on the in terminal.

4. Depending on the value of the disable_ctl_req property, generate enable/disable requests through ctl when needed.

5. Depending on the value of disable_diag, print debug output if operations invoked through out or ctl fail (checked builds only).

4. Theory of Operation

4.1. Main Data Structures

DM_FDSY uses a DriverMagic queue to store all desynchronized operations and their buses.

4.2. Mechanisms

Desynchronization of Incoming Operations

DM_FDSY desynchronizes all operations invoked through the in terminal. DM_FDSY enqueues the operation and its bus and returns to the caller. The return status is ok_stat (if enqueing of the operation succeeded; otherwise a failure status is returned). DM_FDSY then requests pulse generation (if the disable ctl req property is FALSE and the queue was empty) by sending an EV_REQ_ENABLE event through the ctl terminal.

For each EV_IDLE/EV_PULSE event received from the ctl terminal, DM_FDSY dequeues one operation and invokes it through out. If the disable ctl req property is FALSE and the queue is empty, DM_FDSY requests to disable the pulse generation by sending an EV_REQ_{DISABLE —}event through ctl.

The operation bus received on the in terminal is not interpreted, modified or valchked by DM_FDSY. The operation bus passed through out is the exact same bus received with the operation invoked through the in terminal.

All enable/disable pulse generation events sent through ctl are allocated on the stack and sent with the CMEVT_A_SYNC_ANY and CMEVT_A_SELF_CONTAINED attributes.

Event Handling on the ctl Terminal

All self-owned events received on the ctl terminal are freed by DM_FDSY only if the processing of that event is successful (CMST_OK is returned).

All unrecognized events are not processed by DM_FDSY and a CMST_NOT_SUPPORTED status is returned. if an EV_IDLE or EV_PULSE event is received when the operation queue is empty, DM_FDSY returns CMST_NO_ACTION.

4.3. Use Cases

Desynchronizing Operations

1. The counter terminal of in invokes an operation through in and the call is received by DM_FDSY.

2. Unless the disable_ctl_req property is TRUE, an EV_REQ_ENABLE event is sent through the ctl terminal.

3. The operation is enqueued and the flow of control is returned to the caller. The return status is ok_stat.

4. Steps 1 and 3 may be repeated several times.

5. DM_FDSY receives an EV_IDLE/EV_PULSE event from its ctl terminal.

6. DM_FDSY dequeues one operation and invokes it through the out terminal passing the same operation bus as received on the in terminal.

7. If the return status from the operation call is not equal to ok_stat and disable_diag is FALSE, DM_FDSY prints debug output indicating that the operation call failed.

8. Steps 5 through 7 are repeated many times.

9. If the disable ctl_req property is FALSE an EV_REQ_DISABLE event is sent through the ctl terminal to stop the pulse generation (when the operation queue becomes empty).

5. Notes

1. DM_FDSY assumes that buses passed with operations invoked through the in terminal are not allocated on the caller's stack.

2. DM_FDSY does not interpret, modify or valchk the operation buses received on the in terminal. The bus passed through the out terminal is exactly the same as the bus received on the in terminal (it is the original bus pointer).

DM_DSY—Desynchronizer

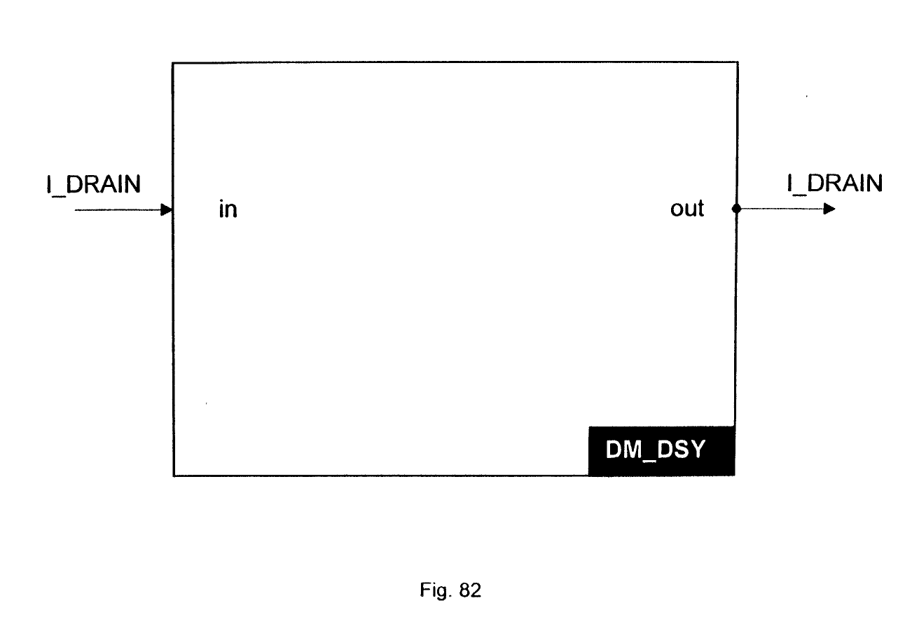

FIG. 82 illustrates the boundary of the inventive DM_DSY part.

DM_DSY desynchronizes and forwards events received at its in input. The input event will be desynchronized only if the input event's attributes specify that it may be distributed asynchronously and it is self-contained. If the input event is not self-owned, DM_DSY will output a copy of the event.

6. Boundary

6.1. Terminals

Terminal “in” with direction “In” and contract I_DRAIN. Note: v-table, infinite cardinality, synchronous This terminal receives all the incoming events for DM_DSY.

Terminal “out” with direction “Out” and contract I_DRAIN. Note: v-table, cardinality 1, synchronous DM_DSY sends all de-synchronized events out through this terminal.

6.2. Events and Notifications

| Incoming | | |
|---|---|---|
| Event | Bus | Notes |
| EV_XXX | CMEVENT_{—} | All incoming events on in are de- |
| | HDR | synchronized and sent out through out. |
| | /CMEvent | |

6.3.

| Outgoing | | |
|---|---|---|
| Event | Bus | Notes |
| EV_XXX | CMEVENT_{—} | All incoming events on in are de- |
| | HDR | synchronized and sent out through out. |
| | /CMEvent | |

6.4. Special Events, Frames, Commands or Verbs

None.

6.5. Properties

None.

7. Encapsulated Interactions

None.

8. Specification

9. Responsibilities

2. Desynchronize all incoming events received from in and send them out through out.

10. Theory of Operation

10.1. State Machine

None.

10.2. Main Data Structures

None.

10.3. Mechanisms

Desynchronization of Incoming Events

DM_DSY desynchronizes an input event by first examining the event attributes. If the event can be distributed only synchronously or is not self-contained, DM_DSY will not desynchronize the event and return error status. If the event is not self-owned, DM_DSY will allocate a new event control block and copy the input event into it.

Next, DM_DSY uses a built-in ClassMagic mechanism to desynchronize the event and returns to the caller. At a later time, usually when the application or the system is idle, DM_DSY passes the event through its out output.

Note The desynchronized event may be distributed in thread different than the one that posted it. This may impose additional limitations if thread-local storage is used.

10.4. Use Cases

Desynchronization of Incoming Events That Are Not Self-Owned

1. The counter terminal of in sends an event to DM_DSY.

2. DM_DSY receives the event.

3. If the event is not desynchronizable, the call fails; DM_DSY returns CMST_REFUSE.

4. DM_DSY allocates a new event control block and copies the input event into it. Note that the input event may have been allocated on the stack or on the heap; DM_DSY handles these cases correctly.

5. The event is enqueued and the control is returned back to the caller.

6. When DM_DSY receives control from the ClassMagic desynchronizer, the event is sent through the out output synchronously.

7. The counter terminal of out processes the event and returns control back to DM_DSY.

8. DM_DSY returns control back to the ClassMagic desynchronizer.

DM_DSYR—Desynchronizer for Requests

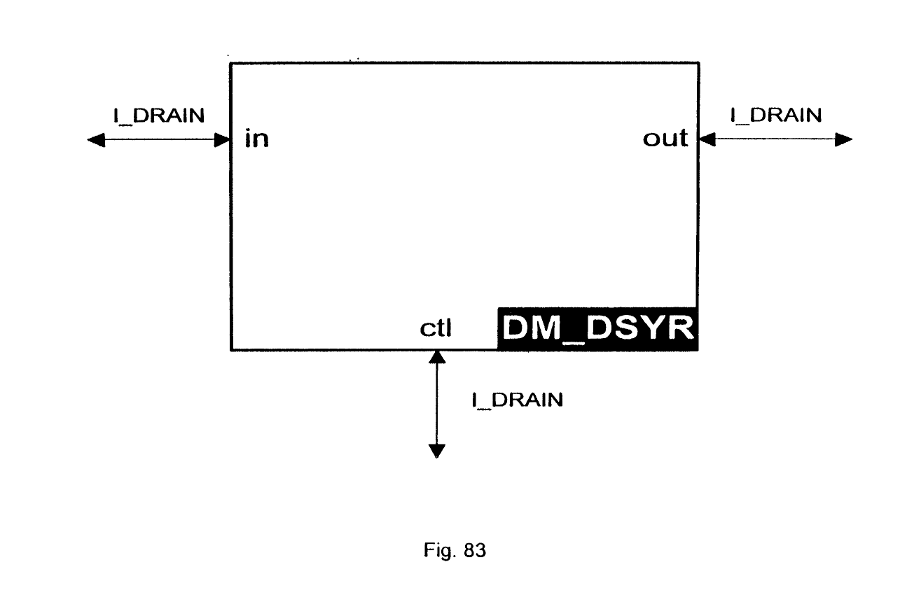

FIG. 83 illustrates the boundary of the inventive DM_DSYR part.

DM_DSYR de-couples the flow of control from the request flow, a mechanism known as desynchronization. DM_DSYR desynchronizes all requests received on its in terminal. DM_DSYR enqueues the request; the queue keeps the requests in the same order as they are received. For each EV_IDLE or EV_PULSE event received on its ctl input, DM_DSYR dequeues one pending request and sends it through the out terminal. The size of the queue used by DM_DSYR is dynamic and may be limited by a property called queue_sz.

DM_DSYR issues EV_REQ_ENABLE and EV_REQ_DISABLE requests through its ctl terminal in order to control the pulse generation. The issuing of these requests can be disabled through the property disable_ctl_req.

DM_DSYR expects that the incoming request can complete asynchronously. If the request does not have the CMEVT_A_ASYNC_CPLT attribute set, DM_DSYR fails the request with CMST_REFUSE.

DM_DSYR assumes that the requests are not allocated on the caller's stack.

11. Boundary

11.1. Terminals

Terminal “in” with direction “Plug” and contract I_DRAIN. Note: v-tablet infinite cardinality, floating, synchronous. DM_DSYR desynchronizes the requests received on this terminal. This terminal is unguarded. DM_DSYR does not enter its guard at any time.

Terminal “out” with direction “Plug” and contract I_DRAIN. Note: v-table, cardinality 1, synchronous. DM_DSYR sends all desynchronized queued requests out through this terminal (when it receives EV_IDLE/EV_PULSE events from ctl). The outgoing requests are in the same order as they were received from in.

Terminal “ctl” with direction “Plug” and contract I_DRAIN. Note: v-table, cardinality 1, synchronous. EV_IDLE/EV_PULSE events are received through this terminal so DM_DSYR can dequeue requests and send them through the out terminal (one operation is dequeued for each EV_IDLE/EV_PULSE event received). DM_DSYR generates pulse enable/disable requests through this terminal (unless the disable-ctl_req property is TRUE). This terminal is unguarded. DM_DSYR does not enter its guard at any time.

11.2. Events and Notifications

| Incoming | | |
|---|---|---|
| Event | Bus | Notes |
| EV_RESET | CMEVENT_{—} | This event is received on the ctl terminal. |
| | HDR | In response, DM_DSYR flushes its |
| | | request queue. No requests are sent |
| | | through the out terminal. |
| EV_IDLE | CMEVENT_{—} | This event is received on the ctl terminal. |
| | HDR | In response, DM_DSYR dequeues |
| | | a request and sends it through out. |
| | | If there are no elements on the queue, |
| | | DM_DSYR will return CMST_NO_{—} |
| | | ACTION even if disable_ctl_req |
| | | property is set to TRUE. |
| EV_PULSE | CMEVENT_{—} | This event is the same as EV_IDLE. |
| | HDR | |

| Outgoing | | |
|---|---|---|
| Event | Bus | Notes |
| EV_REQ_{—} | CMEVENT_{—} | DM_DSYR sends this request through ctl |
| ENABLE | HDR | when a request is received on the in |
| | | terminal and the request queue was empty. |
| | | DM_DSYR sends this event only if |
| | | disable_ctl_req property is FALSE. |
| EV_REQ_{—} | CMEVENT_{—} | DM_DSYR sends this request through ctl |
| DISABLE | HDR | if the request queue is empty (after |
| | | receiving EV_IDLE/EV_PULSE and |
| | | dequeueing the last request). |
| | | DM_DSYR sends this event only if |
| | | disable_ctl_req property is FALSE. |

11.3. Special Events, Frames, Commands or Verbs

None.

11.4. Properties

Property “queue_sz” of type “UINT32”. Note: This is the number of events that the request queue can hold. If 0, the queue will extend itself when it gets full (the number of requests the queue can hold is limited only by available memory). This property is redirected to the FDSY subordinate. Default is 0.

Property “disable_ctl_req” of type “UINT32”. Note: Boolean. If FALSE, DM_DSYR sends requests through ctl to enable/disable the pulse generation when needed. If TRUE, requests are never sent through ctl. This property is redirected to the FDSY subordinate. Default is FALSE.

Property “disable_diag” of type “UINT32”. Note: Boolean. This determines whether DM_DSYR prints debug output indicating that a call through ctl or out failed. A call through ctl fails if the return status is not equal to CMST_OK. A call through out fails if the return status is not equal to CMST_PENDING. This property affects only the checked build of DM_DSYR. This property is redirected to the FDSY subordinate. Default is FALSE.

Property “cplt_s_offs” of type “UINT32”. Note: Offset in bytes of the completion status in the request bus. This property is redirected to the ACT subordinate. Mandatory.

12. Encapsulated Interactions

None.

13. Specification

14. Responsibilities

Desynchronize all incoming requests received through the in terminal and return the appropriate status.

If the CMEVT_A_ASYNC_CPLT attribute is not set on the incoming request fail with CMST_REFUSE.

When an EV_IDLE/EV_PULSE event is received from the ctl terminal, dequeue and invoke a request through the out terminal.

Depending on the value of the disable_ctl_req property, generate enable/disable requests through ctl when needed.

Depending on the value of disable_diag, print debug output if requests sent through out or ctl fail (checked builds only).

15. Internal Definition

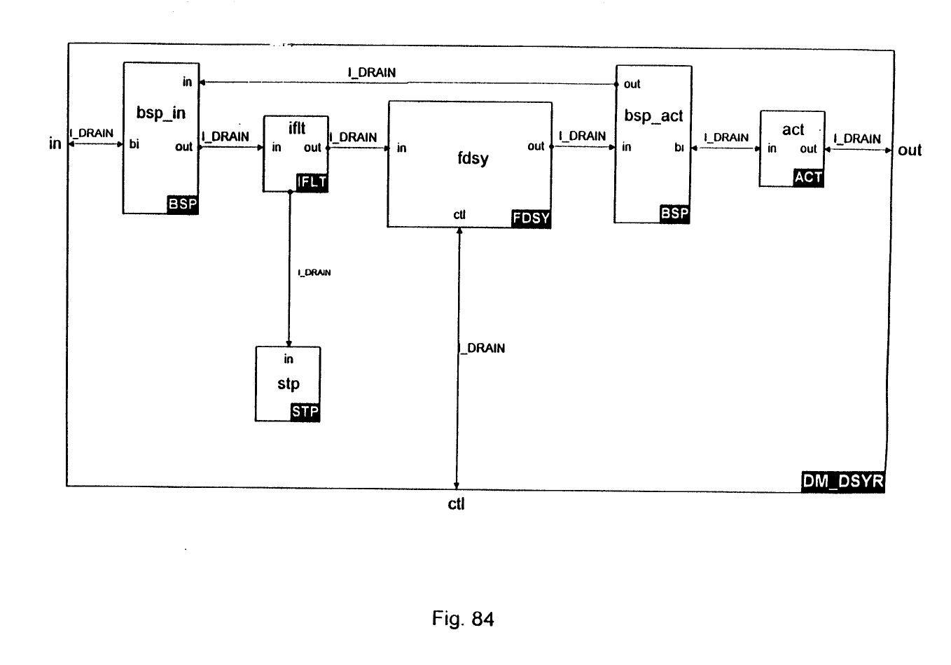

FIG. 84 illustrates the internal structure of the inventive DM_DYSR part.

16. Theory of Operation

DM_DSYR is an assembly built entirely of DriverMagic parts.

DM_DSYR is based mainly on DM_FDSY. Please see the DM_FDSY data sheet for more information.

Requests received on in pass through bsp_in and go to iflt. If the request does not have the CMEVT_A_ASYNC_CPLT attribute set, if It sends the request out through aux where its consumed by stp. stp returns CMST_REFUSE and the status is propagated back to the original caller.

Requests that can complete asynchronously are forwarded to fdsy where they are enqueued in the request queue. fdsy returns CMST_PENDING to indicate that the request will be processed asynchronously.

Requests received on in are continuously enqueued by fdsy until DM_DSYR receives an EV_IDLE or EV_PULSE event on its ctl terminal. These events are forwarded to fdsy. In response, fdsy dequeues one request and sends it out through the out terminal. The request is then passed to bsp-act and forwarded to act.

Requests received by act are forwarded through the out terminal. If the request is completed asynchronously, the completion event is simply forwarded through bsp_act, bsp_in and then through DM_DSYR's in terminal. If the request is completed synchronously, act creates a completion event, stores the completion status in the event, and sends it out through bsp_act. Thus, all requests send through DM_DSYR are gurenteed to be completed with a completion event sent through the back channel of DM_DSYR's in terminal.

17. Subordinate's Responsibilities

17.1. DM_BSP—Bi-Directional Splitter

Split event flow between a single bidirectional interface and an input/output interface pair.

17.2. DM_IFLT—Filter by Integer Value

If the operation filter integer value received on the in terminal is between min and max, pass operation through the aux terminal (auxiliary flow).

If the operation filter integer value received on the in terminal is not between min and max, pass operation through the out terminal (main flow).

17.3. DM_STP—Operation Stopper

1. Consume all operations received on its terminal.

17.4. DM_FDSY—Fundamental Desynchronizer

2. Desynchronize all incoming operations received through the in terminal and return the appropriate status.

17.5. DM_ACT—Asynchronous Completer

3. Transform synchronous completion of an outgoing event into asynchronous completion of the incoming event that generated the former.

18. Dominant's Responsibilities

18.1. Hard Parameterization of Subordinates

| Subordinate | Property | Value |
|---|---|---|
| iflt | offset | offsetof (CMEVENT_HDR, attr) |
| iflt | mask | CMEVT_A_ASYNC_CPLT |
| iflt | min | 0 |
| iflt | max | 0 |
| stp | ret_s | CMST_REFUSE |
| fdsy | ok_stat | CMST_PENDING |

18.2. Distribution of Properties to the Subordinates

| Property Name | Type | Dist | To |
|---|---|---|---|
| queue_sz | UINT32 | Redir | fdsy.queue_sz |
| disable_ctl_req | UINT32 | Redir | fdsy.disable_ctl_req |
| disable_diag | UINT32 | Redir | fdsy.disable_diag |
| cplt_s_offs | UINT32 | Redir | act.cplt_s_offs |

18.3. Use Cases

Desynchronizing Requests

1. A part sends a request to the in terminal of DM_DSYR.

2. Unless the disable_ctl_req property is TRUE, an EV_REQ_ENABLE event is sent through the ctl terminal.

3. The request is enqueued and the flow of control is returned to the caller. The return status is ok_stat.

4. Steps 1-3 may be repeated several times.

5. DM_DSYR receives an EV_IDLE or EV_PULSE event from its ctl terminal.

6. DM_DSYR dequeues one request and sends it out through the out terminal.

7. When the request has completed, the same request with the CMEVT_A_COMPLETED attribute set is sent out through the back channel of the in terminal.

8. Steps 5-7 are repeated many times.

9. If the disable_ctl_req property is FALSE an EV_REQ_DISABLE event is sent through the ctl terminal to stop the pulse generation (when the request queue becomes empty).

Notes

1. DM_DSYR assumes that requests sent through the in terminal are not allocated on the caller's stack and their memory block is valid at least until DM_DSYR sends the completion event.

DM_DWI—Desynchronizer with Idle Input

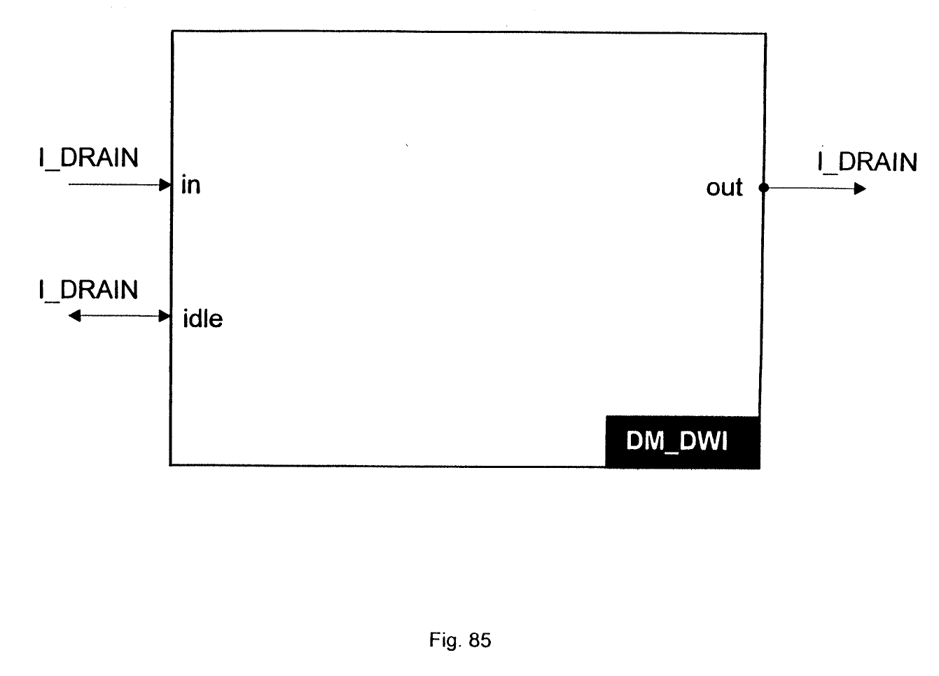

FIG. 85 illustrates the boundary of the inventive DM_DWI part.

DM_DWI de-couples the flow of control from the event flow, a mechanism known as desynchronization. DM_DWI desynchronizes all events received on its in terminal. The input event is desynchronized only if the input event's attributes specify that it may be distributed asynchronously and it is self-contained. DM_DWI enqueues the event; the queue keeps the events in the same order as they are received, As EV_IDLE events are received on its idle input, DM_DWI dequeues all the pending events and sends them through the out terminal (one event is dequeued for each EV_IDLE event received). The size of the queue used by DM_DWI is dynamic and may be limited by a property called queue_sz.

DM_DWI issues EV_REQ_ENABLE and EV_REQ_DISABLE requests through its idle terminal in order to control the idle generation. The issuing of these requests can be stopped through the property disable_idle_req.

19. Boundary

19.1. Terminals

Terminal “in” with direction “In” and contract I_DRAIN. Note: v-table, infinite cardinality, floating, synchronous. DM_DWI desynchronizes the events received on this terminal.

Terminal “out” with direction “Out” and contract I_DRAIN. Note: v-table, cardinality 1, synchronous. DM_DWI sends all de-synchronized queued events out through this terminal (when it receives EV_IDLE from idle). The outgoing events are in the same order as they were received from in.

Terminal “idle” with direction “Bi” and contract I_DRAIN. Note: v-table, cardinality 1, synchronous. EV_IDLE events are received through this terminal so DM_DWI can dequeue events and send them through the out terminal (one event is dequeued for each EV_IDLE event received). DM_DWI generates idle enable/disable requests through this terminal (unless the disable-idle-req property is TRUE).

19.2. Events and Notifications

| Incoming | | |
|---|---|---|
| Event | Bus | Notes |
| EV_XXX | CMEVENT_{—} | All incoming events received from in are |
| | HDR | desynchronized and sent out through out. |
| | /CMEvent | |

| Outgoing | | |
|---|---|---|
| Event | Bus | Notes |
| EV_XXX | CMEVENT_{—} | All incoming events received from in are |
| | HDR | desynchronized and sent out through out. |
| | /CMEvent | The outgoing events are in the same order as |
| | | they are received at in. |

19.3. Special Events, Frames, Commands or Verbs

| Special | | |
|---|---|---|
| Incoming Event | Bus | Notes |
| EV_RESET | CMEVENT_ | This event is received on the idle terminal. |
| | HDR/CME | In response, DM_DWI will flush its event queue. The |
| | vent | events will be consumed by DM_DWI. |
| EV_IDLE | CMEVENT_ | This event is received on the idle terminal. |
| | HDR/CME | In response, DM_DWI will dequeue an event and send it |
| | vent | through out. |
| | | If there are no elements on the queue, DM_DWI will return |
| | | CMST_NO_ACTION even if disable_idle_req property is set |
| | | to TRUE. |

| Special | | |
|---|---|---|
| Outgoing Event | Bus | Notes |
| EV_REQ_ENABLE | CMEVENT_{—} | DM_DWI will send this request out through idle when an |
| | HDR/CME | event is received on the in terminal and the queue was |
| | vent | empty. |
| | | DM_DWI will send this event only if disable_idle_req |
| | | property is FALSE. |
| EV_REQ_DISABLE | CMEVENT_{—} | DM_DWI will send this request out through idle if the |
| | HDR/CME | event queue is empty (after receiving EV_IDLE and |
| | vent | dequeueing the last event). |
| | | DM_DWI will send this event only if disable_idle_req |
| | | property is FALSE. |

19.4. Properties

Property “queue_sz” of type “UINT32”. Note: Default is 0. This is the number of events that the queue can hold. If 0, the queue will extend itself when it gets full (the number of events the queue can hold is limited only by available memory).

Property “disable_idle_req” of type “UINT32”. Note: Default is FALSE. If FALSE, DM_DWI will send requests to enable/disable the idle generation when needed.

20. Encapsulated Interactions

None.

21. Specification

22. Responsibilities

1. Desynchronize all incoming events received through the in terminal.

2. When an EV_IDLE event is received from the idle terminal, dequeue and send an event out through the out terminal.

3. Depending on the value of the disable_idle_req property, generate enable/disable requests through idle.

23. Theory of Operation

23.1. State Machine

None.

23.2. Main Data Structures

DM_DWI uses a queue to store all desynchronized events.

23.3. Mechanisms

Desynchronization of Incoming Events

DM_DWI starts by first examining the event attributes. If the event is not distributed asynchronously or is not self-contained, DM_DWI will not desynchronize the event and return CMST_REFUSE. If the event is not self-owned, DM_DWI will make a copy and mark it as self-owned.

DM_DWI will then enqueue the event and return to the caller. DM_DWI will then request the idle generation (if the disable_idle_req property is FALSE and the queue was empty). It does this by sending an EV_REQ_ENABLE event out through idle terminal.

For each EV_IDLE event received through its idle terminal, DM_DWI will dequeue one event from the queue and send it out through out. If the disable_idle_req property is FALSE and the queue is empty, DM_DWI will request to disable the idle generation by sending an EV_REQ_DISABLE event through idle.

23.4. Use Cases

Desynchronizing Events

10. The counter terminal of in sends an event to DM_DWI.

11. Unless the disable-idle-req property is TRUE, an EV_REQ_ENABLE event will be sent out through the idle terminal.

12. The event is enqueued and the flow of control is returned to the caller.

13. Steps 1 and 3 may be repeated several times.

14. DM_DWI receives an EV_IDLE event from its idle terminal.

15. DM_DWI dequeues one event and sends it out through the out terminal.

16. Steps 5 and 6 are repeated.

17. If the disable_idle_req property is FALSE an EV_REQ_DISABLE event will be sent out the idle terminal (when the event queue becomes empty).

DM_DW12—Desynchronizer with Idle Input

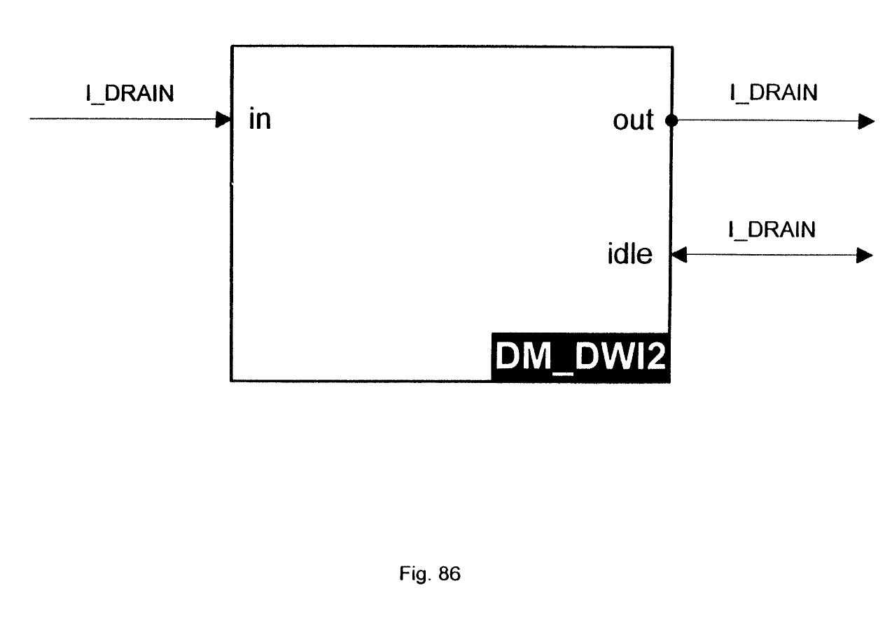

FIG. 86 illustrates the boundary of the inventive DM_DWI2 part.

DM_DWI2 de-couples the flow of control from the event flow, a mechanism known as desynchronization. DM_DWI2 desynchronizes all events received on its in terminal. The input event is desynchronized only if the input event's attributes specify that it may be distributed asynchronously and it is self-contained.

DM_DWI2 enqueues the event; the queue keeps the events in the same order as they are received. As EV_IDLE events are received on its idle input, DM_DWI2 dequeues all the pending events and sends them through the out terminal (one event is dequeued for each EV_IDLE event received). The size of the queue used by DM_DWI2 is dynamic and may be limited by a property called queue_sz.

DM_DWI2 issues EV_REQ_ENABLE and EV_REQ_DISABLE requests through its idle terminal in order to control the idle generation.

The difference between DM_DWI2 and DM_DWI is that when DM_DWI2 is disabled (i.e. it hasn't issued an EV_REQ_ENABLE event out idle) it returns CMST_NO_ACTION for all events it receives on its idle terminal and does not emit EV_REQ_DISABLE event out idle terminal.

24. Boundary

24.1. Terminals

Terminal “in” with direction “In” and contract I_DRAIN. Note: v-table, infinite cardinality, floating, synchronous. DM_DWI2 desynchronizes the events received on this terminal.

Terminal “out” with direction “Out” and contract I_DRAIN. Note: v-table, cardinality 1, synchronous. DM_DWI sends all de-synchronized queued events out through this terminal (when it receives EV_IDLE from idle. The outgoing events are in the same order as they were received from in.

Terminal “idle” with direction “Bi” and contract I_DRAIN. Note: v-table, cardinality 1, synchronous. EV_IDLE events are received through this terminal so DM_DWI can dequeue events and send them through the out terminal (one event is dequeued for each EV_IDLE event received). DM_DWI generates idle enable/disable requests through this terminal

24.2. Events and Notifications

| Incoming | | |
|---|---|---|
| Event | Bus | Notes |
| EV_XXX | CMEVENT_{—} | All incoming events received from in are |
| | HDR | desynchronized and sent out through RXW. |

| Outgoing | | |
|---|---|---|
| Event | BUS | Notes |
| EV_XXX | CMEVENT_{—} | All incoming events received from in are |
| | HDR | desynchronized and sent out through out. |
| | | The outgoing events are in the same order as |
| | | they are received at in. |

24.3. Special Events, Frames, Commands or Verbs

| Special Incoming | | |
|---|---|---|
| Event | Bus | Notes |
| EV_RESET | CMEVENT_{—} | This event is received on the idle terminal. |
| | HDR | In response, DM_DWI2 will flush its event queue. The |
| | | events will be consumed by DM_DWI2. |
| EV_IDLE | CMEVENT_{—} | This event is received on the idle terminal. |
| | HDR | In response, DM_DWI2 will dequeue an event and send |
| | | it through out. |
| | | If there are no elements on the queue, DM_DWI2 will |
| | | return CMST_NO_ACTION |

| Special Outgoing | | |
|---|---|---|
| Event | Bus | Notes |
| EV_REQ_ENABLE | CMEVENT_{—} | DM_DWI2 will send this request out through idle when |
| | HDR | an event is received on the in terminal and the queue |
| | | was empty. |
| EV_REQ_DISABLE | CMEVENT_{—} | DM_DWI2 will send this request out through idle if the |
| | HDR | event queue is empty (after receiving EV_IDLE and |
| | | dequeueing the last event). |

24.4. Properties

Property “queue₁₃ sz” of type “UINT32”. Note: Default is 0. This is the number of events that the queue can hold. If 0, the queue will extend itself when it gets full (the number of events the queue can hold is limited only by available memory).

25. Internal Definition

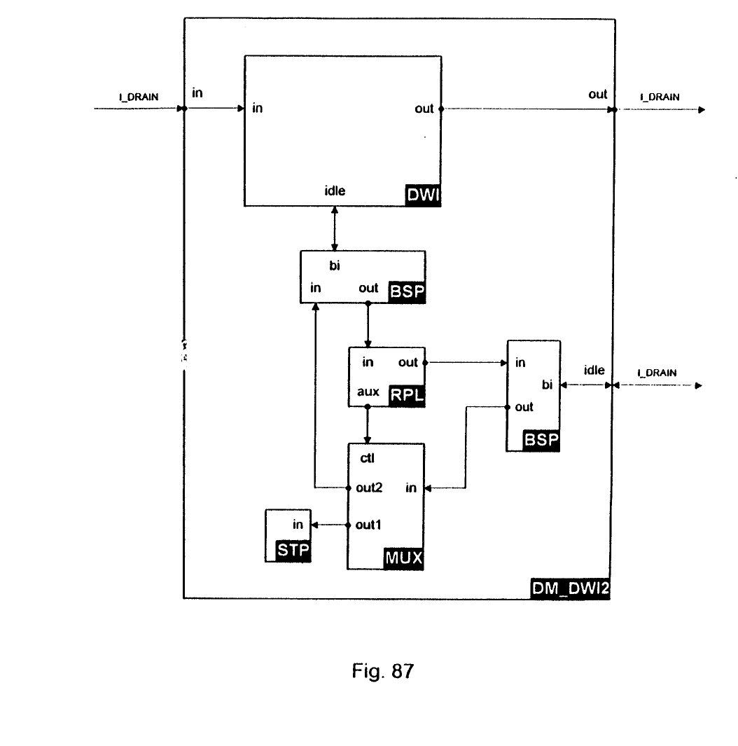

FIG. 87 illustrates the internal structure of the inventive DM_DW12 part.

DM_DW12 is a pure assembly and has no functionality of its own. Refer to the DM_DWI Data Sheet for a detailed functional overview of the desynchronizer with idle input.

26. Subordinate's Responsibilities

26.1. DWI—Desynchronizer with Idle Input

1. Implement an event queue that can be pumped with EV_IDLE events.

2. Clear the event queue on receipt of an EV_RESET event

26.2. BSP—Bi-Directional Splitter

1. Provide plumbing to enable connection of a bi-directional terminal to an unidirectional input or output.

26.3. STP—Event Stopper

1. Terminate the event flow by returning a specified status (e.g., CMST_OK).

26.4. MUX—Event-Controlled Multiplexer

1. Implements a switch between its out1 and out2 outputs that is controlled by event input on its ctl terminal.

26.5. RPL—Event Replicator

1. Duplicates events coming on in, send the duplicates to aux, and send the original event to out.

27. Distribution of Properties

| Property | Distr. | Subordinate |
|---|---|---|
| queue_sz | Redirecte | dwi.queue_sz |

d

28. Subordinate Parameterization

| Part | Property | Value |
|---|---|---|
| dwi | disable_idle_req | FALSE |
| rpl | aux_first | TRUE |
| mux | ev_out1 | EV_REQ_DISABLE |
| | ev_out2 | EV_REQ_ENABLE |
| spl | ret_s | CMST_NO_ACTION |

DM_DWT, DM_DOT—Desynchronizers With Thread

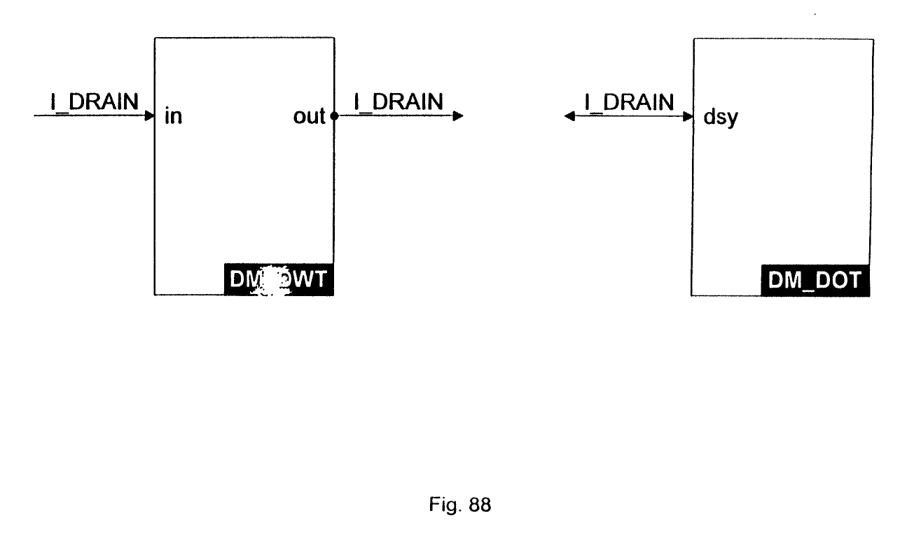

FIG. 88 illustrates the boundary of the inventive DM_DWT_AND DM_DOT part.

DM_DWT desynchronizes and forwards events received on its in input. The input event is desynchronized only if the input event's attributes specify that it may be distributed asynchronously, otherwise DM_DWT returns an error. Each instance of DM_DWT uses its own thread to de-queue the events queued through in and send them to out.

Before an input event is queued, DM_DWT checks the self-owned attribute of the event (CMEVT_A_SELF_OWNED). If it is set, the event is queued as-is, otherwise a copy of the event is queued. In any case the output is called with the self-owned attribute cleared¹. DM_DWT frees the event memory after the call to out returns. ¹ This may change in a future release.

DM_DOT has the same functionality, but it provides a single bi-directional terminal to receive the input events and send the de-synchronized events. It can be used in cases when a part needs to postpone the processing of an event and/or request to be called back in a different thread of execution in order to perform operations that it cannot do in its current execution context.

Note The desynchronized event may be distributed in a thread different than the one that posted it. This may impose additional limitations if thread-local storage is used.

29. Boundary

29.1. Terminals (DM_DWT)

Terminal “in” with direction “In” and contract I_DRAIN. Note: v-table, infinite cardinality, synchronous This terminal receives all the incoming events for DM_DWT. Events that require synchronous distribution are rejected with CMST_REFUSE status. Such events are those that have only the CMEVT_A_SYNC attribute set. In general, all the events to be desynchronized by DM_DWT should have both the CMEVT_A_SYNC and the CMEVT_A_ASYNC attribute set.

Terminal “out” with direction “Out” and contract I_DRAIN. Note: v-table, cardinality 1, synchronous DM_DSY sends all de-synchronized events out through this terminal. This output is called in a dedicated worker thread created by DM_DWT (a separate thread is created by each instance of DM_DWT).

29.2. Terminals (DM_DOT)

Terminal “dsy” with direction “I/O” and contract I_DRAIN. Note: v-table, cardinality 1, synchronous This terminal receives all the incoming events for DM_DOT. Events that require synchronous distribution are rejected with CMST_REFUSE status. Such events are those that have only the CMEVT_A_SYNC attribute set. In general, all the events to be desynchronized by DM_DWT should have both the CMEVT_A_SYNC and the CMEVT_A_ASYNC attribute set. The de-synchronized events are sent out through the same terminal. The output is called in a dedicated worker thread created by DM_DOT (a separate thread is created by each instance of DM_DOT).

29.3. Events and Notifications

| Incoming | | |
|---|---|---|
| Event | Bus | Notes |
| EV_XXX | CMEVENT_HDR | DM_DWT: All incoming events on in |
| | | are de-synchronized and sent out |
| | | through out. |
| | /CMEvent | DM_DOT: All incoming events on dsy |
| | | are de-synchronized and sent back |
| | | through dsy. |

29.4.

| Outgoing | | |
|---|---|---|
| Event | Bus | Notes |
| EV_XXX | CMEVENT_HDR | All incoming events on in(dsy) are de- |
| | | synchronized and sent out |
| | | through out(dsy). |
| | /CMEvent | |

29.5. Special Events, Frames, Commands or Verbs

None.

29.6. Properties

Property “queue_sz” of type “UINT32”. Note: This is the number of events that the event queue can hold. If 0, the queue will extend itself when it gets full (the number of events the queue can hold is limited only by available memory). This property is redirected to the EST subordinate. Default is 0.

Property “thread priority” of type “UINT32”. Note: Specifies the priority of the worker thread. The values for this property depend on the environment. It is used directly to call the environment specific function that sets the thread priority (SetThreadPriority in Win32, KeSetPriorityThread in WDM, etc.). This property is redirected to the EST subordinate.

30. Encapsulated Interactions

The DM_EST part used in the DM_DWT and DM_DOT assemblies uses the following operating system services:

Thread functions

Synchronization functions

Note that these functions are different in each operating environment. For details, please refer to the DM_EST data sheet.

31. Specification

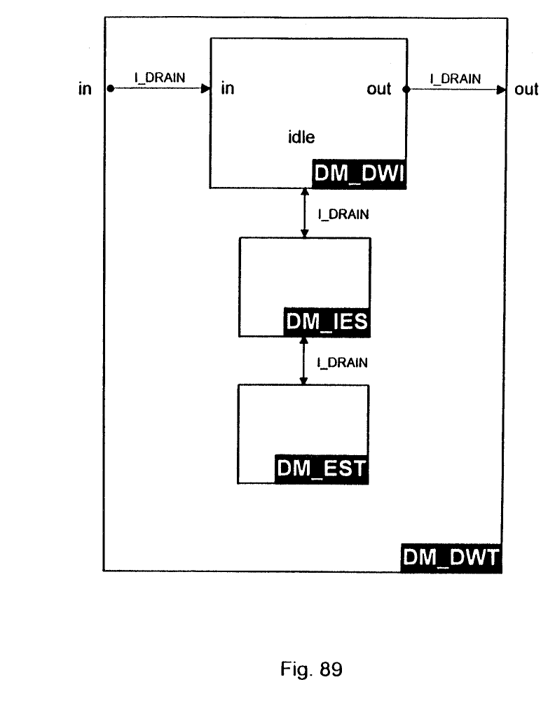

FIG. 89 illustrates the internal structure of the inventive DM_DWT part.

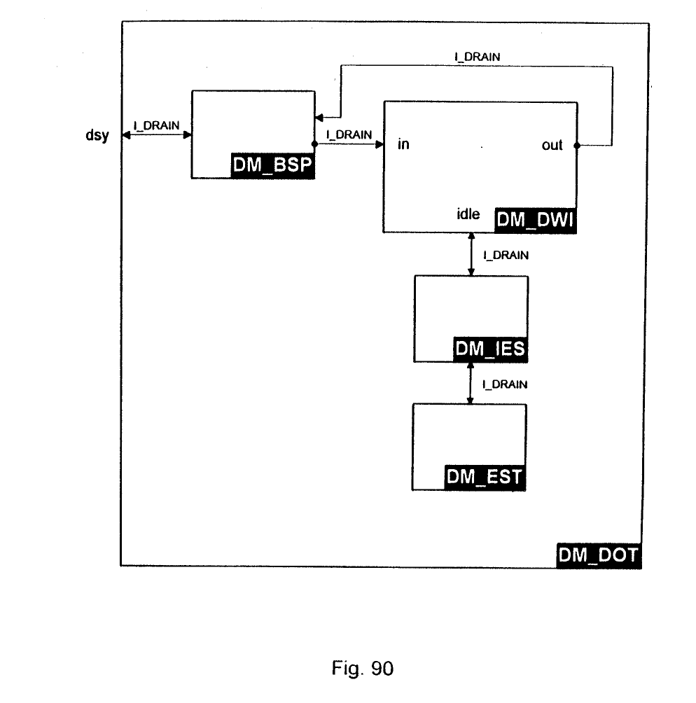

FIG. 90 illustrates the internal structure of the inventive DM_DOT part.

32. Responsibilities

1. Desynchronize all incoming events received from in/dsy and send them out through out/dsy.

2. Use a dedicated worker thread to call the out/dsy terminal.

33. Theory of Operation

DM_DWT and DM_DOT are assemblies built entirely of DriverMagic parts.

For simplicity, the description below refers to DM_DWT only. The same description is valid for DM_DOT, except that DM_DWT has separate input and output while DM_DOT has a single bidirectional terminal for both input and output (see the diagrams above).

An event that enters DM_DWT is enqueued by DM_DWI and control returns to the caller immediately with CMST_OK (if DM_DWI fails to enqueue the event—i.e., the queue is full or the event does not qualify as de-synchronizable, an error status is returned).

If this is the first event enqueued, DM_DWI sends an enable request to its idle terminal. This request is translated by DM_IES to an “arm” operation sent to DM_EST, which in turn unblocks the worker thread created by DM_EST. When the worker thread receives control, DM_EST calls “fire” on its output continuously, until disabled. The “fire” operations are translated by DM_IES into EV_IDLE events used by DM_DWI to de-queue events from its queue and send them to out.

When the queue becomes empty, DM_DWI sends a disable request (translated to “disarm” on DM_EST), which causes the worker thread to be blocked until a new event is enqueued.

34. Subordinate Parameterization

| Subordinate | Property | Value |
|---|---|---|
| DM_EST | force_defaults | TRUE |
| | auto_arm | FALSE |
| | continuous | TRUE |

34.1. Use Cases

De-Synchronizing Events With DM_DWT

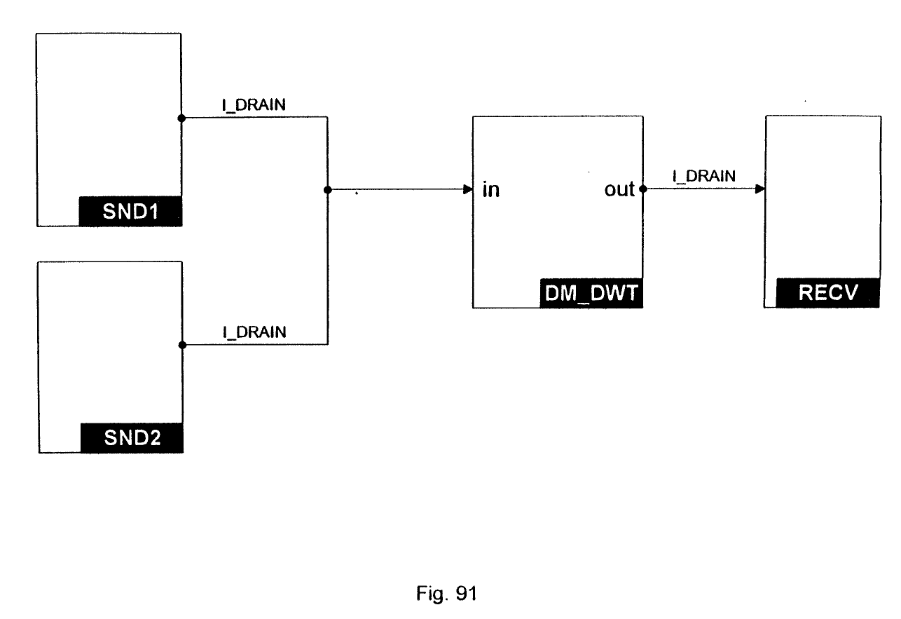

FIG. 91 illustrates an advantageous use of the inventive DM_DWT part.

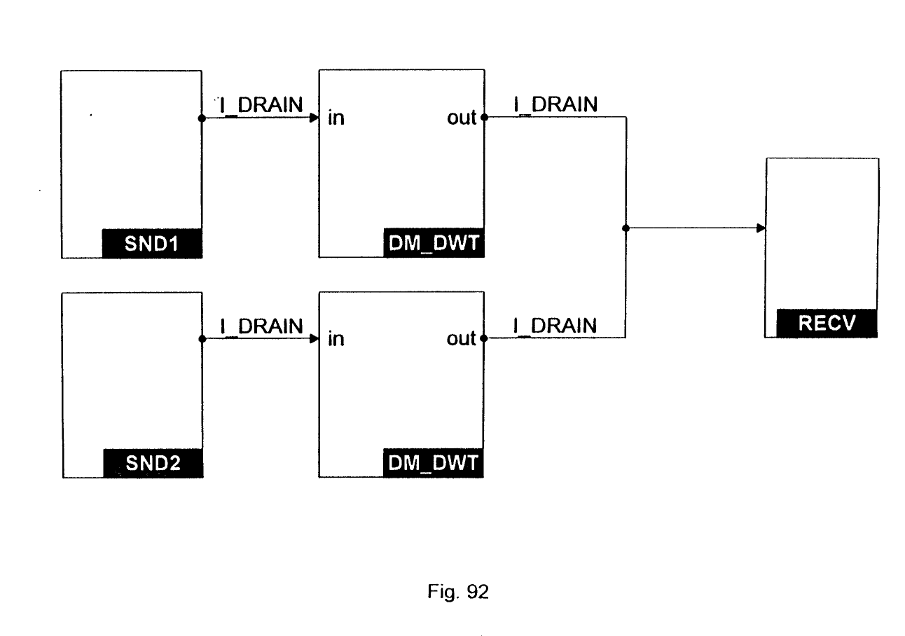

FIG. 92 illustrates an advantageous use of the inventive DM_DWT part.

If one or more event sources are connected to a single event recipient and all the event sources produce only de-synchronizable² events, DM_DWT may be placed in front of the recipient if a direct connection is undesirable for any of the following reasons (or other similar considerations):

The event source(s) do not execute in a normal thread context, while the recipient requires normal thread context to run.

The event source(s) may not be blocked for any reason, while the recipient calls (or is expected to call) system functions that can block the thread and/or its outputs when it receives an event.

If there is a direct or indirect loopback path from the event recipient to the event source—to avoid re-entering the source and causing an infinite loop or recursion that may oveflow the call stack. ² An event is de-synchronizable if it satisfies all of the following requirements:

a) the event data buffer is not in any way bound to the execution context of the caller (e.g., is not allocated on the caller's stack and does not use or refer to thread-specific data) or it may be safely copied (i.e., has no references to volatile data, like automatic or heap-allocated buffers that can become unavailable when the event is de-queued);

b) the event source does not need to receive a return status or data placed in the event data buffer from the processing of the event;

c) the event source can continue execution whether or not the event was actually delivered.

Note that since an instance of DM_DWT uses a single thread, the de-synchronized events are also serialized, i.e., the part connected to DM_DWT's output will receive them in sequence and will never be re-entered from this connection with a new event until it has returned from the previous one. If serialization of events from multiple sources is undesirable, a separate instance of DM_DWT may be used to de-synchronize events from each of the sources.

Serializing and/or Postponing Processing of events generated inside a part with DM_DOT

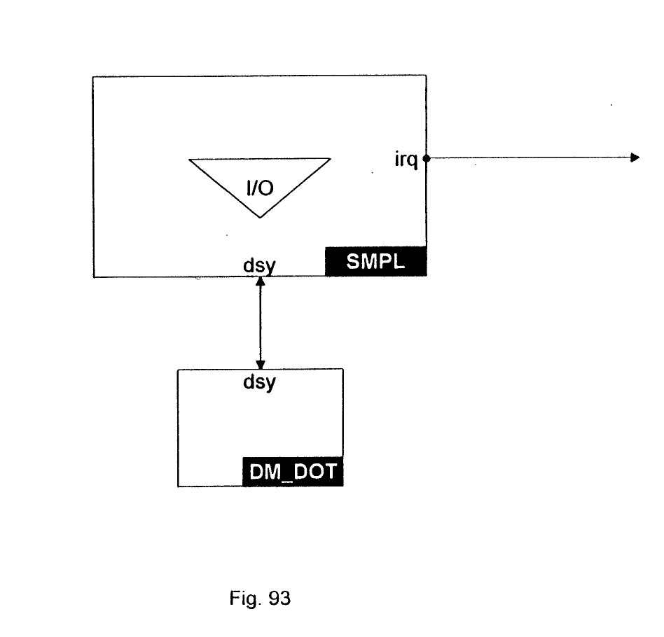

FIG. 93 illustrates an advantageous use of the inventive DM_DOT part.

Some parts interact with sources of asynchronous events (“Asynchronous event” here does not necessarily refer to a ClassMagic event, but to any type of entry into the part that is asynchronous, e.g., a callback from the operating system or an embedded interaction), which may come in an execution context that is restricted in some way, e.g.:

the part's guard cannot be acquired;

access to some system services is restricted;

the event requires lengthy processing and the current thread of execution may not be blocked or delayed.

the execution context may not be suitable for calling the part's outputs, because parts connected to these outputs cannot enter their guard and/or cannot call system APIs at that time.

In such cases the part needs to defer part or all processing of asynchronous events and request to be re-entered in a normal thread context. To do this it should have a bidirectional I_DRAIN terminal (dsy—see diagram) connected to an instance of DM_DOT. When it needs to postpone an event, it fills in a ClassMagic event structure with all the information required to process the event later and sends it through dsy. DM_DOT will later call it back through the same terminal with the posted event structure—in the context of its working thread.

DM_DWP, DM_DOP—Desynchronzers With DriverMagic Pump

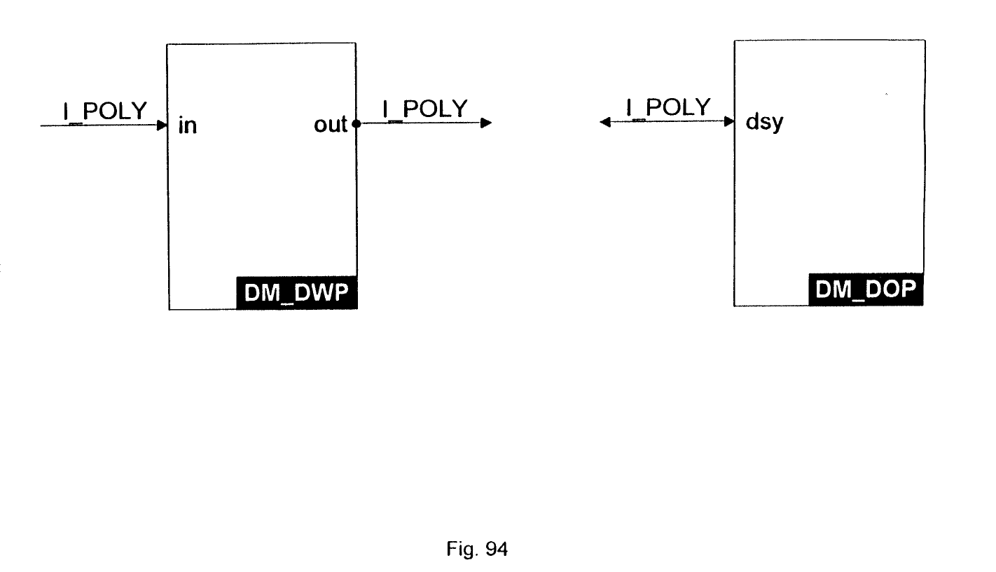

FIG. 94 illustrates the boundary of the inventive DM_DWP and DM_DOP parts.

DM_DWP desynchronizes and forwards operation requests received on its in input. DM_DWP uses the DriverMagic pump to desynchronize the operations received through in and send them to out. The operation requests are dispatched in the execution context of the DriverMagic pump thread.

DM_DOP has the same functionality, but it provides a single bidirectional terminal to receive the input requests and send the de-synchronized requests. It can be used in cases when a part needs to postpone the processing of an event and/or request to be called back in a different thread of execution in order to perform operations that it cannot do in its current execution context.

Note The desynchronized operation request may be distributed in a thread different than the one that posted it. This may impose additional limitations if thread-local storage is used.

35. Boundary

35.1. Terminals (DM_DWP)

Terminal “in” with direction “In” and contract I_POLY. Note: v-table, infinite cardinality, synchronous This terminal receives all the incoming operation requests for DM_DWP.

Terminal “out” with direction “Out” and contract I_POLY. Note: v-table, cardinality 1, synchronous DM_DWP sends all de-synchronized operation requests out through this terminal. This output is called in the thread context of the DriverMagic pump.

35.2. Terminals (DM_DOP)

Terminal “dsy” with direction “Plug” and contract I_POLY. Note: v-table, cardinality 1, synchronous This terminal receives all the incoming operation requests for DM_DOP. This output is called in the thread context of the DriverMagic pump.

35.3. Events and Notifications

None.

35.4. Special Events, Frames, Commands or Verbs

None.

35.5. Properties

Property “queue_sz” of type “UINT32”. Note: This is the number of operation requests that the operation queue can hold. If 0, the queue will extend itself when it gets full (the number of operations the queue can hold is limited only by available memory). Default is 0.

Property “ok_stat” of type “UINT32”. Note: This specifies the status that DM_DWP/DM_DOP returns on calls through in if the operation request was successfully enqueued. This status is also used to determine if operation requests passed through out succeeded. Default is CMST_OK.

Property “disable_diag” of type “UINT32”. Note: Boolean. This determines whether DM_DWP/DM_DOP prints debug output indicating that a call through out failed. A call through out fails if the return status is not equal to ok_stat. This property affects only the checked build of DM_DWP/DM_DOP. Default is FALSE.

36. Encapsulated Interactions

DM_DWP and DM_DOP use the DriverMagic pump in order to desynchronize the operation requests.

37. Specification

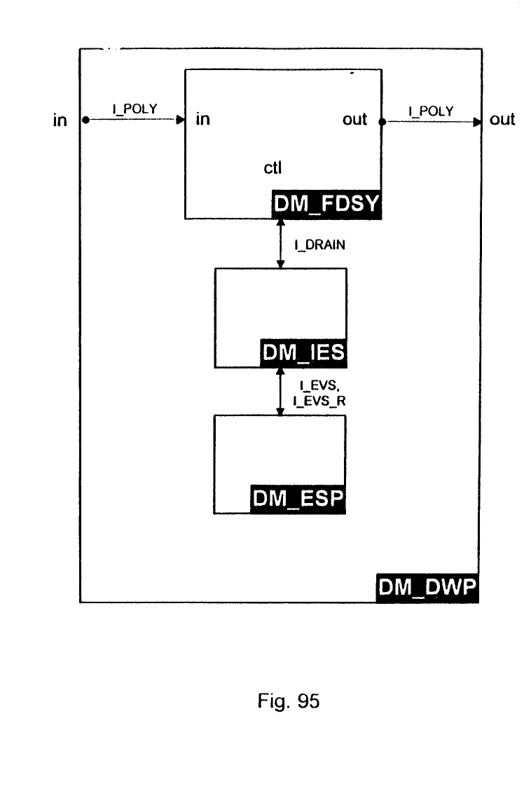

FIG. 95 illustrates the internal structure of the inventive DM_DWP part.

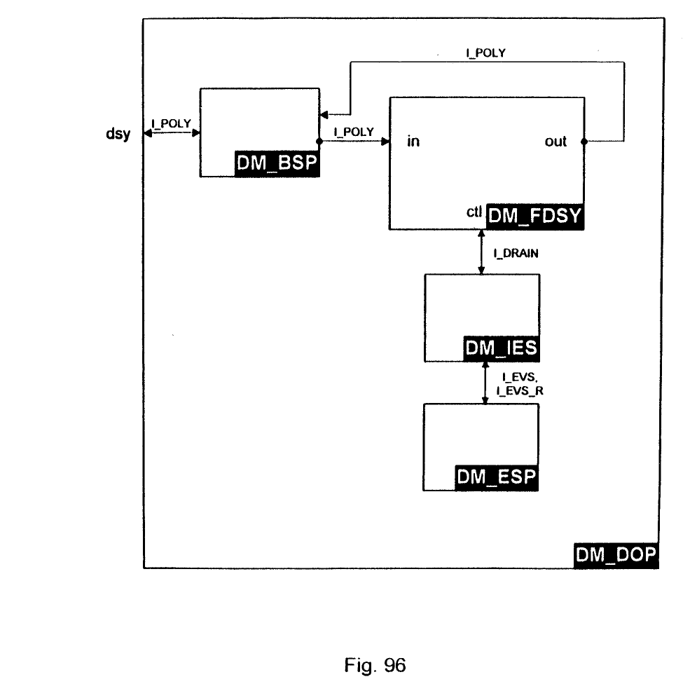

FIG. 96 illustrates the internal structure of the inventive DM_DOP part.

38. Responsibilities

1. Desynchronize all incoming operation requests received from in/dsy and send them out through out/dsy.

39. Theory of Operation

DM_DWP and DM_DOP are assemblies built entirely of DriverMagic parts.

For simplicity, the description below refers to DM_DWP only. The same description is valid for DM_DOP, except that DM_DWP has separate input and output while DM_DOP has a single bi-directional terminal for both input and output (see the diagrams above).

An operation request that enters DM_DWP is enqueued by DM FDSY and control returns to the caller immediately with CMST_OK (if DM FDSY fails to enqueue the request—i.e., the queue is full; an error status is returned).

If this is the first request enqueued, DM FDSY sends an enable request to its ctl terminal. This request is translated by DM_IES to an “arm” operation sent to DM_ESP, which in turn posts a message to itself. When the message is dispatched by the DriverMagic pump, DM_ESP calls “fire” on its output continuously, until disabled. The “fire” operations are translated by DM_IES into EV_IDLE events used by DM_FDSY to de-queue requests from its queue and send them to out.

When the queue becomes empty, DM_FDSY sends a disable request (translated to “disarm” on DM_ESP), which causes DM_ESP to no longer post messages to itself until a new operation request is enqueued.

40. Distribution of Properties

| Property | Distr. | Subordinate |
|---|---|---|
| queue_sz | Redirected | fdsy.queue_sz |
| ok_stat | Redirected | fdsy.ok_stat |
| disable_diag | Redirected | fdsy.disable_diag |

41. Subordinate Parameterization

| Subordinate | Property | Value |
|---|---|---|
| DM_ESP | force_defaults | TRUE |
| | auto_arm | FALSE |
| | continuous | TRUE |
| DM_FDSY | disable_ctl_req | FALSE |

DM_DWW, DM_DOW—Desynchronizers With Window

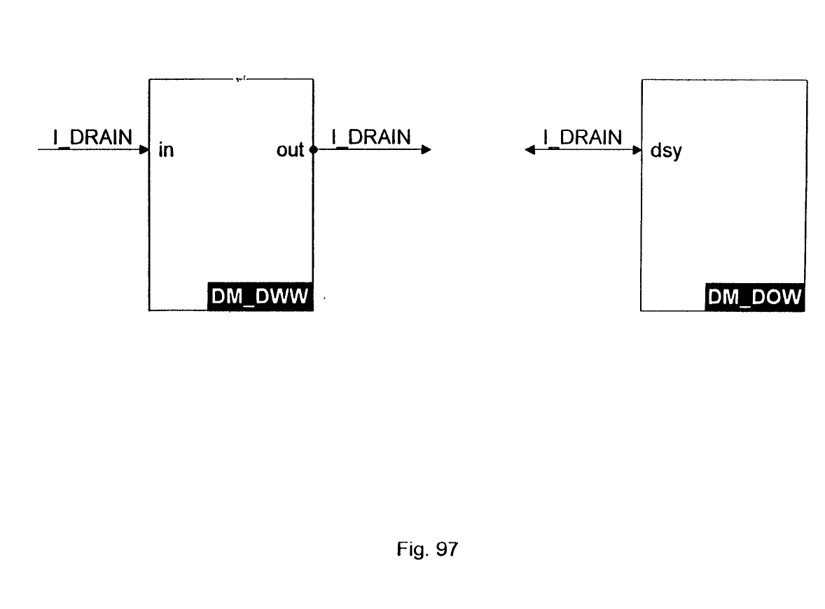

FIG. 97 illustrates the boundary of the inventive DM_DWW and DM_DOW parts.

DM_DWW desynchronizes and forwards events received on its in input. The input event is desynchronized only if the input event's attributes specify that it may be distributed asynchronously, otherwise DM_DWW returns an error. Each instance of DM_DWW uses its own window to de-queue the events queued through in and send them to out. The events are dispatched in the same thread in which DM_DWW was created.

Before an input event is queued, DM_DWW checks the self-owned attribute of the event (CMEVT_A_SELF_OWNED). If it is set, the event is queued as-is, otherwise a copy of the event is queued. In any case the output is called with the self-owned attribute cleared¹. DM_DWW frees the event memory after the call to out returns. ¹ This may change in a future release.

DM_DOW has the same functionality, but it provides a single bidirectional terminal to receive the input events and send the de-synchronized events. It can be used in cases when a part needs to postpone the processing of an event and/or request to be called back in a different thread of execution in order to perform operations that it cannot do in its current execution context.

DM_DWW and DM_DOW are only available in the Win32 environment.

Note The desynchronized event may be distributed in a thread different than the one that posted it. This may impose additional limitations if thread-local storage is used.

42. Boundary

42.1. Terminals (DM_DWW)

Terminal “in” with direction “In” and contract I_DRAIN. Note: v-table, infinite cardinality, synchronous This terminal receives all the incoming events for DM_DWW. Events that require synchronous distribution are rejected with CMST_REFUSE status. Such events are those that have only the CMEVT_A_SYNC attribute set. In general, all the events to be desynchronized by DM_DWW should have both the CMEVT_A_SYNC and the CMEVT_A_ASYNC attribute set.

Terminal “out” with direction “Out” and contract I_DRAIN. Note: v-table, cardinality 1, synchronous DM_DWW sends all de-synchronized events out through this terminal. This output is called in the same thread context of its window, which is the same thread in which DM_DWW was created in. (a separate window is created by each instance of DM_DWW).

42.2. Terminals (DM_DOW)

Terminal “dsy” with direction “I/O” and contract I_DRAIN. Note: v-table, cardinality 1, synchronous This terminal receives all the incoming events for DM_DOW. Events that require synchronous distribution are rejected with CMST_REFUSE status. Such events are those that have only the CMEVT_A_SYNC attribute set. In general, all the events to be desynchronized by DM_DWW should have both the CMEVT_A_SYNC and the CMEVT_A_ASYNC attribute set. The de-synchronized events are sent out through the same terminal. The output is called in the same thread context of its window, which is the same thread in which DM_DWW was created in. (a separate widnow is created by each instance of DM_DOW).

42.3. Events and Notifications

| Incoming | | |
|---|---|---|
| Event | Bus | Notes |
| EV_XXX | CMEVENT_HDR | DM_DWW: All incoming events on in |
| | | are de-synchronized and sent out |
| | | through out. |
| | /CMEvent | DM_DOW: All incoming events on |
| | | dsy are de-synchronized and sent |
| | | back through dsy. |

42.4.

| Outgoing | | |
|---|---|---|
| Event | Bus | Notes |
| EV_XXX | CMEVENT_HDR | All incoming events on in(dsy) are de- |
| | | synchronized and sent out |
| | | through out(dsy). |
| | /CMEvent | |

42.5. Special events, frames, commands or verbs

None.

42.6. Properties

Property “thread_priority” of type “INT32”. Note: Specifies the priority of the worker thread. The values for this property depend on the environment. It is used directly to call the environment specific function that sets the thread priority (SetThreadPriority in Win32, KeSetPriorityThread in WDM, etc.).

43. Encapsulated Interactions

The DM_ESW part used in the DM_DWW and DM_DOW assemblies uses the following Win32 APIs to control its event window and timers:

RegisterClass( )

DeregisterClass( )

CreateWindow( )

DestroyWindow( )

SetTimer( )

KillTimer( )

PostMessage( )

44. Specification

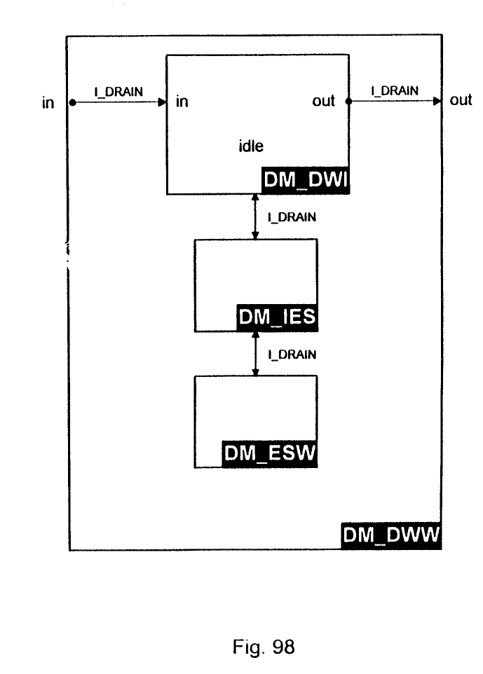

FIG. 98 illustrates the internal structure of the inventive DM_DWW part.

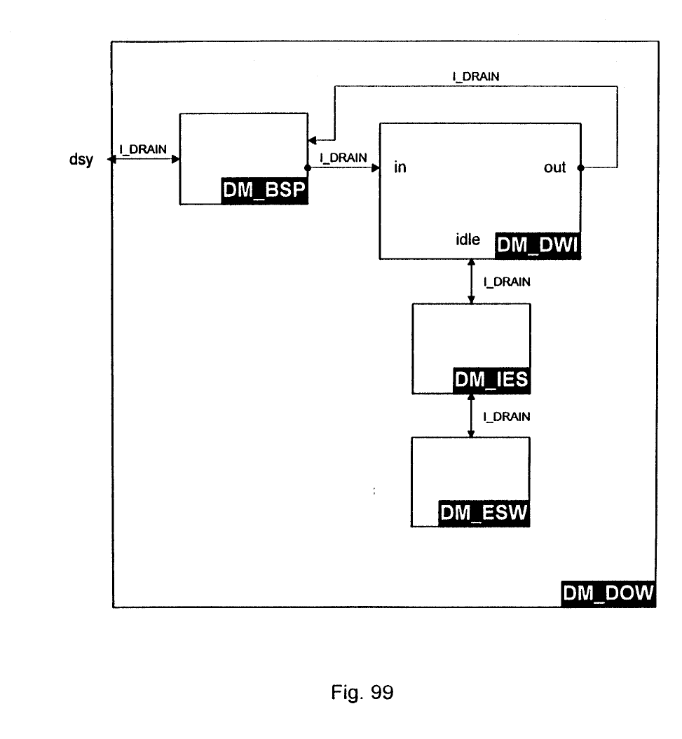

FIG. 99 illustrates the internal structure of the inventive DM_DOW part.

45. Responsibilities

1. Desynchronize all incoming events received from in/dsy and send them out through out/dsy in the same thread context in which it was created.

46. Theory of Operation

DM_DWW and DM_DOW are assemblies built entirely of DriverMagic parts.

For simplicity, the description below refers to DM_DWW only. The same description is valid for DM_DOW, except that DM_DWW has separate input and output while DM_DOW has a single bidirectional terminal for both input and output (see the diagrams above).

An event that enters DM_DWW is enqueued by DM_DWI and control returns to the caller immediately with CMST_OK (if DM_DWI fails to enqueue the event—i.e., the queue is full or the event does not qualify as de-synchronizable, an error status is returned).

If this is the first event enqueued, DM_DWI sends an enable request to its idle terminal. This request is translated by DM_IES to an “arm” operation sent to DM_ESW, which in turn posts a message to its window. When the window receives the message, DM_ESW calls “fire” on its output continuously, until disabled. The “fire” operations are translated by DM_IES into EV_IDLE events used by DM_DWI to de-queue events from its queue and send them to out.

When the queue becomes empty, DM_DWI sends a disable request (translated to “disarm” on DM_ESW), which causes DM_ESW to no longer post messages to its window until a new event is enqueued.

47. Subordinate Parameterization

| Subordinate | Property | Value |
|---|---|---|
| DM_ESW | force_defaults | TRUE |
| | auto_arm | FALSE |
| | continuous | TRUE |

Notes

Some parts interact with sources of asynchronous events (embedded interactions), which may come in an execution context that is restricted in some way, e.g.:

the part's guard cannot be acquired;

access to some system services is restricted;

the event requires lengthy processing and the current thread of execution may not be blocked or delayed.

the execution context may not be suitable for calling the part's outputs, because parts connected to these outputs cannot enter their guard and/or cannot call system APIs at that time.

All outgoing-events must be sent in the same thread that the DM_DOW was created.

In such cases the part needs to defer part or all processing of asynchronous events and request to be re-entered in a normal thread context. To do this it should have a bidirectional I_DRAIN terminal (dsy—see diagram) connected to an instance of DM_DOW. When it needs to postpone an event, it fills in a ClassMagic event structure with all the information required to process the event later and sends it through dsy. DM_DOW will later call it back through the same terminal with the posted event structure—in the thread context in which it was created.

1. In order for DM_DOW and DM_DWW to work correctly, the application that contains the parts must provide a message dispatch loop as defined by Windows. This allows the messages for an application to be dispatched to the aprpropriate window. Please see the Win32 documentation for more information.

2. As Win32 requires that windows be destroyed in the same thread in which they are created, DM_DOW and DM_DWW also must be destroyed in the same thread in which they were created. Failure to do so will typically fail to destroy the window.

DM_RDWT—Request Desynchronizer With Thread

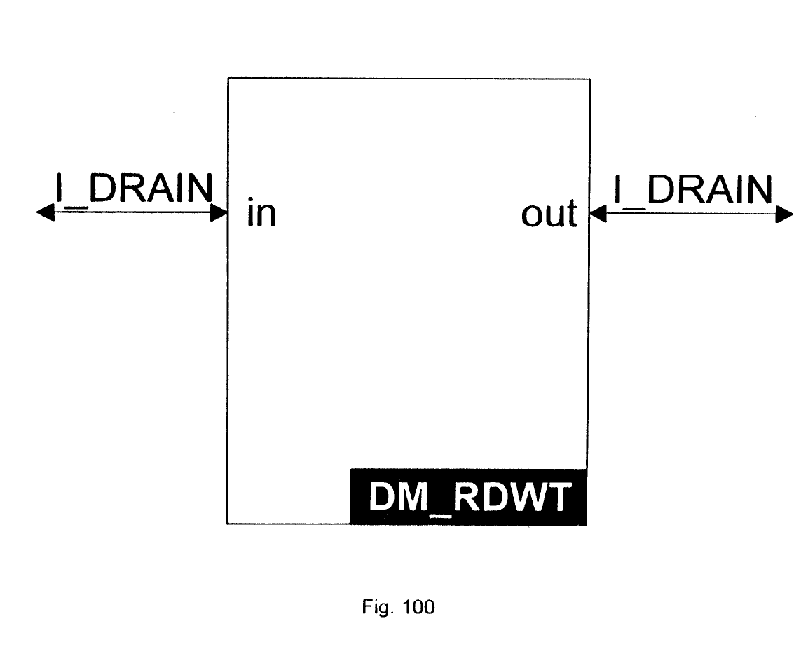

FIG. 100 illustrates the boundary of the inventive DM_RDWT part.

DM_RDWT desynchronizes and forwards requests received on its in input. The input request is assumed not to be allocated on the caller's stack. Each instance of DM_RDWT uses its own thread to de-queue the requests queued through in and sends them to out. The desynchronized requests sent through out are in the context of DM_RDWT's worker thread.

If the incoming request does not have the CMEVT_A_ASYNC_CPLT attribute set DM_RDWT fails with CMST_REFUSE. For each request, there is garenteed to be a completion event sent back through in.

All events received on out are forwarded through in without modification (synchronously).

48. Boundary

48.1. Terminals

Terminal “in” with direction “Plug” and contract I_DRAIN. Note: v-table, cardinality 1, synchronous This terminal receives all the incoming requests for DM_RDWT. Completion events for asynchronously completed requests are received from out and are forwarded out through in.

Terminal “out” with direction “Plug” and contract I_DRAIN. Note: v-table, cardinality 1, synchronous DM_DSY sends all de-synchronized requests out through this terminal. This output is called in a dedicated worker thread created by DM_RDWT (a separate thread is created by each instance of DM_RDWT). Completion events for asynchronously completed requests are received by this terminal and are forwarded out through in.

48.2. Events and Notifications

| Incoming | | |
|---|---|---|
| Event | Bus | Notes |
| EV_XXX | CMEVENT_HDR | All incoming requests on in are de- |
| | | synchronized and sent out through out. |
| | /CMEvent | |

48.3.

| Outgoing | | |
|---|---|---|
| Event | Bus | Notes |
| EV_XXX | CMEVENT | All incoming events on in are |
| | _HDR | de-synchronized and sent |
| | /CMEvent | out through out. |

48.4. Special Events, Frames, Commands or Verbs

None. 48.5. Properties

Property “thread_priority” of type “UINT32”. Note: Specifies the priority of the worker thread. The values for this property depend on the environment. It is used directly to call the environment specific function that sets the thread priority (SetThreadPriority in Win32, KeSetPriorityThread in WDM, etc.). This property is redirected to the EST subordinate.

Property “queue_sz” of type “UINT32”. Note: This is the number of requests that the request queue can hold. If 0, the queue will extend itself when it gets full (the number of events the queue can hold is limited only by available memory). This property is redirected to the DSYR subordinate. Default is 0.

Property “disable_diag” of type “UINT32”. Note: Boolean. This determines whether DM_RDWT prints debug output indicating that a call through out failed. A call through out fails if the return status is not equal to ok_stat. This property affects only the checked build of DM_RDWT. This property is redirected to the DSYR subordinate. Default is FALSE.

Property “cplt_s_offs” of type “UINT32”. Note: Offset in bytes of the completion status in the request bus. This property is redirected to the DSYR subordinate. Mandatory.

49. Encapsulated Interactions

The DM_EST part used in the DM_RDWT assembly uses the following operating system services:

Thread functions

Synchronization functions

Note that these functions are different in each operating environment. For details, please refer to the DM_EST data sheet.

50. Specification

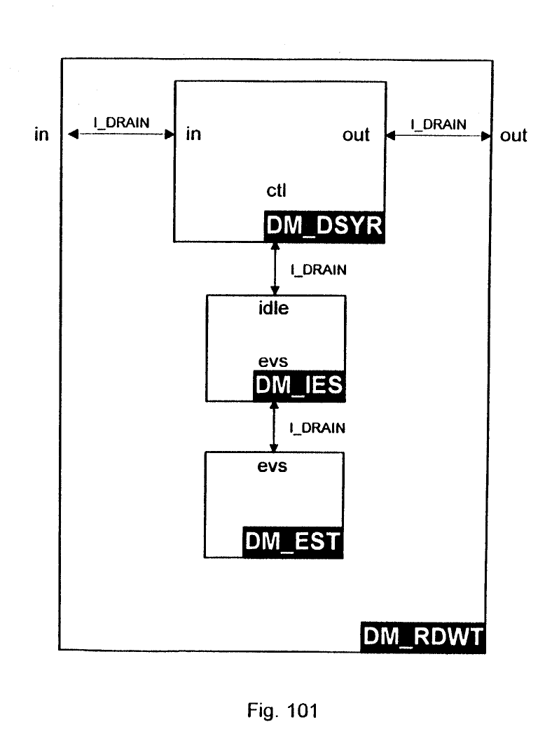

FIG. 101 illustrates the internal structure of the inventive DM_RDWT part.

51. Responsibilities

1. Desynchronize all incoming requests received from in and send them through out.

2. Use a dedicated worker thread to call the out terminal.

52. Theory of Operation

DM_RDWT is an assembly built entirely of DriverMagic parts.

A request that enters DM_RDWT is enqueued by DM_DSYR and control returns to the caller immediately with CMST_OK (if DM_DSYR fails to enqueue the request—i.e., the queue is full an error status is returned).

If this is the first request enqueued, DM_DSYR sends an enable request to its ctl terminal. This request is translated by DM_IES to an “arm” operation sent to DM_EST, which in turn starts issuing “fire” calls in its own thread. The “fire” operations are translated by DM_IES into EV_IDLE events used by DM_DSYR to de-queue requests from its queue and send them to out.

When the queue becomes empty, DM_DSYR sends a disable request (translated to 'disarm” on DM_EST), which causes the DM_EST to stop firing until a new request is enqueued.

53. Subordinate's Responsibilities

53.1. DM_DSYR—Desynchronizer for Requests

Desychronize incoming requests on in and send them through out.

53.2. DM_IES—Idle to Event Source Adapter

Convert EV_REQ_ENABLE and EV_REQ_DISABLE requests on the idle terminal into arm and disarm operations on the evs terminal respectively.

In response to fire operation calls through the evs terminal, generate EV_IDLE requests through idle until CMST_NO_ACTION is returned from the idle processing or an EV_REQ DISABLE request is received.

53.3. DM_EST—Event Source by Thread

Issue “fire” calls within the context of its own thread.

54. Dominant's Responsibilities

54.1. Hard Parameterization of Subordinates

| Subordinate | Property | Value |
|---|---|---|
| DM_DSYR | disable_ctl_req | FALSE |
| DM_EST | force_defaults | TRUE |
| | auto_arm | FALSE |
| | continuous | TRUE |

54.2. Distribution of Properties to the Subordinates

| Property Name | Type | Dist | To |
|---|---|---|---|
| thread_priority | UINT3 | Redir | est.thread_priority |
| | 2 | | |
| queue_sz | UINT3 | Redir | dsyr.queue_sz |
| | 2 | | |
| disable_diag | UINT3 | Redir | dsyr.disable_diag |
| | 2 | | |
| cplt_s_offs | UINT3 | Redir | dsyr.cplt_s_offs |
| | 2 | | |

55. Notes

The desynchronized requests are distributed in a thread different than the one that posted it. This may impose additional limitations if thread-local storage is used.

Resynchronizers

DM_RSY, DM_RSB—Re-Synchronizers

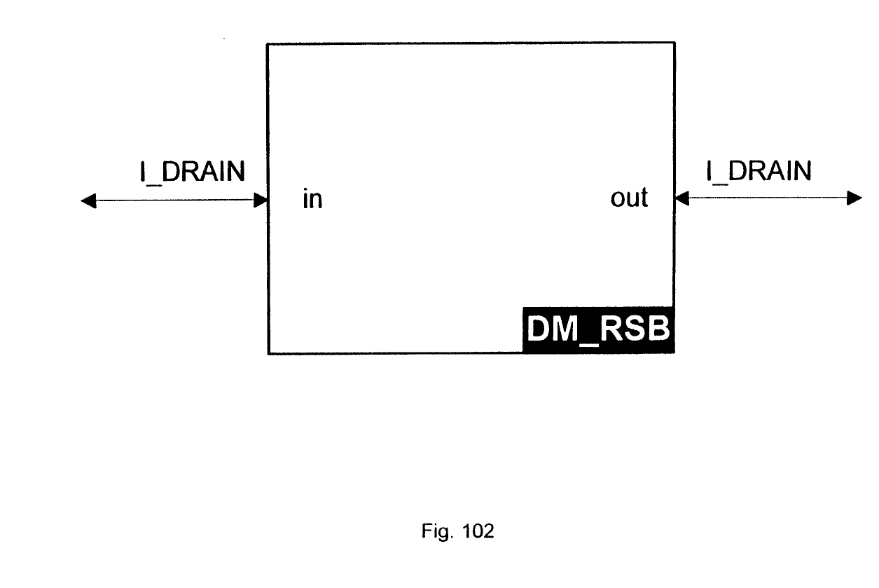

FIG. 102 illustrates the boundary of the inventive DM_RSB part.

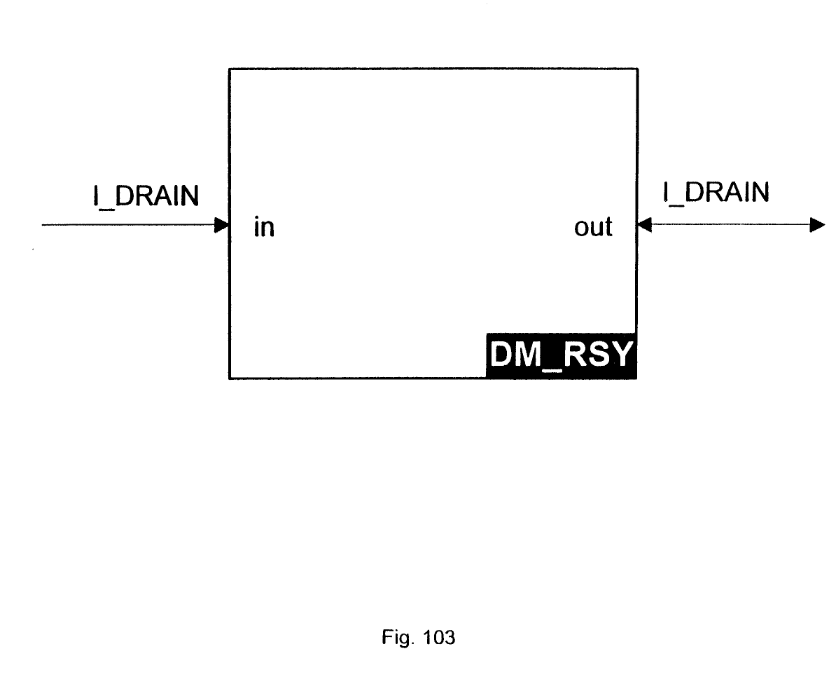

FIG. 103 illustrates the boundary of the inventive DM_RSY part.

1. Overview

DM_RSY is an adapter that converts a Request Event that is expected to complete synchronously into a Request Event that may complete either synchronously or asynchronously.

By doing this, DM_RSY provides the part connected to its out terminal with the option to either complete the request immediately or return CMST_PENDING and delay the actual completion of the request for a future time.

At the same time DM_RSY ensures that the part connected to the in terminal will receive control back (DM_RSY will return from raise operation) only after the processing of the request has actually been completed.

DM_RSY is parameterized with the event ID of the Request Event, which needs to be adapted for asynchronous processing. Addional properties control details of how the adapting procedure is performed.

DM_RSB has the same functionality as DM_RSY, but allows bidirectional connections to its in terminal. The back channel of the in terminal is used to transparently forward all events received on the back channel of the out terminal, allowing DM_RSB to be inserted in bidirectional connections.

2. Details

DM_RSY uses a specialized protocol to accomplish the process of resynchronization. DM_RSY sets an attribute (the value of this attribute is a property) on the incoming event, indicating that the request can be completed asynchronously, and forwards the event to its out terminal.

The part connected to that terminal may complete the processing immediately (synchronously) or may decide to delay the processing and return CMST_PENDING.

If the request was completed synchronously, DM_RSY returns immediately to the originator. If the processing was delayed (CMST_PENDING was returned) however, DM_RSY will block the originator of the event and wait for an event to come from the back channel of the out terminal (the event ID is a property) indicating that the request has been completed. After DM_RSY receives such event, it will return to the Request Event originator (restoring the original attributes).

3. Boundary

3.1. Terminals (DM_RSY)

Terminal “in” with direction “Input” and contract I_DRAIN. Note: v-table, infinite cardinality, synchronous, activetime The req_ev_id event is expected to be received on this terminal. If req_ev_id is EV_NULL, any event may be received on this terminal.

Terminal “out” with direction “Bidir (plug)” and contract I_DRAIN. Note: v-table, cardinality 1, synchronous, unguarded The cplt_ev_id event is expected to be received on this terminal.

3.2. Terminals (DM_RSB)

Terminal “in” with direction “Bidir (plug)” and contract I_DRAIN. Note: v-table, cardinality 1, synchronous The req_ev_id event is expected to be received on this terminal. If req_ev_id is EV_NULL, any event may be received on this terminal.

Terminal “out” with direction “Bidir (plug)” and contract I_DRAIN. Note: v-table, cardinality 1, synchronous, unguarded The cplt_ev_id event is expected to be received on this terminal.

3.3. Events and Notifications

The re-synchronizers recognize two specific events: req_ev_id and cplt_ev_id. The event IDs for these two events are specified as properties and are described in the tables below:

| Incoming Event | Bus | Notes |
|---|---|---|
| req_ev_id | CMEVENT_{—} | The event that requests a synchronous or asynchronous |
| | HDR | operation. |
| | or extended | This event ID is specified as a property on the re- |
| | | synchronizers. |
| | | This event is expected to be received on the in terminal. |
| | | If req_ev_id is EV_NULL, any event may be re- |
| | | synchronized. |
| | | This event may be the same as cplt_ev_id. |
| cplt_ev_id | CMEVENT_{—} | The event that signifies that an asynchronous |
| | HDR | operation, requested by a preceding req_ev_id, has |
| | or extended | completed. |
| | | This event ID is specified as a property on the re- |
| | | synchronizers. |
| | | This event is expected to be received on the out |
| | | terminal. |
| | | This event may be the same as req_ev_id. |
| all others | CMEVENT_{—} | All incoming events received from the in terminal are |
| | HDR | forwarded through out. |
| | or extended | DM_RSB: Unrecognized events received from the out |
| | | terminal are forwarded through in if the re-synchronizer |
| | | is not expecting to receive a completion notification. |
| | | Otherwise, the event is refused. |
| | | DM_RSY: Unrecognized events received from the out |
| | | terminal are not processed by DM_RSY and |
| | | CMST_NOT_CONNECTED is returned. |

3.4.

3.5.

| Outgoing | | |
|---|---|---|
| Event | Bus | Notes |
| req_ev_id | CMEVENT_{—} | The event that requests a synchronous |
| | HDR | or asynchronous operation. |
| | or extended | This event ID is specified as a |
| | | property on the re-synchronizers. |
| | | This event, when received on the |
| | | in terminal, is passed through |
| | | the out terminal. |
| all others | CMEVENT_ | All incoming events received |
| | HDR | from the in terminal are |
| | | or extended forwarded through out. |

3.6. Special Events, Frames, Commands or Verbs

None.

3.7. Properties

Property “req_ev_id” of type “UINT32”. Note: This is the ID of the event that requests the operation that needs to be completed asynchronously. If req_ev_id is EV_NULL, any event may be re-synchronized. This event is expected to be received on the in terminal. This event may be the same as cplt_ev_id. Default is EV_NULL.

Property “cplt_ev_id” of type “UINT32”. Note: This is the ID of the event that signifies the completion of the asynchronous operation. This event is expected to be received on the out terminal. If cplt_ev_id is EV_NULL, the completion event must be the same as req_ev_id, otherwise it may be a different event. Default is EV_NULL.

Property “async_cplt_attr” of type “UINT32”. Note: This is the event-specific attribute to be set on the req_ev_id event in order to signify that the requested operation can be completed asynchronously. The attribute value may be 0. Default is CMEVT_A_ASYNC_CPLT.

Property “cplt_attr” of type “UINT32”. Note: This is the event-specific attribute to be set on the cplt_ev_id event in order to signify that the asynchronous operation has completed. This attribute is used only if req_ev_id is the same as cplt_ev_id. The attribute value may be 0. Default is CMEVT_A_COMPLETED.

Property “copy_cplt_data” of type “BOOL”. Note: If TRUE, the re-synchronizer copies the completion data from the completion event bus to the event bus of the originator of the request. Default is FALSE.

Property “extract_cplt_s” of type “BOOL”. Note: If TRUE, the re-synchronizer extracts the completion status from the completion event bus and return it to the originator of the request. Default is FALSE.

Property “cplt_s_offset” of type “UINT32”. Note: This is the offset from the beginning of the completion event bus (in bytes), where the completion status is stored. This property is ignored if extract_cplt_s is FALSE. Default is 0x0C.

4. Encapsulated Interactions

DM_RSY uses the synchronization services (Events) of the operating system to block the thread that requests the operation which is desynchronized.

5. Dependencies

DM_RSY requires DM_BSP and DM_RSB to be available.

6. Specification

7. Responsibilities

1. Pass all events received from the in terminal through the out terminal.

2. DM_RSB: Pass all unrecognized events received from the out terminal through the in terminal (only if the re-synchronizer is not expecting to receive a completion notification; otherwise the event is refused).

3. DM_RSY: Ignore unrecognized events received from the out terminal.

4. If an req_ev_id event is received on the in terminal, forward the event through out and block the caller (if needed) until the cplt_ev_id event is received on the out terminal. If an req_ev_id is EV_NULL, allow any event to be re-synchronized.

5. When an asynchronous operation completes, return the results and control back to the caller.

8. Theory of Operation

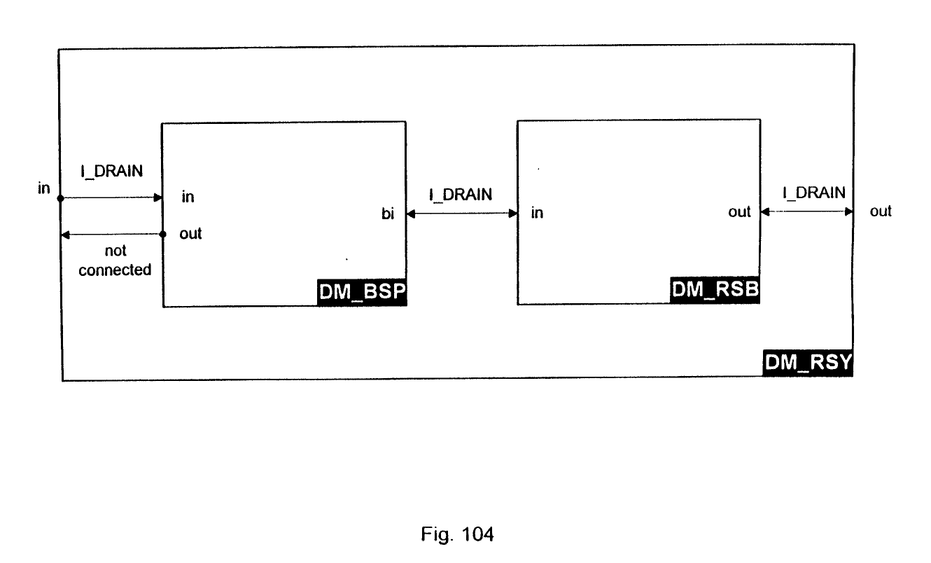

FIG. 104 illustrates the internal structure of the inventive DM_RSY part.

8.1. Interior

DM_RSB is a coded part.

DM_RSY is a static assembly.

8.2. Mechanisms

Handling Operation Requests From the In Terminal

When the re-synchronizer receives an req_ev_id event (or any event if req_ev_id is EV_NULL) from the in terminal, it sets the asynchronous completion attribute (specified by async_cplt_attr) and forwards the event through the out terminal.

If any status other than CMST_OK or CMST_PENDING is returned from the event processing, this is considered an error and the status is returned to the caller.

If the return status is CMST_OK (or any status other than CMST_PENDING) the operation completed synchronously. In this case, the re-synchronizer returns control back to the caller and does nothing else.

If the return status is CMST_PENDING, the operation will complete asynchronously. The re-synchronizer blocks the caller (using an event synchronization object) until it receives an cplt_ev_id event on its out terminal. When an cplt_ev_id event is received, the event object is signaled and control is returned back to the caller.

In all cases, before the control is returned back to the caller, the event-specific attributes (possibly modified by the re-synchronizer) are restored to their original values.

The re-synchronizers pass all other events from the in terminal through the out terminal without modification.

Notification of Asynchronous Operation Completion

The re-synchronizer blocks the caller (as described in the mechanism above) until it receives an cplt_ev_id event on its out terminal. This event indicates that the asynchronous operation is complete.

If the completion event (cplt_ev_id) is the same as the operation request event (req_ev_id), the re-synchronizer expects that the completion attribute (cplt_attr) is set. If not, the re-synchronizer returns CMST_REFUSE.

When the asynchronous operation has completed, the caller is unblocked by signaling the event object. The re-synchronizer uses the values of the properties copy_cplt_data and extract_cplt_s to determine if it should copy the completion event bus and/or return the completion status to the caller. The caller receives the results of the asynchronous operation and continues execution as if the requested operation had completed synchronously.

If an unrecognized event is received on the out terminal and the re-synchronizer is not expecting to receive a completion notification, it will pass the event through the in terminal. If a completion event is expected, the event is refused.

Extraction of the Completion Status

When the asynchronous operation has completed, the re-synchronizer uses the value of the extract_cplt_s property to determine whether the completion status is returned to the caller.

If extract_cplt_s is TRUE, the re-synchronizer uses the value of cplt_s_offset to determine where the completion status is stored in the completion event bus. The status is extracted and returned to the caller.

If extract_cplt_s is FALSE, the re-synchronizer returns CMST_OK to the caller.

8.3. Use Cases

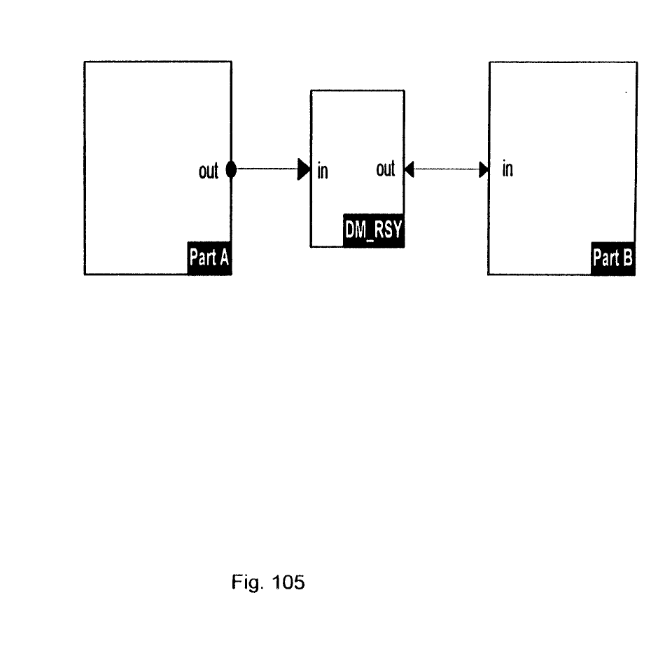

FIG. 105 illustrates an advantageous use of the inventive DM_RSY part.

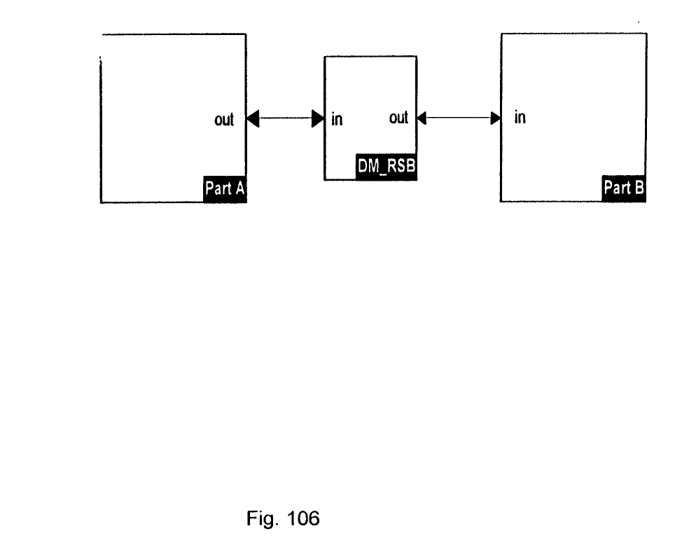

FIG. 106 illustrates an advantageous use of the inventive DM_RSB part.

Requested Operation Completes Synchronously

1. The structures in FIGS. 3 and 4 are created, connected, and activated.

2. At some point, the re-synchronizer receives an req_ev_id event on its in terminal.

3. The re-synchronizer sets the asynchronous attribute (async_cplt_attr) in the event bus to indicate that the operation can complete asynchronously if needed.

4. The event is passed through the out terminal.

5. The part connected to the re-synchronizer's out terminal receives the event and completes the operation synchronously. Control is returned back to the re-synchronizer.

6. The re-synchronizer returns control back to the caller.

7. Steps 2-6 may be executed many times.

8. The re-synchronizer is deactivated, disconnected, and destroyed.

Requested Operation Completes Asynchronously

1. The structures in FIGS. 3 and 4 are created, connected, and activated.

2. At some point, the re-synchronizer receives an req_ev_id event on its in terminal.

3. The re-synchronizer sets the asynchronous attribute (async_cplt_attr) in the event bus to indicate that the operation can complete asynchronously if needed.

4. The event is passed through the out terminal.

5. The part connected to the re-synchronizers out terminal receives the event and returns CMST_PENDING indicating that the operation will complete asynchronously.

6. The re-synchronizer blocks the caller by waiting on an event synchronization object.

7. At some later point, the re-synchronizer receives a cplt_ev_id event on its out terminal.

8. If the copy_cplt_data property is TRUE, the re-synchronizer copies the completion data into the event bus of the blocked caller.

9. If the extract_cplt_S property is TRUE, the re-synchronizer extracts the completion status from the completion data and saves it in its instance data.

10. The re-synchronizer unblocks the caller by signaling the event.

11. If the extract_cplt_s property is TRUE, the saved completion status is returned to the caller, otherwise CMST_OK is returned.

12. Steps 2-11 may be executed many times.

13. The re-synchronizer is deactivated, disconnected, and destroyed.

Unrecognized Events Received on In Terminal

1. DM_RSB/DM_RSY is created, connected, and activated.

2. At some point, the re-synchronizer receives an unrecognized event on its in terminal (any event other than req_ev_id).

3. The re-synchronizer forwards the event through the out terminal and returns the results back to the caller.

4. Steps 2-3 may be executed many times.

5. The re-synchronizer is deactivated, disconnected, and destroyed.

Unrecognized Events Received on Out Terminal

1. DM_RSB/DM_RSY is created, connected, and activated.

2. At some point, the re-synchronizer receives an unrecognized event on its out terminal (any event other than cplt_ev_id).

3. If the re-synchronizer is expecting to receive a completion notification, it returns CMST_REFUSE. Otherwise, DM_RSB forwards the event through the in terminal and returns the results back to the caller. DM_RSY returns CMST_NOT_CONNECTED.

4. Steps 2-3 may be executed many times.

5. The re-synchronizer is deactivated, disconnected, and destroyed.

Using Cascaded Re-Synchronizers

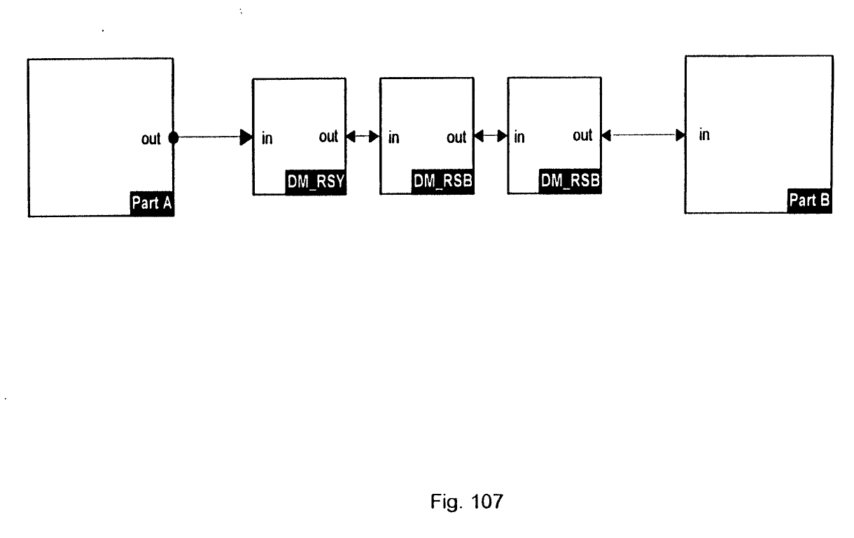

FIG. 107 illustrates an advantageous use of the inventive DM_RSB and DM_RSY parts.

The structure in the figure above is used if there is a need to resynchronize different operations along the same channel. In this example, 3 resynchronizers are cascaded—one for each of 3 events that can be made to complete asynchronously.

1. The structure in FIG. 5 is created, parameterized, and activated.

2. Part A sends an event (e.g., the one that is parameterized on the second resynchronizer) to the first resynchronizer. The resynchronizer passes it through the out terminal.

3. The second resynchronizer receives the event and passes it through the out terminal.

4. The third resynchronizer receives the event and passes it through the out terminal.

5. Part B receives the event and returns CMST_PENDING indicating that the operation will complete asynchronously. Control is returned to the second resynchronizer.

6. The second resynchronizer blocks the caller by waiting on an event synchronization object.

7. The asynchronous operation is completed the same way as in the above use cases.

8. The second resynchronizer returns control back to Part A.

9. Notes

1. If any of the resynchronizers receive cplt_ev_id on its out terminal while it is not expecting asynchronous completion, it will return CMST_REFUSE.

2. If an event is sent to the resynchronizers in terminal while the resynchronizer is waiting for asynchronous completion, the caller will be blocked until the pending asynchronous operation completes.

3. DM_RSY does not enforce the contract ID of the in terminal. The counter terminal of in is expected to be I_DRAIN.

4. If an unrecognized event is received on the resynchronizer's out terminal (while it is not waiting for an asynchronous operation to complete), different situations can occurr. DM_RSY will always return CMST_NOT_CONNECTED and DM_RSB will always pass the event through the in terminal.

5. The asynchronous operation may be completed by sending the completion event to the resynchronizer while in the context of the operation request.

Buffers

DM_SEB—Synchronous Event Buffer

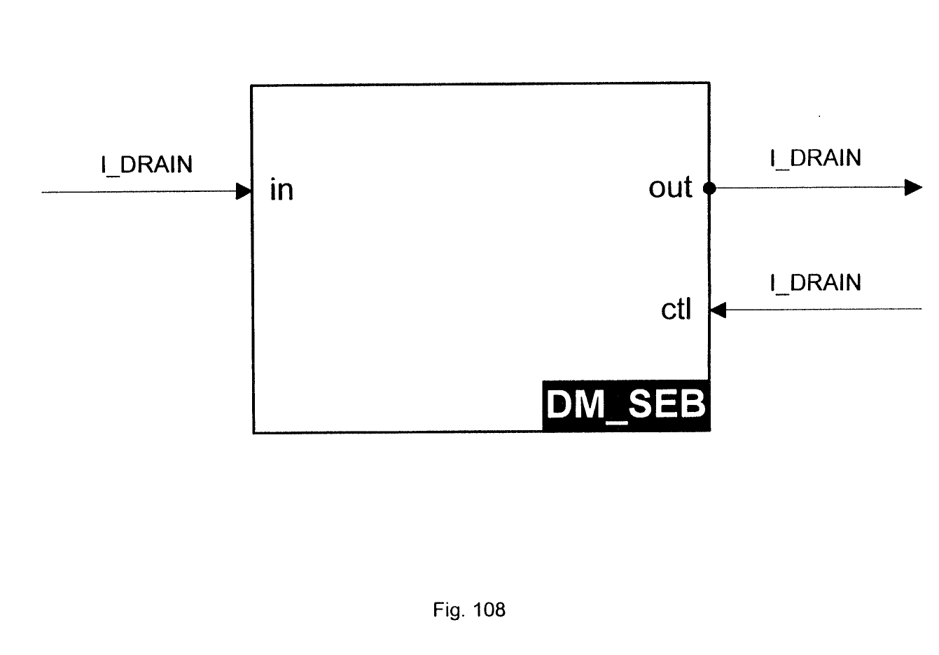

FIG. 108 illustrates the boundary of the inventive DM_SEB part.

DM_SEB is a synchronous event buffer with flow control on its output terminal, out. Events are received synchronously at in and are either passed through to out or are buffered internally until the output is enabled via ctl.

The output is enabled or disabled when the EV_REQ_ENABLE and EV_REQ_DISABLE events are received at ctl, respectively.

When the output is enabled, an event received at in is passed through, un-interpreted and un-buffered, to out and runs in the thread of the sender to in. If the output is disabled, all events received by in are buffered until an EV_REQ ENABLE is received at ctl. On the EV_REQ ENABLE event, all buffered events are sent out the out terminal in the thread of the EV_REQ ENABLE sender.

DM_SEB's output is enabled on activation.

1. Boundary

1.1. Terminals

Terminal “in” with direction “In” and contract I_DRAIN. Note: Input for any type of event to be either buffered or passed through. The event is not interpreted by DM_SEB.

Terminal “out” with direction “Out” and contract I_DRAIN. Note: Output for events received at in. Events are output only if the output is enabled.

Terminal “ctl” with direction “In” and contract I_DRAIN. Note: Output control. Responds to EV_REQ_ENABLE and EV_REQ_DISABLE events in order to enable or disable the output.

1.2. Events and Notifications

| Incoming Event | Bus | Notes |
|---|---|---|
| EV_REQ_{—} | CMEVENT_{—} | Changes the state of the output |
| ENABLE | HDR | to enabled. All events received |
| | | by in after this event are passed |
| | | through, un-interpreted, to out. |
| EV_REQ_{—} | CMEVENT_{—} | Changes the state of the output to |
| DISABLE | HDR | disabled. All events received by in |
| | | after this event are buffered on |
| | | an internal queue and not sent out. |

DM_SEB has no outgoing events.

1.3. Special Events, Frames, Commands or Verbs

None.

1.4. Properties

Property “reset_ev_id” of type “UINT32”. Note: Event ID that will reset DM_SEB before the event is forwarded or buffered. This is a redirected property.

2. Encapsulated Interactions

None.

3. Internal Definition

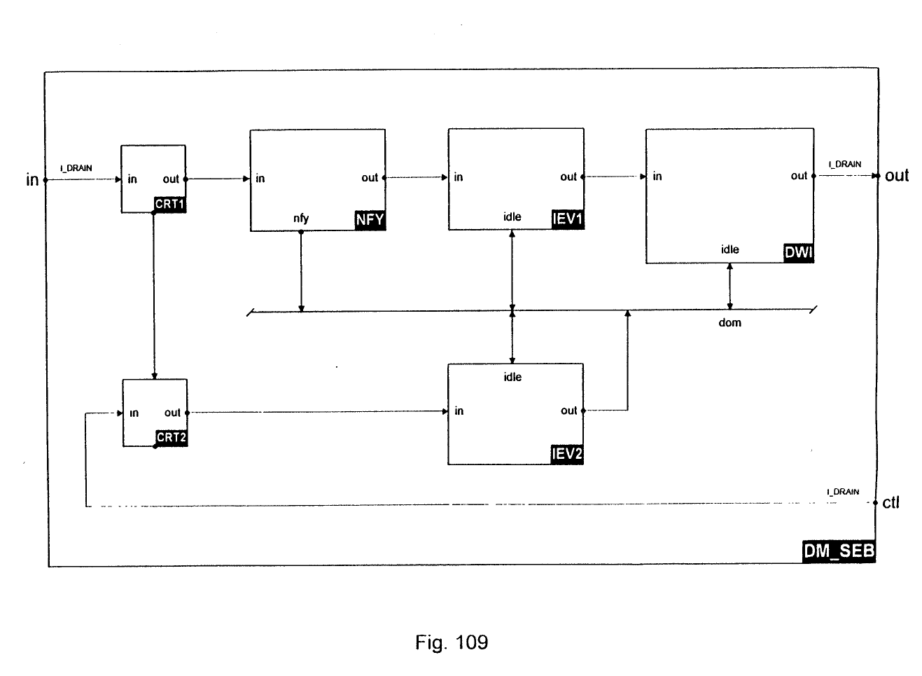

FIG. 109 illustrates the internal structure of the inventive DM_SEB part.

DM_SEB is an assembly that is built entirely out of DriverMagic library parts. It is comprised of a “Desynchronizer with Idle Input” (DWI), which provides the event queue for the assembly, an “Idle Generator Driven by Event” (IEVx) that provides idle events to dequeue events buffered in DWI, a “Event Notifier” (NFY) to reset DWI on a high priority input event and a “Stackable Critical Section” (CRTx), which guard DM_SEB's inputs, since it has no input operations of its own.

Events received at in pass through NFY and IEV1 to be enqueued in DWI. If an EV_REQ_ENABLE event has been previously received at ctl, then IEV1 will generate EV_IDLE events to the event bus, which is parameterized to send the event out its dom terminal first. DWI receives the EV_IDLE event from the event bus and de-queues its events in response.

The output is disabled when an EV_REQ DISABLE event is received at ctl. IEV2 passes this event to the event bus, which in turn passes it to both IEV1 and IEV2 at their idle terminals, disabling them. Any future events received at in will pass through NFY and IEV1 to DWI to be buffered as before, but no EV_IDLE events will be generated by IEV2 or IEV2.

NFY gives DM_SEB the ability to pass “reset” events immediately to its output. It maps an input event, specified by its reset_ev_id property, to an EV_RESET event that it sends out its aux terminal, in order to clear DWI's event queue before it is forwarded to DWI and subsequently out DM_SEB's out terminal. DWI is guaranteed to receive this event with an empty queue. The effect of DM_SEB receiving this event is that it will be passed through to the output immediately, even if DWI had other events already enqueued. The reset event is passed through DM_SEB's out terminal only if DM_SEB is enabled.

4. Subordinate's Responsibilities

4.1. CRTx

1. Provide a common critical section for all the inputs to the assembly. DM_SEB is a pure assembly and has no guarded input operations of its own.

4.2. IEVx

1. Generate EV_IDLE events out its idle terminal in response to any event it receives on its in terminal, if enabled.

2. Provide the mechanism to enable and disable idle generation on EV_REQ xxx events.

4.3. DWI

1. Implement an event queue that can be consumed with EV_IDLE events.

2. Clear the event queue on receipt of an EV_RESET event

4.4. NFY

1. Map an input event at its in terminal to an event sent out aux. The input event is forwarded out out either before or after the mapped event is sent out aux.

5. Subordinate Parameterization

| Subordinate | Property | Value |
|---|---|---|
| DWI | queue_sz | 0 (default) |
| | disable_idle_req | TRUE (default) |
| IEV1 and IEV2 | idle_first | FALSE (default) |
| CRT1 and | attr | CMCRT_A_NONE (default) |
| CRT2 | | |
| NFY | trigger_ev | EV_NULL (default) |
| | pre_ev | EV_RESET |
| | post_ev | EV_NULL (default) |
| EVB | sync | TRUE |
| | dom_first | TRUE |
| | do_pview | FALSE (default) |
| | pview_st_ok | CMST_OK (default) |
| | detect | FALSE (default) |
| | enforce | FALSE (default) |

6. Dominant's Responsibilities

DM_SEB is a pure assembly; it does not have responsibilities of its own.

7. Internal Interfaces

All internal interfaces are of type I_DRAIN.

8. Theory of Operation

8.1. Mechanisms

Event Buffering

DWI implements an event queue to buffer incoming events. Events buffered by DWI will be sent out out while it receives EV_IDLE events. If the EV_IDLE events have been disabled, DWI will simply add any incoming events to its queue.

Idle Generation

Both IEV1 and IEV2 are responsible for generating EV_IDLE events for DM_SEB. IEV1 generates idle events in response to events received at DM_SEB's in terminal and IEV2 generates idles events in response to the EV_REQ_ENABLE event being received at the ctl terminal. In either case, all EV_IDLE events are sent to the event bus for distribution. DWI receives the EV_IDLE events from the bus and sends any enqueued events out DM_SEB's out terminal in response.

Idle Generation Control

Idle generation is enabled or disabled on EV_REQ-xxx events received at DM_SEB's ctl terminal. Both IEV1 and IEV2 must be parameterized to generate idle events after passing the input event through.

When DM_SEB's output is disabled, an EV_REQ_DISABLE event is received at ctl that passes through IEV2 to the event bus where it is distributed to both IEV1 and IEV2, disabling both. No subsequent idle generation can occur.

When an EV_REQ_ENABLE event is received at ctl, it is passes through IEV2 to the event bus and is distributed to IEV1 and IEV2's idle terminal, enabling both. When IEV2 receives control back from the event bus, it generates EV_IDLE events until DWI's queue is emptied and is shut off by DWI. Any subsequent events received at DM_SEB's in terminal will be enqueued by DWI and will start IEV1's EV_IDLE generator to dequeue the event just received by DWI, effectively passing it through.

Handling Reset Events

NFY is parameterized to map an input event to an EV_RESET event that it will send out its aux terminal. When this input event is received, NFY first sends an EV_RESET event out aux to clear the event queue in DWI and then forwards the event out its out terminal, where it eventually is received by DWI. This clears the way for the input event to be passed immediately out DM_SEB's out terminal, regardless of how many events have been previously buffered. The reset event is passed through DM_SEB's out terminal only if DM_SEB is enabled.

DM_SEBP—Synchronous Event Buffer With Postpone

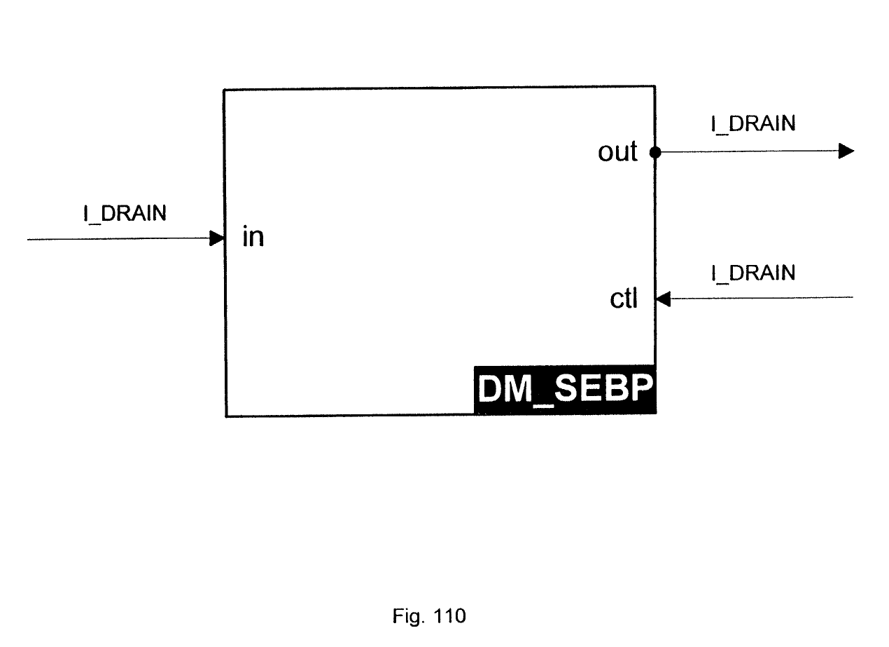

FIG. 110 illustrates the boundary of the inventive DM_SEBP part.

DM_SEBP is a synchronous event buffer with postpone capability and flow control on its output terminal, out. It contains two queues; (a) main queue—queue for buffered events when output is disabled and (b) postponed queue—queue for events that have been postponed.

Events are received synchronously at in and are either passed through to out or are buffered internally on one of SEBP's queues.

The output is enabled or disabled when the EV_REQ_ENABLE and EV_REQ_DISABLE events are received at ctl, respectively.

When the output is enabled, an event received at in is passed through, un-interpreted and un-buffered, to out and runs in the thread of the sender to in. If the call returns CMST_POSTPONE, the event is buffered and placed on the postpone queue.

If the output is disabled, all events received by in are buffered on the main queue until an EV_REQ_ENABLE event is received at ctl. On the EV_REQ_ENABLE event, all buffered events are sent out the out terminal in the thread of the EV_REQ_ENABLE sender.

If an EV_FLUSH event is received at ctl, the buffered events on the postpone queue are moved to the front of the main queue and are sent out the out terminal in the thread of the EV_FLUSH sender.

When the output is disabled, a single event may be dequeued from the main queue and sent out the out terminal by sending an EV IDLE event to the ctl terminal. The event is sent out the out terminal in the thread of the EV_IDLE sender.

DM_SEBP's output is enabled on activation.

9. Boundary

9.1. Terminals

Terminal “in” with direction “In” and contract I_DRAIN. Note: Input for any type of event to be either buffered or passed through. The event is not interpreted by DM_SEBP.

Terminal “out” with direction “Out” and contract I_DRAIN. Note: Output for events received at in. Events are output only if the output is enabled or an EV_FLUSH or EV_IDLE event is received on ctl.

Terminal “ctl” with direction “In” and contract I_DRAIN. Note: Input for output control events.

9.2. Events and Notifications

The following events are recognized on the in terminal:

| Incoming Event | Bus | Notes |
|---|---|---|
| (reset_ev_id) | CMEVENT | DM_SEBP is parameterized with this |
| | _HDR | event via its reset_ev_id property. |
| | | When this event is received, |
| | | DM_SEBP |
| | | empties both of its queues and forwards |
| | | the event to out (if it is enabled). |
| | | If DM_SEBP is |
| | | disabled, the event is placed on the |
| | | main queue. This event does not |
| | | affect the enabled/disabled state of |
| | | DM_SEBP |

The following events are recognized on the ctl terminal:

| Incoming Event | Bus | Notes |
|---|---|---|
| EV_REQ_ENABLE | CMEVENT | Changes the state of the output to enabled. |
| | _HDR | All events received on in, after this event, are passed |
| | | through, un-interpreted, to out. |
| EV_REQ_DISABLE | CMEVENT | Changes the state of the output to disabled. |
| | _HDR | All events received by in after this event are buffered on |
| | | the main queue and not sent out. |
| EV_FLUSH | CMEVENT | Move postponed events to the beginning of the main |
| | _HDR | queue and if enabled, send all events to out. |
| | | This event does not affect the enabled/disabled state of |
| | | SEBP |
| EV_IDLE | CMEVENT | Remove a single event from the main queue and send it |
| | _HDR | to out. The return status is CMST_OK or |
| | | CMST_NO_ACTION. |
| | | This event does not affect the enabled/disabled state of |
| | | SEBP. |
| EV_RESET | CMEVENT | Empty the main and postpone queues (i.e., lose the |
| | _HDR | events). |
| | | This event does not affect the enabled/disabled state of |
| | | SEBP. |

DM_SEBP has no outgoing events.

9.3. Special Events, Frames, Commands or Verbs

None.

9.4. Properties

Property “reset_ev_id” of type “UINT32”. Note: Event ID that will reset DM_SEBP before the event is forwarded or buffered. This is a redirected property.

10. Internal Definition

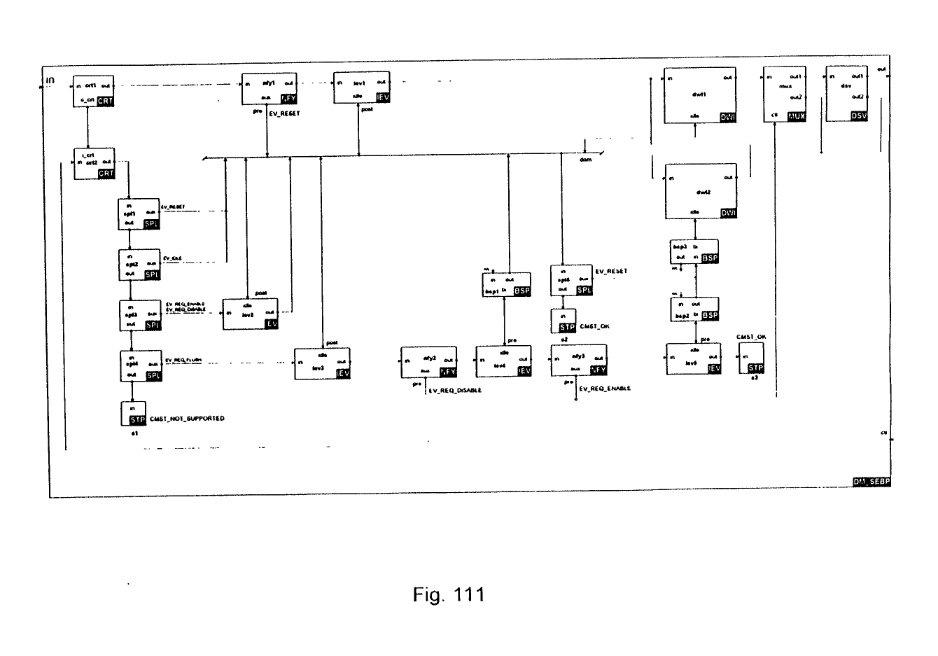

FIG. 111 illustrates the internal structure of the inventive DM_SEBP part.

11. Functional Overview

DM_SEBP is an assembly whose behavior is built entirely, without specific code, by assembling DriverMagic library parts.

Events received at in pass through NFY1 and IEV1 to be enqueued in the main desynchronizer, DWI1. If an EV_REQ_ENABLE event has been previously received at ctl, then IEV1 will generate EV_IDLE events to the event bus, which is parameterized to send the event out its dom terminal first. DWI1 receives the EV_IDLE event from the event bus, dequeues its events in response, and sends subsequent events out. When the status returned from out is CMST_POSTPONE, DSV interprets this status to mean the event was not serviced and sends the event to its out2 terminal, resulting in the event being enqueued in the postpone desynchronizer, DWI2.

The output is disabled when an EV_REQ_DISABLE event is received at ctl. The event is passed to IEV2, which passes this event to the event bus, which in turn passes it to IEV1, IEV2, and IEV3 at their idle terminals, disabling them. Any future events received at in will pass through NFY1 and IEV1 to DWI1 to be buffered as before, but no EV_IDLE events will be generated by IEV1.

When an EV_REQ_ENABLE event is received at ctl, it is passed to IEV2, which is parameterized to forward it out its out terminal before sending EV_IDLE events out its idle terminal. The event passes to the main desynchronizer, DWI1, and enables it. IEV2 then generates EV_IDLE events out its idle terminal resulting in DWI1 sending each of its queued events out.

When an EV_FLUSH event is received at ctl, it is passed to IEV3, which is parameterized to forward it to its out terminal before sending EV_IDLE events out its idle terminal. The event passes to NFY2, which recognizes it and generates an EV_REQ_DISABLE event resulting in MUX switching its output to out2. The EV_FLUSH event is then sent to IEV4, which generates EV_IDLE events causing DWI1 to dequeue all of its buffered events. The dequeued events pass through MUX and are subsequently enqueued in DWI2. IEV4 then passes the event to NFY3, which issues an EV_REQ_ENABLE event out its aux terminal to switch MUX's output back to out1. NFY3 then passes the EV_FLUSH to IEV5, which generates EV_IDLE events and causes DWI2 to dequeue all of its events into DWI1. As a result, all prevously-postponed events are placed at the head of the queue in DWI1. When the EV_FLUSH event returns to IEV3, If DM_SEBP is enabled, IEV3 generates EV_IDLE events to the event bus causing DWI1 to dequeue all of its events.

When DM_SEBP receives the event specified by its reset-ev-id property, NFY1 generates an EV_RESET event to the event bus, causing DWI1 and DWI2 to empty their queues before the event is passed on. If DM_SEBP is disabled, the event that generated the “reset” event will be enqueued in DWI1.

12. Subordinate's Responsibilities

12.1. CRT—Stackable Critical Section

1. Provide a common critical section for all the inputs to the assembly. DM_SEBP is a pure assembly and has no guarded input operations of its own.

12.2. SPL—Event Splitter

1. Filters out specified events and send them out its aux terminal. All other events are sent out its out terminal.

12.3. NFY—Event Notifyier

2. Generates an event out aux when a specific event is received on in. The input event is forwarded out out either before or after the genereated event is sent out aux.

12.4. IEV—Idle by Event

1. Generate EV_IDLE events out its idle terminal in response to any event it receives on its in terminal, if enabled.

2. Provide the mechanism to enable and disable idle generation on EV_REQ_XXX events.

12.5. DWI—Desynchronizer with Idle Input

1. Implement an event queue that can be pumped with EV IDLE events.

2. Clear the event queue on receipt of an EV_RESET event

12.6. BSP—Bi-Directional Splitter

1. Provide plumbing to enable connection of a bidirectional terminal to an unidirectional input or output.

12.7. STP—Event Stopper

1. Terminate the event flow by returning a specified status (e.g., CMST_OK).

12.8. MUX—Event-Controlled Multiplexer

1. Implements a switch between its out1 and out2 outputs that is controlled by event input on its ctl terminal.

12.9. DSV—Distributor for Service

1. Forwards incoming operation to out2 if the operation is not serviced by out1.

13. Distribution of Properties

| Property | Distr. | Subordinate |
|---|---|---|
| reset_ev_id | Redirected | nfy1.trigger_ev |

14. Subordinate Parameterization

| Part | Property | Value |
|---|---|---|
| crt1, crt2 | attr | CMCRT_A_NONE (default) |
| s1 | ret_s | CMST_NOT_SUPPORTED |
| s2, s3 | ret_s | CMST_OK |
| spl1 | ev_min | EV_RESET |
| | ev_max | EV_RESET |
| spl2 | ev_min | EV_IDLE |
| | ev_max | EV_IDLE |
| spl3 | ev_min | EV_REQ_ENABLE |
| | ev_max | EV_REQ_DISABLE |
| spl4 | ev_min | EV_FLUSH |
| | ev_max | EV_FLUSH |
| nfy1 | trigger_ev | EV_NULL (exposed as reset_ev_id) |
| | pre_ev | EV_RESET |
| | post_ev | EV_NULL |
| nfy2 | trigger_ev | EV_FLUSH |
| | pre_ev | EV_REQ_DISABLE |
| | post_ev | EV_NULL |
| nfy3 | trigger_ev | EV_FLUSH |
| | pre_ev | EV_REQ_ENABLE |
| | post_ev | EV_NULL |
| iev1 | idle_first | FALSE |
| iev2 | idle_first | FALSE |
| iev3 | idle_first | FALSE |
| iev4 | idle_first | TRUE |
| iev5 | idle_first | TRUE |
| dwi | queue_sz | 0 (default) |
| | disable_idle_req | TRUE (default) |
| evb | sync | TRUE |
| | dom_first | TRUE |
| | do_preview | FALSE (default) |
| mux | ev_out1 | EV_REQ_ENABLE |
| | ev_out2 | EV_REQ_DISABLE |
| dsv | hunt_stat | CMST_POSTPONE |
| | hunt_if_match | TRUE |

15. Internal Interfaces

All internal interfaces are of type I_DRAIN.

16. Theory of Operation

16.1. Mechanisms

Event Buffering

DWI implements an event queue to buffer incoming events. Events buffered by DWI will be sent out out while it receives EV_IDLE events. If the EV_IDLE events have been disabled, DWI will simply add any incoming events to its queue.

When the queue in DWI is empty, it will return CMST_NO_ACTION, causing the EV_IDLE generation to be stopped.

Idle Generation

All of the IEVx parts are responsible for generating EV_IDLE events for DM_SEBP. IEV1 generates idle events in response to events received at DM_SEBP's in terminal. IEV2 generates idles events in response to the EV_REQ_ENABLE event being received at the ctl terminal. IEV3 generates idle events to empty DWI1's queue after an EV_FLUSH event has been received on ctl. IEV4 generates idle events to move the contents of DWI2's queue to DWI1 after an EV_FLUSH event, and IEV5 generates the idle events to move the contents of DWI1's queue to the end of DWI2's queue after an EV_FLUSH event has been received on ctl.

In all cases, all EV_IDLE events are sent to the event bus for distribution. DWI1 receives the EV_IDLE events from the bus and sends any enqueued events out DM_SEBP's out terminal in response. DWI2 receives EV_IDLE events only from IEV5.

Idle Generation Control

Idle generation is enabled or disabled on EV_REQ_ENABLE/DISABLE events received at DM_SEBP's ctl terminal. When DM_SEBP's output is disabled, an EV_REQ_DISABLE event is received at ctl that passes through IEV2 to the event bus where it is distributed to IEV1, IEV2, and IEV3, disabling all. No subsequent idle generation can occur. When an EV_REQ_ENABLE event is received at ctl, it passes through IEV2 to the event bus and is distributed to IEV1, IEV2 and IEV3's idle terminal, enabling all. When IEV2 receives control back from the event bus, it generates EV_IDLE events until DWI1's queue is emptied and is shut off by DWI1. Any subsequent events received at DM_SEBP's in terminal will be enqueued by DWI and will start IEV1's EV_IDLE generator to dequeue the event just received by DWI1, effectively passing it through.

Flushing Postponed Events

When an EV_FLUSH event is received at ctl, it is passed through IEV3, which passes to IEV4 via NFY2. IEV4 generates EV_IDLE events until DWI1's queue is emptied into DWI2's queue. The event is then passed to IEV5 which generates EV_IDLE events until DWI2's queue is emptied back into DWI1's (i.e. moving contents of DWI2 in front of DWI1). When IEV3 regains control, it generates EV_IDLE events, if it is enabled, to the event bus until DWI1's queue is emptied and is shut off by DWI1.

Postponing Operations

When a forwarded event returns CMST_POSTPONE, that event is enqueued onto DWI2's queue until an EV_FLUSH event is received on ctl. When the EV_FLUSH event is received, the contents of DWI2's queue are moved to the front of DWI1's queue and all events are sent out out if DM_SEBP is enabled.

16.2. Use Cases

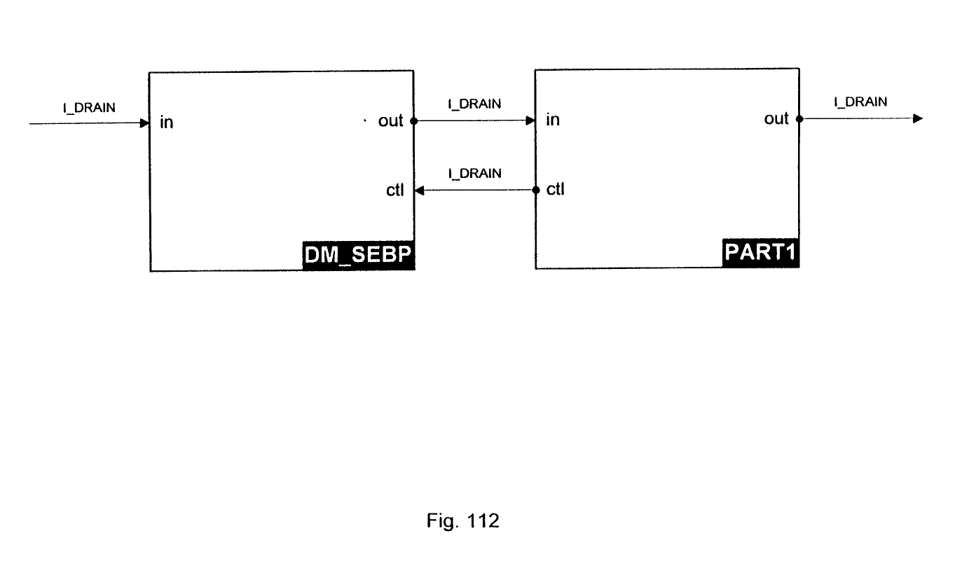

FIG. 112 illustrates an advantageous use of the inventive DM_SEBP part.

Preventing Re-Entrancy

When PART1 does not wish to receive events on in terminal while processing an event, it can disable its event input by sending an EV_REQ_DISABLE event out its ctl terminal. When PART1 is finished processing the event, it sends an EV_REQ_ENABLE event out its ctl terminal to re-enable its event input before returning.

Postponing Operations

If PART1 is in a state where it cannot process certain events, it doesn't want them discarded, and it does not want to prevent further events from coming in, it can postpone delivery of those events by returning a CMST_POSTPONE status. This causes DM_SEBP to enqueue the event on its postpone queue. PART1 is able process the postponed events, it sends an EV_FLUSH event out its ctl terminal. This causes DM_SEBP to dequeue each of the postponed events one at a time and send them to PART1's in terminal.

DM_ASB—Asymmetrical Synchronous Buffer

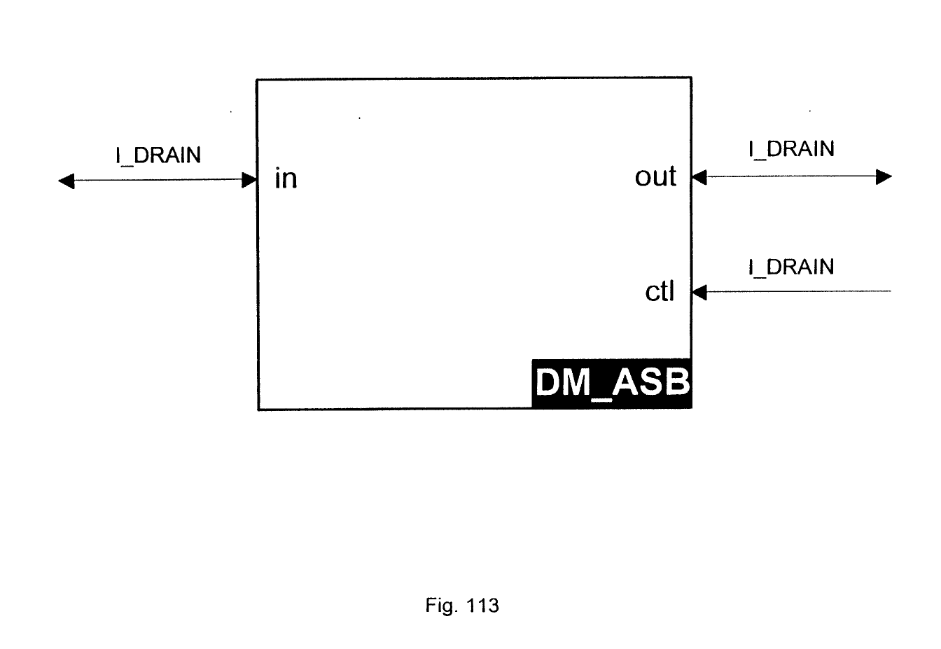

FIG. 113 illustrates the boundary of the inventive DM_ASB part.

DM_ASB is an asymmetrical synchronous event buffer. Flow control is provided for events moving in the forward direction (e.g., from in to out). The flow of events out of out can be disabled by sending EV_REQ_ENABLE and EV_REQ_DISABLE events to ctl. While disabled, events sent to DM_ASB in the forward direction are buffered until the output is re-enabled.

All events sent to DM_ASB in the reverse direction are immediately passed through without any buffering.

17. Boundary

17.1. Terminals

Terminal “in” with direction “Bidir” and contract I_DRAIN. Note: Forward event I/O terminal.

Terminal “out” with direction “Bidir” and contract I_DRAIN. Note: Reverse event I/O terminal.

Terminal “ctl” with direction “In” and contract I_DRAIN. Note: Flow control. Responds to EV_REQ_ENABLE and EV_REQ_DISABLE events in order to enable or disable the output.

17.2. Events and Notifications

| Incoming Event | Bus | Notes |
|---|---|---|
| EV_REQ_ENABLE | CMEVENT_HDR | Changes the state of the |
| | | output to enabled. All |
| | | forward events are passed |
| | | through, un-interpreted, |
| | | to out. |
| EV_REQ_DISABLE | CMEVENT_HDR | Changes the state of the |
| | | output to disabled. All |
| | | forward events are buffered |
| | | on an internal queue |
| | | and not sent out. |

DM_ASB has no outgoing events.

17.3. Special Events, Frames, Commands or Verbs

None.

17.4. Properties

Property “reset_ev_id” of type “UINT32”. Note: Event ID that will reset DM_ASB before the event is forwarded or buffered. This is a redirected property.

18. Internal Definition

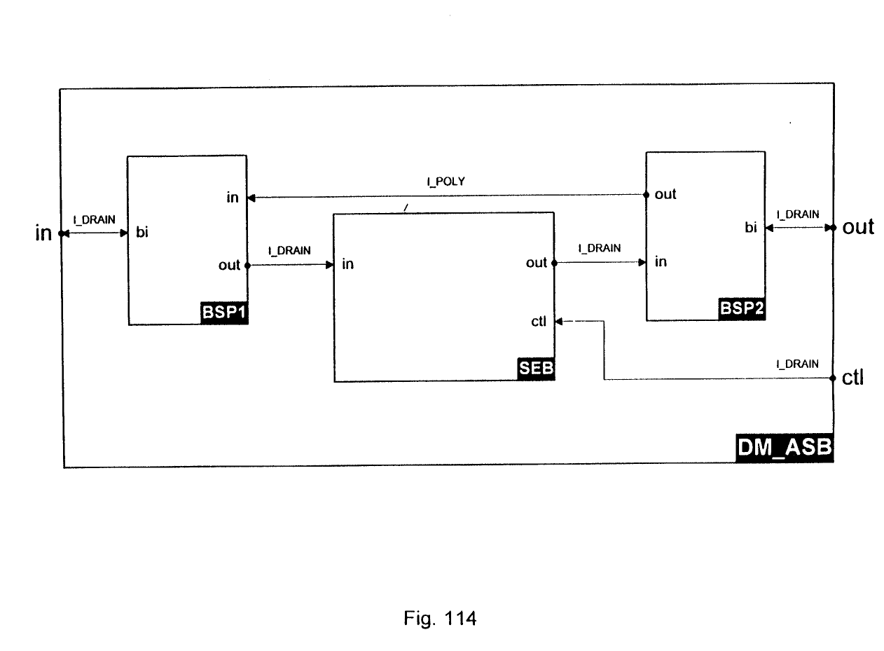

FIG. 114 illustrates the internal structure of the inventive DM_ASB part.

DM_ASB is a pure assembly and has no functionality of its own. Refer to the DM_SEB Data Sheet for a detailed functional overview of the event buffer.

19. Subordinate's Responsibilities

19.1. BSP—Bi-Directional Splitter

Split event flow between a single bi-directional interface and an input/output interface pair.

19.2. SEB—Synchronous Event Buffer

See the description of DM_SEB for a detailed functional overview of the event buffer.

DM_ASBR, DM_ASBR2—Asymmetrical Synchronous Buffer for Requests

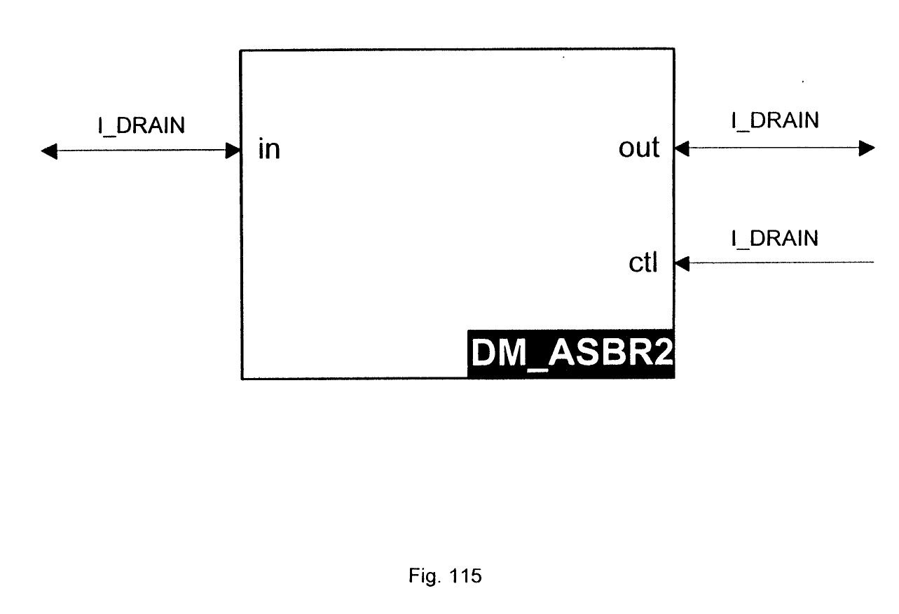

FIG. 115 illustrates the boundary of the inventive DM_ASBR2 part.

DM_ASBR/DM_ASBR2 are asymmetrical synchronous buffers for requests. Flow control is provided for requests moving in the forward direction (e.g., from in to out). The flow of events out of out can be disabled by sending EV_REQ_ENABLE and EV_REQ_DISABLE events to ctl. While disabled, requests sent to DM_ASBR/DM_ASBR2 in the forward direction are buffered until the output is re-enabled.

When DM_ASBR/DM_ASBR2 stores a request in self, it sends back status CMST_PENDING. This status notifies the sender of the request that the request will be completed later by sending the same request back with CMEVT_A COMPLETED attribute set.

DM_ASBR/DM_ASBR2 always completes the incoming requests with a completion event. If the part connected to out completes the event synchronously, DM_ASBR/DM_ASBR2 generates a completion event and returns CMST_PENDING.

DM_ASBR/DM_ASBR2 always use an incoming event—either from in or from ctl to send queued events to out.

All request completions sent in the reverse direction are immediately passed through without any buffering.

Note that DM_ASBR/DM_ASBR2 assumes without assertion that the CMEVT_A_ASYNC_CPLT bit is set on incoming events.

DM_ASBR2 should be used in all new designs. DM_ASBR does not comply with the proper event completion disipline and is provided only for compatibility for older projects.

20. Boundary

20.1. Terminals

Terminal “in” with direction “Bidir” and contract I_DRAIN. Note: Forward event I/O terminal.

Terminal “out” with direction “Bidir” and contract I_DRAIN. Note: Reverse event I/O terminal.

Terminal “ctl” with direction “In” and contract I_DRAIN. Note: Flow control. Accepts to EV_REQ_ENABLE and EV_REQ_DISABLE events in order to enable or disable the output.

20.2. Events and Notifications

The following events can be received on the ctl terminal:

| Incoming | | |
|---|---|---|
| Event | Bus | Notes |
| EV_REQ_ENABLE | CMEVENT_HDR | Changes the state of the |
| | | output to enabled. All |
| | | forward events are passed |
| | | through out. |
| EV_REQ_DISABLE | CMEVENT_HDR | Changes the state of the |
| | | output to disabled. All |
| | | forward events are buffered |
| | | on an internal queue |
| | | and not sent out. |

All events received on the in terminal are eventually forwarded to out. All events (typically request completions) received on the out terminal are immediately sent through the in terminal.

20.3. Special Events, Frames, Commands or Verbs

None.

20.4. Properties (DM_ASBR)

Property “reset_ev_id” of type “UINT32”. Note: Event ID that will reset DM_ASBR before the event is forwarded or buffered. Not available on DM_ASBR2. Default is EV_NULL.

Property “cplt_s_offs” of type “UINT32”. Note: Offset in bytes of the completion status in the event bus. Mandatory.

21. Encapsulated interactions

None.

22. Internal Definition (DM_ASBR2)

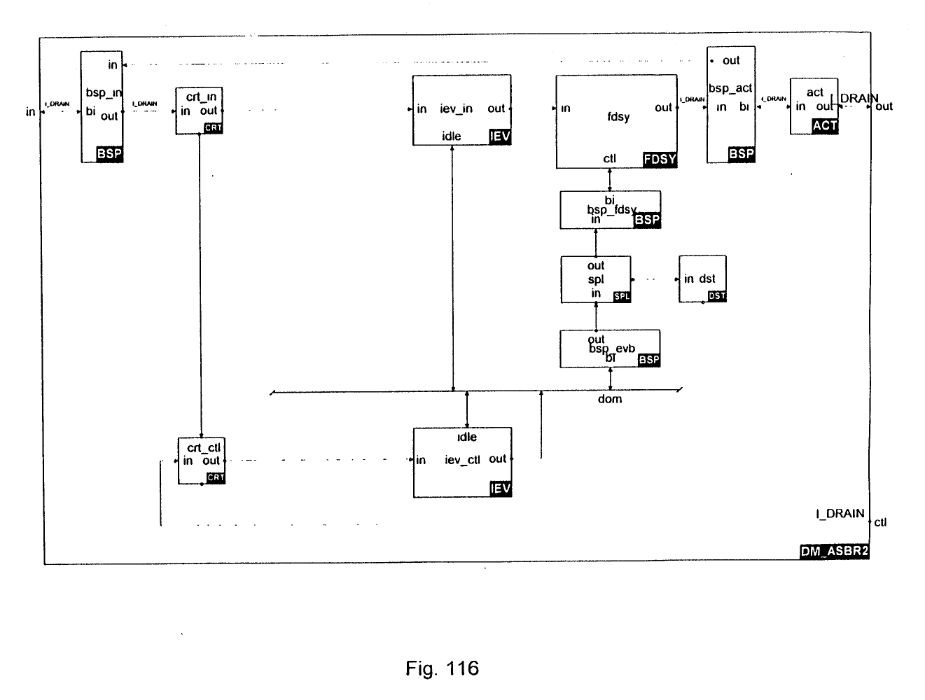

FIG. 116 illustrates the internal structure of the inventive DM_ASBR2 part.

DM_ASBR2 is an assembly that is built entirely out of DriverMagic library parts. It comprises a “Fundamental Desynchronizer” (FDSY), which provides the event queue for the assembly; two “Idle Generator Driven by Event” (IEVx) that provide idle events to dequeue events buffered in FDSY; a “Stackable Critical Section” (CRTx), which guards DM_ASBR2's inputs, since it has no input operations of its own; and an “Asynchronous Completer” (ACT) used to convert synchronous completions to asynchronous.

Events received at in pass through iev_in to be enqueued in FDSY. If an EV_REQ ENABLE event has been previously received at ctl, then iev_in will generate EV_IDLE events to the event bus, which is parameterized to send the event out its dom terminal first. FDSY receives the EV_IDLE event from the event bus and de-queues its events in response.

The output is disabled when an EV_REQ_DISABLE event is received at ctl. iev_ctl passes this event to the event bus, which in turn passes it to both iev_in and iev_ctl at their idle terminals, disabling them. Any future events received at in will pass through IEV1 to FDSY to be buffered as before, but no EV_IDLE events will be generated by iev_in or iev_ctl.

23. Subordinate's Responsibilities

23.1. DM_BSP—Bi-Directional Splitter

1. Split event flow between a single bidirectional interface and an input/output interface pair.

23.2. DM_ACT—Asynchronous Completer

1. Transform synchronous completion of an outgoing event into asynchronous completion.

23.3. DM_CRT—Stackable Critical Section

1. Provide a common critical section for all the inputs to the assembly. DM_ASBR2 is a pure assembly and has no guarded input operations of its own.

23.4. DM_IEV—Idle by Event

1. Generate EV IDLE events out its idle terminal in response to any event it receives on its in terminal, if enabled.

2. Provide the mechanism to enable and disable idle generation on EV_REQ_xxx events.

23.5. DM FDSY—Fundamental Desynchronizer

1. Implement an event desynchronizer which sends out queued events when it receives EV_IDLE or EV_PULSE on its control terminal.

2. Clear the event queue on receipt of an EV_RESET event

23.6. DM_SPL—Event Flow Splitter

1. Split the incoming event flow into a main flow and an auxilary flow.

23.7. DM_DST—Drain Stopper

1. Consume all events received on its terminal.

24. Dominant's Responsibilities

24.1. Hard parameterization of subordinates

| Subordinate | Property | Value |
|---|---|---|
| FDSY | ok_stat | CMST_PENDING |
| | disable_ctl_req | TRUE |
| SPL | ev_min | EV_REQ_ENABLE |
| | ev_max | EV_REQ_DISABLE |
| ACT | enforce_async | TRUE |
| EVB | sync | TRUE |
| | dom_first | TRUE |

24.2. Distribution of Properties to the Subordinates

Property “cplt_s_offs” of type “UINT32”. Note: redir act.cplt_s_offs

25. Theory of Operation

25.1. Mechanisms

Event Buffering

FDSY implements an event queue to buffer incoming events. Events buffered by FDSY will be sent out out when it receives EV_IDLE events. If the EV_IDLE events have been disabled, FDSY will simply add any incoming events to its queue.

Idle Generation

Both iev_in and iev_ctl are responsible for generating EV_IDLE events for DM_ASBR2. iev_in generates idle events in response to events received at DM_ASBR2's in terminal and iev_ctl generates idles events in response to the EV_REQ_ENABLE event being received at the ctl terminal. In either case, all EV_IDLE events are sent to the event bus for distribution. FDSY receives the EV_IDLE events from the bus and sends any enqueued events out DM_ASBR2's out terminal in response.

Idle Generation Control

Idle generation is enabled or disabled on EV_REQ_xxx events received at DM_ASBR2's ctl terminal. Both iev_in and iev_ctl must be parameterized to generate idle events after passing the input event through.

When DM_ASBR2's output is disabled, an EV_REQ_DISABLE event is received at ctl that passes through iev_ctl to the event bus where it is distributed to both iev_in and iev_ctl, disabling both. No subsequent idle generation can occur.

When an EV_REQ_ENABLE event is received at ctl, it is passed through iev_ctl to the event bus and is distributed to iev_in and iev_ctl's idle terminal, enabling both. When iev_ctl receives control back from the event bus, it generates EV_IDLE events until FDSY's queue is emptied and is shut off by FDSY. Any subsequent events received at DM_ASBR2's in terminal will be enqueued by FDSY and will start iev_in's EV_IDLE generator to dequeue the event just received by FDSY, effectively passing it through.

26. Functional Overview of the DM_ASBR Buffer

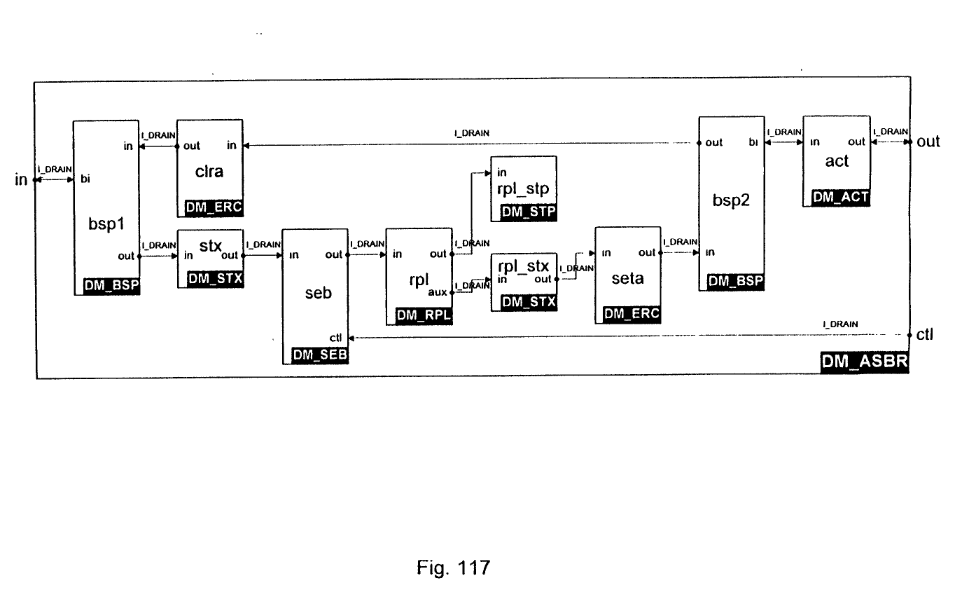

FIG. 117 illustrates the internal structure of the inventive DM_ASBR part.

Refer to the DM_SEB Data Sheet for a detailed functional overview of the event buffer.

27. Subordinate's Responsibilities

27.1. DM_BSP—Bi-Directional Splitter

Split event flow between a single bidirectional interface and an input/output interface pair.

27.2. DM_ACT—Asynchronous Completer

Transform synchronous completion of an outgoing event into asynchronous completion of the incoming event that generated the former.

27.3. DM_ERC—Event Recoder

Remap incoming event IDs and attributes and pass them out.

27.4. DM_STX—Status Recoreder

1. Re-code the event processing return status s1 (from the out terminal) to s2

2. Forward all events received from the in terminal through the out terminal.

27.5. DM_RPL—Event Replicator

1. Pass all events coming on in to out

2. Duplicate events coming on in and send the duplicates to aux.

28. Dominant's Responsibilities

28.1. Hard Parameterization of Subordinates

| Part | Property | Value |
|---|---|---|
| stx | s1 | CMST_OK |
| | s2 | CMST_PENDING |
| act | enforce_async | FALSE |
| seta | in_base | 0 |
| | out_base | 0 |
| | n_events | 0xFFFFFFFF |
| | or_attr | CMEVT_A_ASYNC_CPLT |
| | and_attr | ˜CMEVT_A_SELF_OWNED |
| clra | in_base | 0 |
| | out_base | 0 |
| | n_events | 0xFFFFFFFF |
| | or_attr | CMEVT_A_SELF_OWNED |
| | and_attr | ˜CMEVT_A_ASYNC_CPLT |
| rpl_stx | s1 | CMST_PENDING |
| | s2 | CMST_OK |
| rpl_stp | ret_s | CMST_OK |

28.2.

28.3. Distribution of Properties to the Subordinates

| Property | | | |
|---|---|---|---|
| Name | Type | Dist | To |
| reset_ev_id | UINT32 | redir | seb.reset_ev_id |
| cplt_s_offs | UINT32 | redir | act.cplt_s_offs |

Interaction Serializers

DM_ESL—Event Serializer

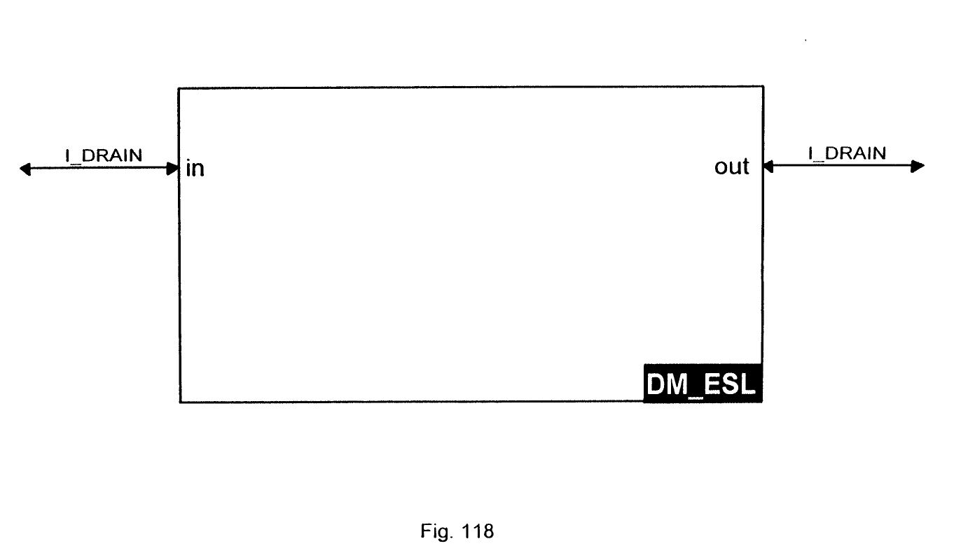

FIG. 118 illustrates the boundary of the inventive DM_ESL part.

DM_ESL serializes a flow of IRP events whenever these events are processed asynchronously. DM_ESL does not send the next event through its output until the processing of the preceding one is complete.

While asynchronous events sent through the out terminal are being processed, the events, coming at the in terminal, are buffered until the completion event arrives at the back channel of out.

In case the completion of the output event is synchronous, the next event from the buffer (if any) is sent to out immediately and the same procedure is commenced.

Effectively, DM_ESL ensures that there is only one event sent to the out terminal that awaits completion. In the meantime all incoming events are buffered for further processing.

Note: This part cannot be used (fed) with events that are not allowed to complete asynchronously. If necessary, insert an instance of DM_RSB at the front, which will effectively eliminate this limitation. For more information, refer to the DM_RSB data sheet.

1. Boundary

1.1. Terminals

Terminal “in” with direction “Plug” and contract I_DRAIN. Note: Incoming IRP events (EV_REQ_IRP). The back channel of this terminal is used for completion events only. Can be connected at Active Time.

Terminal “out” with direction “Plug” and contract I_DRAIN. Note: All events that are not processed are passed through here. The back channel receives the completion events (if completed asynchronously).

1.2. Events and Notifications Passed Through the “In” Terminal

| Incoming Event | Bus | Notes |
|---|---|---|
| EV_REQ_IRP | B_EV_IRP | Indicates that IRP |
| | | needs processing. |
| Outgoing Event | Bus | Notes |
| EV_REQ_IRP | B_EV_IRP | Indicates that IRP |
| | | processing has |
| | | completed. |
| | | This event is the |
| | | same event that was |
| | | processed |
| | | asynchronously with |
| | | CMEVT_A_COMPLETED |
| | | attribute set. |

1.3. Events and Notifications Passed Through the “Out” Terminal

| Outgoing Event | Bus | Notes |
|---|---|---|
| EV_REQ_IRP | B_EV_IRP | Indicates that IRP |
| | | needs processing. |

| Incoming Event | Bus | Notes |
|---|---|---|
| EV_REQ_IRP | B_EV_IRP | Indicates that IRP |
| | | processing has |
| | | completed. |
| | | This event usually is |
| | | the same event as (or |
| | | a copy of) the event |
| | | that was processed |
| | | asynchronously with |
| | | CMEVT_A_COMPLETED |
| | | attribute set. |

1.4. Special Events, Frames, Commands or Verbs

None.

1.5. Properties

None.

2. Encapsulated Interactions

DM_ESL is an assembly and does not have encapsulated interactions. Its subordinates, however, may have such depending on their implementation. For more information on the subordinates, please refer to the data sheets of:

DM_BSP

DM_STX

DM_ASB

DM_EPP

DM_ACT

3. Internal Definition

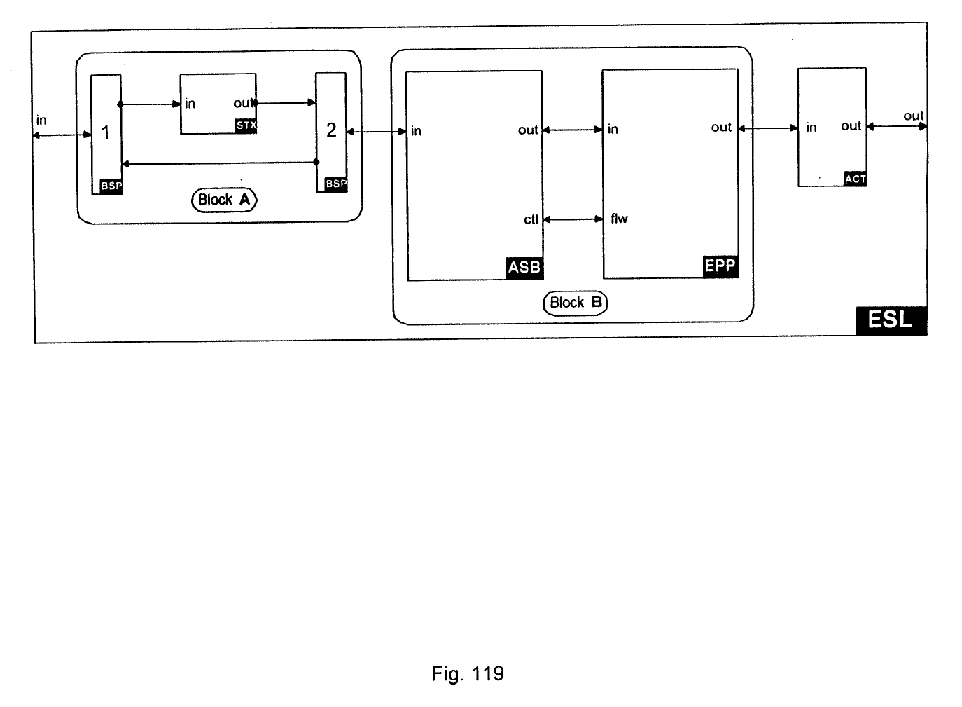

FIG. 119 illustrates the internal structure of the inventive DM_ESL part.

4. Theory of Operation

DM_ESL is an assembly. It contains an asynchronous event buffer (DM_ASB), Event Popper (DM_EPP) and Asynchronous Completer (DM_ACT).

The parts in Block B implement the main functionality in this assembly—event buffering and serialization on completion.

DM_EPP disables (shuts off) the event flow coming to its in terminal after passing an event to out and awaits for an event to come on the back channel, upon which it enables the input flow again.

This procedure when used in conjunction with DM_ASB (as shown above) ensures that incoming events are properly buffered during the processing of the event.

Parts in Block A and DM_ACT condition/transform the bidirectional event flow, to ensure that the whole assembly operates normally. DM_ACT transforms synchronously completed events on its out terminal into events completed asynchronously on the in terminal.

The purpose of Block A is to recode the event distribution status returned by the in terminal of DM_ASB into CMST_PENDING for the purposes of asynchronous event completion.

For more details on DM_ASB, DM_ACT and DM_EPP, refer to their data sheets.

4.1. Subordinate Parameterization

| Subordinate | Property | Value |
|---|---|---|
| STX | s1 | CMST_OK |
| | s2 | CMST_PENDING |
| ACT | cplt_s_offs | offsetof (B_EV_IRP, |
| | | cplt_s) |

DM_RSL—Request Serializer

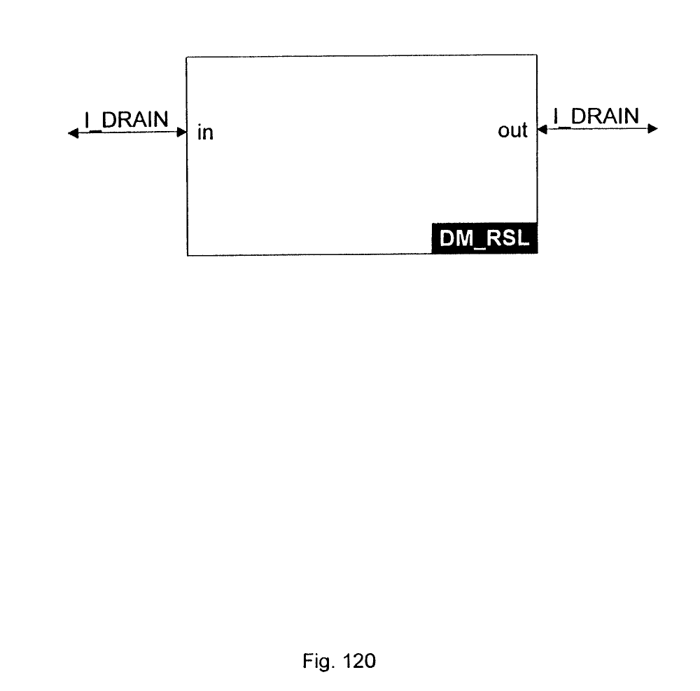

FIG. 120 illustrates the boundary of the inventive DM_RSL part.

DM_RSL is a serializer for asynchronous requests. It is used in cases where it is necessary to guarantee that a server of asynchronous requests is not going to receive a new request until it has completed the previous one.

DM_RSL is limited to serializing a single type of requests, the request type (event ID) that it accepts is programmable through a property. The inputs of DM_RSL are callable only in normal thread time. A caller's thread may be blocked if another thread has already entered the assembly. Since DM_RSL may call its outputs while its critical section is acquired, the possibility of deadlocks should be considered when using this part—see the Specification section below for details.

DM_RSL is an assembly made entirely of standard DriverMagic library parts, as shown on the diagram. It may be used in any operating environment supported by DriverMagic. The Specification section below describes in detail the operation of DM_RSL.

5. Boundary

5.1. Terminals

Terminal “in” with direction “i/o” and contract I_DRAIN. Note: Request input. Requests on this input may arrive in any order, whether or not previous requests have been completed. All requests sent to this input must have the event ID specified by the evt id property and must be desynchronizable—i.e., they should have the CMEVT_A_ASYNC_CPLT attribute set and should not be allocated on the stack. Note that a side effect of the operation of DM_RSY is that all requests submitted to in complete asynchronously.

Terminal “out” with direction “i/o” and contract I_DRAIN. Note: Serialized request output. Requests received from in are sent to out one by one, a second request is not sent until the previous one has completed.

5.2. Properties

Property “evt_id” of type “uint32”. Note: Specifies the value of the id field of the requests sent to in. Note that requests with a different ID or other events should not be sent to DM_RSL's in terminal. Default value: EV_REQ_IRP

Property “cplt_s_offs” of type “uint32”. Note: Specifies the offset in the request bus where the completion status is stored. Default value: offsetof(B_EV_IRP, cplt_s).

6. Encapsulated Interactions

None.

7. Specification

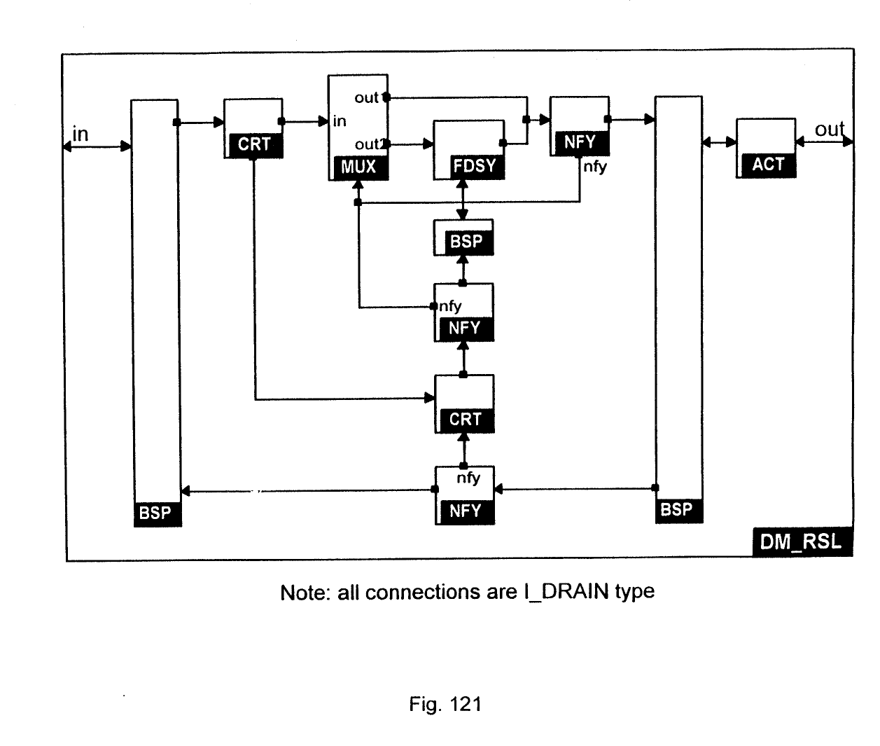

FIG. 121 illustrates the internal structure of the inventive DM_RSL part.

8. Responsibilities

Serialize asynchronous requests coming on the in terminal and forward them to out, so that a part attached to out does not receive more than one request at a time. Use a queue to store additional requests, while one is pending on the out terminal.

9. Theory of Operation

The state of DM_RSL is kept by the DM_MUX part:

ON state (this is the initial state)—DM_MUX has out1 enabled; this state represents tha case when there are no pending requests being processed by the part connected to DM_RSL's out terminal. A request that comes to in in this state is forwarded directly to out.

OFF state—DM_MUX has out2 enabled; this state represents the case when there is a pending request. In this state, new requests that come to in are queued by DM_RSL in the DM_FDSY part. The operation of DM_RSL is illustrated by the following two cases.

9.1. Case 1: Requests Come on the In Terminal in Sequence

The first request that enters DM_RSL comes when the assembly is in the ON state—the request bypasses the DM_FDSY queue and is forwarded to out. On its way it passes through the OFF event generator—DM_NFY, programmed to emit an EV_REQ_DISABLE event, which causes DM_MUX to switch to out2 (DM_RSL enters the OFF state).

The completion of the request goes through the “completed” event generator—DM_NFY, programmed to emit an EV_PULSE event after the request completion has been sent back to DM_RSL's in terminal. The EV_PULSE event goes first through the ON event generator that sends an EV_REQ_ENABLE to the DM_MUX, switching it back to the ON state, and then goes to the queue (DM_FDSY). Since there are no requests queued the latter has no effect.

Now DM_RSL has returned to its original state and can process the next incoming request in the same manner.

9.2. Case 2: New Requests Come on the In Terminal Before the First One has Completed

When the first request comes, the events that take place in DM_RSL are the same as described in the 15 step in Case 1 above.

When a second request comes on in before the first one has completed, DM_RSL is in its OFF state—DM_MUX has its out2 opened, so the incoming request is enqueued in DM_FDSY and CMST_PENDING is returned to the client.

If more requests come before the first one has completed, they are enqueued as well.

When the completion of the request comes on out (or is generated by DM_ACT), it goes through the “completed” event generator—DM_NFY, programmed to emit an EV_PULSE event after the request completion has been sent back to DM_RSL's in terminal. The EV PULSE event goes first through the ON event generator that sends an EV_REQ_ENABLE to the DM_MUX, switching it back to the ON state, and then goes to the queue (DM_FDSY). DM_FDSY dequeues one request and sends it out.

The dequeued request immediately switches DM_RSL back to its OFF state.

The above two steps are repeated until there are no more requests in the queue. The completion of the last request switches DM_RSL to its ON state, exactly as in step #2 of Case 1 above. DM_RSL remains in this state until new requests come to the in terminal.

9.3. Critical Section Guard in DM_RSL

The group of parts in DM_RSL that keeps its state (DM_MUX and DM_FDSY) is guarded by the two connected DM_CRT parts, which act as a single critical section that surrounds this group. This is done to guarantee that the sequence of execution is always going to be as described in the two cases above, even if a second thread of execution enters DM_RSL.

Note that the thread of execution that goes to the out terminal always owns DM_RSL's critical section. DM_RSL calls out in the following two different situations, in both cases within its critical section:

with a request that came on in while DM_RSL was in the ON state

with a dequeued request when called on out with the completion of the previous request—in this case the part connected to out is re-entered in the same thread of execution that it used to send the previous reqeust's completion.

A request completion coming on out is forwarded to in first without entering DM_RSL's guard—see diagram. However, DM_RSL may call back in with a request completion while its guard is acquired if that completion happens in the thread of the original request (e.g., if the completion is generated by DM_ACT).

10. Subordinate Parameterization

| Subordinate | Property | Value |
|---|---|---|
| mux | ev_out1 | EV_REQ_ENABLE |
| (DM_MUX) | ev_out2 | EV_REQ_DISABLE |
| que | disable_ctl_req | TRUE |
| (DM_FDSY) | | |
| | ok_stat | CMST_PENDING |
| off | trigger_ev | EV_REQ_IRP |
| (DM_NFY) | | |
| | pre_ev | DM_REQ_DISABLE |
| on | trigger_ev | EV_PULSE |
| (DM_NFY) | | |
| | pre_ev | DM_REQ_ENABLE |
| cplt | trigger_ev | EV_REQ_IRP |
| (DM_NFY) | | |
| | post_ev | EV_PULSE |
| act | cplt_s_offs | offsetof(B_EV_IRP, |
| (DM_ACT) | | cplt_s) |

DM_EPP—Event Popper

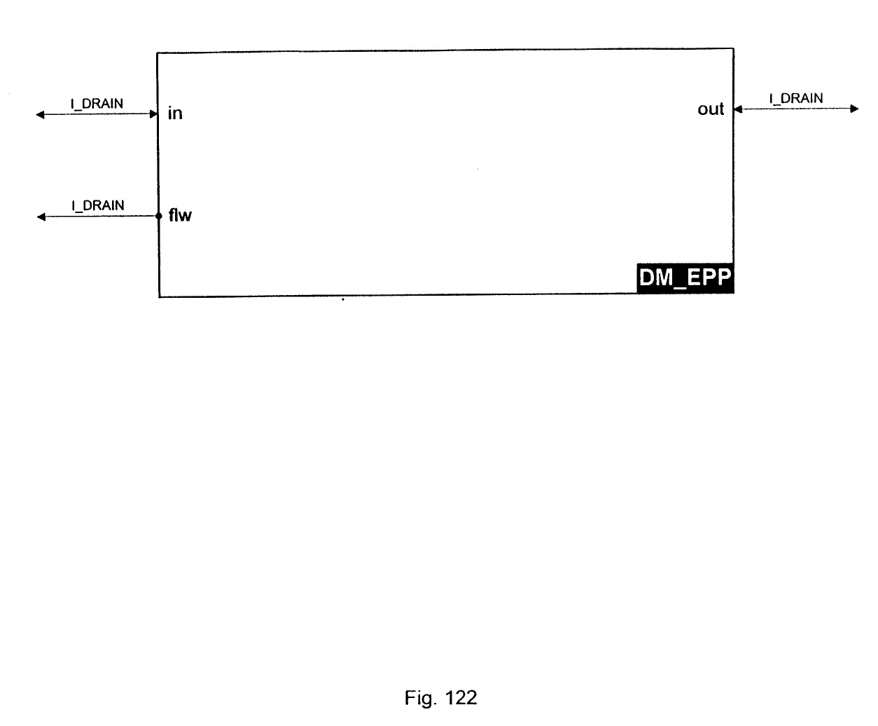

FIG. 122 illustrates the boundary of the inventive DM_EPP part.

DM_EPP is an IRP event popper. It uses an external flow control to disable and enable the incoming flow of events, so that there is only one IRP event, which awaits completion.

DM_EPP expects that all events sent through out will complete asynchronously. Naturally, DM_EPP also expects that the incoming events will be allowed to complete asynchronously. If any of these conditions are not satisfied, the proper operation of DM_EPP cannot be guaranteed³. ³ This is not a serious limitation. Inserting DM_RSB and connecting its output to the in terminal will guarantee that asynchronous completion of the events is allowed; connecting DM_ACT to out will ensure that all events complete asynchronously.

DM_EPP sends requests to enable or disable the event flow through the flw terminal and expects that the part connected there will always succeed to do that

11. Boundary

11.1. Terminals

Terminal “in” with direction “Plug” and contract I_DRAIN. Note: Incoming IRP events (EV_REQ_IRP). The back channel of this terminal is used for completion events only. Can be connected at Active Time.

Terminal “out” with direction “Plug” and contract I_DRAIN. Note: All events that are not processed are passed through here. The back channel receives the completion events (if completed asynchronously).

11.2. Events and Notifications Passed Through the “In” Terminal

| | Bus | Notes |
|---|---|---|
| Incoming Event | | |
| EV_REQ_IRP | B_EV_IRP | Indicates that IRP |
| | | needs processing. |
| Outgoing Event | | |
| EV_REQ_IRP | B_EV_IRP | Indicates that IRP |
| | | processing has |
| | | completed. |
| | | This event is the |
| | | same event that was |
| | | processed |
| | | asynchronously with |
| | | CMEVT_A_COMPLETED |
| | | attribute set. |

11.3. Events and Notifications Passed Through the “Out” Terminal

| Outgoing Event | Bus | Notes |
|---|---|---|
| EV_REQ_IRP | B_EV_IRP | Indicates that IRP |
| | | needs processing. |

| Incoming Event | Bus | Notes |
|---|---|---|
| EV_REQ_IRP | B_EV_IRP | Indicates that IRP |
| | | processing has |
| | | completed. |
| | | This event usually is |
| | | the same event as (or |
| | | a copy of) the event |
| | | that was processed |
| | | asynchronously with |
| | | CMEVT_A_COMPLETED |
| | | attribute set. |

11.4. Special Events, Frames, Commands or Verbs

None.

11.5. Properties

None.

12. Encapsulated Interactions

DM_EPP is an assembly and does not have encapsulated interactions. Its subordinates, however, may have such depending on their implementation. For more information on the subordinates, please refer to the data sheets of:

DM_BSP

DM_STX

DM_ASB

DM_EPP

DM_ACT

13. Internal Definition

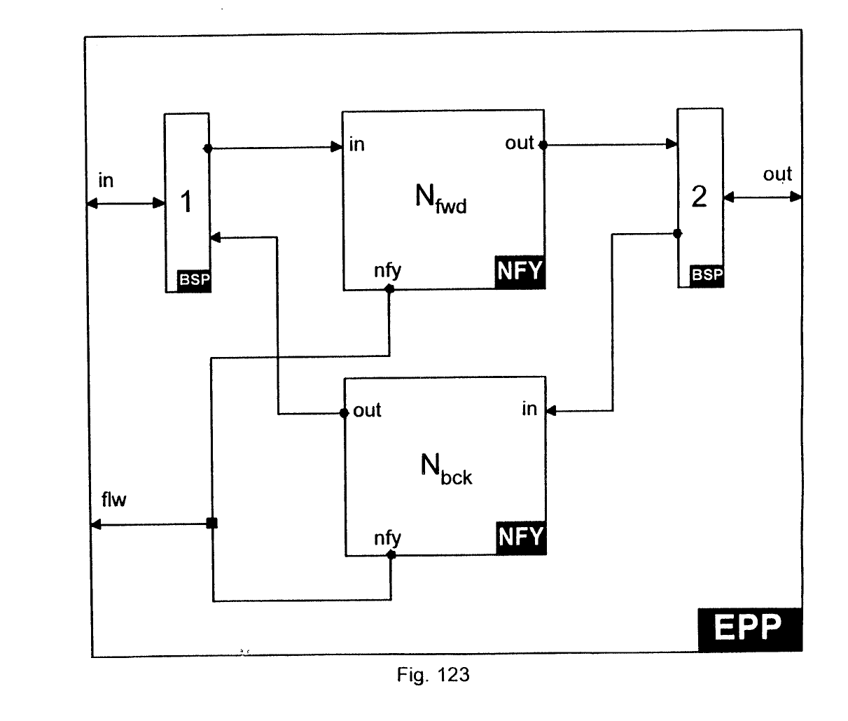

FIG. 123 illustrates the internal structure of the inventive DM_EPP part.

14. Theory of Operation

DM_EPP is an assembly. It is based on parts included in the Advanced Part Library (APL). DM_EPP implements its functionality using two Notifiers (DM_NFY) connected as shown on the diagram. The notifiers are parameterized to issue EV_REQ_DISABLE/EV_REQ_ENABLE before (N_{fwd}) or after (N_{bck}) event is received.

Each IRP event going in the forward direction causes N_{fwd} to issue EV_REQ_DISABLE before the event is forwarded out.

This in turn disables the input flow until a completion event comes through the back channel of out terminal. The completion event will cause N_{bck} to issue EV_REQ_ENABLE after it passes it back to in.

15. Subordinate Parameterization

| Subordinate | Property | Value |
|---|---|---|
| N_{fwd} | trigger_ev | EV_REQ_IRP |
| | pre_ev | EV_REQ_DISABLE |
| N_{bck} | trigger_ev | EV_REQ_IRP |
| | post_ev | EV_REQ_DISABLE |

16. Use Cases

16.1. IRP Event Comes In

The IRP event arrives at the in terminal, which is forwarded to the splitter 1. Splitter1 forwards it to N_{fwd}, which issues EV_REQ_DISABLE before it passes the event out. EV_REQ_DISABLE is forwarded out through flw terminal, which in turn disables the input flow.

N_{fwd} finally sends the event out, which passing through splitter 2 is sent out through the out terminal. At this point DM_EPP expects that the event will be completed asynchronously and will wait for a completion event to come through the back channel if out.

16.2. Completion Event Comes In

When the completion event comes through the back channel of out terminal (even within the output operation to the out terminal), splitter 2 forwards it to N_{bck}.

N_{bck} first sends it out through the back channel of in terminal (passing splitter 1) and then issues EV_REQ_ENABLE, which gets forwarded out through the flw terminal. This last action restores the state of the input event flow.

Property Space Suport

Property Exposers

DM_PEX—Property Exposer

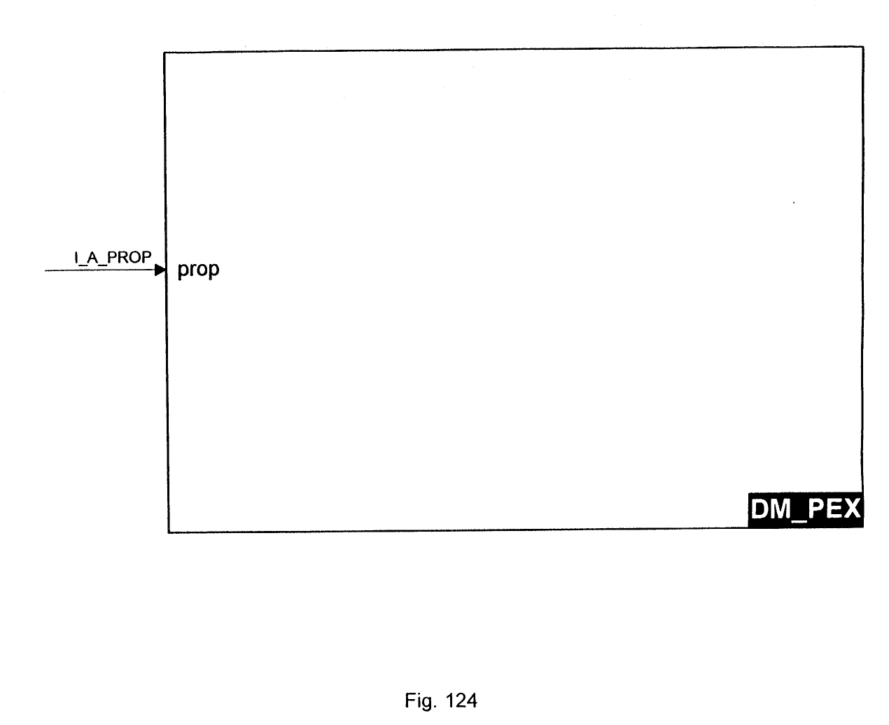

FIG. 124 illustrates the boundary of the inventive DM_PEX part.

DM_PEX is a part that can be used to manipulate properties of the assembly it is included into. DM_PEX allows properties of the assembly to be manipulated through its prop terminal, making it convenient.

DM_PEX does not have state. It redirects all the operations it implements to the assembly that contains it.

1. Boundary

1.1. Terminals

Terminal “prop” with direction “In” and contract I_A_PROP. Note: Direct access to properties of the assembly by name. The entity id is not used and must be 0.

1.2. Events and Notifications

None.

1.3. Special Events, Frames, Commands or Verbs

None.

1.4. Properties

None.

2. Encapsulated Interactions

None.

3. Specification

4. Responsibilities

23. Implement interface for manipulation of assembly's properties.

5. Theory of Operation

None.

5.1. State Machine

None.

5.2. Main Data Structures

None.

5.3. Mechanisms

Accessing Properties of the Host Assembly

Most parts don't need to know the OID of their host assembly (host, or parent assembly is the assembly in which a given part is created as subordinate).

DM_PEX needs to operate on its host assembly. DM_PEX identifies itself as part that has such need either by calling an API function or by placing a specific value in its part descriptor.

DM_PEX can access the properties of the host assembly by using any mechanism. Two possible mechanisms are described below:

1. DM_PEX can obtain the OID of its host assembly by calling an API function and then use the standard cm_prp_get and cm_prp_set, etc., property API functions.

DM_PEX can obtain an internal, private interface to the host assembly. That private interface provides at least the property operations needed by DM_PEX.

Property Containers

DM_VPC—Virtual Property Container

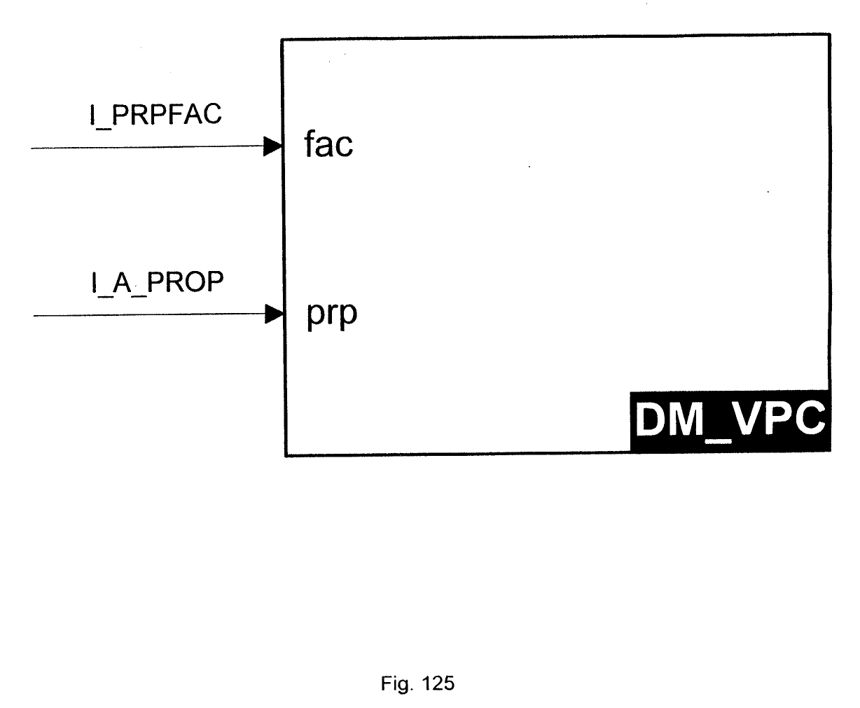

FIG. 125 illustrates the boundary of the inventive DM_VPC part.

DM_VPC is a property container that provides storage and standard property services for virtual (dynamic) properties.

DM_VPC implements all of the operations specified in the I_A_PROP interface and imposes the restriction that there be only one open property query at a time.

DM_VPC provides support all of the standard DriverMagic property types and has no self-imposed restriction as to the size of the property value, provided there is enough system memory.

1. Boundary

1.1. Terminals

| Name | Dir | Contract | Notes |
|---|---|---|---|
| fac | In | I_PRPFA | v-table, infinite cardinality, |
| | | C | synchronous |
| | | | This terminal is used to |
| | | | create, destroy, and |
| | | | reinitialize virtual properties. |
| prp | In | I_A_PROP | v-table, infinite cardinality, |
| | | P | synchronous |
| | | | This terminal is used to get, |
| | | | set, check and enumerate |
| | | | virtual properties in the |
| | | | container. |

1.2. Events and Notifications

None.

1.3. Special Events, Frames, Commands or Verbs

None.

1.4. Properties

Property “max_container_sz” of type “UINT32”. Note: Specifies the maximum number of properties to store in the container. Set to 0 to indicate no limit. Default: 64

2. Encapsulated Interactions

None.

3. Specification

4. Responsibilities

24. Maintain dynamic property container for virtual properties.

25. Provide property factory services on the property container.

26. Provide standard property operations for properties stored in the property container.

5. Theory of Operation

5.1. Main Data Structures

Property Container

DM_VPC uses the ClassMagic handle manager services to implement its property container. With each handle, DM_VPC stores a pointer to a virtual property structure as context. Each virtual property structure contains information about a particular property.

5.2. Mechanisms

Creating and Destroying Properties

When DM_VPC receives a request to create a new property, it first searches the container to ensure that the property doesn't already exist. DM_VPC then creates a virtual property structure for the property, creates a handle and stores a pointer to the structure as a context.

When DM_VPC receives a request to destroy a single property, it finds the property in the property container, frees the virtual property structure, and frees the handle. If the destroy operation specifies that all properties are to be destroyed, DM VPC enumerates the property container, freeing each virtual property structure and handle.

DM_REP—Hierarchical Repository

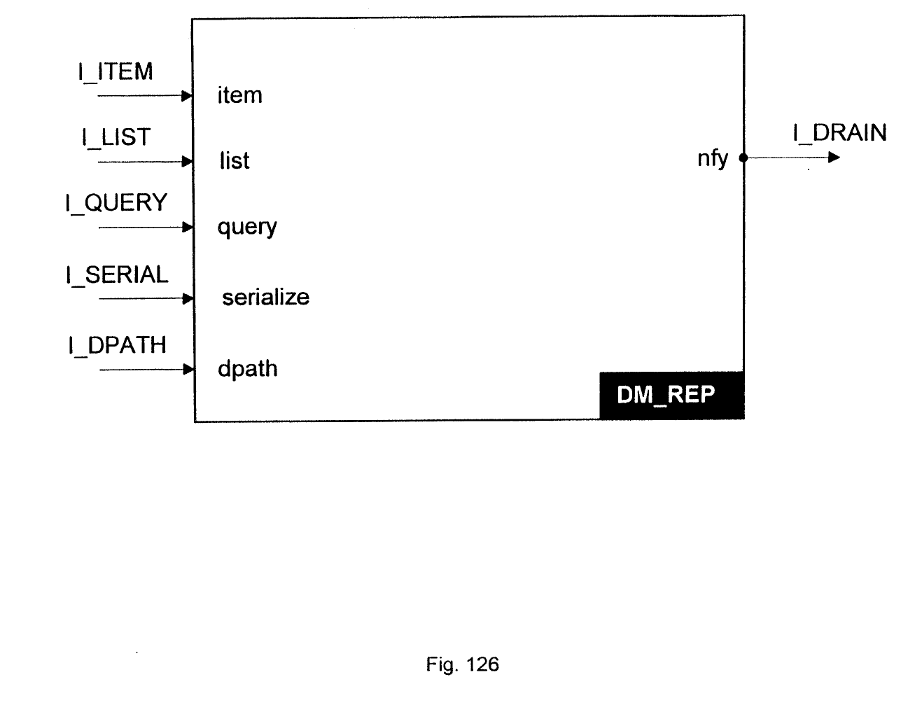

FIG. 126 illustrates the boundary of the inventive DM_REP part.

DM_REP is a hierarchical repository with notifications. It implements a hierarchical data storage in memory. The repository provides functionality to store, query and retrieve data by hierarchical “data paths”. The data paths are strings of up to 256 characters, which are constructed using identifiers and array indices (the terms used as defined by the C programming language). Both identifiers and indices are referred to as “pets”—short for “path element”.

Data paths are constructed using no more than 16 pels, i.e. the total number of identifiers and indices in a valid data path cannot exceed 16. Each data path corresponds to a piece of data (data element) with a variable size. This data can be stored and retrieved through DM_REP terminals item and list.

DM_REP does not have a notion of data types; it supports variable size binary data only. However, for each data element, DM_REP provides a 32-bit external context that can be manipulated in parallel with the data. This context is frequently used to store and retrieve identification of the actual data type.

DM_REP supports queries on the data paths (query terminal). The query criteria are defined using query strings. DM_REP supports up to 16 general queries simultaneously.

DM_REP supports serialization of the repository data to a binary file or the system registry (serialize terminal). It also supports deserialization from a binary file, system registry or INI file.

DM_REP also provides an interface for data path manipulation (dpath terminal). This allows data paths to be joined together or split apart into “pets”.

DM_REP generates notifications when a data item is changed, added or deleted. All notifications are sent out through the nfy terminal. The notifications are sent with an event that describes which data path was affected.

This part is available only in Win32 User Mode environment.

6. Boundary

6.1. Terminals

Terminal “item” with direction “In” and contract I_ITEM. Note: v-table, infinite cardinality, active-time, synchronous. Repository data item manipulation.

Terminal “list” with direction “In” and contract I_LIST. Note: v-table, infinite cardinality, active-time, synchronous. Repository data list manipulation.

Terminal “query” with direction “In” and contract I_QUERY. Note: v-table, infinite cardinality, active-time, synchronous. Repository path queries.

Terminal “serialize” with direction “In” and contract I_SERIAL. Note: v-table, infinite cardinality, active-time, synchronous. Repository serialization.

Terminal “dpath” with direction “In” and contract I_DPATH. Note: v-table, infinite cardinality, active-time, synchronous. Repository path manipulation.

Terminal “nfy” with direction “Out” and contract I_DRAIN. Note: v-table, cardinality 1, floating, synchronous. All notifications from the repository are sent out through this terminal.

6.2. Events and Notifications

No incoming events.

| Outgoing Event | Bus | Notes |
|---|---|---|
| EV_REP_NFY_DATA_{—} | EV_REP | This event is sent |
| CHANGE | | out through the nfy |
| | | terminal when a |
| | | data item is |
| | | changed, added, or |
| | | deleted. |

6.3. Special Events, Frames, Commands or Verbs

None.

6.4. Properties

None.

7. Encapsulated Interactions

None.

8. Specification

9. Responsibilities

1. Provide functionality for data storage and retrieval through item and list terminals.

2. Provide functionality for queries on the data path namespace.

3. Provide functionality for serialization of the repository to a file or the registry.

4. Provide functionality for deserialization of the repository from a file, registry, or INI file.

5. Provide functionality for data path manipulation.

6. Generate notifications through the nfy terminal when a data item is changed, added, or deleted.

10. Theory of Operation

10.1. Data Path Syntax

The data path syntax is very similar to the syntax for specifying data structures in programming languages like C. Here are a few examples of typical data paths:

customer[1].name

Sensor.Value

matrix[1][2][3]

10.2. INI File Structure (Deserialization)

Here is the INI file structure expected on deserialization of the repository:

<data path>=<context>[:{<data>|<fileref>}]

The expression on the right side of the equal sign can be continued on a new line by placing backslash (\) on the incomplete line (like in C preprocessor).

Here are somewhat informal definitions of the items above:

<data>::=<datum>[, <data>]

<datum>::={\[-]<number>[L|S|B]|“<text>”|‘text’}

<fileref>::=@<filename>

<context>::=<number>

<number>::=<dec>|0x<hex>|0<oct>

Here is an example of an INI file demonstrating the syntax:

| | |
|---|---|
| [rep_data] | |
| image.name | = 1: “Sample” |

| | |
|---|---|
| image.author | = 2: ‘John Doe’ |
| image.size.x | = 3: 640 |
| image.size.y | = 4: 480 |

| | |
|---|---|
| cast[O] | = 5: @ c:\external.dat |

| | |
|---|---|
| cast[O].alias | = 6: “Conan” |
| cast[O].type | = Ox7f: ‘Barbarian’ |
| cast[O].data | = 1: −2S, 24L, 255B, ‘a text’, \ |

“More text”

Here are the possible data types for numbers. If type is not explicitly specified with a suffix, the repository automatically assigns the smallest data type in which the value fits. Supported number suffixes:

S=Short (16 bit)

L=Long (32 bit)

B=Byte (8 bit)

The difference between strings with single quotes and strings with double quotes is that for double-quoted strings, the repository automatically includes a 0 to terminate the string. Single-quoted strings are stored as is, with the exact length and no terminator. To illustrate, the following two paths will contains the same values, of 5 bytes each:

customer[0].name=1: “Name”

customer[1].name=1: ‘Name’, 0

Finally, the <context> value in front of the colon sign is the value that will be associated with the data item. It can be obtained together with the item, using the I_ITEM interface.

10.3. Binary File Structure

The following is the binary structure of the DM_REP serialized image:

The header and footer signatures are as follows:

Header: Object Repository Data Format Version 2.0\r\n\x1a

Footer: \r\n[end]\r\n\x1a

10.4. Mechanisms

Data Storage/Retrieval Through I_ITEM Interface

Through the item terminal, single data paths are retrieved, set and deleted from the repository. The operations supported by item are get, set and remove.

The get operation retrieves the current value of the data path. The set operation sets the value of a data path. If the data path doesn't exist in the repository when setting data, it is created. The remove operation deletes the data item from the repository.

The data path is either absolute or relative to a current item in a specified query.

All changes generate notifications through nfy.

Data storage/Retrieval Through LIST Interface

Through the list terminal, elements of data arrays are added to and removed from the repository. The operations supported are add and remove.

DM_REP maintains arrays of data paths. The array consists of one or more data path names and indexes (e.g., customer[1], customer[1].name, customer[1].phone[0], etc.) When adding a new element to the array, the caller specifies only the base name (e.g., customer or customer[1].phone). DM_REP chooses the next available index for the data path. The data path is constructed by DM_REP and returned to the caller for later reference.

It is possible for a data array to have missing elements. When an element is deleted, it is marked as available. Eventually through addition of new elements, the previously deleted elements are reused.

The index range supported by the repository is 0 to 16383.

The data path is either absolute or relative to a current item in a specified query.

All changes to a data path or its value will generate a data change notification through nfy. Unlike I_ITEM, when a data array item is removed, any items that are within its subtree are also removed.

Queries on the Data Path Namespace

DM_REP provides a way to query the data path namespace of the repository. The data path namespace consists of all the existing data paths in the repository (single items and arrays).

DM_REP supports up to 16 data path queries simultaneously. The query criteria is defined with query strings constructed by the following rules:

1. Single question mark can replace a single path element (e.g. “a.?.b”)

2. Asterisk can replace zero or more path elements (e.g. “a.*”)

3. There cannot be more than one asterisk in the query string (e.g. “*.*” is to wrong)

4. Asterisk must be the last path element (e.g. “*.?”, “a.*.b” are wrong)

The query terminal is used to execute queries on the data path namespace. A query must first be opened using the open operation. DM_REP supports a full set of query operations including get_first, get_next, get_prev, get_last, and get_curr.

Serialization/Deserialization of the Repository

DM_REP allows serialization of the repository to a binary file or the system registry. DM_REP allows deserialization of the repository from a binary file, system registry or an INI file.

Data Item Notifications

DM_REP will generate events which are notifications that a data item was changed, added or deleted. This notification is called EV_REP_NFY_DATA_CHANGE. This notification is sent out of the nfy terminal.

The notification describes which data path was affected. Notifications are issued when a data path value is changed, or a data path is added or deleted to/from the repository.

The event that comes out through nfy can be distributed either synchronously or asynchronously. The event is self-owned and self-contained. Note that recipients of the event may need to free it; see I_DRAIN and CMEVENT_HDR for details.

10.5. Use Cases

Working With the Repository

1. A new repository is created or is loaded from secondary storage using DM_REP's serialize terminal.

2. The user adds/deletes data items or data item arrays using DM_REP's item and list terminals.

3. The repository may be saved to secondary storage using DM_REP's serialize terminal.

Querying the Repository

1. A new repository is created or is loaded from secondary storage using DM_REP's serialize terminal.

2. The user adds/deletes data items or data item arrays using DM_REP's item and list terminals.

3. The user opens a new query on the repository.

4. The data items are enumerated using DM_REP's query terminal (get_first, get_next, get_last, get_prev, get_curr). The data items matching the query are returned by the operations.

5. The user closes the query on the repository.

6. The repository may be saved to secondary storage using DM_REP's serialize terminal.

Receiving Repository Notifications

1. A new repository is created or is loaded from secondary storage using DM_REP's serialize terminal.

2. The user adds/deletes data items or data item arrays using DM_REP's item and list terminals.

3. For each change made in the previous step, the repository sends an EV_REP_NFY_DATA_CHANGE notification sent out through its nfy terminal (if connected), along with an event data describing the event and which data path was affected.

The recipient may check the data path and perform any operations it needs; at the end it frees the event (if the CMEVT_A_SELF_OWNED attribute is set). See EV_REP for details on the notification data.

Parameterizers

DM_PRM—Parameterizer (From Registry)

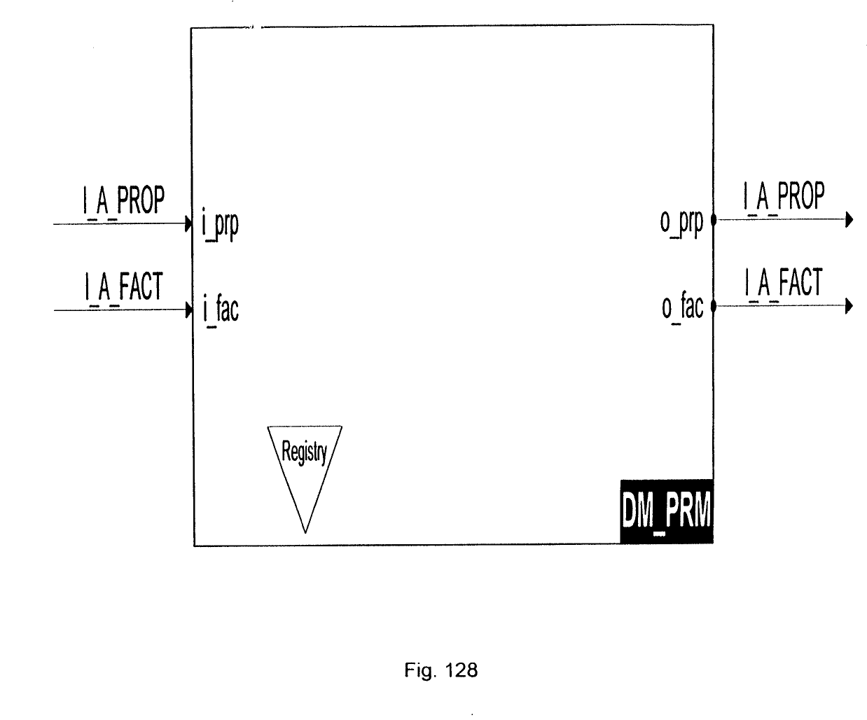

FIG. 128 illustrates the boundary of the inventive DM_PRM part.

DM_PRM is a generic Registry-based parameterizer. This part can be used for parameterizing part instances in part arrays.

This part is available only in Windows NT/95/98 Kernel Mode environments.

Deserialization of the properties from the registry is triggered when the property with a particular name (specified by the reg_prop_name property on DM_PRM) is set through terminal i_prp. The “trigger” property is expected to be of type CMPRP_T_UNICODEZ for Windows NT and CMPRP_T_ASCIZ for Windows 95/98 Kernel Modes. The value of the 'trigger” property is the actual path from which the deserialization is performed.

All other property operations on the i_prp input are passed unchanged to o_prp. This allows DM_PRM to be inserted between two parts connected through an I_A_PROP interface. DM_PRM transparently passes all operations on its i_fac input to o_fac as well.

The event that triggers DM_PRM to begin serialization is a successful deactivation of a part performed through o_fac terminal. On this event DM_PRM updates the registry.

1. Boundary

1.1. Terminals

Terminal “i_prp” with direction “In” and contract I_A_PROP. Note: Input part array property interface. All operations are passed transparently to o_prp.

Terminal “o_prp” with direction “Out” and contract I_A_PROP. Note: All property operations on the i_prp input are passed transparently to this output.

Terminal “i_c” with direction “In” and contract I_A_FACT. Note: Input part array factory interface. All operations are passed transparently to o_fac.

Terminal “o_fac” with direction “Out” and contract I_A_FACT. Note: Calls to i_fac are passed to this output. DM_PRM assumes that the array that is connected to this output is the same as the one connected to the o_prp output. This output may remain unconnected if i_fac terminal is not connected (floating).

1.2. Events and Notifications

None.

1.3. Special Events, Frames, Commands or Verbs

None

1.4. Properties

Property “reg_prop_name” of type “ASCIZ”. Note: Name of property to monitor on i_prp.set operations. The default value is “reg_root”

Property “reg_hive” of type “UINT32”. Note: A registry key to use as the root for all registry operations. The default value is NULL (absolute) for Windows NT and HKEY_LOCAL_MACHINE for Windows 95198 Kernel Mode environments.

Property “enforce_out_prop” of type “UINT32”. Note: Ensure that the o_prp.set operation on the property specified by reg_prop_name is successful. The default value is FALSE.

Property “reg_path_suffix” of type “UNICODE”. Note: Sub-path to be added to value set on reg_prop_name when reading/setting values in the registry. This value is also removed from the property value when a i_prp.get operation is invoked for the property specified by reg_prop_name. The default value is “ ”.

Property “serialize” of type “UINT32”. Note: Serialize properties when I_A_FACT.deactivate received. The default value is FALSE.

Property “ser_query” of type “ASCIZ”. Note: Query string to use when serializing properties. The default value is “*”.

Property “ser_attr_mask” of type “UINT32”. Note: Attribute mask to use when performing query operation to serialize properties. The default value is CMPRP_A_PERSIST.

Property “ser_attr_val” of type “UINT32”. Note: Attribute value to use when performing query operation to serialize properties. The default value is CMPRP_A_PERSIST.

Property “ser_existing_only” of type “UINT32”. Note: Serialize only those properties that already exist in the registry. The default value is FALSE.

Property “buf_sz” of type “UINT32”. Note: Initial size [in bytes] of buffer to allocate for reading values from the registry. The default value is 512 bytes. This value is treated as a lower limit—DM_PRM may round it up and allocate more memory if the given value is too small.

Property “buf_realloc” of type “UINT32”. Note: Reallocate buffer if it becomes too small. The default value is TRUE.

2. Encapsulated Interactions

DM_PRM uses the Windows NT/95/98 Kernel Mode Registry API.

3. Specification

4. Responsibilities

1. Deserialize properties when the property specified by reg_prop_name is set through DM_PRM's i_prp input.

2. Serialize properties after a successful o_fac.deactivate call if serialization is enabled.

3. Map or convert between registry data types and ClassMagic property value types.

4. Pass all operations from i_prp to o_prp.

5. Pass all operations from i_fac to o_fac.

5. Theory of Operation

5.1. State Machine

None.

5.2. Main Data Structures

None.

5.3. Mechanisms

Deserialization of Properties

When DM_PRM receives a call on its i prp.set operation, it checks if the property being set matches the name specified by its reg_prop_name property. If the property matches, DM_PRM forms a registry path from the property value and its reg_path_suffix property. DM_PRM opens the registry key; enumerates its values, and for each value found, validates that the property types are compatible between ClassMagic and the registry, and invokes its o_prp.set output if the types are compatible. If the property types are not compatible, DM_PRM logs an error message and does not set the property. When all values have been enumerated, DM_PRM then forwards the original i_prp.set operation with the added suffix, to its o_prp output.

The following table describes the valid ClassMagic property type for each registry type in Windows NT Kernel Mode environment:

| | Valid ClassMagic Property |
|---|---|
| Registry Type | type(s) |
| REG_DWORD or | CMPRP_T_UINT32 or |
| REG_DWORD_LITTLE_{—} | CMPRP_T_SINT32 |
| ENDIAN | |
| REG_SZ or | CMPRP_T_ASCIZ or |
| REG_EXPAND_SZ | CMPRP_T_UNICODEZ |
| REG_DWORD_BIG_ENDIAN | CMPRP_T_BINARY |
| REG_BINARY | CMPRP_T_MBCSZ, |
| | CMPRP_T_BINARY, |
| | CMPRP_T_UCHAR |
| REG_MULTI_SZ, | CMPRP_T_BINARY |
| REG_LINK, or | |
| REG_RESOURCE_LIST | |

The same for Windows 95/98 Kernel Mode environment:

| | Valid ClassMagic Property |
|---|---|
| Registry Type | type(s) |
| REG_DWORD or | CMPRP_T_UINT32 or |
| REG_DWORD_LITTLE_ENDIAN | CMPRP_T_SINT32 |
| REG_SZ or REG_EXPAND_SZ | CMPRP_T_ASCIZ |
| REG_DWORD_BIG_ENDIAN | CMPRP_T_BINARY |
| REG_BINARY | CMPRP_T_UNICODEZ, |
| | CMPRP_T_MBCSZ, |
| | CMPRP_T_BINARY, |
| | CMPRP_T_UCHAR |
| REG_MULTI_SZ, REG_LINK, | CMPRP_T_BINARY |
| or REG_RESOURCE_LIST | |

Serialization of Properties

When DM_PRM receives a call on its i_fac.deactivate operation, it first forwards the call out its o fac output. If the call is successful and DM_PRM's serialize property has been set to TRUE, DM_PRM calls o_prp.get with its reg_prop_name property to retrieve the Registry path that was set. It then opens the Registry key and opens a query on its o_prp output based upon its ser_query, ser_attr_mask, and ser_attr_val properties.

For each property that is returned, DM_PRM first validates that the types are compatible between ClassMagic and the Registry. If the types are compatible, DM_PRM saves the value in the registry using the current registry type. If the types are not compatible, DM_PRM logs an error message, and saves the value in the registry with a preferred type based upon the property value. The table below describes the valid registry types, and the preferred registry type for each ClassMagic type. If the property does not currently exist in the registry, DM_PRM saves the value with the preferred registry type.

If DM_PRM's ser_existing_only property is set to TRUE, DM_PRM will save only those properties that currently exist in the Registry. The mapping between property types is described in the following tables.

For Windows NT Kernel Mode environment:

| ClassMagic | | Preferred |
|---|---|---|
| Type | Valid Registry Types | Registry Type |
| CMPRP_T_UINT | REG_DWORD or | REG_DWORD |
| 32 or | REG_DWORD_LITTLE | |
| CMPRP_T_SINT | _ENDIAN | |
| 32 | | |
| CMPRP_T_ASCI | REG_SZ or | REG_SZ |
| Z or | REG_EXPAND_SZ | |
| CMPRP_T_UNIC | | |
| ODEZ | | |
| CMPRP_T_UCH | REG_BINARY | REG_BINARY |
| AR or | | |
| CMPRP_T_MBC | | |
| SZ | | |
| CMPRP_T_BINA | REG_BINARY, | REG_BINARY |
| RY | REG_DWORD_BIG_EN | |
| | DIAN, REG_LINK, | |
| | REG_RESOURCE_LIST | |
| | , or REG_MULTI_SZ | |

For Windows 95/98 Kernel Mode environment:

| | | Preferred |
|---|---|---|
| | | Registry |
| ClassMagic Type | Valid Registry Types | Type |
| CMPRP_T_UINT3 | REG_DWORD or | REG_DWOR |
| 2 or | REG_DWORD_LITTLE_E | D |
| CMPRP_T_SINT3 | NDIAN | |
| 2 | | |
| CMPRP_T_ASCIZ | REG_SZ or | REG_SZ |
| | REG_EXPAND_SZ | |
| CMPRP_T_UCHA | REG_BINARY | REG_BINAR |
| R, | | Y |
| CMPRP_T_UNICO | | |
| DEZ, or | | |
| CMPRP_T_MBCS | | |
| Z | | |
| CMPRP_T_BINAR | REG_BINARY, | REG_BINAR |
| Y | REG_DWORD_BIG_END | Y |
| | IAN, REG_LINK, | |
| | REG_RESOURCE_LIST, | |
| | or REG_MULTI_SZ | |

DM_PRM transparently passes all other calls on its i_fac input to its o_fac output.

Buffer Allocation and Reallocation

DM_PRM allocates a data buffer upon activation to be used for retrieving property values from the registry or from a part. If any of the operations return ERROR_INSUFFIENT_BUFFER (registry API) or CMST_OVERFLOW (ClassMagic), DM_PRM will reallocate the buffer to the needed size as returned by the operation. DM_PRM frees the buffer when it is deactivated.

Handling Other Property Operations (get, chk)

When DM_PRM receives a call on i_prp.chk, and the property name matches its reg_prop_name, DM_PRM appends the value of its reg_path_suffix property to the incoming value before forwarding the operation.

When DM_PRM receives a call on i_prp.get, and the property name matches its reg_prop_name, DM_PRM forwards the call to its o_prp output and upon a successful return, strips the reg_path_suffix from the value before returning from the call.

All other operations on DM_PRM's i_prp input are passed transparently to DM_PRM's o_prp output.

Serializers

DM_SER—Serializer (to Registry)

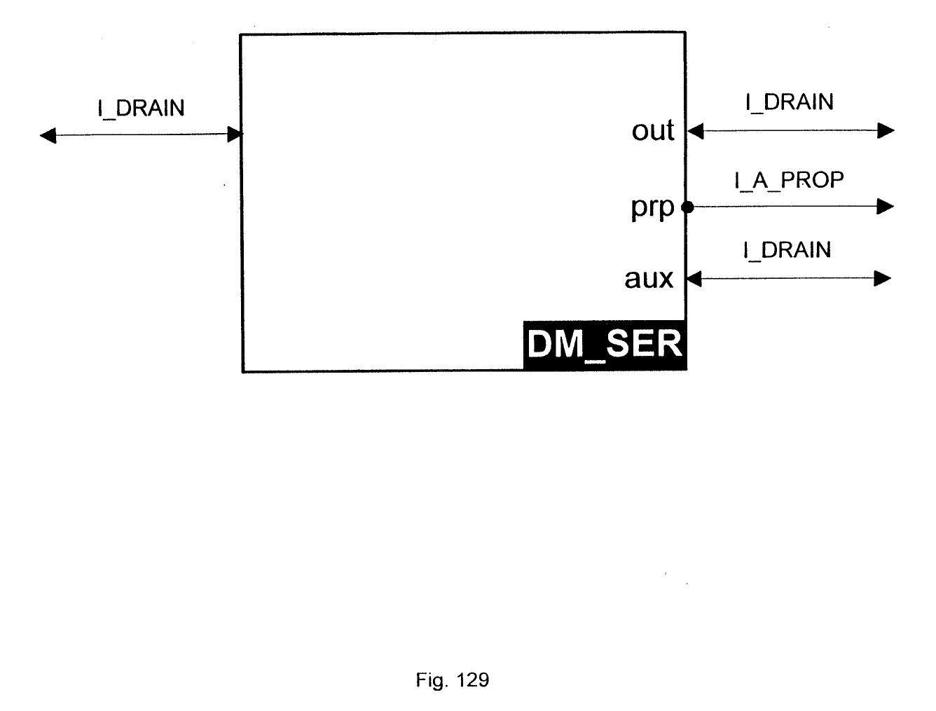

FIG. 129 illustrates the boundary of the inventive DM_SER part.

DM_SER is used to serialize a part's internal state (properties) to the system registry.

When DM_SER receives a specific event from the in terminal (specified through a property), DM_SER enumerates all the properties of the part connected to the prp terminal and saves them to the registry. The serialization event received from in is also passed through the out terminal.

DM_SER may be parameterized to serialize a part before or after the completion of the serialization event passed through out.

The events sent through out can be completed either synchronously or asynchronously—DM_SER takes care of the proper completion and necessary cleanup.

Unrecognized events received on in or aux are passed out through the opposite terminal without modification. This enables DM_SER to be inserted in any event flow and provides greater flexibility.

This part is available only in Windows NT and Windows 95/98 Kernel Mode environments.

1. Boundary

1.1. Terminals

Terminal “in” with direction “Plug” and contract I_DRAIN. Note: Synchronous, v-table, cardinality 1 This teminal receives the (ev-serialize) event that serializes the part connected to the prp terminal. This event is also passed through the out terminal. All unrecognized events received from this terminal are passed out through aux without modification.

Terminal “out” with direction “Plug” and contract I_DRAIN. Note: Synchronous, v-table, cardinality 1 DM_SER passes the serialization event (ev-serialize) through this terminal.

Terminal “prp” with direction “Out” and contract I_A_PROP. Note: Synchronous, v-table, cardinality 1 Serialization terminal. DM_SER uses this terminal to enumerate the properties of a part in order to serialize its state to the registry.

Terminal “aux” with direction “Plug” and contract I_DRAIN. Note: Synchronous, v-table, cardinality 1, floating Auxiliary terminal. All events received from this terminal are passed through in without modification. All unrecognized events received from in are passed out through aux without modification.

1.2. Events and Notifications

The following events are recognized on the in terminal:

| Incoming Event | Bus | Notes |
|---|---|---|
| (ev_serialize) | CMEVENT | This event triggers |
| | _HDR | DM_SER to serialize the |
| | | state of the part |
| | | connected to the prp |
| | | terminal. |

The following events are recognized on the out terminal:

| Outgoing Event | Bus | Notes |
|---|---|---|
| (ev_serialize) | CMEVENT | This event is passed |
| | _HDR | through the out terminal |
| | | when received on the in |
| | | terminal. |
| | | The order between |
| | | sending this event and |
| | | serialization is determined |
| | | by the ser_disc property. |
| | | This event may be |
| | | processed synchronously |
| | | or asynchronously. |
| (ev_cleanup) | CMEVENT | This is the cleanup event |
| | _HDR | that is sent through the |
| | | out terminal if serialization |
| | | fails. |
| | | This event may be |
| | | processed synchronously |
| | | or asynchronously. |

1.3. Special Events, Frames, Commands or Verbs

None.

1.4. Properties

Property “ev_serialize” of type “UINT32”. Note: Event ID of the serialization event received on the in terminal. When this event is received on in, DM_SER serializes the state of the part connected to the prp terminal. If EV_NULL, DM_SER passes all events received on the in terminal out through the aux terminal. Default is EV_NULL.

Property “ev_cleanup” of type “UINT32”. Note: Event ID of the cleanup event sent through the out terminal if the serialization fails. If EV_NULL, no cleanup event is sent through the out terminal. Default is EV_NULL.

Property “ser_disc” of type “ASCIZ”. Note: Distribution of the serialization event. Can be one of the following values: fwd_ignore—send serialization event through out first then serialize part's state. bwd_ignore—serialize part's state first then send serialization event through out. fwd_cleanup—send serialization event through out first then serialize part's state. If serialization fails, send cleanup event through out. See the Mechanism section for more information. Default is fwd ignore.

Property “async_cplt_attr” of type “UINT32”. Note: Value of the attribute that signifies that the serialization event received from in can be processed asynchronously. The default is: CMEVT_A_ASYNC_CPLT

Property “cplt_attr” of type “UINT32”. Note: Value of the attribute that signifies that the processing of the serialization event passed through the out terminal has been completed. When the serialization event passed through out is processed asynchronously, the completion event passed back to DM_SER is expected to have this attribute set. The default is: CMEVT_A_COMPLETED

Property “cplt_offs” of type “UINT32”. Note: Offset in completion event bus for the completion status. The size of the storage must be at least sizeof (cmstat). Default is 0x0C. (first field in event bus after standard fields id, sz and attr)

Property “reg_prop_name” of type “ASCIZ”. Note: Name of the property that contains the registry path used to serialize a parts state. This property is expected to be of type UNICODE. Before serialization, DM_SER reads the value of this property (prp.get) and uses the value as the location to store the parts state in the registry. Default is “reg_root”.

Property “reg_hive” of type “UINT32”. Note: A registry key to use as the root for registry serialization operations. The default value is NULL (absolute) for Windows NT/WDM and HKEY_LOCAL_MACHINE for Windows 95/98 (VxD) Kernel Mode environments.

Property “ser_attr_mask” of type “UINT32”. Note: Attribute mask to use when performing query operations to serialize properties. Default is CMPRP_A_PERSIST.

Property “ser_attr_value” of type “UINT32”. Note: Attribute value to use when performing query operations to serialize properties. Default is CMPRP_A_PERSIST.

Property “ser_existing_only” of type “UINT32”. Note: TRUE to serialize only those properties that already exist in the registry. Default is FALSE.

Property “buf_sz” of type “UINT32”. Note: Initial size [in bytes] of buffer to allocate for reading property values from the part connected to the prp terminal. This value is treated as a lower limit. DM_SER may round it up and allocate more memory if the given value is too small. Default is 512 bytes.

Property “buf_realloc” of type “UINT32”. Note: TRUE to reallocate property value buffer if it becomes too small. Default is TRUE.

2. Encapsulated Interactions

DM_PRM uses the Windows 95/98 and Windows NT_Registry API (kernel-mode).

3. Internal Definition

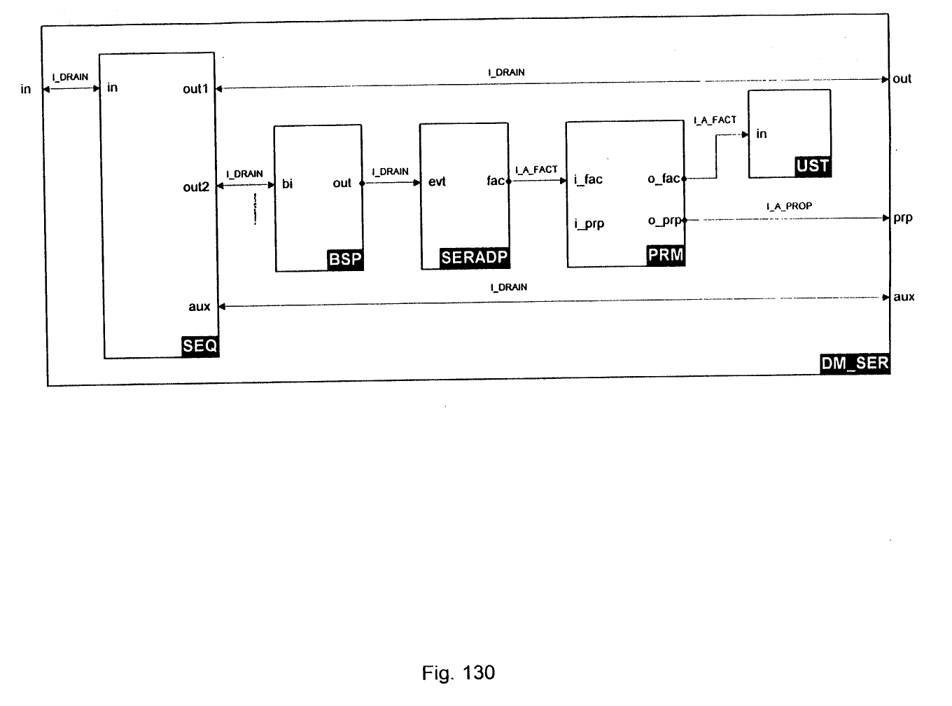

FIG. 130 illustrates the internal structure of the inventive DM_SER part.

4. Subordinate's Responsibilities

4.1. SEQ—Event Sequencer

Distribute incoming events received on in to the parts connected to the out1 and out2 terminals.

Allow both synchronous and asynchronous completion of the distributed events.

Pass all unrecognized events received on the in terminal through the aux terminal.

Pass all events received on the aux terminal through the in terminal.

4.2. BSP—Bi-Directional Splitter

Provide plumbing to enable connection of a bi-directional terminal to an unidirectional input or output.

4.3. ADP—Activation/Deactivation Adapter

Convert deactivation events received on the evt terminal into fac.deactivate operation calls.

4.4. PRM—Parameterizer

Serialize properties to the registry on a i_fac.deactivate operation call.

Map or convert between registry data types and ClassMagic property types.

4.5. UST—Universal Stopper

Stub all operations invoked through the in terminal and return CMST_OK.

5. Distribution of Properties

| Property | Distr. | Subordinate |
|---|---|---|
| ev_serialize | Group | seq.ev[0].ev_id |
| ev_serialize | Group | adp.ev_deactivate |
| ev_cleanup | Redirecte | seq.ev[0].cleanup_id |
| | d | |
| ser_disc | Redirecte | seq.ev[0].disc |
| | d | |
| async_cplt_attr | Redirecte | seq.async_cplt_attr |
| | d | |
| cplt_attr | Redirecte | seq.cplt_attr |
| | d | |
| cplt_s_offs | Redirecte | seq.cplt_s_offs |
| | d | |
| reg_prop_name | Redirecte | prm.reg_prop_name |
| | d | |
| reg_hive | Redirecte | prm.reg_hive |
| | d | |
| ser_attr_mask | Redirecte | prm.ser_attr_mask |
| | d | |
| ser_attr_val | Redirecte | prm.ser_attr_val |
| | d | |
| ser_existing_only | Redirecte | prm.ser_existing_only |
| | d | |
| buf_sz | Redirecte | prm.buf_sz |
| | d | |
| buf_realloc | Redirecte | prm.buf_realloc |
| | d | |

6.

7. Subordinate Parameterization

| Part | Property | Value |
|---|---|---|
| adp | pid_ofs | −1 |
| prm | serialize | TRUE |
| ust | in_is_drain | FALSE |
| ust | ret_s | CMST_OK |

8. Theory of Operation

8.1. Mechanisms

Serialization Event Distribution

DM_SER serializes a parts state when it receives an ev serialize event from the in terminal. The disciplines defined below are used to determine whether this serialization event is passed through the out terminal before or after the actual part serialization. They also determine whether serialization errors are considered and if a cleanup event should be sent through the out terminal.

The serialization disciplines defined below are specified through the ser_disc property (ASCII strings):

fwd_ignore: The serialization event is passed through the out terminal before DM_SER serializes the part connected to the prp terminal. All errors are ignored.

bwd_ignore: The serialization event is passed through the out terminal after DM_SER serializes the part connected to the prp terminal. All errors are ignored.

fwd_cleanup: Same as fwd_ignore except if the part serialization fails, DM_SER sends the cleanup event ev-cleanup through the out terminal. The serialization failure status is propagated back to the original caller.

Serialization of Properties

When DM_SER receives an ev_serialize event from the in terminal, it first calls o_prp.get with its reg_prop_name property to retrieve the registry path of where to store the parts properties in the registry. It then opens the registry key and opens a query on its prp output based upon its ser_attr_mask and ser_attr_val properties. DM_SER then enumerates all the properties of the part connected to the prp terminal.

If the property does not currently exist in the registry, DM_SER saves the value with the preferred registry type. If the property does exist in the registry, DM_SER first validates that the types are compatible between ClassMagic and the registry. If the types are compatible, DM_SER saves the value in the registry using the registry type. If the types are not compatible, DM_SER logs an error message, and saves the value in the registry with a preferred type based upon the property value. The table below describes the valid registry types, and the preferred registry type for each ClassMagic type.

If DM_SER's ser_existing_only property is set to TRUE, DM_SER will save only those properties that currently exist in the registry.

For Windows NT Kernel Mode/WDM environments:

| | | Preferred |
|---|---|---|
| | | Registry |
| ClassMagic Type | Valid Registry Types | Type |
| CMPRP_T_UINT3 | REG_DWORD or | REG_DWOR |
| 2 or | REG_DWORD_LITTLE_E | D |
| CMPRP_T_SINT3 | NDIAN | |
| 2 | | |
| CMPRP_T_ASCIZ | REG_SZ or | REG_SZ |
| or | REG_EXPAND_SZ | |
| CMPRP_T_UNICO | | |
| DEZ | | |
| CMPRP_T_UCHA | REG_BINARY | REG_BINAR |
| R or | | Y |
| CMPRP_T_MBCS | | |
| Z | | |
| CMPRP_T_BINAR | REG_BINARY, | REG_BINAR |
| Y | REG_DWORD_BIG_END | Y |
| | IAN, REG_LINK, | |
| | REG_RESOURCE_LIST, | |
| | or REG_MULTI_SZ | |

For Windows 95/98 VxD Kernel Mode environments:

| | | Preferred |
|---|---|---|
| | | Registry |
| ClassMagic Type | Valid Registry Types | Type |
| CMPRP_T_UINT3 | REG_DWORD or | REG_DWOR |
| 2 or | REG_DWORD_LITTLE_E | D |
| CMPRP_T_SINT3 | NDIAN | |
| 2 | | |
| CMPRP_T_ASCIZ | REG_SZ or | REG_SZ |
| | REG_EXPAND_SZ | |
| CMPRP_T_UCHA | REG_BINARY | REG_BINAR |
| R, | | Y |
| CMPRP_T_UNICO | | |
| DEZ, or | | |
| CMPRP_T_MBCS | | |
| Z | | |
| CMPRP_T_BINAR | REG_BINARY, | REG_BINAR |
| Y | REG_DWORD_BIG_END | Y |
| | IAN, REG_LINK, | |
| | REG_RESOURCE_LIST, | |
| | or REG_MULTI_SZ | |

Buffer Allocation and Reallocation

DM_SER allocates a data buffer upon activation to be used for retrieving property values from the registry or from a part. If any of the operations return ERROR_INSUFFIENT_BUFFER (registry API) or CMST_OVERFLOW (ClassMagic), DM_SER reallocates the buffer to the needed size as returned by the operation. DM_SER frees the buffer when it is deactivated.

DM_SERADP—Activation/Deactivation Adaptor

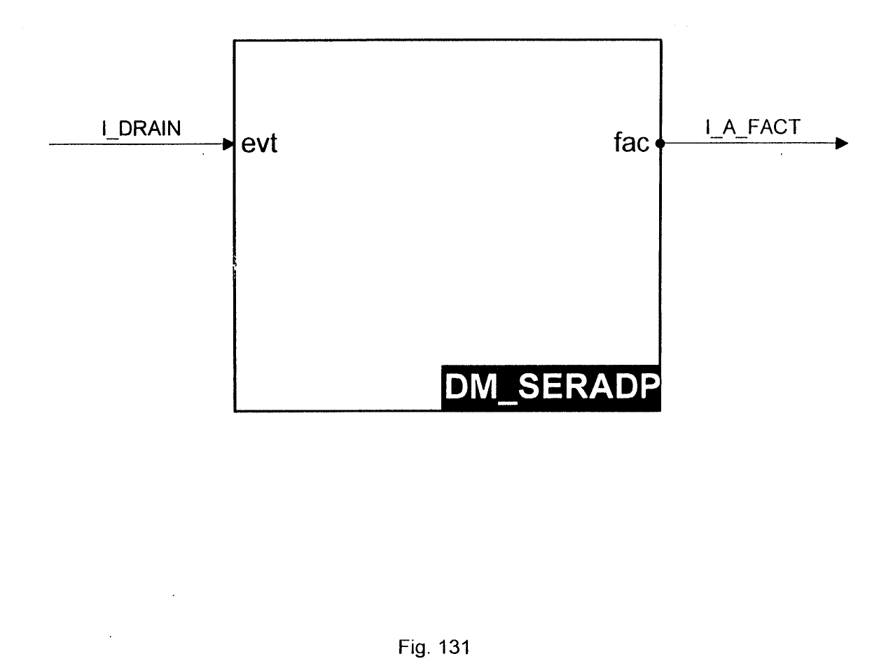

FIG. 131 illustrates the boundary of the inventive DM_SERADP part.

DM_SERADP is an adaptor that converts specific events received on the evt terminal into fac.activate and fac.deactivate operation calls.

The activation and deactivation event IDs are specified as properties on DM_SERADP. These events are always processed synchronously.

DM_SERADP extracts the part ID that identifies the part to be activated/deactivated from the bus that comes with the event. The offset of the part ID storage is specified through a property.

DM_SERADP consumes all unrecognized events and returns CMST_OK.

9. Boundary

9.1. Terminals

Terminal “evt” with direction “In” and contract I_DRAIN. Note: Synchronous, v-table, infinite cardinality This terminal receives the (ev-activate) and (ev deactivate) events which are converted into I_A_FACT activate and deactivate operations (sent out through the fac terminal). This terminal is ungaurded.

Terminal “fac” with direction “Out” and contract I_A_FACT. Note: Synchronous, v-table, cardinality 1 DM_SERADP invokes the life-cycle operations activate and deactivate through this terminal when it receives the (ev activate) and (ev-deactivate) events from the evt terminal respectively.

9.2. Events and Notifications

| Incoming Event | Bus | Notes |
|---|---|---|
| (ev_activate) | CMEVENT_ | Activate part. |
| | HDR | This event is converted |
| | | into a activate operation |
| | | call through the fac |
| | | terminal. |
| | | This event is always |
| | | processed synchronously. |
| (ev_deactivate) | CMEVENT_ | Deactivate part. |
| | HDR | This event is converted |
| | | into a deactivate operation |
| | | call through the fac |
| | | terminal. |
| | | This event is always |
| | | processed synchronously. |

9.3.

9.4. Special Events, Frames, Commands or Verbs

None.

9.5. Properties

Property “ev_activate” of type “UINT32”. Note: ID of the event that is converted into a activate operation call through the fac terminal. If EV_NULL, DM_SERADP does not convert any events received on evt into fac.activate operation calls. In this case DM_SERADP consumes the event and returns CMST_OK. Default is EV_NULL.

Property “ev_deactivate” of type “UINT32”. Note: ID of the event that is converted into a deactivate operation call through the fac terminal. If EV_NULL, DM_SERADP does not convert any events received on evt into fac.deactivate operation calls. In this case DM_SERADP consumes the event and returns CMST_OK. Default is EV_NULL.

Property “pid_ofs” of type “UINT32”. Note: Offset of the part ID in the event bus (specified in bytes). This ID identifies the part that needs to be activated or deactivated. DM_SERADP extracts the part ID from the event bus and passes it to the activate/deactivate operation on the fac terminal. The size of the part ID storage is expected to be sizeof (DWORD). If −1, DM_SERADP passes NO_CMOID for the part ID. Default is 0x0C (first field after the common event bus fields: sz, id and attr).

10. Encapsulated Interactions

None.

11. Specification

12. Responsibilities

1. Convert the (ev_activate) event (received on the evt terminal) into a fac.activate operation call. Extract the part ID from the event bus and pass it with the call.

2. Convert the (ev_deactivate) event (received on the evt terminal) into a fac.deactivate operation call. Extract the part ID from the event bus and pass it with the call.

3. Consume all unrecognized events received on the evt terminal and return CMST_OK.

13. Theory of Operation

13.1. Main Data Structures

None.

13.2. Mechanisms

Event to Life-Cycle Conversion

DM_SERADP converts the (ev_activate) and (ev_deactivate) events received on the evt terminal into fac.activate and fac.deactivate operation calls respectively.

Before invoking the operation, DM_SERADP uses the pid_ofs property to extract the part ID from the event bus. This ID is passed as an argument to the operation call—it identifies the part instance that should be activated or deactivated.

The return status of the part activation/deactivation is propagated back to the caller.

Property Interface Adaptors

DM_E2P—Event to Property Interface Converter

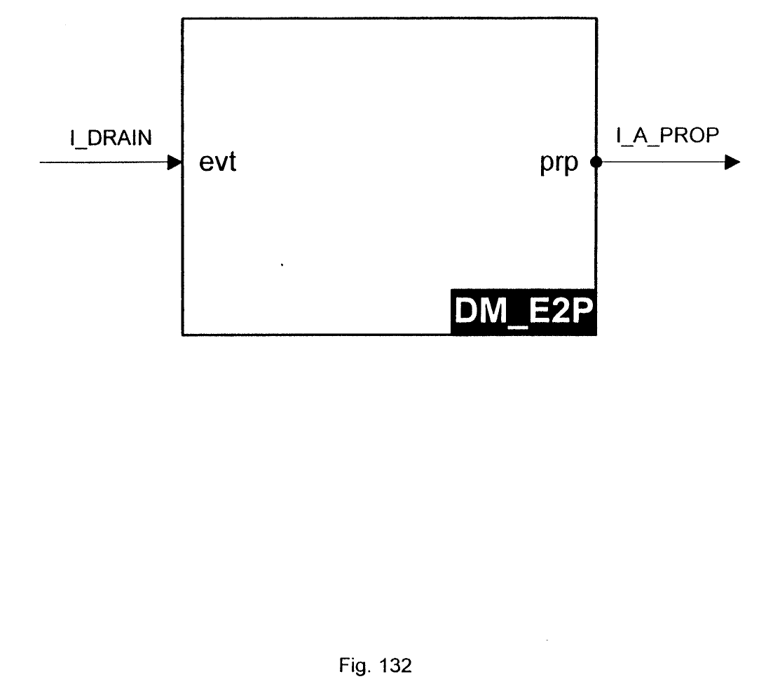

FIG. 132 illustrates the boundary of the inventive DM_E2P part.

DM_E2P converts EV_PRP_REQ events received on the evt terminal into operations of the I_A_PROP interface and executes the operation synchronously. It is assumed that EV_PRP_REQ can carry any operation of the property interface and that its bus is self-contained with possibly variable size, with the actual data value being the last field in the event bus. Please see E_PROP.H for a detailed description of the EV_PRP_REQ event.

1. Boundary

1.1. Terminals

Terminal “evt” with direction “In” and contract I_DRAIN. Note: Process EV_PRP_REQ events. This terminal is ungaurded.

Terminal “prp” with direction “Out” and contract I_A_PROP. Note: Request property operations. EV_PRP_REQ events received from the evt terminal are translated into property operations invoked through this terminal.

1.2. Events and Notifications

| Incoming Event | Bus | Notes |
|---|---|---|
| EV_PRP_REQ | B_EV_PRP | Request property |
| | | operation. |

1.3. Special Events, Frames, Commands or Verbs

None.

1.4. Properties

None.

2. Encapsulated Interactions

None.

3. Specification

4. Responsibilities

1. Synchronously process EV_PRP_REQ events by translating them into I_A_PROP operations and invoking the operation out prp.

2. Refuse all other events.

3. Fill in the completion status of the event bus when the I_A_PROP operation returns.

5. Theory of Operation

5.1. State Machine

None.

5.2. Main Data Structures

None.

5.3. Mechanisms

Translation of EV_PRP_REQ into I_A_PROP operations

When DM_E2P receives an EV_PRP_REQ event, it determines the I_A_PROP operation to call based on the opcode field of the B_EV_PRP bus. The translation is as follows:

| | | |
|---|---|---|
| PROP_OP_GET | → | get |
| PROP_OP_SET | → | set |
| PROP_OP_CHK | → | chk |
| PROP_OP_GET_INFO | → | get_info |
| PROP_OP_QRY_OPEN | → | qry_open |
| PROP_OP_QRY_CLOSE | → | qry_close |
| PROP_OP_QRY_FIRST | → | qry_first |
| PROP_OP_QRY_NEXT | → | qry_next |
| PROP_OP_QRY_CURR | → | qry_curr |

DM_E2P uses the fields of the incoming B_EV_PRP bus to fill in the fields for the B_A_PROP bus without modification and makes the call. When the I_A_PROP operation returns, DM_E2P fills in the cplt_s of the event bus with the return status and returns the same status as a return value.

DM_P2E—Property to Event Adapter

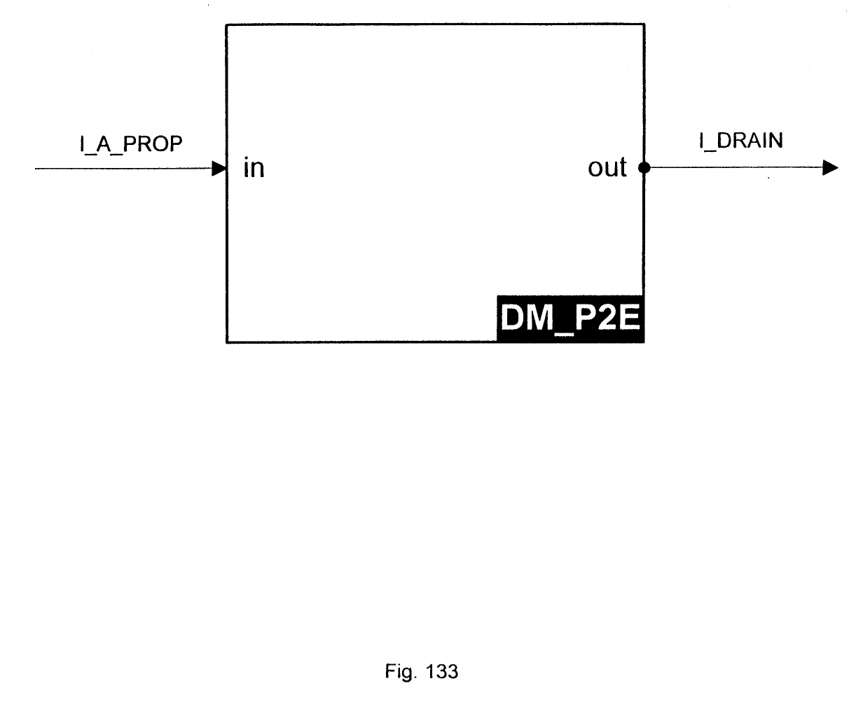

FIG. 133 illustrates the boundary of the inventive DM_P2E part.

DM_P2E is an adapter that converts the I_A_PROP operations received on its input into EV_PRP_REQ events, which are sent out its output. There is a one-to-one correspondence between the two interfaces. The events that DM_P2E generates are expected to be completed synchronously.

6. Boundary

6.1. Terminals

Terminal “in” with direction “In” and contract I_A_PROP. Note: Input for property operation requests. DM_P2E converts these requests into EV_PRP_REQ events and sends them out its out terminal.

Terminal “out” with direction “Out” and contract I_DRAIN. Note: Output for synchronous EV_PRP_REQ events.

6.2. Events and Notifications

| Outgoing | | |
|---|---|---|
| Event | Bus | Notes |
| EV_PRP_REQ | B_EV_PRP | DM_P2E sends this event |
| | | out its out terminal in |
| | | response to being invoked |
| | | on its in terminal. |

6.3. Special Events, Frames, Commands or Verbs

None.

6.4. Properties

None.

7. Encapsulated Interactions

None.

8. Specification

9. Responsibilities

3. Convert I_A_PROP requests received on in to EV_PRP_REQ event requests and send them out the out terminal.

10. Theory of Operation

10.1. State Machine

None.

10.2. Mechanisms

None.

DM_PSET and DM_PSET8—Property Setters

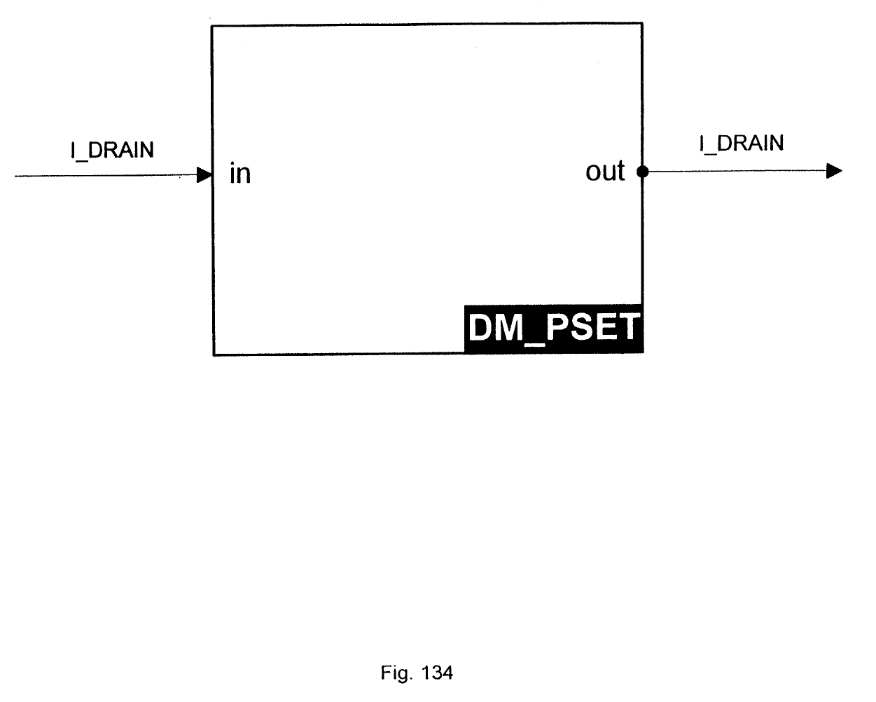

FIG. 134 illustrates the boundary of the inventive DM_PSET part.

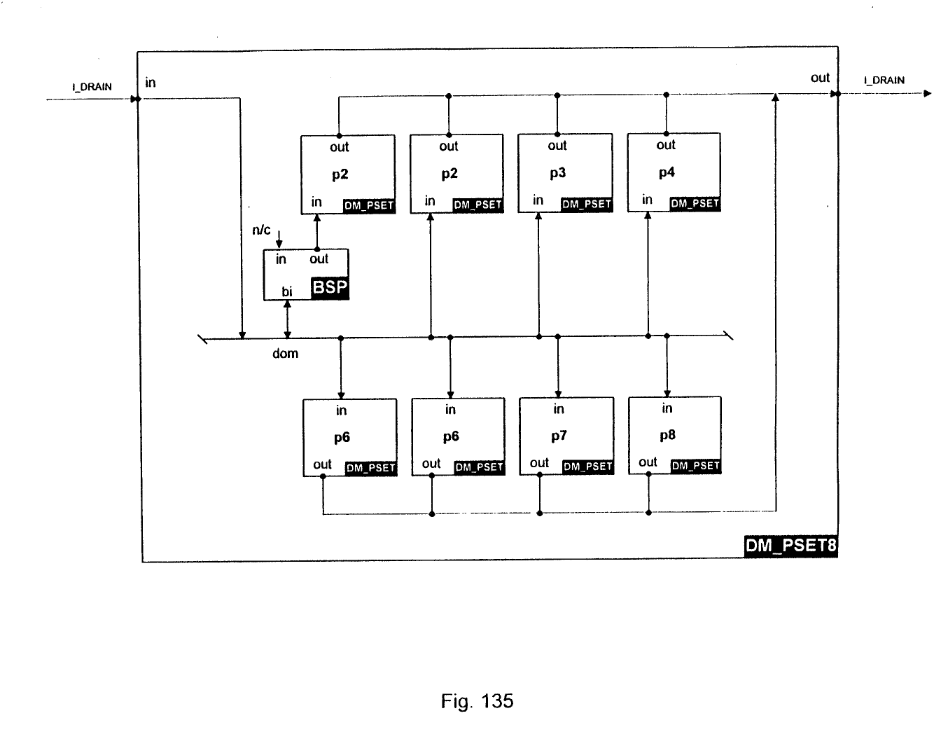

FIG. 135 illustrates the boundary of the inventive DM_PSET8 part. DM_PSET issues a property set request when it receives a trigger event on its input. The property name and type are given to DM_PSET as properties. DM_PSET can also retrieve the value of the property from the event bus of the trigger event.

DM_PSET8 combines eight DM_PSETs to set up to eight properties on the trigger event. The parts have no state.

11. Boundary

11.1. Terminals

Terminal “in” with direction “In” and contract I_DRAIN. Note: v-table, synchronous, infinite cardinality When the trigger event is received on this terminal, DM_PSET/DMPSET8 sends a property set request through the out terminal; otherwise return CMST_NOT_SUPPORTED.

Terminal “out” with direction “Out” and contract I_DRAIN. Note: v-table, synchronous, cardinality 1 Output for property set requests.

11.2. Events and Notifications

“Out” Terminal

| Outgoing Event | Bus | Notes |
|---|---|---|
| EV_PROP_REQ | B_EV_PROP | Request property set operation. |
| | | The event bus is dynamically |
| | | allocated and has only the |
| | | CMEVT_A_SYNC attribute set. |

11.3. Special Events, Frames, Commands or Verbs

None.

11.4. Properties (DM_PSET)

Property “trigger” of type “UINT32”. Note: Trigger event ID on which to set the property; 0 means any event. The default value is EV_PULSE.

Property “name” of type “ASCIZ”. Note: Name of property to set; empty means don't set. The default value is “ ”.

Property “type” of type “UINT32”. Note: Type of property to set (CMPRP_T_XXX). The default value is CMPRP_T_UINT32.

Property “value” of type “UINT32”. Note: Value to set. For string and binary property types, “value” should be set to a pointer to the string. This property is ACTIVETIME and the default value is 0. This property is used only if the offset property is −1.

Property “offset” of type “UINT32”. Note: Offset of value in trigger event bus if the value is be retrieved from the bus. The default value is 0xfffffff (−1); do not retrieve value from bus; use the contents of the value property.

Property “by_ref” of type “UINT32”. Note: If TRUE, the value in the bus is by reference. If FALSE, the value is contained in the bus. Used only if offset is not −1. The default value is FALSE.

Property “size” of type “UINT32”. Note: Size of the property value [in bytes]. This property is used only for binary property types. The default value is 0.

11.5. Properties (DM_PSET8)

Property “trigger” of type “UINT32”. Note: Trigger event ID on which to set the property; 0 means any event. The default value is EV_PULSE.

Property “p1.name . . . p8.name” of type “ASCIZ”. Note: Name of properties to set; empty means don't set. The default value is f.

Property “p1.type . . . p8.type” of type “UINT32”. Note: Type of properties to set (CMPRP_T_XXX). The default value is CMPRP_T_UINT32.

Property “p1.value . . . p8.value” of type “UINT32”. Note: Values to set. For string and binary property types, “value” should be set to a pointer to the string. Each property is ACTIVETIME and the default value is 0. Each property is used only if the pX.offset property is −1.

Property “p.offset . . . p8.offset” of type “UINT32”. Note: Offset of value in trigger event bus if the value is be retrieved from the bus. The default value is 0xfffffff (−1); do not retrieve value from bus; use the contents of the value property.

Property “p1.by_ref . . . p8.by_ref” of type “UINT32”. Note: If TRUE, the value in the bus is by reference. If FALSE, the value is contained in the bus. Used only if pX.offset is not −1. The default value is FALSE.

Property “p1.size . . . p8.size” of type “UINT32”. Note: Size of the property value [in bytes]. This property is used only for binary property types. The default value is 0.

12. Encapsulated Interactions

None.

13. Specification

14. Responsibilities

1. When trigger event is received, send EV_PROP_REQ event with CMEVT_A_SYNC attribute set through the out terminal and return the status from the call. Note: DM_PSET8 returns the status of the first property operation; the status of the remaining operations is ignored.

2. Return CMST_NOT_SUPPORTED for all unrecognized events.

15. Theory of Operation

15.1. State Machine

None.

15.2. Mechanisms

Determining Property Value

When DM_PSET receives a trigger event, it looks at its offset property to determine where from to retrieve the property value. If the offset property is 0xffffffff, then it retrieves the property value from its value property; otherwise, it retrieves the value form the event bus.

Dereferencing Values (‘Offset’ Not −1)

If the by_ref property is FALSE, then the offset in the bus is treated as a byte location representing the first byte of the value. If the by_ref property is TRUE, then the offset is treated as a DWORD value that is converted into a pointer based on the property type.

Determining Property Size

DM_PSET determines the property size based on the property type and or its size property.

If the property type is CMPRP_T_BINARY, the size property contains the value size, in bytes. The size property is only used for binary property types.

If the property type is CMPRP_T_UINT32 or CMPRP_T_SINT32, DM_PSET assumes that the property size is 4.

If the property type is CMPRP_T_ASCIZ, CMPRP_T_UNICODEZ, or CMPRP_T_MBCSZ, the property size is the length of the string (in bytes) plus the terminating null character.

The CMPRP_T_UNICODEZ property type is not supported for VxD environment and the CMPRP_T_MBCSZ property type is only supported in W32 environment. All other types are supported in all environments.

15.3. Use Cases

Property Value Latching

The fact that the “value” property is ACTIVETIME allows DM_PSET to be used as a property value latch. The value may be set on DM_PSET; and DM_PSET will send it out when it receives the trigger event. Note: this usage is available only with UINT32 property type.

16. Dominant's Responsibilities (DM_PSET8)

16.1. Hard Parameterization of Subordinates

DM_PSET8 does not perform any hard parameterization of its subordinates.

16.2. Distribution of Properties to the Subordinates

| Property name | Type | Distr | To |
|---|---|---|---|
| trigger | UINT32 | bcast | pX.trigger |
| p1.name ... p8.name | ASCIZ | redir | p1.name ... p8.name |
| p1.type ... p8.type | UINT32 | redir | p1.type ... p8.type |
| p1.value ... p8.value | UINT32 | redir | p1.value ... p8.value |
| p1.size ... p8.size | UINT32 | redir | p1.size ... p8.size |
| p1.offset ... p8.offset | UINT32 | redir | p1.offset ... p8.offset |
| p1.by_ref ... p8.by_ref | UINT32 | redir | p1.by_ref ... p8.by_ref |

Dynamic Container

DM_ARR—Part Array

DM_ARR (hereinafter “the array”), is a part, which is a dynamic container for other parts. The set of parts can change dynamically at any time including when a DM_ARR instance is active. Once added to the container, individual parts (called array elements or just elements) can be parameterized, connected or activated through specialized (controlling) terminals that DM_ARR exposes.

Typical usage of the array is in an assembly (host) which maintains a dynamic set of parts of the same or similar classes. For example, in a device driver, all device instances can be maintained in a part array and the assembly can simply dispatch the input events to the proper instance.

The array utilizes the connection table of the host in order to establish connections to its elements. All connections to the array itself specified in that connection table are treated as connections to an element of the array and established when a new subordinate is added.

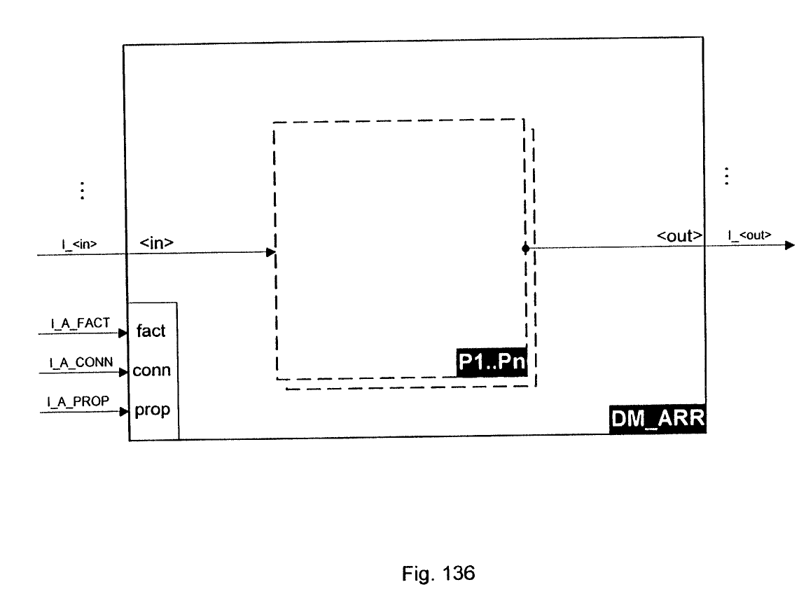

FIG. 136 illustrates the boundary of the inventive DM_ARR part.

1.1. Key Benefits

1. Connections to a dynamic set of parts can be specified in a static connection table and properly maintained. The benefit here is that having this static information eliminates the need of having code that maintains the same information.

2. Specialized parts can be developed that do most of the work pertinent to array elements creation, destruction, parameterization and connection, as well as dispatching, multiplexing and demultiplexing of connections, therefore eliminating the need to have this code in the host.

3. The one-to-many relationship and the dynamism of the structure are encapsulated into a single part. This allows restricting their proliferation into other portions of the design, which can become simpler.

1.2. More Information

The elements of the array can be of different classes. The array supports a default class name, which will be used when new elements are added to create them. The creator has the option to override the default class name and supply a new one.

The array exposes properties and terminals of its elements at its own boundary, allowing the outer scope to connect to and parameterize them directly using the standard ClassMagic mechanisms available.

DM_ARR implements a dynamic set of properties, which are synchronized between all subordinates. This mechanism is analogous to the group property mechanism in ClassMagic. The difference is that in the array, the group is defined as all elements and changes whenever an element is added or removed. The storage for the property values is provided by the array.

1.3. Notes

The connections to the array may be established to more than one element in the array. This means that terminals of objects outside the array that can be connected to terminals on the array (and consecutively, to terminals of objects inside the array) have cardinality at least as high as the maximum number of objects that will be created in the array. As input terminals normally have infinite cardinality, this note affects mostly outputs and bidirectional terminals. Such terminals are may be DriverMagic mux terminals or provide the required cardinality in another way.

The array acts on behalf its host for the purposes of memory allocation, connection table interpretation, etc. In order to accomplish this, the array is given an interface that allows the array to examine the connection table of its host assembly as well as the object identifiers of the specific part instances in this assembly. This allows the array to establish all described connections between a newly created element and parts in the host assembly, as those connections are described in the connection table of the host assembly. The way in which the array receives this information can be varied; different implementations are possible and are surely apparent to one skilled in the art to which the present invention pertains.

Specialized parts can be developed which, when connected to the controlling terminals, ensure the proper life cycle of the array elements. In this case the assembly needs to perform only instance dispatch. In most cases, even that can be avoided by having additional “dispatch” parts and a proper set of “interface adapter” parts.

1.4. Usage

DM_ARR provides a special macro for easy inclusion of part array instances in the table of subordinates. To use this macro, include DM_ARR.H header file after CMAGIC.H/CMAGIC.HPP.

The syntax of this macro is described below. array

| Description: | Declares a subordinate of class DM_ARR and hard-parameterizes this | |
|---|---|---|
| | subordinate as necessary. | |
| Syntax: | array (name, dflt_class, gen_ids) | |
| Arguments: | name | name of the array; this name can be used to establish |
| | | connections to/from the array |
| | dflt_class | default class name to use for new elements |
| | gen_ids | TRUE if the array is supposed to generate IDs for its |
| | | elements; FALSE if the these are supplied from the |
| | | outside |

| | |
|---|---|
| Example: | SUBORDINATES |
| | part (P1, P1_CLASS) |
| | part (P2, P2_CLASS) |
| | part (controller, C_CLASS) |
| | part (bus, CM_EVB) |
| | array (array, ELEMENT_CLASS, CMARR_GEN_KEYS) |
| | param (array, repeated, “out2”) |
| | para_uint32 (array, prop1 , 5 |
| | END_SUBORDINATES |
| | CONNECTIONS |
| | connect ($, mux, array, in) |
| | connect (controller, fact, array, fact) |
| | connect ($, out, array, out2) |
| | connect (array, out1, P1, term) |
| | connect (array, nfy, bus, evt) |
| | END_CONNECTIONS |
| Remarks: | This macro is for use only within the table of subordinates. |
| | Instead of using TRUE or FALSE as third argument, you can use |
| | CMARR_GEN_KEYS or CMARR_USE_KEYS, which provide more meaningful |
| | record of how the array instance is used. |
| See Also: | param, param_xxx, connect |

The macro expands to a statement for a regular subordinate part in an assembly, specifying the class name of said subordinate as DM_ARR. Here is the definition of the array macro:

#define array(nm,cls,keys) \

part (nm, DM_ARR) \

param (nm, ._name , #nm ) \
param (nm, .class , #cls )
param (nm, .gen_keys, keys)

2. Boundary

2.1. Terminals

Terminal “fact” with direction “In” and contract I_A_FACT. Note: Subordinates factory. Allows creation, destruction, life cycle control and enumeration of subordinates.

Terminal “prop” with direction “In” and contract I_A_PROP. Note: Direct access to properties of subordinates by key.

Terminal “conn” with direction “In” and contract I_A_CONN. Note: Connections. Allows connecting subordinates by key or name. Connection to/from terminals of the host are also possible.

2.2. Properties

Property “._sid” of type “UINT32”. Note: Self ID of the host assembly. Used to retrieve information from the Radix (ClassMagic or DriverMagic) instance data including subordinates and connection tables. This property is mandatory.

Property “._name” of type “ASCIZ”. Note: Array instance name. This is the name of the array as known in the host. This property is mandatory.

Property “.auto_activate” of type “BIN (fixed size)”.Note: Set to TRUE to make DM_ARR automatically activate every new subordinate if it (DM_ARR) is in active state. If FALSE, new subordinates can be activated explicitly, through the fact terminal. Default is FALSE.

Property “.class” of type “ASCIZ”. Note: Default class name of the parts added to the array. Default means not specified. Default is “ ”.

Property “.gen_keys” of type “BIN (fixed size)”. Note: Set to TRUE to make DM_ARR generate keys for each part created in the part array. Set to FALSE to make DM_ARR associate an externally provided key for each part created in the part array. This property is mandatory.

Property “._fact” of type “ASCIZ”. Note: Name of the subordinates factory terminal (I_A_FACT) Default is “fact”.

Property “._prop” of type “ASCIZ”. Note: Name of the subordinates property terminal (I_A_PROP) Default is “prop”.

Property “._conn” of type “ASCIZ”. Note: Name of the subordinates connections terminal (I_A_CONN) Default is “conn”.

Property “.repeated” of type “ASCIZ”. Note: Custom implemented property. Used to define the names of repeated (virtual) terminals visible at the boundary of the array. Get operation is not supported. Check operation is supported and will determine if a terminal can be successfully added.

The properties ._fact, ._prop and ._conn allow renaming of the controlling terminals of the array, so that an instance of the array can be created as an element in another instance of the array and its controlling terminals can be connected.

The property .repeated is a property that can be set multiple times. The array accumulates the values set in this property (instead of replacing the value with the last set value). The array preferably keeps a list of all values set in the .repeated property on its instance.

3. Responsibilities

It is important to realize that a major portion of the functionality—and consequent benefit—of the array comes through functionality that the array provides on its component boundary, and not only the from the functionality the array exposes through its terminals.

In addition to the functionality made available through its controlling terminals (fact, prop, and conn), the array provides advantageous functionality on its component boundary. As a component in the DriverMagic component object model, the array receives requests to establish connections on its terminals, to get and set properties, to enumerate properties, to activate and deactivate itself, and many others. A responsibility of the array is to implement these operations in a way that allows the host assembly to view the array of dynamically changeable set of parts as a static part with terminals of multiple cardinality. Most of the advantageous functionality of the array is preferably provided through this boundary.

Another responsibility of the array is to provide all its mechanisms in a way that is independent of any specific part class that will be contained.

Additional responsibilities of the array include:

1. Maintain a dynamic set of parts (subordinates) which may change at all times.

2. Expose all terminals on subordinates as terminals on the array essentially maintaining a dynamic set of terminals.

3. Support a static set of properties for the purposes of regular parameterization. Support one custom property for the purposes of defining virtual terminals.

4. Redirect all property operations for properties qualified with [<key value in hex. or dec.>] at the beginning to the respective subordinate identified by the key extracted from the name. Strip the qualifier before redirecting.

5. Support a dynamic set of virtual group properties, where the group is defined as all current and future subordinates. Create a new group property every time the outer scope attempts to set a new property on the array, which cannot be redirected.

6. Expose controlling terminals: factory for subordinates, connection of subordinates to other parts (incl. other subordinates) and manipulation of properties on subordinates by key. Support mechanism for renaming these terminals through properties.

7. Support virtual terminals for connecting to redirected or repeated outputs on the host. Use property mechanisms to define the names of these terminals. Enforce that these terminals are simple outputs with cardinality 1.

8. Reject all connections to non-virtual terminals as NOP (no operation) if attempted from the array's outer scope. Establish manually all connections to a subordinate upon its creation using the information from the connection table in the host. Interpret connections to the array as connections to the subordinates.

4. Theory of Operation

DM_ARR maintains a dynamic set of subordinates preferably using the available Part Array API in the ClassMagic engine. All functionality pertinent to the maintenance and operation of this set is delegated to this entity. The part array API provides a simple means for holding a number of part instances, creating and destroying them dynamically, and performing connection and property operations on them. All that it does is keep a list (or array) of part object identifiers (oid) for created objects, and when an operation is requested, the part array API locates the specific part instance and forwards the operation to the normal ClassMagic API (or component model API as it may be the case in other systems). The functionality of the part array API is documented in detail the ClassMagic and DriverMagic Reference manuals. Implementations of said API or implementing DM_ARR without using this API is surely apparent to one skilled in the art to which the present invention pertains.

DM_ARR adds value to this functionality primarily by making possible to access terminals and properties of these subordinates as if they were terminals and properties on the DM_ARR itself, and by automatically establishing all connections described in the connection table of the host between elements of the array and other parts in the assembly. This allows a dynamic set of subordinates to be included as a static part in an assembly (by inserting DM_ARR in place of the dynamic set and connecting it with all the connections that would be required from each element of the dynamic set).

In addition DM_ARR provides specialized terminals for programmatic control of the Part Array container (controlling terminals). The implementation of these terminals essentially is delegated to the Part Array entity as well.

DM_ARR implements the following basic mechanisms in order to accomplish what it does.

4.1. Virtual Terminals

Virtual terminals are simple output terminals with cardinality 1 exposed on the boundary of the DM_ARR instance (the array). The purpose of these terminals is to collect the connection information when a connection to them is established. This information is used to repeat the connection attempt (replicate) to all subordinates, current and future.

The set of such terminals is explicitly specified by the array's outer scope and is communicated to the array through properties. This set does not change throughout the life scope of an array instance. Virtual terminals cannot be removed until the instance is destroyed. The outer scope can establish the set of virtual terminals for a particular array instance through hard parameterization.

Connections to virtual terminals can be established at all times and these are replicated immediately to all currently existing subordinates. When a new subordinate is created, all currently established connections to all virtual terminals are attempted to this subordinate and if any of them fails for whatever reason, the subordinate creation fails as well. Note that virtual terminals are only one of the types of terminals supported by the array on behalf of its elements. Another important feature supported by the array is the ability to establish all connections for a newly created element, connecting the element to the same parts and terminals to which the array itself is described to be connected in the host assembly (excluding the array's controlling terminals fact, prop and conn).

4.2. Array Properties

Properties defined as properties on the array itself are interpreted as private properties of the array and are not included in any mechanisms for storage or distribution to subordinates. This also implies that their names are reserved for internal use of the array and cannot be used as names of group properties on the array. These names are intentionally prefixed with dot “.”, to lower the possibility of name conflict.

One of the array properties has a completely custom implementation. This property is used to define the set of virtual terminals available on the array. Any attempt to set such property, upon success, will result in creating a new virtual terminal and this terminal will become immediately available for connections. Operation get is not supported and will return CMST_NOT_SUPPORTED. Operation chk will check if the addition of a new virtual terminal with that name is possible or not.

4.3. Virtual Properties

Virtual Properties are a dynamic set of properties on the array, which are intended to be distributed to all subordinates whenever they become available. This set changes every time a new property is set on the array. The underlying mechanism for storage and distribution of the property values is the one found in a group property.

The values, and preferably, the types, of the virtual properties set by the outer scope are stored and remembered by the array and in the same time distributed to all currently existing subordinates the same way this is done with group properties.

When a new subordinate is created, all virtual properties that have been set in the life scope of the array (and currently remembered) are set on that subordinate ignoring any errors related to whether such property exists or not. If other errors occur, a warning is issued through the ClassMagic API for error medium access.

The get operation is equivalent to the get operation on a group property—the value is retrieved from the storage in the array and no subordinates are involved in the process. Other methods of retrieving the value of the virtual property are possible (e.g., get the value of that property from the first subordinate, if said subordinate exists), and should be apparent to one skilled in the art to which the present invention pertains.

This mechanism in this embodiment of the array does not support UPCASE and RDONLY property attributes. Mandatory properties are not directly supported, however, if any of the subordinates has mandatory properties and these are not set before activation, the activation of the subordinate will fail and the proper diagnostic message will be logged in the checked versions of the ClassMagic engine.

4.4. Redirected Properties

These are properties beginning with a key qualifier [<key value in hex or dec.>] or [<key value in hex. or dec.>]. DM_ARR simply strips the qualifier and redirects them to the proper subordinate essentially doing the same as any assembly would do. DM_ARR uses the key value in the qualifier string to determine which subordinate to redirect to.

No storage is provided for such properties. DM_ARR only acts as a redirector.

4.5. Enumeration of Properties

As any other part, DM_ARR presents a property namespace to the outer scope, preferably constructed in the following manner (and order):

1. All properties on the array itself excluding the custom ones (virtual terminals) and all properties starting with “_”.

2. All virtual properties currently existing on the array. These are the properties set by the outer scope until before the particular enumeration operation was commenced. The property operations are protected—other execution contexts will be blocked or refused entry until the operation is complete.

3. All properties of all subordinates in unspecified order. These are the properties beginning with a key qualifier [<key value in hex. or dec.>].

5. Main data structures and other definitions

5.1. VPROP—Virtual property table entry

// virtual property table entry
typedef struct VPROP

{
char *namep; // name of the property
uint16 type; // property data type
void *valp; // pointer to value
uint32 len; // length of the value
} VPROP;

5.2. VTERM—Virtual terminal table entry

// virtual terminal table entry
typedef struct VTERM

{
char name[MAX_TERM_NM_SZ]; // virtual terminal name
bool connected; // TRUE if terminal connected from outside
byte conn_ctx[CONN_CTX_SZ]; // connection context
} VTERM;

5.3. CONN_NDX—Connection Index

typedef struct CONN_NDX

{
_hdl conn_h; // connection handle
VTERM *vtp; // virtual terminal instance ID (NULL if not virtual)
bool left; // TRUE if the array terminal is on the left side
// of the connection (as per get_info)
} CONN_NDX;

The DM_ARR uses this structure to maintain the index entry for connection terminal map. Instances of this structure are allocated by the array and added to a handle set using the ClassMagic API.

No random access is needed to this index and for this reason the handle values associated with each instance of this structure are not stored anywhere. Only enumeration of these instances is possible which provided by the ClassMagic API for handle management.

5.4. S_PROP_QRY—Enumeration States

enum S_PROP_QRY

| { | |
|---|---|
| S_PQ_ARRAY, | // array properties |
| S_PQ_VPROP, | // virtual properties |
| S_PQ_SUBS, | // properties of subordinates |
| }; | |

The property query state machine uses this enumerated type to determine the next state in the enumeration. Each state is associated with a class of properties currently being enumerated. As the array implements joined name spaces for these classes, the state is needed to identify the current one.

The transition is purely sequential in the order in which these states are defined. Backward enumeration of properties and therefore backward state transition are not possible.

5.5. PQ_ARRAY—Property Query Context in the S_PQ_ARRAY State

typedef struct PQ_ARRAY

{
_ctx enum_ctx; // current property enum. ctx
} PQ_ARRAY;

This structure represents the property query context in S_PQ_ARRAY state. This is the state in which the properties listed on enumeration are these defined on the array itself, skipping properties whose names begin with “._”.

5.6. PQ_VPROP—Property Query Context in the S_PQ_VPROP State

typedef struct PQ_VPROP

{
_ctx enum_ctx; // current virt. prop. enum. ctx
} PQ_VPROP;

This structure represents the property query context in S_PQ_VPROP state. This is the state in which the virtual properties are listed on enumeration.

The context is the one returned by the virtual property enumeration helper API.

5.7. PQ_SUBS—Property Query Context in the S_PQ_SUBS State

typedef struct PQ_SUBS

{

| | | |
|---|---|---|
| _ctx | enum_ctx; | // part array enumeration context |
| bool | curr_1st; | // TRUE to start from the first property |
| dword | curr_oid; | // current subordinate in the array |
| _ctx | curr_qryh; | // query handle on current subordinate |

} PQ_SUBS;

This structure represents the property query context in S_PQ_SUBS state. This is the state in which the properties of subordinates (elements) of the array are listed on enumeration.

Both the current subordinate and the property enumeration context on that subordinate are kept. There is also an indication whether the enumeration has to start from the first property of the current element or to continue from the current one.

5.8. PROP_QRY—General Property Query Context

typedef struct PROP_QRY

| { | | |
|---|---|---|
| uint | state; | // enumeration state |
| flg32 | attr_mask; | // query attributes mask |
| flg32 | attr_val; | // query attributes values |

| | |
|---|---|
| union PQ_ENUM_STATE | // query state depending on the state |

| { | |
|---|---|
| PQ_ARRAY | array; |
| PQ_VPROP | vprop; |
| PQ_SUBS | subs; |
| }; | |

} PROP_QRY;

This structure represents the composite property query instance. It combines the current state of property enumeration in a query instance together with the particular contexts for each individual state. It is assumed that there is no context shared between different states.

6. Self Data Structure (Instance Data)

BEGIN_SELF

| | | |
|---|---|---|
| DM_ARR_HDR | arr; | // Part Array from DriverMagic |
| VECON | vtc; | // virtual terminals container |
| VECON | vpc; | // virtual properties container |
| VTDST | vtd; | // virtual terminal operation distributor |
| VPDST | vpd; | // virtual property operation distributor |
| _hdl | cnx; | // connection index owner key |
| _hdl | qry; | // queries owner key |
| I_META | *host_imetap; | // host meta-object interface |
| | | // used to resolve subordinate name to oid |
| I_R_ECON | *iecnp; | // connection enumeration interface |
| | | // used to enumerate the connections in the host |
| RDX_CNM_DESC | *cdscp; | // connection descriptor in the host |

PROPERTIES

| | | |
|---|---|---|
| ROX_SID | sid; | // self ID of the host |
| bool | auto_activate; | // TRUE to auto-activate |
| bool | gen_keys; | // TRUE to generate keys |
| char | name [RDX_MAX_PRT_NM_LEN + 1]; | // array name |
| char | cls_nm[RDX_MAX_PRT_NM_LEN + 1]; | // default class name |
| char | _fact [RDX_MAX_TRM_NM_LEN + 1]; | // ′fact′ terminal name |
| char | _prop [RDX_MAX_TRM_NM_LEN + 1]; | // ′prop′ terminal name |
| char | _conn [RDX_MAX_TRM_NM_LEN + 1]; | // ′conn′ terminal name |

TERMINALS

decl_input (fact, I_A_FACT)

decl_input (prop, I_A_PROP)

decl_input (conn, I_A_CONN)

END_SELF

7. State Machine Organization

A state machine is used for property enumeration. The input events are three: “reset”, “next” and “current”. The machine performs sequential state transition in the order in which the states are defined. Transition to initial state is possible at any state and will happen if “reset” event is received.

The input events are declared in the following enumerated type:

enum PQ_EVENT

{
PQ_EV_RESET = 0,
PQ_EV_NEXT = 1,
PQ_EV_CURR = 2,
};

All events are fed into a state machine controller—a static function responsible to invoke the proper action handier as defined in the state transition table. The action handler is responsible to perform the state transition before it returns to the controller.

The prototype of such action handler is shown bellow:

typedef_stat pq_ahdlr (PROP_QRY *sp, SELF *selfp, B_PROPERTY *bp);

The state machine event feeder (controller) prototype is shown here:

static_stat pq_sm_feed (PROP_QRY *sp, SELF *selfp, uint ev, B_PROPERTY *bp);

The state transition table associates three action handlers for each state: “reset”, “next” and “current” action handlers.

typedef struct SM_TBL_ENTRY

{
pq_ahdlr *reset_hdlrp;
pq_ahdlr *next_hdlrp;
pq_ahdlr *curr_hdlrp;
} SM_TBL_ENTRY;

State Transition Table:

static SM_TBL_ENTRY g_sm_table [] =

{

/* PQ_EV_RESET *//* PQ_EV_NEXT *//* PQ_EV_NEXT */

/* S_PQ_ARRAY */ ah_reset , ah_arr_next , ah_arr_curr
/* S_PQ_PROP */ ah_reset , ah_vp_next , ah_vp_curr
/* S_PQ_SUBS */ ah_reset , ah_subs_next , ah_subs_curr
};

See the DM_ARR part implementation design in Appendix 5 for more details on the described embodiment. Also see the Appendix 14 for the interfaces exposed by the DM_ARR part.

8. Mechanisms

This section contains a brief overview of some of the DM_ARR mechanisms. For additional details on the preferred embodiment, see the appropriate Appendix.

Redirected Properties

Operations on these properties are redirected (using the key value in the qualifier) to the respective subordinate in the Part Array entity. The determination whether or not to use this mechanism is based on the first character in the property name. If that character is “[”, this mechanism is used, otherwise the property is considered virtual.

Property can also be considered virtual if the syntax of the qualifier is unrecognized. The only recognized syntax is “[<hex. or dec. value>]” or “[<hex. or dec. value>].”. For example, “[abcd].prop” has unrecognized syntax and will not be considered redirected. Operations on properties with syntax “[*].prop” are equivalent to operations on a virtual property “prop”.

If a part with such key does not exist at the time of the property operation, the operation fails.

Virtual Group Properties

DM_ARR uses the handle manager provided by the engine to keep the set of virtual properties. The host memory allocator is used for all allocations including the property name and storage for the value.

Every time a new property is set, the set of virtual properties is enumerated using the owner key for this set and if this property was not found (was not previously set), it is added by allocating an instance of the VPROP data structure and associating it with a handle. All storage is allocated using allocation on behalf of the host. Get operation works off the storage retrieving the information directly from there.

Once a virtual property is added, the set of subordinates is enumerated and the property value is set to them as well. If the property is not found, this condition is ignored.

This mechanism works independently of the fact whether there are any subordinates or not. When new subordinate is created, the virtual property mechanism enumerates the set of all currently existing properties and attempts to set each of them to the new subordinate, following the same logic as for setting on existing ones.

In all cases warnings will be logged in case setting a property on a subordinate fails for any reason other than the property is not found. These warnings will appear only in checked versions of the engine.

Custom Property

To properly maintain the virtual terminal mechanism, DM_ARR uses a custom property implementation for one of its properties. The operation set on this property has the meaning of “create”.

Every time this custom property is set, a new virtual terminal is created with name the property value supplied to the set operation. In case there is a duplicate and/or the creation of a virtual terminal fails for any reason, the set operation fails as well.

Operation chk on this property checks for duplicate name of a virtual terminal and fails if there is a duplicate.

Operation get on this property is not supported and returns ST_NOT_SUPPORTED.

This mechanism uses the Virtual Terminal mechanism to accomplish what it does.

Virtual Terminals

Virtual terminals are maintained only for connections to redirected or repeated outputs on the host. These terminals are created though the operations on a special custom property on the array.

Virtual Terminal mechanism uses the handle manager provided in ClassMagic to maintain the set of virtual terminals existing on the particular instance of the array.

For each virtual terminal, a special control block is allocated which will contain the connection information (once this terminal is connected from the outside) and a handle is created and associated with this control block. The connection context upon creation is initialized to 0 the terminal is marked as unconnected.

When a virtual terminal is connected to, the mechanism stores the connection context supplied by the counter terminal into the storage provided in the control block, replicates the connection to all current subordinates and indicates that the connection was successful. At this point, the mechanism marks the terminal as connected.

When a subordinate is created, the mechanism enumerates all virtual terminals skipping the unconnected ones and repeats the connection to the subordinate supplying the connection context stored in the terminal on connect operation. The mechanism uses the Connection Index to map connections to terminals.

Enumeration of Properties

On enumeration properties are given out in the following order:

1. Custom property values set on the array. The values are listed under the property name “.repeated” and all virtual terminals are given as values.

2. Other properties defined on the array in the order they are defined. “.repeated” and “._<xxx>” properties are skipped.

3. Virtual group properties in no particular order.

4. Properties from the namespaces of the subordinates prefixed by the array element qualifier: “[<key value in hex. or dec. >]” or “<key value in hex. or dec.>].” depending on whether the subordinate property starts with “[” or not.

This mechanism keeps an enumeration state associated with each property query. This state is kept in a PROP_QRY structure described in section below.

The state transition is sequential in the order defined by the S_PROP_QRY enumerated type. Any property enumeration operation can force a state transition to the next or previous state when the current subset of properties is exhausted.

Connection Index

Connection Index mechanism facilitates fast connection of newly created subordinates. Essentially it provides a map between connections and terminals on the array including the virtual ones.

For each connection to the array specified in the connection table of the host assembly, the index entry contains the name of the array terminal, the enumeration context associated with the connection and the handle to a virtual terminal. If the connection is not to a virtual terminal, the handle is 0.

This index is built during activation by enumerating the connection table and for each connection resolving the handle of the virtual terminal participating in that connection (if any).

Special care is taken to ensure that there is at most one connection to/from a virtual terminal as these terminals are assumed simple outputs with cardinality 1. If not, the array will not activate, will log an error and return ST_REFUSE.

The connection index uses the CONN_NDX data structure described below.

This mechanism offers only enumeration interface to this table.

8.1. Use Cases

Legitimate Connections

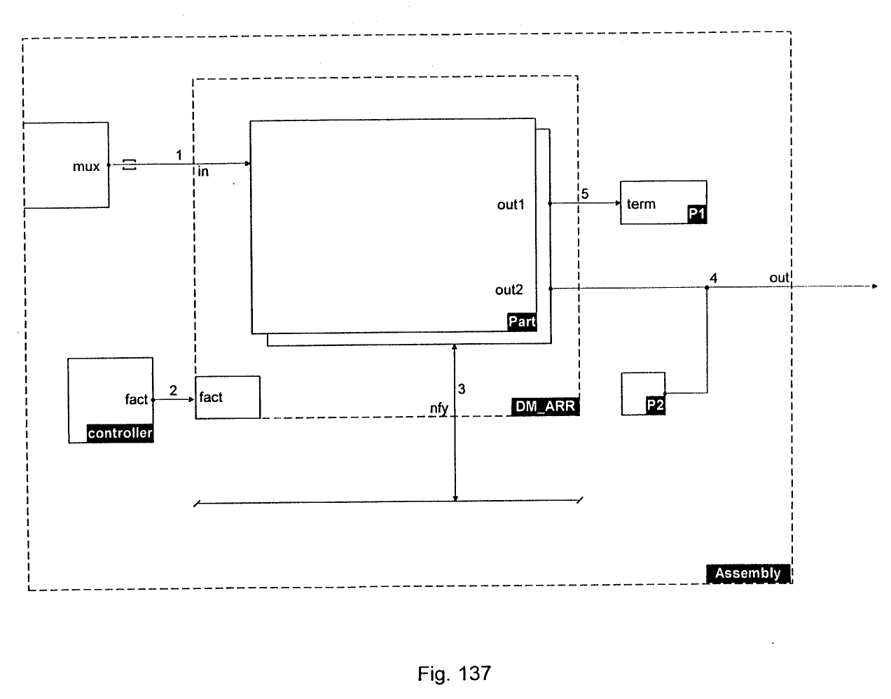

The legitimate connections of interest are shown in FIG. 137. The subordinates and connection tables will look like:

SUBORDINATES

part (P1, P1_CLASS)

part (P2, P2_CLASS)

part (controller, C_CLASS)

part (bus, CM_EVB)

array (array, Part, CMARR_GEN_KEYS)

param (array, “.repeated”, “out2”)

END_SUBORDINATES

CONNECTIONS

connect ($, mux, array, in)

connect (controller, fact, array, fact)

connect ($, out, array, out2)

connect (array, out1, P1, term)

connect (array, nfy, bus, evt)

END_SUBORDINATES

Step 1. Subordinates in the Assembly dominant are created. When the ASSEMBLY dominant (the host) is created, ClassMagic creates instances of all parts specified in the subordinates' table including the array. The array class is DM_ARR and this is hidden by the array declaration macro.

Step 2. Hard parameterization phase. Immediately after creation, ClassMagic performs hard parameterization of them using again the information in the subordinates' table. There is only one parameter set on the array “.repeated”. ClassMagic will set this property with the value specified: out2. As this is a special property (custom), this will trigger creation of a virtual terminal out2 which will be marked as “unconnected” at this time.

Step 3. Connection phase. The connection manager (CM) in ClassMagic will attempt to establish all connections as specified in the connection table including all connections to/from the array. The array will return ST_NOP on all of them except connections to/from out2 (#4) which is a virtual terminal. The connection broker (CB), who will actually perform the connection protocol, will forward this status to the CM, who in turn will just ignore this connection. When the connection to out2 terminal of the array is established, this time the Assembly will return the special ST_NOP indicating that this terminal cannot be connected at this time.

Step 4. Subordinate in the array gets created. It is assumed that the array is active at this time, if not the fact terminal will return ST_NOT_ACTIVE. When this happens the array will enumerate the Connection Index and for each index entry, will establish a connection between the new subordinate and the connection counterpart as specified in the connection table. The array resolves this counterpart by using get curr operation and the connection enumeration context in the index entry (the enumeration context, or index, was stored in the table when the connection index was constructed). For the cases when the connection is to a virtual terminal (handle is non-0), the array resolves this terminal using the handle from the index entry and checks if this terminal is connected from outside. If yes, the array replicates the connection to the virtual terminal using the connection data stored in the virtual terminal. If this virtual terminal is not connected, it is skipped. For cases when the connection is not to a virtual terminal, the array establishes the connection.

Step 5. Connection to a virtual terminal is established. This may happen both at “active” or “inactive” time. The array gets the acquire and connect operations on its terminal interface implementation. It enumerates the virtual terminals in attempt to determine if that's a connection to a virtual terminal. It does that by name comparison. On acquire the array basically does nothing, except to supply empty connection data. On connect, the terminal interface implementation stores the connection data into the virtual terminal storage (provided) and marks it as connected. The array replicates the just established connection to the virtual terminal to all of its elements using the name and connection data from the virtual terminal.

Contingencies

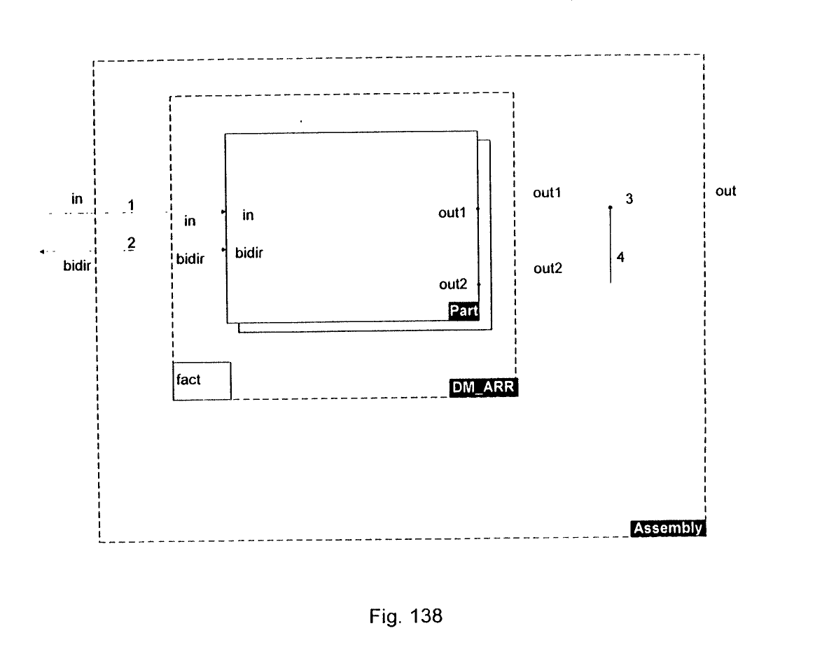

FIG. 138 illustrates an advantageous use of the inventive DM_ARR part.

Possible illegal connections of interest are shown in FIG. 138. Connection 1 and 2 are illegal as both contain redirected output that crosses the boundary of the host without connection multiplexing. Connection 3 is illegal because the terminal on the array to which it refers is not declared as “.repeated”.

SUBORDINATES

array (array, Part, CMARR_GEN_KEYS)

param (array, “.repeated”, “bidir”)

// here we forgot to include “out1 as “.repeated”

param (array, “.repeated”, “out2”)

END_SUBORDINATES

CONNECTIONS

connect ($, in, array, in)

connect ($, bidir, array, bidir)

connect (array, out1, $, out)

connect (array, out2, $, out)

END_SUBORDINATES

This use case assumes that the instance of the array has been created and parameterized as indicated in the table of subordinates. The hard parameterization will create two virtual terminals bidir and out2.

Step 1. Establishing connections 1 and 2. The dominant (host) will attempt to establish these connections in the connection phase (see previous use case).

Connection 1 attempt will fail both on the host side and on the array side; 2 will fail only on the host side. The failures are indicated by returning status ST_NOP and these connections will be skipped by the Connection Manager (CM). In fact, no connections will be established at this time.

Step 2. Establishing connections by the host's outer scope. At some later time before activation, the host's outer scope may attempt to establish any of the connections shown on the above figure. The attempts will be delegated to the array by the host.

Connection 1 will be rejected by the array with status ST_NOP (the host must recognize this and remap the status to ST_REFUSE) as the in terminal is not a virtual one.

Connection 2 is not going to be rejected on the same basis; the array will attempt to update the virtual terminal bidir and will fail with ST_REFUSE because the directions are incompatible: the array would expect the counter terminal to be input.

Connection 3, when redirected from the repeated output on the host, will succeed connecting the out2 terminal, but will fail when out1 is attempted. The failure will be return status ST_NOP. This status will be treated as an error by the repeated output on the host and remapped to ST_REFUSE so this connection will not be established.

The limitations described above pertain to the particular embodiment (based on the DriverMagic composition-based system) and are not inherent limitations of the present invention.

Passing Information About the Host Assembly to DM_ARR

The DM_ARR receives a special value in its ._sid property. This value is a pointer to an interface, which allows the array to obtain information sufficient to enumerate the connections in the host assembly and to be able to resolve the name of a subordinate part in the host assembly (as mentioned in the connection description table) to an object identifier (oid), used when requesting the establishing of connections.

In this particular embodiment, the information obtained by DM_ARR includes:

a pointer to the connection descriptor of the host assembly (RDX_CNM_DESC);

a pointer to an interface for enumerating the connections in a connection descriptor (I_R_ECON);

a pointer to the instance data of the host assembly, providing the ability to resolve the name of a subordinate part in the host assembly to an object ID (oid), using a service similar to the cm_prt_sub2oid( ) API function in DriverMagic.

For more information on the connection descriptor see Appendix 3. RDX_CNM_DESC Structure. For more information on the interface for enumerating connection descriptors, see Appendix 4. I_R_ECON Interface. For more information on resolving subordinate name to oid, see the cm_prt_sub2oid API function in the C Language Binding Reference for the ClassMagic Composition Engine [exact reference exists somewhere in the beginning of the text].

9. Details on Mechanisms and Helpers Used in DM_ARR

9.1. VECON—Virtual Entity Container

The virtual entity container is used for holding the set of virtual properties and for holding the set of virtual terminals.

The following structure is the instance data of a container for virtual entities.

typedef struct VECON

{
_hdl owner_key; //owner key of the handle set
CM_OID oid; // memory owner
uint32 off; // offset of name pointer
} VECON;

The virtual entity container helper maintains a set of handles associated with an owner. The owner is kept on the owner_key field. The oid field is used for ownership of the memory allocated by the helper. The memory allocation is performed on behalf of this object. The off field is used to calculate the pointer to the name of particular entity by a base pointer supplied on all entity operations. For more details on the virtual entity container, see Appendix 6. VECON—Virtual Entity Container and Appendix 13. Interfaces Used by Described Mechanisms.

9.2. VPROP—Virtual Property Helper

The virtual property helper is used to maintain data associated with a single instance of a virtual property. It uses the following structure to keep said data.

typedef struct VPROP

{
char *namep; // name of the property
uint16 type; // property data type
void *valp; // pointer to value
uint32 len; // length of the value
CM_OID oid; // object to allocate on behalf of
} VPROP;

The name of the property is kept by reference; the helper is responsible to allocate the storage. The same is valid for the value of the property. The name/value storage allocation happens at the same time when the virtual property is added (created) and therefore has the same life scope as the property itself.

The reason for this storage being allocated dynamically is that there is no explicit limit on the length of the property name. The same is valid for the property value.

The set of virtual properties is maintained by an instance of the VECON virtual property container.

For more details on the virtual property helper, see Appendix 6. VECON—Virtual Property Container and Appendix 13. Interfaces Used by Described Mechanisms.

9.3. VPDST—Virtual Property Distributor

The virtual property distributor is used to distribute the value of a virtual property to the current set of contained elements, when the array receives a request to set said virtual property (note that this request is typically received through the component boundary, not through the prop terminal).

The following structure is the instance data of a distributor of virtual property values.

typedef struct VPDST

{
DM_ARR_HDR *arrp; // array instance
CM_OID oid; // object to allocate memory on behalf of
} VPDST;

The arrp field is used to identify the Part Array instance as provided by ClassMagic. The oid field is used for ownership of the memory allocated by the helper. The memory allocation is performed on behalf of this object.

For more details on the virtual property helper, see Appendix 8. VPDST—Virtual Property Distributor and Appendix 13. Interfaces Used by Described Mechanisms.

9.4. VTERM—Virtual Terminal Helper

The virtual property helper is used to maintain data associated with a single instance of a virtual terminal. It uses the following structure to keep said data.

typedef struct VTERM

{
char *namep; // pointer to terminal name
bool connected; // TRUE if terminal connected
byte conn_ctx[CONN_CTX_SZ]; // connection context
char name[MAX_TERM_NM_SZ]; // virtual terminal name
word sync; // synchronicity
dword attr; // terminal attributes
} VTERM;

The instance data contains the name of the terminal (fixed length), indication whether this terminal is connected and the connection data (context), synchronicity and attributes supplied by the counter terminal (if connected). The virtual entity container utilizes the pointer to the virtual terminal name (namep field).

For more information on the virtual terminal helper, see Appendix 9. VTERM—Virtual Terminal Helper and Appendix 13. Interfaces Used by Described Mechanisms.

This helper is preferably used in conjunction with VTRME and VTRMI mechanisms described below.

9.5. VTRME—Virtual Terminal Mechanism (Exterior)

This mechanism is used to handle requests to establish and dissolve connections for virtual terminals when said requests are received on the outside boundary of the array (i.e., requests typically coming from the ClassMagic engine when establishing connections inside the host assembly). The VTRME mechanism uses the VTERM data structure described above.

For more information on the virtual terminal mechanism for exterior requests, see Appendix 10. VTRME—Virtual Terminal Mechanism (Exterior) and Appendix 13. Interfaces Used by Described Mechanisms.

9.6. VTRMI—Virtual Terminal Mechanism (Interior)

This mechanism is used to handle requests to establish and dissolve connections with virtual terminals of the array when said requests are received on the inside boundary of the array (i.e., requests typically coming from the ClassMagic engine when the array has requested the connection of a terminal of an element part to the virtual terminal). The VTRMI mechanism uses the VTERM data structure described above.

For more information on the virtual terminal mechanism for interior requests, see Appendix 11. VTRMI—Virtual Terminal Mechanism (Interior) and Appendix 13. Interfaces Used by Described Mechanisms.

9.7. VTDST—Virtual Terminal Distributor

This mechanism is used when a connection to virtual terminal is being established from outside of the array, to distribute the connection data to all present elements in the array.

The virtual terminal distributor uses the following data structure as instance data:

typedef struct VTDST

{
DM_ARR_HDR *arrp; // array instance ID
CM_OID oid; // object ID of the host
} VTDST;

The arrp field is used to identify the Part Array instance as provided by ClassMagic. The oid field is used for ownership of the memory allocated by the helper. The memory allocation is performed on behalf of this object.

For more information on the virtual terminal distributor, see Appendix 12. VTDST—Virtual Terminal Distributor and Appendix 13. Interfaces Used by Described Mechanisms.

10. Example Architecture Using Part Array

This section provides an example of a driver architecture using the DM_ARR part array. The array is used to contain a dynamic set of part instances, one per each individual device that is serviced by the driver.

The section consists of an architectural diagram, a functional overview, definition of principal entities (parts) and identification of specific interfaces between them.

This section is based on an actual driver, identified hereinafter as the MCP Driver. The architecture defined here, however, including the use of the part array and surrounding parts, is universal and can be used for virtually any device driver.

With insignificant modifications, apparent to the one skilled in the art, the same architecture and mechanisms can be used for a variety of other software components and systems, such as COM and ActiveX controls, device drivers for other operating systems, application subsystems, operating system service, and many others.

10.1. Functional Description

Driver Scope

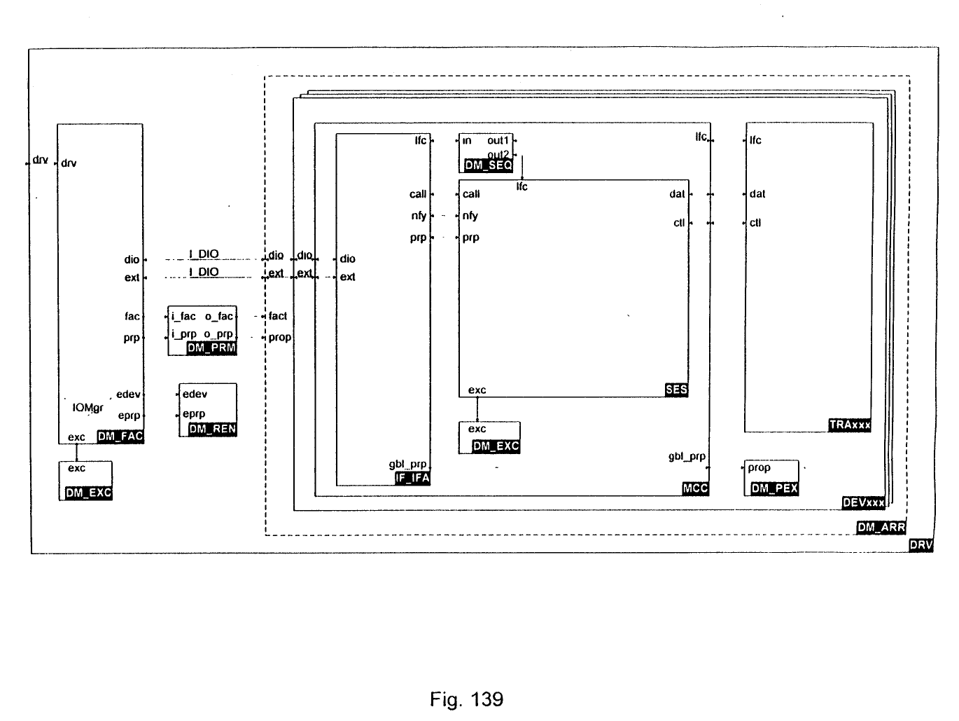

FIG. 139 illustrates a concentric view diagram of the MCP driver for Windows. The top-level assembly (DRV) assembles the following parts: device factory (DM_FAC), device enumerator on registry (DM_REN), device parameterizer (DM_PRM), exception handler (DM_EXC) and part array (DM_ARR) which manages device driver instances (DEVxxx).

The DRV assembly is created when the driver is loaded. It contains a device instance factory (DM_FAC) that is responsible for the creation, parameterization and destruction of all device instances (DEVxxx).

DM_FAC utilizes DM_REN to enumerate installed devices and to access the resources allocated for them. During the driver's initialization, DM_REN is directed to read the list of devices configured in the registry. For each device found by DM_REN, DM_FAC creates a device instance in DM_ARR and DM_PRM parameterizes it with settings found in the Registry sub-key for the particular device.

Device Scope

The device instances DEVxxx created by DM_FAC implement the per-device functionality of the MCP driver. DEVxxx is a generic name for a set of classes; each class handles different communication media (xxx stands for the medium name; for example, DEVSER is for serial devices (RS-232), DEVPAR is for parallel devices (IEEE-1284), DEVUSB is for Universal Serial Bus Devices). DM_ARR is capable of creating any of those (and other) classes. The only requirement to the class is that it has terminals and properties as used by the DRV (which is the host assembly for DM_ARR). For example, the particular DRV of the MCP driver relies to be able to connect to terminals called ‘dio’ and ‘ext’ on the boundary of DEVxxx.

DEVxxx is an assembly of two major components:

(1) The MCP core assembly, MCC, converts the application requests into application messages.

(2) The transport assembly, TRAxxx, which encapsulates the transport-specific functionality required to establish the communication channel with the device. It is responsible for acquiring exclusive access to the communication driver; it also implements reliable communications protocol over the specified connection. TRAxxx provides an OS-independent and error-free transparent interface to device. Due to a differences in the serial/parallel port API in the target operating systems, TRAxxx has different implementation for Windows NT and Windows 95/98.

Communications Protocol Core Scope

The MCC assembly is common for all devices. It contains two major components:

(1) The front end assembly, IF_IFA, which conditions and dispatches the requests from the application according to their function.

(2) The session manager, SES, which is responsible for generating application message requests (from incoming event requests) and submitting them out. When the response to a previously issued request comes, the session manager satisfies the pending event. SES accepts the incoming device notifications: all notifications are buffered inside of SES and passed to the application upon request.

10.2. Definition of Entities—Driver Scope

DRV—Driver

DRV is the top level assembly of the driver framework. It assembles all the major components of the driver framework—DM_FAC, DM_PRM, DM_ARR, DM_REN and DM_EXC.

DRV exposes a single I_DRAIN input through which it receives events from the driver packaging.

DM_FAC—Device Factory

DM_FAC registers the dispatch handlers required for Windows WDM kernel mode device drivers (IRP_MJ_xxx functions).

DM_FAC handles all necessary interactions with the operating system in order to register device driver instances. It receives all the calls that WDM kernel mode device drivers must implement. DM_FAC dispatches these calls to the appropriate instance of the device driver (DEVxxx).

DM_FAC uses the enumerator DM_REN to determine how many and what device instances to create. DM_FAC utilizes DM_ARR to maintain the array of device instances.

In addition, DM_FAC sends a command to the parameterizer DM_PRM to read the device instance properties from the registry and configure the specified device instance with them.

DM_FAC is a DriverMagic library part provided with the Windows NT Driver Kit and WDM_Driver Kit. Refer to the Object Dynamics” Windows NT Driver Kit Reference and WDM_Driver Kit Reference documents for a complete description.

DM_REN—Registry Enumerator

DM_REN emulates device enumeration by reading the all sub-keys in the driver's Registry key (Parameters\Devices\xxxx) and using the data found in each as representing a device instance.

DM_REN is a DriverMagic library part. Refer to the Object Dynamics” DriverMagic User Manual for a complete description.

DM_PRM—Parameterizer from the Registry

DM_PRM reads the device settings from the registry and sends them to the device instance using property “set” requests on its o_prp output.

DM_PRM is a DriverMagic library-part. Refer to the part library reference in the DriverMagic User Manual for a complete description.

DM_ARR—Part Array

DM_ARR is a dynamic container for other parts. The set of parts contained by DM_ARR can be changed dynamically at any time. DM_ARR implements all functionality necessary to manage the parts it contains. It works in conjunction with its host assembly to make its contained parts” terminals and properties visible to the host.

DM_ARR is a DriverMagic library part. Refer to the rest of this document for a complete description.

DM_EXC—Exception Handler/Event Log

DM_EXC displays the exception events generated by DM_FAC to the debug console and/or saves them in the Windows NT system event log or into a text file in Windows 95/98.

DM_EXC is a DriverMagic library part. Refer to the part library reference in the DriverMagic User Manual for a complete description (Windows NT) and the DriverMagic WDM_Driver Kit Reference (Windows 95/98).

10.3. Definition of Entities—Device Scope

The device driver assembly (DEVxxx) implements the core functionality of the driver. An instance of this assembly is created for each installed device that is supported by the driver. DEVxxx consists of the following major parts:

MCC—Communications Protocol Core sub-assembly. MCC converts the application requests into application messages.

TRAxxx—Transport interface sub-assembly. TRAxxx provides a transparent OS-independent error-free interface to device.

Following is a detailed description of the components that make up DEVxxx.

DEVxxx—Device Assembly

DEVxxx assembles MCC, TRAxxx and DM_PEX. This allows the DEVxxx internal structure to be invisible to the outside, so that the device portion of the driver can be created and used as a single component.

MCC—Communications Protocol Core

MCC is the device communication protocol assembly. It does not contain device-specific parts. MCC implements the appropriate Application message protocol. MCC receives the application requests, converts them into application messages and sends them to the device. It keeps track of requests submitted and completes them when the corresponding device responses are received. MCC receives all device notifications and stores them until the user-mode application acquires them.

TRAxxx—Transport Assembly

This assembly implements the device transport protocol. It is responsible for acquiring exclusive access to the communication driver and detecting the device. TRAxxx implements the appropriate transport protocol. TRAxxx provides a uniform interface for communication with the device applications. It has different implementation for the different transport media. The transport assembly contains parts that are operating system specific; it has different implementations under the different target systems.

DM_PEX—Property Exposer

DM_PEX gives any part connected to its prop terminal the ability to access the properties of the assembly that DM_PEX it is contained within. It allows manipulation of assembly's properties (including its subordinates) from a part connected to the assembly.

DM_PEX is a DriverMagic library part provided with Advanced Part Library. Refer to the part library reference in the Object Dynamics” Advanced Part Library document for a complete description.

Communications Protocol Core Scope

The MCC assembly and all parts in it are platform-independent. They are shared between Windows NT and Windows 95/98.

MCC contains of the following parts:

driver interface assembly—IF_IFA

session manager—SES

event sequencer—DM_SEQ

exception handler—DM_EXC.

IF_IFA—Interface Assembly IF IFA assembles parts that convert the incoming IOCTL requests to self-contained events and distribute those events its various output terminals according to their function. IF_IFA converts the incoming IOCTL requests to self-contained events sent out through call, nfy and prp terminals.

SES—Device Session Manager

SES is the device session assembly for MCP driver. It translates the requests incoming on its inputs into application messages and sends them out to the device. It keeps track of requests submitted and completes them when the corresponding device responses are received. SES receives all device notifications and stores them until the user-mode application acquires them.

DM_SEQ—Event Sequencer

DM_SEQ distributes incoming events received on in to the parts connected to the out1 and out2 terminals.

The events sent through outs and out2 can be completed either synchronously or asynchronously—DM_SEQ takes care of the proper sequencing, completion and necessary cleanup.

DM_SEQ is used to distribute device life-cycle events between the session manager and the transport assembly.

DM_SEQ is a DriverMagic library part provided with Advanced Part Library. Refer to the part library reference in the Object Dynamics” Advanced Part Library document for a complete description.

DM_EXC—Exception Handler/Event Log

DM_EXC displays the exception events generated by Session manager (SES) to the debug console and/or saves them in the Windows NT system event log or into a text file in Windows 95/98.

DM_EXC is a DriverMagic library part. Refer to the part library reference in the DriverMagic User Manual for a complete description (Windows NT) and the DriverMagic WDM_Driver Kit Reference (Windows 95/98).

11. Assembly descriptor for DRV

| | |
|---|---|
| /* --------------------------------------------------------------------- | */ |

| | | |
|---|---|---|
| /* | DRV: Driver Assembly | */ |

| | |
|---|---|
| /* | */ |

| | | |
|---|---|---|
| /* | DR_DRV.C - MCP Driver Assembly | */ |

| | | |
|---|---|---|
| /* Version 1.00 | $Revision: | $ */ |

| | |
|---|---|
| /* --------------------------------------------------------------------- | */ |

// ClassMagic support
#include <cmagic.h>
#include <dm_arr.h>

| | |
|---|---|
| #include <i_dio.h> | // for the DIO_MAP_BUFFERED const |

#pragma hdrstop
// project definitions
#define MODULENAME “DR_DRV”
#include <prjdefs.h>
#include <re_ctl.h> // Exception message IDs. Generated

// from re_ctl.mc

#include <re_exctxt.h> // Exception messages text
#if defined(PRJ_SDK_n3f) || defined(PRJ_SDK_n3c)

#define_WIN_NT_PROJECT_{—}

#endif
#define DFLT_CLASS_NAME “DEVSER”
#define PKG_EXT_CLASS_MAP
PRJ_REGISTRY_ROOT_9x“\\Parameters\\ExternalClassMap”
/* --- Self Definitions ------------------------------------------------ */
BEGIN_SELF

decl_pass (drv)
// properties
DRIVER_OBJECT *drv_objp; // grp property storage

END_SELF
/* --- Default Implementations ------------------------------------------- */
PART (DR_DRV, “MCP Driver Assembly”);
/* * --- Terminal/Property declarations ---------------------------------- */
TERMINALS (DR_DRV)

pass (drv)

END_TERMINALS
PROPERTIES (DR_DRV)

prop_grp_uint32 (drv_objp , fac, driver_objectp )

#ifdef_WIN_NT_PROJECT_{—}

prop_grp_uint32 (drv_objp , exc, io_objectp )

#endif

prop_bcast_unicodez (reg_root)
prop_redir (dflt_class_name, fac, dflt_class_name)
prop_redir (device_type , fac, device_type )

END_PROPERTIES
/* * --- Subordinates ----------------------------------------------------- */
SUBORDINATES (DR_DRV)

part (fac, DM_FAC)

| param (fac, dflt_class_name, DFLT_CLASS_NAME ) | |
|---|---|
| param (fac, buf_mapping , DIO_MAP_BUFFERED ) | |
| param (fac, device_type , FILE_DEVICE_UNKNOWN) | |
| param (fac, status_xlat , 1 | ) // custom statuses |

// translated to
// (s | 0xe0000000)

#ifdef_WIN_NT_PROJECT_{—}

| | |
|---|---|
| param (fac, multiplex , TRUE | ) |

#else

| | |
|---|---|
| param (fac, mux_dio , TRUE | ) |
| param (fac, mux_ext , TRUE | ) |
| param (fac, pnp , FALSE | ) |

| | |
|---|---|
| param (fac, copy_stkloc , FALSE | ) |

part (ldr, DM_PKGLDR)

param (ldr, pkg_map_key , PKG_EXT_CLASS_MAP )

#endif

| part (prm, DM_PRM) | |
|---|---|
| part (ren, DM_REN) | |
| array (arr, DEVSER, CMARR_GENERATE_KEYS) | // note: class name is |
| | // set from the outside |

#ifdef_WIN_NT_PROJECT_{—}

part (exc, DM_EXC)

#else

part (exc, MCP_EXC95)

param (exc, file_name , EXC_LOG_FILE_NAME )
param (exc, event_log , FALSE )
param (exc, debug_output , TRUE )
param (exc, file_name , EXC_LOG_FILE_NAME )
param (exc, fmt[0].id , FWK_INTERNAL_ERROR )
param (exc, fmt[0].string , FWK_INTERNAL_ERROR_TXT )
param (exc, fmt[1].id , FWK_NO_DEVICES )
param (exc, fmt[1].string , FWK_NO_DEVICES_TXT )
param (exc, fmt[2].id , FWK_DEV_ACTIVATE_FAILED )
param (exc, fmt[2].string , FWK_DEV_ACTIVATE_FAILED_TXT)
param (exc, fmt[3].id , FWK_CREATE_ALIAS_FAILED )
param (exc, fmt[3].string , FWK_CREATE_ALIAS_FAILED_TXT)
param (exc, fmt[4].id , RRP_CLAIMED_FAILED )
param (exc, fmt[4].string , RRP_CLAIMED_FAILED_TXT )
param (exc, fmt[5].id , RRP_RES_CONFLICT )
param (exc, fmt[5].string , RRP_RES_CONFLICT_TXT )
param (exc, fmt[6].id , RRP_UNCLAIMED_FAILED )
param (exc, fmt[6].string , RRP_UNCLAIMED_FAILED_TXT )

#endif
END_SUBORDINATES
/* * --- Connections ----------------------------------------------------- */
CONNECTIONS (DR_DRV)

connect ($ , drv , fac, drv )
connect (fac, dio , arr, dio )

#ifdef_WIN_NT_PROJECT_{—}

connect (fac, fac , prm, i_fac)

#else

connect (fac, fac , ldr, i_fac)
connect (ldr, o_fac, prm, i_fac)
connect (ldr, o_prp, prm, i_prp)

#endif

connect (fac, prp , prm, i_prp)
connect (prm, o_fac, arr, fact )
connect (prm, o_prp, arr, prop )
connect (fac, edev, ren, edev )
connect (fac, eprp, ren, eprp )
connect (fac, exc , exc, exc )

END_CONNECTIONS

12. Limits of the Implementation

The following list outlines the limitations of an embodiment of the inventive container, none of which is necessary for practicing the present invention as claimed herein and none of which is necessarily preferred for the best mode of practicing the invention. Moreover, none of the following should be viewed as a limitation on means envisioned in the claims for practicing the invention as outlined herein above and below:

1. DM_ARR is built for the ClassMagic object-composition engine used in the DriverMagic system, and thus can be used directly only with that system. As a result, it is a DriverMagic component object, and can contain only other component objects acceptable to DriverMagic. The reason for choosing that system for the preferred embodiment is that, to inventors best knowledge, it is the only composition-based system applicable in a wide area of applications that does not sacrifice performance.

2. DM_ARR uses the ClassMagic part array API as means to create, destroy, connect and disconnect, manipulate properties and activation state, maintain the list of contained objects, and other functions, related to the contained objects. The reason for using this API is that the ClassMagic engine provides it and, thus it was advantageous to use the existing implementation.

3. DM_ARR identifies object classes, terminals and properties by names (text strings). Other identification mechanisms include without limitation, Microsoft COM GUID, integer values, IEEE 802.3 Ethernet MAC addresses, etc. The reason for using names is that the DriverMagic system uses names to identify these entities, which makes it easy for practitioners to remember and use.

4. DM_ARR does not provide a built-in mechanism for dispatching (i.e., multiplexing or demultiplexing) multiple connections between an object outside the container and one or more objects contained in the container. When using this implementation, said dispatching is preferably provided through separate adapter objects or by the outside objects, advantageously allowing the container to be used with a variety of dispatch mechanisms.

5. DM_ARR does not provide the ability to add already created objects to the container and to remove objects from the container without destroying said objects. The reason for this is that there was no perceived need for this feature.

6. DM_ARR provides the ability to hold references (object IDs, oids) of the contained objects instead of the contained objects themselves. The reason for this is that the DriverMagic system does not provide mechanisms for one object to physically contain the memory of other objects.

Dynamic Structure Support

Factories

DM_FAC—Device Driver Factory (WDM)

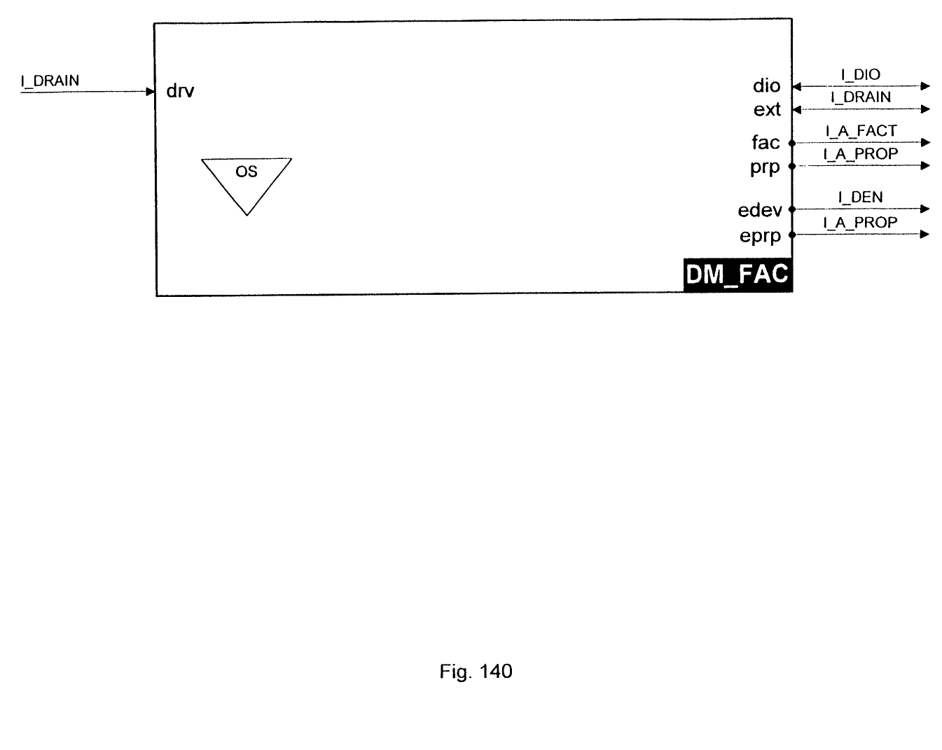

FIG. 140 illustrates the boundary of the inventive DM_FAC part for WDM.

DM_FAC is a generic factory for WDM device drivers including Plug-n-Play (PnP) drivers. The determination of whether the factory will support PnP or not is based on the values set on ext_irp and EXT_xxx properties. If DM FAC is to handle any PnP-related IRPs, it is assumed that this is a factory for PnP driver (operates in PnP mode), otherwise it is not.

DM_FAC provides the necessary functionality to register the driver's entry points with Windows and, if necessary, to enumerate and register the devices controlled by the driver. The device enumeration is not implemented by DM_FAC—it relies on the part connected to the edev and eprp terminals for this. For each registered device DM_FAC creates and parameterizes a device instance through the array control interfaces (fac and prp).

For PnP drivers DM_FAC provides the functionality to dynamically register and deregister devices as they appear and disappear from the system.

DM_FAC registers to receive all the basic device I/O requests for the driver and dispatches them through the dio interface to the appropriate device instance. Depending on the value of its ext_irp and EXT_xxx properties, DM_FAC also registers to receive other I/O requests and dispatches them to the ext interface.

Synchronous and asynchronous I/O request completion is provided on both the dio and ext interfaces. Note that DM_FAC allows asynchronous completion even for its device factory functionality—IRPs signifying that PnP devices have been removed from the system can be completed asynchronously.

DM_FAC has a notification input through which it is informed of driver life-cycle events.

All outgoing calls on DM_FAC's interfaces are executed in the same context that Windows I/O Manager used to enter the driver—this is either a system thread or an application thread and the IRQ level is always PASSIVE (normal thread context).

IMPORTANT NOTE: DM_FAC cannot be used to implement drivers that accept I/O requests at DISPATCH level.

1. Boundary

1.1. Terminals

Terminal “drv” with direction “In” and contract I_DRAIN. Note: Life cycle related events.

Terminal “dio” with direction “Bidir” and contract In: I_DIO Out: I_DIO_C. Note: Device I/O and configuration/status operations. The back channel can be used for asynchronous completion of operations. DM_FAC implements the dio.complete as an unguarded operation, which can be called both in thread context (PASSIVE_IRQL) and in dispatch context (DISPATCH_IRQL). dio is a multiplexed output, connectable at active time.

Terminal “ext” with direction “Plug” and contract I_DRAIN. Note: IRPs not covered by the I_DIO interface are routed through this terminal. DM_FAC provides only the IRP pointer to the callee. The back channel can be used for asynchronous completion of operations. Similarly to dio, the ext input on DM_FAC is unguarded. This terminal may remain unconnected. ext is a multiplexed output, connectable at active time.

Terminal “fac” with direction “Out” and contract I_A_FACT. Note: Part array interface. This terminal is used to create, destroy and enumerate driver instances.

Terminal “prp” with direction “Out” and contract I_A_PROP. Note: Property interface for part arrays. See below for a list of properties that DM_FAC will set on the created device instances.

Terminal “edev” with direction “Out” and contract I_DEN. Note: Device enumeration interface. Unless DM_FAC operates in PnP mode, it requires connection to this terminal to enumerate the devices that have to be created and registered. Floating.

Terminal “eprp” with direction “Out” and contract I_A_PROP. Note: This output is used to get extended information for each device enumerated through edev. Floating.

1.2. Events and Notifications

| Incoming Event | Bus | Notes |
|---|---|---|
| EV_DRV_INIT | B_EV_DRV | DM_FAC must receive this |
| | | notification during the driver |
| | | initialization. DM_FAC will use this |
| | | event to register the driver's entry |
| | | points, and to enumerate and create |
| | | the driver objects. |
| EV_DRV_{—} | B_EV_DRV | DM_FAC must receive this |
| CLEANUP | | notification before the driver is |
| | | unloaded. |
| EV_IRP_NFY_{—} | B_EV_IRP | Complete the IRP specified in the |
| PROC_CPLT | | event bus. |

1.3. Special Events, Frames, Commands or Verbs

None.

1.4. Properties

Property “driver_objectp” of type “UINT32”. Note: Pointer to Windows driver object structure. DM_FAC modifies only the MajorFunction field in the driver object. Mandatory.

Property “ext_irp” of type “UINT32”. Note: A bit mask defining which IRP_MJ_xxx functions to pass to the ext terminal. Bits 0 to 31 correspond to IRP_MJ_xxx codes 0 to 31 respectively. DM_FAC will ignore bits that correspond to IRPs covered by the I_DIO interface or are outside the IRP_MJ_MAXIMUM_FUNCTION code (for WDM this is 27 or 0x1b). DM_FAC will register to receive only those IRP_MJ_xxx calls that have the corresponding bit set in ext_irp. Default: 0x0.

Property “EXT_CREATE_NAMED_PIPE” of type “UINT32”. Note: Boolean. Set to TRUE if DM_FAC is to handle this IRP. The value of this property will be OR-ed with the respective bit in ext_irp property and the result will be used to determine whether DM_FAC will handle a particular IRP or not. Default: FALSE

Property “EXT_QUERY_INFORMATION” of type “UINT32”. Note: Same as above.

Property “EXT_SET_INFORMATION” of type “UINT32”. Note: Same as above.

Property “EXT_QUERY_EA” of type “UINT32”. Note: Same as above.

Property “EXT_SET_EA” of type “UINT32”. Note: Same as above.

Property “EXT_FLUSH_BUFFERS” of type “UINT32”. Note: Same as above.

Property “EXT_QUERY_VOLUME_INFORMATION” of type “UINT32”. Note: Same as above.

Property “EXT_SET_VOLUME_INFORMATION” of type “UINT32”. Note: Same as above.

Property “EXT_DIRECTORY_CONTROL” of type “UINT32”. Note: Same as above.

Property “EXT_FILERSYSTEM_CONTROL” of type “UINT32”. Note: Same as above.

Property “EXT_INTERNAL_DEVICE_CONTROL” of type “UINT32”. Note: Same as above.

Property “EXT_SHUTDOWN” of type “UINT32”. Note: Same as above.

Property “EXT_LOCK_CONTROL” of type “UINT32”. Note: Same as above.

Property “EXT_CREATE_MAILSLOT” of type “UINT32”. Note: Same as above.

Property “EXT_QUERY_SECURITY” of type “UINT32”. Note: Same as above.

Property “EXT_SET_SECURITY” of type “UINT32”. Note: Same as above.

Property “EXT_POWER” of type “UINT32”. Note: Same as above.

Property “EXT_SYSTEM_CONTROL” of type “UINT32”. Note: Same as above.

Property “EXT_DEVICE_CHANGE” of type “UINT32”. Note: Same as above.

Property “EXT_QUERY_QUOTA” of type “UINT32”. Note: Same as above.

Property “EXT_SET_QUOTA” of type “UINT32”. Note: Same as above.

Property “EXT_PNP” of type “UINT32”. Note: Same as above.

Property “EXT_PNP_POWER” of type “UINT32”. Note: Same as above.

Property “pnp” of type “UINT32”. Note: Boolean. Set to non-zero (TRUE) to indicate that DM_FAC will handle PnP events (IRP_MJ_PNP_xxx). Setting this property to TRUE is equivalent to setting IRP_MJ_PNP and IRP_MJ_PNP_POWER to TRUE or setting the respective bit in ext-irp to 1. When TRUE, DM_FAC ignores the settings of the EXT_PNP and EXT_PNP_POWER properties (DM_FAC will always handle these IRPs). Default: FALSE

Property “dflt_class_name” of type “ASCIZ”. Note: The class name to use when creating device instances, in case the device enumerator does not provide a class name. Default: FW_DEV

Property “mux_dio” of type “UINT32”. Note: Boolean. This property defines whether DM_FAC should use the dio interface as a multiplexed output or as normal output. If it is set to non-zero, DM_FAC will multiplex the output using the id returned from the fac interface when device instances are created. If this property is 0, DM_FAC will permanently select the first connection on the dio output and send all calls to it. Default: TRUE.

Property “mux_ext” of type “UINT32”. Note: Boolean. This property defines whether DM_FAC should use the ext interface as a multiplexed output or as normal output. If it is set to non-zero, DM_FAC will multiplex the output using the id returned from the fac interface when device instances are created. If this property is 0, DM_FAC will permanently select the first connection on the dio output and send all calls to it. Default: TRUE.

Property “device-type” of type “UINT32”. Note: Device type identifier to use when registering the devices with the operating system. This property is optional—the default value is

FILE_DEVICE_UNKNOWN (0x22). Use values between 0x8000 and 0xffff for custom-defined types. Note that, although this is not enforced, the device type value is normally used in the high-order word (bits 31.16) of the IOCTL codes for this type of device.

Property “buf_mapping” of type “UINT32”. Note: If set to DIO_MAP_BUFFERED DM_FAC will set DO_BUFFERED_{—}10 flag in the device objects. Default: DIO_MAP_BUFFERED

Property “force_free” of type “UINT32”. Note: Boolean. If TRUE, DM_FAC will free the self-owned events with no regard what the event processing status is. Default: FALSE

Property “copy_stkloc” of type “UINT32”. Note: Boolean. If TRUE, DM_FAC will copy the current stack location to the next one (if any) before sending any IRP events through its ext terminal. Default: TRUE

Property “dev_cls_guidp” of type “UINT32”. Note: Pointer to a GUID identifying the class of devices DM_FAC registers device interfaces for. For a list of device class GUIDs, consult the Microsoft DDK documentation. If NULL, device interfaces will not be registered. Default: NULL

Property “dev_ref” of type “UNICODEZ”. Note: Reference string used when registering device interfaces. For description of device interfaces and reference strings, consult the Microsoft DDK documentation. Default:

Property “dev_name_base” of type “UNICODEZ”. Note: Base (prefix) name for symbolic links created for each device. See discussion at the end of this table. If empty string (“ ”), symbolic link will not be registered. Default:

Property “status_xlat” of type “UINT32”. Note: Specifies how DM_FAC translates return statuses that are propagated back up to user mode (Win32). Possible values are 0 (standard NT error codes), 1 (standard NT error codes and custom error codes), and 2 (only custom error codes). See the Mechanisms section for more information. Default is 0.

1.5. Properties Provided by DM_FAC to Device Instances

The following optional properties are set on the device instances immediately after they are created through the fac interface:

Property “dev_objp” of type “UINT32”. Note: Pointer to the device object that was created for this instance.

Property “dev_name” of type “ASCIZ”. Note: Device name in kernel mode space. In PnP mode this property is set only if dev_name_base property on DM_FAC is set.

Property “dev_sym_lnk1” of type “ASCIZ”. Note: Symbolic link #1. In PnP mode this property is set only if dev_name_base property on DM_FAC is set.

Property “dev_sym_lnk2” of type “ASCIZ”. Note: Symbolic link #2. Not set in PnP mode.

Property “phys_devp” of type “UINT32”. Note: Pointer to the PDO for the PnP device being added. Set in PnP mode only.

Property “low_dev_objp” of type “UINT32”. Note: Pointer to the lower-level driver device object. Set in PnP mode only.

Property “reg_root” of type “UNICODE”. Note: Path to the device's Registry settings. This is provided by the device enumerator connected to DM FAC's or the PnP Device Manager on AddDevice.

2. Encapsulated Interactions

DM_FAC uses the following Windows I/O manager API:

IoAllocateDriverObjectExtension, IoGetDriverObjectExtension

IoCreateDevice, IoDeleteDevice

IoAttachDeviceToDeviceStack, IoDetachDevice

IoRegisterDeviceInterface

IoGetDeviceProperty

IoCreateSymbolicLink, IoDeleteSymbolicLink

IoCompleteRequest

IoGetCurrentIrpStackLocation, IoCopyCurrentIrpStackLocationToNext

IoMarkIrpPending

DM_FAC also provides the entry points to handle IRPs from the I/O Manager and modifies the DriverObject structure in order to direct the requests to these entry points.

3. Specification

4. Responsibilities

1. On EV_DRV_INIT: register entry points and if the edev terminal is connected, enumerate devices through it, create and parameterize device instances (through fac and prp). If connected, retrieve the following information from the device enumerator:

class name for the device instance

Win32 name(s) to associate with the device

device name (in kernel-mode name space)

2. On basic IRP_MJ_xxx calls from I/O Manager (the ones that match operations in I_DIO): use data from the IRP to fill in the B_DIO bus and pass the operation to dio terminal.

3. Handle dynamic (PnP) device addition and removal and create/destroy device instances for each such device. Provide handling for asynchronous completion of the device removal procedure and destroy the instance upon removal.

4. For dynamic (PnP) device closure, delay cleanup in case the device is still open.

5. If an operation on dio returns any status except CMST_PENDING: translate the status to NT status and complete the IRP.

6. If an operation on dio returns CMST_PENDING: return STATUS_PENDING to Windows without completing the IRP.

7. On dio.complete: retrieve the IRP pointer and the completion status from B_DIO, translate status to NT status and complete the IRP.

8. On IRP_MJ_xxx calls that are not covered by I_DIO—pass the call to ext as an EV_REQ_IRP event. If the call returns any status except CMST_PENDING—translate return status and complete the IRP.

9. On EV_REQ_IRP completion event from ext—translate completion status and complete the IRP.

10. Translate the return statuses that are propagated back up to user mode according to the status_xlat property.

5. Theory of Operation

5.1. State Machine

None

5.2. Main Data Structures

DriverObject (System-Defined)

DM_FAC expects to receive a valid pointer to a DriverObject structure with the EV_DRV_INIT event. It modifies the MajorFunction field in this structure to register its entry points. It also passes this structure to the Windows I/O Manager when creating device instances.

DeviceObject (System-Defined)

Windows returns a DeviceObject structure when a new device is created. DM_FAC uses a public field in this structure (DeviceExtension) to store its per-device context.

IRP (System-Defined)

This structure is used by the I/O Manager to pass requests and their arguments for all driver functions (IRP_MJ_xxx).

5.3. Mechanisms

Name and Symbolic Link

In non-PnP mode, the symbollic link to device instances (if any) are provided by the device enumerator connected to the edev terminal. Up to 2 such links can be registered.

In PnP mode, DM_FAC registers symbolic links (Win32 names) to device instances using the value of dev_base_name as a prefix and appending to it the value of DevicePropertyDriverKeyName.

The latter is a persistent identifier of a device. Windows computes this identifier the first time a device appears on a particular slot in a particular hardware bus⁴ and remembers it in a persistent part of the registry. DM_FAC will replace any backslash characters (“ ”) with dots (“.”), so that this identifier can be used as part of a symbolic link name. 4 Note that one and the same device plugged into different hardware buses or even different slots of the same bus, will have different persistent identifiers.

Registry Access

DM_FAC does not read directly from the Registry.

In non-PnP mode, a device enumerator connected to the edev terminal is expected to provide registry path for each device. This path will be passed as a property (reg_root) to the corresponding device instance created by DM_FAC.

In PnP mode, the registry root is calculated by the value of DevicePropertyDriverKeyName property appended to HKLM\System\CurrentControlSet\Services\Class.

Dispatching Operations to Device Instances

DM_FAC's dio and ext terminals are (independently) multiplexed to allow multiple device instances to be connected to these terminals. The default mechanism for multiplex output selection provided by ClassMagic is not atomic—it requires separate “select” and “call” operations. This cannot be used in DM_FAC, because these terminals are not called in a guarded context and may be re-entered from different execution contexts simultaneously.

DM_FAC does not enter any critical sections while it is calling dio and ext operations to allow the device instances to execute in the same context in which DM_FAC was entered by I/O Manager. If it is necessary, the parts that represent the device instances should provide their own guarding (e.g., the standard part terminal guard provided by ClassMagic).

To overcome this restriction, DM_FAC enters a critical section to perform the multiplex output selection and retrieve a valid v-table interface pointer to the selected part. It then calls the operation using the interface pointer outside of the critical section.

Translating DriverMagic Status Codes

DM_FAC translates CMST_xxx status codes (that are returned from invoking operations on the dio and ext terminals—synchronous or asynchronous) into Windows NT status codes or custom status codes defined by the user. These codes are then propagated up to the user mode environment (Win32).

The status translation is controlled through the status_xlat property. This property may have one of the following values:

0: Standard NT status codes only (see status table below)

1: Standard NT status codes and custom (user-defined) status codes

2: Custom (user-defined) status codes only

If translating to standard NT status codes (status_xlat is 0 or 1), DM_FAC uses a status table that maps CMST_xxx statuses to NT statuses. These NT statuses are then converted into Win32 error codes by the operating system.

If the CMST_xxx status code is not found in the table, either the status is mapped to STATUS_UNSUCCESSFULL (status_xlat is 0) or it is mapped to a custom status (status_xlat is 1) by ANDing the status code with 0xE0000000 (this tells the operating system that this is a user-defined status code—the OS will pass the code up to user mode without modification).

If status_xlat is 2, the status codes are always user-defined and are ANDed with 0xE0000000 as described above. In this case, DM_FAC does not use the table to map the status codes. In user mode, the Win32 status code can be ANDed with 0x1FFFFFFF to extract the user-defined status code.

Note that the status codes from Plug-n-Play and power IRPs are always converted to the proper NT status code without reguard to the status_xlat property.

Below is a table showing the mapping of the DriverMagic status codes to NT status codes:

| DriverMagic Status | NT Status |
|---|---|
| CMST_OK | ERROR_SUCCESS |
| CMST_ALLOC | STATUS_NO_MEMORY |
| CMST_NO_ROOM | STATUS_INSUFFICIENT_{—} |
| | RESOURCES |
| CMST_OVERFLOW | STATUS_BUFFER_TOO_SMALL |
| CMST_UNDERFLOW | STATUS_INVALID_PARAMETER |
| CMST_EMPTY | STATUS_PIPE_EMPTY |
| CMST_FULL | STATUS_DISK_FULL |
| CMST_EOF | STATUS_END_OF_FILE |
| CMST_INVALID | STATUS_INVALID_PARAMETER |
| CMST_BAD_VALUE | STATUS_INVALID_PARAMETER |
| CMST_OUT_OF_RANGE | STATUS_INVALID_PARAMETER |
| CMST_NULL_PTR | STATUS_INVALID_PARAMETER |
| CMST_BAD_SYNTAX | STATUS_INVALID_PARAMETER |
| CMST_BAD_NAME | OBJECT_NAME_INVALID |
| CMST_UNEXPECTED | STATUS_INTERNAL_ERROR |
| CMST_PANIC | STATUS_INTERNAL_ERROR |
| CMST_DEADLOCK | STATUS_POSSIBLE_DEADLOCK |
| CMST_STACK_OVERFLOW | STATUS_BAD_INITIAL_STACK |
| CMST_REFUSE | STATUS_REQUEST_NOT_{—} |
| | ACCEPTED |
| CMST_NO_ACTION | STATUS_REQUEST_NOT_{—} |
| | ACCEPTED |
| CMST_FAILED | STATUS_UNSUCCESSFULL |
| CMST_NOT_INITED | STATUS_INTERNAL_ERROR |
| CMST_NOT_ACTIVE | STATUS_INTERNAL_ERROR |
| CMST_NOT_OPEN | STATUS_INTERNAL_ERROR |
| CMST_NOT_CONNECTED | STATUS_INTERNAL_ERROR |
| CMST_NOT_{—} | STATUS_INTERNAL_ERROR |
| CONSTRUCTED | |
| CMST_IOERR | STATUS_IO_DEVICE_ERROR |
| CMST_BAD_CHKSUM | STATUS_DEVICE_DATA_ERROR |
| CMST_NOT_FOUND | STATUS_NO_SUCH_FILE |
| CMST_DUPLICATE | STATUS_DUPLICATE_NAME |
| CMST_BUSY | STATUS_BUSY |
| CMST_ACCESS_DENIED | STATUS_ACCESS_DENIED |
| CMST_PRIVILEGE | STATUS_PRIVILEGE_NOT_HELD |
| CMST_SCOPE_VIOLATION | STATUS_ACCESS_DENIED |
| CMST_BAD_ACCESS | STATUS_ACCESS_DENIED |
| CMST_PENDING | STATUS_PENDING |
| CMST_TIMEOUT | STATUS_IO_TIMEOUT |
| CMST_CANCELED | STATUS_CANCELLED |
| CMST_ABORTED | STATUS_CANCELLED |
| CMST_RESET | STATUS_CANCELLED |
| CMST_CLEANUP | STATUS_CANCELLED |
| CMST_OVERRIDE | STATUS_UNSUCCESSFULL |
| CMST_POSTPONE | STATUS_UNSUCCESSFULL |
| CMST_CANT_BIND | STATUS_NO_SUCH_FILE |
| CMST_API_ERROR | STATUS_NOT_IMPLEMENTED |
| CMST_WRONG_VERSION | STATUS_REVISION_MISMATCH |
| CMST_NOT_{—} | STATUS_NOT_IMPLEMENTED |
| IMPLEMENTED | |
| CMST_NOT_SUPPORTED | STATUS_INVALID_DEVICE_{—} |
| | REQUEST |
| CMST_BAD_OID | STATUS_INTERNAL_ERROR |
| CMST_BAD_MESSAGE | STATUS_INTERNAL_ERROR |

Below is a table showing the mapping of the DriverMagic status codes to Win32 (user mode) status codes:

| DriverMagic Status | Win32 Status |
|---|---|
| CMST_OK | NO_ERROR |
| CMST_ALLOC | ERROR_NOT_ENOUGH_{—} |
| | MEMORY |
| CMST_NO_ROOM | ERROR_NO_SYSTEM_{—} |
| | RESOURCES |
| CMST_OVERFLOW | ERROR_INSUFFICIENT_BUFFER |
| CMST_UNDERFLOW | ERROR_INVALID_PARAMETER |
| CMST_EMPTY | ERROR_NO_DATA |
| CMST_FULL | ERROR_DISK_FULL |
| CMST_EOF | ERROR_HANDLE_EOF |
| CMST_INVALID | ERROR_INVALID_PARAMETER |
| CMST_BAD_VALUE | ERROR_INVALID_PARAMETER |
| CMST_OUT_OF_RANGE | ERROR_INVALID_PARAMETER |
| CMST_NULL_PTR | ERROR_INVALID_PARAMETER |
| CMST_BAD_SYNTAX | ERROR_INVALID_PARAMETER |
| CMST_BAD_NAME | ERROR_INVALID_PARAMETER |
| CMST_UNEXPECTED | ERROR_INTERNAL_ERROR |
| CMST_PANIC | ERROR_INTERNAL_ERROR |
| CMST_DEADLOCK | ERROR_POSSIBLE_DEADLOCK |
| CMST_STACK_OVERFLOW | ERROR_STACK_OVERFLOW |
| CMST_REFUSE | ERROR_REQ_NOT_ACCEP |
| CMST_NO_ACTION | ERROR_REQ_NOT_ACCEP |
| CMST_FAILED | ERROR_GEN_FAILURE |
| CMST_NOT_INITED | ERROR_INTERNAL_ERROR |
| CMST_NOT_ACTIVE | ERROR_INTERNAL_ERROR |
| CMST_NOT_OPEN | ERROR_INTERNAL_ERROR |
| CMST_NOT_CONNECTED | ERROR_INTERNAL_ERROR |
| CMST_NOT_{—} | ERROR_INTERNAL_ERROR |
| CONSTRUCTED | |
| CMST_IOERR | ERROR_IO_DEVICE |
| CMST_BAD_CHKSUM | ERROR_CRC |
| CMST_NOT_FOUND | ERROR_FILE_NOT_FOUND |
| CMST_DUPLICATE | ERROR_DUP_NAME |
| CMST_BUSY | ERROR_BUSY |
| CMST_ACCESS_DENIED | ERROR_ACCESS_DENIED |
| CMST_PRIVILEGE | ERROR_PRIVILEGE_NOT_HELD |
| CMST_SCOPE_VIOLATION | ERROR_ACCESS_DENIED |
| CMST_BAD_ACCESS | ERROR_ACCESS_DENIED |
| CMST_PENDING | ERROR_IO_PENDING |
| CMST_TIMEOUT | ERROR_SEM_TIMEOUT |
| CMST_CANCELED | ERROR_OPERATION_ABORTED |
| CMST_ABORTED | ERROR_OPERATION_ABORTED |
| CMST_RESET | ERROR_OPERATION_ABORTED |
| CMST_CLEANUP | ERROR_OPERATION_ABORTED |
| CMST_OVERRIDE | ERROR_GEN_FAILURE |
| CMST_POSTPONE | ERROR_GEN_FAILURE |
| CMST_CANT_BIND | ERROR_FILE_NOT_FOUND |
| CMST_API_ERROR | ERROR_INVALID_FUNCTION |
| CMST_WRONG_VERSION | ERROR_REVISION_MISMATCH |
| CMST_NOT_{—} | ERROR_INVALID_FUNCTION |
| IMPLEMENTED | |
| CMST_NOT_SUPPORTED | ERROR_INVALID_FUNCTION |
| CMST_BAD_OID | ERROR_INTERNAL_ERROR |
| CMST_BAD_MESSAGE | ERROR_INTERNAL_ERROR |

5.4. Use Cases

PnP Device Instance Creation

DM_FAC receives a call from the PnP Device Manager: AddDevice.

Creates an instance (using default class name) of the part responsible for the new device through its fac terminal (device part)

Parameterizes the device part with the arguments of the AddDevice (PDO pointer) and, if eprp is connected with all the properties that the part connected to this terminal reports (using the devid returned by the fac terminal).

Attaches the device instance to the device stack and sets the returned object pointer as a property on the device part.

Activates the device part.

Registers symbolic links computing name for the device instance based on the device id.

PnP Device Instance Destruction (Sync. Completion)

DM_FAC receives an IRP_MN_REMOVE_DEVICE.

Forwards the event out through ext terminal allowing asynchronous completion.

The event completes synchronously.

Deregisters symbolic links, deactivate, destroys device instance and returns.

PnP Device Instance Destruction (Async. Completion)

DM_FAC receives an IRP_MN_REMOVE_DEVICE.

Forwards the event out through ext terminal allowing asynchronous completion.

The forwarding completes asynchronously (CMST_PENDING)—return STATUS PENDING.

When the completion event comes—deregisters symbolic links, deactivate and destroys the instance.

Completes the IRP.

Synchronous Device I/O Operation

DM_FAC receives a call from the I/O Manager and translates it into an I_DIO operation.

If the mux dio property is non-zero, it selects the connection on the dio output (this and the next step are executed as an atomic select-and-call operation)

DM_FAC invokes the operation on dio

The call returns a completion status and DM_FAC translates it to a Windows NT status and completes the IRP sent by the I/O Manager.

Asynchronous Device I/O Operation

DM_FAC receives a call from the I/O Manager and translates it into an I_DIO operation.

If the mux_dio property is non-zero, it selects the connection on the dio output (this and the next step are executed as an atomic select-and-call operation)

DM_FAC invokes the operation on dio

The call returns CMST_PENDING, which indicates that the operation will be completed later. DM_FAC marks the IRP as pending and returns to I/O Manager without completing it.

When the operation is completed, the part connected to dio invokes the I_DIO_C.complete operation on the back channel of the dio interface using the same bus that was used to start the operation (or a copy of it).

DM_FAC retrieves the operation's IRP pointer from the bus and reports the completion to the I/O Manager.

6. Notes

The recipient of the IRP_MN_REMOVE_DEVICE_IRP event (received from the ext terminal) must return the removal completion status from the lower driver to DM_FAC, not its own removal status. Thus, the return status of the IRP_MN_REMOVE_DEVICE_IRP (from DM_FAC) is that of the lower driver.

DM_FAC—Device Driver Factory (NTK)

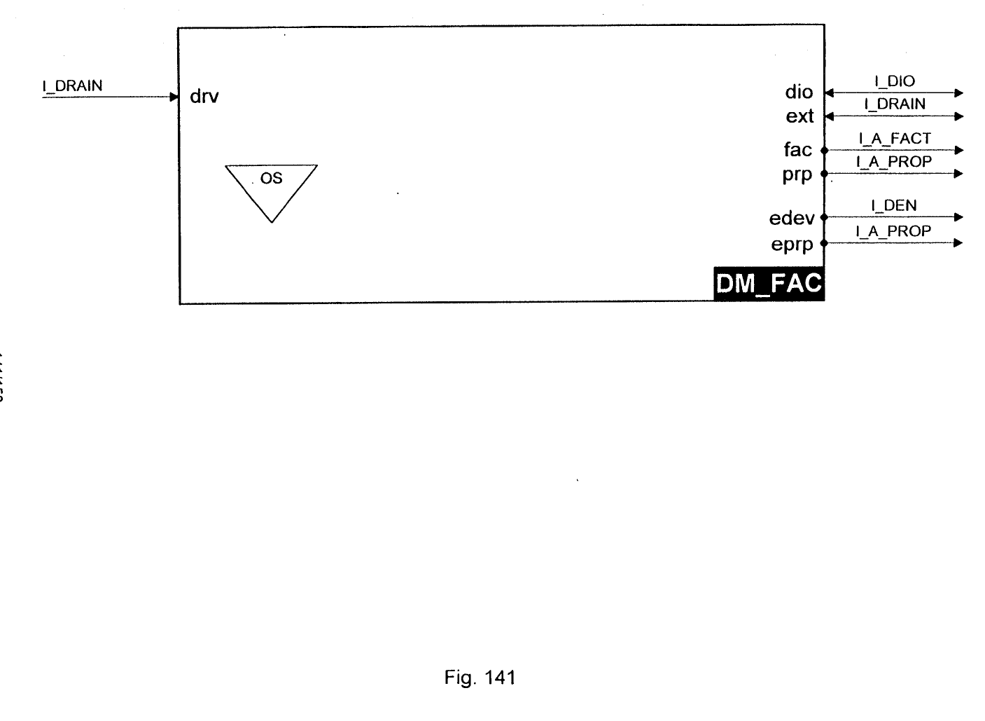

FIG. 141 illustrates the boundary of the inventive DM_FAC part for NTK.

DM_FAC is a generic factory for Windows NT device drivers. Since there can be only one driver in a executable, only one instance of DM_FAC may be created per executable (DM_FAC will enforce this).

DM_FAC provides the necessary functionality to register the driver's entry points with Windows NT and to enumerate and register the devices controlled by the driver. The device enumeration is not implemented by DM_FAC—it relies on the part connected to the edev and eprp terminals for this. For each registered device DM_FAC creates and parameterizes a device instance through the array control interfaces (fac and prp).

DM_FAC registers to receive all the basic device I/O requests for the driver and dispatches them through the dio interface to the appropriate device instance. Depending on the value of its ext_irp property, DM_FAC also registers to receive other I/O requests and dispatches them to the ext interface.

Synchronous and asynchronous I/O request completion is provided on both the dio and ext interfaces.

DM_FAC has a notification input through which it is informed of life-cycle related driver events.

All outgoing calls on DM_FAC's interfaces are executed in the same context that Windows NT I/O Manager used to enter the driver—this is either a system thread or an application thread and the IRQ level is always PASSIVE (normal thread context).

7. Boundary

7. 1. Terminals

Terminal “drv” with direction “In” and contract I_DRAIN. Note: Life cycle related events.

Terminal “dio” with direction “Bidir” and contract In:

I_DIO Out: I_DIO_C. Note: Device I/O and config/status operations. The back channel can be used for asynchronous completion of operations. DM_FAC implements the dio.complete as an unguarded operation, which can be called both in thread context (PASSIVE_IRQL) and in dispatch context (DISPATCH_IRQL). dio is a multiplexed output, connectable at active time.

Terminal “ext” with direction “Plug” and contract I_DRAIN. Note: IRPs not covered by the I_DIO interface are routed through this terminal. DM_FAC provides only the IRP pointer to the callee. The back channel can be used for asynchronous completion of operations. Similarly to dio, the ext input on DM_FAC is unguarded. This terminal may remain unconnected. ext is a multiplexed output, connectable at active time.

Terminal “fac” with direction “Out” and contract I_A_FACT. Note: Part array interface. This terminal is used to create, destroy and enumerate driver instances.

Terminal “prp” with direction “Out” and contract I_A_PROP. Note: Property interface for part arrays. See below for a list of properties that DM_FAC will set on the created device instances.

Terminal “edev” with direction “Out” and contract I_DEN. Note: Device enumeration interface. DM_FAC requires this connection to enumerate the devices that have to be created and registered.

Terminal “eprp” with direction “Out” and contract I_A_PROP. Note: This output is used in conjunction with edev to get extended information for each device enumerated through edev.

7.2. Events and Notifications

| Incoming Event | Bus | Notes |
|---|---|---|
| EV_DRV_INIT | B_EV_DRV | DM_FAC must receive this |
| | | notification during the driver |
| | | initialization. DM_FAC will use this |
| | | event to register the driver's entry |
| | | points, and to enumerate and create |
| | | the driver objects. |
| EV_DRV_{—} | B_EV_DRV | DM_FAC must receive this |
| CLEANUP | | notification before the driver is |
| | | unloaded. |
| EV_IRP_NFY_{—} | B_EV_IRP | Complete the IRP specified in the |
| PROC_CPLT | | event bus. |

7.3. Special Events, Frames, Commands or Verbs

None.

7.4. Properties

Property “driver_objectp” of type “UINT32”. Note: Pointer to Windows NT driver object structure. DM_FAC modifies only the MajorFunction field in the driver object. This property is mandatory.

Property “ext_irp” of type “UINT32”. Note: A bit mask defining which IRP_MJ_xxx functions to pass to the ext terminal. Bits 0 to 31 correspond to IRP_MJ_xxx codes 0 to 31 respectively. DM_FAC will ignore bits that correspond to IRPs covered by the I_DIO interface or are outside the IRP_MJ_MAXIMUM_FUNCTION code (for Windows NT 4.0 this is 27 or 0x1b). DM_FAC will register to receive only those IRP_MJ_xxx calls that have the corresponding bit set in ext_irp. The default value for ext_irp is 0.

Property “dflt_class_name” of type “ASCIZ”. Note: The class name to use when creating device instances, in case the device enumerator does not provide a class name. The default value for this property is “FW_DEV”.

Property “multiplex” of type “UINT32”. Note: This property defines whether DM_FAC should use the dio and ext interfaces as multiplexed outputs or as normal outputs. If it is set to non-zero, DM_FAC will multiplex the outputs using the id returned from the fac interface when device instances are created. If this property is 0, DM_FAC will permanently select the first connection on the dio and ext outputs and send all calls to it. The default value for multiplex is 1 (TRUE).

Property “device_type” of type “UINT32”. Note: Device type identifier to use when registering the devices with the operating system. This property is optional—the default value is

FILE_DEVICE_UNKNOWN (0x22). Use values between 0x8000 and 0xffff for custom-defined types. Note that, although this is not enforced, the device type value is normally used in the high-order word (bits 31. 16) of the IOCTL codes for this type of device.

Property “status_xlat” of type “UINT32”. Note: Specifies how DM_FAC translates return statuses that are propagated back up to user mode (Win32). Possible values are 0 (standard NT error codes), 1 (standard NT error codes and custom error codes), and 2 (only custom error codes). See the Mechanisms section for more information. Default is 0.

7.5. Registry Access

DM_FAC does not read directly from the Registry. The device enumerator connected to the edev terminal is expected to provide a registry path for each device. This path will be passed as a property (reg_root) to the corresponding device instance created by DM_FAC.

7.6. Properties Provided by DM_FAC to Device Instances

The following optional properties are set on the device instances immediately after they are created through the fac interface:

Property “device_objectp” of type “UINT32”. Note: Pointer to the device object that was created for this instance.

Property “reg_root” of type “UNICODE”. Note: Path to the device's Registry settings. This value is provided by the device enumerator connected to DM FAC's edev and eprp outputs.

8. Encapsulated Interactions

DM_FAC calls the Windows NT I/O manager to register devices (IoCreateDevice) and to register Win32-accessible aliases for the devices (IoCreateSymbolicLink).

DM_FAC also provides the entry points to handle IRPs from the I/O Manager and modifies the DriverObject structure in order to direct the requests to these entry points.

9. Specification

10. Responsibilities

On EV_DRV_INIT: register entry points, enumerate devices through edev, and create and parameterize device instances (through fac and prp). Retrieve the following

information from the device enumerator:

class name for the device instance

Win32 name(s) to associate with the device

device name (in kernel-mode name space)

On basic IRP_MJ_xxx calls from I/O Manager (the ones that match operations in I_DIO): use data from the IRP to fill in the B_DIO bus and pass the operation to dio terminal.

If an operation on dio returns any status except CMST_PENDING: translate the status to NT status and complete the IRP.

If an operation on dio returns CMST_PENDING: return STATUS_PENDING to Windows NT without completing the IRP.

On dio.complete: retrieve the IRP pointer and the completion status from B_DIO, translate status to NT status and complete the IRP.

On IRP_MJ_xxx calls that are not covered by I_DIO—pass the call to ext as an EV_IRP_REQ_PROCESS event. If the call returns any status except CMST_PENDING—translate return status and complete the IRP.

On EV_IRP_NFY_PROC_CPLT event from ext—translate completion status and complete the IRP.

Translate the return statuses that are propagated back up to user mode according to the status_xlat property.

11. Theory of Operation

11.1. State Machine

None

11.2. Main Data Structures

DriverObject (System-Defined)

DM_FAC expects to receive a valid pointer to a DriverObject structure with the EV_DRV_INIT event. It modifies the MajorFunction field in this structure to register its entry points. It also passes this structure to the Windows NT I/O Manager when creating device instances.

DeviceObject(System-Defined)

A DeviceObject structure is returned by Windows NT when a new device is created. DM_FAC uses a public field in this structure (DeviceExtension) to store its per-device context.

IRP (System-Defined)

This structure is used by the I/O Manager to pass the arguments for all driver functions (IRP_MJ_xxx).

11.3. Mechanisms

Dispatching Operations to Device Instances

DM_FAC's dio and ext terminals are multiplexed to allow multiple device instances to be connected to these terminals. The default mechanism for multiplex output selection provided by ClassMagic is not atomic—it requires separate “select” and “call” operations. This cannot be used in DM_FAC, because these terminals are not called in a guarded context and may be re-entered from different execution contexts simultaneously.

DM_FAC should not enter any critical sections while it is calling dio and ext operations to allow the device instances to execute in the same context in which DM_FAC was entered by I/O Manager. If it is necessary, the parts that represent the device instances may provide their own guarding (e.g., the standard part terminal guard provided by ClassMagic).

To overcome this restriction, DM_FAC enters a critical section to perform the multiplex output selection and retrieve a valid v-table interface pointer to the selected part. It then calls the operation using the interface pointer outside of the critical section.

Translating DriverMagic Status Codes

DM_FAC translates CMST_xxx status codes (that are returned from invoking operations on the dio and ext terminals—synchronous or asynchronous) into Windows NT status codes or custom status codes defined by the user. These codes are then propagated up to the user mode environment (Win32).

The status translation is controlled through the status_xlat property. This property may have one of the following values:

0: Standard NT status codes only (see status table below)

1: Standard NT status codes and custom (user-defined) status codes

2: Custom (user-defined) status codes only

If translating to standard NT status codes (status_xlat is 0 or 1), DM_FAC uses a status table that maps CMST_xxx statuses to NT statuses. These NT statuses are then converted into Win32 error codes by the operating system.

If the CMST_xxx status code is not found in the table, either the status is mapped to STATUS_UNSUCCESSFULL (status_xlat is 0) or it is mapped to a custom status (status_xlat is 1) by ANDing the status code with 0xE0000000 (this tells the operating system that this is a user-defined status code—the OS will pass the code up to user mode without modification).

If status_xlat is 2, the status codes are always user-defined and are ANDed with 0xE0000000 as described above. In this case, DM_FAC does not use the table to map the status codes. In user mode, the Win32 status code can be ANDed with 0x1FFFFFFF to extract the user-defined status code.

Below is a table showing the mapping of the DriverMagic status codes to NT status codes:

| DriverMagic Status | NT Status |
|---|---|
| CMST_OK | ERROR_SUCCESS |
| CMST_ALLOC | STATUS_NO_MEMORY |
| CMST_NO_ROOM | STATUS_INSUFFICIENT_{—} |
| | RESOURCES |
| CMST_OVERFLOW | STATUS_BUFFER_TOO_SMALL |
| CMST_UNDERFLOW | STATUS_INVALID_PARAMETER |
| CMST_EMPTY | STATUS_PIPE_EMPTY |
| CMST_FULL | STATUS_DISK_FULL |
| CMST_EOF | STATUS_END_OF_FILE |
| CMST_INVALID | STATUS_INVALID_PARAMETER |
| CMST_BAD_VALUE | STATUS_INVALID_PARAMETER |
| CMST_OUT_OF_RANGE | STATUS_INVALID_PARAMETER |
| CMST_NULL_PTR | STATUS_INVALID_PARAMETER |
| CMST_BAD_SYNTAX | STATUS_INVALID_PARAMETER |
| CMST_BAD_NAME | OBJECT_NAME_INVALID |
| CMST_UNEXPECTED | STATUS_INTERNAL_ERROR |
| CMST_PANIC | STATUS_INTERNAL_ERROR |
| CMST_DEADLOCK | STATUS_POSSIBLE_DEADLOCK |
| CMST_STACK_OVERFLOW | STATUS_BAD_INITIAL_STACK |
| CMST_REFUSE | STATUS_REQUEST_NOT_{—} |
| | ACCEPTED |
| CMST_NO_ACTION | STATUS_REQUEST_NOT_{—} |
| | ACCEPTED |
| CMST_FAILED | STATUS_UNSUCCESSFULL |
| CMST_NOT_INITED | STATUS_INTERNAL_ERROR |
| CMST_NOT_ACTIVE | STATUS_INTERNAL_ERROR |
| CMST_NOT_OPEN | STATUS_INTERNAL_ERROR |
| CMST_NOT_CONNECTED | STATUS_INTERNAL_ERROR |
| CMST_NOT_{—} | STATUS_INTERNAL_ERROR |
| CONSTRUCTED | |
| CMST_IOERR | STATUS_IO_DEVICE_ERROR |
| CMST_BAD_CHKSUM | STATUS_DEVICE_DATA_ERROR |
| CMST_NOT_FOUND | STATUS_NO_SUCH_FILE |
| CMST_DUPLICATE | STATUS_DUPLICATE_NAME |
| CMST_BUSY | STATUS_BUSY |
| CMST_ACCESS_DENIED | STATUS_ACCESS_DENIED |
| CMST_PRIVILEGE | STATUS_PRIVILEGE_NOT_HELD |
| CMST_SCOPE_VIOLATION | STATUS_ACCESS_DENIED |
| CMST_BAD_ACCESS | STATUS_ACCESS_DENIED |
| CMST_PENDING | STATUS_PENDING |
| CMST_TIMEOUT | STATUS_IO_TIMEOUT |
| CMST_CANCELED | STATUS_CANCELLED |
| CMST_ABORTED | STATUS_CANCELLED |
| CMST_RESET | STATUS_CANCELLED |
| CMST_CLEANUP | STATUS_CANCELLED |
| CMST_OVERRIDE | STATUS_UNSUCCESSFULL |
| CMST_POSTPONE | STATUS_UNSUCCESSFULL |
| CMST_CANT_BIND | STATUS_NO_SUCH_FILE |
| CMST_API_ERROR | STATUS_NOT_IMPLEMENTED |
| CMST_WRONG_VERSION | STATUS_REVISION_MISMATCH |
| CMST_NOT_{—} | STATUS_NOT_IMPLEMENTED |
| IMPLEMENTED | |
| CMST_NOT_SUPPORTED | STATUS_INVALID_DEVICE_{—} |
| | REQUEST |
| CMST_BAD_OID | STATUS_INTERNAL_ERROR |
| CMST_BAD_MESSAGE | STATUS_INTERNAL_ERROR |

Below is a table showing the mapping of the DriverMagic status codes to Win32 (user mode) status codes:

| DriverMagic Status | Win32 Status |
|---|---|
| CMST_OK | NO_ERROR |
| CMST_ALLOC | ERROR_NOT_ENOUGH_{—} |
| | MEMORY |
| CMST_NO_ROOM | ERROR_NO_SYSTEM_{—} |
| | RESOURCES |
| CMST_OVERFLOW | ERROR_INSUFFICIENT_BUFFER |
| CMST_UNDERFLOW | ERROR_INVALID_PARAMETER |
| CMST_EMPTY | ERROR_NO_DATA |
| CMST_FULL | ERROR_DISK_FULL |
| CMST_EOF | ERROR_HANDLE_EOF |
| CMST_INVALID | ERROR_INVALID_PARAMETER |
| CMST_BAD_VALUE | ERROR_INVALID_PARAMETER |
| CMST_OUT_OF_RANGE | ERROR_INVALID_PARAMETER |
| CMST_NULL_PTR | ERROR_INVALID_PARAMETER |
| CMST_BAD_SYNTAX | ERROR_INVALID_PARAMETER |
| CMST_BAD_NAME | ERROR_INVALID_PARAMETER |
| CMST_UNEXPECTED | ERROR_INTERNAL_ERROR |
| CMST_PANIC | ERROR_INTERNAL_ERROR |
| CMST_DEADLOCK | ERROR_POSSIBLE_DEADLOCK |
| CMST_STACK_OVERFLOW | ERROR_STACK_OVERFLOW |
| CMST_REFUSE | ERROR_REQ_NOT_ACCEP |
| CMST_NO_ACTION | ERROR_REQ_NOT_ACCEP |
| CMST_FAILED | ERROR_GEN_FAILURE |
| CMST_NOT_INITED | ERROR_INTERNAL_ERROR |
| CMST_NOT_ACTIVE | ERROR_INTERNAL_ERROR |
| CMST_NOT_OPEN | ERROR_INTERNAL_ERROR |
| CMST_NOT_CONNECTED | ERROR_INTERNAL_ERROR |
| CMST_NOT_{—} | ERROR_INTERNAL_ERROR |
| CONSTRUCTED | |
| CMST_IOERR | ERROR_IO_DEVICE |
| CMST_BAD_CHKSUM | ERROR_CRC |
| CMST_NOT_FOUND | ERROR_FILE_NOT_FOUND |
| CMST_DUPLICATE | ERROR_DUP_NAME |
| CMST_BUSY | ERROR_BUSY |
| CMST_ACCESS_DENIED | ERROR_ACCESS_DENIED |
| CMST_PRIVILEGE | ERROR_PRIVILEGE_NOT_HELD |
| CMST_SCOPE_VIOLATION | ERROR_ACCESS_DENIED |
| CMST_BAD_ACCESS | ERROR_ACCESS_DENIED |
| CMST_PENDING | ERROR_IO_PENDING |
| CMST_TIMEOUT | ERROR_SEM_TIMEOUT |
| CMST_CANCELED | ERROR_OPERATION_ABORTED |
| CMST_ABORTED | ERROR_OPERATION_ABORTED |
| CMST_RESET | ERROR_OPERATION_ABORTED |
| CMST_CLEANUP | ERROR_OPERATION_ABORTED |
| CMST_OVERRIDE | ERROR_GEN_FAILURE |
| CMST_POSTPONE | ERROR_GEN_FAILURE |
| CMST_CANT_BIND | ERROR_FILE_NOT_FOUND |
| CMST_API_ERROR | ERROR_INVALID_FUNCTION |
| CMST_WRONG_VERSION | ERROR_REVISION_MISMATCH |
| CMST_NOT_{—} | ERROR_INVALID_FUNCTION |
| IMPLEMENTED | |
| CMST_NOT_SUPPORTED | ERROR_INVALID_FUNCTION |
| CMST_BAD_OID | ERROR_INTERNAL_ERROR |
| CMST_BAD_MESSAGE | ERROR_INTERNAL_ERROR |

11.4. Use Cases

Synchronous I/O Operation

DM_FAC receives a call from the I/O Manager and translates it into an I_DIO operation.

If the multiplex property is non-zero, it selects the connection on the dio output (this and the next step are executed as an atomic select-and-call operation)

DM_FAC invokes the operation on dio

The call returns a completion status and DM_FAC translates it to a Windows NT status and completes the IRP sent by the I/O Manager.

Asynchronous I/O Operation

DM_FAC receives a call from the I/O Manager and translates it into an I_DIO operation.

If the multiplex property is non-zero, it selects the connection on the dio output (this and the next step are executed as an atomic select-and-call operation)

DM_FAC invokes the operation on dio

The call returns CMST_PENDING, which indicates that the operation will be completed later. DM_FAC marks the IRP as pending and returns to I/O Manager without completing it.

When the operation is completed, the part connected to dio invokes the I_DIO_C.complete operation on the back channel of the dio interface using the same bus that was used to start the operation (or a copy of it). DM_FAC retrieves the operation's IRP pointer from the bus and reports the completion to the I/O Manager.

DM_VXFAC—VxD Device Driver Factory

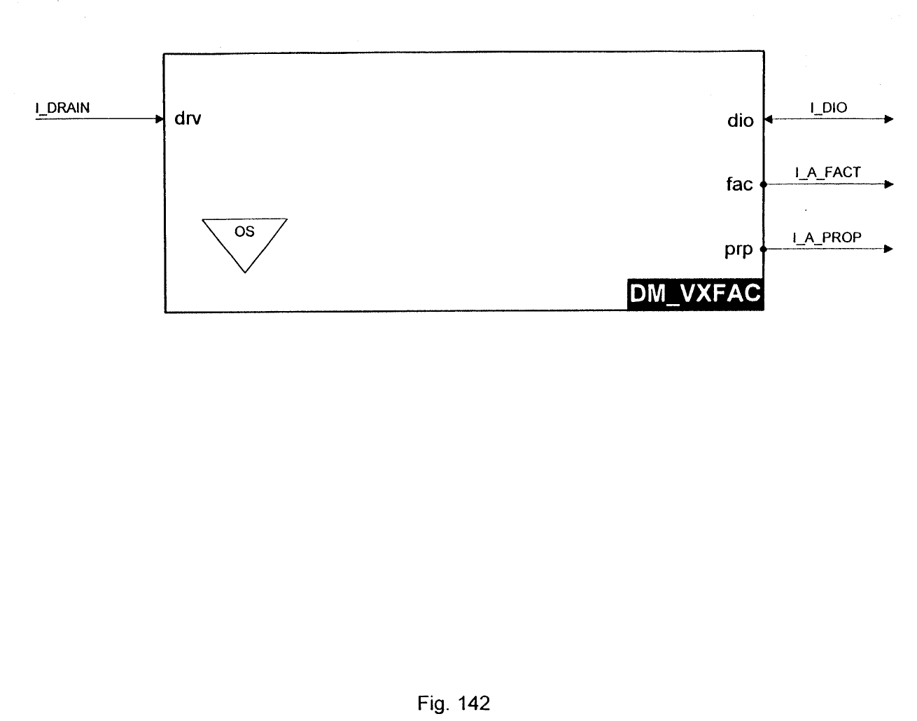

FIG. 142 illustrates the boundary of the inventive DM_VXFAC part.

DM_VXFAC is a generic factory for Windows 95/98 VxD device drivers.

DM_VXFAC translates VxD life-cycle and device I/O control events received on its drv terminal into I_DIO operations that are passed out through the dio terminal.

On driver initialization, DM_VXFAC creates and parameterizes one device instance through the array control interfaces (fac and prp). Typically the device instance receives the dio operation calls generated by DM_VXFAC.

Since there are no specific read and write operations for VxDs, DM_VXFAC allows read and write I/O controls to be defined for a device (specified through properties). When these I/O controls are received by DM_VXFAC, they are translated into dio.read and dio.write operations. All other I/O controls are translated to dio.ioctl.

All dio operations generated by DM_VXFAC may be completed synchronously or asynchronously. DM_VXFAC takes care of the proper operation re-synchronization and completion.

12. Boundary

12.1. Terminals

Terminal “drv” with direction “In” and contract I_DRAIN. Note: Synchronous, vtable, infinite cardinality, unguarded Life cycle and I/O control VxD events are received through this terminal. The life cycle and I/O control events received here are converted into I_DIO operations sent out through the dio terminal. This terminal is compatible with the VxD package events defined in e_vxd.h.

Terminal “dio” with direction “Bidir” and contract In: I_DIO_C Out: I_DIO. Note: Synchronous, vtable, cardinality 1, unguarded, activetime Device I/O operations. DM_VXFAC converts life cycle and I/O control events received from the drv terminal into I_DIO operations sent out through this terminal. The back channel is used for asynchronous completion of operations (as defined by the I_DIO interface).

Terminal “fac” with direction “Out” and contract I_A_FACT. Note: Synchronous, vtable, cardinality 1 Part array factory interface. This terminal is used to create, activate, deactivate and destroy a device instance. DM_VXFAC creates only one device instance.

Terminal “prp” with direction “Out” and contract I_A_PROP. Note: Synchronous, vtable, cardinality 1 Part array property interface for manipulating properties of device instances. See below for a list of properties that DM_VXFAC sets on the created device instances.

12.2. Events and Notifications

| Incoming | | |
|---|---|---|
| Event | Bus | Notes |
| EV_VXD_{—} | B_EV_VXD | VxD initialization event. |
| INIT | | DM_VXFAC must receive this |
| | | notification during the driver initialization. |
| | | DM_VXFAC uses this event to create, |
| | | parameterize and activate the device |
| | | instance assembly. |
| | | Typically, this event is sent by the driver |
| | | packaging. |
| EV_VXD_{—} | B_EV_VXD | VxD cleanup event. |
| CLEANUP | | DM_VXFAC must receive this |
| | | notification before the driver is unloaded. |
| | | DM_VXFAC uses this event to deactivate |
| | | and destroy the device instance assembly. |
| | | Typically, this event is sent by the driver |
| | | packaging. |
| EV_VXD_{—} | B_EV_VXD | VxD life cycle and I/O control event. |
| MESSAGE | | When the W32_DEVICEIOCONTROL |
| | | message is received, DM_VXFAC |
| | | translates the open/close requests |
| | | (DIOC_OPEN and |
| | | DIOC_CLOSEHANDLE) and I/O |
| | | controls into I_DIO operations that are |
| | | passed through the dio terminal. |
| | | DM_VXFAC is parameterized with the |
| | | I/O controls that represent read and write |
| | | operations on the device. All other I/O |
| | | controls are translated into dio.ioctl. |
| | | Typically, this event is sent by the driver |
| | | packaging. |

12.3. Special Events, Frames, Commands or Verbs

None.

12.4. Properties

Property “dflt_class_name” of type “ASCIZ”. Note: Default class name of the device instance assembly. This is the class name to use when creating device instances. DM_VXFAC creates the instance when it receives an EV_VXD_INIT event on the drv terminal. DM_VXFAC only uses this property if the class-name property is empty (“ ”). This property is provided for compatibility with the Windows NT factory (DM_FAC). Default value is “FW_DEV”.

Property “class_name” of type “ASCIZ”. Note: Class name of the device instance assembly. This is the class name to use when creating device instances. DM_VXFAC creates the instance when it receives an EV_VXD_INIT event on the drv terminal. If this property is not equal to “ ”, DM_VXFAC always uses this class name for the device instance. Default value is “a (dflt_class_name is used).

Property “status_xlat” of type “UINT32”. Note: Specifies how DM_VXFAC translates return statuses that are propagated back up to user mode (Win32). Possible values are 0 (standard Win32 error codes), 1 (standard Win32 error codes and custom error codes), 2 (custom error codes only) and 3 (always return success). See the Mechanisms section for more information. Default value is 0.

Property “ioctl_read” of type “UINT32”. Note: I/O control code for read operations. When this I/O control code is received by DM_VXFAC, it converts it into an dio.read operation. Default value is 0 (none).

Property “ioctl_write” of type “UINT32”. Note: I/O control code for write operations. When this I/O control code is received by DM_VXFAC, it converts it into an dio.write operation. Default value is 0 (none).

Property “ioctl_stat_offs” of type “UINT32”. Note: Operation completion status offset. This is the offset (in bytes) into the I/O control data block where the operation's completion status is stored. If −1, DM_VXFAC does not copy the completion status for the operation into the I/O control data block. The size of the storage for the completion status is 4 bytes (unsigned long). Default value is 0 (first field in data block).

Property “cplt_wait_type” of type “UINT32”. Note: Asynchronous completion semaphore flags. These flags control what actions to take when interrupts occur while DM_VXFAC is waiting for an asynchronous open/cleanup/close operation to complete. Default is BLOCK_THREAD_IDLE.

Property “reg_root” of type “ASCIZ”. Note: Registry root path. This is the registry path for the devices registry settings. This path is relative to HKEY_LOCAL_MACHINE. Default value is “ ”.

12.5. Properties Provided by DM VXFAC to Device Instances

The following optional properties are set on the device instance immediately after it is created through the fac terminal:

Property “reg_root” of type “ASCIZ”. Note: Path to the device's registry settings. DM_VXFAC gets the value for this property from its reg_root property (pass-through property). This path is relative to HKEY_LOCAL_MACHINE.

13. Encapsulated Interactions

DM_VXFAC uses the following APIs from VtoolsD for asynchronous operation completion, mutex and semaphore usage:

VWIN32_DIOCCompletionRoutine( )

CreateMutex( )

DestroyMutex( )

EnterMutex( )

LeaveMutex( )

Create_Semaphore( )

Destroy_Semaphore( )

Wait_Semaphore( )

Signal_Semaphore_No_Switch( )

LinPageLock( )

LinePageUnlock( )

14. Specification

15. Responsibilities

On EV_VXD_INIT: create, parameterize and activate a single device instance (through the fac and prp terminals). Create only one device instance.

On EV_VXD_CLEANUP: deactivate and destroy the device instance (through the fac terminal).

On DIOC_OPEN control message (EV_VXD_MESSAGE): generate a dio.open operation call. If operation completes asynchronously (returns CMST_PENDING), wait on a semaphore until the operation is complete.

12.5. Properties Provided by DM_VXFAC to Device Instances

The following optional properties are set on the device instance immediately after it is created through the fac terminal:

Property “reg_root” of type “ASCIZ”. Note: Path to the device's registry settings. DM_VXFAC gets the value for this property from its reg_root property (pass-through property). This path is relative to HKEY_LOCAL_MACHINE.

13. Encapsulated Interactions

DM_VXFAC uses the following APIs from VtoolsD for asynchronous operation completion, mutex and semaphore usage:

VWIN32 DIOCCompletionRoutine( )

CreateMutex( )

DestroyMutex( )

EnterMutex( )

LeaveMutex( )

Create_Semaphore( )

Destroy_Semaphore( )

Wait_Semaphore( )

Signal_Semaphore_No_Switch( )

LinPageLock( )

LinePageUnlock( )

14. Specification

15. Responsibilities

On EV_VXD_INIT: create, parameterize and activate a single device instance (through the fac and prp terminals). Create only one device instance.

On EV_VXD_CLEANUP: deactivate and destroy the device instance (through the fac terminal).

On DIOC_OPEN control message (EV_VXD_MESSAGE): generate a dio.open operation call. If operation completes asynchronously (returns CMST_PENDING), wait on a semaphore until the operation is complete.

On DIOC_CLOSEHANDLE control message (EV_VXD_MESSAGE): generate dio.cleanup and dio.close operation calls. If operations are asynchronous (return CMST_PENDING) wait on a semaphore until the operations complete.

When the read or write I/O control is received (through the EV_VXD_MESSAGE event), generate dio.read and dio.write operations respectively.

On all I/O controls other then DIOC_OPEN, DIOC_CLOSEHANDLE, read or write; generate a dio.ioctl operation.

Allow asynchronous completion of all I_DIO operations.

On dio.complete: retrieve the completion status from B_DIO, translate the completion status and complete the operation.

Translate the completion status for both synchronous and asynchronous operations according to the status_xlat property.

Handle all unrecognized control messages received on drv (all except W32 DEVICEIOCONTROL) by returning CMST_NOT SUPPORTED without entering any critical sections or enabling interrupts.

16. Theory of Operation

16.1. Main Data Structures

DIOCParams (System-Defined)

DM_VXFAC expects to receive a valid pointer to a DIOCParams structure with the EV_VXD_MESSAGE event, W32_DEVICEIOCONTROL message. It copies most of the fields of this structure to a B_DIO bus passed with the corresponding I_DIO operation. Upon operation completion, DM_VXFAC fills in the number of bytes returned in the output buffer (IpcbBytesReturned field).

OVERLAPPED (System-Defined)

DM_VXFAC expects to receive a valid pointer to an OVERLAPPED structure with the EV_VXD_MESSAGE event, W32-DEVICEIOCONTROL message for devices using overlapped I/O. The Win32 event contained in this structure is signaled by the operating system when a pending operation has completed.

16.2. Mechanisms

Driver Initialization and Cleanup

When the VxD containing DM_VXFAC is loaded (or is opened using CreateFile( ), DM_VXFAC receives a EV_VXD_INIT event. In response to this event, DM_VXFAC creates an instance of the device's class (specified by the class_name property). DM_VXFAC then parameterizes and activates the instance. DM_VXFAC enforces that only one instance of the driver's class may exist at any time—DM_VXFAC fails additional EV_VXD_INIT events.

When the VxD is unloaded (or is closed using CloseHandle( ) or DeleteFile( ), DM_VXFAC receives an EV_VXD_CLEANUP event. In response to this event, DM_VXFAC deactivates and destroys the device instance. Additional EV_VXD_CLEANUP events are ignored.

Dispatching Open/Close Operations to Device Instances

When the device is opened using the CreateFile( ) Win32 API, DM_VXFAC receives a DIOC_OPEN message (through the EV_VXD_MESSAGE event). DM_VXFAC fills out a B_DIO bus and translates this message into a dio.open operation.

When the device is closed using the CloseHandle( ) Win32 API, DM_VXFAC receives a DIOC_CLOSEHANDLE message (through the EV_VXD_MESSAGE event). DM_VXFAC fills out a B_DIO bus and translates this message into dio.cleanup and dio.close operations.

If the dio.open, dio.cleanup or dio.close operations complete asynchronously (return CMST_PENDING), DM_VXFAC waits on a semaphore until the operation completes. When dio.complete is called to complete the pending operation, the semaphore is signaled and DM_VXFAC completes the operation. This is necessary because the open and close operations issued by the operating system must complete synchronously.

Dispatching I/O Control Operations to Device Instances

I/O control operations are sent as EV_VXD_MESSAGE events (W32 DEVICEIOCONTROL message) when an application uses the DeviceIOControl( ) Win32 API. The application is expected to pass a pointer to the following structure as the input and output buffers for the I/O control:

typedef struct XXX

{
unsigned long cplt_s ; // IOCTL completion status
unsigned long reserved ; // reserved for internal use
// additional I/O control data here
} XXX;

// nb: no equivalent functionality is provided by the Windows
// NT device driver factory.

The first two fields must be the completion status and a reserved field. Additional fields may be added depending on the operation of the I/O control.

The cplt_S field is used to store the operation completion status. For asynchronous operations (Overlapped I/O), DM_VXFAC returns pending status (DeviceIOControl( ) returns FALSE and GetLastError( )==ERROR_IO_PENDING). When the operation completes, DM_VXFAC copies the operation completion status into the I/O control structure.

When DM_VXFAC receives the I/O control, it checks if the I/O control code is equal to ioctl_read or ioctl_write. If so, DM_VXFAC generates dio.read and dio.write operations respectively. All other I/O controls are translated into dio.ioctl operations.

I/O control operations may be processed synchronously or asynchronously.

For synchronous and asynchronous operations, DM_VXFAC always updates the cplt_s field with the completion status of the operation (if ioctl_stat_offs !=−1). This allows a driver to fail an asynchronous operation; the application checks the cplt_s field for the completion status.

Translating DriverMagic Status Codes

DM_VXFAC translates CMST_xxx status codes (that are returned from invoking operations on the dio terminal—synchronous or asynchronous) into Win32 status codes or custom status codes defined by the user. These codes are then propagated up to the user mode environment (Win32).

The status translation is controlled through the statusxlat property. This property may have one of the following values:

0: Standard Win32 status codes only (see status table below)

1: Standard Win32 status codes and custom status codes

2: Custom (user-defined) status codes only

3: Success status always

If translating to standard Win32 status codes (status_xlat is 0 or 1), DM_VXFAC uses a status table that maps CMST_xxx statuses to Win32 statuses.

If the CMST_xxx status code is not found in the table, either the status is mapped to ERROR_GEN_FAILURE (status_xlat is 0) or it is mapped to a custom status (status_xlat is 1) by ORing the status code with 0xE0000000 (this tells the operating system that this is a user-defined status code—the operating system passes the code up to user mode without modification).

If status_xlat is 2, the status codes are always user-defined and are ORed with 0xE0000000 as described above. In this case, DM_VXFAC does not use the table to map the status codes. In user mode, the Win32 status code can be ANDed with 0x1FFFFFFF to extract the user-defined status code.

If status_xlat is 3, DM_VXFAC always returns success (NO_ERROR) for the operation. A Win32 application can check the status code by checking the completion status in the operation bus (cplt_S). This field will always contain the status returned by the operation ORed with 0xE0000000. This type of status translation is provided since there is no way to return errors for asynchronous operations.

Note that the status translation does not apply to DIOC_OPEN and DIOC_CLOSEHANDLE.

Below is a table showing the mapping of the DriverMagic status codes to Win32 (user mode) status codes:

| DriverMagic Status | Win32 Status |
|---|---|
| CMST_OK | NO_ERROR |
| CMST_ALLOC | ERROR_NOT_ENOUGH_{—} |
| | MEMORY |
| CMST_NO_ROOM | ERROR_NO_SYSTEM_{—} |
| | RESOURCES |
| CMST_OVERFLOW | ERROR_INSUFFICIENT_BUFFER |
| CMST_UNDERFLOW | ERROR_INVALID_PARAMETER |
| CMST_EMPTY | ERROR_NO_DATA |
| CMST_FULL | ERROR_DISK_FULL |
| CMST_EOF | ERROR_HANDLE_EOF |
| CMST_INVALID | ERROR_INVALID_PARAMETER |
| CMST_BAD_VALUE | ERROR_INVALID_PARAMETER |
| CMST_OUT_OF_RANGE | ERROR_INVALID_PARAMETER |
| CMST_NULL_PTR | ERROR_INVALID_PARAMETER |
| CMST_BAD_SYNTAX | ERROR_INVALID_PARAMETER |
| CMST_BAD_NAME | ERROR_INVALID_PARAMETER |
| CMST_UNEXPECTED | ERROR_INTERNAL_ERROR |
| CMST_PANIC | ERROR_INTERNAL_ERROR |
| CMST_DEADLOCK | ERROR_POSSIBLE_DEADLOCK |
| CMST_STACK_OVERFLOW | ERROR_STACK_OVERFLOW |
| CMST_REFUSE | ERROR_REQ_NOT_ACCEP |
| CMST_NO_ACTION | ERROR_REQ_NOT_ACCEP |
| CMST_FAILED | ERROR_GEN_FAILURE |
| CMST_NOT_INITED | ERROR_INTERNAL_ERROR |
| CMST_NOT_ACTIVE | ERROR_INTERNAL_ERROR |
| CMST_NOT_OPEN | ERROR_INTERNAL_ERROR |
| CMST_NOT_CONNECTED | ERROR_INTERNAL_ERROR |
| CMST_NOT_CONSTRUCTED | ERROR_INTERNAL_ERROR |
| CMST_IOERR | ERROR_10_DEVICE |
| CMST_BAD_CHKSUM | ERROR_CRC |
| CMST_NOT_FOUND | ERROR_FILE_NOT_FOUND |
| CMST_DUPLICATE | ERROR_DUP_NAME |
| CMST_BUSY | ERROR_BUSY |
| CMST_ACCESS_DENIED | ERROR_ACCESS_DENIED |
| CMST_PRIVILEGE | ERROR_PRIVILEGE_NOT_{—} |
| | HELD |
| CMST_SCOPE_VIOLATION | ERROR_ACCESS_DENIED |
| CMST_BAD_ACCESS | ERROR_ACCESS_DENIED |
| CMST_PENDING | ERROR_10_PENDING |
| CMST_TIMEOUT | ERROR_SEM_TIMEOUT |
| CMST_CANCELED | ERROR_OPERATION_ABORTED |
| CMST_ABORTED | ERROR_OPERATION_ABORTED |
| CMST_RESET | ERROR_OPERATION_ABORTED |
| CMST_CLEANUP | ERROR_OPERATION_ABORTED |
| CMST_OVERRIDE | ERROR_GEN_FAILURE |
| CMST_POSTPONE | ERROR_GEN_FAILURE |
| CMST_CANT_BIND | ERROR_FILE_NOT_FOUND |
| CMST_API_ERROR | ERROR_INVALID_FUNCTION |
| CMST_WRONG_VERSION | ERROR_REVISION_MISMATCH |
| CMST_NOT_IMPLEMENTED | ERROR_INVALID_FUNCTION |
| CMST_NOT_SUPPORTED | ERROR_INVALID_FUNCTION |
| CMST_BAD_OlD | ERROR_INTERNAL_ERROR |
| CMST_BAD_MESSAGE | ERROR_INTERNAL_ERROR |

16.3. Use Cases

Driver Initialization

The VxD containing DM_VXFAC is loaded, either at boot time (static VxD) or on a call to CreateFile( ) (dynamic VxD).

DM_VXFAC receives an EV_VXD_INIT message on its drv terminal.

DM_VXFAC checks if an instance of the device has already been created, if so DM_VXFAC returns CMST_FAILED.

DM_VXFAC creates an instance of the device.

DM_VXFAC parameterizes the device instance with the registry path for the device settings (reg_root property).

DM_VXFAC activates the device instance and returns CMST_OK.

Driver Cleanup

The VxD containing DM_VXFAC is unloaded, either at system shutdown (static VxD) or on a call to CloseHandle( ) (dynamic VxD).

DM_VXFAC receives an EV_VXD_CLEANUP message on its drv terminal.

DM_VXFAC checks if the device instance has already been destroyed, if so DM_VXFAC returns CMST_OK.

DM_VXFAC deactivates and destroys the device instance.

DM_VXFAC returns CMST_OK.

Synchronous Operations

DM_VXFAC receives an EV_VXD_MESSAGE event on its drv terminal and translates it into an I_DIO operation.

DM_VXFAC invokes the proper operation on dio (open, close, cleanup, read, write or ioctl).

The call returns a completion status and DM_VXFAC translates it to a Win32 status. If operation is read, write or ioctl DM_VXFAC copies the translated status into the cplt_s field of the 110 control data block and updates the number of bytes copied to the output buffer.

DM_VXFAC completes the operation.

Asynchronous Open\Close Operations

DM_VXFAC receives an EV_VXD_MESSAGE event (for DIOC_OPEN or DIOC_CLOSEHANDLE) on its drv terminal and translates it into an I_DIO operation.

DM_VXFAC invokes the proper operation on dio (open, close or cleanup).

The invoked operation returns CMST_PENDING to indicate asynchronous completion.

DM_VXFAC waits on a semaphore until the operation has completed.

At a later time, the dio.complete operation is invoked on DM_VXFAC to indicate the pending operation has completed. DM_VXFAC then signals the semaphore.

DM_VXFAC wakes up from waiting on the semaphore and completes the life-cycle operation.

Asynchronous I/O Operations

DM VXFAC receives an EV_VXD_MESSAGE event (read, write or other I/O controls) on its drv terminal and translates it into an I_DIO operation.

DM_VXFAC invokes the proper operation on dio (read, write or ioctl).

The invoked operation returns CMST_PENDING to indicate asynchronous completion.

DM_VXFAC returns −1 to the operating system to indicate the operation is pending (Overlapped I/O).

At a later time, the dio.complete operation is invoked on DM_VXFAC to indicate the pending operation has completed.

DM_VXFAC translates the completion status as specified by the status_xlat property and updates the completion status in the I/O control data block.

DM_VXFAC passes the number of bytes copied to the output buffer in the DIOCParams structure received with the I/O control.

DM_VXFAC completes the pending operation by invoking VWIN32_DIOCCompletionRoutine( ).

17. Notes

DM_VXFAC expects that all recognized events received through the drv terminal are received while the interrupts are enabled. For all unrecognized events, DM_VXFAC does not assume that the interrupts will be enabled; it returns immediately without any operation.

DM_VXFAC allows only one file to be open at any time. DM_VXFAC fails additional open requests. DM_VXFAC may be updated in the future to handle mutliple nested open requests.

For all I/O control requests, DM_VXFAC maps user mode buffers into kernel mode address space before forwarding I_DIO operations through the dio terminal. For all IOCTL requests other then read and write, DM_VXFAC always maps the output buffer passed to DeviceIoControl( ). The buffer mapping is done by using the LinPageLock( ) and LinPageUnlock( ) kernel mode API.

DM_VXFAC uses buffered I/O for all operations, but DM_VXFAC always maps the user's buffers into the kernel mode address space. This buffer mapping forces all operations to use direct I/O, even though it's buffered 1/O from the operating system standpoint.

The B_DIO bus DM_VXFAC passes to each I_DIO operation is allocated on the stack of the current execution context. If an operation is to be completed asynchronously, DM_VXFAC expects that the B_DIO bus will be duplicated and passed back to dio.complete when the operation has completed.

The B_DIO.irpp field is used internally by DM_VXFAC. DM_VXFAC expects that this field is not modified by the device instance and is passed back to dio.complete for the completion of asynchronous operations.

DM_VXFAC never fails DIOC_OPEN messages even if the I_DIO.open operation generated by DM_VXFAC fails. This is due to the behavior of the Windows 95/98 operating system. However, DM_VXFAC keeps an “open” state on the device instance. If an open attempt does fail, DM_VXFAC fails all I/O controls sent to the device until it is either opened successfully or closed. DM_VXFAC passes additional open attempts until success.

For asynchronous, overlapped I/O operations, it is not advised to complete these operations while the interrupts are disabled. This is because DM_VXFAC during dio.compete needs to free the operation completion context by calling cm_bus_free( ). In doing so, the interrupts become enabled which could cause unpredictable results.

Enumerators

DM_REN—Device Enumerator on Registry

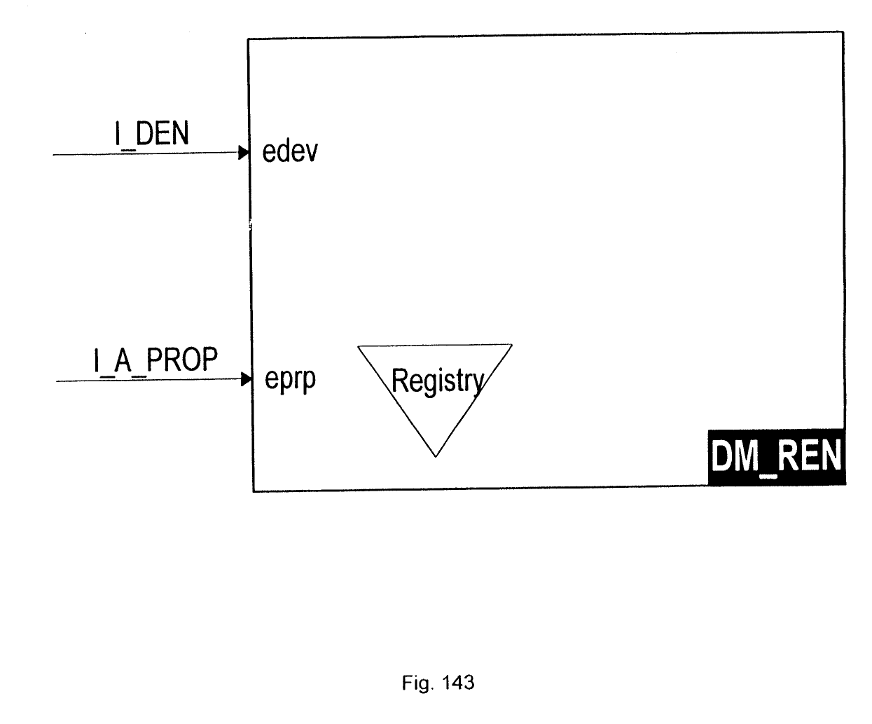

FIG. 143 illustrates the boundary of the inventive DM_REN part.

DM_REN is a registry-based device enumerator specifically designed to work in Windows NT kernel-mode. DM_REN is parameterized with the driver root registry key (as a string).

Upon activation of DM_REN, the edev terminal provides enumeration of devices as defined in Param\Devices subkey of the root registry key; the eprp terminal provides enumeration of the persistent properties for each device obtained through edev.

The properties manipulated through the eprp terminal cannot be modified (set operation will fail).

Full registry path to the specified device key can be obtained from DM_REN by reading a property on its boundary. The enumeration ID received from the device is used for identifying the particular device instance.

DM_REN supports multiple simultaneous queries for devices and properties on a device.

DM_REN does not modify or delete any information from the registry.

This part is available only in Windows NT/95/98 Kernel Mode environments.

1. Boundary

1.1. Terminals

Terminal “edev” with direction “In” and contract I_DEN. Note: DM_REN receives queries for enumerating the installed devices.

Terminal “eprp” with direction “In” and contract I_A_PROP. Note: DM_REN receives queries for obtaining the specific properties information for an installed device.

1.2. Events and Notifications

None.

1.3. Special Events, Frames, Commands or Verbs

None

1.4. Properties

Property “reg_root” of type “UNICODEZ”. Note: Specifies a root Registry key name. The device instance keys are stored into its Parameters\Devices sub-key. This property is mandatory.

Property “dev_name_base” of type “UNICODEZ”. Note: This property is used as the base for making device names. The name is created as: \Device\<device_name_base><dev_subkey>

2. Encapsulated Interactions

DM_REN relies on following services from the Windows NT kernel mode support routines:

ZwOpenKey—open an existing key in the registry

ZwEnumerateKey—to enumerate all existing sub-keys

ZwQueryValueKey—to obtain the current value of the specified value entry

ZwEnumerateValueKey—to enumerate all value entries of the opened registry key

ZwClose—close previously opened registry key

InitializeObjectAttributes—used to initialize the object attributes needed for the subsequent call to ZwOpenKey

3. Specification

4. Responsibilities

1. Implement the I_DEN interface by enumerating the Parameters\Devices sub-key of the driver's Registry key, specified by the reg_root property.

2. Provide the following data for each device instance:

class name for the device instance

registry path to device's settings

Win32 name(s) to associate with the device

device name (in kernel-mode name space)

3. Implement I_A_PROP interface. Supports all property enumeration functionality and property get calls. Does not support changing of the property values. Only one property is supported—reg_root.

5. Theory of Operation

5.1. State Machine

None.

5.2. Main Data Structures

None.

5.3. Mechanisms

Creating a Unique Identifier for the Device Instances

When DM_REN enumerates all device registry keys under driver registry key, it gives them a unique identifier. The identifier is used for obtaining the properties for the selected device (after the enumeration). DM_REN identifies the devices by creating a unique ID using the enumeration index. The sequence of creating this unique ID follows:

1. Get the least significant 16-bits from the enumeration index

2. Make 8-bits check sum (XOR) of all characters in the Registry key name.

3. Combine into one DWORD the least significant byte of the Registry name length, the calculated check sum and the least significant word (16-bits) from the device enumeration index. This DWORD will be the device identifier.

Create a Query Handler

DM_REN uses ClassMagic™ handles with an owner key to keep track of all open queries. DM_REN allocates a memory buffer to keep some query information and store the pointer to this buffer into the handler context. When DM_REN is destroyed, it enumerates the handles with its own key and releases all allocated resources.

DM_PEN—PCI Device Enumerator

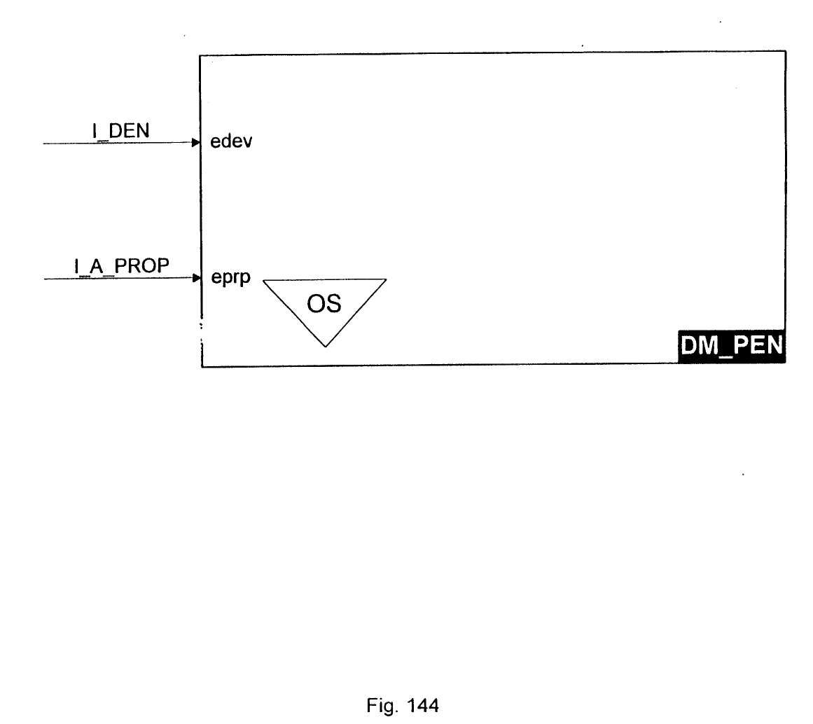

FIG. 144 illustrates the boundary of the inventive DM_PEN part.

DM_PEN a DriverMagic™ part, which is specifically designed to work in Windows NT kernel-mode. It enumerates PCI devices using specific criteria.

Before its activation, DM_PEN receives the name of the driver root registry key—reg_root, pointer to the driver object associated with this device—drv_objp and device and vendors IDs and masks. Using the specified information, it locates all devices of a specified class on a PCI bus. DM_PEN collects information about the resources of the devices, initializes them if necessary and gives a unique name to each of them. Some of the resources are obtained by reading the information stored into Parameters\Devices sub-key of the reg_root key. If those keys are not set in the Registry, the device will use their default values. DM_PEN can work properly even without having this information set in the Registry.

When DM_PEN receives an enumeration query through edev terminal, it returns an id, which is used as an identifier for the particular device instance. This id shall be used for property enumeration the eprp terminal. The identifier is valid only through the DM_PEN lifecycle.

DM_PEN supports property enumeration calls through its eprp terminal. It does not support the property “set” operation from the I_A_PROP interface. DM_PEN supports multiple properties with the same name. For those properties, a two digit decimal number is added at the end of the name.

DM_PEN supports multiple simultaneously open enumeration queries for both types—device and property queries.

NOTE: The initialization and activation of this component must be running at IRQL PASSIVE_LEVEL.

6. Boundary

6.1. Terminals

Terminal “edev” with direction “in” and contract In: I_DEN. Note: DM_PEN receives queries for enumerating the installed devices.

Terminal “eprp” with direction “in” and contract In: I_A_PROP. Note: DM_PEN receives queries for obtaining the specific properties information for an installed device.

6.2. Events and Notifications

DM_PEN has no incoming and outgoing events and notifications.

6.3. Special Events, Frames, Commands or Verbs

None

6.4. Properties

Property “reg_root” of type “unicodez”. Note: Specifies the root Registry key name for the driver. The device instance keys are stored into its Parameters\Devices sub-key. This property is mandatory.

Property “drv_objp” of type “uint32”. Note: pointer to the driver object.

Property “dev_name_base” of type “unicodez”. Note: This property is used as the base for making device names. The name is created as: \Device\<device_name_base>n Where n is the sequential number of the device during the device enumeration This property is mandatory.

Property “vendor_id” of type “uint32”. Note: Vendor ID. This property is mandatory.

Property “vendor_id_mask” of type “uint32”. Note: Vendor ID mask. The default is 0xFFFFFFFF

Property “device_id” of type “uint32”. Note: Device ID. This property is mandatory.

Property “device_id_mask” of type “uint32”. Note: Device ID mask. The default is 0xFFFFFFFF

Property “subsys_vendor_id” of type “uint32”. Note: Subsystem Vendor ID. This property is mandatory.

Property “subsys_vendor_id_mask” of type “uint32”. Note: Subsystem Vendor ID mask. The default is 0xFFFFFFFF

Property “subsys_device_id” of type “uint32”. Note: Subsystem device ID. This property is mandatory.

Property “subsys_device_id-mask” of type “uint32”. Note: Subsystem device ID mask. The default is 0xFFFFFFFF

6.5. Properties Exported Through eprp Terminal.

Property “bus” of type “uint32”. Note: device bus number

Property “slot” of type “uint32”. Note: device slot number

Property “vendor_id” of type “uint32”. Note: Vendor ID.

Property “device_id” of type “uint32”. Note: Device ID.

Property “subsys_vendor_id” of type “uint32”. Note: Subsystem Vendor ID

Property “subsys_device_id” of type “uint32”. Note: Subsystem Device ID

Property “reg_root” of type “unicodez”. Note: registry path to the specified device instance key (per device instance)

Property “class_name” of type “asciiz”. Note: class name of part to be created for handling this device instance

Property “device_name” of type “unicodez”. Note: name to use for registering the device

Property “friendly_name” of type “unicodez”. Note: Win32 alias (does not include the \??\ prefix)

Property “port_base” of type “BINARY (uint64)”. Note: I/O port base. (8-byte physical address). Could be more than 1 per device.

Property “port_length” of type “uint32”. Note: Specifies the range of the I/O port base. Could be more than 1 per device.

Property “mem_base” of type “BINARY (uint64)”. Note: The physical and bus-relative memory base (8-byte physical address). Could be more than 1 per device.

Property “mem_length” of type “uint32”. Note: Specifies the range of the memory base. Could be more than 1 per device.

Property “irq_level” of type “uint32”. Note: Bus-relative IRQL. Could be more than 1 per device.

Property “irq_vector” of type “uint32”. Note: Bus-relative vector. Could be more than 1 per device.

Property “irq_affinity” of type “uint32”. Note: Bus-relative affinity. Could be more than 1 per device.

Property “dma_channel” of type “uint32”. Note: DMA channel number. Could be more than 1 per device.

Property “dma_port” of type “uint32”. Note: MCA-type DMA port. Could be more than 1 per device.

7. Encapsulated Interactions

DM_PEN relies on following services from the Windows NT kernel mode support routines:

HalGetBusData—obtains details about a given slot or address on a particular I/O bus. By changing this function's parameters, it is possible to scan all devices.

HalAssignSlotResources—determines the resource requirements of the target device, allocates them, initializes the target device with its assigned resources, and returns the assignments to the caller.

IoAssignResources—erase the claim on resources (made by HalAssignSlotResources) in the registry when the driver is unloaded.

HalTranslateBusAddress—translates a bus-specific address into the corresponding system logical address.

8. Packaging and Environment Dependencies

DM_PEN is a DriverMagic™ part for use in a Windows NT kernel-mode driver.

9. Specification

10. Responsibilities

1. Implement the I_DEN interface by searching for PCI devices using various criteria, such as Vendor ID, Device ID, etc.

2. Obtain device specific information from the Parameters\Devices sub-key of the driver's Registry key, specified by the reg_root property.

3. Provide the following data for each device instance:

class name for the device instance

Win32 name(s) to associate with the device

device name (in kernel-mode name space)

4. Allocate resources for every device

5. Implement I_A_PROP interface. Supports all property enumeration functionality and property get calls. Support multiple properties with the same name. Does not support changing of the property values.

11. Theory of Operation

11.1. State Machine

DM_PEN has no state machine

11.2. Main data structures

Device Table—table consists of all resource information for each enumerated device.

11.3. Mechanisms

Creating a Unique Identifier for the Device Instances

When DM_PEN enumerates all device registry keys under driver registry key, it gives them a unique identifier. The identifier is used for obtaining the properties for the selected device (after the enumeration). DM_PEN uses DriverMagic™ handles with an owner key to identify the specific device instance.

Creating a Query Handle

DM_PEN uses DriverMagic™ handles with an owner key to keep track of all open queries. DM_PEN allocates a memory buffer to keep some query information and store the pointer to this buffer into the handle context. When DM_PEN is destroyed, it enumerates the handles with its own key and releases all allocated resources.

Creating a Device Name

The device name has the follow structure:

\Device\dev_name_basen

Where dev_name_base is a property supplied by the caller and n is a sequential number of discovering the device.

Note: n starts from 1.

Creating a Device Instance reg_root Path

The device reg_root path is created by adding to the driver reg_root path \Parameters\Devices\nnnn. Where nnnn is a four digit decimal number with leading zeros. It has the same meaning as n in device name creation. E.g. the device reg_root has the following format:

<driver reg_root>\Parameters\Devices\nnnn

Creating a Class Name for the Device

The device class name is obtained from DevPartClass Registry key under device reg_root tree. If this key is not set (from the installer), the class name will be an empty string.

Creating a Device Friendly Name

The device class name is obtained from FriendlyName Registry key under device reg_root tree. If this key is not set (from the installer) the device name is used instead.

12. Unresolved Issues

If multiple PCI devices are installed in the system, there is no reliable way to keep persistent data associated with each device. If the devices are moved to different slots on the PCI bus, a reconfiguration of the devices' parameters will be necessary. Note that this is a problem with Plug-and-Play devices in general, not a problem with the PCI enumerator.

DM_PCEN—PCMCIA Device Enumerator

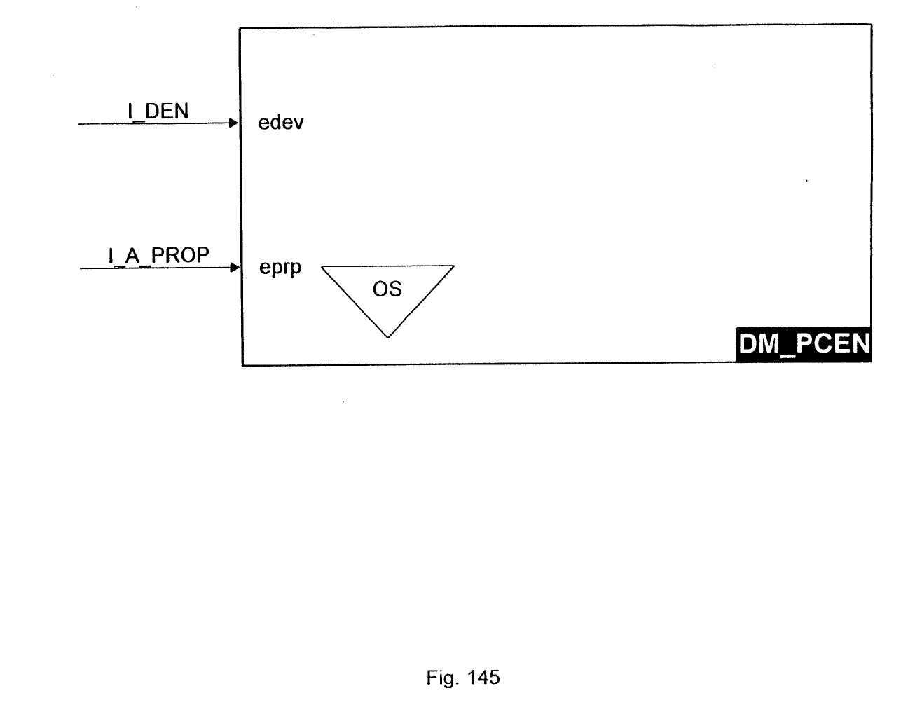

FIG. 145 illustrates the boundary of the inventive DM_PCEN part.

DM_PCEN a DriverMagic™ part that is specifically designed to work in Windows NT kernel-mode. It enumerates PCMCIA devices using specific criteria.

Before its activation, DM_PCEN receives as properties the name of the device manufacturer and the device model name. Using this information, it locates all matching PCMCIA devices installed in the system. DM_PCEN collects information about the resources of the devices and gives a unique name to each of them. Some of the resources are obtained by reading the information stored into Parameters\Devices sub-key of the reg_root key. If those keys are not set in the Registry, the device will use their default values. DM_PCEN can work properly even without having this information set in the Registry.

When DM_PCEN receives an enumeration query through edev terminal, it returns an ID, which is used as an identifier for the particular device instance. This ID is used for property enumeration through the eprp terminal. The identifier is valid only through the DM_PCEN instance lifetime.

DM_PCEN supports property enumeration calls through its eprp terminal. It does not support the property set operation from the I_A_PROP interface. DM_PCEN supports multiple properties with the same name. For those properties, a two digit decimal number is added at the end of the name.

DM_PCEN supports multiple simultaneously open enumeration queries for both types—device and property queries.

Since the PCMCIA support in Windows NT 4.0 does not allow more than one PCMCIA card with the same manufacturer/device name pair, the enumerator can find either zero or one PCMCIA devices.

13. Boundary

13.1. Terminals

Terminal “edev” with direction “in” and contract In: I_DEN. Note: DM_PCEN receives queries for enumerating the installed devices.

Terminal “eprp” with direction “in” and contract In: I_A_PROP. Note: DM_PCEN receives queries for obtaining the specific properties information for an installed device.

13.2. Events and Notifications

DM_PCEN has no incoming and outgoing events and notifications.

13.3. Special Events, Frames, Commands or Verbs

None

13.4. Properties

Property “reg_root” of type “unicodez”. Note: Specifies the root Registry key name for the driver. The device instance keys are stored into its Parameters\Devices sub-key. This property is mandatory.

Property “manufacturer” of type “unicodez”. Note: Device manufacturer name. This property is mandatory.

Property “device” of type “unicodez”. Note: Device model name. This property is mandatory.

13.5. Properties Exported Through the eprp Terminal

Property “bus” of type “uint32”. Note: device bus number

Property “slot” of type “uint32”. Note: device slot number

Property “manufacturer” of type “unicodez”. Note: device manufacturer name

Property “device” of type “unicodez”. Note: device model name

Property “reg_root” of type “unicodez”. Note: registry path to the specified device instance key (per device instance)

Property “class_name” of type “asciiz”. Note: class name of part to be created to handle this device instance (may be empty)

Property “device_name” of type “unicodez”. Note: name to use for registering the device

Property “friendly_name” of type “unicodez”. Note: Win32 alias (does not include the \??\ prefix)

Property “port_base” of type “BINARY (uint64)”. Note: I/O port base. (8-byte physical address). Could be more than 1 per device.

Property “port_length” of type “uint32”. Note: Specifies the range of the I/O port base. Could be more than 1 per device.

Property “mem_base” of type “BINARY (uint64)”. Note: The physical and bus-relative memory base (8-byte physical address). Could be more than 1 per device.

Property “mem_length” of type “uint32”. Note: Specifies the range of the memory base. Could be more than 1 per device.

Property “irq_level” of type “uint32”. Note: Bus-relative IRQL. Could be more than 1 per device.

Property “irq_vector” of type “uint32”. Note: Bus-relative vector. Could be more than 1 per device.

Property “irq_affinity” of type “uint32”. Note: Bus-relative affinity. Could be more than 1 per device.

Property “dma_channel” of type “uint32”. Note: DMA channel number. Could be more than 1 per device.

Property “dma_port” of type “uint32”. Note: MCA-type DMA port. Could be more than 1 per device.

14. Encapsulated Interactions

DM_PCEN relies on following services from the Windows NT kernel mode support routines:

ZwOpenKey—open an existing key in the registry

ZwEnumerateKey—to enumerate all existing sub-keys

ZwQueryValueKey—to obtain the current value of the specified value entry

ZwEnumerateValueKey—to enumerate all value entries of the opened registry key

ZwClose—close previously opened registry key

InitializeObjectAttributes—used to initialize the object attributes needed for the subsequent call to ZwOpenKey

HalTranslateBusAddress—translates a bus-specific address into the corresponding system logical address.

15. Packaging and Environment Dependencies

DM_PCEN is a DriverMagic™ part for use in a Windows NT kernel-mode driver.

16. Specification

17. Responsibilities

1. Implement the I_DEN interface by searching for PCMCIA devices using the manufacturer/device criteria.

2. Obtain device specific information from the Parameters\Devices sub-key of the driver's Registry key, specified by the reg_root property.

3. Provide the following data for each device instance:

class name for the device instance

Win32 name(s) to associate with the device

device name (in kernel-mode name space)

4. Obtain device resources from ‘\Registry\Machine\Hardware\Description\System\PCMCIA PCCARDs’ registry key

5. Implement I_A_PROP interface. Supports all property enumeration functionality and property get calls. Support multiple properties with the same name. Does not support changing of the property values.

18. Theory of Operation

18.1. State Machine

DM_PCEN has no state machine

18.2. Main Data Structures

Device Table—a table that consists of all resource information for each enumerated device.

18.3. Mechanisms

Obtaining Device Resurces

DM_PCEN search the Registry key ‘\Registry\Machine\Hardware\Description\System\PCMCIA PCCARDs’ for the value with matched the device name (see Creating a device name below). This registry value contains REG_FULL_RESOURCE_DESCRIPTOR, which contains all allocated for the specific device resource.

Creating a Unique Identifier for the Device Instances

When DM_PCEN enumerates all device registry keys under driver registry key, it gives them a unique identifier. The identifier is used for obtaining the properties for the selected device (after the enumeration). DM_PCEN uses DriverMagic™ handles with an owner key to identify the specific device instance.

Creating a Query Handle

DM_PCEN uses DriverMagic™ handles with an owner key to keep track of all open queries. DM_PCEN allocates a memory buffer to keep some query information and store the pointer to this buffer into the handle context. When DM_PCEN is destroyed, it enumerates the handles with its own key and releases all allocated resources.

Creating a Device Name

As device name is used the value of the Registry value ‘\Registry\Machine\CurrentControlSet\Services\PCMCIA\DataBase\<manufacturer>\<device>\Driver’

Creating a Device Instance reg_root Path

The device reg_root path is created by adding to the driver reg_root path \Parameters\Devices\nnnn. Where nnnn is a four digit decimal number with leading zeros. It has the same meaning as n in device name creation. The device reg_root has the following format:

<driver reg_root>\Parameters\Devices\nnnn

Creating a Class Name for the Device

The device class name is obtained from DevPartClass registry key under device reg_root tree. If this key is not set (by the installer), the class name will be an empty string.

Creating a Device Friendly Name

The device class name is obtained from FriendlyName registry key under device reg_root tree. If this key is not set (by the installer) the device name is used instead.

19. Unresolved Issues

1. If multiple PCMCIA devices are installed in the system, there is no reliable way to keep persistent data associated with each device. If the devices are moved to different socket on the PCMCIA adapter, a reconfiguration of the devices' parameters will be necessary.

The above note is largely irrelevant since the PCMCIA support in Windows NT 4.0 does not provide for multiple instances of the same PCMCIA device in the system.

Registrars

DM_SGR—Singleton Registrar

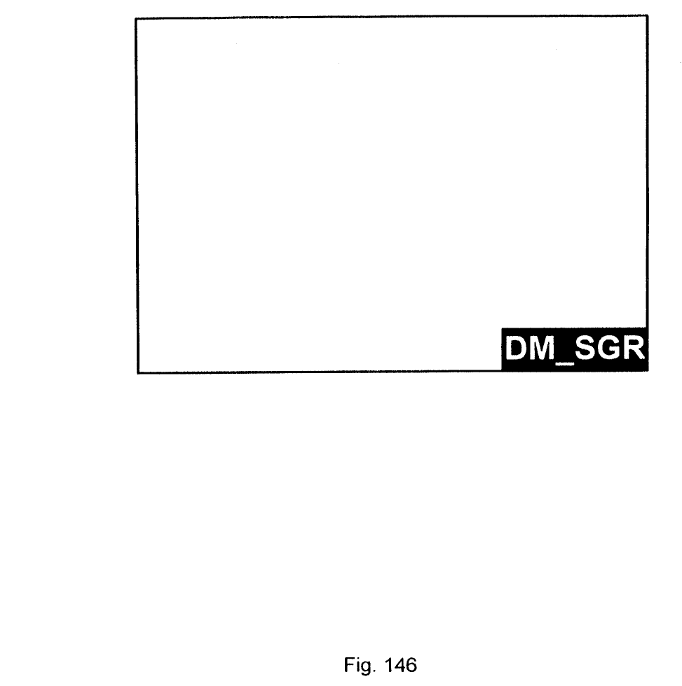

FIG. 146 illustrates the boundary of the inventive DM_SGR part.

DM_SGR is used to register its host assembly under a given name and to make it available for binding. Assemblies of this type are known as singletons.

On activation, DM_SGR registers its host assembly under a given name (parameterized through the name property). The instance name may only be registered once. If the host assembly is instantiated more then once, DM_SGR activation fails.

DM_SGR can be disabled by simply removing the part from its host assembly or for convenience, by setting the name property to “ ”.

DM_SGR has no terminals and does not contain any functionality except on activation.

1. Boundary

1.1. Terminals

None.

1.2. Events and Notifications

None.

1.3. Special Events, Frames, Commands or Verbs

None.

1.4. Properties

Property “name” of type “ASCIZ”. Note: Specifies the instance name that DM_SGR's host assembly should be registered under. Instance name must be less then 128 characters. If name is “ ” DM_SGR is disabled and does nothing. Default value is “ ”.

2. Encapsulated Interactions

None.

3. Specification

4. Responsibilities

27. Register the host assembly by the specified name (name property) to make it available for binding.

28. Prevent its host assembly from being instantiated more then once.

5. Theory of Operation

5.1. State Machine

None.

5.2. Main Data Structures

None.

5.3. Mechanisms

Preventing Host Assembly From Multiple Instantiations

On activation, if the name property is “ ”, DM_SGR does nothing and returns CMST_OK. In this case, the host assembly may be instantiated more then once. Otherwise, DM_SGR registers the instance name with the object ID of its containing assembly.

When the assembly is instantiated for the first time, the instance name registration and DM_SGR's activation succeeds. If the same assembly is instantiated more then once, DM_SGR's activation fails with CMST_DUPLICATE (instance names may only be registered once).

DM_SGR deregisters the instance name on deactivation.

5.4. Use Cases

Implementing a Singleton Assembly

1. The singleton assemblies part table contains the DM_SGR part along with any other parts the assembly uses.

2. The DM_SGR part is parameterized with an instance name for the assembly (e.g., hard parameterization).

3. The assembly is created and activated (there are no connections to DM_SGR).

4. DM_SGR registers the instance name with the object ID of the assembly and its activation succeeds.

5. Any additional attempts to create and activate the singleton assembly a second time will fail with CMST_DUPLICATE.

The assembly is deactivated and destroyed. DM_SGR deregisters the instance name on deactivation.

DM_DSTK—Device Stacker

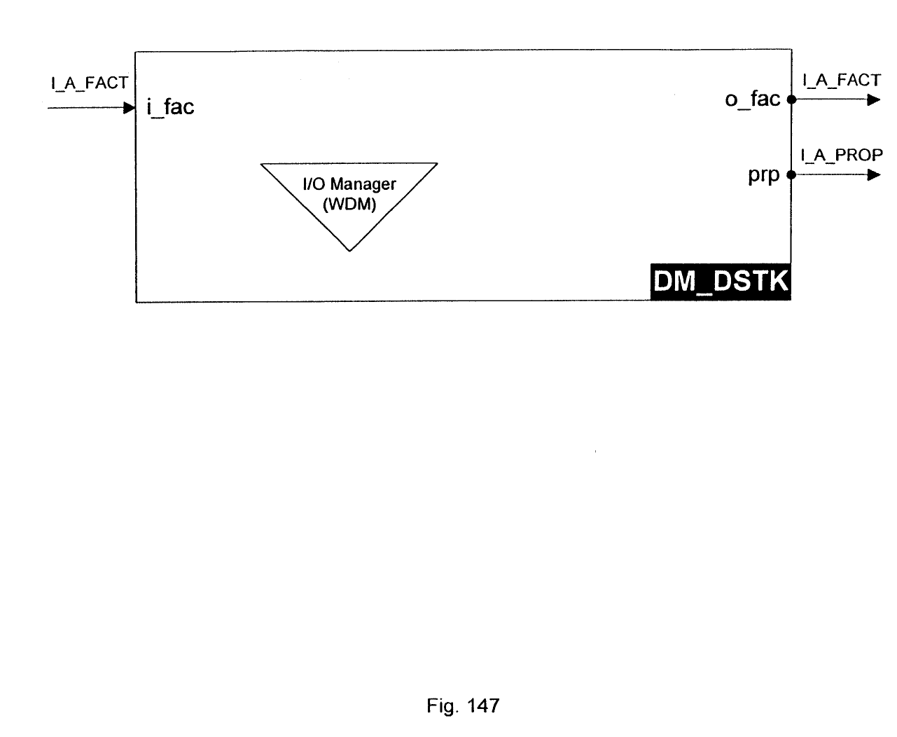

FIG. 147 illustrates the boundary of the inventive DM_DSTK part.

DM_DSTK can be used in a WDM/NT driver to attach devices created by the DriverMagic NT or WDM device factory (DM_FAC) to lower level device drivers.

DM_DSTK should be inserted in the I_A_FACT connection from DM_FAC—it uses the I_A_FACT.activate/deactivate operations to perform its operations.

DM_DSTK is a pure filter—it has no state of its own and relies on the property storage provided by the parts connected to prp to keep context between calls. The device instances used with DM_DSTK must be built to cooperate with it—see the notes in the Terminals section below.

6. Boundary

6.1. Terminals

Terminal “i_fac” with direction “In” and contract I_A_FACT. Note: Operations on this terminal are passed transparently to o fac, excepts activate and deactivate—DM_DSTK performs attaching/detaching to the lower-level device before activate and after deactivate is passed to o_fac. If attaching to the device fails, activate is not passed to o_fac and DM_DSTK return an error status.

Terminal “o_fac” with direction “Out” and contract I_A_FACT. Note: Operations from i_fac are passed to this output. See i_fac above.

Terminal “prp” with direction “Out” and contract I_A_PROP. Note: This output must be connected so that DM_DSTK can access the properties of the same parts that are created through the o_fac terminal. Normally, both these outputs are connected (directly or indirectly) to the control terminals of a DriverMagic part array (DM_ARR). For DM_DSTK to operate, the parts created through o_fac must provide storage for properties that is accessible to DM_DSTK through its prp terminal. See the notes below this table.

The parts created through o_fac should provide storage for the following properties. All of these properties must be available, otherwise DM_DSTK will not activate the instance.

dev_objp (UINT32)—keeps the device object pointer of the WDM device associated with the instance. This value is expected to be set (normally by DM_FAC) before i_fac.activate is called.

low_dev_name (unicode)—keeps the name of the device to whick this instance is to be attached. This property is read by DM_DSTK and must be set to a correct value before i_fac.activate is called. Typically, this property is set on the device instance through the Registry (see DM_PRM).

low_dev_filep (UINT32)—DM_DSTK sets this property to the file object associated with the opened lower-level device (specified by low_dev_name). This value is valid in the scope of the part(s) created through o_fac while they are active. This value should be treated by these parts as read-only and never modified.

low_dev_objp (UINT32)—DM_DSTK sets this property to the device object of the device specified by low_dev_name. This value is valid in the scope of the part(s) created through o_fac while they are active.

6.2. Events and Notifications

None.

6.3. Special Events, Frames, Commands or Verbs

None.

6.4. Properties

None.

7. Encapsulated Interactions

DM_DSTK uses the following WDM services:

IoGetDeviceObjectPointer—open a device

ObDereferenceObject—close a device

IoAttachDeviceToDeviceStack, IoDetachDevice—attach/detach to and from lower-level device.

8. Specification

9. Responsibilities

Pass all i_fac operations to o_fac.

On i_fac.activate, before it is passed to o_fac: open and attach to device specified by low_dev_name, store file and device object pointer in low_dev_filep and low_dev_objp properties.

On i_fac.deactivate, after it is passed to o_fac: reverse the actions taken on i_fac.activate (detach and close lower device).

10. Theory of operation

10.1. State Machine

None.

10.2. Mechanisms

None.

Factory Interface Adaptors

DM_CBFAC—Create/Bind Factory

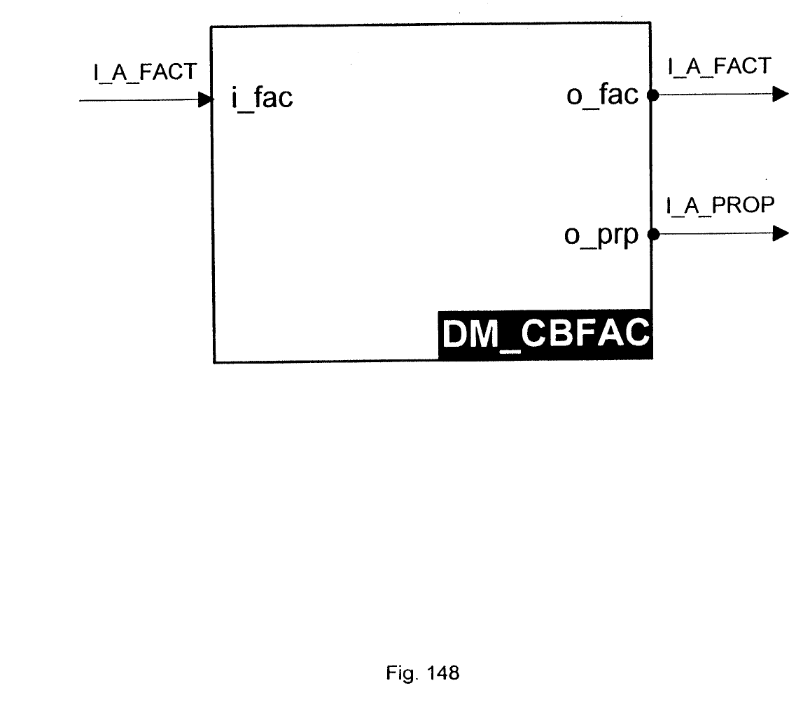

FIG. 148 illustrates the boundary of the inventive DM_CBFAC part.

DM_CBFAC is a part factory that creates and binds to parts by name. DM_CBFAC can be used to manage singletons (parts that may only be instantiated once) or can be used to register and bind to specific part instances.

DM_CBFAC supports the standard factory operations—create, destroy, activate and deactivate. The query operations get first and get next are passed out through o_fac without modification.

The life cycle of the parts created through DM_CBFAC is handled through reference counting. Each instance created using DM_CBFAC is expected to expose reference count properties used specifically by DM_CBFAC. These properties are incremented and decremented through-out the life cycle of the instance (creation, destruction, activation and deactivation). An instance is only deactivated or destroyed when the corresponding reference count reaches zero. This technique is similar to the way COM objects handle the life cycle of interface pointers.

DM_CBFAC has no state. The instance name, reference counts and any other information maintained by the factory are kept on the instance created by DM_CBFAC as properties. The actual names of these properties are controlled through properties exposed by DM_CBFAC.

The actual factory and instance parameterization operations are handled by a separate part connected to the o_fac and o_prp terminals. DM_CBFAC expects that the part connected to these terminals handles all of this functionality. Typically, the part array (DM_ARR) is connected to these terminals.

1. Boundary

1.1. Terminals

Terminal “i_fac” with direction “In” and contract I_A_FACT. Note: v-table, synchronous, infinite cardinality This terminal is used to create, destroy, activate and deactivate part instances. Depending on how DM_CBFAC is used, parts created through DM_CBFAC may only be instantiated one time. Subsequent creations result in DM_CBFAC binding to an existing instance. All operations are subject to reference counting—DM_CBFAC keeps track of the number of times an instance was created and activated. An instance is deactivated or destroyed only when its reference count reaches zero (cumulative). The query operations get first and get next are passed directly through the o_fac terminal without modification.

Terminal “o_fac” with direction “Out” and contract I_A_FACT. Note: v-table, synchronous, cardinality 1 This terminal is used by DM_CBFAC to create, destroy, bind, activate and deactivate parts on behalf of the requests received from the i_fac terminal. The query operations i_fac.get_first and i_fac.get_next are passed directly through this terminal without modification.

Terminal “o_prp” with direction “Out” and contract I_A_PROP. Note: v-table, synchronous, cardinality 1 DM_CBFAC uses this terminal to either set properties on newly created instances or to bind to existing instances. See the Properties section for more information.

1.2. Events and Notifications

None.

1.3. Special Events, Frames, Commands or Verbs

None.

1.4. Properties

Property “dflt_class_name” of type “ASCIIZ”. Note: Specifies the class name of the part that DM_CBFAC creates on i_fac.create operations (overrides the name specified in the B_A_FACT bus). This property is used only if the force_dflt_class property is TRUE. Default is “ ”.

Property “force_dflt_class” of type “BOOL”. Note: If TRUE, DM_CBFAC uses the dflt_class_name property as the class to create on i_fac.create. DM_CBFAC uses the name specified in the B_A_FACT bus as the instance name (set on the newly created part as the name_prop property). In this case the name in the B_A_FACT bus cannot be NULL. If FALSE, the name specified in the B_A_FACT bus is used as both the class name and the instance name (creation of singletons). Default is FALSE.

Property “reg_root” of type “ASCIIZ”. Note: Registry root path prefix for instances created by DM_CBFAC. On instance creation, DM_CBFAC concatenates this property value with the instance name and sets it as the value of the (reg_prop) property on the newly created instance. Default is

Property “name_prop” of type “ASCIIZ”. Note: Name of the instance name property on part instances created by DM_CBFAC. Upon instance creation, DM_CBFAC sets this property to the appropriate instance name. The calculation of the instance name is described in the Mechanisms section below. This property is used by DM_CBFAC to bind to existing instances. Default is “name”.

Property “reg_prop” of type “ASCIIZ”. Note: Name of the registry path property on part instances created by DM_CBFAC. Upon instance creation, DM_CBFAC sets this property to the appropriate registry path (concatenates the reg_root property value with the instance name). Default is “reg_root”.

Property “c_refcnt_prop” of type “ASCIIZ”. Note: Name of the creation reference count property on part instances created by DM_CBFAC. This property value is incremented and decremented as a particular instance is created and destroyed. The instance is only actually destroyed when this count reaches zero. Default is “c_refcnt”.

Property “a_refcnt_prop” of type “ASCIIZ”. Note: Name of the activation reference count property on part instances created by DM_CBFAC. This property value is incremented and decremented as a particular instance is activated and deactivated. The instance is only actually deactivated when this count reaches zero. Default is “a_refcnt”.

1.5. Instance Properties

The instances created by DM_CBFAC are expected to support a specific set of properties used by the factory. All of the following properties must not be modified by the part instance except on construction and destruction. The factory initializes these properties after instance creation. These properties are described in the table below:

Property “(name_prop)” of type “ASCIIZ”. Note: This contains the name of the part instance. This is used by DM_CBFAC to identify an instance of a particular part. This allows the factory to bind to an instance by name. The instance name is either dflt_class_name or it's the name specified in the B_A_FACT bus on i_fac.create. This depends on how the factory is used. See the Mechanisms section below for more information. This property is set after the instance is created.

Property “(c_refcnt_prop)” of type “UINT32”. Note: Active-time. Creation/destruction reference count. Every time a part is created or is bound to by name, the factory increments this property value. By the same token each time a part is destroyed it is decremented. An instance is only destroyed when the reference count reaches zero. This property is used during instance creation and destruction.

Property “(a_refcnt_prop)” of type “UINT32”. Note: Active-time. Activation/deactivation reference count. Every time a part is activated/deactivated the factory increments/decrements this property value respectively. An instance is only deactivated when the reference count reaches zero. This property is used during instance activation and deactivation.

Additionally the instances may support any of the following properties. DM_CBFAC tries to set these properties on the instance after creation, if the property does not exist it is ignored.

Property “(reg_prop)” of type “ASCIIZ”. Note: Optional. Registry path for settings, parameters, etc. The use of this property is defined by the instance created by the factory. The value of this property is the instance name prefixed by the value of the DM_CBFAC reg_root property. This path usually defines the location where device specific settings and parameters are stored.

2. Encapsulated Interactions

None.

3. Specification

4. Responsibilities

1. Create or bind to part instances by name.

2. Upon successful first-time part creation, set the name_prop and reg_prop properties on the newly created instance to the appropriate values.

3. As instances are created, destroyed, activated and deactivated update the instance reference count properties. Only destroy or deactivate an instance when the appropriate reference count reaches zero.

4. Pass the query operations of the i_fac terminal through the o_fac terminal without modification.

5. Theory of Operation

5.1. Mechanisms

Calculation of Class and Instance Names

The way the class and instance names are calculated depends on how the factory is being used. This virtually depends on whether the class name property is being enforced (force_dflt_class is TRUE) and what name is passed on the i_fac.create operation (B_A_FACT.namep).

Below summarizes how these names are calculated based upon factory usage:

1. force_dflt_class is TRUE:

a. if B_A_FACT.namep !=NULL then the class name is the value of the dflt_class_name property and the instance name is the name specified in the bus.

b. if B_A_FACT.namep==NULL then both the class and instance name is the value of the dflt_class_name property.

2. force_dflt_class is FALSE:

a. if B_A_FACT.namep !=NULL then both the class and instance name is the name specified in the bus.

b. if B_A_FACT.namep==NULL then this is illegal and the factory fails the create operation with CMST_INVALID.

Instance Creation and Binding

DM_CBFAC is used both to create new part instances and to bind to existing instances by name.

When i_fac.create is called, the factory checks to see if an existing instance of the requested part exists. This is accomplished by enumerating the instances through o_fac.get_first and o_fac.get_next. For each instance, the factory compares the value of the <name_prop> property on the instance to the instance name calculated as described above.

If an existing instance is found, the factory increments the creation reference count property (<c_refcnt_prop>) on the instance and passes the id back to the caller. If the instance is not found, the factory creates a new instance and parameterizes it with the appropriate property values. The id of the newly created instance is passed back to the caller.

The factory does not keep any state itself—it expects the reference counts and other information to be contained as properties on the created instances.

Reference Counting

All operations invoked through the i_fac terminal (except the query operations) are subject to reference counting.

When an instance is first created the creation reference count (<c_refcnt_prop>) is initialized to one. Every time thereafter, whenever the factory binds to the same instance, it increments the reference count by one. On destruction, the factory decrements the reference count by one. When the reference count reaches zero, the instance is finally destroyed.

Activation and deactivation of instances follow the same reference counting procedure defined above. Each time an instance is activated/deactivated the activation reference count (<a_refcnt_prop>) is incremented/decremented respectively. The instance is only deactivated when the reference count reaches zero.

8. DM_CBFAC binds to the existing instance and increments the construction reference count by one. DM_CBFAC passes the instance id back to MyPart.

9. MyPart activates the singleton through fact.activate passing the instance id returned from fact.create. Since the singleton is already active, DM_CBFAC increments the activation reference count and returns.

10. Steps 7-9 may be repeated several times.

11. Eventually MyPart needs to deactivate and destroy the instances created in the steps above. MyPart calls fact.deactivate and fact.destroy for each instance created in the steps above;

12. DM_CBFAC decrements the activation and construction reference counts by one on each call to fact.deactivate and fact.destroy respectively. As soon as the reference counts reach zero, the factory deactivates and destroys the singleton.

Enforcing One-Time Part Instantiation (Singletons) Using Specified Part Class in B_A_FACT Bus

This use case is exactly the same as the one described above except the singleton part class name is specified in the B_A_FACT bus. This may be used when the name of the singleton part class is known only at run-time (i.e., read from registry, etc.)

The steps are repeated below for clarity:

1. The structure in the above diagram is created and connected.

2. DM_CBFAC is parameterized with the following:

a. force_dflt_class=FALSE

3. The structure in the above diagram is activated.

4. Some time later, MyPart needs to create a singleton part. MyPart invokes fact.create specifying the part class name in B_A_FACT.namep.

5. DM_CBFAC tries to bind to an existing instance using the instance name specified in the bus. The binding fails so DM_CBFAC creates a new

The reference counting along with instance binding allows the factory to manage singleton parts—parts that can only be instantiated once.

Depending on how the factory is used, it is possible to instantiate a class more than once and assign unique names to each instance. The use cases below describe this type of situation.

Use Cases

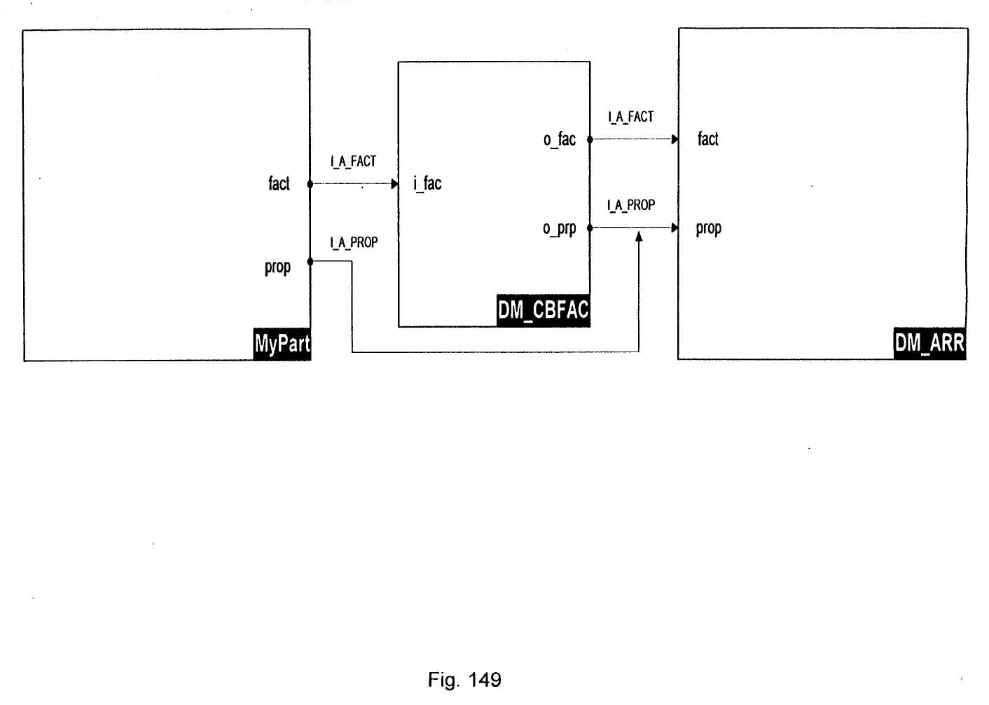

FIG. 149 illustrates a usage of the DM_CBFAC factory interface adapter.

Enforcing One-Time Part Instantiation (Singletons) by Enforced Class Name

This use case pertains to parts that may only be instantiated once. Subsequent instantiation attempts result in the factory binding to the existing instance, thus preventing multiple instantiations. In this case, the class name of the singleton part class is specified through the dflt_class_name property on the factory.

1. The structure in the above diagram is created and connected.

2. DM_CBFAC is parameterized with the following:

a. force_dflt_class=TRUE

b. dflt_class_name=name of singleton part class

3. The structure in the above diagram is activated.

4. Some time later, MyPart needs to create a singleton part. MyPart invokes fact.create specifying a NULL part name (B_A_FACT.namep=NULL).

5. DM_CBFAC tries to bind to an existing instance using the instance name <dflt_class_name>. The binding fails so DM_CBFAC creates a new instance (through o_fac.create) and parameterizes it with the appropriate values (through o_prp.set). The construction reference count is now one.

6. MyPart activates the singleton through fact.activate passing the instance id returned from fact.create. The singleton is activated (through o_fac.activate) and the activation reference count becomes one.

7. Some time later, MyPart may try to create another instance of the same part class specified in <dflt_class_name>. MyPart invokes fact.create specifying a NULL part name (B_A_FACT.namep=NULL). instance (through o_fac.create) and parameterizes it with the appropriate values (through o_prp.set). The construction reference count is now one.

6. MyPart activates the singleton through fact.activate passing the instance id returned from fact.create. The singleton is activated (through o_fac.activate) and the activation reference count becomes one.

7. Some time later, MyPart may try to create another instance of the same part class. MyPart invokes fact.create specifying the part class name in B_A_FACT.namep.

8. DM_CBFAC binds to the existing instance and increments the construction reference count by one. DM_CBFAC passes the instance id back to MyPart.

9. MyPart activates the singleton through fact.activate passing the instance id returned from fact.create. Since the singleton is already active, DM_CBFAC increments the activation reference count and returns.

10. Steps 7-9 may be repeated several times.

11. Some time later, MyPart needs to deactivate and destroy the instances created in the steps above. MyPart calls fact.deactivate and fact.destroy for all instances.

12. DM_CBFAC decrements the activation and construction reference counts by one on each call to fact.deactivate and fact.destroy respectively. As soon as the reference counts reach zero, the factory deactivates and destroys the singleton.

Note that specifying a NULL instance name in B_A_FACT.namep on i_fac.create is invalid and DM_CBFAC will fail the operation with CMST_INVALID. In this case an instance name must be provided at all times.

Enforcing One-Time Part Creation (Singletons) on a per Instance Basis

Sometimes it is useful to instantiate a single part class multiple times while assigning unique names to each instance and enforcing only one instantiation of each instance through i_fac. For example, some device drivers may handle many similar devices using the same part class but only allow one instance of each device to be instantiated at any time.

In this situation, the part class being created usually exposes several properties that identifies what the instance is used for.

The steps below describe this type of situation:

1. The structure in the above diagram is created and connected.

2. DM_CBFAC is parameterized with the following:

a. force_dflt_class=TRUE

b. dflt_class_name=name of part class to create

3. The structure in the above diagram is activated.

4. Some time later, MyPart needs to create an instance of dflt_class_name. MyPart invokes fact.create specifying a unique name for the instance in B_A_FACT.namep.

5. DM_CBFAC tries to bind to an existing instance using the instance name specified in the bus. The binding fails so DM_CBFAC creates a new instance (through o_fac.create) and parameterizes it with the appropriate values (through o_prp.set). The instance name is the name specified in the B A_FACT bus. The construction reference count is now one.

6. MyPart parameterizes the instance according to its specific needs. It may have a separate property terminal that connects directly to the DM_ARR property terminal for the means of parameterization.

7. MyPart activates the instance through fact.activate passing the instance id returned from fact.create. The instance is activated (through o_fac.activate) and the activation reference count becomes one.

8. Steps 4-7 may be repeated many times—each time MyPart supplies a unique name for each instance. The end result is many instances of the same part class each identified by a unique instance name.

9. Some time later, MyPart may try to create a new instance using a duplicate name already specified before. DM_CBFAC binds to the existing instance and increments the construction reference count by one. DM_CBFAC passes the instance id back to MyPart.

10. MyPart activates the instance through fact.activate passing the instance id returned from fact.create. Since the instance is already active, DM_CBFAC increments the activation reference count and returns.

11. Steps 9-10 may be repeated several times.

12. Eventually, MyPart needs to deactivate and destroy all the instances created in the steps above. MyPart calls fact.deactivate and fact.destroy for each instance.

13. DM_CBFAC decrements the activation and construction reference counts by one (for each instance) on each call to fact.deactivate and fact.destroy respectively. As soon as the reference counts reach zero, the factory deactivates and destroys the instances.

ZP_E2FAC—Event to Factory Adapter

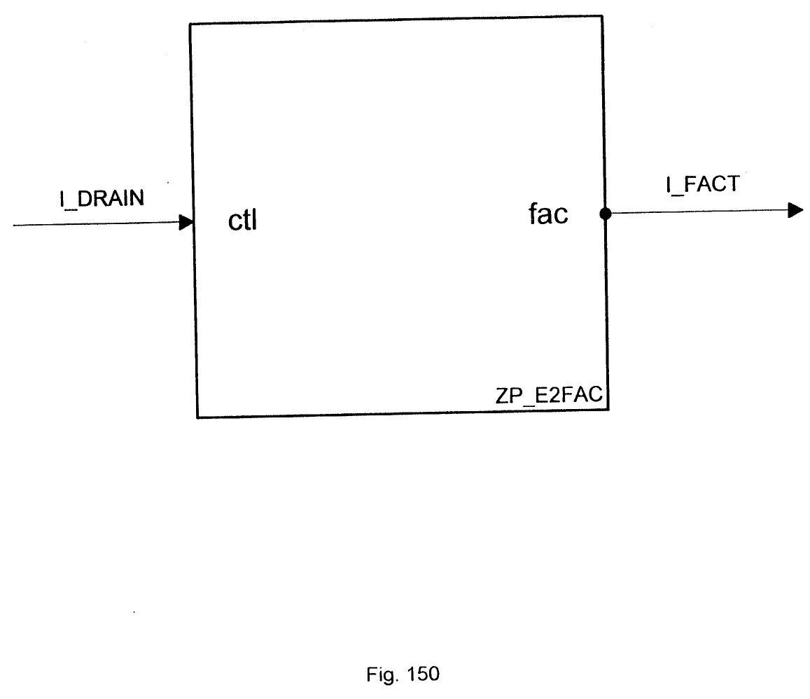

FIG. 150 illustrates the boundary of the inventive ZP_E2FAC part.

ZP_E2FAC is a plumbing part that converts incoming events (i.e., I_DRAIN interface) to part factory operations (i.e., I_FACT interface).

ZP_E2FAC is parameterized with the event IDs that correspond to each factory operation. When the specified event is received on its ctl terminal, ZP_E2FAC generates a factory operation out through its fac terminal. ZP_E2FAC returns ST_NOT_SUPPORTED for all unrecognized events.

ZP_E2FAC can be used in front of the part array to control dynamic creation/destruction of parts based on a set of events.

The ZP_E2FAC's input terminals are not guarded. It does not keep any state so the part can be reentered or used at interrupt context. Note that if the order of the factory operations is of any significance an external event serialization may be required.

6. Boundary

6.1. Terminals

Terminal “ctl” with direction “In” and contract I_DRAIN. Note: Input terminal for the events corresponding to the part factory interface.

Terminal “fac” with direction “Out” and contract I_FACT. Note: Output part factory terminal. This terminal is used to create, destroy and enumerate part instances.

6.2. Properties

Property “create_ev” of type “uint32”. Note: Specifies the event ID received on the ctl terminal that results in ZP_E2FAC creating a part instance out its fac terminal. The value of this property cannot be EV_NULL. This property is mandatory.

Property “destroy_ev” of type “uint32”. Note: Specifies the event ID received on the ctl terminal that results in ZP_E2FAC destroying a part instance out its fac terminal. The value of this property cannot be EV_NULL. This property is mandatory

Property “activate_ev” of type “uint32”. Note: Specifies the event ID received on the ctl terminal that results in ZP_E2FAC activating a part instance out its fac terminal. When the value is EV_NULL, the part instance is activated automatically following successful creation. The default value is EV_NULL.

Property “deactivate_ev” of type “uint32”. Note: Specifies the event ID received on the ctl terminal that results in ZP_E2FAC deactivating a part instance out its fac terminal. When the value is EV_NULL, the part instance is deactivated automatically before destruction. The default value is EV_NULL.

Property “enum_get_first_ev” of type “uint32”. Note: Specifies the event ID received on the ctl terminal that results in ZP_E2FAC resetting its enumeration state and returning the first part instance id. When the value is EV_NULL, ZP_E2FAC does not support part instance enumeration. The default value is EV_NULL.

Property “enum_get_next_ev” of type “uint32”. Note: Specifies the event ID received on the ctl terminal that results in ZP_E2FAC enumerating the next part instance. When the value is EV_NULL, ZP_E2FAC does not support part instance enumeration. The default value is EV_NULL.

Property “gen_id” of type “uint32”. Note: Boolean. If TRUE, the part instance ID returned on the ‘create’ event is generated by the create operation on ZP_E2FAC's fac output. If FALSE, the “create” event contains the ID to use when creating the part. The default value is TRUE.

Property “id.offs” of type “sint32”. Note: Offset of storage in event bus received on the ctl terminal for part instance ID. If this value is >=0, the offset is from the beginning of the event. If this value is <0, the offset is from the end of the event (−1 specifies the last byte). The default value is 0x0 (beginning of the event)

Property “id.sz” of type “uint32”. Note: Size in bytes of part instance ID. This property can be between one and sizeof (uint32). The default value is sizeof (uint32).

Property “id.sgnext” of type “uint32”. Note: Boolean. If TRUE, part instance IDs less than four bytes are sign extended. The default value is FALSE.

Property “dflt_class_name” of type “asciz”. Note: The class name to use when creating part instances in case the class name is not provided with the ‘create’ event. If the value of this property is not an empty string, class_name.xxx properties are used in order to extract the class name from the property bus. The default value is

Property “class_name.offs” of type “sint32”. Note: Specifies the offset in the create_ev event bus, received on the ctl terminal, of the class name to use when creating part instances. If this value is >=0, the offset is from the beginning of the event. If this value is <0, the offset is from the end of the event (−1 specifies the last byte). If the value in the bus is NULL or data is an empty string, the class name specified by the dflt_class_name property is used. The default value is sizeof (uint32)—right after the default part instance ID.

Property “class_name.by_ref” of type “uint32”. Note: Boolean. If TRUE, the data at class_name.offs contains a pointer, to the class name string. If the pointer found in the bus is NULL, the class name specified by the dflt_class_name property is used. If FALSE, the class name is contained in the event bus. The default value is FALSE.

Property “ctx.offs” of type “sint32”. Note: Offset of storage in event bus, received on the ctl terminal, for instance enumeration context. If this value is >=0, the offset is from the beginning of the event. If this value is <0, the offset is from the end of the event (−1 specifies the last byte). Note that the context storage must be at least sizeof (_ctx) big. The default value is (-sizeof (_ctx)) (end of the event)

6.3. Events and Notifications

Terminal: ctl

ZP_E2FAC does not define the set of events or the structure of the event bus. The event bus for the following events must at a minimum contain storage for the part instance ID. The event IDs are specified as properties.

| Incoming Event | Dir | Bus | Notes |
|---|---|---|---|
| (create_ev) | in | any | ZP_E2FAC creates a part instance |
| | | | out its fac terminal. The event bus |
| | | | must contain also part class name or a |
| | | | reference to a part class name. |
| (destroy_ev) | in | any | ZP_E2FAC destroys the part |
| | | | instance out its fac terminal. |
| (activate_ev) | in | any | ZP_E2FAC activates the specified |
| | | | part instance out its fac terminal. |
| (deactivate_ev) | in | any | ZP_E2FAC deactivates the specified |
| | | | part instance out its fac terminal. |
| (enum_get_first_ev) | in | any | Gets the first part instance from a |
| | | | part instance holder. The event bus |
| | | | must contain storage for the |
| | | | enumeration context. The size of the |
| | | | enumeration context is sizeof (_ctx). |
| (enum_get_next_ev) | in | any | Gets the next part instance from a |
| | | | part instance holder. The event bus |
| | | | must contain storage for the |
| | | | enumeration context. The size of the |
| | | | enumeration context is sizeof (_ctx). |

7. Environmental Dependencies

None.

7.1. Encapsulated Interactions

None.

7.2. Other Environmental dependencies

None.

8. Specification

9. Responsibilities

1. Sign extend part instance IDs with size less than four bytes when sign extending is allowed.

2. Upon ‘create instance’ event and gen_id property not TRUE, invoke create operation out the fac terminal allowing the connected part to generate the instance IDs. Copy the generated ID back in the event bus.

3. Upon ‘create instance’ event and gen_id property TRUE, use the part instance ID provided with the incoming event when invoke create operation out the fac terminal.

4. Extract the part instance ID from the event bus and invoke the corresponding I_FACT operation out the fac terminal when ‘destroy’, ‘activate’, and ‘deactivate’ events are received.

5. Activate the part instance following successful creation if the activate ev property is EV_NULL.

6. Deactivate the part instance before destruction if the deactivate_ev property is EV_NULL.

7. Get first instance id when enum_get_first_ev is received.

8. Get next instance id when enum_get_next_ev is received.

9. Disallow self-owned buses for creation events when gen_id property is TRUE.

10. Return status ‘not supported’ for all unrecognized events.

10. External States

None

11. Use Cases

11.1. Explicit Activation and Deactivation

The user of ZP_E2FAC has set the activate_ev and deactivate_ev properties to non-zero values.

1. ZP_E2FAC receives create_ev on its ctl terminal

2. ZP_E2FAC invokes create operation out its fac terminal

3. ZP_E2FAC receives activate_ev on its ctl terminal

4. ZP_E2FAC invokes activate operation out its fac terminal

5. ZP_E2FAC receives deactivate_ev on its ctl terminal

6. ZP_E2FAC invokes deactivate operation out its fac terminal

7. ZP_E2FAC receives destroy_ev on its ctl terminal.

8. ZP_E2FAC invokes destroy operation out its fac terminal.

11.2. Automatic Activation and Deactivation

The user of ZP_E2FAC has set the activate_ev and deactivate_ev properties to zero.

1. ZP_E2FAC receives create_ev on its ctl terminal

2. ZP_E2FAC invokes create operation out its fac terminal

3. If the part creation succeeds, ZP_E2FAC invokes activate operation out its fac terminal

4. ZP_E2FAC receives destroy_ev on its ctl terminal.

5. ZP_E2FAC invokes deactivate operation out its fac terminal

6. If the part deactivation succeeds, ZP_E2FAC invokes destroy operation out its fac terminal.

12. Notes

The byte order in the ID matches the default byte order supported by the CPU.

Appendix 1—Interfaces

This appendix describes preferred definition of interfaces used by parts described herein.

I_DRAIN—Event Drain

Overview

The Event Drain interface is used for event transportation and channeling. The events are carried with event ID, size, attributes and any event-specific data. Implementers of this interface usually need to perform a dispatch on the event ID (if they care).

Events are the most flexible way of communication between parts; their usage is highly justified in many cases, especially in weak interactions. Examples of usage include notification distribution, remote execution of services, etc.

Events can be classified in three groups: requests, notifications and general-purpose events. The events sent through this interface can be distributed synchronously or asynchronously. This is indicated by two bits in the attr member of the bus.

Additional attributes specified within the same member indicate whether the data is constant (that is, no recipient is supposed to modify the contents), or whether the ownership of the memory is transferred with the event (self-ownership). For detailed description of all attributes, see the next section.

There are two categories of parts that implement I_DRAIN: transporters and consumers. Transporters are parts that deliver events for other parts, without interpreting any data except id and, possibly, sz. They may duplicate the event, desynchronize it, marshal it, etc.

In contrast, consumers expect specific events, process them by taking appropriate actions and using any event-specific data that arrives with the event. In this case the event is effectively “consumed”.

If the event is self-owned, consumers need to release it after they are done processing. This is necessary, as there will be no other recipient that will receive the same event instance after the consumer. Transporters do not need to do that, they generally pass events through to other parts. Eventually, all events reach consumers and get released.

Implementations that are mixtures between transporters and consumers need to take about proper resource handling whenever the event is consumed.

Note that the bus for this interface is CMEVENT_HDR. In C++ this is equivalent to a CMEvent-derived class.

List of Operations

| | |
|---|---|
| Name | Description |
| raise | Raise an event, such as request, notification, etc. |

Attribute Definitions

| | |
|---|---|
| Name | Description |
| CMEVT_A_NONE | No attributes specified. |
| CMEVT_A_AUTO | Leave it to the implementation to |
| | determine the best attributes. |
| CMEVT A CONST | Data in the event bus is constant. |
| CMEVT_A_SYNC | Event can be distributed |
| | synchronously. |
| CMEVT_A_ASYNC | Event can be distributed |
| | asynchronously. |
| | All events that are asynchronous |
| | must have self-owned event buses. |
| | See the description of the |
| | CMEVT_A_SELF_OWNED |
| | attribute below. |
| CMEVT_A_SYNC_ANY | Event can be distributed either |
| | synchronously or asynchronously. |
| | This is a convenience attribute that |
| | combines CMEVT_A_SYNC |
| | and CMEVT_A_ASYNC. |
| | If no synchronicity is specified, |
| | it is assumed the event is both |
| | synchronous and asynchronous. |
| CMEVT_A_SELF_OWNED | Event bus was allocated from heap. |
| | Recipient of events with this |
| | attribute set are supposed to free |
| | the event. |
| CMEVT_A_SELF_CONTAINED | Data in the bus structure is self |
| | contained. The event bus contains |
| | no external references. |
| CMEVT_A_DFLT | Default attributes for an event bus |
| | (CMEVT_A_CONST and |
| | CMEVT_A_SYNC). |

Bus Definition

// event header
typedef struct CMEVENT_HDR

| { | |
|---|---|
| uint32 sz; | // size of the event data |
| _id id; // event id | |
| flg32 attr; | // event attributes |

} CMEVENT_HDR;

Note Use the EVENT and/or EVENTX macro to conveniently define event structures.

Raise

Description: Raise an event (such as request, notification, etc.)

| | | |
|---|---|---|
| In: | sz | Size of event bus, incl. event-specific data, in bytes |
| | id | Event ID |
| | attr | Event attributes [CMEVT_A_XXX] |
| | (any other) | Depends on id |
| Out: | void | |

| Return | Varies with the event |
|---|---|
| Status: | |
| Example: | /* define my event */ |
| | EVENTX (MY_EVENT, MY_EVENT_ID, CMEVT_A_AUTO, |

CMEVT_UNGUARDED)

dword my_event_data;
END_EVENTX
MY_EVENT *eventp;
cmstat status;
/* create a new event */
status = evt_alloc (MY_EVENT, &eventp);
if (status != CMST_OK) . . .
/* set event data */
eventp->my_event_data = 128;
/* raise event through I_DRAIN output */
out (drain, raise, eventp);

| | |
|---|---|
| Remarks: | The I_DRAIN interface is used to send events, requests or notifications. It |
| | only has one operation called raise. An event is generated by initializing an |
| | event bus and invoking the raise operation. |
| | The event bus describes the event. The minimum information needed is |
| | the size of the bus, event ID, and event attributes. The binary structure of |
| | the event bus may be extended to include event-specific information. |
| | Extending the event bus structure is done by using the EVENT and |
| | EVENTX macros. Parts that don't recognize the ID of a given event should |
| | interpret only the common header: the members of CMEVENT_HDR. |
| | The event attributes are divided into two categories: generic and event- |
| | specific. The first 16 bits (low word) of the attribute bit area is reserved for |
| | event-specific attributes. The last 16 bits (high word) of the attribute bit |
| | area is reserved for generic attributes. These are defined by CMAGIC.H |
| | (CMEVT_A_XXX). |
| | The generic attributes include the synchronicity of the event, whether the |
| | event data is constant, and if the event bus is self-owned or self- |
| | contained. If the event bus is self-owned, this means that it was allocated |
| | by the generator of the event and it is the responsibility of the recipient to |
| | free it (if the event is consumed). If the event is self-contained, this means |
| | the event bus contains no external references. For the event to be |
| | distributed asynchronously, the event bus must be self-owned and self- |
| | contained. |
| See also: | EVENT, EVENTX |

I_ITEM—Single Data Item Access

Overview

This interface is dedicated to a single item access based on a data path—a string that uniquely identifies the piece of data that is being accessed. This data can be stored in any type of container; how the data is stored is unimportant for the interface.

The set of operations is pretty basic: set, get and remove. The only detail that deserves attention is the fact that there is no need to “add” the data. This is implied by the set operation. If the container does not have data under given data path, this data will get there when set operation (with that path) is executed successfully. In contrast, if the container already had data under the path, the existing data will get replaced.

There is no explicit type information supported by the interface. However, for each piece of data, there is a double word that is associated with that data. Implementations that need type information can use this context for indication of the data type.

Typical implementation of this interface is by a container part that allows addressing the data by a string name. The syntax of that string is not defined by the interface.

List of Operations

| Name | Description |
|---|---|
| get | Get an item specified by data path |
| set | Set an item specified by data path |
| remove | Remove an item specified by data path |

Bus Definition

BUS (B_ITEM)

| | |
|---|---|
| dword qry_hdl; | // query handle |
| char *pathp; | // data path |
| void *stgp; | // pointer to storage |
| uint32 val_len; | // length of value in storage |
| uint32 stg_sz; | // size of storage |
| dword ctx; | // external data item context |
| dword attr; | // attributes |

END_BUS

Notes

There are no attributes defined for this interface. The member attr in the B_ITEM bus is reserved and must be set to zero.

Get

Description: Get an item specified by data path

| | | |
|---|---|---|
| In: | qry_hdl | Handle to query or 0 to use absolute path |
| | pathp | Data path (zero-terminated) |
| | | If qry_hdl != 0 then the data path starts from the |
| | | current query position. |
| | | If qry_hdl = = 0 then data path starts from the root. |
| | stgp | Pointer to buffer for data or NULL to get only the size |
| | | of the item |
| | stg_sz | Size of buffer pointed to by stgp |
| | attr | Reserved, must be zero |
| Out: | (*stgp) | Data for specified data path (if stgp != NULL) |
| | val_len | data size (even if stgp = = NULL) |
| | ctx | data context (even if stgp = = NULL) |
| Return | CMST_OK | The operation was successful. |
| Status: | | |
| | CMST_BAD_SYNTAX | The data path is invalid. |
| | CMST_INVALID | The query handle is invalid. |
| | CMST_NOT_FOUND | No data found at specified data path or the path was |
| | | not found. |
| | CMST_OVERFLOW | Storage buffer too small |

| | |
|---|---|
| Example: | B_ITEM itembus; |
| | char buffer [256]; |
| | cmstat status; |
| | /* initialize item bus */ |
| | itembus.qry_hdl = 0; |
| | itembus.pathp = “customer[0].name”; |
| | itembus.stgp = buffer; |
| | itembus.stg_sz = sizeof (buffer); |
| | itembus.attr = 0; |
| | /* get item data for ‘customer[0].name’ */ |
| | status = out (item, get, &itembus); |
| | if (status != CMST_OK) return; |
| | /* print customers name */ |
| | printf (“The first customers name is %s\n”, buffer); |
| See Also: | DM_REP, I_QUERY, EV_REP_NFY_DATA_CHANGE |

Set

Description: Set an item specified by data path

| | | |
|---|---|---|
| In: | qry_hdl | Handle to query or 0 to use absolute path |
| | pathp | Data path (ASCIIZ zero-terminated) |
| | | If qry_hdl != 0 then data path starts from the current |
| | | query position. |
| | | If qry_hdl = = 0 then data path starts from the root. |
| | stgp | Pointer to buffer with data or NULL for no data |
| | val_len | Length of data |
| | ctx | Data context |
| | attr | Reserved, must be zero |
| Out: | void | |
| Return | CMST_OK | The operation was successful |
| Status: | | |
| | CMST_INVALID | The query handle is invalid. |
| | CMST_BAD_SYNTAX | The data path is improperly formed. |
| | CMST_NO_ROOM | Too many names and/or too many entries |

| | |
|---|---|
| Example: | B_ITEM itembus; |
| | char buffer [256]; |
| | cmstat status |
| | /* initialize buffer with first customers name */ |
| | strcpy (buffer, “John Stewart”); |
| | /* initialize item bus */ |
| | itembus.qry_hdl = 0; |
| | itembus.pathp = “customer[0].name”; |
| | itembus.stgp = buffer; |
| | itembus.val_len = strlen (buffer) + 1; // include \0 |
| | itembus.ctx = MY_STRING_TYPE; // used as type |
| | itembus.attr = 0; |
| | /* set item data for ‘customer[0].name’ */ |
| | status = out (item, set, &itembus); |
| Remarks: | If an item is set by using the set operation and the data path specified |
| | does not exist, it will be created. |
| | It is possible and valid to have a data path with item size 0. In this case |
| | the context value is still present. To delete an item, use the remove |
| | operation. |
| See Also: | DM_REP, I_QUERY, EV_REP_NFY_DATA_CHANGE |

Remove

Description: Remove an item specified by data path

| | | |
|---|---|---|
| In: | qry_hdl | Handle to query or 0 |
| | pathp | Data path (ASCIIZ zero-terminated) |
| | | If qry_hdl != 0 then data path starts from the current |
| | | query position. |
| | | If qry_hdl = = 0 then data path starts from the root. |
| | attr | Reserved, must be zero |
| Out: | void | |
| Return | CMST_OK | The operation was successful |
| Status: | | |
| | CMST_INVALID | The query handle is invalid. |
| | CMST_BAD_SYNTAX | The specified path is invalid or improperly specified. |
| | CMST_NOT_FOUND | No data found at specified path |

| | |
|---|---|
| Example: | B_ITEM itembus; |
| | cmstat status; |
| | /* initialize item bus */ |
| | itembus.qry_hdl = 0; |
| | itembus.pathp = “customer[0].name”; |
| | itembus.attr = 0; |
| | /* remove path ‘customer[0].name’ */ |
| | status = out (item, remove, &itembus); |
| See Also: | DM_REP, I_QUERY, EV_REP_NFY_DATA_CHANGE |

I_LIST—Data List Access

Overview

I_LIST interface is devised to maintain lists. A list in this context is a collection of data objects with a notion of “previous” and “next” given an object. For all elements of the list this notion defines which element is preceding the current and which element is next. Naturally, the first and the last elements do not have previous and next, respectively.

A 0-terminated string uniquely identifies each list element. The implementer defines the syntax of this string.

The basic set of operations defined in this interface allows to simply add or remove elements from the list or to insert element at a particular position in the list. This position is identified by a reference element and the interface allows insertion before/after the reference or at beginning/ end of the list.

The interface supports both dynamic and static lists, thus allowing implementers to choose their best complexity/performance trade-off level.

One typical implementation of a list is an array. In this case is important to understand that recycling of deleted elements is almost always necessary for reasonable behavior. This is a typical scenario in static list implementations. For dynamic lists, the best-suited implementation model is dynamically allocated array with pointers to previous and next in the list elements (a double-linked list).

More sophisticated implementers may choose to carry pointers to last element and/or “recycle list”—a list of deleted array elements.

The examples below assume hierarchical data implementation but this is only for illustration purposes. The nature of data is not defined by the interface.

List of Operations

| Name | Description |
|---|---|
| add | Add a new element to a list |
| remove | Remove an element from a list |

Bus Definition

| BUS (B_LIST) | | |
|---|---|---|
| dword | qry_hdl; | // query handle |
| char | *pathp; | // data path |
| char | *bufp; | // pointer to storage |
| size_t | buf_sz; | // size of storage |
| dword | attr; | // attributes |

END_BUS

Notes

When adding a new element to the list, the implementation of I_LIST should choose the next index for the data path which will be the next available sequential index in the array. The data path is constructed and returned to the caller for later reference.

It is possible for a data path array to have missing elements (e.g., deleted entries).

The maximum number of elements in an array is determined by the implementer of I_LIST.

Add

Description: Add a new element to a list

| | | |
|---|---|---|
| In: | qry_hdl | Handle to query or 0 to use absolute path |
| | pathp | Subpath of list to add to. |
| | | If qry_hdl = = 0 then pathp starts from the root and ends |
| | | before the index (e.g., company[1].phone if you want to |
| | | add a new phone entry under company[1]). |
| | | If qry_hdl != 0 then pathp starts from the current query |
| | | position. |
| | bufp | Pointer to buffer for new path of element or NULL |
| | buf_sz | Size of the buffer pointed to by bufp |
| | attr | Reserved, must be zero |
| Out: | (*bufp) | New path for list element (e.g., company[1].phone[3]) |
| Return | CMST_OK | The operation was successful |
| Status: | | |
| | CMST_INVALID | The query handle is invalid. |
| | CMST_BAD_SYNTAX | The data path is improperly formed. |
| | CMST_NO_ROOM | Too many entries, names or list elements |
| | CMST_OVERFLOW | Too many levels in the path |

| | |
|---|---|
| Example: | B_LIST listbus; |
| | char path [256]; |
| | cmstat status; |
| | /* initialize list bus */ |
| | listbus.qry_hdl = 0; |
| | listbus.pathp = “customer”; |
| | listbus.bufp = path; |
| | listbus.buf_sz = sizeof (path); |
| | listbus.attr = 0; |
| | /* add new element to customer list */ |
| | status = out (list, add, &listbus); |
| | if (status != CMST_OK) return; |
| | /* print new element */ |
| | printf (“New list element added is %s\n”, path); |
| Remarks | Add operates on a single data path which is either explicitly provided or is |
| | the current data path of a query. To operate on the current data path of a |
| | query, a query handle needs to be supplied. See the I_QUERY interface for |
| | more information about queries. |
| See Also: | DM_REP, I_QUERY, EV_REP_NFY_DATA_CHANGE |

Remove

Description: Remove an element from a list

| | | |
|---|---|---|
| In: | qry_hdl | Handle to query or 0 |
| | pathp | Subpath of element root to remove (e.g., company |
| | | [1].forms[4]) |
| Out: | void | |
| Return | CMST_OK | The operation was successful |
| Status: | | |
| | CMST_INVALID | The query handle is invalid. |
| | CMST_BAD_SYNTAX | The data path is improperly formed. |
| | CMST_NOT_FOUND | No such list element (this status will be returned if and |
| | | only if there is no such element; CMST_OK will be |
| | | returned if the element existed, even if there were no |
| | | data below it). |

| | |
|---|---|
| Example: | B_LIST listbus; |
| | cmstat status; |
| | /* initialize list bus */ |
| | listbus.qry_hdl = 0; |
| | listbus.pathp = “customer[0]”; |
| | /* remove first element from customer list */ |
| | status = out (list, remove, &listbus); |
| Remarks: | Remove operates on a single data path or the current data path of a query. |
| | To operate on the current data path of a query, a query handle needs to be |
| | supplied. See the I_QUERY interface for more information about queries. |
| | In hierarchical data spaces, when this operation succeeds, it is expected |
| | that the whole subtree of the specified path was removed, too. |
| See Also: | DM_REP, I_QUERY, EV_REP_NFY_DATA_CHANGE |

I_QUERY—Data Queries

Overview

The I_QUERY interface is designed for performing queries among string elements. A query string is specified when opening a query; matching items can be enumerated.

This interface does not define the query string syntax, nor the possible syntax of the items themselves; this is left to the part that implements the interface. A few examples are: query is a SQL string, items are comma-separated values matching the query; query is a file path with wildcards, items are file names that match the wildcard.

When a query is opened, the open operation returns two values: a query handle and an enumeration context. The handle should be provided on all subsequent operations, including close. The enumeration context is slightly different; again, it should be provided to all operations. The difference is that the enumeration operations can modify the context value; the next time an operation is called, the caller must provide the new value.

This mechanism allows for two principally different implementations of the interface; provided that callers comply with the interface specification, they don't need to know which mechanism is implemented.

The first mechanism, identifying the query by handle, is used when the implementation can and needs to keep state of the query; on each operation, the handle identifies the query among the currently opened queries.

The second mechanism, via enumeration context that is modified by each enumeration operation is used by simple implementations. For example, the context may be the index of last item retrieved; this way, when asked for the next item, the implementation just needs to return the item at the next index. Note that each operation leaves the context in the interface bus, so callers don't have to take special actions to pass the context on every operation.

List of Operations

| Name | Description |
|---|---|
| open | Open a query |
| close | Close a query |
| get_first | Find first match |
| get_next | Find next match |
| get_prey | Find previous match |
| get_last | Find last match |
| get_curr | Get current match |

Bus Definition

BUS (B_QUERY)

| | |
|---|---|
| char *stgp; | // storage buffer |
| size_t stg_sz; | // storage buffer size |
| dword qry_hdl; | // query handle |
| dword attr; | // query attributes |
| dword qry_ctx; | // query context |

END_BUS

Notes

Every open query has a query context represented and accessed by a query handle. This context may just be the position in the enumeration or may contain other implementation specific data. Implementations may support different numbers of simultaneously open queries. This number ranges from 1 to unlimited.

Open

Description: Open a new query

| | | |
|---|---|---|
| In: | stgp | Query syntax string |
| | | The syntax of the query is not |
| | | defined by this interface; |
| | | it is defined by the |
| | | implementation. |
| | attr | Attributes, must be 0 |
| | | The enumeration criteria is |
| | | not defined by this interface; |
| | | it's defined by the |
| | | implementation. |
| Out: | qry_hdl | Query handle |
| Return | CMST_OK | The operation was successful |
| Status: | | |
| | CMST_BAD_SYNTAX | Invalid query syntax |
| | CMST_NO_ROOM | Too many open queries |

| | |
|---|---|
| Example: | B_QUERY qrybus; |
| | cmstat status; |
| | /* initialize query bus */ |
| | qrybus.stgp = “*”; // enumerate everything |
| | qrybus.attr = 0; |
| | /* open query */ |
| | status = out (query, open, &qrybus); |
| | if (status != CMST_OK) return; |
| | /* execute other query operations. . . */ |
| See Also: | DM_REP |

Close

Description: Close a query

| | | |
|---|---|---|
| In: | qry_hdl | Query handle returned from a |
| | | previous call to open |
| | attr | Reserved, must be zero |
| Out: | qry_hdl | 0 |
| Return | none | |
| Status: | | |
| Example | B_QUERY qrybus; | |
| | cmstat status; | |

| | |
|---|---|
| | /* initialize query bus */ |
| | qrybus.stgp = “*”; // enumerate everything |
| | qrybus.attr = 0; |
| | /* open query */ |
| | status = out (query, open, &qrybus); |
| | if (status != CMST_OK) return; |
| | /* execute other query operations. . . */ |
| | /* close query */ |
| | out (query, close, &qrybus); |
| See Also: | DM_REP |

Get_first

| Description: | Find the first match in the given query | |
|---|---|---|
| in: | qry_hdl | Query handle returned from |
| | | a previous call to open |
| | stgp | Pointer to buffer for the |
| | | match found or NULL |
| | stg_sz | Size of the buffer pointed |
| | | to by stgp |
| | attr | Reserved, must be zero |
| Out: | (*stgp) | Result (if stgp ! = NULL), |
| | | in ASCIIZ form |
| | qry_ctx | Query context |
| Return | CMST_OK | The operation was successful. |
| Status: | CMST_INVALID | The query handle is invalid. |
| | CMST_OVERFLOW | Buffer is too small to hold |
| | | match. (if stgp ! = NULL) |
| | CMST_NOT_FOUND | No match was found. |

| | |
|---|---|
| Example: | B QUERY qrybus; |
| | char buffer [256]; |
| | cmstat status; |
| | /* initialize query bus */ |
| | qrybus.stgp = “*”; //enumerate everything |
| | qrybus.attr = 0; |
| | /* open query */ |
| | status = out (query, open, & qrybus); |
| | if (status ! = CMST_OK) return; |
| | /* get first match */ |
| | qrybus.stgp = buffer; |
| | qrybus.stgsz = sizeof (buffer); |
| | status = out (query, get_first, & qrybus); |
| | if (status = = CMST_OK) |
| | /* print match (assuming match syntax is a string) */ |
| | printf (“The first match of the query is % s\n”, buffer); |
| | /* close query */ |
| | out (query, close, & qrybus); |
| See Also: | DM_REP |

Get_next

Description: Find the next match in the given query

| | | |
|---|---|---|
| In: | qry_hdl | Query handle returned from a |
| | | previous call to open |
| | stgp | Pointer to buffer for the match |
| | | found or NULL |
| | stg_sz | Size of the buffer pointed to |
| | | by stgp |
| | qry_ctx | Query context returned from |
| | | a previous call to get_xxx |
| | attr | Reserved, must be zero |
| Out: | (*stgp) | Result (if stgp != NULL) |
| | qry_ctx | Query context |
| Return Status: | CMST_OK | The operation was successful. |
| | CMST_INVALID | The query handle is invalid. |
| | CMST_OVERFLOW | The buffer is too small to hold |
| | | the match. (if stgp != NULL) |
| | CMST_NOT_FOUND | No match found |

| Example: | B_QUERY qrybus; |
|---|---|
| | char buffer [256]; |
| | cmstat status; |
| | /* initialize query bus */ |
| | qrybus.stgp = “*”; // enumerate everything |
| | qrybus.attr = 0; |
| | /* open query */ |
| | status = out (query, open, &qrybus); |
| | if (status != CMST_OK) return; |
| | /* initialize bus get first match */ |
| | qrybus.stgp = buffer; |
| | qrybus.stg_sz = sizeof (buffer); |
| | /* enumerate matching entries */ |
| | for (status = out (query, get_first, &qrybus); |

status = = CMST_OK;
status = out (query, get_next, &qrybus))

{
/* print matching entries */
printf (“The next match is %s\n”, buffer);
}

if (status != CMST_NOT_FOUND)

/* print error. . .*/

| | /* close query */ |
|---|---|
| | out (query, close, &qrybus); |
| See Also: | DM_REP |

Get_prev

Description: Find the previous match in the given query

| | | |
|---|---|---|
| In: | qry_hdl | Query handle returned from a |
| | | previous call to open |
| | stgp | Pointer to buffer for the match |
| | | found or NULL |
| | stg_sz | Size of the buffer pointed to |
| | | by stgp |
| | qry_ctx | Query context returned from a |
| | | previous call to get_xxx |
| | attr | Reserved, must be zero |
| Out: | (*stgp) | Result (if stgp != NULL) |
| | qry_ctx | Query context |
| Return Status: | CMST_OK | The operation was successful |
| | CMST_INVALID | The query handle is invalid. |
| | CMST_OVERFLOW | The buffer is too small to hold |
| | | the match. (if stgp != NULL) |
| | CMST_NOT_FOUND | No match found |

| | |
|---|---|
| Example: | See get_next example |
| See Also: | DM_REP |

Get_last

Description: Find the last match in the given query

| | | |
|---|---|---|
| In: | qry_hdl | Query handle returned from a |
| | | previous call to open |
| | stgp | Pointer to buffer for the match |
| | | found or NULL |
| | stg_sz | Size of the buffer pointed to |
| | | by stgp |
| | attr | Reserved, must be zero |
| Out: | (*stgp) | Result (if stgp != NULL) |
| | qry_ctx | Query context |
| Return Status: | CMST_OK | The operation was successful |
| | CMST_INVALID | The query handle is invalid. |
| | CMST_OVERELOW | The buffer is too small to hold |
| | | the match. (if stgp != NULL) |
| | CMST_NOT_FOUND | No match found |

| | |
|---|---|
| Example: | See get_first example |
| See Also | DM_REP |

Get_curr

Description: Get current match in the given query

| | | |
|---|---|---|
| In: | qry_hdl | Query handle returned from a |
| | | previous call to open |
| | stgp | Pointer to buffer for the match |
| | | found or NULL |
| | stg_sz | Size of the buffer pointed to |
| | | by stgp |
| | qry_ctx | Query context returned from a |
| | | previous call to get_xxx |
| | attr | Reserved, must be zero |
| Out: | (*stgp) | Result (if stgp != NULL) |
| | qry_ctx | Query context |
| Return | CMST_OK | The operation was successful |
| Status: | | |
| | CMST_INVALID | The query handle is invalid. |
| | CMST_OVERFLOW | The buffer is too small to hold |
| | | the match. (if stgp != NULL) |
| | CMST_NOT_FOUND | No match found |
| Example: | B_QUERY qrybus; | |
| | char buffer [256]; | |
| | cmstat status; | |

/* initialize query bus */
qrybus.stgp = “*”; // enumerate everything
qrybus.attr = 0;
/* open query */
status = out (query, open, &qrybus);
if (status != CMST_OK) return;
/* get first match */
qrybus.stgp = buffer;
qrybus.stg_sz = sizeof (buffer);
status = out (query, get_first, &qrybus);
if (status != CMST_OK)

{
/* close query */
out (query, close, &qrybus);
return;
}

/* get current match */
status = out (query, get_curr, &qrybus);
if (status = = CMST_OK)

/* print current match */
printf (“The current match is %s\n”, buffer);

| | /* close query */ |
|---|---|
| | out (query, close, &qrybus); |
| See Also: | DM_REP |

I_DPATH—Hierarchical Data Path Arithmetic

Overview

The I_DPATH interface is designed for manipulation of data paths. A data path is a string, with a specific syntax, that identifies a data item in some type of data storage. The syntax of data paths manipulated by this interface is virtually identical to the syntax of accessing data structures in most high level programming languages, including C and C++

Here are a few examples of data path manipulated by this interface:

customer[1].name

Sensor.Value

matrix[1][2][3]

This interface provides for parsing and constructing data paths. The smallest unit of the path we call pel, or path element. This interface defines the following types of path elements:

names (e.g., Sensor)

indices (e.g., [3])

single pel wildcard (e.g., ? or [?])

wildcard for any number of pels (e.g., *)

List of Operations

| Name | Description |
|---|---|
| join | Construct a path from up to three elements, |
| | inserting the appropriate delimiters |
| split | Split a path at the specified level in up to three parts |
| split2 | Split a path at the specified level in up to two parts |
| get_info | parse the path and count the number of levels |

Pel Type Definition

| Name | Description |
|---|---|
| I_DPATH_PELTYPE_NON | No pel specified |
| E | |
| I_DPATH_PELTYPE_NA | Name pel (ASCII string) |
| ME | |
| I_DPATH_PELTYPE_IND | Index pel |
| EX | |
| I_DPATH_PELTYPE_WIL | Wildcard for one pel |
| D_1 | |
| I_DPATH_PELTYPE_WIL | Wildcard for any number of pels |
| D_ANY | |

Bus Definition

BUS (B_DPATH)

| | | |
|---|---|---|
| char | *pathp; | // full path |
| size_t | path_sz; | // size of buffer for full path, [bytes] |
| char | *pre_pathp; | // path prefix (up to & excluding the |
| | | // pel) |
| size_t | pre_path_sz; | // size of buffer for prefix, [bytes] |
| uint | pel_type; | // path element (pel) |
| uint32 | pel_val; | // value of index pel (when |
| | | // PELTYPE_INDEX) |
| char | *pelp; | // pel in string form (any type) |
| size_t | pel_sz; | // size of pel string buffer, [bytes] |
| char | *post_pathp; | // suffix (after the pel) |
| size_t | post_path_sz; | // size of buffer for suffix, [bytes] |
| dword | attr; | // attributes (none defined) |
| int | level; | // level to split at |
| | | // (<0: count backwards) |
| uint | num_levels; | // number of levels in the full path |

END_BUS

Notes

The data paths are strings of up to 256 characters, which are constructed using identifiers and array indices. Both identifiers and indices are referred to as “pets”—short for “path element”.

The data path syntax is very similar to the syntax for specifying data structures in programming languages like C. Here are a few examples of typical data paths:

customer[1].name

Sensor.Value

matrix[1][2][3]

Join

Description: Construct a path of up to three elements (prefix + pel + suffix),
inserting the appropriate delimiters (path punctuation)

| | | |
|---|---|---|
| In: | pathp | Buffer for resulting path or NULL |
| | path_sz | Size of buffer pointed to by pathp in bytes |
| | pre_pathp | Path prefix or NULL for none |
| | pel_type | Type of pel to insert [I_DPATH_PELTYPE_XXX] |
| | pelp | Pel name to insert between the prefix and suffix |
| | | This argument is supplied only when |
| | | pel_type = = I_DPATH_PELTYPE_NAME. |
| | | Any type of single-level pel can be provided in |
| | | pelp: wildcard, name, or [index] (index must |
| | | have the brackets, otherwise it is interpreted as a name). |
| | pel_val | Pel value to insert between the prefix and suffix |
| | | This argument is supplied only when |
| | | pel_type = = I_DPATH_PELTYPE_INDEX. |
| | post_pathp | Path suffix or NULL for none |
| | attr | Reserved, must be zero |
| Out: | (*pathp) | Resulting path (if pathp != NULL) |
| | num_levels | Number of levels in resulting path |
| Return | CMST_OK | The operation was successful |
| Status: | | |
| | CMST_BAD_SYNTAX | Incorrect path syntax in one or more elements |
| | CMST_OUT_OF_RANGE | Invalid pel index value (for |
| | | I_DPATH_PELTYPE_INDEX only) |
| | CMST_BAD_VALUE | Resulting path is not a valid path (e.g., too long) |

| Example: | B_DPATH dpathbus; |
|---|---|
| | char path [256]; |
| | cmstat status; |
| | /* initialize bus to join: customer[1].name */ |
| | dpathbus.pathp = path; |
| | dpathbus.path_sz = sizeof (path); |
| | dpathbus.pre_pathp = “customer”; |
| | dpathbus.pel_type = I_DPATH_PELTYPE_INDEX; |
| | dpathbus.pel_val = 1; |
| | dpathbus.post_pathp = “name”; |
| | dpathbus.attr = 0; |
| | /* join path elements */ |
| | status = out (dpath, join, &dpathbus); |
| | if (status = = CMST_OK) |

/* print result (customer[1].name) */
printf (“The resulting path is %s\n”, path);

| | |
|---|---|
| Remarks: | All elements (pre_pathp, pelp, and post_pathp) are optional. The |
| | path is to be assembled in a local buffer before being copied into |
| | *pathp; therefore in and out buffers can overlap, e.g., pathp can |
| | be the same as pre_pathp. |
| See Also: | DM_REP |

Split

Description: Divide a path at the specified level in up to three parts

| | | |
|---|---|---|
| In: | pathp | Path to split |
| | | Refer to the notes section act the beginning of |
| | | this interface for a further description of the |
| | | syntax of paths and pels. |
| | pre_pathp | Buffer for path prefix or NULL, may overlap pathp |
| | pre_path_sz | Size of prefix buffer in bytes |
| | pelp | Buffer for pel name or NULL, may overlap pathp |
| | pel_sz | Size of pel name buffer in bytes |
| | post_pathp | Buffer for path suffix or NULL, may overlap pathp |
| | post_path_sz | Size of suffix buffer in bytes |
| | level | Level at which to split |
| | | When level is negative, the split position is counted from |
| | | the end of the path. If the path has n levels, the valid values |
| | | for level are [−n..n−1]. If level < 0, level becomes n-level. |
| | attr | Reserved, must be zero |
| Out: | (*pre_pathp) | Path prefix (if pre_pathp != NULL), may be an empty string |
| | pel_type | Type of pel [I_DPATH_PEL_TYPE_XXX] |
| | | Refer to the notes section act the beginning of |
| | | this interface for a further description of the |
| | | syntax of paths and pels. |
| | (*pelp) | Pel name or value |
| | | (if pelp != NULL) |
| | pel_val | Pel value (0 if pel_type != I_DPATH_PELTYPE_INDEX) |
| | (*post_pathp) | Path suffix (if post_pathp != NULL), may be an empty string |
| | level | Level at which path was split, (> = 0) |
| Return | CMST_OK | The operation was successful. |
| Status: | | |
| | CMST_BAD_SYNTAX | Incorrect path syntax. |
| | CMST_BAD_VALUE | The source path has less than level levels. |

| | |
|---|---|
| Example: | B_DPATH dpathbus; |
| | char prepath [256]; |
| | char postpath [256]; |
| | char pel [256]; |
| | cmstat status; |
| | /* initialize bus to split: customer[1].name */ |
| | dpathbus.pathp = “customer[1].name”; |
| | dpathbus.pre_pathp = prepath; |
| | dpathbus.pre_path_sz = sizeof (prepath); |
| | dpathbus.pelp = pel; |
| | dpathbus.pel_sz = sizeof (pel); |
| | dpathbus.post_pathp = postpath; |
| | dpathbus.post_path_sz = sizeof (postpath); |
| | dpathbus.level = 1; |
| | dpathbus.attr = 0; |
| | /* split path */ |
| | status = out (dpath, split, &dpathbus); |
| | if (status = = CMST_OK) |
| | { |
| | /* print results */ |
| | printf (“path prefix = %s\n”, prepath); // ‘customer’ |
| | printf (“path pel = %s\n”, pel); // ‘[1]’ |
| | printf (“path suffix = %s\n”, postpath); // ‘name’ |
| | } |
| Remarks: | pelp will contain the path element at the position specified |
| | by level. pre_pathp will contain any part of the |
| | path before this position, and post_pathp will |
| | contain any part after this position. |
| See Also: | DM_REP |

Split2

Description: Divide a path at the specified level into two parts

| | | |
|---|---|---|
| In: | pathp | Path to split |
| | | Refer to the notes section act |
| | | the beginning of this interface |
| | | for a further description of the |
| | | syntax of paths and pels. |
| | pre_pathp | Buffer for path prefix or |
| | | NULL, may overlap pathp |
| | pre_path_sz | Size of prefix buffer in bytes |
| | post_pathp | Buffer for path suffix or |
| | | NULL, may overlap pathp |
| | post_path_sz | Size of suffix buffer in bytes |
| | level | Level at which to split |
| | | When level is negative, the |
| | | split position is counted from |
| | | the end of the path. If the path |
| | | has n levels, the valid values |
| | | for level are [−n..n−1]. If |
| | | level < 0, level becomes |
| | | n-level. |
| | attr | Reserved, must be zero |
| Out: | (*pre_pathp) | Path prefix (if pre_pathp != |
| | | NULL), may be an empty |
| | | string |
| | (*post_pathp) | Path suffix (if post_pathp != |
| | | NULL), may be an empty |
| | | string |
| | level | Level at which path was split, |
| | | (>= 0) |
| Return | CMST_OK | The operation was successful |
| Status: | | |
| | CMST_BAD_SYNTAX | Incorrect path syntax in |
| | | source path. |
| | CMST_BAD_VALUE | Source path has less than level |
| | | levels |

| | |
|---|---|
| Example: | B_DPATH dpathbus; |
| | char prepath [256]; |
| | char postpath [256]; |
| | cmstat status; |
| | /* initialize bus to split: ‘customer[1].name’ */ |
| | dpathbus.pathp = “customer[1].name”; |
| | dpathbus.pre_pathp = prepath; |
| | dpathbus.pre_path_sz = sizeof (prepath); |
| | dpathbus.post_pathp = postpath; |
| | dpathbus.post_path_sz = sizeof (postpath); |
| | dpathbus.level = 2; |
| | dpathbus.attr = 0; |
| | /* split path */ |
| | status = out (dpath, split2, &dpathbus); |
| | if (status = = CMST_OK) |

{
/* print results */
printf (“path prefix = %s\n”, prepath); // ‘customer[1]’
printf (“path suffix = %s\n”, postpath); // ‘name’
}

| | |
|---|---|
| See Also: | DM_REP |

Get_info

Description: Parse the path and count the number of levels the path
contains

| | | |
|---|---|---|
| In: | pathp | Path to check or NULL |
| | | Refer to the notes section at |
| | | the beginning of this interface |
| | | for a further description of the |
| | | syntax of paths and pels. |
| | attr | Reserved, must be zero |
| Out: | num_levels | Number of levels in the path, |
| | | if pathp = = NULL 0 is |
| | | returned |
| Return | CMST_OK | The operation was successful |
| Status: | | |
| | CMST_BAD_SYNTAX | Incorrect path syntax |

| Example: | B_DPATH dpathbus; |
|---|---|
| | cmstat status; |
| | /* initialize bus */ |
| | dpathbus.pathp = “customer[0].name”; |
| | dpathbus.attr = 0; |
| | /* get information on path */ |
| | status = out (dpath, get_info, &dpathbus); |
| | if (status = = CMST_OK) |

{
/* print results */
printf (“Path has %u levels.\n”,

dpathbus.num_levels); // displays 3

}

| | |
|---|---|
| See Also: | DM_REP |

I_SERIAL—Data Serialization

Overview

The I_SERIAL interface provides for performing transfers between a primary data store and a secondary data store. For example, it can be used to serialize and deserialize the state of a given object to file.

The definition of the interface does not define the type of data that is being serialized, nor the format in which the data is maintained in either store.

It does define the possible types of secondary data store: disk file, registry entry and Windows INI file; it defines where and how the data is placed in the secondary store.

List of Operations

| Name | Description |
|---|---|
| clear | Clear the state of the primary store |
| load | Load the primary store from the specified |
| | secondary store (deserialize) |
| save | Save the primary store into the specified |
| | secondary store (serialize) |

Storage Type Definitions

| Name | Description |
|---|---|
| I_SERIAL_STG_INI | Windows INI file |
| I_SERIAL_STG_FSPEC | File by supplied file path |
| I_SERIAL_STG_FHANDLE | File by supplied file handle (file is |
| | open) |
| I_SERIAL_STG_REGISTR | Windows Registry |
| Y | |

Bus Definition

BUS (B_SERIAL)

uint stg_type; // storage type
dword attr; // attributes
char *nmp; // depends on storage type
char *sect_nmp; // section name
dword hdl; // depends on storage type

END_BUS

Notes

The implementation of these operations may not support all-storage types. It can return CMST_NOT_SUPPORTED for the storage types not supported. When using the I_SERIAL_STG_FHANDLE storage type, the file handle should contain a handle to an open file. The file should be at the position of where the data is to be saved. After a save operation, the file position will be at the next byte following the data.

The file handle type used with the I_SERIAL_STG_FHANDLE storage type is defined by the implementer (Win32, DOS, etc.). The file handle type must remain consistent with all the I_SERIALIZE operations.

| Description: | Clear the state of the primary store (empty data) | |
|---|---|---|
| Out: | void | |
| Return | CMST_OK | The operation was successful |
| Status: | | |
| | (any other) | An intermittent error has occurred |

| | |
|---|---|
| Example: | B_SERIAL serbus; |
| | /* clear data */ |
| | out (ser, clear, &serbus); |
| See Also: | DM_REP |

Load

Description: Load primary store from persistent storage

| In: | stg_type | Storage type, | |
|---|---|---|---|
| | | [I_SERIAL_STG_xxx] | |
| | attr | Reserved, must be zero | |
| | nmp | Depends on storage type: | |
| | | I_SERIAL_STG_INI | Name of INI |
| | | | file to load |
| | | | data from |
| | | I_SERIAL_STG_FSPEC | Full path of file |
| | | | to load |
| | | I_SERIAL_STG_REGISTRY | Key name in |
| | | | registry to load |
| | | | data from |
| | | (other) | set to NULL |

| | |
|---|---|
| sect_nmp | Depends on storage type: |

| | |
|---|---|
| I_SERIAL_STG_INI | Name of INI |
| | section to load |
| | data from |
| (other) | set to NULL |

| | |
|---|---|
| hdl | Depends on storage type: |

| | |
|---|---|
| I_SERIAL_STG_FHANDLE | File handle |
| I_SERIAL_STG_REGISTRY | Registry Key |
| | handle |
| (other) | set to 0 |

| | | If the storage type is |
|---|---|---|
| | | I_SERIAL_STG_FHANDLE, |
| | | the file position is expected to be |
| | | set at the beginning of the serial- |
| | | ized repository data; after the load |
| | | is complete it will leave the file |
| | | position at the byte after the last |
| | | byte of the repository data. |
| Out: | void | |
| Return | CMST_OK | The operation was successful |
| Status: | | |
| | CMST_NOT_FOUND | The source from which to load |
| | | could not be located. |
| | CMST_IOERR | Could not read data from storage |
| | | medium |
| | CMST_NOT_SUPPORTED | Specified storage type is not |
| | | supported |

| | |
|---|---|
| Example: | B_SERIAL serbus; |
| | cmstat status; |
| | /* initialize serialization bus */ |
| | serbus.stg_type = I_SERIAL_STG_FSPEC; |
| | serbus.attr = 0; |
| | serbus.nmp = “C:\\DOS\\MYDATA.BIN”; |
| | /* load repository from my binary file */ |
| | status = out (ser, load, &serbus); |
| See Also: | DM_REP |

Save

Description: Save primary store to persistent storage

| | | |
|---|---|---|
| In: | stg_type | Storage type [I_SERIAL_STG_XXX] |
| | attr | Reserved, must be zero |
| | nmp | Depends on storage type: |

| | |
|---|---|
| I_SERIAL_STG_INI | Name of INI |
| | section to save |
| | data to |
| I_SERIAL_STG_FSPEC | Full path of file |
| | to save data to |
| I_SERIAL_STG_REGISTRY | Key name in |
| | registry to |
| | save data to |
| (other) | set to NULL |

| | |
|---|---|
| sect_nmp | Depends on storage type: |

| | |
|---|---|
| I_SERIAL_STG_INI | Name of INI |
| | section to save |
| | data to |
| (other) | set to NULL |

| | |
|---|---|
| hdl | Depends on storage type: |

| | |
|---|---|
| I_SERIAL_STG_FHANDLE | File handle |
| I_SERIAL_STG_REGISTRY | Registry Key |
| | handle |
| (other) | set to 0 |

| | | When this argument is |
|---|---|---|
| | | I_SERIAL_STG_FHANDLE, the data |
| | | will be saved starting from the |
| | | current file position; after save is |
| | | complete, it will leave the position at |
| | | the next byte after the last byte of |
| | | the saved data. |
| Out: | void | |
| Return | CMST_OK | The operation was successful |
| Status: | | |
| | CMST_NOT_FOUND | The source to which to save the |
| | | data could not be located. |
| | CMST_IOERR | Could not write data to storage |
| | | medium |
| | CMST_NOT_SUPPORTED | Specified storage type is not |
| | | supported |

| | |
|---|---|
| Example: | B_SERIAL serbus; |
| | cmstat status; |
| | /* initialize serialization bus */ |
| | serbus.stg_type = I_SERIAL_STG_FSPEC; |
| | serbus.attr = 0; |
| | serbus.nmp = “C:\\DOS\\MYDATA.BIN”; |
| | /* save repository to a binary file */ |
| | status = out (ser, save, &serbus); |
| See Also: | DM_REP |

I_A_FACT—Part Array Factory Services

Overview

This interface is used to control the life cycle and enumerate the parts in a part array. The parts are identified by an ID either generated by the array or supplied by the user on creation of a new part.

This interface is typically used by a controlling part in a dynamic assembly. The controlling part is responsible for maintaining the container of part instances for the assembly.

This interface is implemented by DM_ARR.

List of Operations

| Name | Description |
|---|---|
| create | Create a part instance in the array. |
| destroy | Destroy a part instance in the array. |
| activate | Activate a part instance in the array. |
| deactivate | Deactivate a part instance in the array. |
| get_first | Get the first part in the part array. |
| get_next | Get the next part in the part array. |

Bus Definition

BUS (B_A_FACT)

flg32 attr ; // attributes [A_FACT_A_XXX]
char *namep ; // class name for part to create
uint32 id ; // part instance id
_ctx ctx ; // enumeration context

END_BUS

Create

Description: Create a part instance in the array.

| | | |
|---|---|---|
| In: | attr | Creation attributes: |

| | |
|---|---|
| A_FACT_A_NONE | Not specified. |
| A_FACT_A_USE_ID | Use the ID |
| | supplied in id to |
| | identify the |
| | created part. |

| | namep | Class name of the part to create or |
|---|---|---|
| | | NULL to use the default class name. |
| | id | ID to use if the attribute |
| | | A_FACT_A_USE_ID is specified. |
| Out: | id | ID of the created part (only if the |
| | | attribute A_FACT_A_USE_ID |
| | | is not specified). |
| Return | CMST_OK | The operation was successful. |
| Status: | | |
| | CMST_CANT_BIND | The part class was not found. |
| | CMST_ALLOC | Not enough memory. |
| | CMST_NO_ROOM | No more parts can be created. |
| | CMST_DUPLICATE | The specified ID already exists (only if |
| | | the A_FACT_A_USE_ID attribute is |
| | | specifed). |
| | (all others) | Specific error occurred during object |
| | | creation. |

| | |
|---|---|
| Example: | B_A_FACT bus; |
| | CMSTAT s; |
| | /* create a new part in the part array */ |
| | bus.attr = A_FACT_A_NONE; |
| | bus.namep = “MyPartClass”; |
| | s = out (i_a_fact, create, &bus); |
| | if (s != CMST_OK) . . . |
| See Also: | DM_ARR |

Destroy

Description: Destroy a part instance in the array.

| | | |
|---|---|---|
| In: | id | ID of part to destroy. |
| Out: | void | |
| Return | CMST_OK | The operation was successful. |
| Status: | | |
| | CMST_NOT_FOUND | A part with the specified ID was |
| | | not found. |
| | (all others) | An intermittent error occurred |
| | | during destruction. |

| | |
|---|---|
| Example: | B_A_FACT bus; |
| | CMSTAT s; |
| | /* create a new part in the part array */ |
| | bus.attr = A_FACT_A_NONE; |
| | bus.namep = “MyPartClass”; |
| | s = out (i_a_fact, create, &bus); |
| | if (s != CMST_OK) . . . |
| | . . . |
| | /* destroy created part */ |
| | s = out (i_a_fact, destroy, &bus); |
| | if (s != CMST_OK) . . . |
| See Also: | DM_ARR |

Activate

Description: Activate a part instance in the array.

| | | |
|---|---|---|
| In: | id | ID of part to activate. |
| Out: | void | |
| Return | CMST_OK | The operation was successful. |
| Status: | | |
| | CMST_NOT_FOUND | A part with the specified ID was |
| | | not found. |
| | CMST_NO_ACTION | The part is already active. |
| | CMST_REFUSE | Mandatory properties have not |
| | | been set or terminals not |
| | | connected on the part. |
| | (all others) | An intermittent error occurred |
| | | during activation. |

| | |
|---|---|
| Example: | B_A_FACT bus; |
| | CMSTAT s; |
| | /* create a new part in the part array */ |
| | bus.attr = A_FACT_A_NONE; |
| | bus.namep = “MyPartClass”; |
| | s = out (i_a_fact, create, &bus); |
| | if (s != CMST_OK) . . . |
| | /* activate part */ |
| | s = out (i_a_fact, activate, &bus); |
| | if (s != CMST_OK) . . . |
| See Also: | DM_ARR |

Deactivate

Description: Deactivate a part instance in the array.

| | | |
|---|---|---|
| In: | id | ID of part to deactivate. |
| Out: | void | |
| Return | CMST_OK | The operation was successful. |
| Status: | | |
| | CMST_NOT_FOUND | A part with the specified ID was |
| | | not found. |
| | (all others) | An intermittent error occurred |
| | | during deactivation. |

| | |
|---|---|
| Example: | B_A_FACT bus; |
| | CMSTAT s; |
| | /* create a new part in the part array */ |
| | bus.attr = A_FACT_A_NONE; |
| | bus.namep = “MyPartClass”; |
| | s = out (i_a_fact, create, &bus); |
| | if (s != CMST_OK) . . . |
| | /* activate part */ |
| | s = out (i_a_fact, activate, &bus); |
| | if (s != CMST_OK) . . . |
| | . . . |
| | /* deactivate part */ |
| | s = out (i_a_fact, deactivate, &bus); |
| | if (s != CMST_OK) . . . |
| See Also: | DM_ARR |

Get_first

| Description: | Get the first part in the array. | |
|---|---|---|
| In: | void | |
| Out: | id | ID of the first part in the array. |
| | ctx | Enumeration context for subsequent |
| | | get_next calls. |
| Return | CMST_OK | The operation was successful. |
| Status: | | |
| | CMST_NOT_OF | The array has no parts. |
| | UND | |

| | |
|---|---|
| Example: | B_A_FACT bus; |
| | CMSTAT s; |
| | /* enumerate all parts in part array */ |
| | s = out (i_a_fact, get_first, &bus); |
| | while (s = = CMST_OK) |

{
/** print id */
printf (“Part ID = %x\n”, bus.id);
/** get next part */
s = out (i_a_fact, get_next, &bus);
}

| | |
|---|---|
| See Also: | DM_ARR |

Get_next

| Description: | Get the next part in the array. | |
|---|---|---|
| In: | ctx | Enumeration context from previous |
| | | get_xxx calls. |
| Out: | id | ID of next part in the array. |
| | ctx | Enumeration context for subsequent |
| | | get_xxx calls. |
| Return | CMST_OK | The operation was successful. |
| Status: | | |
| | CMST_NOT_OF | The array has no more parts. |
| | UND | |

| | |
|---|---|
| Example: | B_A_FACT bus; |
| | CMSTAT s; |
| | /* enumerate all parts in part array */ |
| | s = out (i_a_fact, get_first, &bus); |
| | while (s = = CMST_OK) |

{
/** print id */
printf (“Part ID = %x\n”, bus.id);
/** get next part */
s = out (i_a_fact, get_next, &bus);
}

| | |
|---|---|
| See Also: | DM_ARR |

I_A_CONN—Part Array Connection Services

Overview

This interface is used to connect and disconnect terminals of parts maintained in a part array. This interface is typically used by a controlling part in a dynamic assembly. The controlling part is responsible for maintaining the container of part instances for the assembly.

This interface is implemented by DM_ARR.

List of Operations

| Name | Description |
|---|---|
| connect_{—} | Connect two terminals between parts in |
| | the array. |
| disconnect | Disconnect two terminals between parts in |
| | the array. |

Bus Definition

BUS (B_A_CONN)

| | | |
|---|---|---|
| uint32 | id1 | ; // id of part 1 |

| | |
|---|---|
| char | *term1_namep ; // terminal name of part 1 |

| | | |
|---|---|---|
| uint32 | id2 | ; // id of part 2 |

| | |
|---|---|
| char | *term2_namep ; // terminal name of part 2 |

| | | |
|---|---|---|
| _id | conn_id | ; // connection id |

END_BUS

Notes

When connecting and disconnecting terminals, id1 and id2 may be the same to connect two terminals on the same part.

Connect_

| Description: | Connect two terminals between parts in the array. | |
|---|---|---|
| In: | id1 | ID of first part. |
| | term1_namep | Terminal name of first part. |
| | id2 | ID of second part. |
| | term2_namep | Terminal name of second part. |
| | conn_id | Connection ID to represent this |
| | | connection. |
| Out: | void | |
| Return | CMST_OK | The operation was successful. |
| Status: | | |
| | CMST_REFUSE | There has been an interface or direction |
| | | mismatch or an attempt has been made |
| | | to connect a non-activetime terminal |
| | | when the part is in an active state. |
| | CMST_NOT_OF | At least one of the terminals could not |
| | UND | be found or one of the ids is invalid. |
| | CMST_OVERFLO | An implementation imposed restriction |
| | W | in the number of connections has been |
| | | exceeded. |

| Example: | B_A_CONN bus; | |
|---|---|---|
| | CMSTAT s; | |
| | /* connect “in” on first part to “out” on second part */ | |
| | bus.id1 | = part_id1; |
| | bus.term1_namep = “in”; | |
| | bus.id2 | = part_id2; |
| | bus.term2_namep = “out”; | |
| | bus.conn_id | = 1; |

| | s = out (i_a_conn, connect_, &bus); |
|---|---|
| | if (s ! = CMST_OK)... |
| See Also: | DM_ARR |

Disconnect

| Description: | Disconnect two terminals between parts in the array. | |
|---|---|---|
| In: | id1 | ID of first part. |
| | term1_namep | Terminal name of first part. |
| | id2 | ID of second part. |
| | term2_namep | Terminal name of second part. |
| | conn_id | Connection ID to represent this |
| | | connection. |
| Out: | void | |
| Return | CMST_OK | The operation was successful. |
| Status: | | |
| Example: | B_A_CONN bus; | |
| | CMSTAT s; | |

| /* connect “in” on first part to “out” on second part */ | |
|---|---|
| bus.id1 | = part_id1; |
| bus.term1_namep = “in”; | |
| bus.id2 | = part id2; |
| bus.term2_namep = “out”; | |
| bus.conn_id | = 1; |

| | s = out (i_a_conn, connect_, &bus); |
|---|---|
| | if (s ! = CMST_OK) ... |
| | ... |
| | /* disconnect terminals */ |
| | out (i_a_conn, disconnect, &bus); |
| See Also: | DM_ARR |

I_A_PROP—Part Array Property Services

Overview

This interface is used to access properties of parts maintained by a part array. The interface includes all the standard property operations including enumeration.

This interface is typically used by a controlling part in a dynamic assembly. The controlling part is responsible for maintaining the container of part instances for the assembly.

This interface is implemented by DM_ARR.

List of Operations

| Name | Description |
|---|---|
| get | Get the value of a property from a part in |
| | the array. |
| set | Set the value of a property of a part in the |
| | array. |
| chk | Check if a property can be set to the |
| | specified value. |
| get_info | Retrieve the type and attributes of the |
| | specified property. |
| qry_open | Open a query to enumerate properties on a |
| | part in the array based upon the specified |
| | attribute mask and values. |
| qry_close | Close a query. |
| qry_first | Retrieve the first property in a query. |
| qry_next | Retrieve the next property in a query. |
| qry_curr | Retrieve the current property in a query. |

Bus Definition

BUS (B_A_PROP)

| | | |
|---|---|---|
| uint32 | id | ; // id of the instance that is the |
| | | // operation target |

| | | |
|---|---|---|
| char | *namep | ; // property name [ASCIZ] |

| | | |
|---|---|---|
| uint16 | type | ; // property type [CMPRP_T_XXX] |

| | | |
|---|---|---|
| flg32 | attr | ; // attributes [CMPRP_A_XXX] |

| | | |
|---|---|---|
| flg32 | attr_mask; | // attribute mask for queries |

// [CMPRP_A_XXX]

| | | |
|---|---|---|
| void | *bufp | ; // pointer to input buffer |

| | | |
|---|---|---|
| uint32 | buf_sz | ; // size of *bufp in bytes |
| uint32 | val_len | ; // length of value in *bufp in bytes |

| | | |
|---|---|---|
| _hdl | qryh | ; // query handle |

END_BUS

Notes

When opening a new query using qry_open, specifiy the set of attributes in attr mask and their desired values in attr. During the enumeration, a bit-wise AND is performed between the actual attributes of each property and the value of attr_mask; the result is then compared to attr. If there is an exact match, the property will be enumerated.

To enumerate all properties of a part, specifiy the query string as “i” and attr-mask and attr as 0.

Get

| Description: | Get the value of a property from a part in the array. | |
|---|---|---|
| In: | id | Part instance ID. |
| | namep | Null-terminated property name. |
| | type | Type of the property to retrieve or |
| | | CMPRP_T_NONE for any. |
| | bufp | Pointer to buffer to receive property or |
| | | NULL. |
| | buf_sz | Size in bytes of *bufp. |
| Out: | (*bufp) | Property value. |
| | val_len | Length in bytes of property value. |
| Return | CMST_OK | The operation was successful. |
| Status: | | |
| | CMST_NOT_OF | The property could not be found or the |
| | UND | ID is invalid. |
| | CMST_REFUSE | The data type does not match the |
| | | expected type. |
| | CMST_OVERFLO | The buffer is too small to hold the |
| | W | property value. |

| | |
|---|---|
| Example: | B_A_PROP bus; |
| | char buffer [256]; |
| | CMSTAT s; |
| | /* get the value of property “MyProp” */ |
| | bus.id = part_id; |
| | bus.namep = “MyProp”; |
| | bus.type = CMPRP_T_ASCIZ; |
| | bus.bufp = buffer; |
| | bus.buf_sz = sizeof (buffer); |
| | s = out (i_a_prop, get, &bus); |
| | if (s != CMST_OK)... |
| | /** print property information */ |
| | printf (“The value of property MyProp is %s\n”, buffer); |
| | printf (“The value is %id bytes long.”, bus.val_len); |
| See Also: | DM_ARR |

Set

| Description: | Set the value of a property from a part in the array. | |
|---|---|---|
| In: | id | Part instance ID. |
| | namep | Null-terminated property name. |
| | type | Type of the property to set. |
| | bufp | Pointer to buffer containing property |
| | | value or NULL (reset the property value |
| | | to its default). |
| | val_len | Size in bytes of property value (for |
| | | string properties this must include the |
| | | terminating zero). |
| Out: | void | |
| Return | CMST_OK | The operation was successful. |
| Status: | | |
| | CMST_NOT_OF | The property could not be found or the |
| | UND | ID is invalid. |
| | CMST_REFUSE | The property type is incorrect or the |
| | | property cannot be changed while the |
| | | part is in an active state. |
| | CMST_OUT_OF_{—} | The property value is not within the |
| | RANGE | range of allowed values for this |
| | | property. |
| | CMST_BAD_AC | There has been an attempt to set a |
| | CESS | read-only property. |
| | CMST_OVERFLO | The property value is too large. |
| | W | |
| | CMST_NULL_PT | The property name pointer is NULL or |
| | R | an attempt was made to set default |
| | | value for a property that does not have |
| | | a default value. |

| | | |
|---|---|---|
| Example: | B_A_PROP | bus; |
| | CMSTAT | s; |

| /* set the value of property “MyProp” */ | |
|---|---|
| bus.id | = part_id; |

| | |
|---|---|
| bus.namep | = “MyProp”; |

| | |
|---|---|
| bus.type | = CMPRP_T ASCIZ; |
| bus.bufp | = “MyStringValue”; |
| bus.val_len | = strlen (“MyStringValue”) + 1; // include |
| NULL | |

// terminator

| | s =out (i_a_prop, set, &bus); |
|---|---|
| | if (s ! = CMST_OK)... |
| See Also: | DM_ARR |

Chk

| Description: | Check if a property can be set to the specified value. | |
|---|---|---|
| In: | id | Part instance ID. |
| | namep | Null-terminated property name. |
| | type | Type of the property to check. |
| | bufp | Pointer to buffer containing property |
| | | value. |
| | val_len | Size in bytes of property value. |
| Out: | void | |
| Return | CMST_OK | The operation was successful. |
| Status: | | |
| | CMST_NOT_OF | The property could not be found or the |
| | UND | ID is invalid. |
| | CMST_REFUSE | The property type is incorrect or the |
| | | property cannot be changed while the |
| | | part is in an active state. |
| | CMST OUT_OF_{—} | The property value is not within the |
| | RANGE | range of allowed values for this |
| | | property. |
| | CMST_BAD_AC | There has been an attempt to set a |
| | CESS | read-only property. |
| | CMST_OVERFLO | The property value is too large. |
| | W | |
| | CMST_NULL_PT | The property name pointer is NULL or |
| | R | an attempt was made to set default |
| | | value for a property that does not have |
| | | a default value. |

| | | |
|---|---|---|
| Example: | B_A_PROP | bus; |
| | CMSTAT | s; |

| /* check setting the value of property “MyProp” */ | |
|---|---|
| bus.id | = part_id; |

| | |
|---|---|
| bus.namep | = “MyProp”; |

| | |
|---|---|
| bus.type | = CMPRP_T_ASCIZ; |
| bus.bufp | = “MyStringValue”; |
| bus.val_len | = strlen (“MyStringValue”) + 1; // include |
| NULL | |

// terminator

| | s = out (i_a_prop, chk, &bus); |
|---|---|
| | if (a ! = CMST_OK). . . |
| See Also: | DM_ARR |

Get_info

| Description: | Retrieve the type and attributes of the specified property. | |
|---|---|---|
| In: | id | Part instance ID. |
| | namep | Null-terminated property name. |
| Out: | type | Type of property [CMPRP_T_XXX]. |
| | attr | Property attributes [CMPRP_A_XXX]. |
| Return | CMST_OK | The operation was successful. |
| Status: | | |
| | CMST_NOT_OF | The property could not be found or the |
| | UND | ID is invalid. |

| | | |
|---|---|---|
| Example: | B_A_PROP | bus; |
| | CMSTAT | s; |

| /* set the value of property “MyProp” */ | |
|---|---|
| bus.id | = part id; |

| | |
|---|---|
| bus.namep | = “MyProp”; |

| | s = out (i_a_prop, get_info, &bus); |
|---|---|
| | if (s ! = CMST_OK) ... |
| | /* print property information */ |
| | printf (“The property type is %u.\n”, bus.type); |
| | printf (“The property attributes are %x.\n”, bus.attr); |
| See Also: | DM_ARR |

Qry_open

Description: Open a query to enumerate properties on a part in the
array based upon the specified attribute mask and values
or CMPRP_A_NONE to enumerate all properties.

| | | |
|---|---|---|
| In: | id | Part instance ID. |
| | namep | Query string (must be “*”). |
| | attr | Attribute values of properties to |
| | | include. |
| | attr_mask | Attribute mask of properties to |
| | | include. Can be one or more of the |
| | | following values: |

| | |
|---|---|
| CMPRP_A_NONE | Not specified. |
| CMPRP_A_PERSIST | Persistent |
| | property. |
| CMPRP_A_ACTIVETIME | Property can be modified |
| | while active. |
| CMPRP_A_MANDATORY | Property must be |
| | set before |
| | activation. |
| CMPRP_A_RDONLY | Read-Only |
| | property. |
| CMPRP_A_UPCASE | Force uppercase. |
| CMPRP_A_ARRAY | Property is an |
| | array. |

| | | |
|---|---|---|
| Out: | qryh | Query handle. |
| Return | CMST_OK | The operation was successful. |
| Status: | | |
| | CMST_NOT_FOUND | The ID could not be found or is |
| | | invalid. |
| | CMST_NOT_SUPPORTED | The specified part does not support |
| | | property enumeration or does not |
| | | support nested or concurrent property |
| | | enumeration. |

| | |
|---|---|
| Example: | B_A_PROP bus; |
| | char buffer [256]; |
| | CMSTAT s; |
| | /* open query for all properties that are mandatory */ |
| | bus.id = part_id; |
| | bus.namep = “*”; |
| | bus.attr = CMPRP_A_MANDATORY; |
| | bus.attr_mask = CMPRP_A_MANDATORY; |
| | bus.bufp = buffer; |
| | bus.buf_sz = sizeof (buffer); |
| | s = out (i_a_prop, qry_open, &bus); |
| | if (s != CMST_OK) . . . |
| | /* enumerate and print all mandatory properties */ |
| | s = out (i_a_prop, qry_first, &bus); |
| | while (s = = CMST_OK) |

{
/* print property name */
printf (“Property name is %s\n”, buffer);
/* get current property */
s = out (i_a_prop, qry_curr, &bus);
if (s != CMST_OK) . . .
/* get next mandatory property */
s = out (i_a_prop, qry_next, &bus);
}

| | |
|---|---|
| | /* * close query */ |
| | out (i_a_prop, qry_close, &bus); |
| See Also: | DM_ARR |

Qry_close

Description: Close a query.

| | | |
|---|---|---|
| In: | qryh | Handle to open query. |
| Out: | void | |
| Return | CMST_OK | The operation was successful. |
| Status: | | |
| | CMST_NOT_FOUND | Query handle was not found |
| | | or is invalid. |
| | CMST_NOT_BUSY | The object can not be entered |
| | | from this execution context at |
| | | this time. |
| Example: | See qry_open example. | |
| See Also: | DM_ARR | |

Qry_first

Description: Retrieve the first property in a query.

| | | |
|---|---|---|
| In: | qryh | Query handle returned on |
| | | qry_open. |
| | bufp | Storage for the returned property |
| | | name or NULL. |
| | buf_sz | Size in bytes of *bufp. |
| Out: | (*bufp) | Property name (if bufp not |
| | | NULL). |
| Return | CMST_OK | The operation was successful. |
| Status: | | |
| | CMST_NOT_FOUND | No properties found matching |
| | | current query. |
| | CMST_OVERFLOW | Buffer is too small for property |
| | | name. |

| | |
|---|---|
| Example: | See qry_open example. |
| See Also: | DM_ARR |

Qry_next

Description: Retrieve the next property in a query.

| | | |
|---|---|---|
| In: | qryh | Query handle returned on |
| | | qry_open. |
| | bufp | Storage for the returned property |
| | | name or NULL. |
| | buf_sz | Size in bytes of *bufp. |
| Out: | (*bufp) | Property name (if bufp not |
| | | NULL). |
| Return | CMST_OK | The operation was successful. |
| Status: | | |
| | CMST_NOT_FOUND | No more properties found |
| | | matching the current query. |
| | CMST_OVERFLOW | Buffer is too small for property |
| | | name. |
| Example: | See qry_open example. | |
| See Also: | DM_ARR | |

Qry_curr

Description: Retrieve the current property in a query.

| | | |
|---|---|---|
| In: | qryh | Query handle returned on |
| | | qry_open. |
| | bufp | Storage for the returned property |
| | | name or NULL. |
| | buf_sz | Size in bytes of *bufp. |
| Out: | (*bufp) | Property name (if bufp not |
| | | NULL). |
| Return | CMST_OK | The operation was successful. |
| Status: | | |
| | CMST_NOT_FOUND | No current property (e.g. after a |
| | | call to qry_open). |
| | CMST_OVERFLOW | Buffer is too small for property |
| | | name. |
| Example: | See qry_open example. | |
| See Also: | DM_ARR | |

I_EVS, I_EVS_R—Event Source Interfaces

Overview

These two interfaces are for manipulating and using event sources. I_EVS and I_EVS_R are conjoint interfaces; they are always used together.

Events generated by an event source can be periodic or singular. Periodic events will be generated in equal intervals of time. Singular events will be generated when a synchronization object gets signaled or when a timeout expires.

The interface also allows “preview” of the events being generated and cancellation.

The I_EVS_R interface has one operation: fire. This operation is invoked when the event source generates an event.

List of Operations

| Name | Description |
|---|---|
| arm | Arm the event source (I_EVS) |
| disarm | Disarm the event source (I_EVS) |
| fire | Trigger event occurred (I_EVS_R) |

Operation Bus

BUS (B_EVS)

| | |
|---|---|
| flg32 attr ; | // attributes [EVS_A_xxx] |
| _ctx ctx ; | // trigger context |
| uint32 time ; | // trigger timeout or period |
| cmstat stat ; | // trigger status |
| _hdl h ; | // synchronization object handle |

END_BUS

Arm

Description: Arm the event source

| Direction: | Input | | |
|---|---|---|---|
| In: | attr | Arm attributes, can be any one of the | |
| | | following: | |
| | | EVS_A_NONE | Not specified. |
| | | EVS_A_ONETIME | Arm for a one-time |
| | | | firing (disarm upon |
| | | | fire) |
| | | EVS_A_CONTINUOUS | Arm for multiple |
| | | | firing (remain armed |
| | | | upon fire) |
| | | EVS_A_PREVIEW | Fire a preview |
| | | | before the actual |
| | | | firing |
| | ctx | User-supplied context to provide when | |
| | | firing | |
| | time | Timeout or fire period in milliseconds, | |
| | | this can also be one of the following | |
| | | values: | |
| | | EVS_T_INFINITE | Infinite time |
| | | EVS_T_DEFAULT | Implementor- |
| | | | defined default |

| | | |
|---|---|---|
| | h | Handle to a synchronization object (or |
| | | NO_HDL for none) |
| Out: | void | |
| Return | CMST_OK | The operation was successful. |
| Status: | | |
| | CMST_NO_ROOM | Can not arm any more events in the |
| | | event source. |
| | CMST_NO_ACTION | Already armed (possibly with different |
| | | arguments). |
| | CMST_REFUSE | Event source cannot be armed |
| | | manually. |
| | CMST_NOT_SUPPORTED | The particular combination of |
| | | attributes and fields is not supported |
| | | by the implementor. |

| | |
|---|---|
| Example: | B_EVS eb; |
| | cmstat s; |
| | // arm event source for a one-shot timer with no preview |
| | eb.attr = EVS_A_ONETIME; |
| | eb.time = 10000; // 10 seconds |
| | eb.ctx = 0x500; |
| | s = out (evs, arm, &eb); |
| | if (s != CMST_OK) . . . |
| Remarks: | The fields attr (not all combinations) and ctx must be |
| | supported by all implementors. Support for all other fields |
| | is optional. Both implementors and users of this interface |
| | must describe their support/requirements in the |
| | appropriate documentation. |
| | Implementors may honor the field time as a timeout or |
| | period between firings. |
| | Implementors may honor the field h as a handle to a |
| | synchronization object. Typically, the source will fire either |
| | when h is signaled or when the timeout expires. It is |
| | also possible to use h with EVS_A_CONTINUOUS. |
| | Implementors may accept a NULL bus or invalid arguments |
| | if the implementor has sufficient defaults. If the bus is |
| | NULL, ctx will be 0 on fire. |
| | Implementors may ignore most or all of the supplied |
| | arguments (if so configured). As long as the bus is not |
| | NULL, ctx should be honored. |
| | Exactly one of EVS_A_ONETIME and |
| | EVS_A_CONTINUOUS must be specified; if none is |
| | specified, the implementor may use its default (usually |
| | with auto-arm). Implementors may support only one of |
| | these two attributes. |
| | If the implementor auto-arms the event source, calling |
| | arm/disarm may return CMST_REFUSE, indicating that the |
| | event source cannot be controlled manually. |
| | If EVS_A_PREVIEW is specified, the terminal on which fire |
| | is received must be unguarded. Preview is invoked in non- |
| | thread context (interrupt or event time in Windows 95/98 |
| | Kernel Mode; DISPATCH IRQL in Windows NT kernel |
| | mode). Not all implementors support the preview feature. |
| See Also: | disarm, fire |

Disarm

Description: Arm the event source

| Direction: | Input | |
|---|---|---|
| In: | ctx | User context - as supplied |
| | | on arm |
| | attr | Disarm attributes, must be |
| | | EVS_A_NONE |
| Out: | void | |
| Return | CMST_OK | The operation was successful. |
| Status: | | |
| | CMST_NOT_FOUND | An armed event associated with |
| | | ctx cannot be found. |
| | CMST_NO_ACTION | The event source is not armed. |
| | CMST_REFUSE | The event source cannot be |
| | | disarmed manually. |

| | |
|---|---|
| Example: | B_EVS eb; |
| | cmstat s; |
| | // disarm event source |
| | eb.attr = EVS_A_NONE; |
| | eb.ctx = 0x500; |
| | s = out (evs, disarm, &eb); |
| | if (s != CMST_OK) . . . |
| Remarks: | Upon successful return, the event source guarantees that |
| | it will not fire unless it is re-armed. |
| See Also: | arm, fire |

Fire

Description: Trigger event occurred

| Direction: | Output | | |
|---|---|---|---|
| In: | attr | Fire attributes, can be one of the | |
| | | following: | |
| | | EVS_A_NONE | Not specified. |
| | | EVS_A_PREVIEW | This is a fire |
| | | | preview. |
| | ctx | User supplied context provided on | |
| | | arm. | |
| | stat | Trigger status, can be one of the | |
| | | following: | |
| | | CMST_OK | Event triggered |
| | | | normally. |
| | | CMST_TIMEOUT | Event triggered due |
| | | | to timeout. |
| | | | This status can only |
| | | | appear if event |
| | | | source was armed to |
| | | | wait on a syn- |
| | | | chronous object |
| | | | with a timeout |
| | | | period. |
| | | CMST_ABORTED | Event source was |
| | | | disarmed due to |
| | | | external reason |
| | | | (e.g., deactivation). |
| | | | This status can only |
| | | | appear if event |
| | | | source was armed |
| | | | to wait on a |
| | | | synchronous object |
| | | | with a timeout |
| | | | period. |

| | | |
|---|---|---|
| Out: | ctx | User supplied context to provide on |
| | | the final fire. |
| | | This is only used if in the context of a |
| | | fire preview (attr = = |
| | | EVS_A_PREVIEW). |
| | | See the Remarks section below. |
| Return | CMST_OK | The event is accepted - to be sent |
| Status: | | again without the EVS_A_PREVIEW |
| | | attribute (ignored if not in the context |
| | | of a fire preview). |
| | (any other) | The event is refused - do not send the |
| | | event again (ignored if not in the |
| | | context of a fire preview). |

| | |
|---|---|
| Example: | B_EVS eb; |
| | cmstat s; |
| | // arm event source for a one-shot timer with no preview |
| | eb.attr = EVS_A_ONETIME; |
| | eb.time = 10000; // 10 seconds |
| | eb.ctx = 0x500; |
| | s = out (evs, arm, &eb); |
| | if (s != CMST_OK) . . . |
| | // fire callback |
| | OPERATION (evs_r, fire, B_EVS) |

{
// nb: bp->ctx should be 0x500 - supplied on arm
printf (“Event source fired!\n”);
return (CMST_OK);
}

END_OPERATION

Remarks: If the event source was armed as a one-time event, the event source is disarmed before fire is called (before preview also).

If the event source was armed as a continuous event, the event source remains armed until disarmed. arm and disarm can be called from within fire (provided that fire came without the EVS_A_PREVIEW attribute).

If EVS_A_PREVIEW is set, the fire call may not be at thread time. Interrupts may be disabled (Windows 95/98 Kernel Mode), the CPU may be running at DISPATCH IRQL (Windows NT Kernel Mode), etc. arm and disarm (and any thread-level guarded code) should not be called from within fire preview. If a recipient expects fire previews, the terminal on which fire is received should be unguarded (or guarded at the appropriate level depending on the event source).

Upon return from fire preview, if a recipient modified ctx, the modified ctx will be provided on the final fire. This change affects only the final fire that corresponds to this preview. Subsequent firings (if the event source was armed as continuous) will come with the original ctx provided on arm.

If EVS_A_PREVIEW is not set, the return status from a fire call is generally ignored. Some event sources may expect CMST_OK for accepted events, and any other for refused events (i.e., event not processed by the recipient). In both cases, the returned status does not affect the armed/disarmed state of the event source for future firings.

See Also: arm, disarm

I_CRT—Critical Section

Overview

This is an interface to a critical section synchronization object. It provides operations for entering and leaving the critical section. No support for conditional entering is provided (a.k.a. try-enter) by this interface.

List of Operations

| Name | Description |
|---|---|
| enter | Enter a critical section (cumulative, |
| | blocking) |
| leave | Leave a critical section (cumulative) |

Enter

Description: Enter a critical section (cumulative, blocking)

| In: | void | |
|---|---|---|
| Out: | void | |
| Return | CMST_OK | The operation was successful. |
| Status: | | |
| | ST_OVERFLOW | Critical section entered too many |
| | | times |

| | |
|---|---|
| Example: | cmstat s; |
| | // enter critical section |
| | s = out (crt, enter, NULL); |
| | if (s != CMST_OK) . . . |
| Remarks: | The calling thread is blocked until the critical section is |
| | available. |

Leave

| | |
|---|---|
| Description: | Leave a critical section (cumulative) |
| In: | void |
| Out: | void |
| Return | CMST_OK The operation was successful. |
| Status: | |
| Example: | cmstat s; |
| | // enter critical section |
| | s = out (crt, enter, NULL); |
| | if (s != CMST_OK) . . . |
| | . . . |
| | // leave critical section |
| | s = out (crt, leave, NULL); |
| | if (s != CMST_OK) . . . |
| Remarks: | If another thread was waiting for this critical section, the |
| | calling thread may be pre-empted before it returns from |
| | this call. |

I_PRPFAC—Property Factory Interface

Overview

The property factory interface is used to handle virtual (dynamic) properties. Such operations include the creation, destruction, initialization and enumeration of the properties.

List of Operations

| Name | Description |
|---|---|
| create | Create a new virtual property |
| destroy | Destroy a virtual property |
| clear | Re-initialize the property value to |
| | empty |
| get_first | Retrieve first virtual property |
| get_next | Retrieve next virtual property |

Operation Bus

BUS (B_PRPFAC)

| | | |
|---|---|---|
| char | *namep | ; // property name [ASCIZ] |
| uint16 | type | ; // property type [CMPRP_T_XXX] |
| flg32 | attr | ; // attributes [CMPRP_A_XXX] |
| byte | *bufp | ; // pointer to buffer to receive |
| | | // property name |
| uint32 | sz | ; // size of *bufp in bytes |
| uint32 | ctx | ; // enumeration context |

END_BUS

Create

| Description: | Create a new virtual property | |
|---|---|---|
| In: | namep | null-terminated property name |
| | type | type of the property to retrieve |
| | | [CMPRP_T_xxx] |
| | attr | attributes to be associated with |
| | | property [CMPRP_A_xxx] |
| Out: | void | |
| Return | CMST_OK | successful |
| Status: | | |
| | CMST_INVALID | namep is empty or “*” |
| | CMST_DUPLICA | the property already exists |
| | TE | |
| | CMST_NULL_PT | namep is NULL |
| | R | |
| | CMST_REFUSE | no data type provided |
| | CMST_NO_ROO | no room to store property |
| | M | |
| | CMST_ALLOC | failed to allocate memory for |
| | | property |

| | |
|---|---|
| Example: | B_PRPFAC bus; |
| | cmstat s; |
| | // create a new virtual property |
| | bus.namep = “MyProp”; |
| | bus.type = CMPRP_T_ASCIZ; |
| | bus.attr = CMPRP_A_NONE; |
| | s = out (prpfac, create, &bus); |
| | if (s ! = CMST_OK) . . . |
| | // other property operations here . . . |
| | // destroy property |
| | s = out (prpfac, destroy, &bus); |
| | if (s ! = CMST_OK) . . . |

Destroy

| Description: | Destroy a virtual property | |
|---|---|---|
| In: | namep | null-terminated property name to |
| | | destroy |
| Out: | void | |
| Return | CMST_OK | successful |
| Status: | | |
| | CMST_NOT_FO | the property could not be found if |
| | UND | namep not NULL |
| | CMST_INVALID | namep is NULL and all is TRUE |
| | CMST_NULL_PT | namep is NULL |
| | R | |

| | |
|---|---|
| Example: | See create example. |
| Remarks: | if namep is “*” then all properties will be destroyed |

Clear

| Description: | Re-initialize the property value to empty | |
|---|---|---|
| In: | namep | null-terminated property name |
| Out: | void | |
| Return | CMST_OK | successful |
| Status: | | |
| | CMST_NOT_FO | the property could not be found if |
| | UND | namep not NULL |
| | CMST_INVALID | namep is NULL and all is TRUE |

| | |
|---|---|
| Example: | B_PRPFAC bus; |
| | cmstat s; |
| | // clear virtual property |
| | bus.namep =“MyProp”; |
| | s = out (prpfac, clear, &bus); |
| | if (s ! = CMST_OK) . . . |
| Remarks: | if namep is “*” then all properties will be re-initialized |
| | empty infers zero-initialized value |

Get_first

| Description: | Retrieve first property | |
|---|---|---|
| In: | bufp | buffer to receive property name |
| | sz | size of *bufp |
| Out: | (*bufp) | null-terminated property name |
| | type | property type [CMPRP_T_xxx] |
| | attr | property attributes |
| | ctx | enumeration context |
| Return | CMST_OK | successful |
| Status: | | |
| | CMST_NOT_FO | no properties to enumerate |
| | UND | |
| | CMST_OVERFLO | buffer too small |
| | W | |

| | |
|---|---|
| Example: | B_PRPFAC bus; |
| | char buf [256]; |
| | cmstat s; |
| | // enumerate all virtual properties in container |
| | bus.namep = buf; |
| | bus.sz = sizeof (buf); |
| | s = out (prpfac, get_first, &bus); |
| | while (s = = CMST_OK) |

{
// print property name
printf (“Property name is %s\n”, buf);
// get next property
s = out (prpfac, get_next, &bus);
}

Get_next

| Description: | Retrieve next property | |
|---|---|---|
| In: | bufp | buffer to receive property name |
| | sz | size of *bufp |
| | ctx | enumeration context |
| Out: | (*bufp) | null-terminated property name |
| | type | property type [CMPRP_T_xxx] |
| | attr | property attributes |
| | ctx | enumeration context |
| Return | CMST_OK | successful |
| Status: | | |
| | CMST_NOT_FO | no properties to enumerate |
| | UND | |
| | CMST_OVERFLO | buffer too small |
| | W | |

| | |
|---|---|
| Example: | See get_first example. |

I_BYTEARR—Byte-Array Interface

Overview

This interface provides access to a byte-array. It provides read and write operations for manipulation of the array. It also allows control over the byte-array metrics (size).

The byte array may be fixed length or it may be dynamic—depending on the implementation.

List of Operations

| Name | Description |
|---|---|
| read | read block of bytes starting at |
| | specified offset |
| write | write block of bytes starting at |
| | specified offset |
| get_metrics | get size of the array |
| set_metrics | set size of the array |

Operation Bus

BUS (B_BYTEARR)

| | | |
|---|---|---|
| void | *p | ; // buffer pointer |
| uint32 | offs | ; // offset |
| uint32 | len | ; // length of data in *p, [bytes] |
| uint32 | sz | ; // size of buffer pointed to by p, |
| | | // [bytes] |
| flg32 | attr | ; // attributes, [BYTEARR_A_xxx] |

END_BUS

Read

| Description: | read block of bytes starting at specified offset | |
|---|---|---|
| In: | p | buffer pointer |
| | sz | size of buffer |
| | offs | offset |
| | len | how many bytes to read |
| | attr | 0 to read < = len bytes, or |
| | | BYTEARR_A_EXACT to read exactly |
| | | len bytes |
| Out: | *p | data |
| | len | bytes actually read |
| Return | CMST_OK | successful |
| Status: | | |
| | CMST_EOF | cannot read requested len bytes (when |
| | | BYTEARR_A_EXACT) |

| | |
|---|---|
| Example: | B_BYTEARR bus; |
| | char buf [256]; |
| | cmstat s; |
| | // read 5 bytes starting at offset 10 |
| | bus.p = buf; |
| | bus.sz = sizeof (buf); |
| | bus.offs = 10; |
| | bus.len = 5; |
| | bus.attr = BYTEARR_A_EXACT; |
| | s = out (arr, read, &bus); |
| | if (s ! = CMST_OK) . . . |
| Remarks: | If BYTEARR_A_EXACT is not specified, an attempt to |
| | read beyond the limits of supported space returns |
| | CMST_OK with len = = 0. |

Write

| Description: | write block of bytes starting at specified offset | |
|---|---|---|
| In: | p | pointer to data to be written |
| | offs | offset |
| | len | number of bytes to write |
| | attr | 0 to BYTEARR_A_GROW to grow |
| | | automatically |
| Out: | void | |
| Return | CMST_OK | successful |
| Status: | | |
| | CMST_OVERFLO | offs + len is beyond the current size |
| | W | of the array and |
| | | BYTEARR_A_GROW |
| | | was not specified |
| | CMST_NOT_SUP | specified attribute is not supported |
| | PORTED | |

| | |
|---|---|
| Example: | B_BYTEARR bus; |
| | char buf [256]; |
| | cmstat s; |
| | // write 5 bytes starting at offset 10 |
| | strcpy (buf, “12345”); |
| | bus.p = buf; |
| | bus.offs = 10; |
| | bus.len = 5; |
| | bus.attr = 0; |
| | s = out (arr, write, &bus); |
| | if (s ! = CMST_OK) . . . |

Get_metrics

| Description: | get size of the array | |
|---|---|---|
| In: | void | |
| Out: | len | number of bytes available for reading |
| | | from offset 0 |
| | sz | number of bytes available for writing |
| | | from offset 0 |
| Return | CMST_OK | successful |
| Status: | | |

| | |
|---|---|
| Example: | B_BYTEARR bus; |
| | cmstat s; |
| | // get size of the array |
| | s = out (arr, get_metrics, &bus); |
| | if (s ! = CMST_OK) . . . |
| | // print size |
| | printf (“available for reading: %ld\n”, bus.len); |
| | printf (“available for writing: %ld\n”, bus.sz); |

Set_metrics

| Description: | set size of the array | |
|---|---|---|
| In: | len | number of bytes to become available |
| | | for reading from offset 0 |
| | sz | number of bytes to become available |
| | | for writing from offset 0 |
| Out: | void | |
| Return | CMST_OK | successful |
| Status: | | |
| | CMST_REFUSE | if specified sz < specified len |
| | CMST_ALLOC | specified size cannot be reached (i.e., |
| | | out of memory) |
| | CMST_NOT_SUP | operation is not supported |
| | PORTED | |

| | |
|---|---|
| Exampl | B_BYTEARR bus; |
| | cmstat s; |
| | // set size of the array |
| | bus.sz = 10; |
| | bus.len = 10; |
| | s = out (arr, set_metrics, &bus); |
| | if (s != CMST_OK) . . . |
| Remarks: | if len < current length, elements are removed |
| | if len > current length, elements are filled with 0 |

I_DEN—Device Enumeration Interface

Overview

This is a device class enumeration interface. Supports multiple queries (if implementation allows it) on the device class name space. The interface supports multiple class name identifications. Uses UNICODE strings.

List of Operations

| Name | Description |
|---|---|
| qry_open | Open a query to enumerate devices |
| qry_close | Close a query |
| qry_first | Get the first device |
| qry_next | Get the next device |

Operation Bus

BUS (B_DEN)

| | | |
|---|---|---|
| char | class_name [16]; | // CMagic class name |

| | | |
|---|---|---|
| WCHAR | device_name[64]; | // name to use for registering |

// the device

| | | |
|---|---|---|
| WCHAR | sym_link1 [64]; | // Win32 alias (does not include |

// the \??\ prefix)

| | | |
|---|---|---|
| WCHAR | sym_link2 [64]; | // Win32 alias (does not include |

| | | // the \??\ prefix) |
|---|---|---|
| uint32 | id; | // device ID (valid while qry is |

| | | // open) |
|---|---|---|
| _hdl | qry_h; | // query handle |

END_BUS

Qry_open

| Description: | Open a query to enumerate devices | |
|---|---|---|
| In: | void | |
| Out: | qry_h | query handle; must be passed on |
| | | subsequent calls qry_first, qry_next, |
| | | qry_close |
| Return | CMST_OK | The operation was successful. |
| Status: | | |
| | ST_NO_ROOM | no more queries can be open |

| | |
|---|---|
| Example: | B_DEN bus; |
| | // open query |
| | s = out (den, qry_open, &bus); |
| | if (s != CMST_OK) . . . |
| | // query all devices |
| | s = out (den, qry_first, &bus); |
| | while (s = = CMST_OK) |

{
// print information
printf (“Class name = %s\n”, bus.class_name);
printf (“ID = %ld\n”, bus.id );
// get next
s = out (den, qry_next, &bus);
}

// close query
out (den, qry_close, &bus);

Qry_close

| Description: | Close a query | |
|---|---|---|
| In: | qry_h | query handle from qry_open |
| Out: | void | |
| Return | CMST_OK | The operation was successful. |
| Status: | | |

| | |
|---|---|
| Example: | See qry_open example. |

Qry_first/qry_next

| Description: | Get the first/next device | |
|---|---|---|
| In: | qry_h | Query handle from qry_open |
| Out: | class_name | ClassMagic class name of the part |
| | | that implements the driver for this |
| | | device (may be empty) |
| | device_name | device name to use when registering |
| | | the device |
| | sym_link1 | DOS/Win32 alias for the device (base |
| | | name only, no DOS/Win32 alias for |
| | | the device (base name only, no NT or |
| | | Win32 prefixes like \??\ or \\.\) |
| | sym_link2 | DOS/Win32 alias for the device (base |
| | | name) |
| | id | device ID (see remarks below) |
| Return | CMST_NOT_FO | no more devices |
| Status: | UND | |

| | |
|---|---|
| Example: | See qry_open example. |
| Remarks: | Any of the string output fields in the bus (except |
| | device_name) may be empty: |

an empty class_name field means that the default
name should be used
an empty sym_link fields means that the symbolic
link is not needed

id is a value defined by the implementor and uniquely
identifies this device. This value is valid as long as the part
that implements I_DEN is active and can be used to
identify the device in calls to other terminals of the same
part.

I_DIO, I_DIO_C—Device I/O Interface

Overview

This is a device I/O interface. Supports bidirectional data transfer and asynchronous operation. The interface also supports special I/O control operation for the purposes of device control.

I_DIO_C is a conjugate interface used to receive notifications for completion; it has exactly one operation: complete.

This interface depends on data structures defined by the Windows NT DDK.

List of Operations

| Name | Description |
|---|---|
| Open | Open a device object |
| Cleanup | Cancel all pending operations, prepare |
| | for close |
| Close | Cancel all pending operations, prepare |
| | for close |
| Read | Read data |
| Write | Write data |
| Ioctl | Execute the IOCTL operation |
| | specified by ‘ioctl’. The definition of |
| | IOCTL operations is outside the scope |
| | of this interface |
| complete | Report completion of an operation |

Operation Bus

BUS (B_DIO)

| // attributes | | |
|---|---|---|
| flg32 | attr; | // attributes (DIO_A_xxx) |

| | | |
|---|---|---|
| uint32 | buf_mapping; | // DIO_MAP_xxx |

| | | |
|---|---|---|
| uint32 | id; | // device instance |

// identification

| _hdl | h; | // handle (returned on open) |
|---|---|---|
| // I/O operation data | | |
| void | *p; | // pointer to data |

| | | |
|---|---|---|
| uint32 | sz; | // size of buffer pointed to by |

// p

| | | |
|---|---|---|
| uint32 | len; | // length of data in *p |

| | |
|---|---|
| LARGE_INTEGER ofs; | // file offset (for block |

// devices)

| | | |
|---|---|---|
| uint32 | ioctl; | // function code |

| // asynchronous completion | | |
|---|---|---|
| void | *irpp; | // NT only: original I/O Request |

// Packet

| | | |
|---|---|---|
| cmstat | cplt_s; | // completion status (for |

// complete operation only)

END_BUS

Notes

1. The term ‘object’ is used below to refer to the entity on which the I/O operations are performed. This can be a file, a device, a pipe or any similar entity.

2. This interface can be used for asynchronous operations if there is a back channel provided (e.g. the I_DIO connection is bi-directional). See the notes at the ‘complete’ operation description

3. The DIO_A_PREVIEW is used for dispatching I_DIO operations to multiple parts. If this attribute is set, the caller should interpret the status as follows:

a. CMST_OK—the operation is acceptable, the part will process it synchronously (i.e. will not return CMST_PENDING status).

b. CMST_SUBMIT—the operation is acceptable, the part claims the exclusive right to execute the operation. The operation may be processed synchronously.

c. Other—the operation is not implemented.

Note that the return statuses listed for the operations below assume that this flag is not set.

4. The id field in the B_DIO bus is used to identify the instance that should handle the operation. The use of this field is optional. It is intended as storage for a part array index in one-to-many connections, but its use is not fixed by this interface.

Open

| Description: | Open a device object. | |
|---|---|---|
| In: | id | Device instance identification (see |
| | | note #4 in the overview) |
| | attr | Attributes, can be any one of the |
| | | following: |

| | |
|---|---|
| DIO_A_PREVIE | “preview” |
| W | operation |
| DIO_A_ASYNC_{—} | operation may |
| CPLT | complete |
| | asynchronously |

| | | |
|---|---|---|
| | p | (WCHAR *) name of object to open |
| | | (may be NULL) |
| | len | Length of data pointed to by p |
| | | (without terminating O) |
| | irpp | (see complete operation) |
| Out: | h | Handle to pass on subsequent |
| | | operations |
| Return | CMST_OK | The operation was successful. |
| Status: | | |
| | CMST_NOT_FOU | Specified object not found |
| | ND | |
| | CMST_ACCESS_{—} | Object already open (if multiple |
| | DENIED | opens are not supported) |
| | CMST_PENDING | See notes for complete operation |

| | |
|---|---|
| Example: | B_DIO bus; |
| | // open device |
| | memset (&bus, O, sizeof (bus)); |
| | bus.p = L“MyDevice”; |
| | bus.len = sizeof (L“MyDevice”); |
| | s = out (dio, open, &bus); |
| | if (s != CMST_OK) . . . |
| | // device operations . . . |
| | // cancel any pending operations |
| | out (dio, cleanup, &bus); |
| | // close device |
| | out (dio, close, &bus); |
| Remarks: | Named object support and the naming conventions are |
| | outside the scope of this interface |

Cleanup

| Description: | Cancel all pending operations, prepare for close | |
|---|---|---|
| In: | id | Device instance identification (see |
| | | note #4 in the overview) |
| | attr | Attributes, can be any one of the |
| | | following: |

| | |
|---|---|
| DIO_A_PREVIE | “preview” |
| W | operation |
| DIO_A_ASYNC_{—} | operation may |
| CPLT | complete |
| | asynchronously |

| | | |
|---|---|---|
| | h | Handle from open |
| | irpp | (see complete operation) |
| Out: | void | |
| Return | CMST_OK | The operation was successful. |
| Status: | | |
| | CMST_NOT_OPE | Object is not open. |
| | N | |
| | CMST_PENDING | Operation is asynchronous, see notes |
| | | for complete operation. |

| | |
|---|---|
| Example: | See example for open. |
| Remarks: | No operations except close should be called after cleanup |

Close

| Description: | Close a device object | |
|---|---|---|
| In: | id | Device instance identification (see |
| | | note #4 in the overview) |
| | attr | Attributes, can be any one of the |
| | | following: |

| | |
|---|---|
| DIO_A_PREVIE | “preview” |
| W | operation |
| DIO_A_ASYNG_{—} | operation may |
| CPLT | complete |
| | asynchronously |

| | | |
|---|---|---|
| | h | Handle from open |
| | irpp | (see complete operation) |
| Out: | void | |
| Return | CMST_OK | The operation was successful. |
| Status: | | |
| | CMST_NOT_OPE | Object is not open |
| | N | |
| | CMST_IOERR | I/O error (nb: object is closed |
| | | anyway) |
| | CMST_PENDING | See notes for complete operation |

| | |
|---|---|
| Example: | See example for open. |

Read

| Description: | Read data | |
|---|---|---|
| In: | id | Device instance identification |
| | | (see note #4 in the overview) |
| | attr | Attributes, can be any one of the |

| following: | |
|---|---|
| DIO_A_PREVIE | “preview” operation |
| W | |
| DIO_A_A_ASYNC_ | operation may |
| CPLT | complete |

asynchronously

| | |
|---|---|
| buf_mapping | Buffering attributes, can be one of the |

| following: | |
|---|---|
| DIO_MAP_BUFF | buffering is handled |
| ERED | by caller, p is a valid |
| | virtual memory |
| | address |
| DIO_MAP_DIRE | no buffering, p value |
| CT | is system-dependent |

| | p | Buffer pointer |
|---|---|---|
| | sz | Size of buffer |
| | ofs | File offset (for block devices) |
| | h | Handle from open |
| | irpp | See complete operation |
| Out: | len | Number of bytes read |
| | *p | Data read |
| Return | CMST_OK | The operation was successful. |
| Status: | | |
| | CMST_NOT_OPE | Object is not open |
| | N | |
| | CMST_IOERR | I/O error |
| | CMST_PENDING | See notes for complete operation |

| Example: | B_DIO bus; |
|---|---|
| | char buffer [256]; |
| | // open device |
| | memset (&bus, 0, sizeof (bus)); |
| | bus.p = L“MyDevice”; |
| | bus.len = sizeof (L“MyDevice”); |
| | s = out (dio, open, &bus); |
| | if (s != CMST_OK). . . |
| | // read from device |
| | bus.buf_mapping = DIO_BUF_DIRECT; |
| | bus.p = buffer; |
| | bus.sz = sizeof (buffer); |
| | bus.ofs = 1000; |
| | bus.irpp = &irp; // NT request packet |
| | s = out (dio, read, &bus); |
| | if (s != CMST_OK). . . |
| | // cancel any pending operations |
| | out (dio, cleanup, &bus); |
| | // close device |
| | out (dio, close, &bus); |

Write

| Description: | Write data | |
|---|---|---|
| In: | id | Device instance identification (see note |

| | #4 in the overview) |
|---|---|
| attr | Attributes, can be any one of the |

| | |
|---|---|
| following: | |
| DIO_A_PREVIE | “preview” operation |
| W | |
| DIO_A_ASYNC_{—} | operation may |
| CPLT | complete |

asynchronously

| | |
|---|---|
| buf_mapping | Buffering attributes, can be one of the |

| following: | |
|---|---|
| DIO_MAP_BUFF | buffering is handled |
| ERED | by caller, p is a valid |
| | virtual memory |
| | address |
| DIO_MAP_DIRE | no buffering, p value |
| CT | is system-dependent |

| | p | Pointer to data to be written |
|---|---|---|
| | sz | Number of bytes to write |
| | ofs | File offset (for block devices) |
| | h | Handle from open |
| | irpp | See complete operation |
| Out: | len | Number of bytes written |
| Return | CMST_OK | The operation was successful. |
| Status: | | |

| | |
|---|---|
| CMST_NOT_OPE | Object is not open |
| N | |
| CMST_IOERR | I/O error |
| CMST_FULL | Media full (for block devices only) |
| CMST_PENDING | See notes for complete operation |

| | |
|---|---|
| Example: | B_DIO bus; |

// open device
memset (&bus, 0, sizeof (bus));
bus.p = L“MyDevice”;
bus.len = sizeof (L“MyDevice”);
s = out (dio, open, &bus);
if (s != CMST_OK). . .
// write to device
bus.buf_mapping = DIO_BUF_DIRECT;
bus.p = “MyString”;
bus.sz = strlen (“MyString”) + 1;
bus.ofs = 1000;
bus.irpp = &irp; // NT request packet
s = out (dio, write, &bus);
if (s != CMST_OK). . .
// cancel any pending operations
out (dio, cleanup, &bus);
// close device
out (dio, close, &bus);

Ioctl

| Description: | Execute the IOCTL operation specified by ioctl. The | |
|---|---|---|
| | definition of IOCTL operations is outside the scope of this | |
| | interface. For more information see the Windows NT DDK | |
| | documentation. | |
| In: | id | Device instance identification (see note |
| | | #4 in the overview) |
| | attr | Attributes, can be any one of the |

| | |
|---|---|
| following: | |
| DIO_A_PREVIE | “preview”operation |
| W | |
| DIO_A_ASYNC_{—} | operation may |
| CPLT | complete |

asynchronously

| | |
|---|---|
| buf_mapping | Buffering attributes, can be one of the |

| following: | |
|---|---|
| DIO_MAP_BUFF | buffering is handled |
| ERED | by caller, p is a valid |
| | virtual memory |
| | address |
| DIO_MAP_DIRE | no buffering, p value |
| CT | is system-dependent |

| | p | Pointer to input data and buffer for |
|---|---|---|
| | | output data |
| | sz | Size of output buffer |
| | len | Length of input data |
| | ioctl | IOCTL function code |
| | h | Handle from open |
| | irpp | See complete operation |
| Out: | len | Length of output data (never more than |
| | | sz) |
| | *p | Output data (depending on function |
| | | code ioctl) |
| Return | CMST_OK | The operation was successful. |
| Status: | | |
| | CMST_NOT_OPE | Object is not open |
| | N | |
| | CMST_IOERR | I/O error |
| | CMST_PENDING | See notes for complete operation |
| | CMST_NOT_SUP | The specified IOCTL code is not |
| | PORTED | implemented |

| Example: | B_DIO bus; |
|---|---|
| | char buffer [256]; |
| | // open device |
| | memset (&bus, 0, sizeof (bus)); |
| | bus.p = L“MyDevice”; |
| | bus.len = sizeof (L“MyDevice”); |
| | s = out (dio, open, &bus); |
| | if (s != CMST_OK). . . |
| | // write to device |
| | strcpy (buffer, “MyData”); |
| | bus.buf_mapping = DIO_BUF_DIRECT; |
| | bus.p = buffer; |
| | bus.sz = sizeof (buffer); |
| | bus.len = strlen (buffer) + 1; |
| | bus.ioctl = IOCTL_SMARTCARD_GET_ATTRIBUTE; |
| | bus.irpp = &irp; // NT request packet |
| | s = out (dio, write, &bus); |
| | if (s != CMST_OK). . . |
| | // cancel any pending operations |
| | out (dio, cleanup, &bus); |
| | // close device |
| | out (dio, close, &bus); |

Complete

| Description: | Report completion of an operation | |
|---|---|---|
| In: | h | Handle to pass to subsequent |
| | | operations (when completing open) |
| | len | Length of output data (if applicable, |
| | | see I_DIO above) |
| | other | See the ‘out’ fields for each I_DIO |
| | | operation |
| | irpp | Must be as received with the operation |
| | | being completed |
| | cplt_s | Completion status |
| Out: | void | |
| Return | CMST_OK | The operation was successful. |
| Status: | | |
| | CMST_INVALID | irpp does not correspond to a valid |

pending operation

| Example: | B_DIO bus; |
|---|---|
| | char buffer [256]; |
| | // open device |
| | memset (&bus, 0, sizeof (bus)); |
| | bus.p = L“MyDevice”; |
| | bus.len = sizeof (L“MyDevice”); |
| | s = out (dio, open, &bus); |
| | if (s != CMST_OK). . . |
| | // read from device asynchronously |
| | bus.attr = DIO_A_ASYNC_CPLT; |
| | bus.buf_mapping = DIO_BUF_DIRECT; |
| | bus.p = buffer; |
| | bus.sz = sizeof (buffer); |
| | bus.ofs = 1000; |
| | bus.irpp = &irp; // NT request packet |
| | s = out (dio, read, &bus); |
| | if (s != CMST_OK) . . . |
| | // . . . |
| | OPERATION (dio_c, complete, B_DIO) |

{
// this is called when the read operation completes
return (CMST_OK);
}

| | END_OPERATION |
|---|---|
| Remarks: | This operation is intended to be used in the client-to-server |
| | direction of a bi-directional I_DIO/I_DIO_C terminal. If the |
| | server has to complete any of the I_DIO operations |
| | described above asynchronously it should copy the bus |
| | and return CMST_PENDING. When the operation |
| | completes it fills in the required ‘out’ fields in the bus and |
| | calls through the back channel with the saved copy of the |
| | bus. |

I_IRQ, I_IRQ_R—Interrupt Source Interface

Overview

This is an interrupt source interface. It is used for enabling and disabling the event source and for receiving events when an interrupt occurs.

List of Operations

| Name | Description |
|---|---|
| enable | Enable interrupt handling |
| disable | Disable interrupt handling |
| preview | Preview interrupt event at device |
| | IRQL |
| submit | Interrupt event occurred (preview |
| | returned CMST_SUBMIT) |

Operation Bus

BUS (B_IRQ)

uint32 attr ; // attributes
_ctx ctx ; // context

END_BUS

Notes

1. The enable and disable operations must be invoked only at PASSIVE IRQL

2. The preview operation is always sent at device IRQL (in interrupt context). The operation implementation must be unguarded.

3. The submit operation is always sent at DISPATCH IRQL.

Enable

| Description: | Enable interrupt handling. | |
|---|---|---|
| In: | void | |
| Out: | void | |
| Return | CMST_OK | Interrupt handling is enabled. |
| Status: | | |
| | CMST_NO_ACTI | The interrupt handling is already |
| | ON | enabled. |
| | CMST_REFUSE | Interrupt source cannot be enabled |
| | | manually |
| | CMST_INVALID | Failed to register ISR because of |
| | | invalid properties. |
| | ST_BUSY | The Interrupt is used exscluzivly |

from sombody else

| Example: | s = out (irq, enable, NULL); |
|---|---|
| | if (s != CMST_OK) . . . |
| | // enable interrupt generation |
| | // . . . |
| | // disable interrupt generation |
| | s = out (irq, disable, NULL); |
| | if (s != CMST_OK) . . . |
| Remarks: | The enable operation must be invoked only at PASSIVE |
| | IRQL |

Disable

| Description: | Disable interrupt handling | |
|---|---|---|
| In: | void | |
| Out: | void | |
| Return | CMST_OK | The operation was successful. |
| Status: | | |
| | CMST_NO_ACTI | Interrupt event source is not |
| | ON | enabled |
| | CMST_REFUSE | Interrupt event source cannot be |

disabled manually

| Example: | See example for enable. |
|---|---|
| Remarks: | The disable operation must be invoked only at PASSIVE |
| | IRQL. Upon successful return, the event source |
| | guarantees that it will not preview or submit unless |
| | it is re-enabled. |

Preview

| Description: | Preview an interrupt at device IRQL | |
|---|---|---|
| In: | void | |
| Out: | ctx | context for the subsequent submit |
| | | operation |
| Return | CMST_OK | Interrupt handling completed, no need |
| Status: | | for sending submit operation |
| | CMST_SUBMIT | Interrupt event accepted. Send submit |
| | | operation at lower IRQL |
| | other error | Interrupt not recognized, don't send |
| | status | submit. |

| Example: | None. |
|---|---|
| Remarks: | preview operation is always sent at device IRQL (in |
| | interrupt context) |
| | Note that if the interrupt is level-sensitive (as opposed to |
| | edge-sensitive), this operation should clear at least one |
| | reason for the interrupt; if the the device does not |
| | deassert the interrupt, the preview operation will be |
| | invoked again upon return. |

Submit

| Description: | Process interrupt. | |
|---|---|---|
| In: | ctx | context returned from preview |
| Out: | void | |
| Return | CMST_OK | Event accepted. |
| Status: | | |
| Example: | None. | |

| | |
|---|---|
| Remarks: | submit operation is always sent at |

DISPATCH IRQL

I_IOP—I/O Port Interface

Overview

This is a generic I/O port interface.

List of Operations

| Name | Description |
|---|---|
| in | Read a byte (8-bits) from the I/O port |
| inw | Read a word (16-bits) from the I/O |
| | port |
| indw | Read a double word (32-bits) from |
| | the I/O port |
| inbuf | read sequence of bytes, words or |
| | double words from the I/O port |
| out | Output a byte (8-bits) to the I/O port |
| outw | Output a word (16-bits) to the I/O |
| | port |
| outdw | Output a dword (32-bits) to the I/O |
| | port |
| outbuf | Output sequence of bytes, words or |
| | double words to the I/O port |

Operation Bus

None

Notes

All operations can be invoked at any interrupt level.

in (CMIFCP (_iface), uint32 offs, byte *bp)

| Description: | Read a byte (8-bits) from the I/O port | |
|---|---|---|
| In: | offs | base relative I/O port offset |
| | bp | pointer to a storage for 8-bit value |
| Out: | *bp | 8-bit value read from the port |
| Return | CMST_OK | operation finished successfully |
| Status: | | |
| Example: | byte b; | |

s = outX (io, in) ((_iface * const)top (io), 0, &b);
if (s != CMST_OK) . . .
printf (“byte received 0x%02x\n”, b);

inw (CMIFCP (_iface), uint32 offs, word *wp)

| Description: | Read a word (16-bits) from the I/O port | |
|---|---|---|
| In: | offs | base relative I/O port offset |
| | wp | pointer to a storage for 16-bit value |
| Out: | *wp | 16-bit value read from the port |
| Return | CMST_OK | operation finished successfully |
| Status: | | |

| | |
|---|---|
| Example: | word w; |
| | s = outX (io,inw) ((_iface * const)top (io), 0, &w); |
| | if (s != CMST_OK) . . . |
| | printf (“word received 0x%04x\n”, w); |

indw (CMIFCP (_iface), uint32 offs, dword *dp)

| Description: | Read a double word (32-bits) from the I/O port | |
|---|---|---|
| In: | offs | base relative I/O port offset |
| | dp | pointer to a storage for 32-bit value |
| Out: | *dp | 32-bit value read from the port |
| Return | CMST_OK | operation finished successfully |
| Status: | | |

| | |
|---|---|
| Example: | word dw; |
| | s = outX (io, indw) ((_iface * const)top (io), 0, &d); |
| | if (s != CMST_OK) . . . |
| | printf (“dword received 0x%08lx\n”, d); |

inbuf (CMIFCP (_iface),

uint32 offs,
uint32 unit_sz,
uint32 n_units,
void *bufp)

| Description: | read sequence of bytes, words or double words from the | |
|---|---|---|
| | I/O port | |
| In: | offs | base relative I/O port offset |
| | unit_sz | port size (in bytes) or size of the units. |
| | | Must be 1,2 or 4 |
| | n_unit | number of the units to be read from the |
| | | port |
| | bufp | output data buffer. The size of the |
| | | buffer must be at least unit_sz * |
| | | n_units (in bytes) |
| Out: | *bufp | n_units read from the port |
| Return | CMST_OK | operation finished successfully |
| Status: | | |
| Example: | byte b; | |
| | word w; | |
| | dword dw[10]; | |

| s = outX (io, inbuf) ((_iface * const)top (io), | |
|---|---|
| | 0, |
| | sizeof(b), |
| | 1, |
| | &b); |
| if (s != CMST_OK) . . . | |
| printf (“byte received 0x%02x\n”, b); | |
| s = outX (io, inbuf) ((_iface * const)top (io), | |
| | 0, |
| | sizeof(w), |
| | 1, |
| | &w); |

if (s != CMST_OK) . . .
printf (“word received 0x%04x\n”, w);
s = outX (io, inbuf) ((_iface * const)top (io),

0,
sizeof(dw[0]),
sizeof(dw)/sizeof(dw[0]),
&dw);

if (s != CMST_OK) . . .
printf (“1-st dword received = 0x%08lx\n”, dw[O]);

out (CMIFCP (_iface), uint32 offs, byte b)

| Description: | Output a byte (8-bits) to the I/O port | |
|---|---|---|
| In: | offs | base relative I/O port offset |
| | b | 8-bit output value |
| Out: | void | |
| Return | CMST_OK | operation finished successfully |
| Status: | | |

| | |
|---|---|
| Example: | s = outX (io, out) ((_iface * const)top (io), 0, 0x12); |
| | if (s != CMST_OK) . . . |

outw (CMIFCP (_iface), uint32 offs, word w)

| Description: | Output a word (16-bits) to the I/O port | |
|---|---|---|
| In: | offs | base relative I/O port offset |
| | w | 16-bit output value |
| Out: | void | |
| Return | CMST_OK | operation finished successfully |
| Status: | | |

| | |
|---|---|
| Example: | word w; |
| | s = outX (io, outw) ((_iface * const)top (io), 0, 0x1234); |
| | if (s != CMST_OK) . . . |

outdw (CMIFCP (_iface), uint32 offs, dword dw)

| Description: | Output a dword (32-bits) to the I/O port | |
|---|---|---|
| In: | offs | base relative I/O port offset |
| | dw | 32-bit output value |
| Out: | void | |
| Return | CMST_OK | operation finished successfully |
| Status: | | |
| Example: | word dw; | |

s = outX (io, outdw) ((_iface * const) top (io),

0,
0x12345678);

if (s != CMST_OK) . . .

| | |
|---|---|
| inbuf (CMIFCP | (i_face), |

uint32 offs,
uint32 unit_sz,
uint32 n_units,
void *bufp)

| Description: | Output sequence of bytes, words or double words to the | |
|---|---|---|
| | I/O port | |
| In: | offs | base relative I/O port offset |
| | unit_sz | port size (in bytes) or size of the units. |
| | | Must be 1,2 or 4 |
| | n_unit | number of the units to be outputed to |
| | | the port |
| | bufp | data buffer. The length of the data is |
| | | equal to unit_sz * n_units (in bytes) |
| Out: | void | |
| Return | CMST_OK | operation finished successfully |
| Status: | | |

| | |
|---|---|
| Example: | byte b = 0x12; |
| | word w = 12345; |
| | dword dw[10]= {1, 2, 3, 4, 5, 6, 7, 8, 9, 10}; |
| | s = outX (io, out) ((_iface * const)top (io), |

0,
sizeof(b),
1,
&b);

if (s != CMST_OK) . . .
s = outX (io, outbuf) ((_iface * const)top (io),

1234,
sizeof(w),
1,
&w);

if (s != CMST_OK) . . .
s = outX (io, outbuf) ((_iface * const)top (io),

333,
sizeof(dw[0]),
sizeof(dw)/sizeof(dw[0]),
&dw);

if (s != CMST_OK) . . .

I_BYTEARR—Byte-Array Interface

Overview

This interface provides access to a byte-array. It provides read and write operations for manipulation of the array. It also allows control over the byte-array metrics (size).

The byte array may be fixed length or it may be dynamic—depending on the implementation.

List of Operations

| Name | Description |
|---|---|
| read | read block of bytes starting at specified offset |
| write | write block of bytes starting at specified offset |
| get_metrics | get size of the array |
| set_metrics | set size of the array |

Operation Bus

BUS (B_BYTEARR)

void *p ; // buffer pointer
uint32 offs ; // offset
uint32 len ; // length of data in *p, [bytes]
uint32 sz ; // size of buffer pointed to by p,

// [bytes]

flg32 attr ; // attributes, [BYTEARR_A_xxx]

END_BUS

Read

| Description: | read block of bytes starting at specified offset | |
|---|---|---|
| In: | p | buffer pointer |
| | sz | size of buffer |
| | offs | offset |
| | len | how many bytes to read |
| | attr | 0 to read <= len bytes, or |
| | | BYTEARR_A_EXACT to read exactly |
| | | len bytes |
| Out: | *p | data |
| | len | bytes actually read |
| Return | CMST_OK | successful |
| Status: | | |
| | CMST_EOF | cannot read requested len bytes (when |
| | | BYTEARR_A_EXACT) |

| | |
|---|---|
| Example: | B_BYTEARR bus; |
| | char buf [256]; |
| | cmstat s; |
| | // read 5 bytes starting at offset 10 |
| | bus.p = buf; |
| | bus.sz = sizeof (buf); |
| | bus.offs = 10; |
| | bus.len = 5; |
| | bus.attr = BYTEARR_A_EXACT; |
| | s = out (arr, read, &bus); |
| | if (s != CMST_OK) . . . |
| Remarks: | If BYTEARR_A_EXACT is not specified, an attempt to read |
| | beyond the limits of supported space returns CMST_OK |
| | with len == 0. |

Write

| Description: | write block of bytes starting at specified offset | |
|---|---|---|
| In: | p | pointer to data to be written |
| | offs | offset |
| | len | number of bytes to write |
| | attr | 0 to BYTEARR_A_GROW to grow |
| | | automatically |
| Out: | void | |
| Return | CMST_OK | successful |
| Status: | | |
| | CMST_OVERFLOW | offs + len is beyond the current size |
| | | of the array and BYTEARR_A_GROW |
| | | was not specified |
| | CMST_NOT_SUP | specified attribute is not supported |
| | PORTED | |

| | |
|---|---|
| Example: | B_BYTEARR bus; |
| | char buf [256]; |
| | cmstat s; |
| | // write 5 bytes starting at offset 10 |
| | strcpy (buf, “12345”); |
| | bus.p = buf; |
| | bus.offs = 10; |
| | bus.len = 5; |
| | bus.attr = 0; |
| | s = out (arr, write, &bus); |
| | if (s != CMST_OK) . . . |

Get_metrics

| Description: | get size of the array | |
|---|---|---|
| In: | void | |
| Out: | len | number of bytes available for reading |
| | | from offset 0 |
| | sz | number of bytes available for writing |
| | | from offset 0 |
| Return | CMST_OK | successful |
| Status: | | |

| | |
|---|---|
| Example: | B_BYTEARR bus; |
| | cmstat s; |
| | // get size of the array |
| | s = out (arr, get_metrics, &bus); |
| | if (s != CMST_OK) . . . |
| | // print size |
| | printf (“available for reading: %Id\n”, bus.len); |
| | printf (“available for writing: %Id\n”, bus.sz); |

Set_metrics

| Description: | set size of the array | |
|---|---|---|
| In: | len | number of bytes to become available |
| | | for reading from offset 0 |
| | sz | number of bytes to become available |
| | | for writing from offset 0 |
| Out: | void | |
| Return | CMST_OK | successful |
| Status: | | |
| | CMST_REFUSE | if specified sz < specified len |
| | CMST_ALLOC | specified size cannot be reached (i.e., |
| | | out of memory) |
| | CMST_NOT_SUP | operation is not supported |
| | PORTED | |

| | |
|---|---|
| Example: | B_BYTEARR bus; |
| | cmstat s; |
| | // set size of the array |
| | bus.sz = 10; |
| | bus.len = 10; |
| | s = out (arr, set_metrics, &bus); |
| | if (s != CMST_OK) . . . |
| Remarks: | if len < current length, elements are removed |
| | if len > current length, elements are filled with 0 |

I_USBCFG—USB Configuration Interface

Overview

This interface is used to enumerate the set of available USB configurations on the current system. After enumeration, a configuration can be set to the current configuration used by a USB driver. The configuration list may be refreshed at any time.

List of Operations

| Name | Description |
|---|---|
| refresh | Refresh the list of available |
| | configurations |
| set | Set a configuration or set to |
| | unconfigured state (id = |
| | NO_USBCFG) |
| get | Get currently selected configuration |
| get_info | Get information for specified |
| | configuration ID (‘id’ does not have |
| | to be the current configuration) |
| qry_open | Open a query for enumerating |
| | configurations |
| qry_close | Close a query for enumerating |
| | configurations |
| qry_first/qry_next | Get first/next configuration |
| reset | Reset the USB device |

Operation Bus

BUS(B_USBCFG)

| // primary identification | | |
|---|---|---|
| uint32 | id; | // configuration ID |
| // USB identification | | |
| byte | cfg_id; | // configuration number |
| byte | ifc_id; | // interface number |
| byte | alt_id; | // alternate setting number |
| // configuration data | | |
| word | cfg_attr; | // USBCFG_A_xxx |
| word | cfg_pwr; | // 0-500 [ma] |

| | |
|---|---|
| byte | cfg_desc_idx; // index of configuration |

// description string

| | |
|---|---|
| byte | ifc_class; // (values are defined by the USB |

// standard)

| | |
|---|---|
| byte | ifc_subclass; // (values are defined by the USB |

// standard)

| | |
|---|---|
| byte | ifc_protocol; // (values are defined by the USB |

// standard)

| | |
|---|---|
| uint32 | n_endpts; // number of entries in endpt[] |

// array

| | |
|---|---|
| ENDPT | endpt[MAX_ENDPTS]; // endpoint data |

END_BUS

Refresh

| Description: | Refresh the list of available configurations | |
|---|---|---|
| In: | void | |
| Out: | void | |
| Return | CMST_OK | configuration was read successfully |
| Status: | | |
| | (other) | failed to read configuration |

| | |
|---|---|
| Remarks: | Use of this operation is not required in order to use other |
| | operations of the I_USBCFG interface |
| | This operation may invalidate configuration IDs obtained |
| | with prior qry_first/qry_next operations |

Set

| Description: | Set a configuration or set to unconfigured state (id = | |
|---|---|---|
| | NO_USBCFG) | |
| In: | id | config ID from qry_first/qry_next or |
| | | NO_USBCFG |
| Out: | void | |
| Return | CMST_OK | configuration was selected successfully |
| Status: | | |
| | CMST_FAILED | configuration was not selected |

| | |
|---|---|
| Remarks: | It is recommended that all activity on USB endpoints |
| | except endpoint 0 is suspended when calling the ‘set’ |
| | operation. |
| | Implementation may not guarantee that device state will |
| | be preserved if the operation fails. |
| | Upon successful return from ‘set’ the device is configured |
| | and ready and all the endpoints are ready for data transfer. |

Get

| Description: | Get currently selected configuration | |
|---|---|---|
| In: | void | |
| Out: | id | current configuration ID |
| Return | CMST_OK | always (except fatal failures) |
| Status: | | |

Get_info

| Description: | Get information for specified configuration ID (‘id’ does | |
|---|---|---|
| | not have to be the current configuration) | |
| In: | id | value returned by qry_first, qry_next or |
| | | get |
| Out: | (all fields - see notes at qry_first/qry_next) | |
| Return | CMST_INVALID | id is not valid (use only values returned |
| Status: | | by qry_first/qry_next) |

Qry_open

| Description: | Open a query for enumerating configurations | |
|---|---|---|
| In: | void | |
| Out: | void | |
| Return | CMST_NO_ROO | a query is already open |
| Status: | M | |

Qry_close

| | |
|---|---|
| Description: | Close a query for enumerating configurations |
| In: | void |
| Out: | void |
| Return | CMST_NO_ACTI no query is open |
| Status: | ON |

Qry_first/qry_next

| Description: | Get first/next configuration | |
|---|---|---|
| In: | id | (for qry_next only) value from previous |
| | | call to qry_first/qry_next |

| | |
|---|---|
| Out: | (all B_USBCFG fields are set) |
| Return | CMST_NOT_FO there are no more configurations |
| Status: | UND |

Reset

| | |
|---|---|
| Description: | Reset the USB device; this operation executes the reset |
| | sequence on the USB port and returns the device to its |
| | unconfigured state. |
| In: | void |
| Out: | void |
| Return | CMST_ACCESS_ device is disconnected |
| Status: | DENIED |

Appendix 2—Events

This appendix describes preferred definition of events used by parts described herein.

EV_IDLE

| Overview: | The EV_IDLE is a generic event used to signal that idle | |
|---|---|---|
| | processing can take place. Recipients of this event | |
| | perform processing that was postponed or | |
| | desynchronized. | |
| Description: | Signifies that a system is idle and that idle processing can | |
| | take place. | |
| Event Bus | CMEVENT_HDR/CMEvent | |
| Definition: | | |
| Return | Depends on the consumer of the event. Usually, the | |
| Status: | following values are interpreted | |
| | CMST_OK | processing was performed; there is need |
| | | for more idle-time processing, waiting for |
| | | another idle event |
| | CMST_NO_{—} | there was nothing to do on this event |
| | ACTION | |

| | |
|---|---|
| Example: | /* my idle event definition - equivalent to CMEVENT_{—} |
| | HDR */ |
| | EVENT (MY_IDLE_EVENT) |
| | // no event data |
| | END_EVENT |
| | MY_IDLE_EVENT idle_event; |
| | /* initialize idle event */ |
| | idle_event.sz = sizeof (idle_event); |
| | idle_event.attr = CMEVT_A_DFLT; |
| | idle_event.id = EV_IDLE; |
| | /* raise event through a I_DRAIN output */ |
| | out (drain, raise, &idle_event); |
| Remarks: | This event uses the CMEVENT_HDR/CMEvent directly; it |
| | does not have any event-specific data. There are no |
| | event-specific attributes defined for this event. |
| | This event is typically distributed synchronously. See the |
| | overview of the I_DRAIN interface for a description of the |
| | generic event attributes. |
| See Also: | I_DRAIN, DM_DWI, DM_IEV, CMEVENT_HDR, |
| | CMEvent |

EV_REQ_ENABLE

| | |
|---|---|
| Overview: | EV_REQ_ENABLE is a generic request to enable a |
| | particular procedure or processing. The nature of this |
| | procedure depends on the context and environment in |
| | which it is used. |
| Description: | Generic request to enable a particular procedure. |
| Event Bus | CMEVENT_HDR/CMEvent |
| Definition: | |
| Return | Depends on the consumer of the event |
| Status: | |
| Example: | EVENTX (MY_ENABLE_EVENT, EV_REQ_{—} |
| | ENABLE, CMEVT_A_AUTO, |
| | CMEVT_UNGUARDED) |
| | char data[32]; |
| | END_EVENTX |
| | /* allocate enable event */ |
| | if (evt_alloc (MY_ENABLE_EVENT, &enable_{—} |
| | eventp) ! = CMST_OK) |
| | return; |
| | /* raise event through a I_DRAIN output */ |
| | memset (&enable_eventp->data[0], |
| | O×AA, sizeof (enable_eventp->data)); |
| | out (drain, raise, enable_eventp); |
| Remarks: | This event does not have any event-specific data or |
| | attributes. |
| | If this event is distributed asynchronously, then the event |
| | bus must be self-owned. See the overview of the |
| | I_DRAIN interface for a description of the generic event |
| | attributes. |
| See Also: | I_DRAIN, DM_DWI, DM_IEV, CMEVENT_HDR/ |
| | CMEvent |

EV_REQ_DISABLE

| | |
|---|---|
| Overview: | EV_REQ_DISABLE is a generic request to disable a |
| | particular procedure or processing. The nature of this |
| | procedure depends on the context and environment in |
| | which it is used. |
| Description: | Generic request to disable a particular procedure. |
| Event Bus | CMEVENT_HDR/CMEvent |
| Definition: | |
| Return | Depends on the consumer of the event |
| Status: | |
| Example: | EVENTX (MY_DISABLE_EVENT, EV_REQ_{—} |
| | DISABLE, CMEVT_A_AUTO, |
| | CMEVT_UNGUARDED) |
| | char data[32]; |
| | END_EVENTX |
| | /* allocate disable event */ |
| | if (evt_alloc (MY_DISABLE_EVENT, &disable_eventp) |
| | ! = CMST_OK) return; |
| | /* raise event through a I_DRAIN output */ |
| | memset (&disable_eventp->data[0], |
| | 0×AA, sizeof (disable_eventp->data)); |
| | /* raise event through a I_DRAIN output */ |
| | out (drain, raise, disable_eventp); |
| Remarks: | This event does not have any event-specific data or |
| | attributes. |
| | If this event is asynchronous, then the event bus must be |
| | self-owned. See the overview of the I_DRAIN interface for |
| | a description of the generic event attributes. |
| See Also: | I_DRAIN, DM_DWI, DM_IEV, CMEVENT_HDR, |
| | CMEvent |

EV_REP_NFY_DATA_CHANGE

| | |
|---|---|
| Overview: | This event is generated when a repository data item or a |
| | subtree changes. The change may be that a value has |
| | been modified, added or deleted. The originator of the |
| | event may use the event with an indication that a whole |
| | subtree has been changed in order to avoid notifying for |
| | each item separately. |
| Description: | Notification that a repository data item has been modified, |
| | added, or deleted |
| Event Bus | EVENTX (EV_REP, EV_REP_NFY_DATA_{—} |
| | CHANGE, |
| Definition: | CMEVT_A_AUTO, |
| | CMEVT_UNGUARDED) |
| | // repository event specific data |
| | char path[I_ITEM_MAX_PATH]; //full path to affected |

// entity

| | |
|---|---|
| bool32 is_subtree | ; // TRUE if the whole |

// subtree is affected

| | END_EVENTX | |
|---|---|---|
| Data: | path | Full data path to affected data item or |
| | | subtree root |
| | is_subtree | TRUE the if whole subtree below the |
| | | path specified by path has changed. If |
| | | this member is FALSE, only the item at |
| | | the specified path has changed. |

| | |
|---|---|
| Return | Since this is a notification of an action that has already |
| Status: | occurred and does not depend on processing by the |
| | recipient, originators of this event can safely ignore the |
| | returned status. |
| Example: | OPERATION (nfy, raise, EV_REP) |

```
{
/* valchk */
if (bp = = NULL) return (CMST_NULL_PTR);
if (bp->id ! = EV_REP_NFY_DATA_CHANGE)
  {
  /* free bus if self-owned */
  if (bp->attr & CMEVT_A_SELF_OWNED)
```

evt_free (bp);

```
  return (CMST_OK);
  {
/* find out which path changed */
if (stricmp (bp->path,
    “customers[1].name”) = = 0)
  printf (“customer #1 name has changed.\n”);
if (stricmp (bp->path,
    “customers[2].name”) = = 0)
  printf (“customer #2 name has changed.\n”);
/* find out if the whole subtree was affected */
if (bp->is_subtree)
  printf (“The whole subtree was affected\n”);
/* free bus if self-owned */
if (bp->attr & CMEVT_A_SELF_OWNED)
evt_free (bp);
return (CMST_OK);
}
```

| | END_OPERATION |
|---|---|
| Remarks: | The EV_REP_NFY_DATA_CHANGE event is |
| | generated by DM_REP when a repository data item |
| | changes (added, changed, deleted). There are no event- |
| | specific attributes defined for this event. |
| | The event bus contains all the information about the |
| | affected entity. It contains the affected data path and |
| | whether or not the whole subtree under that path was |
| | affected. |
| | If this event is distributed asynchronously, then the event |
| | bus must be self-owned. Note that, since the event |
| | contains the storage for the path and not only a pointer to |
| | it, the event is self-contained and can be distributed |
| | asynchronously. See the overview of the I_DRAIN |
| | interface for a description of the generic event attributes. |
| See Also: | I_DRAIN, DM_REP |

EV_RESET

| | |
|---|---|
| Overview: | This event is a generic request for reset. Recipients of this |
| | event should immediately reset their state and get ready to |
| | operate again as if they were just activated. |
| Description: | Reset the internal state of a part. |
| Event Bus | CMEVENT_HDR/CMEvent |
| Definition: | |
| Return | Depends on the consumer of the event |
| Status: | |
| Remarks: | This event does not have any event-specific data or |
| | attributes. |
| | If this event is asynchronous, then the event bus must be |
| | self-owned. See the overview of the I_DRAIN interface for |
| | a description of the generic event attributes. |
| See Also: | I_DRAIN, DM_DWI, CMEVENT_HDR, CMEvent |

EV_MESSAGE

| Overview: | This event contains a message received or to be | | |
|---|---|---|---|
| | transmitted through some communication channel. The | | |
| | event contains the actual data and its length. The event | | |
| | also contains an indication of whether the data is | | |
| | corrupted or not. | | |
| Description: | Send a string of bytes | | |
| Event Bus | EVENTX (B_EV_MSG, EV_NULL, | | |
| Definition: | CMEVT_A_SYNC \| CMEVT_A_SELF_OWNED \| | | |
| | CMEVT_A_SELF_CONTAINED, | | |
| | CMEVT_UNGUARDED) | | |
| | uint len ; // length of the data | | |
| | char data[1]; // variable size data | | |
| | END_EVENT | | |
| Data: | attr | MSG_A_NONE | no attrubutes |
| | | MSG_A_BAD_{—} | message consists |
| | | DATA | of bad data |

| | | |
|---|---|---|
| | len | length of message data |
| | data | beginning of message data |
| Return | CMST_OK | event processed successfully |
| Status: | | |

| | |
|---|---|
| Remarks: | This message must be sent with the EV_A_SYNC |
| | attribute set. |

EV_EXCEPTION

| | |
|---|---|
| Overview: | This event signifies that an exception has occurred which |
| | requires special processing. More than one recipient can |
| | process this event. |
| Description: | Raise exception. |
| Event Bus | EVENTX (B_EV_EXC, EV_EXCEPTION, |
| Definition: | CMEVT_A_SYNC \| CMEVT_A_SELF_{—} |
| | CONTAINED, CMEVT_UNGUARDED) |

| // exception identification | |
|---|---|
| dword exc_id | ; // exception ID |
| byte exc_class | ; // type of exception |
| byte exc_severity | ; // severity, [CMERR_XXX] |
| // source identification | |
| cmoid oid | ; // oid of original issuer |
| cmoid oid2 | ; // current oid |
| char path[48] | ; // path along the assembly |

// hierarchy (dot-separated
// names as in the SUBORDINATES
// tables)

| | |
|---|---|
| char | class_name[24]; // class name |
| char | file_name[24]; // file name |
| dword | line ; // line number in file |

// context

| | |
|---|---|
| char | term_name[16]; // terminal name |
| char | oper_name[16]; // operation name |
| cmstat | cm_stat ; // ClassMagic status (optional) |
| dword | os_stat ; // OS-dependent status |
| _ctx | ctx1 ; // optional context (see |

// EXC_A_xxx)

| | |
|---|---|
| _ctx | ctx2 ; // optional context (see |

// EXC_A_xxx)
// inserts

| | |
|---|---|
| char | format[16] ; // defines format of data[] |
| byte | data[128] ; // packed insert data, as |

// specified by the
// format ‘field’

| | | |
|---|---|---|
| Data: | attr | Attributes, can be any one of the |

| | |
|---|---|
| following: | |
| EXC_A_CTX1 _{—} | ctx1 is a pointer |
| IRP | to IRP |
| EXC_A_CTX2_{—} | ctx2 is an I/O |
| IOM | manager object |

| exc_id | exception ID | |
|---|---|---|
| exc_class | type of exception, reserved | |
| exc_severity | severity, [CMERR_XXX] | |
| oid | oid of original issuer | |
| oid2 | current old - used to trace assembly | |
| | path | |
| path | path along the assembly hierarchy (dot- | |
| | separated names as in the | |
| | SUBORDINATES tables) | |
| class_name | ClassMagic class name | |
| file_name | source file name | |
| line | line number in file | |
| term_name | terminal name | |
| oper_name | operation name | |
| cm_stat | ClassMagic status (CMST_xxx) | |
| os_stat | system status (NT status, Win32 error, | |
| | etc.) | |
| ctx1 | optional context (see EXC_A_xxx) | |
| ctx2 | optional context (see EXC_A_xxx) | |
| format | defines format of the ‘data’ field, one | |
| | char defines one data field as follows: | |
| | b, w, d - byte, word, dword (to be | |
| | printed in hex) | |
| | i, u - signed integer, unsigned integer | |
| | (dword, | |
| | decimal) | |
| | c - byte (to be printed as a character) | |
| | s - asciiz string | |
| | S - unicodez string | |
| | 1 . . 9 - 1 to 9 dwords of binary data | |
| | data | packed insert data, as specified by |
| | | format ‘field’ |
| Return | CMST_OK | The event was processed |
| Status: | | successfully |

| Remarks: | All fields except exc_xxx, class_name, file_name and line |
|---|---|
| | are optional, set them to binary Os if not used |
| | Use guidelines: |
| | 1) original issuer should: |
| | - initialize all mandatory fields |
| | - set ‘oid’ and ‘oid2’ to the same value (sp->self) |
| | - zero-init the following fields, they are for use only by |
| | exception |
| | processing parts: |
| | path |
| | 2) all unused fields should be zero-initialized |

EV_LFC_REQ_START

| | |
|---|---|
| Overview: | This life cycle event is used to signal that normal operation |
| | can begin. Recipients may commence operation |
| | immediately (the usual practice) and return after they have |
| | started. Recipient can postpone the starting for |
| | asynchronous completion and raise |
| | EV_LFC_NFY_START_CPLT event when ready. |
| Description: | Start normal operation |
| Event Bus | EVENT (B_EV_LFC) |
| Definition: | |

cmstat cplt_s; // completion status (asynchronous
completion)

| | END_EVENT | |
|---|---|---|
| Data: | attr | standard event attributes, |
| | | optionally |
| | | LFC_A_ASYNC_CPLT |
| Return | CMST_OK | started OK |
| Status: | | |
| | CMST_PENDING | postponed for asynchronous |
| | | completion (allowed if |
| | | LFC_A_ASYNC_CPLT is spe- |
| | | cified; otherwise treated as failure) |
| | any other | start failed |

| | |
|---|---|
| Remarks: | If LFC_A_ASYNC_CPLT is specified, the recipient may |
| | return CMST_PENDING and complete the start later by |
| | sending EV_LFC_NFY_START_CPLT. |

EV_LFC_REQ_STOP

| | |
|---|---|
| Overview: | This life cycle event is used to signal that normal operation |
| | should end. Typically recipients initiate the stopping |
| | procedure immediately and return after this procedure is |
| | complete. Recipient can postpone the starting for |
| | asynchronous completion and raise |
| | EV_LFC_NFY_STOP_CPLT event when ready. |
| Description: | Stop normal operation |
| Event Bus | EVENT (B_EV_LFC) |
| Definition: | |

cmstat cplt_s; // completion status (asynchronous
completion)

| | END_EVENT | |
|---|---|---|
| Data: | attr | standard event attributes, option- |
| | | ally LFC_A_ASYNC_CPLT |
| Return | CMST_OK | Stop completed |
| Status: | | |
| | CMST_PENDING | postponed for asynchronous |
| | | completion (allowed if |
| | | LFC_A_ASYNC_CPLT is spec- |
| | | ified; otherwise treated as failure) |
| | any other | stop failed |

| | |
|---|---|
| Remarks: | If LFC_A_ASYNC_CPLT is specified, the recipient may |
| | return CMST_PENDING and complete the stop later by |
| | sending EV_LFC_NFY_STOP_CPLT. |
| | In case stop fails, the recipient should still clean up as |
| | much as possible -- in many cases, stop failures are |
| | ignored (e.g., NT kernel mode drivers are unloaded, even if |
| | they fail to stop properly). |

EV_LFC_NFY_START_CPLT

| | |
|---|---|
| Overview: | This event indicates that the starting procedure has |
| | completed. The event is used when an asynchronous |
| | completion is needed and complements |
| | EV_LFC_REQ_START event. |
| Description: | Start has completed |
| Event Bus | EVENT (B_EV_LFC) |
| Definition: | cmstat cplt_s; // completion status |

// (asynchronous completion)

| | |
|---|---|
| | END_EVENT |
| Data: | cplt_s completion status |
| Return | The return status is ignored |
| Status: | |
| Remarks: | Start has completed successfully if cplt_s is CMST_OK, |
| | failed otherwise this event is sent in response to |
| | EV_LFC_REQ_START on which CMST_PENDING |
| | was returned; it goes in the opposite direction of |
| | EV_LFC_REQ_START |

EV_LFC_NFY_STOP_CPLT

| | |
|---|---|
| Overview: | This event indicates that the stopping procedure has |
| | completed. The event is used when an asynchronous |
| | completion is needed and complements |
| | EV_LFC_REQ_STOP event. |
| Description: | Stop has completed |
| Event Bus | EVENT (B_EV_LFC) |
| Definition: | cmstat cplt_s; // completion status |

// (asynchronous completion)

| | |
|---|---|
| | END_EVENT |
| Data: | cplt_s completion status |
| Return | The return status is ignored |
| Status: | |
| Remarks: | Stop has completed successfully if cplt_s is CMST_OK, |
| | failed otherwise this event is sent in response to |
| | EV_LFC_REQ_STOP on which CMST_PENDING was |
| | returned; it goes in the opposite direction of |
| | EV_LFC_REQ_STOP |
| | In case stop fails, the sender should still clean up as much |
| | as possible -- in many cases, stop failures are ignored |
| | (e.g., a file handle becomes invalid even if close failed). |

EV_PRP_REQ

Overview

This event is used to request a part to execute a property operation. All of the standard DriverMagic property operations are supported and are specified in the event as an op-code. The input and output parameters for each operation is dependent upon the op-code.

Each property operation is described below.

Event Bus

EVENTX (B_EV_PRP, EV_PRP_REQ, CMEVT_A_DFLT,

CMEVT_UNGUARDED)

uint32 cplt_s ; // completion status, [CMST_xxx]
_ctx context ; // IOCTL context
uint32 opcode ; // property operation code,

// [PROP_OP_xxx]

_hdl qryh ; // query handle
char name[64] ; // property name
uint16 type ; // property type, [CMPRP_T_XXX]
flg32 prp_attr ; // property attributes, [CMPRP_A_XXX]
flg32 attr_mask; // property attribute mask,

// [CMPRP_A_XXX]

uint32 size ; // size of data in bytes
uint32 len ; // length of data in bytes
byte data[1] ; // buffer for property value

END_EVENTX

PROP_OP_GET

| | | |
|---|---|---|
| Description: | Get a property | |
| In: | context | 32-bit context |
| | opcode | operation id, [PROP_OP_GET] |
| | name | null-terminated property name |
| | type | type of the property to retrieve or |
| | | CMPRP_T_NONE for any |
| | size | size of data, [bytes] |
| | data[] | buffer to receive property value |
| Out: | cplt_s | completion status, [CMST_xxx] |
| | len | length of data returned in data[] |
| | data | property value |
| Return | CMST_OK | success |
| Status: | | |
| | CMST_REFUSE | the data type does not match the |
| | | expected type |
| | CMST_NOT_FO | unknown property |
| | UND | |
| | CMST_OVERFLO | the buffer is too small to hold the |
| | W | property value |

PROP_OP_SET

| | | |
|---|---|---|
| Description: | Set a property | |
| In: | context | 32-bit context |
| | opcode | operation id, [PROP_OP_SET] |
| | name | null-terminated property name |
| | type | property type, [CMPRP_T_XXX] |
| | len | length [in bytes] of data stored in |
| | | data |
| | data[] | property value |
| Out: | cplt_s | completion status, [CMST_xxx] |
| Return | CMST_OK | success |
| Status: | | |
| | CMST_NOT_FO | unknown property |
| | UND | |
| | CMST_OVERFLO | the property value is too large |
| | W | |
| | CMST_REFUSE | the property type is incorrect or the |
| | | property cannot be changed while the |
| | | part is in an active state |
| | CMST_OUT_OF_{—} | the property value is not within the |
| | RANGE | range of allowed values for this |
| | | property |
| | CMST_BAD_AC | there has been an attempt to set a |
| | CESS | read-only property |

PROP_OP_CHK

| Description: | Check if a property can be set to the specified value | |
|---|---|---|
| In: | context | 32-bit context |
| | opcode | operation id, [PROP_OP_CHK] |
| | name | null-terminated property name |
| | type | type of the property value to check |
| | len | size in bytes of property value |
| | data[] | buffer containing property value |
| Out: | cplt_s | completion status. [CMST_xxx] |
| Return | CMST_OK | successful |
| Status: | | |
| | CMST_NOT_FO | the property could not be found or the |
| | UND | id is invalid |
| | CMST_OVERFLO | the property value is too large |
| | W | |
| | CMST_REFUSE | the property type is incorrect or the |
| | | property cannot be changed while the |
| | | part is in an active state |
| | CMST_OUT_OF_{—} | the property value is not within the |
| | RANGE | range of allowed values for this |
| | | property |
| | CMST_BAD_AC | there has been an attempt to set a |
| | CESS | read-only property |

PROP_OP_GET_INFO

| Description: | Retrieve the type and attributes of the specified property | |
|---|---|---|
| In: | context | 32-bit context |
| | opcode | operation id, |
| | | [PROP_OP_GET_INFO] |
| | name | null-terminated property name |
| Out: | cplt_s | completion status, [CMST_xxx] |
| | type | type of property, [CMPRP_T_XXX] |
| | prp_attr | property attributes, |
| | | [CMPRP_A_XXX] |
| Return | CMST_OK | successful |
| Status: | | |
| | CMST_NOT_FO | the property could not be found |
| | UND | |

PROP_OP_QRY_OPEN

| Description: | Open a query to enumerate properties on a part based | |
|---|---|---|
| | upon the specified attribute mask and values or | |
| | CMPRP_A_NONE to enumerate all properties | |
| In: | context | 32-bit context |
| | opcode | operation id, |
| | | [PROP_OP_QRY_OPEN] |
| | name | query string (must be “*”) |
| | prp_attr | attribute values of properties to |
| | | include |
| | attr_mask | attribute mask of properties to include |
| Out: | cplt_s | completion status, [CMST_xxx] |
| | qryh | query handle |
| Return | CMST_OK | successful |
| Status: | | |
| | CMST_NOT_SUP | the specified part does not support |
| | PORTED | property enumeration or does not |
| | | support nested or concurrent property |
| | | enumeration |

| | |
|---|---|
| Remarks: | To filter by atrributes, specifiy the set of attributes in |
| | attr_mask and their desired values in prp_attr. During the |
| | enumeration, a bit-wise AND is performed between the |
| | actual attributes of each property and the value of |
| | attr_mask; the result is then compared to prp_attr. If there |
| | is an exact match, the property will be enumerated. |
| | To enumerate all properties of a part, specifiy the query |
| | string as “*”, and attr_mask and prp_attr as 0. |
| | The attribute mask can be one or more of the following: |
| | CMPRP_A_NONE - not specified |
| | CMPRP_A_PERSIST - persistent property |
| | CMPRP_A_ACTIVETIME - property can be modified |
| | while active |
| | CMPRP_A_MANDATORY - property must be set before |
| | activation |
| | CMPRP_A_RDONLY - read-only property |
| | CMPRP_A_UPCASE - force uppercase |
| | CMPRP_A_ARRAY - property is an array |

PROP_OP_QRY_CLOSE

| | | |
|---|---|---|
| Description: | Close a query | |
| In: | context | 32-bit context |
| | opcode | operation id, [PROP_OP_QRY_CLOSE] |
| | qryh | query handle |
| Out: | cplt_s | completion status, [CMST_xxx] |
| Return | CMST_OK | successful |
| Status: | | |
| | CMST_NOT_FOU | query handle was not found or is |
| | ND | invalid |
| | CMST_BUSY | the object can not be entered from |
| | | this execution context at this time |

PROP_OP_QRY_OPEN

| Description: | Retrieve the first property in a query | |
|---|---|---|
| In: | context | 32-bit context |
| | opcode | operation id, [PROP_OP_QRY_FIRST] |
| | qryh | query handle returned on |
| | | PROP_OP_QRY_OPEN |
| | size | size in bytes of data |
| | data[] | storage for the returned property name |
| Out: | cplt_s | completion status, [CMST_xxx] |
| | data | property name if size is not 0 |
| | len | length of data (including null |
| | | terminator) |
| Return | CMST_OK | successful |
| Status: | | |
| | CMST_NOT_FOU | no properties found matching current |
| | ND | query |
| | CMST_OVERFLO | buffer is too small for property name |
| | W | |

PROP_OP_QRY_NEXT

| Description: | Retrieve the next property in a query | |
|---|---|---|
| In: | context | 32-bit context |
| | opcode | operation id, [PROP_OP_QRY_NEXT] |
| | qryh | query handle returned on |
| | | PROP_OP_QRY_OPEN |
| | size | size in bytes of data |
| | data[] | storage for the returned property name |
| Out: | cplt_s | completion status, [CMST_xxx] |
| | data | property name if size is not 0 |
| | len | length of value (including null |
| | | terminator) |
| Return | CMST_OK | successful |
| Status: | | |
| | CMST_NOT_FOU | there are no more properties that |
| | ND | match the query criteria |
| | CMST_OVERFLO | buffer is too small for property name |
| | W | |

PROP_OP_QRY_CURR

| Description: | Retrieve the current property in a query | |
|---|---|---|
| In: | context | 32-bit context |
| | opcode | operation id, [PROP_OP_QRY_CURR] |
| | qryh | query handle returned on |
| | | PROP_OP_QRY_OPEN |
| | size | size in bytes of data |
| | data[] | storage for the returned property name |
| Out: | cplt_s | completion status, [CMST_xxx] |
| | data | property name if size is not 0 |
| | len | length of value (including null |
| | | terminator) |
| Return | CMST_OK | successful |
| Status: | | |
| | CMST_NOT_FOU | no current property (e.g. after a call to |
| | ND | PROP_OP_QRY_OPEN) |
| | CMST_OVERFLO | buffer is too small for property name |
| | W | |

EV_PULSE

| Overview: | EV_PULSE is a generic event that gives a recipient an | |
|---|---|---|
| | opportunity to execute in the sender's execution context. | |
| Description: | Gives recipient an opportunity to execute in sender's | |
| | execution context. | |
| Event Bus | uses CMEVENT_HDR/CMEvent | |
| Definition: | | |
| Return | CMST_OK | recipient executed OK |
| Status: | | |
| | CMST_NO_ACTI | recipient didn't have any action to be |
| | ON | performed |

| | |
|---|---|
| Remarks: | This event is typically distributed only synchronously. |
| | A sender of this event may re-send the event until |
| | CMST_NO_ACTION is returned, allowing the receipient to |
| | complete all pending actions'. |

This chapter provides details on the events used by WDK.

The first three events are extensions to the standard life-cycle event set provided by DriverMagic. These operate on the same bus and their event IDs are binary compatible with the standard life-cycle event IDs.

The third event EV_REQ_IRP is a request to process IRP. This event is the fundamental carrier of request packets entering the driver. The ownership of the IRP travels with the event.

The next seven events are used to request operations on device drivers. Each event corresponds to an operation on the I_DIO interface. These events are mainly used for communication with other device drivers.

The last three events are used for keyboard interaction. Only the DM_A2K part uses these events.

All requests can be completed synchronously or asynchronously (default). Some parts may refuse operation if asynchronous completion is not allowed. If this creates a problem, use DM_RSB part from the Advanced Part Library. For more information, consult the DM_RSB data sheet in the Advanced Part Library documentation.

In case of asynchronous completion, the same event is sent back with CMEVT_A_COMPLETED attribute set, to indicate that the processing of the event is complete.

EV_LFC_REQ_DEV_PAUSE

| | |
|---|---|
| Overview: | This is a request to pause the operation with the device. |
| | Recipients of this event may process it synchronously or |
| | asynchronously. |
| | In the later case they have to issue the same event with |
| | CMEVT_A_COMPLETED attribute set. |
| Description: | Request to pause the device |
| Event Bus | EVENT (B_EV_LFC) |
| Definition: | |
| | cmstat cplt_s; // completion status |

// (asynchronous completion)

| | | |
|---|---|---|
| | END_EVENT | |
| Data: | cplt_s | Completion status |
| | attr | CMEVT_A_ASYNC_CPLT - if |
| | | asynchronous completion is allowed |
| | | CMEVT_A_COMPLETED - if the event |
| | | is a completion event. |
| Return | CMST_PENDING | callee assumes responsibility to |
| Status: | | complete the request later (either |
| | | directly or by sending back the same |
| | | event with CMEVT_A_COMPLETED |
| | | set) |

| | |
|---|---|
| Remarks | This event is defined in e_lfc_ex.h. |

EV_LFC_REQ_DEV_RESUME

| | |
|---|---|
| Overview: | This is a request to resume the operation with the device. |
| | Recipients of this event may process it synchronously or |
| | asynchronously. |
| | In the later case they have to issue the same event with |
| | CMEVT_A_COMPLETED attribute set. |
| Description: | Request to resume the device |
| Event Bus | EVENT (B_EV_LEC) |
| Definition: | |
| | cmstat cplt_s; // completion status |

// (asynchronous completion)

| | | |
|---|---|---|
| | END_EVENT | |
| Data: | cplt_s | Completion status |
| | attr | CMEVT_A_ASYNC_CPLT - if |
| | | asynchronous completion is allowed |
| | | CMEVT_A_COMPLETED - if the event |
| | | is a completion event. |
| Return | CMST_PENDING | callee assumes responsibility to |
| Status: | | complete the request later (either |
| | | directly or by sending back the same |
| | | event with CMEVT_A_COMPLETED |
| | | set) |

| | |
|---|---|
| Remarks | This event is defined in e_lfc_ex.h. |

EV_LFC_NFY_DEV_REMOVED

| | |
|---|---|
| Overview: | This is a post-notification that the device has been |
| | removed. Recipients of this event may process it only |
| | synchronously. |
| | In no event recipients of this event can access the |
| | hardware device - at the time this event is sent, the |
| | hardware device may have been unplugged. |
| Description: | Notification that the device has been removed. |
| Event Bus | EVENT (B_EV_LFC) |
| Definition: | |
| | cmstat cplt_s; // completion status |

// (asynchronous completion)

| | |
|---|---|
| | END_EVENT |
| Remarks | This event is defined in e_lfc_ex.h. |
| | This event is a notification and cannot be completed |
| | asynchronously. |

EV_REQ_IRP

| Overview: | This event indicates that an IRP (I/O request packet) needs | |
|---|---|---|
| | processing. Recipients of this event may process it | |
| | synchronously or asynchronously. In the later case they | |
| | have to issue the same event with | |
| | CMEVT_A_COMPLETED attribute set. | |
| Description: | Process the I/O request | |
| Event Bus | EVENTX (B_EV_IRP, EV_REQ_IRP, CMEVT_A_NONE, | |
| Definition: | CMEVT_UNGUARDED) | |
| | dword devid ; // instance ID | |
| | void *irpp ; // pointer to IRP | |
| | cmstat cplt_s; // completion status | |
| | END_EVENTX | |
| Data: | devid | ID of the instance that should process |
| | | the request |
| | irpp | pointer to IRP (NT I/O request packet) |
| Return | CMST_PENDING | callee assumes responsibility to |
| Status: | | complete the request later (either |
| | | directly or by sending back an |
| | | EV_REQ_IRP event with |
| | | CMEVT_A_COMPLETED set) |

| | |
|---|---|
| Remarks: | The value of devid is implementation-specific. |
| | This event is defined in e_irp.h. |

EV_KBD_EVENT

| Overview: | This event is sent when keyboard data is present either | |
|---|---|---|
| | from the user pressing a key or another part emulating | |
| | keystrokes. | |
| Description: | Notifies that the specified keyboard event has occurred. | |
| Event Bus | EVENTX (B_EV_KBD, EV_KBD_EVENT, | |
| Definition: | CMEVT_A_SELF_CONTAINED \| CMEVT_A_SYNC, | |
| | CMEVT_UNGUARDED) | |
| | uint16 data; | // keyboard event data (raw data |
| | | // or shift state) |
| | uint16 flags; | // KBD_F_xxx |

uint32 time_delta; // time since the previous event

// (msec)

uint32 dev_data[4]; // originator-specific data, do

// not modify

| | END_EVENTX | | |
|---|---|---|---|
| Data: | attr | event attributes - CMEVT_A_CONST | |
| | | and/or KBD_A_DEVICE_KBD (indicates | |
| | | event is generated by actual device) | |
| | data | keyboard data (device-specific) | |
| | flags | keyboard flags, may be one or more of | |
| | | the following: | |
| | | KBD_F_BR | indicates that the event |
| | | EAK | is a “key release” event |
| | | KBD_F_E0 | 0xe0 prefix was sent |
| | | | with key (AT-keyboard |
| | | | specific and may be |
| | | | ignored if not needed) |
| | | KBD_F_E1 | 0xe1 prefix was sent |
| | | | with key (AT-keyboard |
| | | | specific and may be |
| | | | ignored if not needed) |

| | | |
|---|---|---|
| | time_delta | time [in msec] since the previous |
| | | event. If there was no previous event |
| | | or the time since the previous event |
| | | exceeds the size of a 32-bit integer, |
| | | time_delta is set to oxffffffff. This |
| | | field is optional and not all event |
| | | sources have to support it. |
| | dev_data[] | originator context data. must be |
| | | preserved by recipients of this event. |
| | | Event filters that process |
| | | EV_KBD_EVENTs should pass this |
| | | data on unchanged. |
| Return | CMST_OK | event was processed successfully |
| Status: | | |
| | CMST_NOT_SUP | the recipient does not support new |
| | PORTED | event insertion (may be returned if |
| | | KBD_A_DEVICE_EVT attribute is not |
| | | set) |
| | (other) | other (valchk/fatal) errors may be |
| | | returned if receiver cannot process |
| | | event |

| | |
|---|---|
| Remarks: | if a “fake” keyboard event is initiated by a non-keyboard |
| | part, it should set the dev_data[] fields to 0. The “fake” |
| | event is recognized by the KBD_A_DEVICE_EVT flag in |
| | the attr field - it is 0 for such events and 1 for actual |
| | device events. Support for “fake” events may be limited |
| | by operating system (or other) restrictions. |

EV_KBD_STATE_NFY

| Overview: | This event is sent when the state of the shift, control, alt | | |
|---|---|---|---|
| | or lock (scroll, num and caps) keys of the keyboard has | | |
| | changed. | | |
| Description: | Notifies that the keyboards shift keys are in the specified | | |
| | state. | | |
| Event Bus | EVENTX (B_EV_KBD, EV_KBD_EVENT, | | |
| Definition: | CMEVT_A_SELF_CONTAINED\|CMEVT_A_{—} | | |
| | SYNC, CMEVT_UNGUARDED) | | |
| | uint16 | data; | // keyboard event data (raw data |

// or shift state)

| | | |
|---|---|---|
| uint16 | flags; | // KBD_F_xxx |
| uint32 | time_delta; | // time since the previous event |

// (msec)

| | | |
|---|---|---|
| uint32 | dev_data[4]; | // originator-specific data, do |

| | | // not modify | |
|---|---|---|---|
| | END_EVENTX | | |
| Data: | attr | event attributes - CMEVT_A_CONST | |
| | | and/or KBD_A_DEVICE_KBD (indicates | |
| | | event is generated by actual device) | |
| | data | bit flag specifying current shift and | |
| | | lock state, may be one or more of the | |
| | | following: | |
| | | KBD_SF_RSHIFT | Right shift pressed |
| | | KBD_SF_LSHIFT | Left shift pressed |
| | | KBD_SF_CTRL | Control pressed |
| | | KBD_SF_ALT | Alt pressed |
| | | KBD_SF_SCROLL | Scroll lock on |
| | | KBD_SF_NUM | Num lock on |
| | | KBD_SF_CAPS | Caps lock on |

| | |
|---|---|
| flags | bit mask specifying which of the bits |
| | in data are valid (if a bit is ′O′ in flags, |
| | the corresponding bit in data should |
| | be ignored) |

EV_KBD_GET_STATE

| Overview: | This event is sent to find out the current state of the shift, | | |
|---|---|---|---|
| | control, alt and lock state (scroll, num and caps) of the | | |
| | keyboard. | | |
| Description: | Request current shift and lock state. | | |
| Event Bus | EVENTX (B_EV_KBD, EV_KBD_EVENT, | | |
| Definition: | CMEVT_A_SELF_CONTAINED\|CMEVT_A_{—} | | |
| | SYNC, CMEVT_UNGUARDED) | | |
| | uint16 | data; | // keyboard event data (raw data |

// or shift state)

| | | |
|---|---|---|
| uint16 | flags; | // KBD_F_xxx |
| uint32 | time_delta; | // time since the previous event |

// (msec)

| | | |
|---|---|---|
| uint32 | dev_data[4]; | // originator-specific data, do |

| | | // not modify | |
|---|---|---|---|
| | | END_EVENTX | |
| Data: | data | bit flag specifying current shift and | |
| | | lock state, may be one or more of the | |
| | | following: | |
| | | KBD_SF_RSHIFT | Right shift pressed |
| | | KBD_SF_LSHIFT | Left shift pressed |
| | | KBD_SF_CTRL | Control pressed |
| | | KBD_SF_ALT | Alt pressed |
| | | KBD_SF_SCROLL | Scroll lock on |
| | | KBD_SF_NUM | Num lock on |
| | | KBD_SF_CAPS | Caps lock on |

| | flags | bit mask specifying which of the bits |
|---|---|---|
| | | in data are valid (if a bit is ′O′ in flags, |
| | | the corresponding bit in data should |
| | | be ignored) |
| Return | CMST_{—} | event was processed successfully |
| | OK | |
| Status: | | |
| | CMST_{—} | the recipient does not support the |
| | NOT_{—} | request |
| | SUPPORTED | |
| | (other) | other (valchk/fatal) errors may be |
| | | returned |

Device I/O Events—Notes

The following notes apply to all the device I/O events defined below:

1. The term ‘object’ is used below to refer to the entity on which the I/O operations are performed. This can be a file, a device, a pipe or any similar entity.

2. The dev_id field in the B_EV_DIO bus can be used to identify the instance that should handle the operation. The use of this field is optional. It is intended as storage for a part or connection ID in one-to-many connections. Its use is not explicitly defined here.

3. The dev_h field in the B_EV_DIO bus is usually a handle of a device or of a file opened on the device.

4. All EV_DIO_RQ_xxx requests can be completed asynchronously, provided that the originator has set the CMEVT_A_ASYNC_CPLT attribute. To complete a request asynchronously, recipient should perform the following actions:

a) save the event bus pointer

b) return CMST_PENDING

c) if necessary, use the event bus during processing (the event bus is exclusively available to the part that is processing the request)

d) when request is completed, use the saved bus pointer and

fill in the completion status (cplt_s)

fill in all fields specified as “out” for the request

set the CMEVT_A_COMPLETED attribute (all other fields, esp. ctx, must be preserved)

send the completion event (typically out the terminal through which the request was received).

If the CMEVT_A_ASYNC_CPLT attribute is not set, the request must be completed synchronously.

5. The ctx field is used by the request originator to store its context. This value is not to be interpreted or modified by any part that processes the event, unless the originator has set the DIO_A_NT_IRP attribute to indicate that ctx contains a pointer to a NT driver IRP (I/O request packet) associated with the event. The DIO_A_NT_IRP attribute shall be clear if ctx does not contain pointer to a valid IRP.

6. (Note specific to Windows NT kernel mode and WDM environments) If ctx contains pointer to NT driver IRP, the rules for intermediate drivers apply to the processors of the EV_DIO_RQ_xxx request: they can use the next and lower stack locations. In no case the IRP should be completed. If the IRP's next stack location is used to call a lower-level driver in the device's stack, the caller must set a completion routine and prevent full completion of the IRP—the request should be completed according to note #4 above.

7. The DIO_A_UNICODE attribute can be set on EV_DIO_RQ_OPEN to indicate that the object name pointed by buf_p is a unicode string. Note that in Windows NT kernel mode and WDM environments, the string may not be zero-terminated; the length is always correctly specified in buf_len (in bytes, excluding any zero terminator). If the DIO_A_UNICODE attribute is not set, buf_p on EV_DIO_RQ_OPEN is either NULL or points to a valid 0-terminated ASCII string. If buf_p is NULL, DIO_A_UNICODE should not be set.

EV_DIO_RQ_OPEN

| Overview: | This event is used to open a specific device driver or file. | | |
|---|---|---|---|
| | The entity being opened is identified by a path specified | | |
| | with the event. The format of the path is defined by the | | |
| | operating system. | | |
| Description: | Open a device or file object. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification |
| | | see note #2 above) |
| | buf_p | name of object to open (may be |
| | | NULL) (see note #7) |
| | buf_len | length of data pointed to by ′buf_p′ |
| | | (without the terminating O), |
| | | [bytes] |
| | buf_h | device handle to pass on |
| | | subsequent operations (out) |
| Return | CMST_NOT_ | specified object not found |
| Status: | FOUND | |
| | CMST_ACCESS_ | object already open (if multiple |
| | DENIED | opens are not supported) |

| | |
|---|---|
| Remarks: | Named object support and the naming conventions are |
| | outside the scope of this interface. If DIO_A_UNICODE |
| | is specified, buf_p is to be interpreted as WCHAR * and |
| | the string may not be O-terminated. |

EV_DIO_RQ_CLEANUP

| Overview: | This request is sent to cancel all pending operations on a | | |
|---|---|---|---|
| | specific device driver and to prepare it for closing. | | |
| Description: | Cancel all pending operations, prepare for close. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see note |
| | | #2 above) |
| | dev_h | device handle from ′open′ |
| Return | CMST_ | object is not open |
| | NOT_OPEN | |
| Status: | | |

| | |
|---|---|
| Remarks: | No operations except ′close′ should be called after |
| | ′cleanup′. |

EV_DIO_RQ_CLOSE

| Overview: | This request is sent to close a specific deivce driver or file. | | |
|---|---|---|---|
| Description: | Close a device object. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originators context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see note |
| | | #2 above) |
| | dev_h | device handle from ′open′ |
| Return | CMST_ | object is not open |
| | NOT_OPEN | |
| Status: | CMST_IOERR | I/O error (object is closed anyway) |

EV_DIO_RQ_READ

| Overview: | This request is sent to read data from a specific device | | |
|---|---|---|---|
| | driver or file. | | |
| Description: | Read data from device. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see note |
| | | #2 above) |
| | dev_h | device handle from ′open′ |
| | offs | file offset (for block devices) |
| | buf_p | buffer pointer |
| | buf_sz | size of buffer, bytes |
| | buf_len | number of bytes read (out) |
| | *buf_p | data read (out) |
| Return | CMST_ | object is not open |
| | NOT_OPEN | |
| Status: | CMST_IOERR | I/O error |

| | |
|---|---|
| Remarks: | Reading at end of a stream is usually not considered an |
| | error; in this case the request is completed with buf_len 0 |
| | (or any value less than buf_sz). |

EV_DIO_RQ_WRITE

| Overview: | This request is sent to write data to a specific device | | |
|---|---|---|---|
| | driver or file. | | |
| Description: | Write data to device. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see |
| | | note #2 above) |
| | dev_h | device handle from ′open′ |
| | offs | file offset (for block devices) |
| | buf_p | pointer to data to be written |
| | buf_sz | number of bytes to write |
| | buf_len | number of bytes written (out) |
| Return | CMST_ | object is not open |
| | NOT_OPEN | |
| Status: | CMST_IOERR | I/O error |
| | CMST_FULL | media full (for block devices only) |

EV_DIO_RQ_IOCTL

| Overview: | This request is sent to execute a specific operation on a | | |
|---|---|---|---|
| | device driver. The operation is defined by the driver. This | | |
| | type of I/O control can be sent to a driver by another | | |
| | driver or an application (user-mode). | | |
| Description: | Execute an I/O control operation on a device. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | : // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see note |
| | | #2 above) |
| | dev_h | device handle from ′open′ |
| | func | I/O control function code |
| | buf_p | pointer to input data and buffer for |
| | | output data |
| | buf_sz | size of output buffer, bytes |
| | buf_len | length of input and output data in |
| | | bytes |
| Return | CMST_ | object is not open |
| | NOT_OPEN | |
| Status: | CMST_IOERR | I/O error |
| | CMST_NOT_{—} | the specified I/O control code is not |
| | SUPPORTED | supported |

| | |
|---|---|
| Remarks: | The definition of the I/O control operations is outside the |
| | scope of this definition. |

EV_DIO_RQ_INTERNAL_IOCTL

| Overview: | This request is sent to execute a specific internal operation | | |
|---|---|---|---|
| | on a device driver. The operation is defined by the driver. | | |
| | This type of I/O control can only be sent to a driver from | | |
| | another driver, not by an application (user-mode). | | |
| Description: | Execute an internal I/O control operation on a device. | | |
| Event Bus | EVENT (B_EV_DIO) | | |
| Definition: | | | |
| | cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see note |
| | | #2 above) |
| | dev_h | device handle from ′open′ |
| | func | internal I/O control function code |
| | buf_p | pointer to input data and buffer for |
| | | output data |
| | buf_sz | size of output buffer, bytes |
| | buf_len | length of input and output data in |
| | | bytes |
| Return | CMST_ | object is not open |
| | NOT_OPEN | |
| Status | CMST_IOERR | I/O error |
| | CMST_NOT_ | the specified I/O control code is not |
| | SUPPORTED | supported |

| | |
|---|---|
| Remarks: | The definition of the I/O control operations is outside the |
| | scope of this definition. |
| | ″internal IOCTL″ is a Windows NT driver term. Device |
| | IOCTL's can be submitted to drivers by an application or |
| | by another driver. Internal IOCTL's can be submitted only |
| | by other drivers. The main implication is that, for internal |
| | IOCTL's, the buffers are always mapped properly in |
| | system address space (i.e., the buffer pointed by buf_p is |
| | accessible in arbitrary thread context). |

EV_USBCTL_REQ

| Overview: | This event is used to send vender or class-specific | | |
|---|---|---|---|
| | command requests to a USB device. | | |
| | This request can complete synchronously or | | |
| | asynchronously. | | |
| | This event should never be sent with the | | |
| | CMEVT_A_SELF_OWNED attribute set. | | |
| Description: | Send a vendor or class-specific command to a USB device. | | |
| Event Bus | EVENTX (B_EV_USB_CTLREQ, | | |
| Definition: | EV_USBCTL_REQ, | | |
| | CMEVT_A_SELF_CONTAINED, | | |
| | CMEVT_UNGUARDED) | | |
| | cmstat | cplt_s | ; // completion status |
| | uint32 | func | ; // request type |
| | | | // (USB_REQ_xxx) |
| | uint32 | n_resv_bits | ; // additional function bits |
| | | | // (not used - must be 0) |
| | uint32 | code | ; // Specifies the USB or |
| | | | // vendor-defined request |
| | | | // code for the device |
| | uint32 | value | ; // Is a value, specific to |
| | | | // Request, that becomes |
| | | | // part of the USB-defined |
| | | | // setup packet for the |
| | | | // device |
| | uint32 | index | ; // Specifies the device- |
| | | | // defined identifier for |
| | | | // the request |
| | uint32 | data_len | ; // length of the data in the |
| | | | // buffer |
| | uint32 | data_sz | ; // data buffer size |
| | byte | data[1] | ; // data buffer |

| | END_EVENTX | |
|---|---|---|
| In: | attr | USB_A_XFER_TO_xxx specifies |
| | | the control request direction |
| | func | function number (must be one of |
| | | URB_FUNCTION_VENDOR_xxx or |
| | | URB_FUNCTION_CLASS_xxx) |
| | code | Specifies the USB or vendor-defined |
| | | request code for the device |
| | value | specific to code value |
| | index | specifies the device-defined identifier |
| | | for the request |
| | data_len | length of the data in the buffer (only |
| | | for USB_A_XFER_ |
| | | TO_DEVICE requests) |
| | data_sz | data buffer size |
| | data | data buffer variable size |
| Out: | cplt_s | completion status |
| | len | data_len |
| | data | returned from USB_A_XFER_TO_ |
| | | HOST requests data |
| Return | CMST_ | callee assumes responsibility to |
| Status: | PENDING | complete the request later (either |
| | | directly or by sending back an |
| | | EV_USBCTL_REQ event) |

EV_USB_ENABLE

| | |
|---|---|
| Overview: | This event is sent to enable the isochronous USB stream. |
| | This request can complete synchronously or |
| | asynchronously. |
| | This event should never be sent with the |
| | CMEVT_A_SELF_OWNED attribute set. |
| Description: | Enable isochronous USB stream. |
| Event Bus | EVENTX (B_EV_USBCTL, |
| Definition: | EV_USB_ENABLE, |
| | CMEVT_A_ASYNC_CPLT \| |
| | CMEVT_A_SELF_CONTAINED \| |
| | CMEVT_A_SYNC, CMEVT_UNGUARDED) |

cmstat cplt_s ; // completion status
uint32 frame_no ; // isochronous frame number

to

// start from

bool32 asap ; // TRUE - start ASAP.FALSE

-

// use 0.frame_no to start from

uint32 cfg_no ; // configuration number. Not

// used.

// (must be −1 undefined)

END_EVENTX

| | | |
|---|---|---|
| In: | frame_no | isochronous frame number to start |
| | | from. (only if asap is FALSE) |
| | asap | TRUE - enable ASAP, ignoring the |
| | | frame_number. |
| Out: | cplt_s | enable completion status |
| Return | CMST_PENDING | callee assumes responsibility to |
| Status: | | complete the request later (either |
| | | directly or by sending back an |
| | | EV_USB_ENABLE event) |

EV_USB_DISABLE

| Overview: | This event is sent to disable the isochronous USB stream. | |
|---|---|---|
| | This request can complete synchronously or | |
| | asynchronously. | |
| | This event should never be sent with the | |
| | CMEVT_A_SELF_OWNED attribute set. | |
| Description: | Disable isochronous USB stream. | |
| Event Bus | EVENTX (B_EV_USBCTL, | |
| Definition: | EV_USB_DISABLE, | |
| | CMEVT_A_ASYNC_CPLT \| | |
| | CMEVT_A_SELF_CONTAINED \| | |
| | CMEVT_A_SYNC, CMEVT_UNGUARDED) | |
| | cmstat cplt_s ; // completion status | |
| | uint32 frame_no ; // isochronous frame number | |
| | to | |
| | // start from | |
| | bool32 asap ; // TRUE - start ASAP.FALSE | |
| | - | |
| | // use 0.frame_no to start from | |
| | uint32 cfg_no ; // configuration number. Not | |
| | // used. | |
| | // (must be −1 undefined) | |
| | END_EVENTX | |
| In: | void | |
| Out: | cplt_s | disable completion status |
| Return | CMST_PENDING | callee assumes responsibility to |
| Status: | | complete the request later (either |
| | | directly or by sending back an |
| | | EV_USB_DISABLE event) |

EV_STM_DATA

| Overview: | This event is sent to submit an isochronous USB data | |
|---|---|---|
| | frame. | |
| | This request can complete synchronously or | |
| | asynchronously. | |
| | This event should never be sent with the | |
| | CMEVT_A_SELF_OWNED attribute set. | |
| Description: | Submit an isochronous USB data frame. | |
| Event Bus | EVENTX (B_EV_STM_DATA, | |
| Definition: | EV_STM_DATA, | |
| | CMEVT_A_ASYNC_CPLT \| | |
| | CMEVT_A_SELF_CONTAINED \| | |
| | CMEVT_A_SYNC, | |
| | CMEVT_UNGUARDED) | |
| | cmstat cplt_s ; // data completion status | |
| | uint32 frame_no ; // current isochronous frame | |
| | // number | |
| | uint32 data_len ; // data length | |
| | uint32 data_sz ; // data buffer size | |
| | _ctx owner_ctx; // owner context | |
| | byte data[1] ; // data buffer (variable size) | |
| | END_EVENTX | |
| In: | frame_no | current isochronous frame number |
| | owner_ctx | owner context |
| | data_len | data length |
| | data_sz | data buffer size |
| | data | submitted out data |
| | data | data buffer (variable size) |
| Out: | cplt_s | current status |
| | owner_ctx | owner context (caller supplied) |
| Return | CMST_PENDING | callee assumes responsibility to |
| Status: | | complete the request later (either |
| | | directly or by sending back an |
| | | EV_USB_DISABLE event) |

EV_VXD_INIT

| | |
|---|---|
| Overview: | This packaging event is used to signal that the virtual |
| | device was loaded by the system and can perform its |
| | initialization tasks. |
| Description: | Initialize virtual device |
| Event Bus | EVENT ( B_EV_VXD ) |
| Definition: | dword msg; // control message (value of EAX |
| | register) |
| | dword ebx; // value of EBX register |
| | dword ecx; // value of ECX register |
| | dword edx; // value of EDX register |
| | dword esi; // value of ESI register |
| | dword edi; // value of EDI register |
| | dword retval; // value to return |

// (also affects carry flag)

| | | |
|---|---|---|
| | END_EVENT | |
| Data: | void | |
| Return | CMST_OK | initialized OK |
| Status: | | |
| | any other | initialization failed |

| | |
|---|---|
| Remarks: | This event is issued at thread time, before |
| | SYS_DYNAMIC_DEVICE_INIT |
| | (for dynamic VxDs) or DEVICE_INIT (for static VxDs). |
| | Some EV_VXD_MESSAGE events may be sent before |
| | this event. |
| See Also: | EV_VXD_CLEANUP |

EV_VXD_CLEANUP

| | |
|---|---|
| Overview: | This packaging event is used to signal that the virtual |
| | device is about to be unloaded by the system and should |
| | perform its cleanup tasks. |
| Description: | Cleanup virtual device |
| Event Bus | EVENT ( B_EV_VXD ) |
| Definition: | dword msg; // control message (value of EAX |
| | register) |
| | dword ebx; // value of EBX register |
| | dword ecx; // value of ECX register |
| | dword edx; // value of EDX register |
| | dword esi; // value of ESI register |
| | dword edi; // value of EDI register |
| | dword retval; // value to return |

// (also affects carry flag)

| | | |
|---|---|---|
| | END_EVENT | |
| Data: | void | |
| Return | CMST_OK | cleanup completed, OK to unload |
| Status: | | |
| | any other | cleanup failed - don't unload |

| | |
|---|---|
| Remarks: | This event is issued at thread time, after the |
| | SYS_DYNAMIC_DEVICE_EXIT. It is not sent for |
| | static VxDs. |
| See Also: | EV_VXD_INIT |

EV_VXD_MESSAGE

| | |
|---|---|
| Overview: | This packaging event is used to distribute raw VxD |
| | messages as they are sent by the system. |
| Description: | Raw message needs processing |
| Event Bus | EVENT ( B_EV_VXD ) |
| Definition: | dword msg; // control message (value of EAX |
| | register) |
| | dword ebx; // value of EBX register |
| | dword ecx; // value of ECX register |
| | dword edx; // value of EDX register |
| | dword esi; // value of ESI register. |
| | dword edi; // value of EDI register |
| | dword retval; // value to return |

// (also affects carry flag)

| | | |
|---|---|---|
| | END_EVENT | |
| Data: | void | |
| Return | <see Remarks> | cleanup completed, OK to unload |
| Status: | | |

| | |
|---|---|
| Remarks: | This event may come in any context, including on |
| | disabled interrupts. |
| | Upon return, the status and retval are interpreted the |
| | following way: |

```
for all control messages except
  PNP_NEW_DEVNODE and
  W32_DEVICEIOCONTROL:
If returned status is not CMST_OK: EAX is
  set to 0, carry set
If returned status is CMST_OK, EAX is set
  to retval and
If retval is non-zero (VXD_SUCCESS), carry
  is cleared
If retval is zero (VXD_FAILURE), carry is
  set to indicate error
for the PNP_NEW_DEVNODE and
  W32_DEVICEIOCONTROL control
  messages
If returned status is not CMST_OK: EAX is
  set to −1, carry set
If returned status is CMST_OK, EAX is set
  to retval and
If retval is zero
  (CR_SUCCESS/DEVIOCTL_NOERROR),
  carry clear
If retval is non-zero, carry is set to indicate
  error
```

```
Note that, on W32_DEVICEIOCONTROL, retval has
the following meanings:
    0 - success
    −1 - operation accepted for asynchronous
processing
    any other - error
```

EV_DRV_INIT

| Overview: | This packaging event is used to signal that the driver was | |
|---|---|---|
| | loaded by the system and can perform its initialization | |
| | tasks. | |
| Description: | Initialize driver | |
| Event Bus | EVENT (B_EV_DRV) | |
| Definition: | NTSTATUS ns; | |
| | END_EVENT | |
| Data: | ns | status that DriverEntry will return on |
| | | failure |
| Return | CMST_OK | initialized OK |
| Status: | | |
| | any other | initialization failed |

| | |
|---|---|
| Remarks: | This event is issued at thread time, IRQ level passive |
| | The value returned from DriverEntry is determined as |
| | follows: |

if event returned CMST_OK, DriverEntry

returns STATUS_SUCCESS, regardless
of ns

if event returned CMST_FAILED,

DriverEntry returns ns (unless ns is
STATUS_SUCCESS, in which case
DriverEntry returns
STATUS_UNSUCCESSFUL)

if event returned any other status,

DriverEntry returns
STATUS_UNSUCCESSFUL.

| | |
|---|---|
| See Also: | EV_DRV_CLEANUP |

EV_DRV_CLEANUP

| Overview: | This packaging event is used to signal that the driver is | |
|---|---|---|
| | about to be unloaded by the system and should perform | |
| | its cleanup tasks. | |
| Description: | Cleanup driver | |
| Event Bus | EVENT (B_EV_DRV) | |
| Definition: | NTSTATUS ns; | |
| | END_EVENT | |
| Data: | void | |
| Return | CMST_OK | cleanup OK |
| Status: | | |
| | any other | cleanup failed |

| | |
|---|---|
| Remarks: | This event is issued at thread time, IRQ level passive |
| | Regardless of the returned status, the driver will be |
| | unloaded. |
| See Also: | EV_DRV_INIT |

Appendix 3. RDX_CNM_DESC Structure

The connection descriptor comprises a header structure, RDX_CNM_DESC and an array (table) of RDX_CNM_ENTRY structures. When a descriptor is filled in, the tblp field of RDX_CNM_DESC is set to point to the array of the RDX_CNM_ENTRY structures.

typedef struct RDX_CNM_DESC

| { | | |
|---|---|---|
| dword | sig; | // signature |
| uint16 | sz; | // size of the header |
| uint16 | esz; | // size of a single entry |
| uint16 | n_entries; // # of entries in the table | |
| flg16 | attr; | // table attributes [defined w/table] |
| const void | *tblp; | // table of entries or NULL if none |

} RDX_CNM_DESC;
// attributes

| | |
|---|---|
| #define RDX_CNM_A_NONE | 0 |
| // entry types | |
| #define RDX_CNM_E_NONE | 0 // not initialized |
| #define RDX_CNM_E_SIMP | 1 // connection entry |
| // connection table entry | |
| typedef struct RDX_CNM_ENTRYtag | |

| | | |
|---|---|---|
| { | | |
| WORD | et; | // entry type |
| DWORD | et_ctx; | // entry type context |
| char | *lnamep; | // left part name |
| char | *ltermp; | // left terminal name |
| char | *rnamep; | // right part name |
| char | *rtermp; | // right terminal name |
| DWORD | attr; | // attributes [RDX_CNM_A_xxx] |
| DWORD | ctx; | // attribute dependent context |
| DWORD | usr_ctx; | // user context |

} RDX_CNM_ENTRY;

Appendix 4. I_R_ECON Interface

| | |
|---|---|
| /* ----------------------------------------------------------- | */ |

| | | |
|---|---|---|
| /* | RFC: Radix Interface | */ |

| | |
|---|---|
| /* | */ |

| | | |
|---|---|---|
| /* | I_R_ECON.H - RMC Connection Enumeration Interface | */ |

| | |
|---|---|
| /* ----------------------------------------------------------- | */ |

| | |
|---|---|
| /* Version 1.00 | */ |

| /* ----------------------------------------------------------- | */ |
|---|---|
| /* Copyright (c) 1998 Object Dynamics Corp. All Rights Reserved. */ | |
| /* | */ |

/* Use of copyright notice does not imply publication or disclosure. */
/* THIS SOFTWARE CONTAINS CONFIDENTIAL AND

| | |
|---|---|
| PROPRIETARY INFORMATION | */ |

/* CONSTITUTING VALUABLE TRADE SECRETS OF OBJECT

| | |
|---|---|
| DYNAMICS CORP., AND | */ |

/* MAY NOT BE (a) DISCLOSED TO THIRD PARTIES,

| | |
|---|---|
| (b) COPIED IN ANY FORM, | */ |

/* OR (c) USED FOR ANY PURPOSE EXCEPT AS

| | |
|---|---|
| SPECIFICALLY PERMITTED IN | */ |

| | |
|---|---|
| /* WRITING BY OBJECT DYNAMICS CORP. | */ |

| | |
|---|---|
| /* ----------------------------------------------------------- | */ |

| #ifndef _I_R_ECON_H_DEFINED_{—} | |
|---|---|
| #define _I_R_ECON_H_DEFINED_{—} | |
| /* --- Connection Enumeration Definitions --------------------------- */ | |
| // contract id | |
| #define CID_R_ECON 0x570 | |
| // connection bus | |
| BUS (B_R_ECON) | |
| RDX_CNM_DESC | *cdscp ; // connection list descriptor |

| | |
|---|---|
| char | *part_nmp ; // part name |
| char | *term_nmp ; // terminal name |
| _ctx | qry_ctx ; // query context |
| _hdl | conn_h ; // connection handle |
| char | *part_bufp ; // pointer to part name buffer |
| uint | part_buf_sz ; // part name buffer size |
| char | *term_bufp ; // pointer to terminal name buffer |
| uint | term_buf_sz ; // terminal name buffer size |
| char | *part2_bufp ; // pointer to part #2 name buffer |
| uint | part2_buf_sz ; // part name #2 buffer size |
| char | *term2_bufp ; // pointer to terminal #2 name buffer |
| uint | term2_buf_sz ; // terminal name #2 buffer size |
| bool | split_loops ; // TRUE to split loop connections |

END_BUS
/* --- Connection Enumeration Vtable Interface ---------------------- */
DECLARE_INTERFACE (I_R_ECON)

| | |
|---|---|
| operation (qry_open | , B_R_ECON) |
| operation (qry_reset | , B_R_ECON) |
| operation (qry_next | , B_R_ECON) |
| operation (qry_prev | , B_R_ECON) |
| operation (qry_curr | , B_R_ECON) |
| operation (qry_close | , B_R_ECON) |
| operation (get_info | , B_R_ECON) |

| END_DECLARE_INTERFACE // I_R_ECON | |
|---|---|
| /* --- Description Of Connection Enumeration Interface ------------ */ | |
| // on : qry_open | |
| // in : cdscp - connection list descriptor | |
| // | part_nmp - part name to be matched |
| // | term_nmp - terminal name to be matched |
| // | split_loops - TRUE to present loops as two connections |

// out : qry_ctx - query context for subsequent qry_xxx operations
// act : open a new query on the connection namespace
// s : ST_NO_ROOM - too many open queries
// on : qry_reset

Write

| | | |
|---|---|---|
| Description: | Write data | |
| In: | id | Device instance identification (see |
| | | note #4 in the overview) |
| | attr | Attributes, can be any one of the |
| | | following: |

| | |
|---|---|
| DIO_{—} | “preview” |
| A_PREVIEW | operation |
| DIO_A_{—} | operation may |
| ASYNC_CPLT | complete |
| | asynchronously |

| | |
|---|---|
| buf_mapping | Buffering attributes, can be one of the |
| | following: |

| | |
|---|---|
| DIO_MAP_{—} | buffering is |
| BUFFERED | handled by |
| | caller, p is |
| | a valid |
| | virtual |
| | memory |
| | address |
| DIO_MAP_{—} | no buffering, |
| DIRECT | p value is |
| | system- |
| | dependent |

| | p | Pointer to data to be written |
|---|---|---|
| | sz | Number of bytes to write |
| | ofs | File offset (for block devices) |
| | h | Handle from open |
| | irpp | See complete operation |
| Out: | len | Number of bytes written |
| Return | CMST_OK | The operation was successful. |
| Status: | | |
| | CMST_NOT_{—} | Object is not open |
| | OPEN | |
| | CMST_IOERR | I/O error |
| | CMST_FULL | Media full (for block devices only) |
| | CMST_{—} | See notes for complete operation |
| | PENDING | |
| | Example: | B_DIO bus; |
| | | // open device |
| | | memset (&bus, 0, sizeof (bus)); |
| | | bus.p = L“MyDevice”; |
| | | bus.len = sizeof (L“MyDevice”); |
| | | s = out (dio, open, &bus); |
| | | if (s != CMST_OK) . . . |
| | | // write to device |
| | | bus.buf_mapping = DIO_BUF_{—} |
| | | DIRECT; |

| | |
|---|---|
| bus.p | = “MyString”; |
| bus.sz | = strlen (“MyString”) + 1; |
| bus.ofs | = 1000; |
| bus.irpp | = &irp; // NT request packet |

s = out (dio, write, &bus);
if (s != CMST_OK) . . .
// cancel any pending operations
out (dio, cleanup, &bus);
// close device
out (dio, close, &bus);

Ioctl

| Description: | Execute the IOCTL operation specified by ioctl. The | |
|---|---|---|
| | definition of IOCTL operations is outside the scope of | |
| | this interface. For more information see the | |
| | Windows NT DDK documentation. | |
| In: | id | Device instance identification (see |
| | | note #4 in the overview) |
| | attr | Attributes, can be any one of the |
| | | following: |

| | |
|---|---|
| DIO_A_{—} | “preview” |
| PREVIEW | operation |
| DIO_A_ASYNC_{—} | operation |
| CPLT | may |
| | complete |
| | asynch- |
| | ronously |

| | |
|---|---|
| buf_mapping | Buffering attributes, can be one of |
| | the following: |

| | |
|---|---|
| DIO_MAP_{—} | buffering is |
| BUFFERED | handled by caller, |
| | p is a valid |
| | virtual memory |
| | address |
| DIO_MAP_{—} | no buffering, |
| DIRECT | p value is |
| | system-dependent |

| | p | Pointer to input data and buffer for |
|---|---|---|
| | | output data |
| | sz | Size of output buffer |
| | len | Length of input data |
| | ioctl | IOCTL function code |
| | h | Handle from open |
| | irpp | See complete operation |
| Out: | len | Length of output data (never more |
| | | than sz) |
| | *p | Output data (depending on function |
| | | code ioctl) |
| Return | CMST_OK | The operation was successful. |
| Status: | | |
| | CMST_NOT_{—} | Object is not open |
| | OPEN | |
| | CMST_IOERR | I/O error |
| | CMST_PENDING | See notes for complete operation |
| | CMST_NOT_{—} | The specified IOCTL code is not |
| | SUPPORTED | implemented |

| Example: | B_DIO bus; | |
|---|---|---|
| | char buffer [256]; | |
| | // open device | |
| | memset (&bus, 0, sizeof (bus)); | |
| | bus.p = L“MyDevice”; | |
| | bus.len = sizeof (L“MyDevice”); | |
| | s = out (dio, open, &bus); | |
| | if (s != CMST_OK) . . . | |
| | // write to device | |
| | strcpy (buffer, “MyData”); | |
| | bus.buf_mapping = DIO_BUF_DIRECT; | |
| | bus.p | = buffer; |
| | bus.sz | = sizeof (buffer); |
| | bus.len | = strlen (buffer) + 1; |
| | bus.ioctl | = |
| | | IOCTL_SMARTCARD_GET_{—} |
| | | ATTRIBUTE; |
| | bus.irpp | = &irp; // NT request packet |

s = out (dio, write, &bus);
if (s != CMST_OK) . . .
// cancel any pending operations
out (dio, cleanup, &bus);
// close device
out (dio, close, &bus);

Complete

| Description: | Report completion of an operation | |
|---|---|---|
| In: | h | Handle to pass to subsequent |
| | | operations (when completing open) |
| | len | Length of output data (if applicable, |
| | | see I_DIO above) |
| | other | See the ‘out’ fields for each I_DIO |
| | | operation |
| | irpp | Must be as received with the operation |
| | | being completed |
| | cplt_s | Completion status |
| Out: | void | |
| Return | CMST_OK | The operation was successful. |
| Status: | | |
| | CMST_INVALID | irpp does not correspond to a valid |
| | | pending operation |

| | |
|---|---|
| Example: | B_DIO bus; |
| | char buffer [256]; |
| | // open device |
| | memset (&bus, 0, sizeof (bus)); |
| | bus.p = L“MyDevice”; |
| | bus.len = sizeof (L“MyDevice”); |
| | s = out (dio, open, &bus); |
| | if (s != CMST_OK) . . . |
| | // read from device asynchronously |
| | bus.attr = DIO_A_ASYNC_CPLT; |
| | bus.buf_mapping = DIO_BUF_DIRECT; |
| | bus.p = buffer; |
| | bus.sz = sizeof (buffer); |
| | bus.ofs = 1000; |
| | bus.irpp = &irp; // NT request packet |
| | s = out (dio, read, &bus); |
| | if (s != CMST_OK) . . . |
| | // |
| | OPERATION (dio_c, complete, B_DIO) |
| | { |
| | // this is called when the read operation completes |
| | return (CMST_OK); |
| | } |
| | END_OPERATION |
| Remarks: | This operation is intended to be used in the client-to-server |
| | direction of a bi-directional I_DIO/I_DIO_C terminal. If the |
| | server has to complete any of the I_DIO operations |
| | described above asynchronously it should copy the bus |
| | and return CMST_PENDING. When the operation |
| | completes it fills in the required “out” fields in the bus and |
| | calls through the back channel with the saved copy of the |
| | bus. |

I_IRQ, I_IRQ R—Interrupt Source Interface

Overview

This is an interrupt source interface. It is used for enabling and disabling the event source and for receiving events when an interrupt occurs.

List of Operations

| Name | Description |
|---|---|
| enable | Enable interrupt handling |
| disable | Disable interrupt handling |
| preview | Preview interrupt event at device |
| | IRQL |
| submit | Interrupt event occurred (preview |
| | returned CMST_SUBMIT) |

Operation Bus

BUS (B_IRQ)

uint32 attr; // attributes
_ctx ctx; // context

END_BUS

Notes

1. The enable and disable operations must be invoked only at PASSIVE IRQL

2. The preview operation is always sent at device IRQL (in interrupt context). The operation implementation must be unguarded.

3. The submit operation is always sent at DISPATCH IRQL.

Enable

| Description: | Enable interrupt handling. | |
|---|---|---|
| In: | void | |
| Out: | void | |
| Return | CMST_OK | Interrupt handling is enabled. |
| Status: | | |
| | CMST_NO_ACTI | The interrupt handling is already |
| | ON | enabled. |
| | CMST_REFUSE | Interrupt source cannot be enabled |
| | | manually |
| | CMST_INVALID | Failed to register ISR because of invalid |
| | | properties. |
| | ST_BUSY | The Interrupt is used exscluzivly from |
| | | sombody else |

| | |
|---|---|
| Example: | s = out (irq, enable, NULL); |
| | if (s != CMST_OK) . . . |
| | // enable interrupt generation |
| | // . . . |
| | // disable interrupt generation |
| | s = out (irq, disable, NULL); |
| | if (s != CMST_OK) . . . |
| Remarks: | The enable operation must be invoked only at PASSIVE |
| | IRQL |

Disable

| Description: | Disable interrupt handling | |
|---|---|---|
| In: | void | |
| Out: | void | |
| Return | CMST_OK | The operation was successful. |
| Status: | | |
| | CMST_NO_ACTI | Interrupt event source is not enabled |
| | ON | |
| | CMST_REFUSE | Interrupt event source cannot be |
| | | disabled manually |

| | |
|---|---|
| Example: | See example for enable. |
| Remarks: | The disable operation must be invoked only at PASSIVE |
| | IRQL. Upon successful return, the event source guarantees |
| | that it will not preview or submit unless it is re-enabled. |

Preview

| Description: | Preview an interrupt at device IRQL | |
|---|---|---|
| In: | void | |
| Out: | ctx | context for the subsequent submit |
| | | operation |
| Return | CMST_OK | Interrupt handling completed, no need |
| Status: | | for sending submit operation |
| | CMST_SUBMIT | Interrupt event accepted. Send submit |
| | | operation at lower IRQL |
| | other error | Interrupt not recognized, don't send |
| | status | submit. |
| Example: | None. | |

| | |
|---|---|
| Remarks: | preview operation is always sent at device IRQL (in |
| | interrupt context) |
| | Note that if the interrupt is level-sensitive (as opposed to |
| | edge-sensitive), this operation should clear at least one |
| | reason for the interrupt; if the the device does not |
| | deassert the interrupt, the preview operation will be |
| | invoked again upon return. |

Submit

| Description: | Process interrupt. | |
|---|---|---|
| In: | ctx | context returned from preview |
| Out: | void | |
| Return | CMST_OK | Event accepted. |
| Status: | | |
| Example: | None. | |

| | |
|---|---|
| Remarks: | submit operation is always sent at DISPATCH IRQL |

I_IOP—I/O Port Interface

Overview

This is a generic I/O port interface.

List of Operations

| Name | Description |
|---|---|
| in | Read a byte (8-bits) from the I/O port |
| inw | Read a word (16-bits) from the I/O |
| | port |
| indw | Read a double word (32-bits) from |
| | the I/O port |
| inbuf | read sequence of bytes, words or |
| | double words from the I/O port |
| out | Output a byte (8-bits) to the I/O port |
| outw | Output a word (16-bits) to the I/O |
| | port |
| outdw | Output a dword (32-bits) to the I/O |
| | port |
| outbuf | Output sequence of bytes, words or |
| | double words to the I/O port |

Operation Bus

None

Notes

All operations can be invoked at any interrupt level.

in (CMIFCP (_iface), uint32 offs, byte *bp)

| Description: | Read a byte (8-bits) from the I/O port | |
|---|---|---|
| In: | offs | base relative I/O port offset |
| | bp | pointer to a storage for 8-bit value |
| Out: | *bp | 8-bit value read from the port |
| Return | CMST_OK | operation finished successfully |
| Status: | | |

| | |
|---|---|
| Example: | byte b; |
| | s = outX (io, in) ((_iface * const)top (io), 0, &b); |
| | if (s != CMST_OK) . . . |
| | printf (“byte received 0x%02x\n”, b); |

inw (CMIFCP (_iface), uint32 offs, word *wp)

| Description: | Read a word (16-bits) from the I/O port | |
|---|---|---|
| In: | offs | base relative I/O port offset |
| | wp | pointer to a storage for 16-bit value |
| Out: | *wp | 16-bit value read from the port |
| Return | CMST_OK | operation finished successfully |
| Status: | | |
| Example: | word w; | |

s = outX (io, inw) ((_iface * const)top (io), 0, &w);
if (s != CMST_OK) . . .
printf (“word received 0x%04x\n”, w);

indw (CMIFCP (_iface), uint32 offs, dword *dp)

| Description: | Read a double word (32-bits) from the I/O port | |
|---|---|---|
| In: | offs | base relative I/O port offset |
| | dp | pointer to a storage for 32-bit value |
| Out: | *dp | 32-bit value read from the port |
| Return | CMST_OK | operation finished successfully |
| Status: | | |
| Example: | word dw; | |

s = outX (io, indw) ((_iface * const)top (io), 0, &d);
if (s != CMST_OK) . . .
printf (“dword received 0x%08Ix\n”, d);

inbuf (CMIFCP (_iface),

uint32 offs,
uint32 unit_sz,
uint32 n_units,
void *bufp)

| Description: | read sequence of bytes, words or double words from the | |
|---|---|---|
| | I/O port | |
| In: | offs | base relative I/O port offset |
| | unit_sz | port size (in bytes) or size of the units. |
| | | Must be 1, 2 or 4 |
| | n_unit | number of the units to be read from the |
| | | port |
| | bufp | output data buffer. The size of the |
| | | buffer must be at least unit_sz * |
| | | n_units (in bytes) |
| Out: | *bufp | n_units read from the port |
| Return | CMST_OK | operation finished successfully |
| Status: | | |
| Example: | byte b; | |

word w;
dword dw[10];
s = outX (io, inbuf) ((_iface * const)top (io),

0,
sizeof(b),
1,
&b);

if (s != CMST_OK) . . .
printf (“byte received 0x%02x\n”, b);
s = outX (io, inbuf) ((_iface * const)top (io),

0,
sizeof(w),
1,
&w);

if (s != CMST_OK) . . .
printf (“word received 0x%04x\n”, w);
s =outX (io, inbuf) ((_iface * const)top (io),

0,
sizeof(dw[0]),
sizeof(dw)/sizeof(dw[0]),
&dw);

if (s != CMST_OK) . . .
printf (“1-st dword received = 0x%08Ix\n”, dw[0]);

out (CMIFCP (_iface), uint32 offs, byte b)

| Description: | Output a byte (8-bits) to the I/O port | |
|---|---|---|
| In: | offs | base-relative I/O port offset |
| | b | 8-bit output value |
| Out: | void | |
| Return | CMST_OK | operation finished successfully |
| Status: | | |

| | |
|---|---|
| Example: | s = outX (io, out) ((_iface * const)top (io), 0, 0x12); |
| | if (s != CMST_OK) . . . |

outw (CMIFCP (_iface), uint32 offs, word w)

| Description: | Output a word (16-bits) to the I/O port | |
|---|---|---|
| In: | offs | base relative I/O port offset |
| | w | 16-bit output value |
| Out: | void | |
| Return | CMST_OK | operation finished successfully |
| Status: | | |
| Example: | word w; | |

s = outX (io, outw) (( iface * const)top (io), 0, 0x1234);
if (s != CMST_OK) . . .

outdw (CMIFCP (_iface), uint32 offs, dword dw)

| Description: | Output a dword (32-bits) to the I/O port | |
|---|---|---|
| In: | offs | base relative I/O port offset |
| | dw | 32-bit output value |
| Out: | void | |
| Return | CMST_OK | operation finished successfully |
| Status: | | |
| Example: | word dw; | |

s = outX (io, outdw) ((_iface * const) top (io),

0,
0x12345678);

if (s != CMST_OK) . . .

| | |
|---|---|
| inbuf (CMIFCP | (_iface), |

| | |
|---|---|
| uint32 | offs, |
| uint32 | unit_sz, |
| uint32 | n_units, |
| void | *bufp) |

| Description: | Output sequence of bytes, words or double words to the | |
|---|---|---|
| | I/O port | |
| In: | offs | base relative I/O port offset |
| | unit_sz | port size (in bytes) or size of the units. |
| | | Must be 1 ,2 or 4 |
| | n_unit | number of the units to be outputed to |
| | | the port |
| | bufp | data buffer. The length of the data is |
| | | equal to unit_sz * n_units (in bytes) |
| Out: | void | |
| Return | CMST_OK | operation finished successfully |
| Status: | | |

| | |
|---|---|
| Example: | byte b = 0×12; |
| word w = 12345; | |

dword dw[10]= {1, 2, 3, 4, 5, 6, 7, 8, 9, 10};
s = outX (io, out) ( (_iface * const)top (io),

0,
sizeof(b),
1,
&b);

if (s ! = CMST_OK)...
s = outX (io, outbuf) ( (_iface * const)top (io),

1234,
sizeof(w),
1,
&w);

if (s ! = CMST_OK) ...
s = outX (io, outbuf) ( (_iface * const)top (io),

333,
sizeof(dw[w]),
sizeof(dw)/sizeof(dw[0]),
&dw);

if (s ! = CMST_OK)...

I_BYTEARR—Byte-Array Interface

Overview

This interface provides access to a byte-array. It provides read and write operations for manipulation of the array. It also allows control over the byte-array metrics (size).

The byte array may be fixed length or it may be dynamic—depending on the implementation.

List of Operations

| Name | Description |
|---|---|
| read | read block of bytes starting at specified offset |
| write | write block of bytes starting at specified offset |
| get_metrics | get size of the array |
| set_metrics | set size of the array |

Operation Bus

BUS (B_BYTEARR)

| | |
|---|---|
| void | *p ; // buffer pointer |
| uint32 | offs ; // offset |
| uint32 | len ; // length of data in *p, [bytes] |
| uint32 | sz ; // size of buffer pointed to by p, |

// [bytes]

| | |
|---|---|
| flg32 | attr ; // attributes, [BYTEARR_A_xxx] |

END_BUS

Read

| Description: | read block of bytes starting at specified offset | |
|---|---|---|
| In: | p | buffer pointer |
| | sz | size of buffer |
| | offs | offset |
| | len | how many bytes to read |
| | attr | 0 to read < = len bytes, or |
| | | BYTEARR_A_EXACT to read exactly |
| | | len bytes |
| Out: | * p | data |
| | len | bytes actually read |
| Return | CMST_OK | successful |
| Status: | | |
| | CMST_EOF | cannot read requested len bytes (when |
| | | BYTEARR_A_EXACT) |

| | |
|---|---|
| Example: | B_BYTEARR bus; |
| | char buf [256]; |
| | cmstat s; |
| | // read 5 bytes starting at offset 10 |
| | bus.p = buf; |
| | bus.sz = sizeof (buf); |
| | bus.offs = 10; |
| | bus.len = 5; |
| | bus.attr = BYTEARR_A_EXACT; |
| | s = out (arr, read, &bus); |
| | if (s ! = CMST_OK)... |
| Remarks: | If BYTEARR_A_EXACT is not specified, an attempt to read |
| | beyond the limits of supported space returns CMST_OK |
| | with len = =0. |

Write

| Description: | write block of bytes starting at specified offset | |
|---|---|---|
| In: | p | pointer to data to be written |
| | offs | offset |
| | len | number of bytes to write |
| | attr | 0 to BYTEARR_A_GROW to grow |
| | | automatically |
| Out: | void | |
| Return | CMST_OK | successful |
| Status: | | |
| | CMST_OVERFLO | offs + len is beyond the current size |
| | W | of the array and BYTEARR_A_GROW |
| | | was not specified |
| | CMST_NOT_SUP | specified attribute is not supported |
| | PORTED | |

| | |
|---|---|
| Example: | B_BYTEARR bus; |
| | char buf [256]; |
| | cmstat s; |
| | // write 5 bytes starting at offset 10 |
| | strcpy (buf, “12345”); |
| | bus.p = buf; |
| | bus.offs = 10; |
| | bus.len = 5; |
| | bus.attr = 0; |
| | s = out (arr, write, &bus); |
| | if (s ! = CMST OK)... |

Get_metrics

| Description: | get size of the array | |
|---|---|---|
| In: | void | |
| Out: | len | number of bytes available for reading |
| | | from offset 0 |
| | sz | number of bytes available for writing |
| | | from offset 0 |
| Return | CMST_OK | successful |
| Status: | | |

| Example: | B_BYTEARR bus; |
|---|---|
| | cmstat s; |
| | // get size of the array |
| | s = out (arr, get_metrics, &bus); |
| | if (s ! = CMST_OK)... |
| | // print size |
| | printf (“available for reading: %Id\n”, bus.len); |
| | printf (“available for writing: %Id\n”, bus.sz ); |

Set_metrics

| Description: | set size of the array | |
|---|---|---|
| In: | len | number of bytes to become available |
| | | for reading from offset 0 |
| | sz | number of bytes to become available |
| | | for writing from offset 0 |
| Out: | void | |
| Return | CMST_OK | successful |

Status:

| CMST_REFUSE | if specified sz < specified len |
|---|---|
| CMST_ALLOC | specified size cannot be reached (i.e., |
| | out of memory) |
| CMST_NOT_SUP | operation is not supported |
| PORTED | |

| Example: | B_BYTEARR bus; |
|---|---|
| | cmstat s; |
| | // set size of the array |
| | bus.sz = 10; |
| | bus.len = 10; |
| | s = out (arr, set_metrics, &bus); |
| | if (s != CMST_OK)... |
| Remarks: | if len < current length, elements are removed |
| | if len > current length, elements are filled with 0 |

I_USBCFG—USB Configuration Interface

Overview

This interface is used to enumerate the set of available USB configurations on the current system. After enumeration, a configuration can be set to the current configuration used by a USB driver. The configuration list may be refreshed at any time.

List of Operations

| Name | Description |
|---|---|
| refresh | Refresh the list of available |
| | configurations |
| set | Set a configuration or set to |
| | unconfigured state (id = |
| | NO_USBCFG) |
| get | Get currently selected configuration |
| get_info | Get information for specified |
| | configuration ID (‘id’ does not have |
| | to be the current configuration) |
| qry_open | Open a query for enumerating |
| | configurations |
| qry_close | Close a query for enumerating |
| | configurations |
| qry_first/qry_next | Get first/next configuration |
| reset | Reset the USB device |

Operation Bus

BUS( B_USBCFG)

| // primary identification | | |
|---|---|---|
| uint32 | id; | // configuration ID |
| // USB identification | | |
| byte | cfg_id; | // configuration number |
| byte | ifc_id; | // interface number |
| byte | alt_id; | // alternate setting number |
| // configuration data | | |
| word | cfg_attr; | // USBCFG_A_xxx |
| word | cfg_pwr; | 11 0-500 [ma] |
| byte | cfg_desc_idx; | //index of configuration |

// description string

| | | |
|---|---|---|
| byte | ifc_class; | // (values are defined by the USB |

// standard)

| | | |
|---|---|---|
| byte | ifc_subclass; | // (values are defined by the USB |

// standard)

| | | |
|---|---|---|
| byte | ifc_protocol; | // (values are defined by the USB |

// standard)

| | | |
|---|---|---|
| uint32 | n_endpts; | // number of entries in endpt[] |

// array

ENDPT endpt[MAX_ENDPTS]; // endpoint data

END_BUS
refresh

| Description: | Refresh the list of available configurations | |
|---|---|---|
| In: | void | |
| Out: | void | |
| Return | CMST_OK | configuration was read successfully |
| Status: | | |
| | (other) | failed to read configuration |

| | |
|---|---|
| Remarks: | Use of this operation is not required in order to use other |
| | operations of the I_USBCFG interface |
| | This operation may invalidate configuration IDs obtained |
| | with prior qry_first/qry_next operations |

Set

| Description: | Set a configuration or set to unconfigured state (id = | |
|---|---|---|
| | NO_USBCFG) | |
| In: | id | config ID from qry_first/qry_next or |
| | | NO_USBCFG |
| Out: | void | |
| Return | CMST_OK | configuration was selected successfully |
| Status: | | |
| | CMST_FAILED | configuration was not selected |

| | |
|---|---|
| Remarks: | It is recommended that all activity on USB endpoints |
| | except endpoint 0 is suspended when calling the ‘set’ |
| | operation. |
| | Implementation may not guarantee that device state will |
| | be preserved if the operation fails. |
| | Upon successful return from ‘set’ the device is configured |
| | and ready and all the endpoints are ready for data transfer. |

Get

| Description: | Get currently selected configuration | |
|---|---|---|
| In: | void | |
| Out: | id | current configuration ID |
| Return | CMST_OK | always (except fatal failures) |
| Status: | | |

Get_info

| Description: | Get information for specified configuration ID (‘id’ does | |
|---|---|---|
| | not have to be the current configuration) | |
| In: | id | value returned by qry_first, qry_next or |
| | | get |
| Out: | (all fields - see notes at qry_first/qry_next) | |
| Return | CMST_INVALID | id is not valid (use only values returned |
| Status: | | by qry_first/qry_next) |

Qry_open

| Description: | Open a query for enumerating configurations | |
|---|---|---|
| In: | void | |
| Out: | void | |
| Return | CMST_NO_ROO | a query is already open |
| Status: | M | |

Qry_close

Description: Close a query for enumerating configurations

In: void

Out: void

Return CMST_NO_ACTI no query is open

| | |
|---|---|
| Status: | ON |

Qry_first/qry_next

| Description: | Get first/next configuration | |
|---|---|---|
| In: | id | (for qry_next only) value from previous |
| | | call to qry_first/qry_next |
| Out: | (all B_USBCFG fields are set) | |
| Return | CMST_NOT_FO | there are no more configurations |
| Status: | UND | |

Reset

| Description: | Reset the USB device; this operation executes the reset | |
|---|---|---|
| | sequence on the USB port and returns the device to its | |
| | unconfigured state. | |
| In: | void | |
| Out: | void | |
| Return | CMST_ACCESS_{—} | device is disconnected |
| Status: | DENIED | |

Appendix 2—Events

This appendix describes preferred definition of events used by parts described herein.

EV_IDLE

| Overview: | The EV_IDLE is a generic event used to signal that idle | |
|---|---|---|
| | processing can take place. Recipients of this event | |
| | perform processing that was postponed or | |
| | desynchronized. | |
| Description: | Signifies that a system is idle and that idle processing can | |
| | take place. | |
| Event Bus | CMEVENT_HDR/CMEvent | |
| Definition: | | |
| Return | Depends on the consumer of the event. Usually, the | |
| Status: | following values are interpreted | |
| | CMST_OK | processing was performed; |
| | | there is need for more idle- |
| | | time processing, waiting for |
| | | another idle event |
| | CMST_NO_ACTION | there was nothing to do on |
| | | this event |

| | |
|---|---|
| Example: | /* my idle event definition - equivalent to |
| | CMEVENT_HDR */ |
| | EVENT (MY_IDLE_EVENT) |

// no event data

| | END_EVENT |
|---|---|
| | MY_IDLE_EVENT idle_event; |
| | /* initialize idle event */ |
| | idle event.sz = sizeof (idle_event); |
| | idle_event.attr = CMEVT_A_DFLT; |
| | idle_event.id = EV_IDLE; |
| | /* raise event through a I_DRAIN output */ |
| | out (drain, raise, &idle_event); |
| Remarks: | This event uses the CMEVENT_HDR/CMEvent directly; it |
| | does not have any event-specific data. There are no |
| | event-specific attributes defined for this event. |
| | This event is typically distributed synchronously. See the |
| | overview of the I_DRAIN interface for a description of the |
| | generic event attributes. |
| See Also: | I_DRAIN, DM_DWI, DM_IEV, CMEVENT_HDR, |
| | CMEvent |

EV_REQ_ENABLE

| Overview: | EV_REQ_ENABLE is a generic request to enable a |
|---|---|
| | particular procedure or processing. The nature of this |
| | procedure depends on the context and environment in |
| | which it is used. |
| Description: | Generic request to enable a particular procedure. |
| Event Bus | CMEVENT_HDR/CMEvent |
| Definition: | |
| Return | Depends on the consumer of the event |
| Status: | |
| Example: | EVENTX (MY_ENABLE_EVENT, |
| | EV_REQ_ENABLE, CMEVT_A_AUTO, |

CMEVT_UNGUARDED)

char data[32];

END_EVENTX
/* allocate enable event */
if (evt_alloc (MY_ENABLE_EVENT,
&enable_eventp) != CMST_OK)

return;

/* raise event through a I_DRAIN output */
memset (&enable_eventp−>data[0],

0xAA, sizeof (enable_eventp−>data));

| | out (drain, raise, enable_eventp); |
|---|---|
| Remarks: | This event does not have any event-specific data or |
| | attributes. |
| | If this event is distributed asynchronously, then the event |
| | bus must be self-owned. See the overview of the |
| | I_DRAIN interface for a description of the generic event |
| | attributes. |
| See Also: | I_DRAIN, DM_DWI, DM_IEV, CMEVENT_HDR/ |
| | CMEvent |

EV_REQ_DISABLE

| | |
|---|---|
| Overview: | EV_REQ_DISABLE is a generic request to disable a |
| | particular procedure or processing. The nature of this |
| | procedure depends on the context and environment in |
| | which it is used. |
| Description: | Generic request to disable a particular procedure. |
| Event Bus | CMEVENT_HDR/CMEvent |
| Definition: | |
| Return | Depends on the consumer of the event |
| Status: | |
| Example: | EVENTX (MY_DISABLE_EVENT, |
| | EV_REQ_DISABLE, CMEVT_A_AUTO, |

CMEVT_UNGUARDED)

char data[32];

END_EVENTX
/* allocate disable event */
if (evt_alloc (MY_DISABLE_EVENT, &disable_eventp)

! = CMST_OK) return;

/* raise event through a I_DRAIN output */
memset (&disable_eventp−>data[0],

0xAA, sizeof (disable_eventp−>data));

| | /* raise event through a I_DRAIN output */ |
|---|---|
| | out (drain, raise, disable_eventp); |
| Remarks: | This event does not have any event-specific data or |
| | attributes. |
| | If this event is asynchronous, then the event bus must be |
| | self-owned. See the overview of the I_DRAIN interface for |
| | a description of the generic event attributes. |
| See Also: | I_DRAIN, DM_DWI, DM_IEV, CMEVENT_HDR, |
| | CMEvent |

EV_REP_NFY_DATA_CHANGE

| | |
|---|---|
| Overview: | This event is generated when a repository data item or a |
| | subtree changes. The change may be that a value has |
| | been modified, added or deleted. The originator of the |
| | event may use the event with an indication that a whole |
| | subtree has been changed in order to avoid notifying for |
| | each item separately. |
| Description: | Notification that a repository data item has been modified, |
| | added, or deleted |
| Event Bus | EVENTX (EV_REP, EV_REP_NFY_DATA_CHANGE, |
| Definition: | CMEVT_A_AUTO, |

CMEVT_UNGUARDED)

// repository event specific data
char path[I_ITEM_MAX_PATH]; //full path to affected

// entity

| | |
|---|---|
| bool32 is_subtree | ; // TRUE if the whole |

// subtree is affected

| | END_EVENTX | |
|---|---|---|
| Data: | path | Full data path to affected data item or |
| | | subtree root |
| | is_subtree | TRUE the if whole subtree below the |
| | | path specified by path has changed. If |
| | | this member is FALSE, only the item at |
| | | the specified path has changed. |

| | |
|---|---|
| Return | Since this is a notification of an action that has already |
| Status: | occurred and does not depend on processing by the |
| | recipient, originators of this event can safely ignore the |
| | returned status. |
| Example: | OPERATION (nfy, raise, EV_REP) |

{
/* valchk */
if (bp = =NULL) return (CMST_NULL_PTR);
if (bp->id !=EV_REP_NFY_DATA_CHANGE)
{
/* free bus if self-owned */
if (bp->attr & CMEVT_A_SELF_OWNED) evt_free

(bp);

return (CMST_OK);
{
/* find out which path changed */
if (stricmp (bp->path,

″customers[1].name″) ==0)

printf (″customer #1 name has changed.\n″);

if (stricmp (bp->path,

″customers[2].name″) ==0)

printf (″customer #2 name has changed .\n″);

/* find out if the whole subtree was affected */
if (bp->is_subtree)

printf (″The whole subtree was affected\n″);
/* free bus if self-owned */
if (bp->attr & CMEVT_A_SELF_OWNED) evt_free (bp);
return (CMST_OK);
{

| | END_OPERATION |
|---|---|
| Remarks: | The EV_REP_NFY_DATA_CHANGE event is generated by |
| | DM_REP when a repository data item changes (added, |
| | changed, deleted). There are no event-specific attributes |
| | defined for this event. |
| | The event bus contains all the information about the |
| | affected entity. It contains the affected data path and |
| | whether or not the whole subtree under that path was |
| | affected. |
| | If this event is distributed asynchronously, then the event |
| | bus must be self-owned. Note that, since the event |
| | contains the storage for the path and not only a pointer to |
| | it, the event is self-contained and can be distributed |
| | asynchronously. See the overview of the I_DRAIN |
| | interface for a description of the generic event attributes. |
| See Also: | I_DRAIN, DM_REP |

EV_RESET

| | |
|---|---|
| Overview: | This event is a generic request for reset. Recipients of this |
| | event should immediately reset their state and get ready to |
| | operate again as if they were just activated. |
| Description: | Reset the internal state of a part. |
| Event Bus | CMEVENT_HDR/CMEvent |
| Definition: | |
| Return | Depends on the consumer of the event |
| Status: | |
| Remarks: | This event does not have any event-specific data or |
| | attributes. |
| | If this event is asynchronous, then the event bus must be |
| | self-owned. See the overview of the I_DRAIN interface for |
| | a description of the generic event attributes. |
| See Also: | I_DRAIN, DM_DWI, CMEVENT_HDR, CMEvent |

EV_MESSAGE

| | |
|---|---|
| Overview: | This event contains a message received or to be |
| | transmitted through some communication channel. The |
| | event contains the actual data and its length. The event |
| | also contains an indication of whether the data is |
| | corrupted or not. |
| Description: | Send a string of bytes |
| Event Bus | EVENTX (B_EV_MSG, EV_NULL, |
| Definition: | CMEVT_A_SYNC \| CMEVT_A_SELF_OWNED \| |
| | CMEVT_A_SELF_CONTAINED, |
| | CMEVT_UNGUARDED) |
| | uint len ; // length of the data |
| | char data[1]; // variable size data |
| | END_EVENT |

| | | | |
|---|---|---|---|
| Data: | attr | MSG_A_{—} | no attrubutes |
| | | NONE | |
| | | MSG_A_{—} | message |
| | | BAD_DAT | consists |
| | | A | of bad |
| | | | data |
| | len | length of | |
| | | message data | |
| | data | beginning of | |
| | | message data | |
| Return | CMST_OK | event processed | |
| | | successfully | |
| Status: | | | |

| | |
|---|---|
| Remarks: | This message must be sent with the EV_A_SYNC |
| | attribute set. |

EV_EXCEPTION

| | |
|---|---|
| Overview: | This event signifies that an exception has occurred which |
| | requires special processing. More than one recipient can |
| | process this event. |
| Description: | Raise exception. |
| Event Bus | EVENTX (B_EV_EXC, EV_EXCEPTION, |

| | |
|---|---|
| Definition: | CMEVT_A_SYNC \| CMEVT_A_SELF_CONTAINED, |
| | CMEVT_UNGUARDED) |

// exception identification
dword exc_id ; // exception ID
byte exc_class ; // type of exception
byte exc_severity ; // severity, [CMERR_XXX]
// source identification
cmoid oid ; // oid of original issuer
cmoid oid2 ; // current oid
char path[48]; // path along the assembly

// hierarchy (dot-separated
// names as in the SUBORDINATES
// tables)

char class_name[24]; // class name
char file_name[24]; //file name
dword line ; //line number in file

// context

char term_name[16] ; // terminal name
char oper_name[16]; // operation name
cmstat cm_stat ; // ClassMagic status (optional)
dword os_stat ; // OS-dependent status
_ctx ctx1 ; // optional context (see

// EXC_A_xxx)

_ctx ctx2 ; // optional context (see

// EXC_A_xxx)
//inserts

| | char format[16]// defines format of data[] | |
|---|---|---|
| | byte data[128]; // packed insert data, as | |
| | | // specified by the |
| | | //format ‘field’ |
| Data: | attr | Attributes, can be any one of the |

| following: | |
|---|---|
| EXC_A_CTX1_IRP | ctxl is a pointer |
| | to IRP |
| EXC_A_CTX2_IO | ctx2 is an I/O |
| M | manager object |

| exc_id | exception ID | |
|---|---|---|
| exc_class | type of exception, reserved | |
| exc_severity | severity, [CMERR_XXX] | |
| oid | oid of original issuer | |
| oid2 | current oid - used to trace assembly | |
| | path | |
| path | path along the assembly hierarchy (dot- | |
| | separated names as in the | |
| | SUBORDINATES tables) | |
| class_name | ClassMagic class name | |
| file_name | source file name | |
| line | line number in file | |
| term_name | terminal name | |
| oper_name | operation name | |
| cm_stat | ClassMagic status (CMST_xxx) | |
| os_stat | system status (NT status, Win32 error, | |
| | etc.) | |
| ctx1 | optional context (see EXC_A_xxx) | |
| ctx2 | optional context (see EXC_A_xxx) | |
| format | defines format of the ‘data’field, one | |
| | char defines one data field as follows: | |
| | b, w, d - byte, word, dword (to be | |
| | printed in hex) | |
| | i, u - signed integer, unsigned integer | |
| | (dword, | |
| | decimal) | |
| | c - byte (to be printed as a character) | |
| | s - asciiz string | |
| | S - unicodez string | |
| | 1..9 - 1 to 9 dwords of binary data | |
| | data | packed insert data, as specified by |
| | | format ‘field’ |
| Return | CMST_OK | The event was processed |
| Status: | | successfully |

| | |
|---|---|
| Remarks: | All fields except exc_xxx, class_name, file_name and line |
| | are optional, set them to binary 0s if not used |
| | Use guidelines: |
| | 1) original issuer should: |
| | - initialize all mandatory fields |
| | - set ‘oid’and ‘oid2’ to the same value (sp- > self) |
| | - zero-init the following fields, they are for use only by |
| | exception |
| | processing parts: |
| | path |
| | 2) all unused fields should be zero-initialized |

EV_LFC_REQ_START

| | |
|---|---|
| Overview: | This life cycle event is used to signal that normal operation |
| | can begin. Recipients may commence operation |
| | immediately (the usual practice) and return after they have |
| | started. Recipient can postpone the starting for |
| | asynchronous completion and raise |
| | EV_LFC_NFY_START_CPLT event when ready. |
| Description: | Start normal operation |
| Event Bus | EVENT (B_EV_LFC) |
| Definition: | |

cmstat cplt_s; // completion status (asynchronous

completion)

| | END_EVENT | |
|---|---|---|
| Data: | attr | standard event attributes, |
| | | optionally |
| | | LFC_A_ASYNC_CPLT |
| Return | CMST_OK | started OK |
| Status: | | |
| | CMST_PENDING | postponed for asynchronous |
| | | completion (allowed if |
| | | LFC_A_ASYNC_CPLT is |
| | | specified; otherwise treated as failure) |
| | any other | start failed |

| | |
|---|---|
| Remarks: | If LFC_A_ASYNC_CPLT is specified, the recipient may |
| | return CMST_PENDING and complete the start later by |
| | sending EV_LFC_NFY_START_CPLT. |

EV_LFC_REQ_STOP

| Overview: | This life cycle event is used to signal that normal operation | |
|---|---|---|
| | should end. Typically recipients initiate the stopping | |
| | procedure immediately and return after this procedure is | |
| | complete. Recipient can postpone the starting for | |
| | asynchronous completion and raise | |
| | EV_LFC_NFY_STOP_CPLT event when ready. | |
| Description: | Stop normal operation | |
| Event Bus | EVENT (B_EV_LFC) | |
| Definition: | | |
| | cmstat cplt_s; // completion status (asynchronous | |
| | completion) | |
| | END_EVENT | |
| Data: | attr | standard event attributes, optionally |
| | | LFC_A_ASYNC_CPLT |
| Return | CMST_OK | Stop completed |
| Status: | | |
| | CMST_PENDING | postponed for asynchronous |
| | | completion (allowed if |
| | | LFC_A_ASYNC_CPLT is specified; |
| | | otherwise treated as failure) |
| | any other | stop failed |

| | |
|---|---|
| Remarks: | If LFC_A_ASYNC_CPLT is specified, the recipient may |
| | return CMST_PENDING and complete the stop later by |
| | sending EV_LFC_NFY_STOP_CPLT. |
| | In case stop fails, the recipient should still clean up as |
| | much as possible -- in many cases, stop failures are |
| | ignored (e.g., NT kernel mode-drivers are unloaded, even if |
| | they fail to stop properly). |

EV_LFC_NFY_START_CPLT

| Overview: | This event indicates that the starting procedure has | |
|---|---|---|
| | completed. The event is used when an asynchronous | |
| | completion is needed and complements | |
| | EV_LFC_REQ_START event. | |
| Description: | Start has completed | |
| Event Bus | EVENT (B_EV_LFC) | |
| Definition: | cmstat cplt_s; // completion status | |
| | // (asynchronous completion) | |
| | END_EVENT | |
| Data: | cplt_s | completion status |

| | |
|---|---|
| Return | The return status is ignored |
| Status: | |
| Remarks: | Start has completed successfully if cplt_s is CMST_OK, |
| | failed otherwise this event is sent in response to |
| | EV_LFC_REQ_START on which CMST_PENDING was |
| | returned; it goes in the opposite direction of |
| | EV_LFC_REQ_START |

EV_LFC_NFY_STOP_CPLT

| | |
|---|---|
| Overview: | This event indicates that the stopping procedure has |
| | completed. The event is used when an asynchronous |
| | completion is needed and complements |
| | EV_LFC_REQ_STOP event. |
| Description: | Stop has completed |
| Event Bus | EVENT (B_EV_LFC) |

| | |
|---|---|
| Definition: | cmstat cplt_s; // completion status |

// (asynchronous completion)

| | END_EVENT | |
|---|---|---|
| Data: | cplt_s | completion status |

| | |
|---|---|
| Return | The return status is ignored |
| Status: | |
| Remarks: | Stop has completed successfully if cplt_s is CMST_OK, |
| | failed otherwise this event is sent in response to |
| | EV_LFC_REQ_STOP on which CMST_PENDING was |
| | returned; it goes in the opposite direction of |
| | EV_LFC_REQ_STOP |
| | In case stop fails, the sender should still clean up as much |
| | as possible—in many cases, stop failures are ignored |
| | (e.g., a file handle becomes invalid even if close failed). |

EV_PRP_REQ

Overview

This event is used to request a part to execute a property operation. All of the standard DriverMagic property operations are supported and are specified in the event as an op-code. The input and output parameters for each operation is dependent upon the op-code.

Each property operation is described below.

Event Bus

EVENTX (B_EV_PRP, EV_PRP_REQ, CMEVT_A_DFLT,

CMEVT_UNGUARDED)

| | | |
|---|---|---|
| uint32 | cplt_s | ; // completion status, [CMST_xxx] |

| | | |
|---|---|---|
| _ctx | context | ; // IOCTL context |

| | | |
|---|---|---|
| uint32 | opcode | ; // property operation code, |

// [PROP_OP xxx]

| | | |
|---|---|---|
| _hdl | qryh | ; // query handle |

| | | |
|---|---|---|
| char | name[64] | ; // property name |

| | | |
|---|---|---|
| uint16 | type | ; // property type, [CMPRP_T_XXX] |

| | | |
|---|---|---|
| flg32 | prp_attr | ; // property attributes, [CMPRP_A_XXX] |

| | | |
|---|---|---|
| flg32 | attr_mask; | // property attribute mask, |

// [CMPRP_A_XXX]

| | | |
|---|---|---|
| uint32 | size | ; // size of data in bytes |
| uint32 | len | ; // length of data in bytes |

| | | |
|---|---|---|
| byte | data[1] | ; // buffer for property value |

END_EVENTX

PROP_OP_GET

| Description: | Get a property | |
|---|---|---|
| In: | context | 32-bit context |
| | opcode | operation id, [PROP_OP_GET] |
| | name | null-terminated property name |
| | type | type of the property to retrieve or |
| | | CMPRP_T_NONE for any |
| | size | size of data, [bytes] |
| | data[] | buffer to receive property value |
| Out: | cplt_s | completion status, [CMST_xxx] |
| | len | length of data returned in data[] |
| | data | property value |
| Return | CMST_OK | success |
| Status: | | |
| | CMST_REFUSE | the data type does not match the |
| | | expected type |
| | CMST_NOT_FO | unknown property |
| | UND | |
| | CMST_OVERFLO | the buffer is too small to hold the |
| | W | property value |

PROP_OP_SET

| Description: | Set a property | |
|---|---|---|
| In: | context | 32-bit context |
| | opcode | operation id, [PROP_OP_SET] |
| | name | null-terminated property name |
| | type | property type, [CMPRP_T_XXX] |
| | len | length [in bytes] of data stored in data |
| | data[] | property value |
| Out: | cplt_s | completion status, [CMST_xxx] |
| Return | CMST_OK | success |
| Status: | | |
| | CMST_NOT_FO | unknown property |
| | UND | |
| | CMST_OVERFLO | the property value is too large |
| | W | |
| | CMST_REFUSE | the property type is incorrect or the |
| | | property cannot be changed while the |
| | | part is in an active state |
| | CMST_OUT_OF_{—} | the property value is not within the |
| | RANGE | range of allowed values for this |
| | | property |
| | CMST_BAD_AC | there has been an attempt to set a |
| | CESS | read-only property |

PROP_OP_CHK

| Description: | Check if a property can be set to the specified value | |
|---|---|---|
| In: | context | 32-bit context |
| | opcode | operation id, [PROP_OP_CHK] |
| | name | null-terminated property name |
| | type | type of the property value to check |
| | len | size in bytes of property value |
| | data[] | buffer containing property value |
| Out: | cplt_s | completion status, [CMST_xxx] |
| Return | CMST_OK | successful |
| Status: | | |
| | CMST_NOT_FO | the property could not be found or the |
| | UND | id is invalid |
| | CMST_OVERFLO | the property value is too large |
| | W | |
| | CMST_REFUSE | the property type is incorrect or the |
| | | property cannot be changed while the |
| | | part is in an active state |
| | CMST_OUT_OF_{—} | the property value is not within the |
| | RANGE | range of allowed values for this |
| | | property |
| | CMST_BAD_AC | there has been an attempt to set a |
| | CESS | read-only property |

PROP_OP_GET_INFO

| Description: | Retrieve the type and attributes of the specified property | |
|---|---|---|
| In: | context | 32-bit context |
| | opcode | operation id, [PROP_OP_GET_INFO] |
| | name | null-terminated property name |
| Out: | cplt_s | completion status, [CMST_xxx] |
| | type | type of property, [CMPRP_T_XXX] |
| | prp_attr | property attributes, [CMPRP_A_XXX] |
| Return | CMST_OK | successful |
| Status: | | |
| | CMST_NOT_FO | the property could not be found |
| | UND | |

PROP_OP_QRY_OPEN

| Description: | Open a query to enumerate properties on a part based | |
|---|---|---|
| | upon the specified attribute mask and values or | |
| | CMPRP_A_NONE to enumerate all properties | |
| In: | context | 32-bit context |
| | opcode | operation id, |
| | | [PROP_OP_QRY_OPEN] |
| | name | query string (must be “*”) |
| | prp_attr | attribute values of properties to |
| | | include |
| | attr_mask | attribute mask of properties to include |
| Out: | cplt_s | completion status, [CMST_xxx] |
| | qryh | query handle |
| Return | CMST_OK | successful |
| Status: | | |
| | CMST_NOT_SUP | the specified part does not support |
| | PORTED | property enumeration or does not |
| | | support nested or concurrent property |
| | | enumeration |

| Remarks: | To filter by atrributes, specifiy the set of attributes in | |
|---|---|---|
| | attr_mask and their desired values in prp_attr. During the | |
| | enumeration, a bit-wise AND is performed between the | |
| | actual attributes of each property and the value of | |
| | attr_mask; the result is then compared to prp_attr. If there | |
| | is an exact match, the property will be enumerated. | |
| | To enumerate all properties of a part, specifiy the query | |
| | string as “*”, and attr_mask and prp_attr as 0. | |
| | The attribute mask can be one or more of the following: | |
| | CMPRP_A_NONE | not specified |

| | |
|---|---|
| CMPRP_A_PERSIST | persistent property |
| CMPRP_A_ACTIVETIME | property can be modified |
| while active | |

| | |
|---|---|
| CMPRP_A_MANDATORY | property must be set |
| before activation | |
| CMPRP_A_RDONLY | read-only property |
| CMPRP_A_UPCASE | force uppercase |
| CMPRP_A_ARRAY | property is an array |

PROP_OP_QRY_CLOSE

| Description: | Close a query | |
|---|---|---|
| In: | context | 32-bit context |
| | opcode | operation id, |
| | | [PROP_OP_QRY_CLOSE] |
| | qryh | query handle |
| Out: | cplt_s | completion status, [CMST_xxx] |
| Return | CMST_OK | successful |
| Status: | | |
| | CMST_NOT_FOU | query handle was not found or is |
| | ND | invalid |
| | CMST_BUSY | the object can not be entered from |
| | | this execution context at this time |

PROP_OP_QRY_FIRST

| Description: | Retrieve the first property in a query | |
|---|---|---|
| In: | context | 32-bit context |
| | opcode | operation id, |
| | | [PROP_OP_QRY_FIRST] |
| | qryh | query handle returned on |
| | | PROP_OP_QRY_OPEN |
| | size | size in bytes of data |
| | data[] | storage for the returned property |
| | | name |
| Out: | cplt_s | completion status, [CMST_xxx] |
| | data | property name if size is not 0 |
| | len | length of data (including null |
| | | terminator) |
| Return | CMST_OK | successful |
| Status: | | |
| | CMST_NOT_FOU | no properties found matching current |
| | ND | query |
| | CMST_OVERFLO | buffer is too small for property name |
| | W | |

PROP_OP_QRY_NEXT

Description: Retrieve the next property in a query

| | | |
|---|---|---|
| In: | context | 32-bit context |
| | opcode | operation id, |
| | | [PROP_OP_QRY_NEXT] |
| | qryh | query handle returned on |
| | | PROP_OP_QRY_OPEN |
| | size | size in bytes of data |
| | data[] | storage for the returned property |
| | | name |
| Out: | cplt_s | completion status, [CMST_xxx] |
| | data | property name if size is not 0 |
| | len | length of value (including null |
| | | terminator) |
| Return | CMST_OK | successful |
| Status: | CMST_NOT_FOUND | there are no more properties that |
| | | match the query criteria |
| | CMST_OVERFLOW | buffer is too small for property name |

PROP_OP_QRY_CURR

| Description: | Retrieve the current property in a query | |
|---|---|---|
| In: | context | 32-bit context |
| | opcode | operation id, |
| | | [PROP_OP_QRY_CURR] |
| | qryh | query handle returned on |
| | | PROP_OP_QRY_OPEN |
| | size | size in bytes of data |
| | data[] | storage for the returned property |
| | | name |
| Out: | cplt_s | completion status, [CMST_xxx] |
| | data | property name if size is not 0 |
| | len | length of value (including null |
| | | terminator) |
| Return | CMST_OK | successful |
| Status: | | |
| | CMST_NOT_FOU | no current property (e.g. after a call |
| | ND | to PROP_OP_QRY_OPEN) |
| | CMST_OVERFLO | buffer is too small for property name |
| | W | |

EV_PULSE

| Overview: | EV_PULSE is a generic event that gives a recipient an | |
|---|---|---|
| | opportunity to execute in the sender's execution context. | |
| Description: | Gives recipient an opportunity to execute in sender's | |
| | execution context. | |
| Event Bus | uses CMEVENT_HDR/CMEvent | |
| Definition: | | |
| Return | CMST_OK | recipient executed OK |
| Status: | | |
| | CMST_NO_ACTI | recipient didn't have any action to |
| | ON | be performed |

| | |
|---|---|
| Remarks: | This event is typically distributed only synchronously. |
| | A sender of this event may re-send the event until |
| | CMST_NO_ACTION is returned, allowing the receipient |
| | to complete all pending actions'. |

This chapter provides details on the events used by WDK.

The first three events are extensions to the standard life-cycle event set provided by DriverMagic. These operate on the same bus and their event IDs are binary compatible with the standard life-cycle event IDs.

The third event EV_REQ_IRP is a request to process IRP. This event is the fundamental carrier of request packets entering the driver. The ownership of the IRP travels with the event.

The next seven events are used to request operations on device drivers. Each event corresponds to an operation on the I_DIO interface. These events are mainly used for communication with other device drivers.

The last three events are used for keyboard interaction. Only the DM_A2K part uses these events.

All requests can be completed synchronously or asynchronously (default). Some parts may refuse operation if asynchronous completion is not allowed. If this creates a problem, use DM_RSB part from the Advanced Part Library. For more information, consult the DM_RSB data sheet in the Advanced Part Library documentation.

In case of asynchronous completion, the same event is sent back with CMEVT_A_COMPLETED attribute set, to indicate that the processing of the event is complete.

EV_LFC_REQ_DEV_PAUSE

| | |
|---|---|
| Overview: | This is a request to pause the operation with the device. |
| | Recipients of this event may process it synchronously or |
| | asynchronously. |
| | In the later case they have to issue the same event with |
| | CMEVT_A_COMPLETED attribute set. |
| Description: | Request to pause the device |
| Event Bus | EVENT (B_EV_LFC) |
| Definition: | |

cmstat cplt_s; // completion status

// (asynchronous completion)

| | END_EVENT | |
|---|---|---|
| Data: | cplt_s | Completion status |
| | attr | CMEVT_A_ASYNC_CPLT— |
| | | if asynchronous completion |
| | | is allowed |
| | | CMEVT_A_COMPLETED—if |
| | | the event is a completion event. |
| Return | CMST_PENDING | callee assumes responsibility to |
| Status: | | complete the request later (either |
| | | directly or by sending back the |
| | | same event with |
| | | CMEVT_A_COMPLETED |
| | | set) |

| | |
|---|---|
| Remarks | This event is defined in e_lfc_ex.h. |

EV_LFC_REQ_DEV_RESUME

| | |
|---|---|
| Overview: | This is a request to resume the operation with the device. |
| | Recipients of this event may process it synchronously or |
| | asynchronously. |
| | In the later case they have to issue the same event with |
| | CMEVT_A_COMPLETED attribute set. |
| Description: | Request to resume the device |
| Event Bus | EVENT (B_E_V LFG) |
| Definition: | |
| | cmstat cplt_s; // completion status |

// (asynchronous completion)

| | END_EVENT | |
|---|---|---|
| Data: | cplt_s | Completion status |
| | attr | CMEVT_A_ASYNC_CPLT - if |
| | | asynchronous completion is allowed |
| | | CMEVT_A_COMPLETED - if the event |
| | | is a completion event. |
| Return | CMST_PENDING | callee assumes responsibility to |
| Status: | | complete the request later (either |
| | | directly or by sending back the same |
| | | event with CMEVT_A_COMPLETED |
| | | set) |

| | |
|---|---|
| Remarks | This event is defined in e_lfc_ex.h. |

EV_LFC_NFY_DEV_REMOVED

| | |
|---|---|
| Overview: | This is a post-notification that the device has been |
| | removed. Recipients of this event may process it only |
| | synchronously. |
| | In no event recipients of this event can access the |
| | hardware device - at the time this event is sent, the |
| | hardware device may have been unplugged. |
| Description: | Notification that the device has been removed. |
| Event Bus | EVENT (B_EV_LFC) |
| Definition: | |
| | cmstat cplt_s; // completion status |

// (asynchronous completion)

| | END_EVENT |
|---|---|
| Remarks | This event is defined in e_lfc_ex.h. |
| | This event is a notification and cannot be completed |
| | asynchronously. |

EV_REQ_IRP

| | |
|---|---|
| Overview: | This event indicates that an IRP (I/O request packet) needs |
| | processing. Recipients of this event may process it |
| | synchronously or asynchronously. In the later case they |
| | have to issue the same event with |
| | CMEVT_A_COMPLETED attribute set. |
| Description: | Process the I/O request |
| Event Bus | EVENTX (B_EV_IRP, EV_REQ_IRP, CMEVT_A_NONE, |

| Definition: | CMEVT_UNGUARDED) | |
|---|---|---|
| | dword | devid ; //instance ID |

| | |
|---|---|
| void | *irpp ; // pointer to IRP |

| | |
|---|---|
| cmstat | cpit_s; // completion status |

| | END_EVENTX | |
|---|---|---|
| Data: | devid | ID of the instance that should process |
| | | the request |
| | irpp | pointer to IRP (NT I/O request packet) |
| Return | CMST_PENDING | callee assumes responsibility to |
| Status: | | complete the request later (either |
| | | directly or by sending back an |
| | | EV_REQ_IRP event with |
| | | CMEVT_A_COMPLETED set) |

| | |
|---|---|
| Remarks: | The value of devid is implementation-specific. |
| | This event is defined in e_irp.h. |

EV_KBD_EVENT

| | |
|---|---|
| Overview: | This event is sent when keyboard data is present either |
| | from the user pressing a key or another part emulating |
| | keystrokes. |
| Description: | Notifies that the specified keyboard event has occurred. |
| Event Bus | EVENTX (B_EV_KBD, EV_KBD_EVENT, |

| | |
|---|---|
| Definition: | CMEVT_A_SELF_CONTAINED\|CMEVT_A_SYNC, |
| | CMEVT_UNGUARDED) |

| | | |
|---|---|---|
| uint16 | data; | // keyboard event data (raw data |

// or shift state)

| | | |
|---|---|---|
| uint16 | flags; | // KBD_F_xxx |

| | | |
|---|---|---|
| uint32 | time_delta; | // time since the previous event |

// (msec)

| | | |
|---|---|---|
| uint32 | dev_data[4]; | // originator-specific data, do |

| | | // not modify |
|---|---|---|
| | END_EVENTX | |
| Data: | attr | event attributes - CMEVT_A_CONST |
| | | and/or KBD_A_DEVICE_KBD (indicates |
| | | event is generated by actual device) |
| | data | keyboard data (device-specific) |
| | flags | keyboard flags, may be one or more of |
| | | the following: |

| | |
|---|---|
| KBD_F_BR | indicates that the event |
| EAK | is a “key release” event |
| KBD_F_EO | Oxe0 prefix was sent |
| | with key (AT-keyboard |
| | specific and may be |
| | ignored if not needed) |
| KBD_F_E1 | Oxe1 prefix was sent |
| | with key (AT-keyboard |
| | specific and may be |
| | ignored if not needed) |

| | time_delta | time [in msec] since the previous |
|---|---|---|
| | | event. If there was no previous event |
| | | or the time since the previous event |
| | | exceeds the size of a 32-bit integer, |
| | | time_delta is set to Oxffffffff. This |
| | | field is optional and not all event |
| | | sources have to support it. |
| | dev_data[] | originator context data. must be |
| | | preserved by recipients of this event. |
| | | Event filters that process |
| | | EV_KBD_EVENTs should pass this |
| | | data on unchanged. |
| Return | CMST_OK | event was processed successfully |
| Status: | | |
| | CMST_NOT_SUP | the recipient does not support new |
| | PORTED | event insertion (may be returned if |
| | | KBD_A_DEVICE_EVT attribute is not |
| | | set) |
| | (other) | other (valchk/fatal) errors may be |
| | | returned if receiver cannot process |
| | | event |

| | |
|---|---|
| Remarks: | if a “fake” keyboard event is initiated by a non-keyboard |
| | part, it should set the dev_data[] fields to 0. The “fake” |
| | event is recognized by the KBD_A_DEVICE_EVT flag in |
| | the attr field - it is 0 for such events and 1 for actual |
| | device events. Support for “fake” events may be limited |
| | by operating system (or other) restrictions. |

EV_KBD_STATE_NFY

| | |
|---|---|
| Overview: | This event is sent when the state of the shift, control, alt |
| | or lock (scroll, num and caps) keys of the keyboard has |
| | changed. |
| Description: | Notifies that the keyboard's shift keys are in the specified |
| | state. |
| Event Bus | EVENTX (B_EV_KBD, EV_KBD_EVENT, |

| | |
|---|---|
| Definition: | CMEVT_A_SELF_CONTAINED\|CMEVT_A_SYNC, |
| | CMEVT_UNGUARDED) |

| | | |
|---|---|---|
| uint16 | data; | // keyboard event data (raw data |

// or shift state)

| | | |
|---|---|---|
| uint16 | flags; | // KBD_F_xxx |

| | | |
|---|---|---|
| uint32 | time_delta; | // time since the previous event |

// (msec)

| | | |
|---|---|---|
| uint32 | dev_data[4]; | // originator-specific data, do |

| | | // not modify |
|---|---|---|
| | END_EVENTX | |
| Data: | attr | event attributes - CMEVT_A_CONST |
| | | and/or KBD_A_DEVICE_KBD (indicates |
| | | event is generated by actual device) |
| | data | bit flag specifying current shift and |
| | | lock state, may be one or more of the |
| | | following: |

| | |
|---|---|
| KBD_SF_RSHIF | Right shift pressed |
| T | |
| KBD_SF_LSHIF | Left shift pressed |
| T | |
| KBD_SF_CTRL | Control pressed |
| KBD_SF_ALT | Alt pressed |
| KBD_SF_SCRO | Scroll lock on |
| LL | |
| KBD_SF_NUM | Num lock on |
| KBD_SF_CAPS | Caps lock on |

| | |
|---|---|
| flags | bit mask specifying which of the bits |
| | in data are valid (if a bit is ‘0’ in flags, |
| | the corresponding bit in data should |
| | be ignored) |

EV_KBD_GET_STATE

| | |
|---|---|
| Overview: | This event is sent to find out the current state of the shift, |
| | control, alt and lock state (scroll, num and caps) of the |
| | keyboard. |
| Description: | Request current shift and lock state. |
| Event Bus | EVENTX (B_EV_KBD, EV_KBD_EVENT, |

| | |
|---|---|
| Definition: | CMEVT_A_SELF_CONTAINED\|CMEVT_A_SYNC, |
| | CMEVT_UNGUARDED) |

| | | |
|---|---|---|
| uint16 | data; | // keyboard event data (raw data |

// or shift state)

| | | |
|---|---|---|
| uint16 | flags; | // KBD_F_xxx |

| | | |
|---|---|---|
| uint32 | time_delta; | // time since the previous event |

// (msec)

| | | |
|---|---|---|
| uint32 | dev_data[4]; | // originator-specific data, do |

| | | // not modify |
|---|---|---|
| | END_EVENTX | |
| Data: | data | bit flag specifying current shift and |
| | | lock state, may be one or more of the |
| | | following: |

| | |
|---|---|
| KBD_SF_RSHIF | Right shift pressed |
| T | |
| KBD_SF_LSHIF | Left shift pressed |
| T | |
| KBD_SF_CTRL | Control pressed |
| KBD_SF_ALT | Alt pressed |
| KBD_SF_SCRO | Scroll lock on |
| LL | |
| KBD_SF_NUM | Num lock on |
| KBD_SF_CAPS | Caps lock on |

| | flags | bit mask specifying which of the bits |
|---|---|---|
| | | in data are valid (if a bit is ‘0’ in flags, |
| | | the corresponding bit in data should |
| | | be ignored) |
| Return | CMST_OK | event was processed successfully |
| Status: | | |
| | CMST_NOT_SUP | the recipient does not support the |
| | PORTED | request |
| | (other) | other (valchk/fatal) errors may be |
| | | returned |

Device I/O Events—Notes

The following notes apply to all the device I/O events defined below:

1. The term ‘object’ is used below to refer to the entity on which the I/O operations are performed. This can be a file, a device, a pipe or any similar entity.

2. The dev_id field in the B_EV_DIO bus can be used to identify the instance that should handle the operation. The use of this field is optional. It is intended as storage for a part or connection ID in one-to-many connections. Its use is not explicitly defined here.

3. The dev_h field in the B_EV_DIO bus is usually a handle of a device or of a file opened on the device.

4. All EV_DIO_RQ_xxx requests can be completed asynchronously, provided that the originator has set the CMEVT_A_ASYNC_CPLT attribute. To complete a request asynchronously, recipient should perform the following actions:

a) save the event bus pointer

b) return CMST_PENDING

c) if necessary, use the event bus during processing (the event bus is exclusively available to the part that is processing the request)

d) when request is completed, use the saved bus pointer and

fill in the completion status (cplt_s)

fill in all fields specified as “out” for the request

set the CMEVT_A_COMPLETED attribute (all other fields, esp. ctx, must be preserved)

send the completion event (typically out the terminal through which the request was received).

If the CMEVT_A_ASYNC_CPLT attribute is not set, the request must be completed synchronously.

5. The ctx field is used by the request originator to store its context. This value is not to be interpreted or modified by any part that processes the event, unless the originator has set the DIO_A_NT_IRP attribute to indicate that ctx contains a pointer to a NT driver IRP (I/O request packet) associated with the event. The DIO_A_NT_IRP attribute shall be clear if ctx does not contain pointer to a valid IRP.

6. (Note specific to Windows NT kernel mode and WDM environments) If ctx contains pointer to NT driver IRP, the rules for intermediate drivers apply to the processors of the EV_DIO_RQ_xxx request: they can use the next and lower stack locations. In no case the IRP should be completed. If the IRP's next stack location is used to call a lower-level driver in the device's stack, the caller must set a completion routine and prevent full completion of the IRP—the request should be completed according to note #4 above.

7. The DIO_A_UNICODE attribute can be set on EV_DIO_RQ_OPEN to indicate that the object name pointed by buf_p is a unicode string. Note that in Windows NT kernel mode and WDM environments, the string may not be zero-terminated; the length is always correctly specified in buf_len (in bytes, excluding any zero terminator). If the DIO_A_UNICODE attribute is not set, buf_p on EV_DIO_RQ_OPEN is either NULL or points to a valid 0-terminated ASCII string. If buf_p is NULL, DIO_A_UNICODE should not be set.

EV_DIO_RQ_OPEN

| | |
|---|---|
| Overview: | This event is used to open a specific device driver or file. |
| | The entity being opened is identified by a path specified |
| | with the event. The format of the path is defined by the |
| | operating system. |
| Description: | Open a device or file object. |
| Event Bus | EVENT (B_EV_DIO) |
| Definition: | |

| | | |
|---|---|---|
| cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p, |

// [bytes]

| | END_EVENT | |
|---|---|---|
| Data: | dev_id | device instance identification (see note |
| | | #2 above) |
| | buf_p | name of object to open (may be NULL) |
| | | (see note #7) |
| | buf_len | length of data pointed to by ‘buf_p’ |
| | | (without the terminating 0), [bytes] |
| | buf_h | device handle to pass on subsequent |
| | | operations (out) |
| Return | CMST_NOT_FOU | specified object not found |
| Status: | ND | |
| | CMST_ACCESS_{—} | object already open (if multiple opens |
| | DENIED | are not supported) |

| | |
|---|---|
| Remarks: | Named object support and the naming conventions are |
| | outside the scope of this interface. If DIO_A_UNICODE is |
| | specified, buf_p is to be interpreted as WCHAR * and the |
| | string may not be 0-terminated. |

EV_DIO_RQ_CLEANUP

| | |
|---|---|
| Overview: | This request is sent to cancel all pending operations on a |
| | specific device driver and to prepare it for closing. |
| Description: | Cancel all pending operations, prepare for close. |
| Event Bus | EVENT (B_EV_DIO) |
| Definition: | |

| | | |
|---|---|---|
| cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p. |

// [bytes]

END_EVENT

| | | |
|---|---|---|
| Data: | dev_id | device instance identification (see note |
| | | #2 above) |
| | dev_h | device handle from ‘open’ |
| Return | CMST_NOT_OPE | object is not open |
| Status: | N | |

| | |
|---|---|
| Remarks: | No operations except ‘close’ should be called after |
| | ‘cleanup’. |

EV_DIO_RQ_CLOSE

| | |
|---|---|
| Overview: | This request is sent to close a specific deivce driver or file. |
| Description: | Close a device object. |
| Event Bus | EVENT (B_EV_DIO) |
| Definition: | |

| | | |
|---|---|---|
| cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | ; // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p. |

// [bytes]

| | END_EVENT | |
|---|---|---|
| Data: | dev_id | device instance identification (see note |
| | | #2 above) |
| | dev_h | device handle from ‘open’ |
| Return | CMST_NOT_OPE | object is not open |
| Status: | N | |
| | CMST_IOERR | I/O error (object is closed anyway) |

EV_DIO_RQ_READ

| | |
|---|---|
| Overview: | This request is sent to read data from a specific device |
| | driver or file. |
| Description: | Read data from device. |
| Event Bus | EVENT (B_EV_DIO) |
| Definition: | |

| | | |
|---|---|---|
| cmstat | cplt_s | ; // completion status |

// (asynchronous completion)

| | | |
|---|---|---|
| dword | ctx | ; // originator's context value |

// (may be IRP)

| | | |
|---|---|---|
| uint32 | dev_id | // device instance |

// identification

| | | |
|---|---|---|
| _hdl | dev_h | ; // device handle |
| uint32 | func | ; // function code (for IOCTL) |

| | |
|---|---|
| LARGE_INTEGER offs | ; // file offset (for block |

// devices)

| | | |
|---|---|---|
| void | *buf_p | ; // pointer to data |
| uint32 | buf_sz | ; // size of buffer pointed to |

// by p, [bytes]

| | | |
|---|---|---|
| uint32 | buf_len | ; // length of data in *buf_p. |

// [bytes]

| | END_EVENT | |
|---|---|---|
| Data: | dev_id | device instance identification (see note |
| | | #2 above) |
| | dev_h | device handle from ‘open’ |
| | offs | file offset (for block devices) |
| | buf_p | buffer pointer |
| | buf_sz | size of buffer, bytes |
| | buf_len | number of bytes read (out) |
| | *buf_p | data read (out) |
| Return | CMST_NOT_OPE | object is not open |
| Status: | N | |
| | CMST_IOERR | I/O error |

| | |
|---|---|
| Remarks: | Reading at end of a stream is usually not considered an |
| | error; in this case the request is completed with buf_len 0 |
| | (or any value less than buf_sz). |

EV_DIO_RQ_WRITE

| | |
|---|---|
| Overview: | This request is sent to write data to a specific device |
| | driver or file. |
| Description: | Write data to device. |
| Event Bus | EVENT (B_EV_DIO) |
| Definition: | |

| cmstat | cplt_s | ; | // completion status |
|---|---|---|---|
| | | | // (asynchronous |
| | | | completion) |
| dword | ctx | ; | // originator's context value |
| | | | // (may be IRP) |
| uint32 | dev_id | ; | // device instance |
| | | | // identification |
| _hdl | dev_h | ; | // device handle |
| uint32 | func | ; | // function code (for |
| | | | IOCTL) |
| LARGE_INTEGER offs | | ; | // file offset (for block |
| | | | // devices) |
| void | *buf_p | ; | // pointer to data |
| uint32 | buf_sz | ; | // size of buffer pointed to |
| | | | // by p, [bytes] |
| uint32 | buf_len | ; | // length of data in *buf_p, |
| | | | // [bytes] |

| | END_EVENT | |
|---|---|---|
| Data: | dev_id | device instance identification (see |
| | | note #2 above) |
| | dev_h | device handle from ‘open’ |
| | offs | file offset (for block devices) |
| | buf_p | pointer to data to be written |
| | buf_sz | number of bytes to write |
| | buf_len | number of bytes written (out) |
| Return | CMST_NOT_OPEN | object is not open |
| Status: | | |
| | CMST_IOERR | I/O error |
| | CMST_FULL | media full (for block devices only) |

EV_DIO_RQ_IOCTL

| | |
|---|---|
| Overview: | This request is sent to execute a specific operation on a |
| | device driver. The operation is defined by the driver. This |
| | type of I/O control can be sent to a driver by another |
| | driver or an application (user-mode). |
| Description: | Execute an I/O control operation on a device. |
| Event Bus | EVENT (B_EV_DIO) |
| Definition: | |

| cmstat | cplt_s | ; | // completion status |
|---|---|---|---|
| | | | // (asynchronous |
| | | | completion) |
| dword | ctx | ; | // originator's context value |
| | | | // (may be IRP) |
| uint32 | dev_id | ; | // device instance |
| | | | // identification |
| _hdl | dev_h | ; | // device handle |
| uint32 | func | ; | // function code (for |
| | | | IOCTL) |
| LARGE_INTEGER offs | | ; | // file offset (for block |
| | | | // devices) |
| void | *buf_p | ; | // pointer to data |
| uint32 | buf_sz | ; | // size of buffer pointed to |
| | | | // by p, [bytes] |
| uint32 | buf_len | ; | // length of data in *buf_p, |
| | | | // [bytes] |

| | | |
|---|---|---|
| | END_EVENT | |
| Data: | dev_id | device instance identifi- |
| | | cation (see note #2 above) |
| | dev_h | device handle from ‘open’ |
| | func | I/O control function code |
| | buf_p | pointer to input data and |
| | | buffer for output data |
| | buf_sz | size of output buffer, bytes |
| | buf_len | length of input and output |
| | | data in bytes |
| Return | CMST_NOT_OPEN | object is not open |
| Status: | | |
| | CMST_IOERR | I/O error |
| | CMST_NOT_SUPPORTED | the specified I/O control |
| | | code is not supported |

| | |
|---|---|
| Remarks: | The definition of the I/O control operations is outside the |
| | scope of this definition. |

EV_DIO_RQ_INTERNAL_IOCTL

| | |
|---|---|
| Overview: | This request is sent to execute a specific internal operation |
| | on a device driver. The operation is defined by the driver. |
| | This type of I/O control can only be sent to a driver from |
| | another driver, not by an application (user-mode). |
| Description: | Execute an internal I/O control operation on a device. |
| Event Bus | EVENT (B_EV_DIO) |
| Definition: | |

| cmstat | cplt_s | ; | // completion status |
|---|---|---|---|
| | | | // (asynchronous |
| | | | completion) |
| dword | ctx | ; | // originator's context value |
| | | | // (may be IRP) |
| uint32 | dev_id | ; | // device instance |
| | | | // identification |
| _hdl | dev_h | ; | // device handle |
| uint32 | func | ; | // function code (for |
| | | | IOCTL) |
| LARGE_INTEGER offs | | ; | // file offset (for block |
| | | | // devices) |
| void | *buf_p | ; | // pointer to data |
| uint32 | buf_sz | ; | // size of buffer pointed to |
| | | | // by p, [bytes] |
| uint32 | buf_len | ; | // length of data in *buf_p, |
| | | | // [bytes] |

| | | |
|---|---|---|
| | END_EVENT | |
| Data: | dev_id | device instance identi- |
| | | fication (see note #2 above) |
| | dev_h | device handle from ‘open’ |
| | func | internal I/O control function |
| | | code |
| | buf_p | pointer to input data and |
| | | buffer for output data |
| | buf_sz | size of output buffer, bytes |
| | buf_len | length of input and output |
| | | data in bytes |
| Return | CMST_NOT_OPEN | object is not open |
| Status: | | |
| | CMST_IOERR | I/O error |
| | CMST_NOT_SUPPORTED | the specified I/O control |
| | | code is not supported |

| | |
|---|---|
| Remarks: | The definition of the I/O control operations is outside the |
| | scope of this definition. |
| | “internal IOCTL” is a Windows NT driver term. Device |
| | IOCTL's can be submitted to drivers by an application or |
| | by another driver. Internal IOCTL's can be submitted only |
| | by other drivers. The main implication is that, for internal |
| | IOCTL's, the buffers are always mapped properly in |
| | system address space (i.e., the buffer pointed by buf_p is |
| | accessible in arbitrary thread context). |

EV_USBCTL_REQ

| | |
|---|---|
| Overview: | This event is used to send vender or class-specific |
| | command requests to a USB device. |
| | This request can complete synchronously or |
| | asynchronously. |
| | This event should never be sent with the |
| | CMEVT_A_SELF_OWNED attribute set. |
| Description: | Send a vendor or class-specific command to a USB device. |
| Event Bus | EVENTX (B_EV_USB_CTLREQ, |

| Definition: | EV_USBCTL_REQ, | | | |
|---|---|---|---|---|
| | CMEVT_A_SELF_CONTAINED, | | | |
| | CMEVT_UNGUARDED) | | | |
| | cmstat | cplt_s | ; | // completion status |
| | uint32 | func | ; | // request type |
| | | | | // (USB_REQ_xxx) |
| | uint32 | n_resv_bits | ; | // additional function bits |
| | | | | // (not used - must be 0) |
| | uint32 | code | ; | // Specifies the USB or |
| | | | | // vendor- defined request |
| | | | | // code for the device |
| | uint32 | value | ; | // Is a value, specific to |
| | | | | // Request, that becomes |
| | | | | // part of the USB-defined |
| | | | | // setup packet for the |
| | | | | // device |
| | uint32 | index | ; | // Specifies the device- |
| | | | | // defined identifier for |
| | | | | // the request |
| | uint32 | data_len | ; | // length of the data in the |
| | | | | // buffer |
| | uint32 | data_sz | ; | // data buffer size |
| | byte | data[1] | ; | // data buffer |

END_EVENTX

| | | |
|---|---|---|
| In: | attr | USB_A_XFER_TO_xxx |
| | | specifies the control request |
| | | direction |
| | func | function number (must be one of |
| | | URB_FUNCTION_VENDOR_xxx |
| | | or |
| | | URB_FUNCTION_CLASS_xxx) |
| | code | Specifies the USB or vendor- |
| | | defined request code for the device |
| | value | specific to code value |
| | index | specifies the device-defined |
| | | identifier for the request |
| | data_len | length of the data in the buffer |
| | | (only for |
| | | USB_A_XFER_TO_DEVICE |
| | | requests) |
| | data_sz | data buffer size |
| | data | data buffer variable size |
| Out: | cplt_s | completion status |
| | len | data_len |
| | data | returned from |
| | | USB_A_XFER_TO_HOST |
| | | requests data |
| Return | CMST_PENDING | callee assumes responsibility to |
| Status: | | complete the request later (either |
| | | directly or by sending back an |
| | | EV_USBCTL_REQ event) |

EV_USB_ENABLE

| | |
|---|---|
| Overview: | This event is sent to enable the isochronous USB stream. |
| | This request can complete synchronously or |
| | asynchronously. |
| | This event should never be sent with the |
| | CMEVT_A_SELF_OWNED attribute set. |
| Description: | Enable isochronous USB stream. |

| | |
|---|---|
| Event Bus | EVENTX (B_EV_USBCTL, |

| | |
|---|---|
| Definition: | EV_USB_ENABLE, |
| | CMEVT_A_ASYNC_CPLT \| |

CMEVT_A_SELF_CONTAINED |

CMEVT_A_SYNC, CMEVT_UNGUARDED)

| | | | |
|---|---|---|---|
| cmstat | cplt_s | ; | // completion status |
| uint32 | frame_no | ; | // isochronous frame |
| | | | number |

to

| | | | |
|---|---|---|---|
| | | | // start from |
| bool32 | asap | ; | // TRUE - start ASAP. |
| | | | FALSE |

-

| | | | |
|---|---|---|---|
| | | | // use 0.frame_no to |
| | | | start from |
| uint32 | cfg_no | ; | // configuration number. |
| | | | Not |
| | | | // used. |
| | | | // (must be −1 undefined) |

| | | |
|---|---|---|
| | END_EVENTX | |
| In: | frame_no | isochronous frame number to start |
| | | from. (only if asap is FALSE) |
| | asap | TRUE - enable ASAP, ignoring the |
| | | frame_number. |
| Out: | cplt_s | enable completion status |
| Return | CMST_PENDING | callee assumes responsibility to |
| Status: | | complete the request later (either |
| | | directly or by sending back an |
| | | EV_USB_ENABLE event) |

EV_USB_DISABLE

| | |
|---|---|
| Overview: | This event is sent to disable the isochronous USB stream. |
| | This request can complete synchronously or |
| | asynchronously. |
| | This event should never be sent with the |
| | CMEVT_A_SELF_OWNED attribute set. |
| Description: | Disable isochronous USB stream. |

| | |
|---|---|
| Event Bus | EVENTX (B_EV_USBCTL, |

| | |
|---|---|
| Definition: | EV_USB_DISABLE, |
| | CMEVT_A_ASYNC_CPLT \| |

CMEVT_A_SELF_CONTAINED |

CMEVT_A_SYNC, CMEVT_UNGUARDED)

| | | | |
|---|---|---|---|
| cmstat | cplt_s | ; | // completion status |
| uint32 | frame_no | ; | // isochronous frame |
| | | | number |

to

| | | | |
|---|---|---|---|
| | | | // start from |
| bool32 | asap | ; | // TRUE - start ASAP. |
| | | | FALSE |

-

| | | | |
|---|---|---|---|
| | | | // use 0.frame_no to |
| | | | start from |
| uint32 | cfg_no | ; | // configuration number. |
| | | | Not |
| | | | // used. |
| | | | // (must be −1 undefined) |

END_EVENTX

| | | |
|---|---|---|
| In: | void | |
| Out: | cplt_s | disable completion status |
| Return | CMST_PENDING | callee assumes responsibility to |
| Status: | | complete the request later (either |
| | | directly or by sending back an |
| | | EV_USB_DISABLE event) |

EV_STM_DATA

| | |
|---|---|
| Overview: | This event is sent to submit an isochronous USB data |
| | frame. |
| | This request can complete synchronously or |
| | asynchronously. |
| | This event should never be sent with the |
| | CMEVT_A_SELF_OWNED attribute set. |
| Description: | Submit an isochronous USB data frame. |

| | |
|---|---|
| Event Bus | EVENTX (B_EV_STM_DATA, |

| | |
|---|---|
| Definition: | EV_STM_DATA, |
| | CMEVT_A_ASYNC_CPLT \| |

CMEVT_A_SELF_CONTAINED |

CMEVT_A_SYNC,

| CMEVT_UNGUARDED) | | | |
|---|---|---|---|
| cmstat | cplt_s | ; | // data completion status |
| uint32 | frame_no | ; | // current isochronous |
| | | | frame |
| | | | // number |
| uint32 | data_len | ; | // data length |
| uint32 | data_sz | ; | // data buffer size |
| _ctx | owner_ctx | ; | // owner context |
| byte | data[1] | ; | // data buffer (variable |
| | | | size) |

END_EVENTX

| | | |
|---|---|---|
| In: | frame_no | current isochronous frame number |
| | owner_ctx | owner context |
| | data_len | data length |
| | data_sz | data buffer size |
| | data | submitted out data |
| | data | data buffer (variable size) |
| Out: | cplt_s | current status |
| | owner_ctx | owner context (caller supplied) |
| Return | CMST_PENDING | callee assumes responsibility to |
| Status: | | complete the request later (either |
| | | directly or by sending back an |
| | | EV_USB_DISABLE event) |

EV_VXD_INIT

| | |
|---|---|
| Overview: | This packaging event is used to signal that the virtual |
| | device was loaded by the system and can perform its |
| | initialization tasks. |
| Description: | Initialize virtual device |
| Event Bus | EVENT ( B_EV_VXD ) |

| | | |
|---|---|---|
| Definition: | dword msg; | // control message (value of EAX |
| | | register) |
| | dword ebx; | // value of EBX register |
| | dword ecx; | // value of ECX register |
| | dword edx; | // value of EDX register |
| | dword esi; | // value of ESI register |
| | dword edi; | // value of EDI register |
| | dword retval; | // value to return |
| | | // (also affects carry flag) |

| | | |
|---|---|---|
| | END_EVENT | |
| Data: | void | |
| Return | CMST_OK | initialized OK |
| Status: | | |
| | any other | initialization failed |

| | |
|---|---|
| Remarks: | This event is issued at thread time, before |
| | SYS_DYNAMIC_DEVICE_INIT (for dynamic VxDs) or |
| | DEVICE_INIT (for static VxDs). |
| | Some EV_VXD_MESSAGE events may be sent before |
| | this event. |
| See Also: | EV_VXD_CLEANUP |

EV_VXD_CLEANUP

| | |
|---|---|
| Overview: | This packaging event is used to signal that the virtual |
| | device is about to be unloaded by the system and should |
| | perform its cleanup tasks. |
| Description: | Cleanup virtual device |
| Event Bus | EVENT ( B_EV_VXD ) |

| | | |
|---|---|---|
| Definition: | dword msg; | // control message (value of EAX |
| | | register) |
| | dword ebx; | // value of EBX register |
| | dword ecx; | // value of ECX register |
| | dword edx; | // value of EDX register |
| | dword esi; | // value of ESI register |
| | dword edi; | // value of EDI register |
| | dword retval; | // value to return |
| | | // (also affects carry flag) |

| | | |
|---|---|---|
| | END_EVENT | |
| Data: | void | |
| Return | CMST_OK | cleanup completed, OK to unload |
| Status: | | |
| | any other | cleanup failed - don't unload |

| | |
|---|---|
| Remarks: | This event is issued at thread time, after the |
| | SYS_DYNAMIC_DEVICE_EXIT. It is not sent for static |
| | VxDs. |
| See Also: | EV_VXD_INIT |

EV_VXD_MESSAGE

| | |
|---|---|
| Overview: | This packaging event is used to distribute raw VxD |
| | messages as they are sent by the system. |
| Description: | Raw message needs processing |
| Event Bus | EVENT ( B_EV_VXD ) |

| | | |
|---|---|---|
| Definition: | dword msg; | // control message (value of EAX |
| | | register) |
| | dword ebx; | // value of EBX register |
| | dword ecx; | // value of ECX register |
| | dword edx; | // value of EDX register |
| | dword esi; | // value of ESI register. |
| | dword edi; | // value of EDI register |
| | dword retval; | // value to return |
| | | // (also affects carry flag) |

| | |
|---|---|
| | END_EVENT |
| Data: | void |
| Return | <see Remarks> cleanup completed, OK to unload |
| Status: | |
| Remarks: | This event may come in any context, including on |
| | disabled interrupts. |
| | Upon return, the status and retval are interpreted the |
| | following way: |

for all control messages except

PNP_NEW_DEVNODE and
W32_DEVICEIOCONTROL:

If returned status is not CMST_OK: EAX is

set to 0, carry set

If returned status is CMST_OK, EAX is set

to retval and

If retval is non-zero (VXD_SUCCESS), carry

is cleared

If retval is zero (VXD_FAILURE), carry is

set to indicate error

for the PNP_NEW_DEVNODE and

W32_DEVICEIOCONTRQL control
messages

If returned status is not CMST_OK: EAX is

set to -1, carry set

If returned status is CMST_OK, EAX is set

to retval and

If retval is zero

(CR_SUCCESS/DEVIOCTL_NOERROR),
carry clear

If retval is non-zero, carry is set to indicate

error

Note that, on W32_DEVICEIOCONTROL, retval has the
following meanings:

0 - success
−1 - operation accepted for asynchronous

processing

any other - error

EV_DRV_INIT

| Overview: | This packaging event is used to signal that the driver was |
|---|---|
| | loaded by the system and can perform its initialization |
| | tasks. |
| Description: | Initialize driver |
| Event Bus | EVENT (B_EV_DRV) |

| | |
|---|---|
| Definition: | NTSTATUS ns; |

| | END_EVENT | |
|---|---|---|
| Data: | ns | status that DriverEntry will return on |
| | | failure |
| Return | CMST_OK | initialized OK |
| Status: | | |
| | any other | initialization failed |

| Remarks: | This event is issued at thread time, IRQ level passive |
|---|---|
| | The value returned from DriverEntry is determined as |
| | follows: |

if event returned CMST_OK, DriverEntry

returns STATUS_SUCCESS,
regardless of ns

if event returned CMST_FAILED,

DriverEntry returns ns (unless ns is
STATUS_SUCCESS, in which case
DriverEntry returns
STATUS_UNSUCCESSFUL)

if event returned any other status,

DriverEntry returns
STATUS_UNSUCCESSFUL.

| | |
|---|---|
| See Also: | EV_DRV_CLEANUP |

EV_DRV_CLEANUP

| Overview: | This packaging event is used to signal that the driver is |
|---|---|
| | about to be unloaded by the system and should perform |
| | its cleanup tasks. |
| Description: | Cleanup driver |
| Event Bus | EVENT (B_EV_DRV) |

| | |
|---|---|
| Definition: | NTSTATUS ns; |

| | END_EVENT | |
|---|---|---|
| Data: | void | |
| Return | CMST_OK | cleanup OK |
| Status: | | |
| | any other | cleanup failed |

| Remarks: | This event is issued at thread time, IRQ level passive |
|---|---|
| | Regardless of the returned status, the driver will be |
| | unloaded. |
| See Also: | EV_DRV_INIT |

Appendix 3. RDX_CNM_DESC Structure

The connection descriptor comprises a header structure, RDX_CNM_DESC and an array (table) of RDX_CNM_ENTRY structures. When a descriptor is filled in, the tbip field of RDX_CNM_DESC is set to point to the array of the RDX_CNM_ENTRY structures.

typedef struct RDX_CNM_DESC

| | |
|---|---|
| { | |
| dword | sig; // signature |
| uint16 | sz; // size of the header |
| uint16 | esz; // size of a single entry |
| uint16 | n_entries; // # of entries in the table |
| fig16 | attr; // table attributes [defined w/table] |
| const void | *tblp; // table of entries or NULL if none |

} RDX_CNM_DESC;

// attributes
#define RDX_CNM_E_NONE 0
// entry types
#define RDX_CNM_E_NONE 0 // not initialized
#define RDX_CNM_A_SIMP 1 // connection entry
// connection table entry
typedef struct RDX_CNM_ENTRYtag

| | |
|---|---|
| { | |
| WORD | et; // entry type |
| DWORD | et_ctx; // entry type context |

| | |
|---|---|
| char | *lnamep; // left part name |
| char | *ltermp; // left terminal name |
| char | *rnamep; // right part name |
| char | *rtermp; // right terminal name |

| | |
|---|---|
| DWORD | attr; // attributes [RDX_CNM_A_xxx] |
| DWORD | ctx; // attribute dependent context |
| DWORD | usr_ctx; // user context |

} RDX_CNM_ENTRY;

Appendix 4. I_R_ECON Interface

| /* -------------------------------------------------------------------------- */ | | |
|---|---|---|
| /* | RFC: Radix Interface | */ |

| | |
|---|---|
| /* | */ |

| | | |
|---|---|---|
| /* | I_R_ECON.H - RMC Connection Enumeration Interface | */ |

| /* -------------------------------------------------------------------------- */ | |
|---|---|
| /* Version 1.00 | */ |

| /* -------------------------------------------------------------------------- */ | |
|---|---|
| /* Copyright (c) 1998 Object Dynamics Corp. All Rights Reserved. | */ |

| | |
|---|---|
| /* | */ |

| | |
|---|---|
| /* Use of copyright notice does not imply publication or disclosure. | */ |

/* THIS SOFTWARE CONTAINS CONFIDENTIAL AND PROPRIETARY

| | |
|---|---|
| INFORMATION | */ |

/* CONSTITUTING VALUABLE TRADE SECRETS OF OBJECT DYNAMICS CORP.,

| | |
|---|---|
| AND | */ |

/* MAY NOT BE (a) DISCLOSED TO THIRD PARTIES. (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

/* -------------------------------------------------------------------------- */

#ifndef _{——}I_R_ECON_H_DEFINED__
#define _{——}I_R_ECON_H_DEFINED__
/* --- Connection Enumeration Definitions ----------------------------------- */
// contract id
#define CID_R_ECON 0×570
// connection bus
BUS (B_R_ECON)

| | |
|---|---|
| RDX_CNM_DESC | *cdscp ; // connection list descriptor |

| | |
|---|---|
| char | *part_nmp ; // part name |
| char | *term_nmp ; // terminal name |
| _ctx | qry_ctx ; // query context |
| _hdl | conn_h ; // connection handle |
| char | *part_bufp ; // pointer to part name buffer |
| uint | part_buf_sz ; // part name buffer size |
| char | *term_bufp ; // pointer to terminal name buffer |
| uint | term_buf_sz ; // terminal name buffer size |
| char | *part2_bufp ; // pointer to part #2 name buffer |
| uint | part2_buf_sz ; // part name #2 buffer size |
| char | *term2_bufp ; // pointer to terminal #2 name buffer |
| uint | term2_buf_sz ; // terminal name #2 buffer size |
| bool | split_loops; // TRUE to split loop connections |

END_BUS
/* --- Connection Enumeration Vtable Interface ------------------------------ */
DECLARE_INTERFACE (I_R_ECON)

operation (qry_open , B_R_ECON)
operation (qry_reset , B_R_ECON)
operation (qry_next , B_R_ECON)
operation (qry_prev , B_R_ECON)
operation (qry_curr , B_R_ECON)
operation (qry_close , B_R_ECON)
operation (get_info , B_R_ECON)

END_DECLARE_INTERFACE // I_R_ECON
/* --- Description Of Connection Enumeration Interface ---------------------- */
// on : qry_open
// in : cdscp - connection list descriptor

| | |
|---|---|
| // | part_nmp - part name to be matched |
| // | term_nmp - terminal name to be matched |
| // | split_loops - TRUE to present loops as two connections |

// out: qry_ctx - query context for subsequent qry_xxx operations
// act: open a new query on the connection namespace
// s : ST_NO_ROOM - too many open queries
// on : qry_reset
// in : cdscp - connection list descriptor

| | |
|---|---|
| // | qry_ctx - query context from previous qry_xxx operations |

// out : qry_ctx - query context for subsequent qry_xxx operations
// act : reset the current position to the beginning of the connection sub-space
// nb : ST_OK is returned even if there are no connections defined in the

| | |
|---|---|
| // | connection sub-space |

// on : qry_next
// in : cdscp - connection list descriptor

| | |
|---|---|
| // | part_bufp - buffer for part name or NULL |
| // | part_buf_sz - size of part name buffer, [bytes] |
| // | term_bufp - buffer for terminal name or NULL |
| // | term_buf_sz - size of terminal #2 name buffer, [bytes] |
| // | part2_bufp - buffer for part #2 name or NULL |
| // | part2_buf_sz - size of part #2 name buffer, [bytes] |
| // | term2_bufp - buffer for terminal #2 name or NULL |
| // | term2_buf_sz - size of terminal name buffer, [bytes] |
| // | qry_ctx - query context from previous qry_xxx operations |

// out :(*part_bufp) - part name

| | |
|---|---|
| // | (*term_bufp) - terminal name |
| // | (*part2_bufp) - part #2 name |
| // | (*term2_bufp) - terminal #2 name |
| // | qry_ctx - query context for subsequent qry_xxx operations |
| // | conn_h - connection handle |

// act : get next connection according to the query context

| | |
|---|---|
| // | the current enumeration context |

// s : ST_NOT_FOUND - no next connection in the sub-space

| | |
|---|---|
| // | ST_OVERFLOW - buffer too small for part or terminal name |

// on : qry_prev
// in : cdscp - connection list descriptor

| | |
|---|---|
| // | part_bufp - buffer for part name or NULL |
| // | part_buf_sz - size of part name buffer, [bytes] |
| // | term_bufp - buffer for terminal name or NULL |
| // | term_buf_sz - size of terminal name buffer, [bytes] |
| // | part2_bufp - buffer for part #2 name or NULL |
| // | part2_buf_sz - size of part #2 name buffer, [bytes] |
| // | term2_bufp - buffer for terminal #2 name or NULL |
| // | term2_buf_sz - size of terminal name buffer, [bytes] |
| // | qry_ctx - query context from previous qry_xxx operations |

// out :(*part_bufp) - part name

| | |
|---|---|
| // | (*term_bufp) - terminal name |
| // | (*part2_bufp) - part #2 name |
| // | (*term2_bufp) - terminal #2 name |
| // | qry_ctx - query context for subsequent qry_xxx operations |
| // | conn_h connection handle |

// act : get previous connection according to query context
// s : ST_NOT_FOUND - no previous connection in the sub-space

| | |
|---|---|
| // | ST_OVERFLOW - buffer too small for part or terminal name |

// on : qry_curr
// in : cdscp - connection list descriptor

| | |
|---|---|
| // | part_bufp - buffer for part name or NULL |
| // | part_buf_sz - size of part name buffer, [bytes] |
| // | term_bufp - buffer for terminal name or NULL |
| // | term_buf_sz - size of terminal name buffer, [bytes] |
| // | part2_bufp - buffer for part #2 name or NULL |
| // | part2_buf_sz - size of part #2 name buffer, [bytes] |
| // | term2_bufp - buffer for terminal #2 name or NULL |
| // | term2_buf_sz - size of terminal name buffer, [bytes] |
| // | qry_ctx - query context from previous qry xxx_operations |

// out :(*part_bufp) - part name

| | |
|---|---|
| // | (*term_bufp) - terminal name |
| // | (*part2_bufp) - part #2 name |
| // | (*term2_bufp) - terminal #2 name |
| // | qry_ctx - query context for subsequent qry_xxx operations |
| // | conn_h - connection handle |

// act : get previous connection according to query context
// s : ST_NOT_FOUND - no previous connection in the sub-space

| | |
|---|---|
| // | ST_OVERFLOW - buffer too small for part or terminal name |

// on : qry_close
// in : qry_ctx - query context from previous qry_xxx operations
// out : void
// act : close query on the connection namespace
// nb : “qry_ctx”becomes invalid after this operation
// on : get_info
// in : cdscp - connection list descriptor

| | |
|---|---|
| // | part_bufp - buffer for part name or NULL |
| // | part_buf_sz - size of part name buffer, [bytes] |
| // | term_bufp - buffer for terminal name or NULL |
| // | term_buf_sz - size of terminal name buffer, [bytes] |
| // | part2_bufp - buffer for part #2 name or NULL |
| // | part2_buf_sz - size of part #2 name buffer, [bytes] |
| // | term2_bufp - buffer for terminal #2 name or NULL |
| // | term2_buf_sz - size of terminal name buffer, [bytes] |
| // | conn_h - connection handle |

// out :(*part_bufp) - part name

| | |
|---|---|
| // | (*term_bufp) - terminal name |
| // | (*part2_bufp) - part #2 name |
| // | (*term2_bufp) - terminal #2 name |

// act : get information about particular connection
// s : ST_OVERFLOW - buffer too small for part or terminal name
#endif // __I_R_ECON_H_DEFINED_{——}

Appendix 5. DM_ARR Part Implementation Design

Structures Used

1.1. Summary

This section contains a summary of the main data structures used in DM_ARR.

// virtual property table entry
typedef struct VPROP

{
char *namep; // name of the property
uint 16 type; // property data type
void *valp; // pointer to value
uint32 len; // length of the value
} VPROP;

// virtual terminal table entry
typedef struct VTERM

{
char name[MAX_TERM_NM_SZ]; // virtual terminal
name
bool connected; // TRUE if terminal connected from outside
byte conn_ctx[CONN_CTX_SZ]; // connection context
} VTERM;

// connection index
typedef struct CONN_NDX

{
_ctx qry_ctx; // current connection context
_hdl vth; // virtual terminal handle

} CONN_NDX;

// property enumeration state
enum S_PROP_QRY

{
S_PQ_ARRAY, // array properties
S_PQ_VIRT_PROP, // virtual properties
S_P0_SUBS, // properties of subordinates
};

// query state for S_PQ_ARRAY state
typedef struct PQ_ARRAY

{
_ctx pctx; // current property enum. ctx
} PQ_ARRAY;

// query state for S_PQ_VIRT_PROP state
typedef struct PQ_VPROP

{
_ctx enum_ctx; // current virt. prop. enum ctx
} PQ_VPROP;

// query state for S_PQ_SUBS state
typedef struct PQ_SUBS

{
_ctx key_pctx; // propety enum. context of subordinate.
} PQ_SUBS;

// property query state
typedef struct PROP_QRY
{
// enumeration state
S_PROP_QRY state;
// query state depending on the state
union PQ_ENUM_STATE

{
PQ_ARRAY;
PQ_VPROP;
PQ_SUBS;

} PROP_QRY;

CONN_NDX - Connection Index

typedef struct CONN_NDX

{
_hdl conn_h; // connection handle
VTERM *vtp; // virtual terminal instance ID (NULL if

not virtual)

bool left; // TRUE if the array terminal is on the left side
// of the connection (as per get info)
} CONN_NDX;

The DM_ARR uses this structure to maintain the index entry for connection [symbol] terminal map. Instances of this structure are allocated by the array and added to a handle set using the ClassMagic API.

No random access is needed to this index and for this reason the handle values associated with each instance of this structure are not stored anywhere. Only enumeration of these instances is possible which provided by the ClassMagic API for handle management.

S_PROP_QRY—Enumeration States

enum S_PROP_QRY

| | |
|---|---|
| { | |
| S_PQ_ARRAY, | // array properties |
| S_PQ_VPROP, | // virtual properties |
| S_PQ_SUBS, | // properties of subordinates |
| }; | |

The property query state machine uses this enumerated type to determine the next state in the enumeration. Each state is associated with a class of properties currently being enumerated. As the array implements joined name spaces for these classes, the state is needed to identify the current one.

The transition is purely sequential in the order in which these states are defined. Backward enumeration of properties and therefore backward state transition are not possible.

PQ_ARRAY—Property Query Context in the S_PQ_ARRAY state

typedef struct PQ_ARRAY

| | |
|---|---|
| { | |
| _ctx | enum_ctx; // current property enum. ctx |

} PQ_ARRAY;

This structure represents the property query context in S_PQ_ARRAY state. This is the state in which the properties listed on enumeration are these defined on the array itself, skipping properties whose names begin with “._”.

PQ_VPROP—Property Query Context in the S_PQ_VPROP State

typedef struct PQ_PROP

| | |
|---|---|
| { | |
| _ctx | enum_ctx; // current virt. prop. enum. ctx |

} PQ_VPROP;

This structure represents the property query context in S_PQ_VPROP state. This is the state in which the virtual properties are listed on enumeration.

The context is the one returned by the virtual property enumeration helper API.

PQ_SUBS—Property Query Context in the S_PQ_SUBS State

typedef struct PQ_SUBS

{
_ctx enum_ctx; // part array enumeration context
bool curr_1 st; // TRUE to start from the first property
dword curr_oid; // current subordinate in the array
_ctx curr_qryh; // query handle on current subordinate
} PQ_SUBS;

This structure represents the property query context in S_PQ_SUBS state. This is the state in which the properties of subordinates (elements) of the array are listed on enumeration.

Both the current subordinate and the property enumeration context on that subordinate are kept. There is also an indication whether the enumeration has to start from the first property of the current element or to continue from the current one.

PROP_QRY—General Property Query Context

typedef struct PROP_QRY

{
uint state; // enumeration state
flg32 attr_mask; // query attributes mask
flg32 attr_val; // query attributes values
union PQ_ENUM_STATE // query state depending on the state

{
PQ_ARRAY array;
PQ_VPROP vprop;
PQ_SUBS subs;
};

} PROP_QRY;

This structure represents the composite property query instance. It combines the current state of property enumeration in a query instance together with the particular contexts for each individual state. It is assumed that there is no context shared between different states.

Self Data Structure

BEGIN_SELF

| DM_ARR_HDR arr; // Part Array from DriverMagic | |
|---|---|
| VECON vtc; // virtual terminals container | |
| VECON vpc; // virtual properties container | |
| VTDST vtd; // virtual terminal operation distributor | |
| VPDST vpd; // virtual property operation distributor | |
| _hdl cnx; // connection index owner key | |
| _hdl qry; // queries owner key | |
| I_META * host_imetap; | // host meta-object interface |
| | // used to resolve subordinate name to old |
| I_R_ECON *iecnp; // connection enumeration interface | |
| | // used to enumerate the connections in the host |
| RDX_CNM_DESC *cdscp; | // connection descriptor in the host |

| PROPERTIES | | |
|---|---|---|
| RDX_SID sid; | | // self ID of the host |
| bool | auto activate; | // TRUE to auto-activate |
| bool | gen_keys; | // TRUE to generate keys |

| | |
|---|---|
| char | name [RDX_MAX_PRT_NM_LEN + 1]; // array name |
| char | cls_nm[RDX_MAX_PRT_NM_LEN + 1]; // default class name |
| char | _fact [RDX_MAX_TRM_NM_LEN + 1]; // ‘fact’ terminal name |
| char | _prop [RDX_MAX_TRM_NM_LEN + 1]; // ‘prop’ terminal name |
| char | _conn [RDX_MAX_TRM_NM_LEN + 1]; // ‘conn’ terminal name |

TERMINALS
decl_input (fact, I_A_FACT)
decl_input (prop, I_A_PROP)
decl_input (conn, I_A_CONN)

END_SELF

State Machine Organization

State machine is used for property enumeration. The input events are three: “reset”, “next” and “current”. The machine performs sequential state transition in the order in which the states are defined. Transition to initial state is possible at any state and will happen if “reset” event is received.

The input events are declared in the following enumerated type:

enum PQ_EVENT

{
PQ_EV_RESET = 0,
PQ_EV_NEXT = 1,
PQ_EV_CURR = 2,
};

All events are fed into a state machine controller—a static function responsible to invoke the proper action handler as defined in the state transition table. The action handler is responsible to perform the state transition before it returns to the controller.

The prototype of such action handler is shown bellow:

typedef_stat pq_ahdir (PROP_QRY *sp, SELF *selfp, B_PROPERTY *bp);

The state machine event feeder (controller) prototype is shown here:

static_stat pq_sm_feed (PROP_QRY *sp, SELF *selfp, uint ev, B_PROPERTY *bp);

The state transition table associates three action handlers for each state: “reset”, “next” and “current” action handlers.

typedef struct SM_TBL_ENTRY

| | |
|---|---|
| { | |
| pq_ahdlr | *reset_hdlrp; |
| pq_ahdlr | *next_hdlrp; |
| pq_ahdlr | *curr_hdlrp; |

} SM_TBL_ENTRY;

State Transition Table:

static SM_TBL_ENTRY g_sm_table [] =

{

/* PQ_EV_RESET *//* PQ_EV_NEXT *//* PQ_EV_NEXT */

| | | |
|---|---|---|
| /* S_PQ_ARRAY */ ah_reset | , ah_arr_next | , ah_arr_curr , |
| /* S_PQ_VPROP */ ah_reset | , ah_vp_next | , ah_vp_curr , |
| /* S_PQ_SUBS */ ah_reset | , ah_subs_next | , ah_subs_curr , |
| }; | | |

Pseudo-Code

Life Cycle

Constructor

in: void

out: void

initialize property defaults

create unique owner id for the connection index

create unique owner id for the property queries

Destructor

in: void

out: void

destroy connection index owner id

destroy property queries owner id

Activation

in: void

out: void

retrieve host information

connection descriptor→sp->cdscp

connection enumeration interface→sp->iecnp

host's meta object interface→sp->host_imetap

build connection index

open query on connections to ‘sp->name’

enumerate connections, for each connection:

find virtual terminal with such name

stop if error

determine which end of the connection the array (we) are

get connection table entry using the connection handle returned by the enumeration

compute left:=(‘sp->name’ is the left part)

allocate connection index entry on behalf of the host (using the interior object ID)→cip

initialize entry:

handle of the connection

virtual terminal ID or NULL if not virtual

left

create a handle for the entry using ‘sp->cnx’ and associate it with the ‘cip’

close query on connections

on failure in adding connection to connection index, cleanup:

enumerate handles with ‘sp->cnx’ onwer, for each

lock handle, retrieve entry pointer [continue]

free entry pointer

destroy handle locked

return failure status

construct sub-entities in a composite operation

construct Part Array instance ‘sp->arr’

construct virtual terminals container ‘sp->vtc’

construct virtual properties container ‘sp->vpc’

construct virtual property distributor ‘sp->vpd’

construct virtual terminal distributor ‘sp->vtd’

end composite operation

on composite operation error, cleanup:

destruct Part Array instance [ignore]

destruct virtual terminals container [ignore]

destruct virtual properties container [ignore]

destruct virtual property distributor [ignore]

destruct virtual terminal distributor [ignore]

return failure status

return ST_OK

Deactivation

in: void

out: void

destruct Part Array instance

destruct virtual properties container

destruct virtual terminals container

destruct virtual property distributor

destruct virtual terminal distributor

destroy connection index

enumerate connection index, for each entry

lock handle, retrieve index entry

free

destroy handle (locked)

Public: “fact” terminal

Create

| in: | attr | - attributes [A_FACT_A_XXX] |
|---|---|---|
| | namep | - class name of part or NULL for default |
| | id | - id to use if A_FACT_A_USE_ID is set |
| out: | id | - id of the created part in the array |
| act: | Create a part instance in the array | |
| s: | CMST_OK | - successful |

CMST_CANT_BIND - the part class was not found
CMST_ALLOC - not enough memory
CMST_NO_ROOM - no more ids available (if

A_FACT_A_USE_ID not set)

CMST_DUPLICATE - the specified id already exists (if

A_FACT_A_USE_ID)

(all others) - specific error occurred during object

creation

if “attr” has A_FACT_A_USE_ID set

create element in the Part Array using the id in the bus [if_ret]

else

create element in the Part Array by generating a id [if_ret]

store element id→el_id

retrieve object id of the new element→el_oid

retrieve our interior oid→int_oid

enumerate connection index using ‘sp->cnx’, for each entry in the index:

lock handle to retrieve entry

retrieve connection table information from “cip->h’ (using ‘sp->i_ecnp’]

part1

term1

part2

term2

if connection is to a virtual terminal (‘cip->vtp’ !=NULL):

use ClassMagic connection broker API to connect the element terminal to the terminal on the DM_ARR interior:

oid1:=int_oid

term1:=cip->vtp->namep

oid2:=el_oid

term2:=cip->vtp->namep

conn_id:=el_id

[cleanup: destroy Part Array element]

else connect to terminal in the host's interior

retrieve object id of the part in the interior from the sp->host_imetap:

part name:=cip->left ? part2: part1

part name→part oid

use Part Array connection broker API to connect the element terminal to the terminal in the host's interior:

array id:=element array id

array term:=left ? term1: term2

oid:=part oid

term name:=left ? term2: term1

unlock handle

[common cleanup: destroy Part Array element]

set all current virtual properties to the new element

enumerate virtual property container, for each virtual property

use part array API to set the virtual property value into the array element

auto-activate new element if needed

pass ‘el_id’ back to the caller if needed

return ST_OK

Destroy

| | | |
|---|---|---|
| in: | id | - id of part to destroy |
| out: | void | |

| act: | destroy a part instance in the array |
|---|---|
| s: | CMST_OK - successful |
| | CMST_NOT_FOUND - the id could not be found |
| | (all others) - an intermittent error occurred during |

destruction

destroy Part Array element by id (count on automatic connection cleanup)

return ST_OK

Activate

| | | |
|---|---|---|
| in: | id | - id of part to activate |
| out: | void | |

| act: | activate a part instance in the array |
|---|---|
| s: | CMST_OK - successful |
| | CMST_NOT_FOUND - the id was not found |
| | CMST_NO_ACTION - the object is already active |
| | CMST_REFUSE - mandatory properties have not been set or |

terminals not connected

(all others) - as returned by part's activator

redirect to Part Array API

Deactivate

| | | |
|---|---|---|
| in: | id | - id of part to deactivate |
| out: | void | |

| | |
|---|---|
| act: | deactivate a part instance in the array |
| s: | CMST_OK - successful |
| | CMST_NOT_FOUND - the id was not found |
| | (all others) - as returned by part's deactivator |

redirect to Part Array API

Get_first

| | | |
|---|---|---|
| in: | void | |
| out: | id | - id of the first part in the array |
| | ctx | - enumeration context for subsequent get_next |

| | |
|---|---|
| act: | get the first part in the part array |
| s: | CMST_OK - successful |
| | CMST_NOT_FOUND - the array has no parts |

redirect to Part Array API (qry_reset and then qry_next)

Get_next

| | | |
|---|---|---|
| in: | ctx | - enumeration context from previous get_xxx |
| out: | id | - id of next part in the array |
| | ctx | - enumeration context for subsequent get_xxx |

| | |
|---|---|
| act: | get the next part in the part array |
| s: | CMST_OK - successful |
| | CMST_NOT_FOUND - the array has no more parts |

redirect to Part Array API

Public: “prop” Terminal

Get

| | | |
|---|---|---|
| in : | id | - id of part in the array |

| | |
|---|---|
| namep | - null-terminated property name |

| | |
|---|---|
| type | - type of the property to retrieve |
| | or CMPRP_T_NONE for any |
| bufp | - pointer to buffer to receive property or NULL |

| | |
|---|---|
| buf_sz | - size in bytes of *bufp |

| | |
|---|---|
| out:(*bufp) | - property value |

| | |
|---|---|
| val_len | - length in bytes of property value |

| act: | get the value of a property from a part in the array | |
|---|---|---|
| s : | CMST_OK | - successful |

| | |
|---|---|
| CMST_NOT_FOUND | - the property could not be found or the id is invalid |

| | |
|---|---|
| CMST_REFUSE | - the data type does not match the expected type |

| | |
|---|---|
| CMST_OVERFLOW | - the buffer is too small to hold the property value |

redirect to Part Array API

Set

| | | |
|---|---|---|
| in : | id | - id of part in the array |

| | |
|---|---|
| namep | - null-terminated property name |

| | |
|---|---|
| type | - type of the property to set |
| bufp | - pointer to buffer containing property value |
| val_len | - size in bytes of property value |

| out: | void | |
|---|---|---|
| act: | set the value of a property of a part in the array | |
| s : | CMST_OK | - successful |

| | |
|---|---|
| CMST_NOT_FOUND | - the property could not be found |

or the id is invalid

| | |
|---|---|
| CMST_REFUSE | - the property type is incorrect or the |

property cannot be changed while the
part is in an active state

| | |
|---|---|
| CMST_OUT_OF_RANGE | - the property value is not within the |

range of allowed values for this
property

| | |
|---|---|
| CMST_BAD_ACCESS | - there has been an attempt to set a |

read-only property

| | |
|---|---|
| CMST_OVERFLOW | - the property value is too large |

| | |
|---|---|
| CMST_NULL_PTR | - the property name pointer is NULL or an |

attempt was made to set default value
for a property that does not have a
default value

| nb : | for string properties, val_len must include the terminating zero |
|---|---|
| nb : | If bufp is NULL, the function tries to reset the property value to its |
| | default. |

redirect to Part Array API

Chk

| | | |
|---|---|---|
| in : | id | - id of part in the array |

| | |
|---|---|
| namep | - null-terminated property name |

| | |
|---|---|
| type | - type of the property value to check |
| bufp | - pointer to buffer containing property |

value

| | |
|---|---|
| val_len | - size in bytes of property value |

| out: | void | |
|---|---|---|
| act: | check if a property can be set to the specified value | |
| s : | CMST_OK | - successful |

| | |
|---|---|
| CMST_NOT_FOUND | - the property could not be found |

or the id is invalid

| | |
|---|---|
| CMST_REFUSE | - the property type is incorrect or the |

property cannot be changed while the
part is in an active state

| | |
|---|---|
| CMST_OUT_OF_RANGE | - the property value is not within the |

range of allowed values for this
property

| | |
|---|---|
| CMST_BAD_ACCESS | - there has been an attempt to set a |

read-only property

| | |
|---|---|
| CMST_OVERFLOW | - the property value is too large |

| | |
|---|---|
| CMST_NULL_PTR | - the property name pointer is NULL or an |

attempt was made to set default value
for a property that does not have a
default value

redirect to Part Array API

Get_info

| | | |
|---|---|---|
| in : | id | - id of part in the array |

| | |
|---|---|
| namep | - null-terminated property name |

| | | |
|---|---|---|
| out: | type | - type of property [CMPRP_T_XXX] |

| | |
|---|---|
| attr | - property attributes [CMPRP_A_XXX] |

| act: | retrieve the type and attributes of the specified property | |
|---|---|---|
| s : | CMST_OK | - successful |

| | |
|---|---|
| CMST_NOT_FOUND | - the property could not be found |

or the id is invalid

retrieve element oid

redirect to ClassMagic API

Qry_open

| | | |
|---|---|---|
| in : | id | - id of part in the array |

| | |
|---|---|
| namep | - query string (must be “*”) |

| | |
|---|---|
| attr | - attribute values of properties to include |

| | |
|---|---|
| attr_mask | - attribute mask of properties to include |

| | | |
|---|---|---|
| out: | qryh | - query handle |

| | |
|---|---|
| act: | open a query to enumerate properties on a part in the array based upon |

the specified attribute mask and values or CMPRP_A_NONE to
enumerate all properties

| | | |
|---|---|---|
| s : | CMST_OK | - successful |

| | |
|---|---|
| CMST_NOT_FOUND | - the id could not be found or is |

invalid

| | |
|---|---|
| CMST_NOT_SUPPORTED | - the specified part does not support |

property enumeration or does not
support nested or concurrent property
enumeration

| | |
|---|---|
| nb : | To filter by atrributes, specify the set of attributes in attr_mask and their |

desired values in attr. During the enumeration, a bit-wise AND is
performed between the actual attributes of each property and the value
of attr_mask; the result is then compared to attr. If there is an exact
match, the property will be enumerated.

| | |
|---|---|
| nb : | To enumerate all properties of a part, specifiy the query string as “*” and |

attr_mask and attr as 0.

| | |
|---|---|
| nb : | The attribute mask can be one or more of the following: |

| | |
|---|---|
| CMPRP_A_NONE | - not specified |

| | |
|---|---|
| CMPRP_A_PERSIST | - persistent property |

| | |
|---|---|
| CMPRP_A_ACTIVETIME | - property can be modified while |

active

| | |
|---|---|
| CMPRP_A_MANDATORY | - property must be set before |

activation

| | |
|---|---|
| CMPRP_A_RDONLY | - read-only property |

| | |
|---|---|
| CMPRP_A_UPCASE | - force uppercase |

| | |
|---|---|
| CMPRP_A_ARRAY | - property is an array |

retrieve element oid

redirect to ClassMagic API

Qry_first

| in : | qryh | - query handle returned on qry_open |
|---|---|---|
| | bufp | - storage for the returned property name or NULL |

| | |
|---|---|
| buf_sz | - size in bytes of *bufp |

| | |
|---|---|
| out:(*bufp) | - property name (if bufp not NULL) |

| act: | retrieve the first property in a query | |
|---|---|---|
| s : | CMST_OK | - successful |

| | |
|---|---|
| CMST_NOT_FOUND | - no properties found matching current query |

| | |
|---|---|
| CMST_OVERFLOW | - buffer is too small for property name |

retrieve element oid

redirect to ClassMagic API

Qry_next

| in : | qryh | - query handle returned on qry_open |
|---|---|---|
| | bufp | - storage for the returned property name or NULL |

| | |
|---|---|
| buf_sz | - size in bytes of *bufp |

| | |
|---|---|
| out:(*bufp) | - property name (if bufp not NULL) |

| act: | retrieve the next property in a query | |
|---|---|---|
| s : | CMST_OK | - successful |

| | |
|---|---|
| CMST_NOT_FOUND | - there are no more properties that match the |

query criteria

| | |
|---|---|
| CMST_OVERFLOW | - buffer is too small for property name |

retrieve element oid

redirect to ClassMagic API

Qry_curr

| in : | gryh | - query handle returned on qry_open |
|---|---|---|
| | bufp | - storage for the returned property name |

| | |
|---|---|
| buf_sz | - size in bytes of *bufp |

| | |
|---|---|
| out:(*bufp) | -property name (if bufp not NULL) |

| act: | retrieve the current property in a query | |
|---|---|---|
| s : | CMST_OK | - successful |

| | |
|---|---|
| CMST_NOT_FOUND | - no current property (e.g. after a call to qry_open) |

| | |
|---|---|
| CMST_OVERFLOW | - buffer is too small for property name |

retrieve element old

redirect to ClassMagic API

Public: “conn” Terminal

Connect

| | | |
|---|---|---|
| in : | id1 | - id of part 1 |
| | term1_namep | - terminal name of part 1 |
| | id2 | - id of part 2 |
| | term2_namep | - terminal name of part 2 |
| | conn_id | - connection id to represent this connection |

| out: | void | |
|---|---|---|
| act: | connect two terminals between parts in the array | |
| s : | CMST_OK | - successful |
| | CMST_REFUSE | - there has been an interface or direction |

mismatch or an attempt has been made to connect a
non-active-time terminal when the part is in an
active state

| | |
|---|---|
| CMST_NOT_FOUND | - at least one of the terminals could |

not be found or one of the ids is invalid

| | |
|---|---|
| CMST_OVERFLOW | - an implementation imposed restriction |

in the number of connections has been exceeded

| | |
|---|---|
| nb : | id1 and id2 may be the same to connect two terminals on the |
| | same part |

retrieve second element oid

redirect to Part Array API

Disconnect

| | | |
|---|---|---|
| in : | id1 | -id of part 1 |
| | term1_namep | - terminal name of part 1 |
| | id2 | - id of part 2 |
| | term2_namep | - terminal name of part 2 |
| | conn_id | - connection id to represent this connection |

| | |
|---|---|
| out: | void |
| act: | disconnect terminals between parts in the array |

| | | |
|---|---|---|
| s : | CMST_OK | - successful |

retrieve second element oid

redirect to Part Array API

Custom: Terminal Mechanism (Exterior)

Acquire

| | | |
|---|---|---|
| in : | namep | - terminal name or NULL |
| | (hdl) | - terminal handle (if namep = = NULL) |
| | conn_id | - connection id or NO_ID |
| out: | context | - connection context |
| | type | - terminal type [TERM_TYPE] |
| | card | - cardinality |
| | sync | - terminal synchronosity |
| | dir | - terminal direction |
| | attr | - terminal attributes |
| | conn_h | - connection handle |

| | |
|---|---|
| act: | acquire connection context |

| | | |
|---|---|---|
| s : | ST_NOT_FOUND | - terminal not found |
| | ST_REFUSE | - component is in inappropriate state |
| | ST_NO_ROOM | - terminal cardinality exhausted |
| | ST_NOP | ‘- operation impossible at this time |
| | ST_OVERFLOW | - provided space for context is not enough |

| | |
|---|---|
| nb : | The connection context structures are ‘tagged’, i.e. the |

first 8 bits contain an identifier of the structure. Any
implementation must check and recognize the ‘tag’ before
it can operate with the rest of the structure.

valchk: namep !=NULL

invoke default terminal implementation

return if anything different than ST_NOT_FOUND

invoke term_name_replace internal method

srcp=bp

tgtp=local copy of ‘*bp’

term_nm=stack buffer

term_nm_sz=sizeof (term nm)

backward=FALSE

invoke default terminal implementation again

return if anything different than ST_NOT_FOUND

resolve terminal by name in the virtual terminals container

if not found return ST_NOP

if error return error

redirect operation to the exterior virtual terminal helper

Release

| | | |
|---|---|---|
| in : | namep | - terminal name or NULL |
| | (hdl) | - terminal handle (if namep = = NULL) |
| | (conn_id) | - connection id or NO_ID |
| | (conn_h) | - connection handle or NO_HDL |

| out: | void | |
|---|---|---|
| act: | release connection context | |
| s : | ST_NO_ACTION | - the specified context was not acquired |
| | ST_REFUSE | - component is in inappropriate state |
| | ST_NOT_FOUND | - terminal not found |

| | |
|---|---|
| nb : | either ‘conn_id’ or ‘conn_h’ should contain a value for |

this operation to succeed; if both contain values, ‘conn_id’ is ignored.

valchk: namep !=NULL

invoke default terminal implementation

return if anything different than ST_NOT_FOUND

invoke term_name_replace internal method

srcp=bp

tgtp=local copy of ‘*bp’

term_nm=stack buffer

term_nm_sz=sizeof (term nm)

backward=FALSE

invoke default terminal implementation again

return if anything different than ST_NOT_FOUND

resolve terminal by name in the virtual terminals container

if not found return ST_NOP

if error return error

redirect operation to the exterior virtual terminal helper

Connect

| | | |
|---|---|---|
| in : | namep | - terminal name or NULL |
| | (hdl) | - terminal handle (if namep = = NULL) |
| | type | - target terminal type [TERM_TYPE] |
| | sync | - target terminal synchronosity |
| | dir | - target terminal direction |
| | attr | - target terminal attributes |
| | context | - connection context of the terminal to |

connect to

| | |
|---|---|
| (conn_id) | - connection id or NO_ID |
| (conn_h) | - connection handle or NO_HDL |

| out: | void | |
|---|---|---|
| act: | connect terminal to another terminal | |
| s : | ST_REFUSE | - interface mismatch (e.g., unacceptable |

‘contract_id’) or inappropriate state

| | |
|---|---|
| ST_NOP | - operation impossible at this time |
| ST_NOT_FOUND | - terminal not found |
| ST_OVERFLOW | - implementation imposed restriction |

in # of connections

| | |
|---|---|
| nb : | either ‘conn_id’ or ‘conn_h’ should contain a value for |

this operation to succeed; if both contain values, ‘conn_id’ is ignored.

| | |
|---|---|
| nb : | The connection context structures are ‘tagged’, i.e. the |

first 8 bits contain an identifier of the structure. Any
implementation must check and recognize the ‘tag’ before it
can operate with the rest of the structure.

valchk: namep !=NULL

invoke default terminal implementation

return if anything different than ST_NOT_FOUND

invoke term_name_replace internal method

srcp=bp

tgtp=local copy of ‘*bp’

term_nm=stack buffer

term_nm_sz=sizeof (term_nm)

backward=FALSE

invoke default terminal implementation again

return if anything different than ST_NOT_FOUND

resolve terminal by name in the virtual terminals container

if not found return ST_NOP

if error return error

invoke operation on the exterior virtual terminal helper

redirect to virtual terminal distributor

skip_err=FALSE

Disconnect

| in : | namep | - terminal name or NULL |
|---|---|---|
| | (hdl) | - terminal handle (if namep = = NULL) |
| | (conn_id) | - connection id or NO_ID |
| | (conn h) | - connection handle or NO_HDL |
| out: | void | |
| act: | disconnect terminal | |
| s : | ST_REFUSE | - component is in inappropriate state |
| | ST_NOP | - operation impossible at this time |

| | |
|---|---|
| nb : | either ‘conn_id’ or ‘conn_h’ should contain a value for |

this operation to succeed; if both contain values,
‘conn_id’ is ignored.

valchk: namep !=NULL

invoke default terminal implementation

return if anything different than ST_NOT_FOUND

invoke term_name_replace internal method

srcp=bp

tgtp=local copy of ‘*bp’

term_nm=stack buffer

term_nm_sz=sizeof (term_nm)

backward=FALSE

invoke default terminal implementation again

return if anything different than ST_NOT_FOUND

resolve terminal by name in the virtual terminals container

if not found return ST_NOP

if error return error

invoke operation on the exterior virtual terminal helper

redirect to virtual terminal distributor

skip_err=FALSE

Get_info

| | | |
|---|---|---|
| in : | namep | - terminal name or NULL |
| | (hdl) | - terminal handle (if namep = = NULL) |
| out: | type | - terminal type [TERM_TYPE] |
| | card | - terminal cardinality (static, not current) |
| | n_conn | - current # of connections |
| | sync | - terminal synchronosity |
| | attr | - terminal attributes |
| | dir | - terminal direction |

| act: | return information about specified terminal | |
|---|---|---|
| s : | ST_NOT_FOUND | - terminal not found |

valchk: namep !=NULL

invoke default terminal implementation

return if anything different than ST_NOT_FOUND

invoke term_name_replace internal method

srcp=bp

tgtp=local copy of ‘*bp’

term_nm=stack buffer

term_nm_sz=sizeof (term_nm)

backward=FALSE

invoke default terminal implementation again

return if anything different than, ST_NOT_FOUND

resolve terminal by name in the virtual terminals container

if not found return ST_NOP

if error return error

redirect operation to the exterior virtual terminal helper

Qry_open

| | | |
|---|---|---|
| in : | namep | - query string |
| out: | qry_ctx | - query context for subsequent qry_xxx |

operations

| act: | open query on terminal namespace | |
|---|---|---|
| s : | ST_NO_ROOM | - too many open queries |
| | ST_BAD_SYNTAX | - bad query syntax |

| | |
|---|---|
| nb : | the query syntax is defined by the particular |

implementation

redirect to the default implementation

Qry_get_first

| | | |
|---|---|---|
| in : | namep | - buffer for name or NULL |
| | (name_sz) | - size of buffer, [bytes] |
| | qry_ctx | - query context from previous qry_xxx |

operation

| | |
|---|---|
| out:(*namep) | - terminal name |

| | |
|---|---|
| qry_ctx | - query context for subsequent qry_xxx |

operation

| act: | get first matching terminal name | |
|---|---|---|
| s : | ST_NOT_FOUND | - no matching terminals |

invoke default implementation

invoke term_name_replace

srcp=bp

tgtp=bp

bufp=bp->namep

buf_sz=bp->name_sz

backward=TRUE

return ST_OK

Qry_get_last

| | | |
|---|---|---|
| in : | namep | - buffer for name or NULL |
| | (name_sz) | - size of buffer, [bytes] |
| | qry_ctx | - query context from previous qry_xxx |

operation

| | |
|---|---|
| out:(*namep) | - terminal name |

| | |
|---|---|
| qry_ctx | - query context for subsequent qry_xxx |

operation

| act: | get last matching terminal name | |
|---|---|---|
| s : | ST_NOT_FOUND | - no matching terminals |

invoke default implementation

invoke term_name_replace

srcp=bp

tgtp=bp

bufp=bp->namep

buf_sz=bp->name_sz

backward=TRUE

return ST_OK

Qry_get_next

| in : namep | | - buffer for name or NULL |
|---|---|---|
| | (name_sz) | - size of buffer, [bytes] |

| | |
|---|---|
| qry_ctx | - query context from previous qry_xxx |

operation

| | |
|---|---|
| out:(*namep) | - terminal name |

| | |
|---|---|
| qry_ctx | - query context for subsequent qry_xxx |

operation

act: get next matching terminal name

| | |
|---|---|
| s : ST_NOT_FOUND | - no more matching terminals |

invoke default implementation

invoke term_name_replace

srcp=bp

tgtp=bp

bufp=bp->namep

buf_sz=bp->name sz

backward=TRUE

return ST_OK

Qry_get_prev

| | |
|---|---|
| in : namep | - buffer for name or NULL |

| | |
|---|---|
| (name_sz) | - size of buffer, [bytes] |

| | |
|---|---|
| qry_ctx | - query context from previous qry_xxx |

operation

| | |
|---|---|
| out:(*namep) | - terminal name |

| | |
|---|---|
| id | - alternative id (if any) or NO_ID |
| qry_ctx | - query context for subsequent qry_xxx |

operation

act: get previous matching terminal name

| | |
|---|---|
| s : ST_NOT_FOUND | - no more matching terminals |

invoke default implementation

invoke term_name_replace

srcp=bp

tgtp=bp

bufp=bp->namep

buf_sz=bp->name_sz

backward=TRUE

return ST_OK

Qry_get_curr

| in : namep | | - buffer for name or NULL |
|---|---|---|
| | (name_sz) | - size of buffer, [bytes] |

| | |
|---|---|
| qry_ctx | - query context from previous qry_xxx ration |

| | |
|---|---|
| out:(*namep) | - terminal name |

| | |
|---|---|
| id | - alternative id (if any) or NO_ID |

act: get current terminal name in query
nb: qry_ctx is unchanged
on qry_close

| | |
|---|---|
| in : qry_ctx | - query context from qry_open or another |

qry_xxx operation

out: void
act: close query on terminal name space

invoke default implementation

invoke term_name_replace

srcp=bp

tgtp=bp

bufp=bp->namep

buf_sz=bp->name_sz

backward=TRUE

return ST_OK

Qry_close

qry_close

| | |
|---|---|
| in qry_ctx | - query context from qry_open or another |

qry_xxx operation

out: void
act: close query on terminal name space

redirect to the default implementation

Custom: Terminal Mechanism (Interior)

Acquire

| | |
|---|---|
| in : namep | - terminal name or NULL |

| | |
|---|---|
| (hdl) | - terminal handle (if namep = = NULL) |

| | |
|---|---|
| conn_id | - connection id or NO_ID |

| | |
|---|---|
| out: context | - connection context |

| | |
|---|---|
| type | - terminal type [TERM_TYPE] |
| card | - cardinality |
| sync | - terminal synchronosity |

| | |
|---|---|
| dir | - terminal direction |

| | |
|---|---|
| attr | - terminal attributes |

| | |
|---|---|
| conn_h | - connection handle |

act: acquire connection context

| | |
|---|---|
| s : ST_NOT_FOUND | - terminal not found |

| | |
|---|---|
| ST_REFUSE | - component is in inappropriate state |
| ST_NO_ROOM | - terminal cardinality exhausted |

| | |
|---|---|
| ST_NOP | - operation impossible at this time |

| | |
|---|---|
| ST_OVERFLOW | - provided space for context is not enough |

nb: The connection context structures are ‘tagged’, i.e. the first 8 bits contain an identifier of the structure. Any implementation must check and recognize the ‘tag’ before it can operate with the rest of the structure.

resolve terminal by name in the virtual terminals container [if_ret]

redirect operation to the interior virtual terminal helper

Release

| | |
|---|---|
| in : namep | - terminal name or NULL |

| | |
|---|---|
| (hdl) | - terminal handle (if namep = = NULL) |

| | |
|---|---|
| (conn_id) | - connection id or NO_ID |
| (conn_h) | - connection handle or NO_HDL |

out: void
act: release connection context

| | |
|---|---|
| s : ST_NO_ACTION | - the specified context was not acquired |

| | |
|---|---|
| ST_REFUSE | - component is in inappropriate state |

| | |
|---|---|
| ST_NOP | - operation impossible at this time |

| | |
|---|---|
| ST_NOT_FOUND | - terminal not found |

nb: either ‘conn_id’ or ‘conn_h’ should contain a value for this operation to succeed; if both contain values, ‘conn_id’ is ignored.

resolve terminal by name in the virtual terminals container [if_ret]

redirect operation to the interior virtual terminal helper

Connect

| | |
|---|---|
| in : namep | - terminal name or NULL |

| | |
|---|---|
| (hdl) | - terminal handle (if namep = = NULL) |

| | |
|---|---|
| type | - target terminal type [TERM_TYPE] |
| sync | - target terminal synchronosity |

| | |
|---|---|
| dir | - target terminal direction |
| attr | - target terminal attributes |

| | |
|---|---|
| context | - connection context of the terminal to |

connect to

| | |
|---|---|
| (conn_id) | - connection id or NO_ID |
| (conn_h) | - connection handle or NO_HDL |

out: void
act: connect terminal to another terminal

| | |
|---|---|
| s : ST_REFUSE | - interface mismatch (e.g., unacceptable |

‘contract_id’) or inappropriate state

| | |
|---|---|
| ST_NOT_FOUND | - terminal not found |

| | |
|---|---|
| ST_NOP | - operation impossible at this time |

| | |
|---|---|
| ST_OVERFLOW | - implementation imposed restriction |

in # of connections
nb: either ‘conn_id’ or ‘conn_h’ should contain a value for this operation to succeed; if both contain values, ‘conn_Id’ is ignored.
nb: The connection context structures are ‘tagged’, i.e. the first 8 bits contain an identifier of the structure. Any implementation must check and recognize the ‘tag’ before it can operate with the rest of the structure.

resolve terminal by name in the virtual terminals container [if_ret]

redirect operation to the interior virtual terminal helper

Disconnect

| | |
|---|---|
| in : namep | - terminal name or NULL |

| | |
|---|---|
| (hdl) | - terminal handle (if namep = = NULL) |

| | |
|---|---|
| (conn_id) | - connection id or NO_ID |
| (conn_h) | - connection handle or NO_HDL |

out: void
act: disconnect terminal

| | |
|---|---|
| s : ST_REFUSE | - component is in inappropriate state |

| | |
|---|---|
| ST_NOP | - operation impossible at this time |

nb: either ‘conn_id’ or ‘conn_h’ should contain a value for this operation to succeed; if both contain values, ‘conn_id’ is ignored.

resolve terminal by name in the virtual terminals container [if ret]

redirect operation to the interior virtual terminal helper

Get_info

| | |
|---|---|
| in : namep | - terminal name or NULL |

| | |
|---|---|
| (hdl) | - terminal handle (if namep = = NULL) |

| | |
|---|---|
| out: type | - terminal type [TERM_TYPE] |

| | |
|---|---|
| card | - terminal cardinality (static, not current) |

| | |
|---|---|
| n_conn | - current # of connections |

| | |
|---|---|
| sync | - terminal synchronosity |

| | |
|---|---|
| attr | - terminal attributes |
| dir | - terminal direction |

act: return information about specified terminal

| | |
|---|---|
| s : ST_NOT_FOUND | - terminal not found |

resolve terminal by name in the virtual terminals container [if_ret]

redirect operation to the interior virtual terminal helper

Qry_open

| | |
|---|---|
| in : namep | - query string |
| out: qry_ctx | - query context for subsequent qry_xxx |

operations

act: open query on terminal namespace

| | |
|---|---|
| s : ST_NO_ROOM | - too many open queries |

| | |
|---|---|
| ST_BAD_SYNTAX | - bad query syntax |

nb: the query syntax is defined by the particular implementation

compare ‘namep’ with “*”

return ST_BAD_SYNTAX if no match

invoke ‘get first’ operation on the virtual terminal container

if ST_OK or ST_NOT FOUND return ST_OK

if error return error

pass returned context as qry_ctx

return ST_OK

Qry_get_first

| | | |
|---|---|---|
| in : | namep | - buffer for name or NULL |
| | (name_sz) | - size of buffer, [bytes] |
| | qry_ctx | - query context from previous qry_xxx |

operation

| | |
|---|---|
| out:(*namep) | - terminal name |

| | |
|---|---|
| qry_ctx | - query context for subsequent qry_xxx |

operation

| act: get first matching terminal name | |
|---|---|
| s : ST_NOT_FOUND | - no matching terminals |

redirect to ‘get_first’ operation on the virtual terminal container

pass virtual terminal name if needed

pass returned context as qry_ctx

Qry_get_last

| | | |
|---|---|---|
| in : | namep | - buffer for name or NULL |
| | (name_sz) | - size of buffer, [bytes] |
| | qry_ctx | - query context from previous qry_xxx |

operation

| | |
|---|---|
| out:(*namep) | - terminal name |
| qry_ctx | - query context for subsequent qry_xxx |

operation

| act: get last matching terminal name | |
|---|---|
| s : ST_NOT_FOUND | - no matching terminals |

return ST_NOT_SUPPORTED

Qry_get_next

| | | |
|---|---|---|
| in : | namep | - buffer for name or NULL |
| | (name_sz) | - size of buffer, [bytes] |
| | qry_ctx | - query context from previous qry_xxx |

operation

| | |
|---|---|
| out:(*namep) | - terminal name |
| qry_ctx | - query context for subsequent qry_xxx |

operation

| act: get next matching terminal name | |
|---|---|
| s : ST_NOT_FOUND | - no more matching terminals |

redirect to ‘get_next’ operation on the virtual terminal container

pass virtual terminal name if needed

pass returned context as qry_ctx

Qry_get_prev

| | | |
|---|---|---|
| in : | namep | - buffer for name or NULL |
| | (name_sz) | - size of buffer, [bytes] |
| | qry_ctx | - query context from previous qry_xxx |

operation

| | |
|---|---|
| out:(*namep) | - terminal name |

| | |
|---|---|
| id | - alternative id (if any) or NO_ID |
| qry_ctx | - query context for subsequent qry_xxx |

operation

| act: get previous matching terminal name | | |
|---|---|---|
| s : | ST_NOT_FOUND | - no more matching terminals |

return ST_NOT_SUPPORTED

Qry_get_curr

| | | |
|---|---|---|
| in : | namep | - buffer for name or NULL |
| | (name_sz) | - size of buffer, [bytes] |
| | qry_ctx | - query context from previous qry_xxx ration |

| | |
|---|---|
| out:(*namep) | - terminal name |

| | |
|---|---|
| id | - alternative id (if any) or NO_ID |

| act: get current terminal name in query | | |
|---|---|---|
| nb : qry_ctx is unchanged | | |
| on qry_close | | |
| in : | qry_ctx | - query context from qry_open or another |

qry_xxx operation

out: void
act: close query on terminal name space

redirect to ‘get_curr’ operation on the virtual terminal container

pass virtual terminal name if needed

Qry_close

| | | |
|---|---|---|
| in : | qry_ctx | - query context from qry_open or another |

qry_xxx operation

| | |
|---|---|
| out: | void |
| act: | close query on terminal name space |

return ST_OK

Custom: Property Mechanism

Get

| | | |
|---|---|---|
| in: | bp->namep | - name/id of property to get or NULL |
| | (bp->hdl) | - property handle (if ‘bp->namep’ is NULL) |
| | (bp->ndx) | - index of the array element if needed |
| | bp->type | - expected value type or PROP_T_NONE for any |
| | bp->p | - buffer for property value or NULL |
| | bp->sz) | - size of buffer (if bp->p != NULL) |
| out: | bp->type | - actual type of value (if bp->type == |

PROP_T_NONE)

| | |
|---|---|
| (*bp->p) | - property value (if bp->p != NULL) |
| bp->len | - actual length of value, [bytes], incl. any |

terminators

| | |
|---|---|
| act: | get property value |
| s: | ST_NOT_FOUND - property not found |
| | ST_REFUSE - incorrect property type |
| | ST_OVERFLOW - buffer too small for property value |
| nb: | bp->sz must be provided for all property types, included |
| | fixed-size |

process properties defined on the array:

invoke default property mechanism (ClassMagic) and return status if anything different than ST_NOT_FOUND

if array element property (‘bp->namep[0]’ is ‘[’)

if extracting the id value between the ‘[’ and ‘]’ successful:

redirect the operation to Part Array:

convert the string value between ‘[’ and ‘]’ to element id

strip the “[xxx]” and, if present, the ‘.’ after that

use element id calculated above and redirect to the Part Array API

else if property is broadcast (name starts with “[*]”)

redirect operation to virtual property distributor helper stripping the “[*]” and the ‘.’ after that if present

else return ST_NOT_FOUND

if ‘bp->namep’ is ‘._repeated’

return ST_NOT_SUPPORTED

find virtual property with the same name as the one requested by the operation [if_ret]

redirect operation to virtual property

Set

| | | |
|---|---|---|
| in : | bp->namep | name/id of property to set or NULL |

| | |
|---|---|
| (bp->hdl) | property handle (if ‘bp->namep’ is |

NULL)

| | |
|---|---|
| (bp->ndx) | index of the array/vector element if |

needed

| | |
|---|---|
| bp->type | property type or PROP_T_NONE if unknown |

| | |
|---|---|
| bp->p | buffer containing property value, NULL for |

default

| | |
|---|---|
| bp->len | actual length of value, [bytes], or 0 for |

auto

| | |
|---|---|
| out: | void |
| act: | set property value |

| | | |
|---|---|---|
| s : | ST_NOT_FOUND | property not found |

| | |
|---|---|
| ST_REFUSE | incorrect property type |

| | |
|---|---|
| ST_BAD_VALUE | bad property value |

| | |
|---|---|
| ST_BAD_ACCESS | attempt to set a read-only property |

| | |
|---|---|
| ST_OVERFLOW | property value too long |

| | |
|---|---|
| nb : | bp->len = = 0 is allowed only on fixed-size types, ASCIZ and |

UNICODEZ

invoke default property mechanism (ClassMagic)

return if anything but ST_NOT_FOUND

if array element property (‘bp-→namep[0]’ is ‘[’)

if extracting id value between the ‘[’ and ‘]’ successful:

convert the string value between ‘[’ and ‘]’ to element id

strip the “[xxx]” and, if present, the ‘.’ after that

use element id calculated above and redirect to the Part Array API

else if property is broadcast (name starts with “[*]”)

find virtual property with name the string after the “[*]”

if no such property exists, create it

invoke same operation on the virtual property

redirect operation to the virtual property distributor

else return ST_NOT_FOUND

if ‘bp->namep’ is ‘._repeated’

create virtual terminal with name the value of the property

return status of the creation operation

find virtual property with the same name as the requested by the operation

if no such property exists, create it

redirect to the same operation on the virtual property

redirect to the same operation on the virtual property distributor

Chk

| | | |
|---|---|---|
| in : | bp->namep | name/id of property to check or NULL |

| | |
|---|---|
| (bp->hdl) | property handle (if ‘bp->namep’ is NULL) |

| | |
|---|---|
| (bp->ndx) | index of the array element if needed |
| bp->type | property type or PROP_T_NONE if unknown |

| | |
|---|---|
| bp->p | buffer containing property value, NULL for |

default

| | |
|---|---|
| bp->len | actual length of value, [bytes], or 0 for |

auto

| | |
|---|---|
| out: | void |
| act: | check property value |

| | | |
|---|---|---|
| s : | ST_NOT_FOUND | property not found |

| | |
|---|---|
| ST_REFUSE | incorrect property type |

| | |
|---|---|
| ST_BAD_VALUE | bad property value |

| | |
|---|---|
| ST_BAD_ACCESS | attempt to set a read-only property |

| | |
|---|---|
| ST_OVERFLOW | property value too long |

| | |
|---|---|
| nb : | bp->len = = 0 is allowed only on fixed-size types, ASCIZ and |

UNICODEZ

invoke default property mechanism (ClassMagic)

return if anything but ST_NOT_FOUND

if array element property (‘bp->namep’ starts with ‘[’)

if extracting id value between the ‘[’ and ‘]’ successful:

convert the string value between ‘[’ and ‘]’ to element id

strip the ‘[xxx]’ and, if present, the ‘.’ after that

use element id calculated above and redirect to the Part Array API

else if broadcast property (name starts with “[*]”)

find virtual property with name the string after the “[*]”

if no such property exists, return ST_NOT_FOUND

invoke same operation to the so found virtual property

redirect operation to the virtual property distributor

else return ST_NOT_FOUND

if ‘bp->namep’ is ‘._repeated’

ask virtual terminal container to find terminal with name equal to the property value.

if ST_OK (found) return ST_DUPLICATE

if ST_NOT_FOUND return ST_OK

else return status of the above operation

find virtual property with the same name as the requested by the operation

if no such property exists, return ST_OK

invoke same operation on virtual property mechanism

redirect to property distributor

Get_info

| | | |
|---|---|---|
| in : | bp->namep | property name/id |

| | |
|---|---|
| (bp->hdl) | property handle (if ‘bp->namep’ is NULL) |

| | | |
|---|---|---|
| out: | bp->type | property type |

| | |
|---|---|
| bp->attr | property attributes |

| | |
|---|---|
| act: | get information about specified property |

| | | |
|---|---|---|
| s : | ST_NOT_FOUND | property name not found |

| | |
|---|---|
| nb : | the information returned by this operation is not affected |

by the current value of the property

if ‘bp->namep’ starts with ‘[’

if extracting id value between the ‘[’ and ‘]’ successful:

redirect the operation to Part Array stripping the ‘[. . .]’ and, if present, the ‘.’ after that.

else if property name starts with “[*]”

find virtual property with name the string after the “[*]”

if no such property exists, return ST_NOT_FOUND

redirect operation to the virtual property

else return ST_NOT_FOUND

if ‘bp->namep’ is ‘._repeated’

return ST_NOT_SUPPORTED

find virtual property with the same name as the requested by the operation

if no such property, return ST_NOT_FOUND

redirect operation to virtual property mechanism

Qry_open

| | | |
|---|---|---|
| in : | bp->namep | query string |

| | |
|---|---|
| bp->qry_mask | attributes to filter on query operations |

| | |
|---|---|
| bp->attr | values of attributes |

| | | |
|---|---|---|
| out: | bp->qry_ctx | query context for subsequent qry_xxx |

operations

| | |
|---|---|
| act: | open query on property namespace |

| | | |
|---|---|---|
| s : | ST_NO_ROOM | too many open queries |

| | |
|---|---|
| ST_BAD_SYNTAX | bad query syntax |

return ST_BAD_SYNTAX if query is not

allocate query instance:

allocate PROP_QRY instance on behalf of the host

open query on our properties

initialize query instance

state

query attribute mask

query attribute values

array.enum_ctx

associate query instance with a handle

pass

query handle as ‘bp->qry_ctx’

return ST_OK

Qry_get_first

in: bp->namep—buffer for property name

bp->name_sz—size of buffer (bytes)

bp->qry_ctx—query context from prp_qry_open

out: bp->namep—property name

act: get first matching property name

s: ST_NOT_FOUND—no matching properties

ST_INVALID—bad query context

ST_OVERFLOW—buffer too small for property name

lock the query handle to resolve the query context

invoke pq_sm_feed (RESET, query context) [cleanup: unlock handle]

invoke pq_sm_feed (NEXT, query context) [cleanup: unlock handle]

unlock the handle

return ST_OK

Qry_get_fast

in: bp->namep—buffer for property name

bp->name sz—size of buffer (bytes)

bp->qry_ctx—query context from prp_qry_open

out: bp->namep—property name

act: get last matching property name

s: ST_NOT_FOUND—no matching properties

ST_INVALID—bad query context

ST_OVERFLOW—buffer too small for property name

return ST_NOT_SUPPORTED

Qry_get_next

in: bp->namep—buffer for property name

bp->name sz—size of buffer (bytes)

bp->qry_ctx—query context from prp_qry_open

out: bp->namep—property name

act: get next matching property name

s: ST_NOT_FOUND—no matching properties

ST_INVALID—bad query context

ST_OVERFLOW—buffer too small for property name

lock the query handle to resolve the query context

invoke pq_sm_feed (NEXT, query context) [cleanup: unlock handle]

unlock the handle

return ST_OK

Qry_get_prev

in: bp->namep—buffer for property name

bp->name_sz—size of buffer (bytes)

bp->qry_ctx—query context from prp qry_open

out: bp->namep—property name

act: get previous matching property name

s: ST_NOT_FOUND—no matching properties

ST_INVALID—bad query context

ST_OVERFLOW—buffer too small for property name

return ST_NOT_SUPPORTED

Qry_get_curr

in: bp->namep—buffer for property name

bp->name_sz—size of buffer (bytes)

bp->qry_ctx—query context from prp_qry_open

out: bp->namep—property name

act: get current property name

s: ST_NOT_FOUND—no matching properties

ST_INVALID—bad query context ST_OVERFLOW—buffer too small for property name

lock the query handle to resolve the query context

invoke pq_sm_feed (CURR, query context) [cleanup: unlock handle]

unlock the handle

return ST_OK

Qry_close

in: bp->qry_ctx—query context for subsequent qry_xxx

operations

out: void

act: close query on property namespace

s: ST_INVALID—bad query context

lock the query handle to resolve the query context

invoke pq_sm_feed (RESET, query context) [cleanup: unlock handle]

free query context

destroy the handle locked

return ST_OK

Private: Internal Methods

term_name_replace

in: sp—part self pointer

srcp—source terminal bus

tgtp—target terminal bus

bufp—storage

buf_sz—storage size

backward—TRUE to map old names to new names, FALSE otherwise

out: *tgtp—name replaced bus

act: replace name of the terminal with respective property

s: ST_NOT_FOUND—no replacement happened

valchk: everything !=0

cmp_valp:=backward ? ‘._fact’: ‘sp->fact’

rpl_valp:=backward ? ‘sp->fact’: ‘._fact’

if cmp_valp matches with the name in ‘srcp->namep’

replace the ‘tgtp->namep’ with ‘bufp’

string copy ‘rpl_valp’ into ‘bufp’

return ST_OK

cmp_valp:=backward ? ‘._prop’: ‘sp->_prop’

rpl_valp:=backward ? ‘sp->_prop’: ‘._prop’

if cmp_valp matches with the name in ‘srcp->namep’

replace the ‘tgtp->namep’ with ‘bufp’

string copy ‘rpl_valp’ into ‘bufp’

return ST_OK

cmp_valp:=backward ? ‘._conn’: ‘sp->conn’

rpl_valp:=backward ? ‘sp->conn’: ‘. conn’

if cmp_valp matches with the name in ‘srcp->namep’

replace the ‘tgtp->namep’ with ‘bufp’

string copy ‘rpl_valp’ into ‘bufp’

return ST_OK

return ST_NOT_FOUND

Pq_sm_feed

| | | |
|---|---|---|
| in : | sp | - property query instance data |
| | selfp | - part instance pointer |
| | ev | - event |
| | bp | - property bus pointer |
| out: | *tgtp | - name replaced bus |

| | |
|---|---|
| act: | resolve and invoke action handler based on <state, event> pair |
| s : | <action handler status> |

valchk: everything !=0

dispatch by event

compute action handler based on state

redirect to action handler

Private: Action Handlers for Property Enumeration State Machine

Ah_reset

| in : | sp | - property query state |
|---|---|---|
| | sp−>state | - current state |
| | selfp | - part instance data |
| | bp | - property bus |
| out: | *sp | - modified query state |
| act: | reset enumeration on array properties | |
| s : | ST_OK | - success |
| | (any other) | - intermittent error |

switch by sp->state

case S_PQ_-ARRAY

close property query on us

zero sp->array portion of the query state

case S_PQ_VPROP

zero sp->vprop portion of the query state

case S_PQ_SUBS

close property query on subordinates

zero sp->subs portion of the query state

sp->state→S_PQ_ARRAY

return ST_OK

Ah_arr_next

| in : | sp | - property query state |
|---|---|---|
| | sp−>state | - current state |
| | selfp | - part instance data |
| | bp | - property bus |
| out: | *sp | - modified query state |
| act: | get next array property | |
| s : | ST_OK | - success |
| | (any other) | - intermittent error |

get first if array.enum_ctx==NO_CTX

open property query on us

use sp->attr-val, sp->attr-mask

get first

if ST_NOT_FOUND

close query on us

transit state to S_PQ_VPROP

initizlize vprop portion of the query state

re-feed the event

update state

return ST_OK

invoke get_next operation on us

update state (array.enum_ctx)

pass enum_ctx→bp->qry_ctx

return ST_OK

Ah_arr_curr

| in : | sp | - property query state |
|---|---|---|
| | sp−>state | - current state |
| | selfp | - part instance data |
| | bp | - property bus |
| out: | *sp | - modified query state |
| act: | get current array property | |
| s : | ST_OK | - success |
| | (any other) | - intermittent error |

invoke get-curr operation on us

return ST_OK

Ah_vp_next

| in: | sp | property query state |
|---|---|---|
| | sp-> state | current state |
| | selfp | part instance data |
| | bp | property bus |
| out: | *sp | modified query state |
| act: get next virtual property | | |
| s: | ST_OK | success |
| | (any other) | intermittent error |

calculate which operation on the virtual property container to call:

vprop.enum_ctx==NO_CTX ? vc_get_first : vc_get_next

call operation

if ST_NOT_FOUND

zero out vprop portion of the query state

transit state to S_PQ_SUBS

zero out subs portion of the query state

re-feed event

return ST_OK

pass if bp->namep !=NULL

return ST_OK

Ah_vp_curr

| in: | sp | property query state |
|---|---|---|
| | sp-> state | current state |
| | selfp | part instance data |
| | bp | property bus |
| out: | *sp | new query state |
| act: get current virtual property | | |
| s: | ST_OK | success |
| | (any other) | intermittent error |

get current virtual property [if_ret]

pass if bp->namep !=NULL

return ST_OK

Ah_subs_next

| in: | sp | property query state |
|---|---|---|
| | sp-> state | current state |
| | selfp | part instance data |
| | bp | property bus |
| out: | *sp | new query state |
| act: get next property from the subordinates | | |
| s: | ST_OK | success |
| | (any other) | intermittent error |

get first subordinate if subs.enum_ctx=NO_CTX

reset subordinates enumeration

get next subordinate

retrieve object ID

open query on subordinate

use sp->attr_mask, sp->attr_val

update subs state

enum_ctx:=subordinate enumeration

curr_oid:=current sub. object ID

curr_qryh:=property query handle

curr_{—}1st:=TRUE

recurse

get first/next property on current subordinate based on sp->subs.curr_{—}1^{st}

if ST_NOT_FOUND

close property query on current subordinate

get next subordinate [if_ret]

resolve its object ID

open query on new subordinate

use sp->attr_mask, sp->attr_val

update subs state

enum_ctx:=subordinate enumeration

curr_id:=current sub. object ID

curr_qryh:=property query handle

curr 1st:=FALSE

recurse

set sp->subs.curr_{—}1^{st} to FALSE

return ST_OK

Ah_subs_curr

| in: | sp | property query state |
|---|---|---|
| | sp-> state | current state |
| | selfp | part instance data |
| | bp | property bus |
| out: | *sp | new query state |
| act: get current property from the subordinates | | |
| s: | ST_OK | success |
| | (any other) | intermittent error |

return ST_NOT_FOUND if sp->subs.curr_{—}1^{st} is TRUE

get current property on current subordinate based on sp->subs.curr_{—}1^{st} [if_ret]

return ST_OK

Appendix 6. VECON—Virtual Entity Container

The virtual entity container is used for holding the set of virtual properties and for holding the set of virtual terminals.

typedef struct VECON

| { | | |
|---|---|---|
| _hdl | owner_key; | // owner key of the handle set |

| | | |
|---|---|---|
| CM_OID | oid; | // memory owner |

| | | |
|---|---|---|
| uint32 | off; | // offset of name pointer |

} VECON;

This structure is the instance data of a container for virtual entities.

The virtual entity container helper maintains a set of handles associated with an owner. The owner is kept on the owner_key field.

The oid field is used for ownership of the memory allocated by the helper. The memory allocation is performed on behalf of this object.

The off field is used to calculate the pointer to the name of particular entity by a base pointer supplied on all entity operations.

1. Self Data Structure

The self is the VECON structure defined above.

Pseudo-Code

2. Virtual Entity Container

Vc_construct

| in: | sp | storage for virtual terminal container |
|---|---|---|
| | | instance |
| | sz | size of the storage |
| | oid | object to allocate on behalf on |
| | off | offset of the pointer to the entity name |
| out: | *sp | virtual entity container instance |
| act: construct virtual entity container container | | |
| s: | ST_ALLOC | not enough memory |

valchk: sp !=NULL

sanity chk: sz>=sizeof (VTCON)

create unique onwer key→sp->owner_key

off→sp->off

return ST_OK

Vc_destruct

| | | |
|---|---|---|
| in: | sp | virtual entity container instance |
| out: | *sp | zeroed memory |

act: destruct virtual entity container container

valchk: sp !=NULL

enumerate all handles that belong to sp->owner_key, for each

destroy handle

zero self

return ST_OK

Vc_add

| in: | sp | virtual entity container instance |
|---|---|---|
| | ep | virtual entity instance |
| out: | void | |
| act: add virtual entity to the container instance | | |
| s: | ST_ALLOC | not enough memory |
| | ST_NO_ROOM | too many virtual entities |
| | ST_DUPLICATE | virtual entity with this name exists |

valchk: sp !=NULL, vtp !=NULL

calc name pointer in the entity to add

enumerate handle set using sp->owner_key

lock handle, retrieve entity base pointer

calc name pointer in the contained entity

compare two names, if match

unlock handle

return ST_DUPLICATE

unlock handle

create handle:

owner: sp->owner_key

context: vtp

return ST_OK

Vc_remove

| | | |
|---|---|---|
| in: | sp | virtual entity container instance |
| | ep | virtual entity to remove |
| out: | void | |

| act: remove virtual entity from the container instance | |
|---|---|
| s: | ST_NOT_FOUND |

calc name pointer of the entity to remove

enumerate all handles with onwer sp->key, for each

lock handle, retrieve entity base pointer

calc contained entity name pointer

compare two names, if match

destroy handle (locked)

return ST_OK

unlock handle

return ST_NOT_FOUND

Vc_find

| | | |
|---|---|---|
| in: | sp | virtual entity container instance |
| | nmp | virtual terminal name to find |
| | epp | storage for virtual entity instance ID |
| out: | *epp | virtual entity instance ID |

act: find virtual entity by name

| | | |
|---|---|---|
| s: | ST_NOT_FOUND | no such terminal |

enumerate all handles with onwer sp->key, for each

lock handle, retrieve entity base pointer

calc contained entity name pointer

if name of entity is the same as nmp (string compare)

pass entity base pinter→*epp

unlock handle

return ST_OK

unlock handle

return ST_NOT_FOUND

Vc_get_first

| | | |
|---|---|---|
| in: | sp | virtual entity container instance |
| | ep | storage for virtual entity instance ID |
| | | or NULL |
| | enum_ctxp | storage for enumeration context |
| out: | *enum_ctxp | enumeration context |
| | (*epp) | virtual entity instance ID |
| | | (if ‘epp’ is not NULL) |

act: get first virtual terminal

| | | |
|---|---|---|
| s: | ST_NOT_FOUND | no terminals |

get first handle with owner sp->owner_key [if_]

lock handle, retrieve entity base pointer, unlock handle

pass entity base pointer→*epp

pass enum_ctx→*enum_ctxp

return ST_OK

Vc_get_next

| | | |
|---|---|---|
| in : | sp | virtual entity container instance |
| | epp | storage for virtual entity instance |
| | | ID |

| | |
|---|---|
| | or NULL |
| enum_ctxp | pointer to enumeration context |
| | from previous |

vc_get_xxx operation

| | | |
|---|---|---|
| out: | *enum_ctxp | new enumeration context |

| | |
|---|---|
| (*epp) | virtual entity instance ID |

(if ‘epp’ is not NULL)

| act: | get next virtual terminal according to the enumeration context | |
|---|---|---|
| s : | ST_NOT_FOUND | - no more terminals |

get next handle with owner sp->owner_key [if_ret] and enumeration context: *enum_ctxp

lock handle, retrieve entity base pointer, unlock handle

pass entity base pointer→*epp

pass enum_ctx→*enum_ctxp

return ST_OK

Vc_get_curr

| | | |
|---|---|---|
| in : | sp | virtual terminal container instance |
| | epp | storage for virtual entity instance ID |

| | |
|---|---|
| | or NULL |
| enum_ctx | enumeration context from previous vc_get_xxx operation |

| | | |
|---|---|---|
| out: | (*epp) | virtual entity instance ID |

(if ‘epp’ is not NULL)

| act: | get current virtual terminal according to the enumeration context | |
|---|---|---|
| s : | ST_NOT_FOUND | no current terminal |

return ST_NOT_SUPPORTED

Appendix 7. VPROP—Virtual Property Helper

The virtual property helper uses the following structure to maintain the data associated with a single instance of a virtual property.

typedef struct VPROP

| { | | |
|---|---|---|
| char | *namep; | // name of the property |

| | | |
|---|---|---|
| uint16 | type; | // property data type |

| | | |
|---|---|---|
| void | *valp; | // pointer to value |

| | | |
|---|---|---|
| uint32 | len; | // length of the value |

| | | |
|---|---|---|
| CM_OID | oid; | // object to allocate on behalf of |

} VPROP;

The name of the property is kept by reference; the helper is responsible to allocate the storage. The same is valid for the value of the property. The name/value storage allocation happens at the same time when the virtual property is added (created) and therefore has the same life scope as the property itself.

The reason for this storage being allocated dynamically is that there is no explicit limit on the length of the property name. The same is valid for the property value.

1. Self Data Structure

The self is the VPROP structure defined above.

Pseudo-Code

Vp_construct

| | | |
|---|---|---|
| in : | sp | storage for virtual property instance |
| | sz | size of the storage |
| | oid | object to allocate on behalf on |

| | | |
|---|---|---|
| | nmp | property name |
| out: | *sp | virtual property instance |

| act: | construct virtual property instance | |
|---|---|---|
| s : | ST_ALLOC | not enough memory |

valchk: sp !=NULL, nmp !=NULL

sanity chk: sz>=sizeof VPROP

allocate memory for the property name on behalf of oid [if_ret]

sz=strlen (nmp)+1

copy name into allocated memory

zero *sp out

update sp

allocated memory→sp->namep

oid→sp->oid

PROP_T_NONE→sp->type

0→sp->len

NULL→sp->valp

return ST_OK

Vp_destruct

| | | |
|---|---|---|
| in : | sp | virtual property instance |

| | | |
|---|---|---|
| out: | *sp | zeroed memory |

| | |
|---|---|
| act: | destruct virtual property instance |

valchk: sp !=NULL

free sp->namep on behalf of sp->oid

if sp->valp not NULL free sp->valp on behalf of sp->oid

return ST_OK

Vp_get

| | | |
|---|---|---|
| in : | sp | virtual property instance |

| | |
|---|---|
| bp->type | expected value type or PROP_T_NONE for any |
| bp->p | buffer for property value or NULL |
| (bp->sz) | size of buffer (if bp->p ! = NULL) |

| | | |
|---|---|---|
| out: | bp->type | actual type of value |
| | | (if bp->type = = PROP_T_NONE) |

| | |
|---|---|
| (*bp->p) | property value (if bp->p ! = NULL) |

| | |
|---|---|
| bp->len | actual length of value, [bytes], incl. any terminators |

| act: | get virtual property value | |
|---|---|---|
| s : | ST_REFUSE | incorrect property type |

| | |
|---|---|
| ST_OVERFLOW | buffer too small for property value |

| | |
|---|---|
| nb : | bp->sz must be provided for all property types, included fixed-size |

valchk: sp !=NULL, bp !=NULL

if bp->p is NULL

pass

sp->ten→bp->ten

return ST_OK

if bp->sz <sp->len return ST_OVERFLOW

pass

sp->type→bp->type

copy sp->valp to bp->p (len: sp->len)

sp->len→bp->len

return ST_OK

Vp_set

| | | |
|---|---|---|
| in : | sp | virtual property instance |

| | |
|---|---|
| bp->type | property type or PROP_T_NONE if unknown |

| | |
|---|---|
| bp->p | buffer containing property value, |

NULL for default

| | |
|---|---|
| bp->len | actual length of value, [bytes], or 0 for auto |

| | |
|---|---|
| out: | void |
| act: | set virtual property value |

| | | |
|---|---|---|
| s : | ST_REFUSE | incorrect property type |

| | |
|---|---|
| ST_BAD_VALUE | bad property value |
| ST_OVERFLOW | property value too long |

| | |
|---|---|
| nb : | bp->len = = 0 is allowed only on fixed-size types, ASCIZ and |

UNICODEZ

valchk: sp !=NULL, bp !=NULL

if bp->p is NULL return ST_OK

bp->len→len

recalc value length if len is 0

SINT32, UINT32: len=4

ASCIZ: len=strlen (bp->p)+1

MBCSZ: len=mbclen (bp->p)+1

UNICODE: len=wclen (bp->p)+2;

any other: return ST_INVALID

if sp->len <len

reallocate valp to len on behalf of sp->oid

copy bp->p to sp->len

len→sp->len

return ST_OK

Vp_chk

| | | |
|---|---|---|
| in : | sp | virtual property instance |

| | |
|---|---|
| bp->namep | name of property to check or NULL |

| | |
|---|---|
| bp->type | property type or PROP_T_NONE if unknown |
| bp->p | buffer containing property value, NULL for default |
| bp->len | actual length of value, [bytes], or 0 for auto |

| out: | void | |
|---|---|---|
| act: | check virtual property value | |
| s : | ST_REFUSE | incorrect property type |

| | |
|---|---|
| ST_BAD_VALUE | bad property value |
| ST_OVERFLOW | property value too long |

| | |
|---|---|
| nb : | bp->len = = 0 is allowed only on fixed-size types, ASCIZ and |

UNICODEZ

valchk: sp !=NULL, bp !=NULL

return ST_OK

Vp_get_info

| | | |
|---|---|---|
| in : | sp | virtual property instance |

| | |
|---|---|
| bp->p | buffer for the name |
| bp->sz | size of the buffer |

| | | |
|---|---|---|
| out: | *bp->p | virtual property name |

| | |
|---|---|
| (bp->sz) | size of buffer needed for property name |

(if ST_OVERFLOW returned)

| | |
|---|---|
| bp->type | property type |

| act: | retrieve information about the virtual property | |
|---|---|---|
| s : | ST_OVERFLOW | buffer too small (bp->sz contains the needed size) |

valchk: sp !=NULL, bp !=NULL

strien (sp->namep)+1→len

if len>bp->sz

pass

bp->sz=len

return ST_OVERFLOW

pass

copy string sp->namep→bp->p

sp->type→bp->type

return ST_OK

Appendix 8. VPDST—Virtual Property Distributor

The following structure is the instance data of a distributor of virtual property values.

typedef struct VPDST

| { | | |
|---|---|---|
| DM_ARR_HDR | *arrp; | // array instance |

| | | |
|---|---|---|
| CM_OID | oid; | // object to allocate memory on behalf of |

} VPDST;

The arrp field is used to identify the Part Array instance as provided by ClassMagic.

The oid field is used for ownership of the memory allocated by the helper. The memory allocation is performed on behalf of this object.

1. Self Data Structure

The self is the VPDST structure defined above.

Pseudo-Code

Vpd_construct

| | | |
|---|---|---|
| in : | sp | storage for virtual property distributor instance |
| | sz | size of the storage |
| | oid | object ID to allocate on behalf of |
| | arrp | array instance ID to distribute to |

| | | |
|---|---|---|
| out: | *sp | virtual property distributor instance |

| act: | construct virtual property distributor instance | |
|---|---|---|
| s : | ST_ALLOC | not enough memory |

valchk: sp !=NULL

sanity chk: sz>=sizeof (VPDST)

arrp→sp->arrp

oid→sp->oid

return ST_OK

Vpd_destruct

| | | |
|---|---|---|
| in : | sp | virtual property distributor instance |

| | | |
|---|---|---|
| out: | *sp | zeroed memory |

| | |
|---|---|
| act: | destruct virtual property distributor instance |

valchk: sp=NULL

zero out *sp

return ST_OK

Vpd_set

in : sp - virtual property distributor instance

bp->p - pointer to value to set (NULL for default)
bp->len - value length (0 - for auto)
bp->type - property type or PROP_T_NONE if unknown

skip_err - TRUE to skip errors

out: void
act: set virtual property value to all elements in the array
s : ST_REFUSE - incorrect property type

ST_BAD_VALUE - bad property value
ST_OVERFLOW - property value too long

nb : bp->len == 0 is allowed only on fixed-size types, ASCIZ and

UNICODEZ

valchk: sp !=NULL, bp !=NULL

init ‘operation status’ to ST_OK

enum keys in the array, for each one

invoke DM_ARR_prp_set( ) using the value in the buffer and type from ‘bp’

if skip_err continue enumeration

if error set it into ‘operation status’ and stop enumeration

return ‘operation status’

Vpd_chk

| | |
|---|---|
| in : sp | - virtual property distributor instance |

| | |
|---|---|
| bp->p | - pointer to value to check (NULL for |
| | default) |

| | |
|---|---|
| bp->len | - value length (0 - for auto) |
| bp->type | - property type or PROP_T_NONE if unknown |

out: void
act: check virtual property value to all elements in the array
s : ST_REFUSE - incorrect property type

ST_BAD_VALUE - bad property value
ST_OVERFLOW - property value too long

nb : bp->len == 0 is allowed only on fixed-size types, ASCIZ and

UNICODEZ

valchk: sp !=NULL, bp !=NULL

init ‘operation status’ to ST_OK

enum keys in the array, for each one

invoke DM_ARR_prp_chk( ) using the value in the buffer and type from ‘bp’

if error set it into ‘operation status’ and stop enumeration

return ‘operation status’

Appendix 9. VTERM—Virtual Terminal Helper

The following structure is the instance data of a single virtual terminal.

typedef struct VTERM

| { | | |
|---|---|---|
| char | *namep; | // pointer to terminal name |
| bool | connected; | // TRUE if terminal connected |

| | | |
|---|---|---|
| byte | conn_ctx[CONN_CTX_SZ]; | // connection context |
| char | name[MAX_TERM_NM_SZ]; | // virtual terminal name |

| | | |
|---|---|---|
| word | sync; | // synchronicity |

| | | |
|---|---|---|
| dword | attr; | // terminal attributes |

} VTERM;

The instance data contains the name of the terminal (fixed length), indication whether this terminal is connected and the connection data (context), synchronicity and attributes supplied by the counter terminal (if connected).

The virtual entity container utilizes the pointer to the virtual terminal name (namep field).

1. Self Data Structure

The self is the VTERM structure defined above.

Pseudo-Code

Vt_construct

| | | |
|---|---|---|
| in : | sp | - storage for virtual terminal instance |
| | sz | - size of the storage |
| | oid | - object to allocate on behalf on |
| | nmp | - terminal name |

| | |
|---|---|
| out: *sp | - virtual terminal instance |

act: construct virtual terminal instance
s : ST_ALLOC - not enough memory

argchk: sp !=NULL, sz>=sizeof (VTERM), nmp !=NULL

if name (nmp) is too long return ST_OVERFLOW

copy terminal name into self (sp->name)

set sp->namep to point to sp->name

set sp->connected to FALSE

zero init the connection context (sp->conn_ctx)

set sp->attr and sp->sync to zero

return ST_OK

Vt_destruct

| | |
|---|---|
| in : sp | - virtual terminal instance |
| out: *sp | - zeroed memory |

act: destruct virtual terminal instance

argchk: sp !=NULL

memset sp to zeros

return ST_OK

Appendix 10. VTRME—Virtual Terminal Mechanism (Exterior)

This mechanism is used to handle exterior virtual terminals.

1. Structures Used

1.1. VTERM—Virtual Terminal

This structure is the instance data of a single virtual terminal.

typedef struct VTERM

| { | | |
|---|---|---|
| char | *namep; | // pointer to terminal name |
| bool | connected; | // TRUE if terminal connected |

| | | |
|---|---|---|
| byte | conn_ctx[CONN_CTX_SZ]; | // connection context |
| char | name[MAX_TERM_NM_SZ]; | // virtual terminal name |

| | | |
|---|---|---|
| word | sync; | // synchronicity |

| | | |
|---|---|---|
| dword | attr; | // terminal attributes |

} VTERM;

The instance data contains the name of the terminal (fixed length), indication whether this terminal is connected and the connection data (context), synchronicity and attributes supplied by the counter terminal (if connected).

The virtual entity container utilizes the pointer to the virtual terminal name (namep field).

2. Self Data Structure

The self is the VTERM structure defined above.

Pseudo-Code

vte_acquire

| | |
|---|---|
| in : sp | - virtual terminal instance |

| | |
|---|---|
| bp->conn_id | - connection id or NO_ID |

| | |
|---|---|
| out: bp->context | - connection context |

| | |
|---|---|
| bp->mech | - terminal mechanism [TERM_M] |
| bp->card | - cardinality |
| bp->sync | - terminal synchronosity |
| bp->dir | - terminal direction |
| bp->attr | - terminal attributes |
| bp->conn_h | - connection handle |

| act: acquire connection context | |
|---|---|
| s : ST_NOT_FOUND | - terminal not found |

| | |
|---|---|
| ST_REFUSE | - component is in inappropriate state |
| ST_NO_ROOM | - terminal cardinality exhausted |
| ST_OVERFLOW | - provided space for context is not |
| | enough |

argchk: sp !=NULL, bp !=NULL

if sp->connected return ST_NO_ROOM (cardinality exhausted)

prepare connection context:

tag RDX_TRM_CTX_VTBL_TAG;

sz=sizeof (sp->conn_ctx)

cid_out=CID_ANY

pass:

connection context assembled above

bp->mech=TERM_M_VTABLE

bp->card=1

bp->sync =TERM_S_BOTH

bp->dir=TERM_D_OUTPUT

bp->attr=TERM_A_ACTIVETIME_|TERM_A_NEGOTIABLE

bp->conn_h=NO_HDL

return ST_OK

Vte_release

| in : sp | | - virtual terminal instance |
|---|---|---|
| | (bp->conn_id) | - connection id or NO_ID |
| | (bp->conn_h) | - connection handle or NO_HDL |

out: void
act: release connection context

| s : ST_NO_ACTION | | - the specified context was not acquired |
|---|---|---|
| | ST_REFUSE | - component is in inappropriate state |
| | ST_NOT_FOUND | - terminal not found |

nb : either ‘conn_id’ or ‘conn_h’ should contain a value for this opera-

tion to succeed; if both contain values, ‘conn_id’ is ignored.

argchk: sp !=NULL, bp !=NULL

return ST_OK

Vte_connect

| in : sp | | - virtual terminal instance |
|---|---|---|
| | bp->mech | - target terminal mechanism [TERM_M] |
| | bp->sync | - target terminal synchronosity |
| | bp->dir | - target terminal direction |
| | bp->attr | - target terminal attributes |
| | bp->context | - connection context of the terminal to connect to |
| | (bp->conn_id) | - connection id or NO_ID |
| | (bp->conn_h) | - connection handle or NO_HDL |

out: void
act: connect terminal to another terminal

| | |
|---|---|
| s : ST_REFUSE | - interface mismatch (e.g., unacceptable |
| | ‘contract_id’) or inappropriate state |

ST_NOT_FOUND - terminal not found
ST_OVERFLOW - implementation imposed restriction in # of

connections

nb : either ‘conn_id’ or ‘conn_h’ should contain a value for this opera-

tion to succeed; if both contain values, ‘conn_id’ is ignored.

nb : The connection context structures are ‘tagged’, i.e. the first

8 bits contain an identifier of the structure. Any implementation must
check and recognize the ‘tag’ before it can operate with the rest of
the structure.

argchk: sp !=NULL, bp !=NULL

sanity check: if sp->connected return ST_REFUSE

verify connection is possible:

if bp->dir has an output return ST_REFUSE

if bp->mech not vtable return ST_REFUSE

if tag in bp->context !=RDX_TRM_CTX_VTBL_TAG return ST_REFUSE

copy connection data (bp->context) into sp->conn_ctx

set sp->sync to bp->sync

set sp->attr to bp->attr

set sp->connected to TRUE

return ST_OK

Vte_disconnect

| in : sp | | - virtual terminal instance |
|---|---|---|
| | (bp->conn_id) | - connection id or NO_ID |
| | (bp->conn_h) | - connection handle or NO_HDL |

out: void
act: disconnect terminal

| | |
|---|---|
| s : ST_REFUSE | - component is in inappropriate state |

nb : either ‘conn_id’ or ‘conn_h’ should contain a value for this

operation to succeed; if both contain values, ‘conn_id’ is ignored.

argchk: sp !=NULL, bp !=NULL

if sp->connected is FALSE return ST_OK

zero out connection context (sp->conn_ctx)

set sp->connected to FALSE

return ST_OK

Vte_get_info

| in : sp | | - virtual terminal instance |
|---|---|---|
| out: bp->mech | | - terminal mechanism [TERM_M] |
| | bp->card | - terminal cardinality (static, not |
| | | current) |
| | bp->n_conn | - current # of connections |
| | bp->sync | - terminal synchronosity |
| | bp->attr | - terminal attributes |
| | bp->dir | - terminal direction |

act: return information about specified terminal

argchk: sp !=NULL, bp !=NULL

bp->mech=TERM_M_VTABLE

bp->card=1

bp->n_conn =(if sp->connected then 1 else 0)

bp->sync=TERM_S_BOTH

bp->dir=TERM_D_OUTPUT

bp->attr=TERM_A_ACTIVETIME_|TERM_A_NEGOTIABLE

return ST_OK

Appendix 11. VTRMI—Virtual Terminal Mechanism (Interior)

This mechanism is used to handle exterior virtual terminals.

1. Structures Used

1.1. VTERM—Virtual Terminal

typedef struct VTERM

| { | | |
|---|---|---|
| char | *namep; | // pointer to terminal name |
| bool | connected; | // TRUE if terminal connected |

| | | |
|---|---|---|
| byte | conn_ctx[CONN_CTX_SZ]; | // connection context |
| char | name[MAX_TERM_NM_SZ]; | // virtual terminal name |

| | | |
|---|---|---|
| word | sync; | // synchronocity |

| | | |
|---|---|---|
| dword | attr; | // terminal attributes |

} VTERM;

This structure is the instance data of a single virtual terminal.

The instance data contains the name of the terminal (fixed length), indication whether this terminal is connected and the connection data (context), synchronocity and attributes supplied by the counter terminal (if connected).

The virtual entity container utilizes the pointer to the virtual terminal name (namep field).

2. Self Data Structure

The self is the VTERM structure defined above.

Pseudo-Code

vti_acquire

| | |
|---|---|
| in : sp | - virtual terminal instance |

| | |
|---|---|
| bp->conn_id | - connection id or NO_ID |

| | |
|---|---|
| out: bp->context | - connection context |

| | |
|---|---|
| bp->mech | - terminal mechanism [TERM_M] |
| bp->card | - cardinality |
| bp->sync | - terminal synchronosity |
| bp->dir | - terminal direction |
| bp->attr | - terminal attributes |
| bp->conn_h | - connection handle |

act: acquire connection context
s : ST_NOT_FOUND - terminal not found

ST_NOT_CONNECTED - virtual terminal not connected
ST_REFUSE - component is in inappropriate state
ST_NO_ROOM - terminal cardinality exhausted
ST_OVERFLOW - provided space for context is not

enough

argchk: sp !=NULL, bp !=NULL

if sp->connected is FALSE return ST_NOP

pass:

connection context in self (sp->conn_ctx)

bp->mech=TERM_M_VTABLE

bp->card=infinite

bp->sync=sp->sync

bp->dir=TERM_D_INPUT

bp->attr=sp->attr

bp->conn_h=NO_HDL

return ST_OK

Vti_release

| | |
|---|---|
| in : sp | - virtual terminal instance |

| | |
|---|---|
| (bp−>conn_id) | - connection id or NO_ID |
| (bp−>conn_h) | - connection handle or NO_HDL |

out: void
act: release connection context

| s : ST_NO_ACTION | | - the specified context was not acquired |
|---|---|---|
| | ST_REFUSE | - component is in inappropriate state |
| | ST_NOT_CONNECTED | - virtual terminal not connected |
| | ST_NOT_FOUND | - terminal not found |

nb : either ‘conn_id’ or ‘conn_h’ should contain a value for this

operation to succeed; if both contain values, ‘conn_id’ is ignored.

argchk: sp !=NULL, bp !=NULL

if sp->connected is FALSE return ST_NOP

return ST_OK

Vti_connect

| | |
|---|---|
| in : sp | - virtual terminal instance |

| | |
|---|---|
| bp−>mech | - target terminal mechanism [TERM_M] |
| bp−>sync | - target terminal synchronosity |
| bp−>dir | - target terminal direction |
| bp−>attr | - target terminal attributes |
| bp−>context | - connection context of the terminal to |
| | connect to |
| (bp−>conn_id) | - connection id or NO_ID |
| (bp−>conn_h) | - connection handle or NO_HDL |

out: void
act: connect terminal to another terminal

| s : ST_REFUSE | | - interface mismatch (e.g., unacceptable |
|---|---|---|
| | | ‘contract_id’) or inappropriate state |
| | ST_NOT_FOUND | - terminal not found |
| | ST_NOT_CONNECTED | - virtual terminal not connected |
| | ST_OVERFLOW | - implementation imposed restriction |
| | | in # of connections |

| | |
|---|---|
| nb : | either ‘conn_id’ or ‘conn_h’ should contain a value for this |
| | operation to succeed; if both contain values, ‘conn_id’ is ignored. |
| nb : | The connection context structures are ‘tagged’, i.e. the first |
| | 8 bits contain an identifier of the structure. Any implementation |
| | must check and recognize the ‘tag’ before it can operate with |
| | the rest of the structure. |

argchk: sp !=NULL, bp !=NULL

if sp->connected is FALSE return ST_NOP

verify connection is possible:

if bp->dir has an input return ST_REFUSE

if bp->mech not vtable return ST_REFUSE

if bp->sync and sp->sync are not compatable return ST_REFUSE

if target terminal tag !=RDX_TRM_CTX_VTBL_TAG return ST_REFUSE

set cid_any to TRUE if either the target terminal output cid is CID_ANY or if sp->conn_ctx input cid is CID_ANY

if not cid_any and target terminal output cid !=sp->conn_ctx input cid return ST_REFUSE

return ST_OK

Vti_disconnect

| | |
|---|---|
| in : sp | - virtual terminal instance |

| | |
|---|---|
| (bp−>conn_id) | - connection id or NO_ID |
| (bp−>conn_h) | - connection handle or NO_HDL |

out: void
act: disconnect terminal

| | |
|---|---|
| s : ST_REFUSE | - component is in inappropriate state |

| | |
|---|---|
| ST_NOT_CONNECTED | - virtual terminal not connected |

| | |
|---|---|
| nb : | either ‘conn_id’ or ‘conn_h’ should contain a value for this |
| | operation to succeed; if both contain values, ‘conn_id’ is ignored. |

argchk: sp !=NULL, bp !=NULL

if sp->connected is FALSE return ST_NOP

return ST_OK

Vti_get_info

| | |
|---|---|
| in : sp | - virtual terminal instance |
| out: bp−>mech | - terminal mechanism [TERM_M] |

| | |
|---|---|
| bp−>card | - terminal cardinality (static, not current) |
| bp−>n_conn | - current # of connections |
| bp−>sync | - terminal synchronosity |
| bp−>attr | - terminal attributes |
| bp−>dir | - terminal direction |

| | |
|---|---|
| act: | return information about specified terminal |

argchk: sp !=NULL, bp !=NULL

bp->mech=TERM_M_VTABLE

bp->card=infinite

bp->n_conn=1

bp->sync=sp->sync

bp->dir=TERM_D_INPUT

bp->attr=sp->attr

return ST_OK

Appendix 12. VTDST—Virtual Terminal Distributor

The following structure is the instance data of a distributor of connections to virtual terminals.

typedef struct VTDST

{
DM_ARR_HDR *arrp; // array instance ID
CM_OID oid; // object ID of the host
} VTDST;

The arrp field is used to identify the Part Array instance as provided by ClassMagic.

The oid field is used for ownership of the memory allocated by the helper. The memory allocation is performed on behalf of this object.

1. Self Data Structure

The self is the VTDST structure defined above.

Pseudo-Code

Vtd_construct

| in : sp | | - storage for virtual terminal distributor instance |
|---|---|---|
| | sz | - size of the storage |
| | oid | - host |
| | arrp | - array instance ID to distribute to |

| | |
|---|---|
| out: *sp | - virtual terminal distributor instance |

| | |
|---|---|
| act: | construct virtual terminal distributor instance |

| | |
|---|---|
| s : ST_ALLOC | - not enough memory |

valchk: sp !=NULL

sanity chk: sz>=sizeof (VTDST)

arrp→sp->arrp

oid→sp->oid

return ST_OK

Vtd_destruct

| | |
|---|---|
| in : sp | - virtual terminal distributor instance |
| out: *sp | - zeroed memory |

| | |
|---|---|
| act: | destruct virtual terminal distributor instance |

valchk: sp !=NULL

zero out *sp

return ST_OK

Vtd_connect

| | |
|---|---|
| in : sp | - virtual terminal distributor instance |

| | |
|---|---|
| bp−>namep | - terminal name |

| | |
|---|---|
| skip_err | - TRUE to skip all errors |

out: void

| | |
|---|---|
| act: | connect the virtual terminal to all array elements |
| nb : | ‘skip_err’ will skip real errors only; if a terminal name |
| | is not found on a particular part this will not be considered as an |
| | error and the part will be skipped independently of whether |
| | ‘skip_err’ is TRUE or FALSE |

valchk: sp !=NULL, bp !=NULL

enumerate keys in the array, for each key

invoke DM_ARR_connect_oid

sp->arrp

key from enumeration

bp->namep (terminal name on the array element)

sp->oid

bp->namep (terminal name on the other side) key from enumeration (as conn_id)

if skip_err continue enumeration

if status different than ST_OK, ST_NOT_FOUND, return it

return ST_OK

Vtd_disconnect

| | |
|---|---|
| in : sp | - virtual terminal distributor instance |

| | |
|---|---|
| bp−>namep | - terminal name |

| | |
|---|---|
| out: | void |
| act: | disconnect the virtual terminal from ail array elements |

valchk: sp !=NULL, bp !=NULL

enumerate keys in the array, for each key

invoke DM_ARR_connect_oid

sp->arrp

key from enumeration

bp->namep (terminal name on the array element)

sp->oid

bp->namep (terminal name on the other side)

key from enumeration (as conn id)

return ST_OK

Appendix 13. Interfaces Used by Described Mechanisms

| | |
|---|---|
| /* --------------------------------------------------------------------------- | */ |

| | | |
|---|---|---|
| /* | ARR - Part Array | */ |

| | |
|---|---|
| /* | */ |

| | | |
|---|---|---|
| /* | VECON.H - Virtual Entity Container Interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

| | |
|---|---|
| /* --------------------------------------------------------------------------- | */ |
| #ifndef_VECON_H_{—} | |
| #define_VECON_H_{—} | |
| /* --- Definitions ------------------------------------------------------------ | */ |
| // instance data (the impl. detail will be hidden) | |
| typedef struct VECON | |

| { | |
|---|---|
| _hdl owner_key; | // owner key of the handle set |
| CM_OID oid; | // memory owner |
| uint32 off; | // offset of name pointer |
| } VECON; | |

| // factory | |
|---|---|
| _fpi_vc_construct (VECON *sp, uint32 sz, CM_OID oid, uint32 off); | |
| _fpi_vc_destruct (VECON *sp); | |
| // container | |
| _fpi_vc_add (VECON *sp, void *ep); | |
| _fpi_vc_remove (VECON *sp, void *ep); | |
| _fpi_vc_find (VECON *sp, const char *nmp, void * *epp); | |
| // enumeration | |
| _fpi_vc_get_first (VECON *sp, void * *epp, _ctx *ctxp); | |
| _fpi_vc_get_next (VECON *sp, void * *epp, _ctx *ctxp); | |
| _fpi_vc_get_curr (VECON *sp, void * *epp, _ctx ctx); | |
| /* --- Descriptions ---------------------------------------------------------- | */ |
| // on : vc_construct | |

| | | |
|---|---|---|
| // in : | sp | - storage for virtual entity container instance |
| // | sz | - size of the storage |
| // | oid | - object to allocate on behalf of |
| // | off | - offset of the entity name pointer |

| | |
|---|---|
| // out: *sp | - virtual entity container instance |

| // act: construct virtual entity container instance | |
|---|---|
| // s : ST_ALLOC | - not enough memory |

| // on : vc_destruct | | |
|---|---|---|
| // in : sp | | - virtual entity container instance |
| // out: *sp | | - zeroed memory |
| // act: destruct virtual entity container instance | | |
| // on : vc_add | | |
| // in : | sp | - virtual entity container instance |
| // | ep | - virtual entity instance |

| // out: void | | |
|---|---|---|
| // act: add virtual entity to the container instance | | |
| // s : | ST_ALLOC | - not enough memory |

| | | |
|---|---|---|
| // | ST_NO_ROOM | - too many virtual properties |
| // | ST_DUPLICATE | - duplicate entity name |

| // on : vc_remove | | |
|---|---|---|
| // in : | sp | - virtual entity container instance |
| // | ep | - virtual entity to remove |
| // out: void | | |
| // act: remove virtual entity from the container instance | | |
| // s : ST_NOT_FOUND | | |
| // on : vc_find | | |
| // in : | sp | - virtual entity container instance |
| // | nmp | - virtual entity name to find |
| // | epp | - storage for virtual entity |

| | |
|---|---|
| // out: *epp | - virtual entity |

| // act: find virtual entity by name | | |
|---|---|---|
| // s : ST_NOT_FOUND - no such property | | |
| // on : vc_get_first | | |
| // in : | sp | - virtual entity container instance |
| // | epp | - storage for virtual entity or NULL |

| | | |
|---|---|---|
| // | enum_ctxp | - storage for enumeration context |

| | |
|---|---|
| // out: *enum_ctxp | - enumeration context |

| | | |
|---|---|---|
| // | (*epp) | - virtual entity (if ‘epp’ is not NULL) |

| // act: get first virtual entity | | |
|---|---|---|
| // s : ST_NOT_FOUND - no terminals | | |
| // on : vc_get_next | | |
| // in : | sp | - virtual entity container instance |
| // | epp | - storage for virtual entity or NULL |

| | | |
|---|---|---|
| // | enum_ctxp | - pointer to enumeration context from previous |

| | |
|---|---|
| // | vc_get_xxx operation |

| | |
|---|---|
| // out: *enum_ctxp | - new enumeration context |

| | | |
|---|---|---|
| // | (*epp) | - virtual entity (if ‘epp’ is not NULL) |

| // act: get next virtual entity according to the enumeration context | | |
|---|---|---|
| // s : ST_NOT_FOUND - no more terminals | | |
| // on : vc_get_curr | | |
| // in : | sp | - virtual entity container instance |
| // | epp | - storage for virtual entity or NULL |

| | | |
|---|---|---|
| // | enum_ctx | - enumeration context from previous vc_get_xxx operation |

| | |
|---|---|
| // out:(*epp) | - virtual entity (if ‘epp’ is not NULL) |

| // act: get current virtual entity according to the enumeration context | |
|---|---|
| // s : ST_NOT_FOUND - no current terminal | |
| #endif // _VECON_H_{—} | |
| /* --------------------------------------------------------------------------- | */ |

| | | |
|---|---|---|
| /* | ARR - Part Array | */ |

| | |
|---|---|
| /* | */ |

| | | |
|---|---|---|
| /* | VPROP.H - Virtual Property Mechanism Helper Interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |
| /* --------------------------------------------------------------------------- | */ |
| #ifndef_VPROP_H_{—} | |
| #define_VPROP_H_{—} | |
| /* --- Definitions ----------------------------------------------------------- | */ |
| // instance data (the impl. detail will be hidden) | |
| typedef struct VPROP | |

{
char *namep; // name of the property
uint16 type; // property data type
void *valp; // pointer to value
uint32 len; // length of the value
CM_OID oid; // memory owner
} VPROP;

typedef struct B_VPROP

| { | |
|---|---|
| void *p; | // data pointer |
| uint32 len; | // length |
| uint32 sz; | // size |
| uint type; | // property type |

} B_VPROP;

| | |
|---|---|
| /* --- Operations ------------------------------------------------------------ | */ |

| // factory | |
|---|---|
| _fpi_vp_construct (VPROP *sp, uint32 sz, CM_OID oid, const char *nmp); | |
| _fpi_vp_destruct (VPROP *sp); | |
| // mechanism operations | |
| _fpi_vp_get | (VPROP *sp, B_VPROP *bp); |
| _fpi_vp_set | (VPROP *sp, B_VPROP *bp); |
| _fpi_vp_chk | (VPROP *sp, B_VPROP *bp); |

| // utility | |
|---|---|
| _fpi_vp_get_info | (VPROP *sp, B_VPROP *bp); |

| | |
|---|---|
| /* --- Descriptions --------------------------------------------------------- | */ |
| // on : vp_construct | |

| | | |
|---|---|---|
| // in : | sp | - storage for virtual property instance |
| // | sz | - size of the storage |
| // | oid | - object to allocate on behalf on |
| // | nmp | - property name |

| | |
|---|---|
| // out: *sp | - virtual property instance |

| // act: construct virtual property instance | |
|---|---|
| // s : ST_ALLOC | - not enough memory |

| // on : vp_destruct | | |
|---|---|---|
| // in : sp | | - virtual property instance |
| // out: *sp | | - zeroed memory |
| // act: destruct virtual property instance | | |
| // on : vp_get | | |
| // in : | sp | - virtual property instance |

| // | bp->type | - expected value type or PROP_T_NONE for any |
|---|---|---|
| // | bp->p | - buffer for property value or NULL |
| // | (bp->sz) | - size of buffer (if bp->p != NULL) |
| // out: bp->type | | - actual type of value (if bp->type = = PROP_T_NONE) |
| // | (*bp->p) | - property value (if bp->p != NULL) |
| // | bp->len | - actual length of value, [bytes], incl. any terminators |

| // act: get virtual property value | | |
|---|---|---|
| // s : | ST_REFUSE | - incorrect property type |
| // | ST_OVERFLOW | - buffer too small for property value |

| // nb : bp->sz must be provided for all property types, included fixed-size | | |
|---|---|---|
| // on : vp_set | | |
| // in : | sp | - virtual property instance |

| | | |
|---|---|---|
| // | bp->type | - property type or PROP_T_NONE if unknown |
| // | bp->p | - buffer containing property value, NULL for default |
| // | bp->len | - actual length of value, [bytes], or 0 for auto |

| // out: void | | |
|---|---|---|
| // act: set virtual property value | | |
| // s : | ST_REFUSE | - incorrect property type |

| | | |
|---|---|---|
| // | ST_BAD_VALUE | - bad property value |
| // | ST_OVERFLOW | - property value too long |

| // nb : bp->len = = 0 is allowed only on fixed-size types, ASCIZ and UNICODEZ | | |
|---|---|---|
| // on : vp_chk | | |
| // in : | sp | - virtual property instance |

| | | |
|---|---|---|
| // | bp->namep | - name of property to check or NULL |
| // | bp->type | - property type or PROP_T_NONE if unknown |
| // | bp->p | - buffer containing property value, NULL for default |
| // | bp->len | - actual length of value, [bytes], or 0 for auto |

| // out: void | | |
|---|---|---|
| // act: check virtual property value | | |
| // s : | ST_REFUSE | - incorrect property type |
| // | ST_BAD_VALUE | - bad property value |
| // | ST_OVERFLOW | - property value too long |

| // nb : bp->len = = 0 is allowed only on fixed-size types, ASCIZ and UNICODEZ | | |
|---|---|---|
| // on : vp_get_info | | |
| // in : | sp | - virtual property instance |

| // | bp->p | - buffer for the name |
|---|---|---|
| // | bp->sz | - size of the buffer |
| // out: *bp->p | | - virtual property name |
| // | (bp->sz) | - size of buffer needed for property name |

| | |
|---|---|
| // | (if ST_OVERFLOW returned) |

| | | |
|---|---|---|
| // | bp->type | - property type |

| // act: retrieve information about the virtual property | |
|---|---|
| // s : ST_OVERFLOW - buffer too small (bp->sz contains the needed size) | |
| #endif //_VPROP_H_{—} | |
| /* --------------------------------------------------------------------------- | */ |

| | | |
|---|---|---|
| /* | ARR - Part Array | */ |

| | |
|---|---|
| /* | */ |

| | | |
|---|---|---|
| /* | VPDST.H - Virtual Property Distributor Helper Interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

| | |
|---|---|
| /* --------------------------------------------------------------------------- | */ |
| #ifndef _VPDST_H_{—} | |
| #define _VPDST_H_{—} | |
| /* --- Definitions ----------------------------------------------------------- | */ |
| // instance data (the impl. detail will be hidden) | |
| typedef struct VPDST | |

{
DM_ARR_HDR *arrp; // array instance ID
CM_OID oid; // object to allocate memory on behalf of
} VPDST;

| /* --- Operations ------------------------------------------------------------ | */ |
|---|---|
| // factory | |
| _fpi_vpd_construct (VPDST *sp, uint32 sz, CM_OID oid, _hdl arrh); | |
| _fpi_vpd_destruct (VPDST *sp); | |
| // operations | |
| _fpi_vpd_set (VPDST *sp, B_PROPERTY *bp, bool skip_err); | |
| _fpi_vpd_chk (VPDST *sp, B_PROPERTY *bp); | |
| /* --- Descriptions ----------------------------------------------------------- | */ |
| // on : vpd_construct | |

| | | |
|---|---|---|
| // in : | sp | - storage for virtual property distributor instance |
| // | sz | - size of the storage |
| // | oid | - object ID to allocate on behalf of |
| // | arrp | - array instance ID to distribute to |

| | |
|---|---|
| // out: *sp | - virtual property distributor instance |

| // act: construct virtual property distributor instance | | |
|---|---|---|
| // s : | ST_ALLOC | - not enough memory |

| // on : vpd_destruct | | |
|---|---|---|
| // in : sp | | - virtual property distributor instance |
| // out: *sp | | - zeroed memory |
| // act: destruct virtual property distributor instance | | |
| // on | vpd_set | |
| // in : | sp | - virtual property distributor instance |
| // | bp->p | - pointer to value to set (NULL for default) |
| // | bp->len | - value length (0 - for auto) |

| | | |
|---|---|---|
| // | bp->type | - property type or PROP_T_NONE if unknown |
| // | skip_err | - TRUE to skip errors |

| // out: void | | |
|---|---|---|
| // act: set virtual property value to all elements in the array | | |
| // s : | ST_REFUSE | - incorrect property type |
| // | ST_BAD_VALUE | - bad property value |
| // | ST_OVERFLOW | - property value too long |

| // nb : | bp->len = = 0 is allowed only on fixed-size types, ASCIZ and UNICODEZ | |
|---|---|---|
| // nb : | ‘skip_err’ will skip real errors only; if a property name is not found | |
| // | on a particular part this will not be considered as an error and | |
| // | the part will be skipped independently of whether ‘skip_err’ is | |
| // | TRUE or FALSE | |
| // on vpd_chk | | |
| // in : | sp | - virtual property distributor instance |
| // | vp | - virtual property to distribute the value of |

| // out: void | | |
|---|---|---|
| // act: check virtual property value to all elements in the array | | |
| // s : | ST_REFUSE | - incorrect property type |

| | | |
|---|---|---|
| // | ST_BAD_VALUE | - bad property value |
| // | ST_OVERFLOW | - property value too long |

| // nb : bp->Len = = 0 is allowed only on fixed-size types, ASCIZ and UNICODEZ | |
|---|---|
| #endif //_VPDST_H_{—} | |
| /* --------------------------------------------------------------------------- | */ |

| | | |
|---|---|---|
| /* | ARR - Part Array | */ |

| | |
|---|---|
| /* | */ |

| | | |
|---|---|---|
| /* | VTERM.H - Virtual Terminal Helper Interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

| /* --------------------------------------------------------------------------- | */ |
|---|---|
| #ifndef _VTERM_H_{—} | |
| #define _VTERM_H_{—} | |
| /* --- Definitions ----------------------------------------------------------- | */ |
| // instance data (the impl. detail will be hidden) | |
| typedef struct VTERM | |

| { | | |
|---|---|---|
| char | *namep; | // pointer to entity name |
| bool | connected; | // TRUE if terminal is connected |

| | | |
|---|---|---|
| byte | conn_ctx[TERM_CONN_CTX_SZ]; | // connection context |
| char | name[RDX_MAX_TRM_NM_LEN + 1]; | // virtual terminal name |

} VTERM;

| /* --- Operations ---------------------------------------------------------- | */ |
|---|---|
| // factory | |
| _fpi_vt_construct (VTERM *sp, uint32 sz, CM_OID oid, const char *nmp); | |
| _fpi_vt_destruct (VTERM *sp); | |
| /* --- Operations ---------------------------------------------------------- | */ |
| // on : vt_construct | |

| | | |
|---|---|---|
| // in : | sp | - storage for virtual terminal instance |
| // | sz | - size of the storage |
| // | oid | - object to allocate on behalf on |
| // | nmp | - terminal name |

| | |
|---|---|
| // out: *sp | - virtual terminal instance |
| // act: | construct virtual terminal instance |
| // s : | ST_ALLOC - not enough memory |
| // on : | vt_destruct |
| // in : sp | - virtual terminal instance |
| // out: *sp | - zeroed memory |

| // act: destruct virtual terminal instance | |
|---|---|
| #endif // _VTERM_H_{—} | |
| /* --------------------------------------------------------------------------- | */ |

| | | |
|---|---|---|
| /* | ARR - Part Array | */ |

| | |
|---|---|
| /* | */ |

| | | |
|---|---|---|
| /* | VTRME.H - Exterior Virtual Terminal Helper Interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

| | |
|---|---|
| /* --------------------------------------------------------------------------- | */ |
| #ifndef _VTRME_H_{—} | |
| #define _VTRME_H_{—} | |
| /* --- Definitions ----------------------------------------------------------- | */ |
| #include <vterm.h> | |
| /* --- Operations ------------------------------------------------------------ | */ |
| // mechanism operations | |
| _fpi_vte_acquire (VTERM *sp, B_TERMINAL *bp); | |
| _fpi_vte_connect (VTERM *sp, B_TERMINAL *bp); | |
| _fpi_vte_disconnect (VTERM *sp, B_TERMINAL *bp); | |
| _fpi_vte_release (VTERM *sp, B_TERMINAL *bp); | |
| // utility | |
| _fpi_vte_get_info (VTERM *sp, B_TERMINAL *bp); | |
| /* --- Descriptions ---------------------------------------------------------- | */ |
| // on : vte_acquire | |

| | | |
|---|---|---|
| // in : | sp | - virtual terminal instance |

| // | bp->conn_id | - connection id or NO_ID |
|---|---|---|
| // out: bp->context | | - connection context |
| // | bp->type | - terminal type [TERM_TYPE] |
| // | bp->card | - cardinality |
| // | bp->sync | - terminal synchronosity |
| // | bp->dir | - terminal direction |
| // | bp->attr | - terminal attributes |
| // | bp->conn_h | - connection handle |

| // act: acquire connection context | | |
|---|---|---|
| // s : | ST_NOT_FOUND | - terminal not found |
| // | ST_REFUSE | - component is in inappropriate state |
| // | ST_NO_ROOM | - terminal cardinality exhausted |
| // | ST_OVERFLOW | - provided space for context is not enough |

| // on : vte_release | | |
|---|---|---|
| // in : | sp | - virtual terminal instance |

| | | |
|---|---|---|
| // | (bp->conn_id) | - connection id or NO_ID |
| // | (bp->conn_h) | - connection handle or NO_HDL |

| // out: void | | |
|---|---|---|
| // act: release connection context | | |
| // s : | ST_NO_ACTION | - the specified context was not acquired |

| | | |
|---|---|---|
| // | ST_REFUSE | - component is in inappropriate state |

| | | |
|---|---|---|
| // | ST_NOT_FOUND | - terminal not found |

| // nb : either ‘conn_id’ or ‘conn_h’ should contain a value for this operation | | |
|---|---|---|
| // | to succeed; if both contain values, ‘conn_id’ is ignored. | |
| // on : vte_connect | | |
| // in : | sp | - virtual terminal instance |

| | | |
|---|---|---|
| // | bp->type | - target terminal type [TERM_TYPE] |
| // | bp->sync | - target terminal synchronosity |

| | | |
|---|---|---|
| // | bp->dir | - target terminal direction |
| // | bp->attr | - target terminal attributes |

| | | |
|---|---|---|
| // | bp->context | - connection context of the terminal to connect to |
| // | (bp->conn_id) | - connection id or NO_ID |
| // | (bp->conn_h) | - connection handle or NO_HDL |

| // out: void | | |
|---|---|---|
| // act: connect terminal to another terminal | | |
| // s : | ST_REFUSE | - interface mismatch (e.g., unacceptable ‘contract_id’) |

| | |
|---|---|
| // | or inappropriate state |

| | | |
|---|---|---|
| // | ST_NOT_FOUND | - terminal not found |
| // | ST_OVERFLOW | - implementation imposed restriction in # of connections |

| // nb : either ‘conn_id’ or ‘conn_h’ should contain a value for this operation | |
|---|---|
| // | to succeed; if both contain values, ‘conn_id’ is ignored. |
| // nb : | The connection context structures are ‘tagged’, i.e. the first |
| // | 8 bits contain an identifier of the structure. Any implementation must |
| // | check and recognize the ‘tag’ before it can operate with the rest of |
| // | the structure. |

| // on : vte_disconnect | |
|---|---|
| // in : sp | - virtual terminal instance |

| // | (bp->conn_id) | - connection id or NO_ID |
|---|---|---|
| // | (bp->conn_h) | - connection handle or NO_HDL |
| // out: void | | |
| // act: disconnect terminal | | |
| // s : | ST_REFUSE | - component is in inappropriate state |

| // nb : either ‘conn_id’ or ‘conn_h’ should contain a value for this operation | |
|---|---|
| // | to succeed; if both contain values, ‘conn_id’ is ignored. |

| // on : vte_get_info | |
|---|---|
| // in : sp | - virtual terminal instance |

| | |
|---|---|
| // out : bp->type | - terminal type [TERM_TYPE] |

| | | |
|---|---|---|
| // | bp->card | - terminal cardinality (static, not current) |

| | | |
|---|---|---|
| // | bp->n_conn | - current # of connections |

| | | |
|---|---|---|
| // | bp->sync | - terminal synchronosity |
| // | bp->attr | - terminal attributes |
| // | bp->dir | - terminal direction |

| // act: return information about specified terminal | |
|---|---|
| #endif // _VTRME_H_{—} | |
| /* --------------------------------------------------------------------------- | */ |

| | | |
|---|---|---|
| /* | ARR - Part Array | */ |

| | |
|---|---|
| /* | */ |

| | | |
|---|---|---|
| /* | VTRMI.H - Interior Virtual Terminal Helper interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* --------------------------------------------------------------------------- | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

| /* --------------------------------------------------------------------------- | */ |
|---|---|
| #ifndef _VTRMI_H_{—} | |
| #define _VTRMI_H_{—} | |
| /* --- Definitions --------------------------------------------------------- | */ |
| #include <vterm.h> | |
| /* --- Operations ---------------------------------------------------------- | */ |
| // mechanism operations | |
| _fpi_vti_acquire (VTERM *sp, B_TERMINAL *bp); | |
| _fpi_vti_connect (VTERM *sp, B_TERMINAL *bp); | |
| _fpi_vti_disconnect (VTERM *sp, B_TERMINAL *bp); | |
| _fpi_vti_release (VTERM *sp, B_TERMINAL *bp); | |
| // utility | |
| _fpi_vti_get_info (VTERM *sp, B_TERMINAL *bp); | |
| /* --- Descriptions ------------------------------------------------------- | */ |

| // on : vti_acquire | | |
|---|---|---|
| // in : | sp | - virtual terminal instance |

| | | |
|---|---|---|
| // | bp->conn_id | - connection id or NO_ID |

| | |
|---|---|
| // out: bp->context | - connection context |

| | | |
|---|---|---|
| // | bp->type | - terminal type [TERM_TYPE] |
| // | bp->card | - cardinality |
| // | bp->sync | - terminal synchronosity |

| | | |
|---|---|---|
| // | bp->dir | - terminal direction |
| // | bp->attr | - terminal attributes |

| // | bp->conn_h | - connection handle |
|---|---|---|
| // act: acquire connection context | | |
| // s : | ST_REFUSE | - component is in inappropriate state |

| | | |
|---|---|---|
| // | ST_NO_ROOM | - terminal cardinality exhausted |

| | | |
|---|---|---|
| // | ST_NOP | - operation cannot be performed at this time |

| | | |
|---|---|---|
| // | ST_OVERFLOW | - provided space for context is not enough |

| // on : vti_release | | |
|---|---|---|
| // in : | sp | - virtual terminal instance |

| | | |
|---|---|---|
| // | (bp->conn_id) | - connection id or NO_ID |
| // | (bp->conn_h) | - connection handle or NO_HDL |

| // out: void | | |
|---|---|---|
| // act: release connection context | | |
| // s : | ST_NO_ACTION | - the specified context was not acquired |

| | | |
|---|---|---|
| // | ST_NOT_CONNECTED | - virtual terminal not connected |

| | | |
|---|---|---|
| // | ST_REFUSE | - component is in inappropriate state |

| // nb : either ‘conn_id’ or ‘conn_h’ should contain a value for this operation | | |
|---|---|---|
| // | to succeed; if both contain values, ‘conn_id’ is ignored. | |
| // on : vti_connect | | |
| // in : | sp | - virtual terminal instance |

| | | |
|---|---|---|
| // | bp->type | - target terminal type [TERM_TYPE] |
| // | bp->sync | - target terminal synchronosity |

| | | |
|---|---|---|
| // | bp->dir | - target terminal direction |
| // | bp->attr | - target terminal attributes |

| | | |
|---|---|---|
| // | bp->context | - connection context of the terminal to connect to |
| // | (bp->conn_id) | - connection id or NO_ID |
| // | (bp->conn_h) | - connection handle or NO_HDL |

| // out: void | | |
|---|---|---|
| // act: connect terminal to another terminal | | |
| // s : | ST_REFUSE | - interface mismatch (e.g., unacceptable |

| | |
|---|---|
| // | ‘contract_id’) or inappropriate state |

| | | |
|---|---|---|
| // | ST_OVERFLOW | - implementation imposed restriction in # of |

| | |
|---|---|
| // | connections |

| | | |
|---|---|---|
| // | ST_NOP | - operation cannot be performed at this time |

| // nb : either ‘conn_id’ or ‘conn_h’ should contain a value for this operation | | |
|---|---|---|
| // | to succeed; if both contain values, ‘conn_id’ is ignored. | |
| // nb : The connection context structures are ‘tagged’, i.e. the first | | |
| // | 8 bits contain an identifier of the structure. Any implementation must | |
| // | check and recognize the ‘tag’ before it can operate with the rest of | |
| // | the structure. | |
| // on : vti_disconnect | | |
| // in : | sp | - virtual terminal instance |

| | | |
|---|---|---|
| // | (bp->conn_id) | - connection id or NO_ID |
| // | (bp->conn_h) | - connection handle or NO_HDL |

| // out: void | | |
|---|---|---|
| // act: disconnect terminal | | |
| // s : | ST_REFUSE | - component is in inappropriate state |

| | | |
|---|---|---|
| // | ST_NOP | - operation cannot be performed at this time |

| // nb : either ‘conn_id’ or ‘conn_h’ should contain a value for this operation | | |
|---|---|---|
| // | to succeed; if both contain values, ‘conn_id’ is ignored. | |
| // on : vti_get_info | | |
| // in : | sp | - virtual terminal instance |

| | |
|---|---|
| // out: bp->type | - terminal type [TERM_TYPE] |

| | | |
|---|---|---|
| // | bp->card | - terminal cardinality (static, not current) |

| | | |
|---|---|---|
| // | bp->n_conn | - current # of connections |

| | | |
|---|---|---|
| // | bp->sync | - terminal synchronosity |
| // | bp->attr | - terminal attributes |
| // | bp->dir | - terminal direction |

| // act: return information about specified terminal | |
|---|---|
| // s : ST_NOP | - operation cannot be performed at this time |

| #endif // _VTRMI_H_{—} | |
|---|---|
| /* --------------------------------------------------------------------------- | */ |

| | | |
|---|---|---|
| /* | ARR - Part Array | */ |

| | |
|---|---|
| /* | */ |

| | | |
|---|---|---|
| /* | VTDST.H - Virtual Terminal Distributor Helper Interface | */ |

| | |
|---|---|
| /* --------------------------------------------------------------------------- | */ |

| | |
|---|---|
| /* Copyright (c) 1998 Object Dynamics Corp. All Rights Reserved. | */ |

| | |
|---|---|
| /* --------------------------------------------------------------------------- | */ |

| | |
|---|---|
| /* Use of copyright notice does not imply publication or disclosure. | */ |

/* THIS SOFTWARE CONTAINS CONFIDENTIAL AND PROPRIETARY

INFORMATION */

/* CONSTITUTING VALUABLE TRADE SECRETS OF OBJECT DYNAMICS CORP.,

AND */

/* MAY NOT BE (a) DISCLOSED TO THIRD PARTIES, (b) COPIED IN ANY FORM,

*/

/* OR (c) USED FOR ANY PURPOSE EXCEPT AS SPECIFICALLY PERMITTED IN

*/

| | |
|---|---|
| /* WRITING BY OBJECT DYNAMICS CORP. | */ |

| /* ------------------------------------------------------------------------- | */ |
|---|---|
| #ifndef _VTDST_H_{—} | |
| #define _VTDST_H_{—} | |
| /* --- Definitions --------------------------------------------------------- | */ |

// instance data (the impl. detail will be hidden)
typedef struct VTDST

{
DM_ARR_HDR *arrp; // array instance ID
CM_OID oid; // object ID of the host
} VTDST;

| /* --- Operations ---------------------------------------------------------- | */ |
|---|---|
| // factory | |
| _fpi_vtd_construct (VTDST *sp, uint32 sz, CM_OID oid, _hdl arrh); | |
| _fpi_vtd_destruct (VTDST *sp); | |
| // operations | |
| _fpi_vtd_connect (VTDST *sp, B_TERMINAL *vtp, bool skip_err); | |
| _fpi_vtd_disconnect (VTDST *sp, B_TERMINAL *vtp); | |
| /* --- Descriptions -------------------------------------------------------- | */ |

| // on : vtd_construct | | |
|---|---|---|
| // in : | sp | - storage for virtual terminal distributor instance |
| // | sz | - size of the storage |
| // | oid | - host |
| // | arrp | - array instance ID to distribute to |

| | |
|---|---|
| // out: *sp | - virtual terminal distributor instance |

| // act: construct virtual terminal distributor instance | | |
|---|---|---|
| // s : | ST_ALLOC | - not enough memory |

| // on : vtd_destruct | | |
|---|---|---|
| // in : | sp | - virtual terminal distributor instance |
| // out: | *sp | - zeroed memory |

| // act: | destruct virtual terminal distributor instance | |
|---|---|---|
| // on | vtd_connect | |
| // in : | sp | - virtual terminal distributor instance |

| | | |
|---|---|---|
| // | bp->namep | - terminal name |

| // | skip_err | - TRUE to skip all errors |
|---|---|---|
| // out: | void | |
| // act: | connect the terminal on the host to all array elements | |
| // nb : | ‘skip_err’ will skip real errors only; if a terminal name is not found | |
| // | on a particular part this will not be considered as an error and | |
| // | the part will be skipped independently of whether ‘skip_err’ is | |
| // | TRUE or FALSE | |
| // on | vtd_disconnect | |
| // in : | sp | - virtual terminal distributor instance |

| | | |
|---|---|---|
| // | bp->namep | - terminal name |

| | |
|---|---|
| // out: | void |
| // act: | disconnect the terminal on the host from all array elements |

#endif // _VTDST_H_{—}

Appendix 14. Interfaces Exposed by DM_ARR

This sections describes the interfaces used by the DM_ARR terminals fact, prop and conn. These interfaces are I_A_FACT, I_A_PROP and I_A_CONN, respectively.

| | |
|---|---|
| /* --------------------------------------------------------------------------- | */ |

| | | |
|---|---|---|
| /* | I_A_FACT.H - Array Factory | */ |

| | |
|---|---|
| /* | */ |

| | | |
|---|---|---|
| /* | Copyright (c) 1990-1998 Object Dynamics Corp. All Rights Reserved. | */ |

| | |
|---|---|
| /* --------------------------------------------------------------------------- | */ |

| | |
|---|---|
| /* BE180BD0-D30B-11D1-B589-0040052479F6 | */ |

| | |
|---|---|
| /* --------------------------------------------------------------------------- | */ |

#ifndef _I_A_FACT_H_{—}
#define _I_A_FACT_H_{—}
// attribute definitions

| | |
|---|---|
| #define A_FACT_A_NONE | 0 |
| #define A_FACT_A_USE_ID | (1 UL << 0) |

// bus declaration
BUS (B_A_FACT)

flg32 attr ; // attributes [A_FACT_A_XXX]
char *namep ; // class name for part to create
uint32 id ; // part instance id
_ctx ctx ; // enumeration context

END_BUS
// interface declaration
IFACE (I_A_FACT, (CM_USRBASE + 0x1640))

| | |
|---|---|
| oper (create | , B_A_FACT) |
| oper (destroy | , B_A_FACT) |
| oper (activate | , B_A_FACT) |
| oper (deactivate | , B_A_FACT) |
| oper (get_first | , B_A_FACT) |
| oper (get_next | , B_A_FACT) |

END_IFACE
// Operation descriptions:
// on create

| | | |
|---|---|---|
| // in : | attr | - attributes [A_FACT_A_XXX] |

| | | |
|---|---|---|
| // | namep | - class name of part or NULL for default |

| | | |
|---|---|---|
| // | id | - id to use if A_FACT_A_USE_ID is set |

| | | |
|---|---|---|
| // out: | id | - id of the created part (A_FACT_A_USE_ID is clear) |

| | |
|---|---|
| // act: | Create a part instance in the array |
| // s : | CMST_OK - successful |
| // | CMST_CANT_BIND - the part class was not found |
| // | CMST_ALLOC - not enough memory |
| // | CMST_NO_ROOM - no more parts can be created |
| // | CMST_DUPLICATE - the specified id already exists (if A_FACT_A_USE_ID) |
| // | (all others) - specific error occurred during object creation |

// on destroy
// in : id - id of part to destroy
// out: void
// act: destroy a part instance in the array

| | | |
|---|---|---|
| // s : | CMST_OK | - successful |

| | |
|---|---|
| // | CMST_NOT_FOUND - a part with the specified id was not found |
| // | (all others) - an intermittent error occurred during destruction |

// on activate
// in : id - id of part to activate
// out: void
// act: activate a part instance in the array

| | |
|---|---|
| // s : | CMST_OK - successful |
| // | CMST_NOT_FOUND - a part with the specified id was not found |
| // | CMST_NO_ACTION - the object is already active |
| // | CMST_REFUSE - mandatory properties have not been set or |

| | |
|---|---|
| // | terminals not connected |

| | |
|---|---|
| // | (all others) - as returned by part's activator |

// on deactivate
// in : id - id of part to deactivate
// out: void
// act: deactivate a part instance in the array

| | |
|---|---|
| // s : | CMST_OK - successful |
| // | CMST_NOT_FOUND - a part with the specified id was not found |
| // | (all others) - as returned by part's deactivator |

// on get_first
// in : void

| | | |
|---|---|---|
| // out: | id | - id of the first part in the array |
| // | ctx | - enumeration context for subsequent get_next |

// act: get the first part in the part array

| // s : | CMST_OK - successful | |
|---|---|---|
| // | CMST_NOT_FOUND - the array has no parts | |
| // on | get_next | |
| // in : | ctx | - enumeration context from previous get_xxx |
| // out: | id | - id of next part in the array |
| // | ctx | - enumeration context for subsequent get_xxx |

| | |
|---|---|
| // act: | get the next part in the part array |
| // s : | CMST_OK - successful |
| // | CMST_NOT_FOUND - the array has no more parts |

#endif // _I_A_FACT_H_{—}

| | |
|---|---|
| /* --------------------------------------------------------------------------- | */ |

| | | |
|---|---|---|
| /* | I_A_PROP.H - Array Property | */ |

| | |
|---|---|
| /* | */ |

| | | |
|---|---|---|
| /* | Copyright (c) 1990-1998 Object Dynamics Corp. All Rights Reserved. | */ |

| | |
|---|---|
| /* --------------------------------------------------------------------------- | */ |

| | |
|---|---|
| /* BE 180BD3-D30B-11D1-B589-0040052479F6 | */ |

| | |
|---|---|
| /* --------------------------------------------------------------------------- | */ |

#ifndef _I_A_PROP_H_{—}
#define _I_A_PROP_H_{—}
// bus declaration
BUS (B_A_PROP)

| | |
|---|---|
| uint32 | id ; // id of the instance that is the operation target |
| char | *namep ; // property name [ASCIZ] |
| uint16 | type ; // property type [CMPRP_T_XXX] |
| flg32 | attr ; // attributes [CMPRP_A_XXX] |
| flg32 | attr_mask; // attribute mask for queries [CMPRP_A_XXX] |
| void | *bufp ; // pointer to input buffer |
| uint32 | buf_sz ; // size of *bufp in bytes |
| uint32 | val_len ; // length of value in *bufp in bytes |
| _hdl | qryh ; // query handle |

END_BUS
// interface declaration
IFACE (I_A_PROP, (CM_USRBASE + 0x1650))

| | |
|---|---|
| oper (get | , B_A_PROP) |
| oper (set | , B_A_PROP) |
| oper (chk | , B_A_PROP) |

| | |
|---|---|
| oper (get_info | , B_A_PROP) |

| | |
|---|---|
| oper (qry_open | , B_A_PROP) |
| oper (qry_close | , B_A_PROP) |

| | |
|---|---|
| oper (qry_first | , B_A_PROP) |

| | |
|---|---|
| oper (qry_next | , B_A_PROP) |
| oper (qry_curr | , B_A_PROP) |

END_IFACE
// Operation descriptions:
// on get

| | |
|---|---|
| // in : | id - target instance ID |
| // | namep - null-terminated property name |
| // | type - type of the property to retrieve |

| | |
|---|---|
| // | or CMPRP_T_NONE for any |

| | |
|---|---|
| // | bufp - pointer to buffer to receive property or NULL |
| // | buf_sz - size in bytes of *bufp |

// out:(*bufp) - property value

| | |
|---|---|
| // | val_len - length in bytes of property value |

// act: get the value of a property from a part in the array

| | |
|---|---|
| // s : | CMST_OK - successful |
| // | CMST_NOT_FOUND - the property could not be found or the id is invalid |
| // | CMST_REFUSE - the data type does not match the expected type |
| // | CMST_OVERFLOW - the buffer is too small to hold the property value |

// on set

| | | |
|---|---|---|
| // in : | id | - target instance ID |
| // | namep | - null-terminated property name |
| // | type | - type of the property to set |
| // | bufp | - pointer to buffer containing property value |
| // | val_len | - size in bytes of property value |

| | |
|---|---|
| // out: | void |
| // act: | set the value of a property of a part in the array |
| // s : | CMST_OK - successful |
| // | CMST_NOT_FOUND - the property could not be found |

| | |
|---|---|
| // | or the id is invalid |

| | |
|---|---|
| // | CMST_REFUSE - the property type is incorrect or the property |

| | |
|---|---|
| // | cannot be changed while the part is in an active |
| // | state |

| | |
|---|---|
| // | CMST_OUT_OF_RANGE - the property value is not within the range of |

| | |
|---|---|
| // | allowed values for this property |

| | |
|---|---|
| // | CMST_BAD_ACCESS - there has been an attempt to set a |

| | |
|---|---|
| // | read-only property |

| | |
|---|---|
| // | CMST_OVERFLOW - the property value is too large |
| // | CMST_NULL_PTR - the property name pointer is NULL or an attempt was |

| | |
|---|---|
| // | made to set default value for a property that does |
| // | not have a default value |

| | |
|---|---|
| // nb : | for string properties, val_len must include the terminating zero |
| // nb : | If bufp is NULL, the function tries to reset the property value to |
| // | its default. |
| // on | chk |
| // in : | id - target instance ID |
| // | namep - null-terminated property name |
| // | type - type of the property value to check |
| // | bufp - pointer to buffer containing property value |
| // | val_len - size in bytes of property value |

// out: void
// act: check if a property can be set to the specified value

| | |
|---|---|
| // s : | CMST_OK - successful |
| // | CMST_NOT_FOUND - the property could not be found or the id |

| | |
|---|---|
| // | is invalid |

| | |
|---|---|
| // | CMST_REFUSE - the property type is incorrect or the property |

| | |
|---|---|
| // | cannot be changed while the part is in an active |
| // | state |

| | |
|---|---|
| // | CMST_OUT_OF_RANGE - the property value is not within the range of |

| | |
|---|---|
| // | allowed values for this property |

| | |
|---|---|
| // | CMST_BAD_ACCESS - there has been an attempt to set a |

| | |
|---|---|
| // | read-only property |

| | |
|---|---|
| // | CMST_OVERFLOW - the property value is too large |
| // | CMST_NULL_PTR - the property name pointer is NULL or an attempt was |

| | |
|---|---|
| // | made to set default value for a property that does |
| // | not have a default value |

| | |
|---|---|
| // on | get_info |
| // in : | id - target instance ID |
| // | namep - null-terminated property name |
| // out: | type - type of property [CMPRP_T_XXX] |
| // | attr - property attributes [CMPRP_A_XXX] |
| // act: | retrieve the type and attributes of the specified property |
| // s : | CMST_OK - successful |
| // | CMST_NOT_FOUND - the property could not be found |

| | |
|---|---|
| // | or the id is invalid |

// on qry_open

| | |
|---|---|
| // in : | id - target instance ID |
| // | namep - query string (must be “*”) |
| // | attr - attribute values of properties to include |
| // | attr_mask - attribute mask of properties to include |
| // out: | qryh - query handle |
| // act: | open a query to enumerate properties on a part in the array based |
| // | upon the specified attribute mask and values |
| // | or CMPRP_A_NONE to enumerate all properties |
| // s : | CMST_OK - successful |
| // | CMST_NOT_FOUND - the id could not be found or is invalid |
| // | CMST_NOT_SUPPORTED - the specified part does not support property |

| | |
|---|---|
| // | enumeration or does not support nested or |
| // | concurrent property enumeration |

| | |
|---|---|
| // nb : | To filter by atrributes, specifiy the set of attributes in attr_mask |
| // | and their desired values in attr. During the enumeration, a bit-wise |
| // | AND is performed between the actual attributes of each property and |
| // | the value of attr_mask; the result is then compared to attr. If there |
| // | is an exact match, the property will be enumerated. |
| // nb : | To enumerate all properties of a part, specifiy the query string as “*”, |
| // | and attr_mask and attr as 0. |
| // nb : | The attribute mask can be one or more of the following: |
| // | CMPRP_A_NONE - not specified |
| // | CMPRP_A_PERSIST - persistent property |
| // | CMPRP_A_ACTIVETIME - property can be modified while active |
| // | CMPRP_A_MANDATORY - property must be set before activation |
| // | CMPRP_A_RDONLY - read-only property |
| // | CMPRP_A_UPCASE - force uppercase |
| // | CMPRP_A_ARRAY - property is an array |
| // on | qry_close |
| // in : | qryh |
| // out: | void |
| // act: | close a query |
| // s : | CMST_OK - successful |
| // | CMST_NOT_FOUND - query handle was not found or is invalid |
| // | CMST_BUSY - the object can not be entered from this execution |

| | |
|---|---|
| // | context at this time. |

| // on | qry_first | |
|---|---|---|
| // in : | qryh | - query handle returned on qry_open |
| // | bufp | - storage for the returned property name or NULL |

| | | |
|---|---|---|
| // | buf_sz | - size in bytes of *bufp |

| | |
|---|---|
| // out:(*bufp) | - property name (if bufp not NULL) |

| // act: | retrieve the first property in a query | |
|---|---|---|
| // s : | CMST_OK - successful | |
| // | CMST_NOT_FOUND - no properties found matching current query | |
| // | CMST_OVERFLOW - buffer is too small for property name | |
| // on | qry_next | |
| // in : | qryh | - query handle returned on qry_open |
| // | bufp | - storage for the returned property name or NULL |

| | | |
|---|---|---|
| // | buf_sz | - size in bytes of *bufp |

| | |
|---|---|
| // out:(*bufp) | - property name (if buf p not NULL) |

| | |
|---|---|
| // act: | retrieve the next property in a query |
| // s : | CMST_OK - successful |
| // | CMST_NOT_FOUND - there are no more properties that match the |

| | |
|---|---|
| // | query criteria |

| | |
|---|---|
| // | CMST_OVERFLOW - buffer is too small for property name |

// on qry_curr

| | | |
|---|---|---|
| // in : | qryh | - query handle returned on qry_open |
| // | bufp | - storage for the returned property name |
| // | buf_sz | - size in bytes of *bufp |

| | |
|---|---|
| // out:(*bufp) | - property name (if bufp not NULL) |

// act: retrieve the first property in a query

| | |
|---|---|
| // s : | CMST_OK - successful |
| // | CMST_NOT_FOUND - no current property (e.g. after a call to qry_open) |
| // | CMST_OVERFLOW - buffer is too small for property name |

#endif // _I_A_PROP_H_{—}

| | |
|---|---|
| /* --------------------------------------------------------------------------- | */ |

| | | |
|---|---|---|
| /* | I_A_CONN.H - Array Connection | */ |

| | |
|---|---|
| /* | */ |

| | | |
|---|---|---|
| /* | Copyright (c) 1990-1998 Object Dynamics Corp. All Rights Reserved. | */ |

| | |
|---|---|
| /* --------------------------------------------------------------------------- | */ |

| | |
|---|---|
| /* BE180BD4-D30B-11D1-B589-0040052479F6 | */ |

| | |
|---|---|
| /* --------------------------------------------------------------------------- | */ |

#ifndef _I_A_CONN_H_{—}
#define _I_A_CONN_H_{—}
// bus declaration
BUS (B_A_CONN)

uint32 id1 ; // array element id or oid of part 1
char *term1_namep ; // terminal name of part 1
uint32 id2 ; // array element id or oid of part 2
char *term2_namep ; // terminal name of part 2
_id conn_id ; // connection id

END_BUS
// interface declaration
IFACE (I_A_CONN, (CM_USRBASE + 0x1660))

| | |
|---|---|
| oper (connect_ | , B_A_CONN) |
| oper (disconnect | , B_A_CONN) |

END_IFACE
// Operation descriptions:
// on connect_{—}

| | |
|---|---|
| // in : | id1 - id or oid of part 1 |
| // | term1_namep - terminal name of part 1 |
| // | id2 - id or oid of part 2 |
| // | term2_namep - terminal name of part 2 |
| // | conn_id - connection id to represent this connection |

// out: void
// act: connect two terminals between parts in the array or between a part in

| | |
|---|---|
| // | the array and a part outside of the array |
| // s : | CMST_OK - successful |
| // | CMST_REFUSE - there has been an interface or direction mismatch |

| | |
|---|---|
| // | or an attempt has been made to connect a non-active- |
| // | time terminal when the part is in an active state |

| | |
|---|---|
| // | CMST_NOT_FOUND - at least one of the terminals could not be found or |

| | |
|---|---|
| // | one of the ids is invalid |

| | |
|---|---|
| // | CMST_OVERFLOW - an implementation imposed restriction in the number |

| | |
|---|---|
| // | of connections has been exceeded |

| | |
|---|---|
| // nb : | the operation name, connect_, has a trailing underscore to avoid |
| // | name conflict with the connect macro used in the CONNECTIONS table. |
| // nb : | id1 and id2 may be the same to connect two terminals on the same part |
| // nb : | at least one of the two ids must be an id of a part in the array |
| // nb : | if the part specified by oid is the array host, its terminal name may |
| // | identify an interior or exterior terminal. In all other cases, only |
| // | exterior terminals can be connected. |
| // on | disconnect |
| // in : | id1 - id or oid of part 1 |
| // | term1_namep - terminal name of part 1 |
| // | id2 - id or oid of part 2 |
| // | term2_namep - terminal name of part 2 |
| // | conn_id - connection id to represent this connection |
| // out: | void |
| // act: | disconnect specified terminals |
| // s : | CMST_OK - successful |
| // | (other) - intermittent failure; if possible, the connection |

| | |
|---|---|
| // | has been dissolved |

| | |
|---|---|
| // nb : | see notes above on part ids and terminal names |

#endif // _I_A_CONN_H_{—}

Glossary

The following definitions will assist the reader in comprehending the enclosed description of a preferred embodiment of the present invention. All of the following definitions are presented as they apply in the context of the present invention.

Adapter a part which converts one interface, logical connection contract and/or physical connection mechanism to another. Adapters are used to establish connections between parts that cannot be connected directly because of incompatibilities.

Alias an alternative name or path representing a part, terminal or property. Aliases are used primarily to provide alternative identification of an entity, usually encapsulating the exact structure of the original name or path.

Assembly a composite object most of the functionality of which is provided by a contained structure of interconnected parts. In many cases assemblies can be instantiated by descriptor and do not require specific program code.

Bind or binding an operation of resolving a name of an entity to a pointer, handle or other identifier that can be used to access this entity. For example, a component factory provides a bind operation that gives access to the factory interface of an individual component class by a name associated with it.

Bus, part a part which provides a many-to-many type of interaction between other parts. The name “bus” comes from the analogy with network architectures such as Ethernet that are based on a common bus through which every computer can access all other computers on the network.

Code, automatically

generated program code, such as functions or parts of functions, the source code for which is generated by a computer program.

Code, general purpose program code, such as functions and libraries, used by or on more than one class of objects.

COM an abbreviation of Component Object Model, a component model defined and supported by Microsoft Corp. COM is the basis of OLE2 technologies and is supported on all members of the Windows family of operating systems.

Component an instantiable object class or an instance of such class that can be manipulated by general purpose code using only information available at run-time. A Microsoft COM object is a component, a Win32 window is a component; a C++ class without run-time type information (RTTI) is not a component.

Component model(s) a class of object model based on language-independent definition of objects, their attributes and mechanisms of invocation. Unlike object-oriented languages, component models promote modularity by allowing systems to be built from objects that reside in different executable modules, processes and computers.

Connecting process of establishing a connection between terminals of two parts in which sufficient information is exchanged between the parts to establish that both parts can interact and to allow at least one of the parts to invoke services of the other part.

Connection an association between two terminals for the purposes of transferring data, invoking operations or passing events.

Connection broker an entity that drives and enforces the procedure for establishing connections between terminals. Connection brokers are used in the present invention to create connections exchanging the minimum necessary information between the objects being connected.

Connection,

direction of a characteristic of a connection defined by the flow of control on it. Connections can be unidirectional, such as when only one of the participants invokes operations on the other, or bi-directional, when each of the participants can invoke operations on the other one.

Connection, direction

of data flow a characteristic of a connection defined by the data flow on it. For example, a function call on which arguments are passed into the function but no data is returned has uni-directional data flow as opposed to a function in which some arguments are passed in and some are returned to the caller.

Connection, logical

contract a defined protocol of interaction on a connection recognized by more than one object. The same logical contract may be implemented using different physical mechanisms.

Connection, physical

mechanism a generic mechanism of invoking operations and passing data through connections. Examples of physical mechanisms include function calls, messages, v-table interfaces, RPC mechanisms, inter-process communication mechanisms, network sessions, etc.

Connection point see terminal.

Connection,

synchronosity a characteristic of a connection which defines whether the entity that invokes an operation is required to wait until the execution of the operation is completed. If at least one of the operations defined by the logical contract of the connection must be synchronous, the connection is assumed to be synchronous.

Container an object which contains other objects. A container usually provides interfaces through which the collection of multiple objects that it contains can be manipulated from outside.

Control block see Data bus.

CORBA Common Object Request Broker Architecture, a component model architecture maintained by Object Management Group, Inc., a consortium of many software vendors.

Critical section a mechanism, object or part the function of which is to prevent concurrent invocations of the same entity. Used to protect data integrity within entities and avoid complications inherent to multiple threads of control in preemptive systems.

Data bus a data structure containing all fields necessary to invoke all operations of a given interface and receive back results from them. Data buses improve understandability of interfaces and promote polymorphism. In particular interfaces based on data buses are easier to de-synchronize, convert, etc.

Data flow direction in which data is being transferred through a function call, message, interface or connection. The directions are usually denoted as “in”, “out” or “in-out”, the latter defining a bidirectional data flow.

Descriptor table an initialized data structure that can be used to describe or to direct a process. Descriptors are especially useful in conjunction with general purpose program code. Using properly designed descriptor tables, such code can be directed to perform different functions in a flexible way.

De-serialization part of a persistency mechanism in object systems. A process of restoring the state of one or more objects from a persistent storage such as file, database, etc. See also serialization.

De-synchronizer a category of parts used to convert synchronous operations to asynchronous. Generally, any interface with unidirectional data flow coinciding with the flow of control can be de-synchronized using such a part.

Event in the context of a specific part or object, any invocation of an operation implemented by it or its subordinate parts or objects. Event-driven designs model objects as state machines which change state or perform actions in response to external events. In the context of a system of objects, a notification or request typically not directed to a single object but rather multicast to, or passed through, a structure of objects. In a context of a system in general, an occurrence.

Event, external An event caused by reasons or originated outside of the scope of a given system.

Execution context State of a processor and, possibly of regions of memory and of system software, which is not shared between streams of processor instructions that execute in parallel. Typically includes some but not necessarily all processor registers, a stack, and, in multithreaded operating systems, the attributes of the specific thread, such as priority, security, etc.

Factory, abstract a pattern and mechanism for creating instances of objects under the control of general purpose code. The mechanism used by OLE COM to create object instances is an abstract factory; the operator “new” in C++ is not an abstract factory.

Factory, component

or part portion of the program code of a component or part which handles creation and destruction of instances. Usually invoked by an external abstract factory in response to request(s) to create or destroy instances of the given class.

Flow of control a sequence of nested function calls, operation invocations, synchronous messages, etc. Despite all abstractions of object-oriented and event-driven methods, on single-processor computer systems the actual execution happens strictly in the sequence of the flow of control.

Group property a property used to represent a set of other properties for the purposes of their simultaneous manipulation. For example, an assembly containing several parts may define a group property through which similar properties of those parts can be set from outside via a single operation.

Indicator a category of parts that provides human-readable representation of the data and operations that it receives. Used during the development process to monitor the behavior of a system in a given point of its structure.

Input a terminal with incoming flow of control. As related to terminals, directional attributes such as incoming and outgoing are always defined from the viewpoint of the object on which the terminal is defined.

Interaction an act of transferring data, invoking an operation, passing an event, or otherwise transfer control between objects, typically on a single connection between two terminals,

Interaction, incoming in a context of a given object, an interaction that transfers data, control or both data and control into this is object. Whenever both control and data are being transferred in one and the same interaction, the direction is preferably determined by the direction of the transfer of control.

Interaction, outgoing in a context of a given object, an interaction that transfers data, control or both data and control out of this object. Whenever both control and data are being transferred in one and the same interaction, the direction is preferably determined by the direction of the transfer of control

Interface a specification for a set of related operations that are implemented together. An object given access to an implementation of an interface is guaranteed that all operations of the interface can be invoked and will behave according to the specification of that interface.

Interface,

message-based an interface the operations of which are invoked through messages in message-passing systems. “Message-based” pertains to a physical mechanism of access in which the actual binding of the requested operation to code that executes this operation on a given object is performed at call time.

Interface, OLE COM a standard of defining interfaces specified and enforced by COM. Based on the virtual table dispatch mechanism supported by C++ compilers.

Interface, remoting a term defined by Microsoft OLE COM to denote the process of transferring operations invoked on a local implementation of an interface to some implementation running on a different computer or in a different address space, usually through an RPC mechanism.

Interface, v-table a physical mechanism of implementing interfaces, similar to the one specified by OLE COM.

Marshaler a category of parts used to convert an interface which is defined in the scope of a single address space to a logically equivalent interface on which the operations and related data can be transferred between address spaces.

Multiplexor a category of parts used to direct a flow of operations invoked on its input through one of several outgoing connections. Multiplexors are used for conditional control of the event flows in structures of interconnected parts.

Name a persistent identifier of an entity that is unique within a given scope. Most often names are human-readable character strings; however, other values can be used instead as long as they are persistent.

Name space the set of all defined names in a given scope.

Name space, joined a name space produced by combining the name spaces of several parts. Preferably used in the present invention to provide unique identification of properties and terminals of parts in a structure that contains those parts.

Object, composite an object that includes other objects, typically interacting with each other. Composites usually encapsulate the subordinate objects.

Output a terminal with outgoing flow of control. See also Input.

Parameterization a mechanism and process of modifying the behavior of an object by supplying particular data values for attributes defined by the object.

Part an object or a component preferably created through an abstract factory and having properties and terminals. Parts can be assembled into structures at run-time.

Property a named attribute of an object exposed for manipulation from outside through a mechanism that is not specific for this attribute or object class.

Property interface an interface which defines the set of operations to manipulate properties of objects that implement it. Typical operations of a property interface include: get value, set value, and enumerate properties.

Property mechanism a mechanism defining particular ways of addressing and accessing properties. A single property interface may be implemented using different property mechanisms, as it happens with parts and assemblies. Alternatively, the same property mechanism can be exposed through a number of different property interfaces.

Proxy program code, object or component designed to present an entity or a system in a way suitable for accessing it from a different system. Compare to a wrapper.

Repeater a category of parts used to facilitate connections in cases where the number of required connections is greater than the maximum number supported by one or more of the participants.

Return status a standardized type and set of values returned by operations of an interface to indicate the completion status of the requested action, such as OK, FAILED, ACCESS VIOLATION, etc.

Serialization part of a persistency mechanism in object systems. A process of storing the state of one or more objects to persistent storage such as file, database, etc. See also de-serialization.

Structure of parts a set of parts interconnected in a meaningful way to provide specific functionality.

Structured storage a mechanism for providing persistent storage in an object system where objects can access the storage separately and independently during run-time.

Terminal a named entity defined on an object for the purposes of establishing connections with other objects.

Terminal, cardinality the maximum number of connections in which a given terminal can participate at the same time. The cardinality depends on the nature of the connection and the way the particular terminal is implemented.

Terminal, exterior a terminal, preferably used to establish connections between the part to which it belongs and one or more objects outside of this part.

Terminal, interior a terminal, of an assembly, preferably used to establish connections between the assembly to which it belongs and one or more subordinate objects of this assembly.

Terminal interface an interface which defines the set of operations to manipulate terminals of objects that implement it.

Terminal mechanism a mechanism defining particular ways of addressing and connecting terminals. A single terminal interface may be implemented using different terminal mechanisms, as happens with parts and assemblies.

Thread of execution a unit of execution in which processor instructions are being executed sequentially in a given execution context. In the absence of a multithreaded operating system or kernel, and when interrupts are disabled, a single-processor system has only one thread of execution, while a multiprocessor system has as many threads of execution as it has processors. Under the control of a multithreaded operating system or kernel, each instance of a system thread object defines a separate thread of execution.

Wrapper program code, object or component designed to present an entity or a system in a way suitable for inclusion in a different system. Compare to a proxy.

What is claimed is:

1. A method for designing a software system in which system at least a first object is created arbitrarily earlier than a second object and said second object is automatically connected to at least said first object, said method comprising the steps of:
creating said first object;
creating a first container object capable of holding at least one other object of arbitrary object class;
defining at least a first template connection between said first object and said first container object;
creating said second object;
connecting said second object to said first object using said first template connection in which template said first container object is replaced with said second object.

2. The method in claim 1 wherein the step of creating said second object is performed by said first container object.

3. The method in claim 1 wherein the step of connecting said second object to said first object is performed by said first container object.

4. The method in claim 1 wherein the step of creating said second object is performed by said first container object and the step of connecting said second object to said first object is performed by said first container object.

5. The method in claim 1 wherein connections between ail objects are established between connection points on said objects.

6. The method in claim 1 wherein said first template connection is defined in a data structure.

7. The method in claim 5 wherein said first template connection is defined in a data structure.

8. A system created using any one of claims 1, 2, 3, 4, 5, 6 or 7.

9. A method for describing connections between a plurality of objects in a software system in which at least a first object of said plurality is created arbitrarily later than the remainder of said plurality, said method comprising the steps of:
defining at least a second object of said remainder;
defining a first container object which will be used as a placeholder for defining connections between said first object and said remainder;
defining at least a first connection between said second object and said first object by using said first container object in place of said first object.

10. A method for describing connections between a first plurality of objects in a software system and a second plurality of objects in said software system, said second plurality being created arbitrarily later than said first plurality, said method comprising the steps of:
defining at least a first object of said first plurality;
defining a first container object which will be used as a placeholder for defining connections between said first object and each object of said second plurality;
defining at least a first connection to be created between said first object and each object of said second plurality as a connection between said first object and said first container object.

11. In a software system, said software system having a plurality of objects, a container object comprising:
a first memory for keeping reference to at least a first object of arbitrary object class;
a section of program code causing said first memory to be modified so that it will contain a first reference to a second object;
a section of program code accessing a data structure and determining that at least a first connection needs to be established between said second object and at least a third object;
a section of program code causing said first connection to be established.

12. The container object of claim 10 further comprising a section of program code causing said second object to be created.

13. In a software system, said software system having a plurality of objects, a container object comprising:
a memory for keeping at least one reference to a contained object of arbitrary class;
a connection point for receiving requests to modify the set of contained objects;
at least one virtual connection point that accepts at least a first connection to be established to said contained object, said acceptance occurring before said contained object is added to said contained object;
a section of program code that establishes said first connection when said contained object is added to said container object.

14. In a software system, said software system having a plurality of objects, a container object comprising:
a first memory for keeping at least one reference to a contained object of arbitrary class;
a connection point for receiving requests to modify the set of contained objects;
at least one virtual property that accepts the value to be set in a first property on said contained object, said virtual property being capable of accepting values of a plurality of data types;
a section of program code that sets said first property on said contained object to said accepted value when said contained object is added to said contained object.

15. In a software system, said software system having a plurality of objects, a container object comprising:
a first memory for keeping a first plurality of contained objects of arbitrary classes;
a second memory for keeping a second plurality of unique identifiers, each identifier of said second plurality associated with exactly one object of said first plurality;
at least a first property, said first property being a second property of a first object of said first plurality and said first property being identified by a combined identifier produced by combining the associated identifier of said first object and the identifier of said second property.

16. The software system of claim 15, wherein each said property comprises a terminal.

17. The software system of either of claims 15 or 16, wherein the second memory doesn't exist and contained objects are identified by identifiers assigned by the container.

18. A container object class in a software system, said software system having a first plurality of objects, each object of said first plurality belonging to an object class, said container object class comprising:
means for holding a second plurality of contained objects, said means being applicable to contained objects of any class;
means for changing the set of said contained objects, said means being applicable to contained objects of any class;
means for presenting said plurality of contained objects as a single object, said means being applicable to contained objects of any class.

19. The container object class of claim 18 wherein said single object is an instance of said container object class.

20. A container object which is an instance of the container object class of claim 18.

21. In a software system, said software system having a plurality of objects, each object of said plurality of objects belonging to an object class, said software system having means for building at least one structure of connected objects and means of describing said structure of connected objects, a container object class comprising:
means for holding a plurality of contained objects, said means being applicable to contained objects of any class;
means for changing the set of said contained objects programmatically, said means being applicable to contained objects of any class;
means for presenting said plurality of contained objects as a single object in said structure of connected objects, said means being applicable to contained objects of any class.

22. A container object which is an instance of the container object class of claim 21.

23. In a software system having at least a first object and a second object, said first object having at least one first connection point, said second object having at least one second connection point, said first connection point being used to establish a first connection between said first connection point of said first object and said second connection point of said second object, and said software system having means of requesting the establishment of a connection between connection points, a container object comprising:
means for adding and removing said first object from said container;
means for defining a third connection point on said container object;
means for transforming a requests for establishing of a connection between said second connection point and said third connection point into a request for establishing a connection between said second connection point and said first connection point.

24. The container object of claim 23 wherein said software system includes means of identifying said first connection point using a first identifier, said container object having the additional means to identify said third connection point using said first identifier.

25. The container object of claim 23 wherein said software system includes means of identifying said first connection point using a first identifier, said container object having the additional means to identify said first object using a second identifier and said container object having the additional means to identify said third connection point using a combination of said first identifier and said second identifier.

26. A container object in a software system, said software system having at least one first object and said container object, said first object having at least one first property, said software system having means of requesting operations over said first property, said container comprising:
means for adding and removing said first object from said container;
means for defining a second property on said container object;
means for transforming a request for operations over said second property into a request for operations over said first property.

27. The container object of claim 26 wherein said software system has means of identifying said first property using a first identifier, said container object having the additional means to identify said second property using said first identifier.

28. The container object of claim 26 wherein said software system has means of identifying said first property using a first identifier, said container object having the additional means to identify said first object using a second identifier and said container object having the additional means to identify said second property using a combination of said first identifier and said second identifier.

29. A container object having the sum of the means of the container object of claim 25 and of the container object of claim 28.

30. The container of claim 29 wherein all the specified means of said container are implemented independently of the class of said first object.

31. A container object in a software system, said software system having a plurality of objects, said software system having means for requesting operations over an object, said container object comprising:
means for holding a plurality of contained objects;
means for changing the set of said contained objects programmatically;
means for identifying each object of said contained objects by a separate, unique identifier for each object;
means of handling requests for operations over any object of said contained objects wherein said identifier is used to determine which object of said contained objects should handle the request.

32. The container of claim 31 wherein said container has the additional means of automatically assigning said unique identifier to each object added to said container.

33. The container of claim 31 wherein said unique identifier is assigned outside of said container, and said container has the additional means of associating said unique identifier with each said contained object.

34. A method for caching and propagating property values to a dynamic set of objects in a software system, said software system having a plurality of objects, each of said objects having a plurality of properties, each said property having a value and an identifier, said method comprising the steps of:
accepting a first request to modify the value of a first property on behalf of said dynamic set of objects as if said dynamic set of objects were one object;
storing said value and identifier of said first property in a first data storage;
retrieving said value and identifier of said first property from said first data storage;
issuing a request to modify the value of said first property on a first object of said dynamic set of objects, using said value and identifier retrieved from said first data storage.

35. A container object in a software system using the method in claim 34.

36. A method for caching and propagating outgoing connections of a dynamic set of objects in a software system, said software system having a plurality of objects, said software system having means for establishing connections between said objects, said connections providing means for a first connected object to make outgoing calls to a second connected object, said method comprising the steps of:
accepting the request to establish a first outgoing connection between said dynamic set of objects and a first object, as if said dynamic set of objects were a single object;
storing a first data value necessary to effect said first connection in a first data storage;
retrieving said first data value from said first data storage;
issuing a request to establish a second connection between a second object of said dynamic set and said first object, using said first data value retrieved from said first data storage.

37. A container object in a software system using the method in claim 36.

38. A container object in a software system using both the method in claim 34 and the method in claim 36.

39. A container object in a software system, said software system having a plurality of objects, said software system having means for building at least one structure of connected objects, said software system having a first means of describing said structure, said container object being a first object in said structure, said first object having a first connection to at least a second object in said structure, said first connection being described by said first means, said container comprising:
means for holding a plurality of contained objects;
means for changing the set of said contained objects programmatically;
means for connecting each of said contained objects to said second object.

40. The container in claim 39 wherein said container has the additional means of establishing all connections between said container and other objects in said structure, said all connections being described by said first means, said additional means causing the establishing of each of said all connections between each of said contained objects and said other objects in said structure.

41. A container object in a software system, said software system having a plurality of objects, said software system having means of building at least one structure of connected objects, said software system having a first means of describing said structure, said software system providing a second means of enumerating all connections described by said first means, said container being a first object in said structure, said container being connected to at least a second object in said structure, said container comprising:
means for holding a plurality of contained objects;
means for changing the set of said contained objects programmatically;
means for finding a first described connection between said container and said second object;
means for establishing said first connection between a third object contained in said container and said second object.

42. The container in claim 41 wherein said container establishes connections between a first connection point of said third object and a second connection point of said second object.

43. A container object in a software system, said software system having a plurality of objects, said container having a first connection to at least one object, said first connection being described in a first data structure, said container comprising:
means for holding a plurality of contained objects;
means for changing the set of said contained objects programmatically;
means for determining a first set of connections to be established for each object added to said set of contained objects based on the set of connections described in said first data structure;
means for establishing said first set of connections.

44. The container in claim 43 wherein said container further comprises means for dissolving said first set of connections.

45. The container in claim 43 wherein said container further comprises:
means for remembering a second set of outgoing connections from said container to other objects
means for excluding said second set of connections from said first set of connections
means for establishing said second set of outgoing connections for each object added to said set of contained objects.

46. The container in claim 43 wherein said container further comprises:
means for remembering properties set on said container;
means for setting remembered properties on each new object added to said set of contained objects;
means for propagating properties set on said container to all objects in said set of contained objects;

47. A container object in a software system, said software system containing a plurality of objects, said software system having a first means to establish connections between connection points of objects of said plurality, said first means providing the ability to establish more than one connection to a first connection point of a first object, said container object having a second connection point connected to said first connection point of said first object, said container comprising:
means for holding a plurality of contained objects;
means for changing the set of said contained objects programmatically;
means for establishing a separate connection between a connection point on each object of said plurality of contained objects and said first connection point of said first object.

48. The container in claim 43 wherein said container further comprises:
means for remembering properties set on said container;

49. A part for distributing events among a plurality of parts, said part comprising:
a multiple cardinality input,
a multiple cardinality output,
means for recording references to parts that are connected to said output
means for forwarding events received on said input to each of the connected objects to said output.

50. A part for distributing events and requests between a plurality of other parts, said part comprising:
a first terminal for receiving calls;
a second terminal for sending calls out to a first connected part;
a third terminal for sending calls out to a second connected part;
means for choosing whether to send the received call through said second terminal or through said third terminal.

51. A part for distributing events and requests between a plurality of other parts, said part comprising:
a first terminal for receiving calls;
a second terminal for sending calls out to a first connected part;
a third terminal for sending calls out to a second connected part;
means for choosing whether to first send the received call through said second terminal and then through said third terminal or to first send the received call through said third terminal and then through said second terminal.

52. A part for distributing events and requests between a plurality of other parts, said part comprising:
a first terminal for receiving calls;
a second terminal for sending calls out to a first connected part;
a third terminal for sending calls out to a second connected part;
means for sending a first received call as a first call to said second terminal and then, based on value returned from said first call, choose whether or not to send said first received call as a second call to said third terminal.

53. A method for desynchronizing events and requests in a software system, said method comprising the steps of:
storing said event in a memory;
receiving a pulse signal;
retrieving said event from said memory and continuing to process said event in the execution context of said pulse signal.

54. A part in a software system, said part comprising:
a first terminal for receiving calls;
a second terminal for sending calls out to a first connected part;
a third terminal for receiving a pulse call;
a memory for storing call information received from said first terminal;
a section of program code that is executed when said part receives said pulse calls, said section retrieving said call information from said memory and sending a call out to said second terminal.

55. The part in claim 54 wherein said memory can hold call information for a plurality of calls.

56. The part in claim 54 wherein said memory is a queue.

57. The part in claim 54 wherein said memory is a stack.

58. The part in claim 54 wherein said first terminal and said second terminal are one terminal.

59. A part in a software system, said part comprising:
a first terminal for receiving calls;
a second terminal for sending calls out to first connected part;
a memory for storing call information received from said first terminal;
a means for obtaining execution context;
a section of program code that is executed in said execution context, said section retrieving said call information from said memory and sending a call out to said second terminal.

60. The part in claim 59 wherein said means for obtaining execution context is a thread of execution in a multithreaded system.

61. The part in claim 59 wherein said means for obtaining execution context is a timer callback.

62. The part in claim 59 wherein said means for obtaining execution context is a subordinate part.

63. The part in claim 59 wherein said means for obtaining execution context is a subordinate part, said subordinate part having a primary function of providing execution context for other parts.

64. The part in claim 59 wherein said first terminal and said second terminal are one terminal.

65. A part in a software system, said part comprising:
a first subordinate part for storing incoming data;
a second subordinate part for generating execution context.

66. The part in claim 65 wherein said part further comprises a connection between said first subordinate part and said second subordinate part.

67. A part in a software system, said part comprising:
a first terminal for receiving an incoming request;
a second terminal for sending out an outgoing request;
a third terminal for receiving a request completion indication;
a synchronization object for blocking the thread in which said incoming request was received until said request completion indication is received.

68. The part in claim 67 wherein said second terminal and said third terminal are one terminal.

69. A part in a software system, said part comprising:
an input terminal for receiving calls of a first type;
an output terminal for sending calls of a second type;
means for converting calls of said first type to calls of said second type.

70. A part in a software system, said part comprising:
an input terminal for receiving calls of a first type and sending calls of said first type;
an output terminal for receiving calls of a second type and sending calls of said second type;
means for converting calls of said first type to calls of said second type;
means for converting calls of said second type to calls of said first type.

71. The part of claim 70 wherein said first type and said second type differ by physical mechanism.

72. The part of claim 70 wherein said first type and said second type differ by logical contract.

73. A part in a software system, said part comprising:
a first terminal for receiving a first request and sending a second request;
a second terminal for sending said first request;
a third terminal for receiving said second request.

74. The part of claim 73 wherein:
said first terminal is a bidirectional terminal;
said second terminal is an output terminal;
said third terminal is an input terminal.

75. A part in a software system, said part comprising:
a first terminal for receiving calls;
a second terminal for sending out calls received on said first terminal;
a third terminal for sending out calls whenever a call is received on said first terminal.

76. The part in claim 76 wherein said part further comprises a first property for defining a criterion for selecting for which calls received on said first terminal said part will send out calls through said third terminal.

77. The part in claim 76 wherein said part further comprises a second property for configuring what call said part will send out said third terminal.

78. The part in claim 76 wherein said part further comprises a third property for configuring what call said part will send out said third terminal before sending out a call received on said first terminal to said second terminal.

79. The part in claim 76 wherein said part further comprises a third property for configuring what call said part will send out said third terminal after sending out a call received on said first terminal to said second terminal.

80. The part in claim 76 wherein said part further comprises a third property for configuring whether a call out through said third terminal should be made before or after sending out a call received on said first terminal to said second terminal.

81. A part in a software system, said part comprising:
a first terminal for receiving calls;
a second terminal for sending out calls received on said first terminal;
a third terminal for sending out calls whenever a call sent out said second terminal returns a pre-determined value.

82. The part of claim 81 wherein said part further comprises a property for configuring said pre-determined value.

83. The part of claim 81 wherein said pre-determined value indicates that said second call has failed.

84. The part of claim 81 wherein said pre-determined value indicates that said second call has succeeded.

85. A part in a software system, said part comprising:
a first terminal for receiving calls;
a second terminal for sending out calls received on said first terminal;
a first property for configuring a first value;
a third terminal for sending out notification calls whenever a call sent out said second terminal returns a second value that matches said first value.

86. The part of claim 85 wherein said part further comprises a second property for configuring whether said part will send out said notification calls if said second value matches said first value or if said second value differs from said first value.

87. A part in a software system, said part comprising:
a terminal for receiving calls of arbitrary logical contract;
a property for defining a return value.

88. The part of claim 87 wherein said part further comprises a property for configuring the logical contract for calls received on said terminal.

89. The part of claim 87 wherein said terminal is an input terminal.

90. The part of claim 87 wherein said terminal is a bidirectional terminal and said part does not make calls out said terminal.

91. A part in a software system, said part comprising:
a terminal for receiving a first call and a reference to a first memory;
a property for defining a return value;
a section of program code for freeing said first memory.

92. The part in claim 91 wherein said part further comprises means for determining whether said section of program code should be executed for said first call.

93. The part in claim 91 wherein said part further comprises means for determining whether said section of program code should be executed for said first call based on a value contained in said first memory.

94. A part in a software system, said part comprising:
a first terminal for receiving a first call;
a second terminal for sending out said first call;
means for extracting data from said first call;
means for formatting said extracted data as a first text;
means for sending out said first text.

95. The part of claim 94 wherein said means for sending out said first text is a third terminal.

96. The part of claim 94 wherein said means for sending out said first text is a section of program code that invokes a function for displaying said first text on a console.

97. A first structure of connected parts in a software system, said first structure comprising:
a factory part for determining when a new part should be created;
a container part for holding a first plurality of parts of arbitrary part class;
a connection between said factory part and said container part.

98. The structure of claim 97 wherein:
said factory part has a first terminal;
said container part has a second terminal;
said connection is established between said first terminal and said second terminal.

99. The structure of claim 97 wherein said structure further comprises a demultiplexing part having a first terminal for receiving calls, a second terminal for sending out calls and means for selecting a part connected to said second terminal.

100. The structure of claim 99 wherein said structure further comprises a plurality of connections, each connection established between said second terminal of said demultiplexing part and a terminal of each part in said first plurality.

101. The structure of claim 100 wherein said connection demultiplexing part and said factory part are one part.

102. A composite part in a software system, said composite part comprising the structure in claim 97.

103. The structure of claim 97 wherein said structure further comprises an enumerator part for defining the set of parts in said first plurality.

104. The structure of claim 103 wherein said structure further comprises a connection between said enumerator part and said factory part.

105. The structure of claim 97 wherein said enumerator uses a data container for defining the parts in first plurality.

106. The structure of claim 103 wherein said enumerator comprises means for enumerating a set of peripheral devices connected to a computer system.

107. The structure of claim 106 wherein said enumerator further comprises a first property for configuring a limitation on the type of peripheral devices to be enumerated.

108. The structure of claim 97 wherein said structure further comprises a parameterizer part for retrieving the value for at least one property to be set on each part of said first plurality.

109. The structure of claim 108 wherein said parameterizer part retrieves said value from a data container.

110. The structure of claim 108 wherein said parameterizer part uses a persistent identifier to select said value among a set of values.

111. The structure of claim 97 wherein said structure further comprises a serializer part for saving the value of at least on property of each part in said first plurality.

112. The structure of claim 111 wherein said structure further comprises a trigger part for initiating said saving of the value.

113. The structure of claim 97 wherein said structure further comprises a parameterizer part for retrieving the value for a first property to be set on each part of said first plurality and for saving the value of said first property.

114. The structure of claim 97 wherein said factory part determines whether to create a new part in said first plurality or to use an existing part in said first plurality based a persistent identifier provided to said factory part.

115. The structure of claim 97 wherein said structure further comprises a loader part for bringing in memory a class for a part to be created.

116. The structure of claim 116 wherein said structure further comprises:
a connection between said factory part and said loader part;
a connection between said loader part and said container part.

117. A part in a software system, said part comprising:
a first terminal for receiving calls;
a second terminal for sending out calls received on said first terminal;
a third terminal for sending out requests to create new parts;
means for selecting calls received on said first terminal for which said part sends out requests on said third terminal.

118. A method for designing access to a hardware component in a component-based software system, said method comprising the steps of:
designating a first software component for receiving interrupts from said hardware component;
designating a at least a second software component for accessing input and output ports of said hardware component;
designating a third software component for handling interrupts received by said first software component;
designating a fourth software component for manipulating said hardware component; connecting said first software component to said third software component;
connecting said second software component to said fourth software component.

119. The method in claim 118 wherein said method further comprises the step of connecting said third software component and said fourth software component.

120. The method in claim 118 wherein said third software component and said fourth software component are one component.

121. A part in a software system, said part comprising:
a first terminal for sending out calls;
a section of program code for receiving control when an interrupt occurs and sending out a call through said first terminal.

122. The part of claim 121 wherein said part further comprises a property for configuring which hardware interrupt vector among a plurality of hardware interrupt vectors said part should receive.

123. The part of claim 121 wherein said part further comprises a section of program code for registering said part to receive control when said interrupt occurs.

124. A part in a software system, said part comprising:
a terminal for receiving requests to access at least one port of a hardware component;
a property defining the base address of said port;
a section of code that accesses said port when a request is received on said first terminal.

125. The part of claim 124 wherein said port is a memory-mapped port.

126. The part of claim 124 wherein said port is a input-output port.

127. The part of claim 124 wherein said requests include a read request and a write request.

128. A structure of connected parts in a software system, said structure comprising:
an interrupt source part for receiving interrupt from a hardware component;
at least one port accessor part for accessing ports of said hardware component;
at least one controller part for controlling said hardware component.

129. The structure of claim 128 wherein said controller part accesses said hardware component exclusively through said interrupt source part and said port accessor part.

130. The structure of claim 128 wherein said structure further comprises:
a connection between said interrupt source part and one of said controller parts;
a connection between one of said port accessor parts and one of said controller parts.

131. A composite part in a software system, said composite part containing the structure of claim 128.

132. A composite part in a software system, said composite part containing the structure of claim 129.

133. A method for designing software system in which system at least a first object is created arbitrarily earlier than a second object and said second object is automatically connected to at least said first object, said method comprising the steps of:
creating said first object;
creating a first container object capable of holding at least one other object of arbitrary object class;
defining at least a first template connection between said first object and said first container object;
creating said second object;
connecting said second object to said first object using said first template connection in which template said first container object is replaced with said second object.
